(19) United States
(12) Patent Application Publication
(10) Pub. No.: US 2017/0027172 A1
(43) Pub. Date: Feb. 2, 2017

(54) USE OF SUBSTITUTE OXO TETRAHYDROQUINOLINE SULFONAMIDES OR SALTS THEREOF FOR RAISING STRESS TOLERANCE OF PLANTS

(71) Applicant: BAYER CROPSCIENCE AKTIENGESELLSCHAFT, Monheim am Rhein (DE)

(72) Inventors: Jens FRACKENPOHL, Frankfurt (DE); Guido BOJACK, Wiesbaden-Naurod (DE); Hendrik HELMKE, Liederbach (DE); Stefan LEHR, Liederbach (DE); Thomas MÜLLER, Frankfurt (DE); Lothar WILLMS, Hoftheim (DE); Hansjörg DIETRICH, Liederbach (DE); Dirk SCHMUTZLER, Hattersheim (DE); Rachel BALTZ, Collonges Au Mont D OR (FR); Udo BICKERS, Köln (DE)

(21) Appl. No.: 15/302,867

(22) PCT Filed: Apr. 7, 2015
(86) PCT No.: PCT/EP2015/057446

§ 371 Date: Oct. 7, 2016

(30) Foreign Application Priority Data
Apr. 10, 2014 (EP) 14164238.9

(51) Int. Cl. A01N 43/42; A01N 43/58; A01N 43/54; A01N 53/00; A01N 43/60

(52) U.S. Cl. CPC A01N 43/42; A01N 53/00; A01N 43/60; A01N 43/54; A01N 43/58

(57) ABSTRACT

The invention relates to the use of substituted oxotetrahydroquinolinylsulfonamides or salts thereof

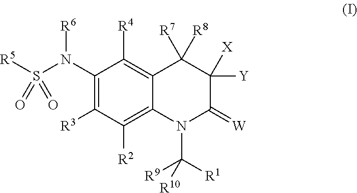

where the radicals in the general formula (I) correspond to the definitions given in the description, for enhancing stress tolerance in plants to abiotic stress, and/or for increasing plant yield.

The invention relates to the use of substituted oxotetrahydroquinolinylsulfonamides or salts thereof for enhancing stress tolerance in plants to abiotic stress, and for enhancing plant growth and/or for increasing plant yield.

It is known that particular arylsulfonamides, for example 2-cyanobenzenesulfonamides, have insecticidal properties (cf., for example, EP0033984 and WO2005/035486, WO2006/056433, WO2007/060220). 2-Cyanobenzenesulfonamides with particular heterocyclic substituents are described in EP2065370. It is further known that particular aryl- and heteroaryl-substituted sulfonamides can be used as active ingredients to counter abiotic plant stress (cf. WO2011/113861). The action of particular aryl-, heteroaryl- and benzylsulfonamidocarboxylic acids, -carboxylic esters, -carboxamides and -carbonitriles against abiotic plant stress is described in WO 2012/089721 and WO 2012/089722.

The preparation of sulfamidoalkanecarboxylic acids and sulfamidoalkanecarbonitriles is described in DE847006. The use of selected arylsulfonamides having alkylcarboxyl substituents as growth regulators especially for limiting the longitudinal growth of rice and wheat plants with the aim of minimizing weather-related lodging is described in DE2544859, while the fungicidal action of certain N-cyanoalkylsulfonamides is described in EP176327. It is also known that substituted N-sulfonylaminoacetonitriles can be used to control parasites in warm-blooded animals (cf. WO2004/000798). The use of 1-(4-methylphenyl)-N-(2-oxo-1-propyl-1,2,3,4-tetrahydroquinolin-6-yl)methanesulfonamide to counter drought stress in Arabidopsis thaliana and soya is described in Proc. Natl. Acad. Sci. 2013, 110(29), 12132-12137. Further 1-aryl-N-(2-oxo-1-alkyl-1,2,3,4-tetrahydroquinolin-6-yl)methanesulfonamides having an alkyl group in the N-tetrahydroquinolinyl unit which is unbranched or branched but has no further substitution are described in WO2013/148339. WO2013/148339 likewise describes the agonistic effect of the substances in question on abscisic acid receptors.

It is also known that substituted arylsulfonamides (cf., for example, WO2009/105774, WO2006/124875, WO96/36595) and substituted hetarylsulfonamides (cf. WO2009/113600, WO2007/122219) can be used as active pharmaceutical ingredients. WO2003/007931 likewise describes the pharmaceutical use of substituted naphthylsulfonamides, while Eur. J. Med. 2010, 45, 1760 describes naphthylsulfonyl-substituted glutaminamides and their antitumor action. Effects on cancer stem cells are also described in WO2013/130603. In addition, it is known that pyrrolidinyl-substituted arylsulfonamides can be used as cathepsin C inhibitors in the treatment of respiratory disorders (WO2009/026197) or as antiinfective agents in the treatment of hepatitis C (WO2007/092588). The pharmaceutical use of N-arylsulfonyl derivatives of various other amino acids, for example as urokinase inhibitors (cf. WO2000/05214), as active ingredients for treatment of diabetes (cf. WO2003/091211), as analgesics (cf. WO2008/131947) and as γ-secretase modulators (cf. WO2010/108067) has also been described.

It is likewise known that particular substituted benzoxazinylsulfonamides can be used as active pharmaceutical ingredients, for example as regulators of mineralocorticoid receptors (cf. JP2009051830, WO2007/089034). The use of amidinophenylpropionyl-substituted tetrahydroquinolines as active antithrombotic ingredients is described in DE19727117. The use of 2-oxoquinoline derivatives as active immunomodulating ingredients has likewise been described (cf. JP07252228). Furthermore, it is known that oxotetrahydroquinolinylsulfonamides can be used as Rho kinase inhibitors (cf. Eur. J. Med. Chem. 2008, 43, 1730).

It is known that plants can react with specific or unspecific defense mechanisms to natural stress conditions, for example cold, heat, drought stress (stress caused by aridity and/or lack of water), injury, pathogenic attack (viruses, bacteria, fungi, insects) etc., but also to herbicides [Pflanzenbiochemie [Plant Biochemistry], p. 393-462, Spektrum Akademischer Verlag, Heidelberg, Berlin, Oxford, Hans W. Heldt, 1996.; Biochemistry and Molecular Biology of Plants, p. 1102-1203, American Society of Plant Physiologists, Rockville, Md., eds. Buchanan, Gruissem, Jones, 2000].

Numerous proteins in plants, and the genes that code for them, which are involved in defense reactions to abiotic stress (for example cold, heat, drought, salt, flooding) are known. Some of these form part of signal transduction chains (e.g. transcription factors, kinases, phosphatases) or cause a physiological response of the plant cell (e.g. ion transport, deactivation of reactive oxygen species). The signaling chain genes of the abiotic stress reaction include transcription factors of the DREB and CBF classes (Jaglo-Ottosen et al., 1998, Science 280: 104-106). Phosphatases of the ATPK and MP2C type are involved in the reaction to salt stress. In addition, in the event of salt stress, the biosynthesis of osmolytes such as proline or sucrose is frequently activated. This involves, for example, sucrose synthase and proline transporters (Hasegawa et al., 2000, Annu Rev Plant Physiol Plant Mol Biol 51: 463-499). The stress defense of the plants to cold and drought uses some of the same molecular mechanisms. There is a known accumulation of what are called late embryogenesis abundant proteins (LEA proteins), which include the dehydrins as an important class (Ingram and Bartels, 1996, Annu Rev Plant Physiol Plant Mol Biol 47: 277-403, Close, 1997, Physiol Plant 100: 291-296). These are chaperones which stabilize vesicles, proteins and membrane structures in stressed plants (Bray, 1993, Plant Physiol 103: 1035-1040). In addition, there is frequently induction of aldehyde dehydrogenases, which deactivate the reactive oxygen species (ROS) which form in the event of oxidative stress (Kirch et al., 2005, Plant Mol Biol 57: 315-332). Heat shock factors (HSF) and heat shock proteins (HSP) are activated in the event of heat stress and play a similar role here as chaperones to that of dehydrins in the event of cold and drought stress (Yu et al., 2005, Mol Cells 19: 328-333).

A number of signaling substances which are endogenous to plants and are involved in stress tolerance or pathogenic defense are already known. Mention should be made here, for example, of salicylic acid, benzoic acid, jasmonic acid or ethylene [Biochemistry and Molecular Biology of Plants, p. 850-929, American Society of Plant Physiologists, Rockville, Md., eds. Buchanan, Gruissem, Jones, 2000]. Some of these substances or the stable synthetic derivatives and derived structures thereof are also effective on external application to plants or in seed dressing, and activate defense reactions which cause elevated stress tolerance or pathogen tolerance of the plant [Sembdner, and Parthier, 1993, Ann. Rev. Plant Physiol. Plant Mol. Biol. 44: 569-589].

It is also known that chemical substances can increase the tolerance of plants to abiotic stress. Such substances are applied either by seed dressing, by leaf spraying or by soil treatment. For instance, an increase in the abiotic stress tolerance of crop plants by treatment with elicitors of systemic acquired resistance (SAR) or abscisic acid derivatives is described (Schading and Wei, WO2000/28055; Abrams and Gusta, U.S. Pat. No. 5,201,931; Abrams et al., WO97/23441, Churchill et al., 1998, Plant Growth Regul 25: 35-45). In addition, effects of growth regulators on the stress tolerance of crop plants have been described (Morrison and Andrews, 1992, J Plant Growth Regul 11: 113-117, RD-259027). In this context, it is likewise known that a growth-regulating naphthylsulfonamide (4-bromo-N-(pyridin-2-ylmethyl)naphthalene-1-sulfonamide) influences the germination of plant seeds in the same way as abscisic acid (Park et al. Science 2009, 324, 1068-1071). Furthermore, in biochemical receptor tests a naphthylsulfamidocarboxylic acid (N-[(4-bromo-1-naphthyl)sulfonyl]-5-methoxynorvaline) shows a mode of action comparable to 4-bromo-N-(pyridin-2-ylmethyl)naphthalene-1-sulfonamide (Melcher et al. Nature Structural & Molecular Biology 2010, 17, 1102-1108). It is also known that a further naphthylsulfonamide, N-(6-aminohexyl)-5-chloronaphthalene-1-sulfonamide, influences the calcium level in plants which have been exposed to cold shock (Cholewa et al. Can. J. Botany 1997, 75, 375-382).

Similar effects are also observed on application of fungicides, especially from the group of the strobilurins or of the succinate dehydrogenase inhibitors, and are frequently also accompanied by an increase in yield (Draber et al., DE3534948, Bartlett et al., 2002, Pest Manag Sci 60: 309). It is likewise known that the herbicide glyphosate in low dosage stimulates the growth of some plant species (Cedergreen, Env. Pollution 2008, 156, 1099).

In the event of osmotic stress, a protective effect has been observed as a result of application of osmolytes, for example glycine betaine or the biochemical precursors thereof, e.g. choline derivatives (Chen et al., 2000, Plant Cell Environ 23: 609-618, Bergmann et al., DE4103253). The effect of antioxidants, for example naphthols and xanthines, for increasing abiotic stress tolerance in plants has also already been described (Bergmann et al., DD277832, Bergmann et al., DD277835). However, the molecular causes of the antistress action of these substances are largely unknown.

It is also known that the tolerance of plants to abiotic stress can be increased by a modification of the activity of endogenous poly-ADP-ribose polymerases (PARP) or poly-(ADP-ribose) glycohydrolases (PARG) (de Block et al., The Plant Journal, 2004, 41, 95; Levine et al., FEBS Lett. 1998, 440, 1; WO2000/04173; WO2004/090140).

It is thus known that plants possess several endogenous reaction mechanisms which can bring about an effective defense against a wide variety of different harmful organisms and/or natural abiotic stress. Since the environmental and economic demands on modern plant treatment compositions are increasing constantly, for example with respect to their toxicity, selectivity, application rate, formation of residues and favorable manufacture, there is a constant need to develop novel plant treatment compositions which have advantages over those known, at least in some areas.

It was therefore an object of the present invention to provide compounds which further increase tolerance to abiotic stress in plants, bring about invigoration of plant growth and/or contribute to an increase in plant yield. In this context, tolerance to abiotic stress is understood to mean, for example, tolerance to cold, heat and drought stress (stress caused by drought and/or lack of water), salts and flooding.

Surprisingly, it has now been found that substituted oxotetrahydroquinolinylsulfonamides can be used to enhance stress tolerance in plants to abiotic stress, and to enhance plant growth and/or to increase plant yield.

The present invention accordingly provides for the use of substituted oxotetrahydroquinolinylsulfonamides of the general formula (I), or salts thereof,

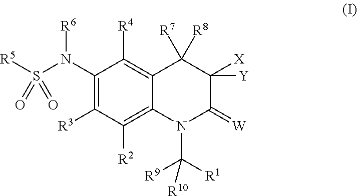

for increasing tolerance to abiotic stress in plants and/or for increasing plant yield, in which
R¹ is halogen, cyano, (C₃-C₁₀)-cycloalkyl, (C₃-C₁₀)-halocycloalkyl, (C₄-C₁₀)-cycloalkenyl, (C₄-C₁₀)-halocycloalkenyl, (C₁-C₁₀)-haloalkyl, (C₂-C₈)-haloalkenyl, (C₁-C₈)-alkoxy-(C₁-C₈)-haloalkyl, aryl, aryl-(C₁-C₈)-alkyl, heteroaryl, heteroaryl-(C₁-C₈)-alkyl, (C₃-C₈)-cycloalkyl-(C₁-C₈)-alkyl, (C₂-C₈)-haloalkynyl, heterocyclyl, heterocyclyl-(C₁-C₈)-alkyl, (C₁-C₈)-alkoxy-(C₁-C₈)-alkyl, (C₁-C₈)-alkylcarbonyl-(C₁-C₈)-alkyl, hydroxycarbonyl-(C₁-C₈)-alkyl, (C₁-C₈)-alkoxycarbonyl-(C₁-C₈)-alkyl, (C₂-C₈)-alkenyloxycarbonyl-(C₁-C₈)-alkyl, (C₂-C₈)-alkynyloxycarbonyl-(C₁-C₈)-alkyl, aryl-(C₁-C₈)-alkoxycarbonyl-(C₁-C₈)-alkyl, (C₃-C₈)-cycloalkoxycarbonyl-(C₁-C₈)-alkyl, (C₃-C₈)-cycloalkyl-(C₁-C₈)-alkoxycarbonyl-(C₁-C₈)-alkyl, aminocarbonyl-(C₁-C₈)-alkyl, (C₁-C₈)-alkylaminocarbonyl-(C₁-C₈)-alkyl, (C₃-C₈)-cycloalkylaminocarbonyl-(C₁-C₈)-alkyl, aryl-(C₁-C₈)-alkylaminocarbonyl-(C₁-C₈)-alkyl, heteroaryl-(C₁-C₈)-alkylaminocarbonyl-(C₁-C₈)-alkyl, (C₁-C₈)-alkylthio-(C₁-C₈)-alkyl, (C₃-C₈)-cycloalkylthio-(C₁-C₈)-alkyl, arylthio-(C₁-C₈)-alkyl, heterocyclylthio-(C₁-C₈)-alkyl, heteroarylthio-(C₁-C₈)-alkyl, aryl-(C₁-C₈)-alkylthio-(C₁-C₈)-alkyl, (C₁-C₈)-alkylsulfinyl-(C₁-C₈)-alkyl, (C₁-C₈)-alkylsulfonyl-(C₁-C₈)-alkyl, arylsulfinyl-(C₁-C₈)-alkyl, arylsulfonyl-(C₁-C₈)-alkyl, (C₃-C₈)-cycloalkylsulfinyl-(C₁-C₈)-alkyl, (C₃-C₈)-cycloalkylsulfonyl-(C₁-C₈)-alkyl, (C₁-C₈)-alkoxy-(C₁-C₈)-alkoxy-(C₁-C₈)-alkyl, (C₁-C₈)-alkylcarbonyl, (C₁-C₈)-haloalkylcarbonyl, (C₃-C₈)-cycloalkylcarbonyl, hydroxycarbonyl, (C₁-C₈)-alkoxycarbonyl, (C₂-C₈)-alkenyloxycarbonyl, (C₂-C₈)-alkynyloxycarbonyl, aryl-(C₁-C₈)-alkoxycarbonyl, (C₃-C₈)-cycloalkyl-(C₁-C₈)-alkoxycarbonyl, arylcarbonyl, heteroarylcarbonyl, heterocyclylcarbonyl, aryl-(C₁-C₈)-alkylcarbonyl, (C₁-C₈)-alkylaminocarbonyl, (C₃-C₈)-cycloalkylaminocarbonyl, arylaminocarbonyl, aryl-(C₁-C₈)-alkylaminocarbonyl, heteroarylaminocarbonyl, heterocyclylaminocarbonyl, heteroaryl-(C₁-C₈)-alkylaminocarbonyl, heterocyclyl-(C₁-C₈)-alkylaminocarbonyl, (C₁-C₈)-alkylsulfonyl, (C₃-C₈)-cycloalkylsulfonyl, arylsulfonyl, aryl-(C₁-C₈)-alkylsulfonyl, heteroarylsulfonyl, heterocyclylsulfonyl, cyano-(C₁-C₈)-alkyl, (C₄-C₈)-cycloalkenyl-(C₁-C₈)-alkyl, nitro-(C₁-C₈)-alkyl, (C₁-C₈)-haloalkoxy-(C₁-C₈)-alkyl, (C₁-C₈)-haloalkylthio-(C₁-C₈)-alkyl, bis-[(C₁-C₈)-alkyl]aminocarbonyl, (C₃-C₈)-cycloalkyl-[(C₁-C₈)-alkyl]aminocarbonyl, aryl-[(C₁-C₈)-alkyl]aminocarbonyl, aryl-(C₁-C₈)-alkyl-[(C₁-C₈)-alkyl]aminocarbonyl, (C₂-C₈)-alkenylaminocarbonyl, (C₂-C₈)-alkynylaminocarbonyl, (C₁-C₈)-alkylaminosulfonyl, bis-[(C₁-C₈)-alkyl]aminosulfonyl, heterocyclylsulfinyl-(C₁-C₈)-alkyl, heteroarylsulfinyl-(C₁-C₈)-alkyl, aryl-(C₁-C₈)-alkylsulfinyl-(C₁-C₈)-alkyl, heterocyclylsulfonyl-(C₁-C₈)-alkyl, heteroarylsulfonyl-(C₁-C₈)-alkyl, aryl-(C₁-C₈)-alkylsulfonyl-(C₁-C₈)-alkyl, bis-[(C₁-C₈)-alkyl]aminocarbonyl-(C₁-C₈)-alkyl, (C₃-C₈)-cycloalkyl-[(C₁-C₈)-alkyl]aminocarbonyl-(C₁-C₈)-alkyl, aryl-[(C₁-C₈)-alkyl]aminocarbonyl-(C₁-C₈)-alkyl, aryl-(C₁-C₈)-alkyl-[(C₁-C₈)-alkyl]aminocarbonyl-(C₁-C₈)-alkyl, (C₂-C₈)-alkenylaminocarbonyl-(C₁-C₈)-alkyl, (C₂-C₈)-alkynylaminocarbonyl-(C₁-C₈)-alkyl, (C₁-C₈)-alkylamino, bis-[(C₁-C₈)-alkyl]amino, (C₃-C₈)-cycloalkyl[(C₁-C₈)-alkyl]amino, amino, (C₂-C₈)-alkenylamino, (C₂-C₈)-alkynylamino, arylamino, heteroarylamino, aryl-(C₁-C₈)-alkylamino, heteroaryl-(C₁-C₈)-alkylamino, heterocyclylamino, heterocyclyl-(C₁-C₈)-alkylamino, (C₂-C₈)-alkenylcarbonyl-(C₁-C₈)-alkyl, (C₂-C₈)-alkynylcarbonyl-(C₁-C₈)-alkyl, (C₃-C₈)-cycloalkyl-(C₁-C₈)-alkylaminocarbonyl-(C₁-C₈)-alkyl, (C₃-C₈)-cycloalkyl-(C₁-C₈)-alkyl-[(C₁-C₈)-alkyl]aminocarbonyl-(C₁-C₈)-alkyl, (C₂-C₈)-alkenylsulfonyl-(C₁-C₈)-alkyl, (C₂-C₈)-alkynylsulfonyl-(C₁-C₈)-alkyl, heteroaryl-(C₁-C₈)-alkylsulfonyl-(C₁-C₈)-alkyl, heterocyclyl-(C₁-C₈)-alkylsulfonyl-(C₁-C₈)-alkyl, (C₂-C₈)-alkenylsulfinyl-(C₁-C₈)-alkyl, (C₂-C₈)-alkynylsulfinyl-(C₁-C₈)-alkyl, heteroaryl-(C₁-C₈)-alkylsulfinyl-(C₁-C₈)-alkyl, heterocyclyl-(C₁-C₈)-alkylsulfinyl-(C₁-C₈)-alkyl, (C₂-C₈)-alkenyloxy-(C₁-C₈)-alkoxy-(C₁-C₈)-alkyl, (C₂-C₈)-alkynyloxy-(C₁-C₈)-alkoxy-(C₁-C₈)-alkyl, heteroaryl-(C₁-C₈)-alkoxy-(C₁-C₈)-alkyl, heterocyclyl-(C₁-C₈)-alkoxy-(C₁-C₈)-alkyl, tris[(C₁-C₈)-alkyl]silyl, tris[(C₁-C₈)-alkyl]silyl-(C₁-C₈)-alkyl, (C₁-C₈)-alkoxy, (C₁-C₈)-haloalkoxy, (C₁-C₈)-alkylamino-(C₁-C₈)-alkyl, bis-[(C₁-C₈)-alkyl]amino-(C₁-C₈)-alkyl, (C₃-C₈)-cycloalkyl[(C₁-C₈)-alkyl]amino-(C₁-C₈)-alkyl, amino-(C₁-C₈)-alkyl, (C₂-C₈)-alkenylamino-(C₁-C₈)-alkyl, (C₂-C₈)-alkynylamino-(C₁-C₈)-alkyl, arylamino-(C₁-C₈)-alkyl, heteroarylamino-(C₁-C₈)-alkyl, aryl-(C₁-C₈)-alkylamino-(C₁-C₈)-alkyl, heteroaryl-(C₁-C₈)-alkylamino-(C₁-C₈)-alkyl, heterocyclylamino-(C₁-C₈)-alkyl, heterocyclyl-(C₁-C₈)-alkylamino-(C₁-C₈)-alkyl, (C₁-C₈)-haloalkoxy-(C₁-C₆)-haloalkyl, (C₂-C₈)-alkenyloxy-(C₁-C₆)-haloalkyl, (C₂-C₈)-alkynyloxy-(C₁-C₆)-haloalkyl, (C₁-C₈)-alkoxy-(C₁-C₈)-alkoxy-(C₁-C₆)-haloalkyl, (C₃-C₈)-cycloalkyl-(C₁-C₈)-alkoxy-(C₁-C₆)-haloalkyl, (C₃-C₈)-cycloalkyl-(C₁-C₈)-alkoxy-(C₁-C₈)-alkyl, (C₁-C₈)-alkoxy-(C₁-C₈)-alkoxy, (C₁-C₈)-alkoxycarbonyl-(C₃-C₈)-cycloalkyl,
R², R³, R⁴ are each independently hydrogen, halogen, (C₁-C₈)-alkoxy, (C₁-C₈)-alkyl, (C₁-C₈)-haloalkyl, (C₁-C₈)-haloalkoxy, (C₁-C₈)-alkylthio, (C₁-C₈)-haloalkylthio, aryl, aryl-(C₁-C₈)-alkyl, heteroaryl, heteroaryl-(C₁-C₈)-alkyl, heterocyclyl, heterocyclyl-(C₁-C₈)-alkyl, (C₃-C₈)-cycloalkyl, nitro, amino, hydroxyl, (C₁-C₈)-alkylamino, bis-[(C₁-C₈)-alkyl]amino, hydrothio, (C₁-C₈)-alkylcarbonylamino, (C₃-C₈)-cycloalkylcarbonylamino, arylcarbonylamino, heteroarylcarbonylamino, heterocyclylcarbonylamino, formyl, hydroxyiminomethyl, (C₁-C₈)-alkoxyiminomethyl, (C₃-C₈)-cycloalkoxyiminomethyl, aryloxyiminomethyl, (C₃-C₈)-cycloalkyl-(C₁-C₈)-alkoxyiminomethyl, thiocyanato, isothiocyanato, aryloxy, heteroaryloxy, (C₃-C₈)-cycloalkoxy, (C₃-C₈)-cycloalkyl-(C₁-C₈)-alkoxy, aryl-(C₁-C₈)-alkoxy, (C₂-C₈)-alkynyl, (C₂-C₈)-alkenyl, aryl-(C₁-C₈)-alkynyl, tris-[(C₁-C₈)-alkyl]silyl-(C₂-C₈)-alkynyl, bis-[(C₁-C₈)-alkyl](aryl)silyl-(C₂-C₈)-alkynyl, bis-aryl[(C₁-C₈)-alkyl]silyl-(C₂-C₈)-alkynyl, (C₃-C₈)-cycloalkyl-(C₂-C₈)-alkynyl, aryl-(C₂-C₈)-alkenyl, heteroaryl-(C₂-C₈)-alkenyl, (C₃-C₈)-cycloalkyl-(C₂-C₈)-alkenyl, (C₃-C₈)-cycloalkyl-(C₂-C₈)-alkyl, (C₂-C₈)-haloalkynyl, (C₂-C₈)-haloalkenyl, (C₄-C₈)-cycloalkenyl, (C₁-C₈)-alkoxy-(C₁-C₈)-alkoxy-(C₁-C₈)-alkyl, (C₁-C₈)-alkylsulfonyl, arylsulfonyl, heteroarylsulfonyl, (C₁-C₈)-alkylsulfonylamino, arylsulfonylamino, aryl-(C₁-C₈)-alkylsulfonylamino, heteroarylsulfonylamino, heteroaryl-(C₁-C₈)-alkylsulfonylamino, bis-[(C₁-C₈)-alkyl]aminosulfonyl, (C₄-C₈)-cycloalkenyl-(C₁-C₈)-alkyl, (C₁-C₈)-alkylsulfinyl, arylsulfinyl, heteroarylsulfinyl, (C₁-C₈)-haloalkylsulfinyl, (C₁-C₈)-haloalkylsulfonyl, aryl-(C₁-C₈)-alkylsulfonyl, heteroaryl-(C₁-C₈)-alkylsulfonyl, (C₁-C₈)-alkylaminosulfonyl, (C₁-C₈)-alkylaminosulfonylamino, bis-[(C₁-C₈)-alkyl]aminosulfonyl, (C₃-C₈)-cycloalkylaminosulfonylamino, (C₁-C₈)-alkoxycarbonyl, (C₂-C₈)-alkenyloxycarbonyl, (C₂-C₈)-alkynyloxycarbonyl, (C₃-C₈)-cycloalkyloxycarbonyl, aryl-(C₁-C₈)-alkoxycarbonyl, (C₁-C₈)-alkylaminocarbonyl, (C₃-C₈)-cycloalkylaminocarbonyl, aryl-(C₁-C₈)-alkylaminocarbonyl,
R⁵ is amino, (C₁-C₈)-alkyl, (C₃-C₈)-cycloalkyl, (C₃-C₈)-cycloalkyl-(C₁-C₈)-alkyl, (C₁-C₈)-haloalkyl, (C₃-C₈)-halocycloalkyl, (C₄-C₈)-cycloalkenyl, aryl, heteroaryl, heterocyclyl, aryl-(C₁-C₈)-alkyl, heteroaryl-(C₁-C₈)-alkyl, heterocyclyl-(C₁-C₈)-alkyl, (C₁-C₈)-alkoxycarbonyl-(C₁-C₈)-alkyl, aryl-(C₁-C₈)-alkoxycarbonyl-(C₁-C₈)-alkyl, (C₃-C₈)-cycloalkoxycarbonyl-(C₁-C₈)-alkyl, (C₃-C₈)-cycloalkyl-(C₁-C₈)-alkoxycarbonyl-(C₁-C₈)-alkyl, heteroaryl-(C₁-C₈)-alkoxycarbonyl-(C₁-C₈)-alkyl, aminocarbonyl-(C₁-C₈)-alkyl, (C₁-C₈)-alkylaminocarbonyl-(C₁-C₈)-alkyl, (C₃-C₈)-cycloalkylaminocarbonyl-(C₁-C₈)-alkyl, aryl-(C₁-C₈)-alkylaminocarbonyl-(C₁-C₈)-alkyl, (C₁-C₈)-alkylamino, arylamino, (C₃-C₈)-cycloalkylamino, aryl-(C₁-C₈)-alkylamino, heteroaryl-(C₁-C₈)-alkylamino, heteroarylamino, heterocyclylamino, aryloxy-(C₁-C₈)-alkyl, (C₁-C₈)-alkoxy-(C₁-C₈)-alkyl, heteroaryloxy-(C₁-C₈)-alkyl, (C₂-C₈)-alkenyl, (C₂-C₈)-alkynyl, (C₂-C₈)-alkenylamino, (C₂-C₈)-alkynylamino, bis-[(C₁-C₈)-alkenyl]amino, aryloxy, bis-[(C₁-C₈)-alkyl]amino, aryl-(C₂-C₈)-alkenyl, heteroaryl-(C₂-C₈)-alkenyl, heterocyclyl-(C₂-C₈)-alkenyl, aryloxycarbonyl-(C₁-C₈)-alkyl, heteroaryloxycarbonyl-(C₁-C₈)-alkyl, bis[(C₁-C₈)-alkyl]aminocarbonyl-(C₁-C₈)-alkyl, (C₁-C₈)-alkylthio-(C₁-C₈)-alkyl, cyano-(C₁-C₈)-alkyl, (C₁-C₈)-alkoxy-(C₁-C₈)-alkoxy-(C₁-C₈)-alkyl, (C₁-C₈)-alkylsulfonylamino-(C₁-C₈)-alkyl, (C₃-C₈)-cycloalkylsulfonylamino-(C₁-C₈)-alkyl, arylsulfonylamino-(C₁-C₈)-alkyl, heteroarylsulfonylamino-(C₁-C₈)-alkyl, heterocyclylsulfonylamino-(C₁-C₈)-alkyl, bis-[(C₁-C₈)-alkyl]aminosulfonyl-(C₁-C₈)-alkyl,
R⁶ is hydrogen, (C₁-C₈)-alkyl, (C₃-C₈)-cycloalkyl, cyano-(C₁-C₈)-alkyl, (C₃-C₈)-cycloalkyl-(C₁-C₈)-alkyl, (C₁-C₈)-alkylsulfonyl, arylsulfonyl, heteroarylsulfonyl, (C₃-C₈)-cycloalkylsulfonyl, heterocyclylsulfonyl, aryl-(C₁-C₈)-alkylsulfonyl, (C₁-C₈)-alkylcarbonyl, arylcarbonyl, heteroarylcarbonyl, (C₃-C₈)-cycloalkylcarbonyl, heterocyclylcarbonyl, (C₁-C₈)-alkoxycarbonyl, aryl-(C₁-C₈)-alkoxycarbonyl, (C₁-C₈)-haloalkylcarbonyl, (C₂-C₈)-alkenyl, (C₂-C₈)-alkynyl, (C₁-C₈)-haloalkyl, halo-(C₂-C₈)-alkynyl, halo-(C₂-C₈)-alkenyl, (C₁-C₈)-alkoxy-(C₁-C₈)-alkyl, amino, (C₁-C₈)-alkoxy-(C₁-C₈)-alkoxy-(C₁-C₈)-alkyl, heteroaryl-(C₁-C₈)-alkylsulfonyl, heterocyclyl-(C₁-C₈)-alkylsulfonyl, (C₄-C₆)-cycloalkenyl, (C₄-C₈)-cycloalkenyl-(C₁-C₈)-alkyl, (C₂-C₈)-alkenyloxycarbonyl, (C₂-C₈)-alkynyloxycarbonyl, (C₁-C₈)-alkylaminocarbonyl, (C₃-C₈)-cycloalkylaminocarbonyl, bis-[(C₁-C₈)-alkyl]aminocarbonyl,
R⁷, R⁸ are each independently hydrogen, (C₁-C₈)-alkyl, halogen, cyano, nitro, hydroxyl, amino, hydrothio, (C₁-C₈)-alkylamino, bis[(C₁-C₈)-alkyl]amino, (C₃-C₈)-cycloalkylamino, aryl-(C₁-C₈)-alkylamino, heteroaryl-(C₁-C₈)-alkylamino, (C₂-C₈)-alkenyl, (C₂-C₈)-alkynyl, (C₁-C₈)-haloalkyl, hydroxy-(C₁-C₈)-alkyl, cyano-(C₁-C₈)-alkyl, nitro-(C₁-C₈)-alkyl, aryl, heteroaryl, (C₃-C₈)-cycloalkyl, (C₄-C₈)-cycloalkenyl, heterocyclyl, (C₁-C₈)-alkoxy, (C₁-C₈)-haloalkoxy, (C₁-C₈)-haloalkylthio, (C₁-C₈)-alkylthio, (C₁-C₈)-alkoxy-(C₁-C₈)-alkyl, (C₁-C₈)-alkylthio-(C₁-C₈)-alkyl, amino-(C₁-C₈)-alkyl, (C₁-C₈)-alkylamino-(C₁-C₈)-alkyl, (C₃-C₈)-cycloalkylamino-(C₁-C₈)-alkyl, aryl-(C₁-C₈)-alkylamino-(C₁-C₈)-alkyl, heteroaryl-(C₁-C₈)-alkylamino-(C₁-C₈)-alkyl, heterocyclyl-(C₁-C₈)-alkylamino-(C₁-C₈)-alkyl, heterocyclylamino-(C₁-C₈)-alkyl, heteroarylamino-(C₁-C₈)-alkyl, (C₁-C₈)-alkoxycarbonylamino-(C₁-C₈)-alkyl, arylamino-(C₁-C₈)-alkyl, aryl-(C₁-C₈)-alkoxycarbonylamino-(C₁-C₈)-alkyl, (C₃-C₈)-cycloalkoxycarbonylamino-(C₁-C₈)-alkyl, (C₃-C₈)-cycloalkyl-(C₁-C₈)-alkoxycarbonylamino-(C₁-C₈)-alkyl, heteroaryl-(C₁-C₈)-alkoxycarbonylamino-(C₁-C₈)-alkyl, (C₁-C₈)-alkylcarbonylamino-(C₁-C₈)-alkyl, (C₃-C₈)-cycloalkylcarbonylamino-(C₁-C₈)-alkyl, arylcarbonylamino-(C₁-C₈)-alkyl, heteroarylcarbonylamino-(C₁-C₈)-alkyl, heterocyclylcarbonylamino-(C₁-C₈)-alkyl, (C₂-C₈)-alkenyloxycarbonylamino-(C₁-C₈)-alkyl, aryl-(C₂-C₈)-alkenylamino-(C₁-C₈)-alkyl, hydroxycarbonyl, (C₁-C₈)-alkoxycarbonyl, (C₂-C₈)-alkenyloxycarbonyl, aryl-(C₁-C₈)-alkoxycarbonyl, aminocarbonyl, alkylaminocarbonyl, (C₃-C₈)-cycloalkylaminocarbonyl, aryl-(C₁-C₈)-alkylaminocarbonyl, heteroarylaminocarbonyl, arylamino, heteroarylamino, heterocyclylamino, (C₂-C₈)-alkenylamino, (C₂-C₈)-alkynylamino, (C₁-C₈)-alkylsulfinyl, (C₂-C₈)-alkenylsulfinyl, arylsulfinyl, heteroarylsulfinyl, heterocyclylsulfinyl, (C₃-C₈)-cycloalkylsulfinyl, (C₁-C₈)-alkylsulfonyl, (C₂-C₈)-alkenylsulfonyl, arylsulfonyl, heteroarylsulfonyl, heterocyclylsulfonyl, (C₃-C₈)-cycloalkylsulfonyl, bis-[(C₁-C₈)-alkyl]amino-(C₁-C₈)-alkyl, (C₁-C₈)-alkyl(aryl)amino-(C₁-C₈)-alkyl, heteroaryloxycarbonylamino-(C₁-C₈)-alkyl, heterocyclyloxycarbonylamino-(C₁-C₈)-alkyl, aryl-(C₁-C₈)-alkoxycarbonylamino-(C₁-C₈)-alkyl, arylaminocarbonyl, (C₁-C₈)-alkylsulfonylamino-(C₁-C₈)-alkyl, (C₃-C₈)-cycloalkylsulfonylamino-(C₁-C₈)-alkyl, arylsulfonylamino-(C₁-C₈)-alkyl, heteroarylsulfonylamino-(C₁-C₈)-alkyl, heterocyclylsulfonylamino-(C₁-C₈)-alkyl, bis-[(C₁-C₈)-alkyl]aminosulfonyl-(C₁-C₈)-alkyl, (C₁-C₈)-alkylsulfonylamino, (C₃-C₈)-cycloalkylsulfonylamino, arylsulfonylamino, heteroarylsulfonylamino, heterocyclylsulfonylamino, (C₁-C₈)-alkoxy-(C₁-C₈)-alkoxy or
R⁷ and R⁸ together with the carbon atom to which they are bonded form a fully saturated or partly saturated 3- to 10-membered monocyclic or bicyclic ring optionally interrupted by heteroatoms and optionally having further substitution or
R⁷ and R⁸ together with the carbon atom to which they are bonded form an oxo group or
R⁷ and R⁸ together with the carbon atom to which they are bonded form an oxime group substituted by hydrogen, (C₁-C₈)-alkyl, (C₃-C₈)-cycloalkyl, (C₃-C₈)-cycloalkyl-(C₁-C₈)-alkyl, aryl, heteroaryl, aryl-(C₁-C₈)-alkyl, heteroaryl-(C₁-C₈)-alkyl,
R⁹, R¹⁰ are each independently hydrogen, (C₁-C₈)-alkyl, halogen, cyano, (C₁-C₈)-haloalkyl, cyano-(C₁-C₈)-alkyl, aryl, heteroaryl, (C₃-C₈)-cycloalkyl, (C₄-C₈)-cycloalkenyl, heterocyclyl, (C₁-C₈)-alkoxy-(C₁-C₈)-alkyl, (C₁-C₈)-alkylthio-(C₁-C₈)-alkyl,
W is oxygen or sulfur,
X, Y are each independently hydrogen, (C₁-C₈)-alkyl, halogen, (C₂-C₈)-alkenyl, (C₂-C₈)-alkynyl, (C₁-C₈)-haloalkyl, hydroxy-(C₁-C₈)-alkyl, cyano-(C₁-C₈)-alkyl, aryl, heteroaryl, (C₃-C₈)-cycloalkyl, (C₄-C₈)-cycloalkenyl, heterocyclyl, cyano, nitro, hydroxyl, (C₁-C₈)-alkoxy, (C₁-C₈)-alkylthio, (C₁-C₈)-alkoxy-(C₁-C₈)-alkyl, (C₁-C₈)-alkylthio-(C₁-C₈)-alkyl, aryloxy, aryl-(C₁-C₈)-alkoxy, (C₁-C₈)-haloalkoxy, (C₁-C₈)-haloalkylthio, (C₁-C₈)-alkylamino, bis-[(C₁-C₈)-alkyl]amino, (C₁-C₈)-alkoxy-(C₁-C₈)-alkoxy, amino-(C₁-C₈)-alkyl, (C₁-C₈)-alkylamino-(C₁-C₈)-alkyl, (C₃-C₈)-cycloalkylamino-(C₁-C₈)-alkyl, aryl-(C₁-C₈)-alkylamino-(C₁-C₈)-alkyl, heteroaryl-(C₁-C₈)-alkylamino-(C₁-C₈)-alkyl, heterocyclyl-(C₁-C₈)-alkylamino-(C₁-C₈)-alkyl, heterocyclylamino-(C₁-C₈)-alkyl, heteroarylamino-(C₁-C₈)-alkyl, (C₁-C₈)-alkoxycarbonylamino-(C₁-C₈)-alkyl, arylamino-(C₁-C₈)-alkyl, aryl-(C₁-C₈)-alkoxycarbonylamino-(C₁-C₈)-alkyl, (C₃-C₈)-cycloalkoxycarbonylamino-(C₁-C₈)-alkyl, (C₃-C₈)-cycloalkyl-(C₁-C₈)-alkoxycarbonylamino-(C₁-C₈)-alkyl, heteroaryl-(C₁-C₈)-alkoxycarbonylamino-(C₁-C₈)-alkyl, (C₁-C₈)-alkylcarbonylamino-(C₁-C₈)-alkyl, (C₃-C₈)-cycloalkylcarbonylamino-(C₁-C₈)-alkyl, arylcarbonylamino-(C₁-C₈)-alkyl, heteroarylcarbonylamino-(C₁-C₈)-alkyl, heterocyclylcarbonylamino-(C₁-C₈)-alkyl, (C₂-C₈)-alkenyloxycarbonylamino-(C₁-C₈)-alkyl, aryl-(C₂-C₈)-alkenylamino-(C₁-C₈)-alkyl, arylsulfonyl-(C₁-C₈)-alkyl, heteroarylsulfonyl-(C₁-C₈)-alkyl, (C₁-C₈)-alkylsulfonyl-(C₁-C₈)-alkyl, (C₃-C₈)-cycloalkylsulfonyl-(C₁-C₈)-alkyl, arylsulfinyl-(C₁-C₈)-alkyl, heteroarylsulfinyl-(C₁-C₈)-alkyl, (C₁-C₈)-alkylsulfinyl-(C₁-C₈)-alkyl, (C₃-C₈)-cycloalkylsulfinyl-(C₁-C₈)-alkyl, bis[(C₁-C₈)-alkyl]amino-(C₁-C₈)-alkyl, (C₁-C₈)-alkoxycarbonyl, aryl-(C₁-C₈)-alkoxycarbonyl, heteroaryl-(C₁-C₈)-alkoxycarbonyl, (C₃-C₈)-cycloalkoxycarbonyl, (C₃-C₈)-cycloalkyl-(C₁-C₈)-alkoxycarbonyl, (C₁-C₈)-alkylcarbonyl, (C₃-C₈)-cycloalkylcarbonyl, arylcarbonyl, heteroarylcarbonyl, heterocyclylcarbonyl, (C₁-C₈)-alkylsulfonylamino-(C₁-C₈)-alkyl, (C₃-C₈)-cycloalkylsulfonylamino-(C₁-C₈)-alkyl, arylsulfonylamino-(C₁-C₈)-alkyl, heteroarylsulfonylamino-(C₁-C₈)-alkyl, heterocyclylsulfonylamino-(C₁-C₈)-alkyl, bis-[(C₁-C₈)-alkyl]aminosulfonyl-(C₁-C₈)-alkyl, (C₁-C₈)-alkylsulfonylamino, (C₃-C₈)-cycloalkylsulfonylamino, arylsulfonylamino, heteroarylsulfonylamino, heterocyclylsulfonylamino, heteroaryloxycarbonylamino-(C₁-C₈)-alkyl, heterocyclyloxycarbonylamino-(C₁-C₈)-alkyl or
X and Y together with the carbon atom to which they are bonded form a fully saturated or partly saturated 3- to 10-membered monocyclic or bicyclic ring optionally interrupted by heteroatoms and optionally having further substitution.

The compounds of the general formula (I) can form salts by addition of a suitable inorganic or organic acid, for example mineral acids, for example HCl, HBr, H₂SO₄, H₃PO₄ or HNO₃, or organic acids, for example carboxylic acids such as formic acid, acetic acid, propionic acid, oxalic acid, lactic acid or salicylic acid or sulfonic acids, for example p-toluenesulfonic acid, onto a basic group, for example amino, alkylamino, dialkylamino, piperidino, morpholino or pyridino. These salts then contain the conjugate base of the acid as anion. Suitable substituents in deprotonated form, for example sulfonic acids, particular sulfonamides or carboxylic acids, are capable of forming internal salts with groups, such as amino groups, which are themselves protonatable. Salts may also be formed by action of a base on compounds of the general formula (I). Examples of suitable bases are organic amines such as trialkylamines, morpholine, piperidine and pyridine, and the hydroxides, carbonates and hydrogencarbonates of ammonium, alkali metals or alkaline earth metals, especially sodium hydroxide, potassium hydroxide, sodium carbonate, potassium carbonate, sodium hydrogencarbonate and potassium hydrogencarbonate. These salts are compounds in which the acidic hydrogen is replaced by an agriculturally suitable cation, for example metal salts, especially alkali metal salts or alkaline earth metal salts, in particular sodium and potassium salts, or else ammonium salts, salts with organic amines or quaternary ammonium salts, for example with cations of the formula [NR^{a}R^{b}R^{c}R^{d}]⁺ in which R^{a} to R^{d} are each independently an organic radical, especially alkyl, aryl, aralkyl or alkylaryl. Also suitable are alkylsulfonium and alkylsulfoxonium salts, such as (C₁-C₄)-trialkylsulfonium and (C₁-C₄)-trialkylsulfoxonium salts.

The compounds of the formula (I) used in accordance with the invention and salts thereof are referred to hereinafter as “compounds of the general formula (I)”.

Preference is given to the inventive use of compounds of the general formula (I) in which
R¹ is halogen, cyano, (C₃-C₁₀)-cycloalkyl, (C₃-C₁₀)-halocycloalkyl, (C₄-C₁₀)-cycloalkenyl, (C₄-C₁₀)-halocycloalkenyl, (C₁-C₁₀)-haloalkyl, (C₂-C₇)-haloalkenyl, (C₁-C₇)-alkoxy-(C₁-C₇)-haloalkyl, aryl, aryl-(C₁-C₇)-alkyl, heteroaryl, heteroaryl-(C₁-C₇)-alkyl, (C₃-C₇)-cycloalkyl-(C₁-C₇)-alkyl, (C₂-C₇)-haloalkynyl, heterocyclyl, heterocyclyl-(C₁-C₇)-alkyl, (C₁-C₇)-alkoxy-(C₁-C₇)-alkyl, (C₁-C₇)-alkylcarbonyl-(C₁-C₇)-alkyl, hydroxycarbonyl-(C₁-C₇)-alkyl, (C₁-C₇)-alkoxycarbonyl-(C₁-C₇)-alkyl, (C₂-C₇)-alkenyloxycarbonyl-(C₁-C₇)-alkyl, (C₂-C₇)-alkynyloxycarbonyl-(C₁-C₇)-alkyl, aryl-(C₁-C₇)-alkoxycarbonyl-(C₁-C₇)-alkyl, (C₃-C₇)-cycloalkoxycarbonyl-(C₁-C₇)-alkyl, (C₃-C₇)-cycloalkyl-(C₁-C₇)-alkoxycarbonyl-(C₁-C₇)-alkyl, aminocarbonyl-(C₁-C₇)-alkyl, (C₁-C₇)-alkylaminocarbonyl-(C₁-C₇)-alkyl, (C₃-C₇)-cycloalkylaminocarbonyl-(C₁-C₇)-alkyl, aryl-(C₁-C₇)-alkylaminocarbonyl-(C₁-C₇)-alkyl, heteroaryl-(C₁-C₇)-alkylaminocarbonyl-(C₁-C₇)-alkyl, (C₁-C₇)-alkylthio-(C₁-C₇)-alkyl, (C₃-C₇)-cycloalkylthio-(C₁-C₇)-alkyl, arylthio-(C₁-C₇)-alkyl, heterocyclylthio-(C₁-C₇)-alkyl, heteroarylthio-(C₁-C₇)-alkyl, aryl-(C₁-C₇)-alkylthio-(C₁-C₇)-alkyl, (C₁-C₇)-alkylsulfinyl-(C₁-C₇)-alkyl, (C₁-C₇)-alkylsulfonyl-(C₁-C₇)-alkyl, arylsulfinyl-(C₁-C₇)-alkyl, arylsulfonyl-(C₁-C₇)-alkyl, (C₃-C₇)-cycloalkylsulfinyl-(C₁-C₇)-alkyl, (C₃-C₇)-cycloalkylsulfonyl-(C₁-C₇)-alkyl, (C₁-C₇)-alkoxy-(C₁-C₇)-alkoxy-(C₁-C₇)-alkyl, (C₁-C₇)-alkylcarbonyl, (C₁-C₇)-haloalkylcarbonyl, (C₃-C₇)-cycloalkylcarbonyl, hydroxycarbonyl, (C₁-C₇)-alkoxycarbonyl, (C₂-C₇)-alkenyloxycarbonyl, (C₂-C₇)-alkynyloxycarbonyl, aryl-(C₁-C₇)-alkoxycarbonyl, (C₃-C₇)-cycloalkyl-(C₁-C₇)-alkoxycarbonyl, arylcarbonyl, heteroarylcarbonyl, heterocyclylcarbonyl, aryl-(C₁-C₇)-alkylcarbonyl, (C₁-C₇)-alkylaminocarbonyl, (C₃-C₇)-cycloalkylaminocarbonyl, arylaminocarbonyl, aryl-(C₁-C₇)-alkylaminocarbonyl, heteroarylaminocarbonyl, heterocyclylaminocarbonyl, heteroaryl-(C₁-C₇)-alkylaminocarbonyl, heterocyclyl-(C₁-C₇)-alkylaminocarbonyl, (C₁-C₇)-alkylsulfonyl, (C₃-C₇)-cycloalkylsulfonyl, arylsulfonyl, aryl-(C₁-C₇)-alkylsulfonyl, heteroarylsulfonyl, heterocyclylsulfonyl, cyano-(C₁-C₇)-alkyl, (C₄-C₇)-cycloalkenyl-(C₁-C₇)-alkyl, nitro-(C₁-C₇)-alkyl, (C₁-C₇)-haloalkoxy-(C₁-C₇)-alkyl, (C₁-C₇)-haloalkylthio-(C₁-C₇)-alkyl, bis-[(C₁-C₇)-alkyl]aminocarbonyl, (C₃-C₇)-cycloalkyl-[(C₁-C₇)-alkyl]aminocarbonyl, aryl-[(C₁-C₇)-alkyl]aminocarbonyl, aryl-(C₁-C₇)-alkyl-[(C₁-C₇)-alkyl]aminocarbonyl, (C₂-C₇)-alkenylaminocarbonyl, (C₂-C₇)-alkynylaminocarbonyl, (C₁-C₇)-alkylaminosulfonyl, bis-[(C₁-C₇)-alkyl]aminosulfonyl, heterocyclylsulfinyl-(C₁-C₇)-alkyl, heteroarylsulfinyl-(C₁-C₇)-alkyl, aryl-(C₁-C₇)-alkylsulfinyl-(C₁-C₇)-alkyl, heterocyclylsulfonyl-(C₁-C₇)-alkyl, heteroarylsulfonyl-(C₁-C₇)-alkyl, aryl-(C₁-C₇)-alkylsulfonyl-(C₁-C₇)-alkyl, bis-[(C₁-C₇)-alkyl]aminocarbonyl-(C₁-C₇)-alkyl, (C₃-C₇)-cycloalkyl-[(C₁-C₇)-alkyl]aminocarbonyl-(C₁-C₇)-alkyl, aryl-[(C₁-C₇)-alkyl]aminocarbonyl-(C₁-C₇)-alkyl, aryl-(C₁-C₇)-alkyl-[(C₁-C₇)-alkyl]aminocarbonyl-(C₁-C₇)-alkyl, (C₂-C₇)-alkenylaminocarbonyl-(C₁-C₇)-alkyl, (C₂-C₇)-alkynylaminocarbonyl-(C₁-C₇)-alkyl, (C₁-C₇)-alkylamino, bis-[(C₁-C₇)-alkyl]amino, (C₃-C₇)-cycloalkyl[(C₁-C₇)-alkyl]amino, amino, (C₂-C₇)-alkenylamino, (C₂-C₇)-alkynylamino, arylamino, heteroarylamino, aryl-(C₁-C₇)-alkylamino, heteroaryl-(C₁-C₇)-alkylamino, heterocyclylamino, heterocyclyl-(C₁-C₇)-alkylamino, (C₂-C₇)-alkenylcarbonyl-(C₁-C₇)-alkyl, (C₂-C₇)-alkynylcarbonyl-(C₁-C₇)-alkyl, (C₃-C₇)-cycloalkyl-(C₁-C₇)-alkylaminocarbonyl-(C₁-C₇)-alkyl, (C₃-C₇)-cycloalkyl-(C₁-C₇)-alkyl-[(C₁-C₇)-alkyl]aminocarbonyl-(C₁-C₇)-alkyl, (C₂-C₇)-alkenylsulfonyl-(C₁-C₇)-alkyl, (C₂-C₇)-alkynylsulfonyl-(C₁-C₇)-alkyl, heteroaryl-(C₁-C₇)-alkylsulfonyl-(C₁-C₇)-alkyl, heterocyclyl-(C₁-C₇)-alkylsulfonyl-(C₁-C₇)-alkyl, (C₂-C₇)-alkenylsulfinyl-(C₁-C₇)-alkyl, (C₂-C₇)-alkynylsulfinyl-(C₁-C₇)-alkyl, heteroaryl-(C₁-C₇)-alkylsulfinyl-(C₁-C₇)-alkyl, heterocyclyl-(C₁-C₇)-alkylsulfinyl-(C₁-C₇)-alkyl, (C₂-C₇)-alkenyloxy-(C₁-C₇)-alkoxy-(C₁-C₇)-alkyl, (C₂-C₇)-alkynyloxy-(C₁-C₇)-alkoxy-(C₁-C₇)-alkyl, heteroaryl-(C₁-C₇)-alkoxy-(C₁-C₇)-alkyl, heterocyclyl-(C₁-C₇)-alkoxy-(C₁-C₇)-alkyl, tris[(C₁-C₇)-alkyl]silyl, tris[(C₁-C₇)-alkyl]silyl-(C₁-C₇)-alkyl, (C₁-C₇)-alkoxy, (C₁-C₇)-haloalkoxy, (C₁-C₇)-alkylamino-(C₁-C₇)-alkyl, bis-[(C₁-C₇)-alkyl]amino-(C₁-C₇)-alkyl, (C₃-C₇)-cycloalkyl[(C₁-C₇)-alkyl]amino-(C₁-C₇)-alkyl, amino-(C₁-C₇)-alkyl, (C₂-C₇)-alkenylamino-(C₁-C₇)-alkyl, (C₂-C₇)-alkynylamino-(C₁-C₇)-alkyl, arylamino-(C₁-C₇)-alkyl, heteroarylamino-(C₁-C₇)-alkyl, aryl-(C₁-C₇)-alkylamino-(C₁-C₇)-alkyl, heteroaryl-(C₁-C₇)-alkylamino-(C₁-C₇)-alkyl, heterocyclylamino-(C₁-C₇)-alkyl, heterocyclyl-(C₁-C₇)-alkylamino-(C₁-C₇)-alkyl, (C₁-C₇)-haloalkoxy-(C₁-C₆)-haloalkyl, (C₂-C₇)-alkenyloxy-(C₁-C₆)-haloalkyl, (C₂-C₇)-alkynyloxy-(C₁-C₆)-haloalkyl, (C₁-C₇)-alkoxy-(C₁-C₇)-alkoxy-(C₁-C₆)-haloalkyl, (C₃-C₇)-cycloalkyl-(C₁-C₇)-alkoxy-(C₁-C₆)-haloalkyl, (C₃-C₇)-cycloalkyl-(C₁-C₇)-alkoxy-(C₁-C₇)-alkyl, (C₁-C₇)-alkoxy-(C₁-C₇)-alkoxy, (C₁-C₇)-alkoxycarbonyl-(C₃-C₇)-cycloalkyl,
R², R³, R⁴ are each independently hydrogen, halogen, (C₁-C₇)-alkoxy, (C₁-C₇)-alkyl, (C₁-C₇)-haloalkyl, (C₁-C₇)-haloalkoxy, (C₁-C₇)-alkylthio, (C₁-C₇)-haloalkylthio, aryl, aryl-(C₁-C₇)-alkyl, heteroaryl, heteroaryl-(C₁-C₇)-alkyl, heterocyclyl, heterocyclyl-(C₁-C₇)-alkyl, (C₃-C₇)-cycloalkyl, nitro, amino, hydroxyl, (C₁-C₇)-alkylamino, bis-[(C₁-C₇)-alkyl]amino, hydrothio, (C₁-C₇)-alkylcarbonylamino, (C₃-C₇)-cycloalkylcarbonylamino, arylcarbonylamino, heteroarylcarbonylamino, heterocyclylcarbonylamino, formyl, hydroxyiminomethyl, (C₁-C₇)-alkoxyiminomethyl, (C₃-C₇)-cycloalkoxyiminomethyl, aryloxyiminomethyl, (C₃-C₇)-cycloalkyl-(C₁-C₇)-alkoxyiminomethyl, thiocyanato, isothiocyanato, aryloxy, heteroaryloxy, (C₃-C₇)-cycloalkoxy, (C₃-C₇)-cycloalkyl-(C₁-C₇)-alkoxy, aryl-(C₁-C₇)-alkoxy, (C₂-C₇)-alkynyl, (C₂-C₇)-alkenyl, aryl-(C₁-C₇)-alkynyl, tris-[(C₁-C₇)-alkyl]silyl-(C₂-C₇)-alkynyl, bis-[(C₁-C₇)-alkyl](aryl)silyl-(C₂-C₇)-alkynyl, bis-aryl[(C₁-C₇)-alkyl]silyl-(C₂-C₇)-alkynyl, (C₃-C₇)-cycloalkyl-(C₂-C₇)-alkynyl, aryl-(C₂-C₇)-alkenyl, heteroaryl-(C₂-C₇)-alkenyl, (C₃-C₇)-cycloalkyl-(C₂-C₇)-alkenyl, (C₃-C₇)-cycloalkyl-(C₂-C₇)-alkyl, (C₂-C₇)-haloalkynyl, (C₂-C₇)-haloalkenyl, (C₄-C₇)-cycloalkenyl, (C₁-C₇)-alkoxy-(C₁-C₇)-alkoxy-(C₁-C₇)-alkyl, (C₁-C₇)-alkylsulfonyl, arylsulfonyl, heteroarylsulfonyl, (C₁-C₇)-alkylsulfonylamino, arylsulfonylamino, aryl-(C₁-C₇)-alkylsulfonylamino, heteroarylsulfonylamino, heteroaryl-(C₁-C₇)-alkylsulfonylamino, bis-[(C₁-C₇)-alkyl]aminosulfonyl, (C₄-C₇)-cycloalkenyl-(C₁-C₇)-alkyl, (C₁-C₇)-alkylsulfinyl, arylsulfinyl, heteroarylsulfinyl, (C₁-C₇)-haloalkylsulfinyl, (C₁-C₇)-haloalkylsulfonyl, aryl-(C₁-C₇)-alkylsulfonyl, heteroaryl-(C₁-C₇)-alkylsulfonyl, (C₁-C₇)-alkylaminosulfonyl, (C₁-C₇)-alkylaminosulfonylamino, bis-[(C₁-C₇)-alkyl]aminosulfonyl, (C₃-C₇)-cycloalkylaminosulfonylamino, (C₁-C₇)-alkoxycarbonyl, (C₂-C₇)-alkenyloxycarbonyl, (C₂-C₇)-alkynyloxycarbonyl, (C₃-C₇)-cycloalkyloxycarbonyl, aryl-(C₁-C₇)-alkoxycarbonyl, (C₁-C₇)-alkylaminocarbonyl, (C₃-C₇)-cycloalkylaminocarbonyl, aryl-(C₁-C₇)-alkylaminocarbonyl,
R⁵ is amino, (C₁-C₇)-alkyl, (C₃-C₇)-cycloalkyl, (C₃-C₇)-cycloalkyl-(C₁-C₇)-alkyl, (C₁-C₇)-haloalkyl, (C₃-C₇)-halocycloalkyl, (C₄-C₇)-cycloalkenyl, aryl, heteroaryl, heterocyclyl, aryl-(C₁-C₇)-alkyl, heteroaryl-(C₁-C₇)-alkyl, heterocyclyl-(C₁-C₇)-alkyl, (C₁-C₇)-alkoxycarbonyl-(C₁-C₇)-alkyl, aryl-(C₁-C₇)-alkoxycarbonyl-(C₁-C₇)-alkyl, (C₃-C₇)-cycloalkoxycarbonyl-(C₁-C₇)-alkyl, (C₃-C₇)-cycloalkyl-(C₁-C₇)-alkoxycarbonyl-(C₁-C₇)-alkyl, heteroaryl-(C₁-C₇)-alkoxycarbonyl-(C₁-C₇)-alkyl, aminocarbonyl-(C₁-C₇)-alkyl, (C₁-C₇)-alkylaminocarbonyl-(C₁-C₇)-alkyl, (C₃-C₇)-cycloalkylaminocarbonyl-(C₁-C₇)-alkyl, aryl-(C₁-C₇)-alkylaminocarbonyl-(C₁-C₇)-alkyl, (C₁-C₇)-alkylamino, arylamino, (C₃-C₇)-cycloalkylamino, aryl-(C₁-C₇)-alkylamino, heteroaryl-(C₁-C₇)-alkylamino, heteroarylamino, heterocyclylamino, aryloxy-(C₁-C₇)-alkyl, (C₁-C₇)-alkoxy-(C₁-C₇)-alkyl, heteroaryloxy-(C₁-C₇)-alkyl, (C₂-C₇)-alkenyl, (C₂-C₇)-alkynyl, (C₂-C₇)-alkenylamino, (C₂-C₇)-alkynylamino, bis-[(C₁-C₇)-alkenyl]amino, aryloxy, bis-[(C₁-C₇)-alkyl]amino, aryl-(C₂-C₇)-alkenyl, heteroaryl-(C₂-C₇)-alkenyl, heterocyclyl-(C₂-C₇)-alkenyl, aryloxycarbonyl-(C₁-C₇)-alkyl, heteroaryloxycarbonyl-(C₁-C₇)-alkyl, bis[(C₁-C₇)-alkyl]aminocarbonyl-(C₁-C₇)-alkyl, (C₁-C₇)-alkylthio-(C₁-C₇)-alkyl, cyano-(C₁-C₇)-alkyl, (C₁-C₇)-alkoxy-(C₁-C₇)-alkoxy-(C₁-C₇)-alkyl,
R⁶ is hydrogen, (C₁-C₇)-alkyl, (C₃-C₇)-cycloalkyl, cyano-(C₁-C₇)-alkyl, (C₃-C₇)-cycloalkyl-(C₁-C₇)-alkyl, (C₁-C₇)-alkylsulfonyl, arylsulfonyl, heteroarylsulfonyl, (C₃-C₇)-cycloalkylsulfonyl, heterocyclylsulfonyl, aryl-(C₁-C₇)-alkylsulfonyl, (C₁-C₇)-alkylcarbonyl, arylcarbonyl, heteroarylcarbonyl, (C₃-C₇)-cycloalkylcarbonyl, heterocyclylcarbonyl, (C₁-C₇)-alkoxycarbonyl, aryl-(C₁-C₇)-alkoxycarbonyl, (C₁-C₇)-haloalkylcarbonyl, (C₂-C₇)-alkenyl, (C₂-C₇)-alkynyl, (C₁-C₇)-haloalkyl, halo-(C₂-C₇)-alkynyl, halo-(C₂-C₇)-alkenyl, (C₁-C₇)-alkoxy-(C₁-C₇)-alkyl, amino, (C₁-C₇)-alkoxy-(C₁-C₇)-alkoxy-(C₁-C₇)-alkyl, heteroaryl-(C₁-C₇)-alkylsulfonyl, heterocyclyl-(C₁-C₇)-alkylsulfonyl, (C₄-C₇)-cycloalkenyl, (C₄-C₇)-cycloalkenyl-(C₁-C₇)-alkyl, (C₂-C₇)-alkenyloxycarbonyl, (C₂-C₇)-alkynyloxycarbonyl, (C₁-C₇)-alkylaminocarbonyl, (C₃-C₇)-cycloalkylaminocarbonyl, bis-[(C₁-C₇)-alkyl]aminocarbonyl,
R⁷, R⁸ are each independently hydrogen, hydroxyl, amino, (C₁-C₇)-alkylamino, bis[(C₁-C₇)-alkyl]amino, (C₃-C₇)-cycloalkylamino, (C₁-C₇)-alkyl, halogen, (C₂-C₇)-alkenyl, (C₂-C₇)-alkynyl, (C₁-C₇)-haloalkyl, hydroxy-(C₁-C₇)-alkyl, cyano-(C₁-C₇)-alkyl, nitro-(C₁-C₇)-alkyl, aryl, heteroaryl, (C₃-C₇)-cycloalkyl, (C₄-C₇)-cycloalkenyl, heterocyclyl, (C₁-C₇)-alkoxy, (C₁-C₇)-haloalkoxy, (C₁-C₇)-alkoxy-(C₁-C₇)-alkyl, (C₁-C₇)-alkylthio-(C₁-C₇)-alkyl, amino-(C₁-C₇)-alkyl, (C₁-C₇)-alkylamino-(C₁-C₇)-alkyl, (C₃-C₇)-cycloalkylamino-(C₁-C₇)-alkyl, aryl-(C₁-C₇)-alkylamino-(C₁-C₇)-alkyl, heteroaryl-(C₁-C₇)-alkylamino-(C₁-C₇)-alkyl, heterocyclyl-(C₁-C₇)-alkylamino-(C₁-C₇)-alkyl, heterocyclylamino-(C₁-C₇)-alkyl, heteroarylamino-(C₁-C₇)-alkyl, (C₁-C₇)-alkoxycarbonylamino-(C₁-C₇)-alkyl, arylamino-(C₁-C₇)-alkyl, aryl-(C₁-C₇)-alkoxycarbonylamino-(C₁-C₇)-alkyl, (C₃-C₇)-cycloalkoxycarbonylamino-(C₁-C₇)-alkyl, (C₃-C₇)-cycloalkyl-(C₁-C₇)-alkoxycarbonylamino-(C₁-C₇)-alkyl, heteroaryl-(C₁-C₇)-alkoxycarbonylamino-(C₁-C₇)-alkyl, (C₁-C₇)-alkylcarbonylamino-(C₁-C₇)-alkyl, (C₃-C₇)-cycloalkylcarbonylamino-(C₁-C₇)-alkyl, arylcarbonylamino-(C₁-C₇)-alkyl, heteroarylcarbonylamino-(C₁-C₇)-alkyl, heterocyclylcarbonylamino-(C₁-C₇)-alkyl, (C₂-C₇)-alkenyloxycarbonylamino-(C₁-C₇)-alkyl, aryl-(C₂-C₇)-alkenylamino-(C₁-C₇)-alkyl, hydroxycarbonyl, (C₁-C₇)-alkoxycarbonyl, (C₂-C₇)-alkenyloxycarbonyl, aryl-(C₁-C₇)-alkoxycarbonyl, aminocarbonyl, alkylaminocarbonyl, (C₃-C₇)-cycloalkylaminocarbonyl, aryl-(C₁-C₇)-alkylaminocarbonyl, heteroarylaminocarbonyl, arylamino, heteroarylamino, heterocyclylamino, (C₂-C₇)-alkenylamino, (C₂-C₇)-alkynylamino, (C₁-C₇)-alkylsulfinyl, (C₂-C₇)-alkenylsulfinyl, arylsulfinyl, heteroarylsulfinyl, heterocyclylsulfinyl, (C₃-C₇)-cycloalkylsulfinyl, (C₁-C₇)-alkylsulfonyl, (C₂-C₇)-alkenylsulfonyl, arylsulfonyl, heteroarylsulfonyl, heterocyclylsulfonyl, (C₃-C₇)-cycloalkylsulfonyl, bis-[(C₁-C₇)-alkyl]amino-(C₁-C₇)-alkyl, (C₁-C₇)-alkyl(aryl)amino-(C₁-C₇)-alkyl, heteroaryloxycarbonylamino-(C₁-C₇)-alkyl, heterocyclyloxycarbonylamino-(C₁-C₇)-alkyl, aryl-(C₁-C₇)-alkoxycarbonylamino-(C₁-C₇)-alkyl, arylaminocarbonyl, (C₁-C₇)-alkylsulfonylamino-(C₁-C₇)-alkyl, (C₃-C₇)-cycloalkylsulfonylamino-(C₁-C₇)-alkyl, arylsulfonylamino-(C₁-C₇)-alkyl, heteroarylsulfonylamino-(C₁-C₇)-alkyl, heterocyclylsulfonylamino-(C₁-C₇)-alkyl, bis-[(C₁-C₇)-alkyl]aminosulfonyl-(C₁-C₇)-alkyl, (C₁-C₇)-alkylsulfonylamino, (C₃-C₇)-cycloalkylsulfonylamino, arylsulfonylamino, heteroarylsulfonylamino, heterocyclylsulfonylamino, (C₁-C₇)-alkoxy-(C₁-C₇)-alkoxy or
R⁷ and R⁸ together with the carbon atom to which they are bonded form a fully saturated or partly saturated 3- to 10-membered monocyclic or bicyclic ring optionally interrupted by heteroatoms and optionally having further substitution or
R⁷ and R⁸ together with the carbon atom to which they are bonded form an oxo group or
R⁷ and R⁸ together with the carbon atom to which they are bonded form an oxime group substituted by hydrogen, (C₁-C₇)-alkyl, (C₃-C₇)-cycloalkyl, (C₃-C₇)-cycloalkyl-(C₁-C₇)-alkyl, aryl, heteroaryl, aryl-(C₁-C₇)-alkyl, heteroaryl-(C₁-C₇)-alkyl,
R⁹, R¹⁰ are each independently hydrogen, (C₁-C₇)-alkyl, halogen, cyano, (C₁-C₇)-haloalkyl, cyano-(C₁-C₇)-alkyl, aryl, heteroaryl, (C₃-C₇)-cycloalkyl, (C₄-C₇)-cycloalkenyl, heterocyclyl, (C₁-C₇)-alkoxy-(C₁-C₇)-alkyl, (C₁-C₇)-alkylthio-(C₁-C₇)-alkyl,
W is oxygen or sulfur,
X, Y are each independently hydrogen, (C₁-C₇)-alkyl, halogen, (C₂-C₇)-alkenyl, (C₂-C₇)-alkynyl, (C₁-C₇)-haloalkyl, hydroxy-(C₁-C₇)-alkyl, cyano-(C₁-C₇)-alkyl, aryl, heteroaryl, (C₃-C₇)-cycloalkyl, (C₄-C₇)-cycloalkenyl, heterocyclyl, cyano, nitro, hydroxyl, (C₁-C₇)-alkoxy, (C₁-C₇)-alkylthio, (C₁-C₇)-alkoxy-(C₁-C₇)-alkyl, (C₁-C₇)-alkylthio-(C₁-C₇)-alkyl, aryloxy, aryl-(C₁-C₇)-alkoxy, (C₁-C₇)-haloalkoxy, (C₁-C₇)-haloalkylthio, (C₁-C₇)-alkylamino, bis-[(C₁-C₇)-alkyl]amino, (C₁-C₇)-alkoxy-(C₁-C₇)-alkoxy, amino-(C₁-C₇)-alkyl, (C₁-C₇)-alkylamino-(C₁-C₇)-alkyl, (C₃-C₇)-cycloalkylamino-(C₁-C₇)-alkyl, aryl-(C₁-C₇)-alkylamino-(C₁-C₇)-alkyl, heteroaryl-(C₁-C₇)-alkylamino-(C₁-C₇)-alkyl, heterocyclyl-(C₁-C₇)-alkylamino-(C₁-C₇)-alkyl, heterocyclylamino-(C₁-C₇)-alkyl, heteroarylamino-(C₁-C₇)-alkyl, (C₁-C₇)-alkoxycarbonylamino-(C₁-C₇)-alkyl, arylamino-(C₁-C₇)-alkyl, aryl-(C₁-C₇)-alkoxycarbonylamino-(C₁-C₇)-alkyl, (C₃-C₇)-cycloalkoxycarbonylamino-(C₁-C₇)-alkyl, (C₃-C₇)-cycloalkyl-(C₁-C₇)-alkoxycarbonylamino-(C₁-C₇)-alkyl, heteroaryl-(C₁-C₇)-alkoxycarbonylamino-(C₁-C₇)-alkyl, (C₁-C₇)-alkylcarbonylamino-(C₁-C₇)-alkyl, (C₃-C₇)-cycloalkylcarbonylamino-(C₁-C₇)-alkyl, arylcarbonylamino-(C₁-C₇)-alkyl, heteroarylcarbonylamino-(C₁-C₇)-alkyl, heterocyclylcarbonylamino-(C₁-C₇)-alkyl, (C₂-C₇)-alkenyloxycarbonylamino-(C₁-C₇)-alkyl, aryl-(C₂-C₇)-alkenylamino-(C₁-C₇)-alkyl, arylsulfonyl-(C₁-C₇)-alkyl, heteroarylsulfonyl-(C₁-C₇)-alkyl, (C₁-C₇)-alkylsulfonyl-(C₁-C₇)-alkyl, (C₃-C₇)-cycloalkylsulfonyl-(C₁-C₇)-alkyl, arylsulfinyl-(C₁-C₇)-alkyl, heteroarylsulfinyl-(C₁-C₇)-alkyl, (C₁-C₇)-alkylsulfinyl-(C₁-C₇)-alkyl, (C₃-C₇)-cycloalkylsulfinyl-(C₁-C₇)-alkyl, bis[(C₁-C₇)-alkyl]amino-(C₁-C₇)-alkyl, (C₁-C₇)-alkoxycarbonyl, aryl-(C₁-C₇)-alkoxycarbonyl, heteroaryl-(C₁-C₇)-alkoxycarbonyl, (C₃-C₇)-cycloalkoxycarbonyl, (C₃-C₇)-cycloalkyl-(C₁-C₇)-alkoxycarbonyl, (C₁-C₇)-alkylcarbonyl, (C₃-C₇)-cycloalkylcarbonyl, arylcarbonyl, heteroarylcarbonyl, heterocyclylcarbonyl, (C₁-C₇)-alkylsulfonylamino-(C₁-C₇)-alkyl, (C₃-C₇)-cycloalkylsulfonylamino-(C₁-C₇)-alkyl, arylsulfonylamino-(C₁-C₇)-alkyl, heteroarylsulfonylamino-(C₁-C₇)-alkyl, heterocyclylsulfonylamino-(C₁-C₇)-alkyl, bis-[(C₁-C₇)-alkyl]aminosulfonyl-(C₁-C₇)-alkyl, (C₁-C₇)-alkylsulfonylamino, (C₃-C₇)-cycloalkylsulfonylamino, arylsulfonylamino, heteroarylsulfonylamino, heterocyclylsulfonylamino, heteroaryloxycarbonylamino-(C₁-C₇)-alkyl, heterocyclyloxycarbonylamino-(C₁-C₇)-alkyl or
X and Y together with the carbon atom to which they are bonded form a fully saturated or partly saturated 3- to 10-membered monocyclic or bicyclic ring optionally interrupted by heteroatoms and optionally having further substitution.

Particular preference is given to the inventive use of compounds of the general formula (I) in which
R¹ is fluorine, chlorine, bromine, iodine, cyano, (C₃-C₁₀)-cycloalkyl, (C₃-C₁₀)-halocycloalkyl, (C₄-C₁₀)-cycloalkenyl, (C₄-C₁₀)-halocycloalkenyl, (C₁-C₁₀)-haloalkyl, (C₂-C₆)-haloalkenyl, (C₁-C₆)-alkoxy-(C₁-C₆)-haloalkyl, aryl, aryl-(C₁-C₆)-alkyl, heteroaryl, heteroaryl-(C₁-C₆)-alkyl, (C₃-C₆)-cycloalkyl-(C₁-C₆)-alkyl, (C₂-C₆)-haloalkynyl, heterocyclyl, heterocyclyl-(C₁-C₆)-alkyl, (C₁-C₆)-alkoxy-(C₁-C₆)-alkyl, (C₁-C₆)-alkylcarbonyl-(C₁-C₆)-alkyl, hydroxycarbonyl-(C₁-C₆)-alkyl, (C₁-C₆)-alkoxycarbonyl-(C₁-C₆)-alkyl, (C₂-C₆)-alkenyloxycarbonyl-(C₁-C₆)-alkyl, (C₂-C₆)-alkynyloxycarbonyl-(C₁-C₆)-alkyl, aryl-(C₁-C₆)-alkoxycarbonyl-(C₁-C₆)-alkyl, (C₃-C₆)-cycloalkoxycarbonyl-(C₁-C₆)-alkyl, (C₃-C₆)-cycloalkyl-(C₁-C₆)-alkoxycarbonyl-(C₁-C₆)-alkyl, aminocarbonyl-(C₁-C₆)-alkyl, (C₁-C₆)-alkylaminocarbonyl-(C₁-C₆)-alkyl, (C₃-C₆)-cycloalkylaminocarbonyl-(C₁-C₆)-alkyl, aryl-(C₁-C₆)-alkylaminocarbonyl-(C₁-C₆)-alkyl, heteroaryl-(C₁-C₆)-alkylaminocarbonyl-(C₁-C₆)-alkyl, (C₁-C₆)-alkylthio-(C₁-C₆)-alkyl, (C₃-C₆)-cycloalkylthio-(C₁-C₆)-alkyl, arylthio-(C₁-C₆)-alkyl, heterocyclylthio-(C₁-C₆)-alkyl, heteroarylthio-(C₁-C₆)-alkyl, aryl-(C₁-C₆)-alkylthio-(C₁-C₆)-alkyl, (C₁-C₆)-alkylsulfinyl-(C₁-C₆)-alkyl, (C₁-C₆)-alkylsulfonyl-(C₁-C₆)-alkyl, arylsulfinyl-(C₁-C₆)-alkyl, arylsulfonyl-(C₁-C₆)-alkyl, (C₃-C₆)-cycloalkylsulfinyl-(C₁-C₆)-alkyl, (C₃-C₆)-cycloalkylsulfonyl-(C₁-C₆)-alkyl, (C₁-C₆)-alkoxy-(C₁-C₆)-alkoxy-(C₁-C₆)-alkyl, (C₁-C₆)-alkylcarbonyl, (C₁-C₆)-haloalkylcarbonyl, (C₃-C₆)-cycloalkylcarbonyl, hydroxycarbonyl, (C₁-C₆)-alkoxycarbonyl, (C₂-C₆)-alkenyloxycarbonyl, (C₂-C₆)-alkynyloxycarbonyl, aryl-(C₁-C₆)-alkoxycarbonyl, (C₃-C₆)-cycloalkyl-(C₁-C₆)-alkoxycarbonyl, arylcarbonyl, heteroarylcarbonyl, heterocyclylcarbonyl, aryl-(C₁-C₆)-alkylcarbonyl, (C₁-C₆)-alkylaminocarbonyl, (C₃-C₆)-cycloalkylaminocarbonyl, arylaminocarbonyl, aryl-(C₁-C₆)-alkylaminocarbonyl, heteroarylaminocarbonyl, heterocyclylaminocarbonyl, heteroaryl-(C₁-C₆)-alkylaminocarbonyl, heterocyclyl-(C₁-C₆)-alkylaminocarbonyl, (C₁-C₆)-alkylsulfonyl, (C₃-C₆)-cycloalkylsulfonyl, arylsulfonyl, aryl-(C₁-C₆)-alkylsulfonyl, heteroarylsulfonyl, heterocyclylsulfonyl, cyano-(C₁-C₆)-alkyl, (C₄-C₆)-cycloalkenyl-(C₁-C₆)-alkyl, nitro-(C₁-C₆)-alkyl, (C₁-C₆)-haloalkoxy-(C₁-C₆)-alkyl, (C₁-C₆)-haloalkylthio-(C₁-C₆)-alkyl, bis-[(C₁-C₆)-alkyl]aminocarbonyl, (C₃-C₆)-cycloalkyl-[(C₁-C₆)-alkyl]aminocarbonyl, aryl-[(C₁-C₆)-alkyl]aminocarbonyl, aryl-(C₁-C₆)-alkyl-[(C₁-C₆)-alkyl]aminocarbonyl, (C₂-C₆)-alkenylaminocarbonyl, (C₂-C₆)-alkynylaminocarbonyl, (C₁-C₆)-alkylaminosulfonyl, bis-[(C₁-C₆)-alkyl]aminosulfonyl, heterocyclylsulfinyl-(C₁-C₆)-alkyl, heteroarylsulfinyl-(C₁-C₆)-alkyl, aryl-(C₁-C₆)-alkylsulfinyl-(C₁-C₆)-alkyl, heterocyclylsulfonyl-(C₁-C₆)-alkyl, heteroarylsulfonyl-(C₁-C₆)-alkyl, aryl-(C₁-C₆)-alkylsulfonyl-(C₁-C₆)-alkyl, bis-[(C₁-C₆)-alkyl]aminocarbonyl-(C₁-C₆)-alkyl, (C₃-C₆)-cycloalkyl-[(C₁-C₆)-alkyl]aminocarbonyl-(C₁-C₆)-alkyl, aryl-[(C₁-C₆)-alkyl]aminocarbonyl-(C₁-C₆)-alkyl, aryl-(C₁-C₆)-alkyl-[(C₁-C₆)-alkyl]aminocarbonyl-(C₁-C₆)-alkyl, (C₂-C₆)-alkenylaminocarbonyl-(C₁-C₆)-alkyl, (C₂-C₆)-alkynylaminocarbonyl-(C₁-C₆)-alkyl, (C₁-C₆)-alkylamino, bis-[(C₁-C₆)-alkyl]amino, (C₃-C₆)-cycloalkyl[(C₁-C₆)-alkyl]amino, amino, (C₂-C₆)-alkenylamino, (C₂-C₆)-alkynylamino, arylamino, heteroarylamino, aryl-(C₁-C₆)-alkylamino, heteroaryl-(C₁-C₆)-alkylamino, heterocyclylamino, heterocyclyl-(C₁-C₆)-alkylamino, (C₂-C₆)-alkenylcarbonyl-(C₁-C₆)-alkyl, (C₂-C₆)-alkynylcarbonyl-(C₁-C₆)-alkyl, (C₃-C₆)-cycloalkyl-(C₁-C₆)-alkylaminocarbonyl-(C₁-C₆)-alkyl, (C₃-C₆)-cycloalkyl-(C₁-C₆)-alkyl-[(C₁-C₆)-alkyl]aminocarbonyl-(C₁-C₆)-alkyl, (C₂-C₆)-alkenylsulfonyl-(C₁-C₆)-alkyl, (C₂-C₆)-alkynylsulfonyl-(C₁-C₆)-alkyl, heteroaryl-(C₁-C₆)-alkylsulfonyl-(C₁-C₆)-alkyl, heterocyclyl-(C₁-C₆)-alkylsulfonyl-(C₁-C₆)-alkyl, (C₂-C₆)-alkenylsulfinyl-(C₁-C₆)-alkyl, (C₂-C₆)-alkynylsulfinyl-(C₁-C₆)-alkyl, heteroaryl-(C₁-C₆)-alkylsulfinyl-(C₁-C₆)-alkyl, heterocyclyl-(C₁-C₆)-alkylsulfinyl-(C₁-C₆)-alkyl, (C₂-C₆)-alkenyloxy-(C₁-C₆)-alkoxy-(C₁-C₆)-alkyl, (C₂-C₆)-alkynyloxy-(C₁-C₆)-alkoxy-(C₁-C₆)-alkyl, heteroaryl-(C₁-C₆)-alkoxy-(C₁-C₆)-alkyl, heterocyclyl-(C₁-C₆)-alkoxy-(C₁-C₆)-alkyl, tris[(C₁-C₆)-alkyl]silyl, tris[(C₁-C₆)-alkyl]silyl-(C₁-C₆)-alkyl, (C₁-C₆)-alkoxy, (C₁-C₆)-haloalkoxy, (C₁-C₆)-alkylamino-(C₁-C₆)-alkyl, bis-[(C₁-C₆)-alkyl]amino-(C₁-C₆)-alkyl, (C₃-C₆)-cycloalkyl[(C₁-C₆)-alkyl]amino-(C₁-C₆)-alkyl, amino-(C₁-C₆)-alkyl, (C₂-C₆)-alkenylamino-(C₁-C₆)-alkyl, (C₂-C₆)-alkynylamino-(C₁-C₆)-alkyl, arylamino-(C₁-C₆)-alkyl, heteroarylamino-(C₁-C₆)-alkyl, aryl-(C₁-C₆)-alkylamino-(C₁-C₆)-alkyl, heteroaryl-(C₁-C₆)-alkylamino-(C₁-C₆)-alkyl, heterocyclylamino-(C₁-C₆)-alkyl, heterocyclyl-(C₁-C₆)-alkylamino-(C₁-C₆)-alkyl, (C₁-C₆)-haloalkoxy-(C₁-C₆)-haloalkyl, (C₂-C₆)-alkenyloxy-(C₁-C₆)-haloalkyl, (C₂-C₆)-alkynyloxy-(C₁-C₆)-haloalkyl, (C₁-C₆)-alkoxy-(C₁-C₆)-alkoxy-(C₁-C₆)-haloalkyl, (C₃-C₆)-cycloalkyl-(C₁-C₆)-alkoxy-(C₁-C₆)-haloalkyl, (C₃-C₆)-cycloalkyl-(C₁-C₆)-alkoxy-(C₁-C₆)-alkyl, (C₁-C₆)-alkoxy-(C₁-C₆)-alkoxy, (C₁-C₆)-alkoxycarbonyl-(C₃-C₆)-cycloalkyl,
R², R³, R⁴ are each independently hydrogen, halogen, (C₁-C₆)-alkoxy, (C₁-C₆)-alkyl, (C₁-C₆)-haloalkyl, (C₁-C₆)-haloalkoxy, (C₁-C₆)-alkylthio, (C₁-C₆)-haloalkylthio, aryl, aryl-(C₁-C₆)-alkyl, heteroaryl, heteroaryl-(C₁-C₆)-alkyl, heterocyclyl, heterocyclyl-(C₁-C₆)-alkyl, (C₃-C₆)-cycloalkyl, nitro, amino, hydroxyl, (C₁-C₆)-alkylamino, bis-[(C₁-C₆)-alkyl]amino, hydrothio, (C₁-C₆)-alkylcarbonylamino, (C₃-C₆)-cycloalkylcarbonylamino, arylcarbonylamino, heteroarylcarbonylamino, heterocyclylcarbonylamino, formyl, hydroxyiminomethyl, (C₁-C₆)-alkoxyiminomethyl, (C₃-C₆)-cycloalkoxyiminomethyl, aryloxyiminomethyl, (C₃-C₆)-cycloalkyl-(C₁-C₆)-alkoxyiminomethyl, thiocyanato, isothiocyanato, aryloxy, heteroaryloxy, (C₃-C₆)-cycloalkoxy, (C₃-C₆)-cycloalkyl-(C₁-C₆)-alkoxy, aryl-(C₁-C₆)-alkoxy, (C₂-C₆)-alkynyl, (C₂-C₆)-alkenyl, aryl-(C₁-C₆)-alkynyl, tris-[(C₁-C₆)-alkyl]silyl-(C₂-C₆)-alkynyl, bis-[(C₁-C₆)-alkyl](aryl)silyl-(C₂-C₆)-alkynyl, bis-aryl[(C₁-C₆)-alkyl]silyl-(C₂-C₆)-alkynyl, (C₃-C₆)-cycloalkyl-(C₂-C₆)-alkynyl, aryl-(C₂-C₆)-alkenyl, heteroaryl-(C₂-C₆)-alkenyl, (C₃-C₆)-cycloalkyl-(C₂-C₆)-alkenyl, (C₃-C₆)-cycloalkyl-(C₂-C₆)-alkyl, (C₂-C₆)-haloalkynyl, (C₂-C₆)-haloalkenyl, (C₄-C₆)-cycloalkenyl, (C₁-C₆)-alkoxy-(C₁-C₆)-alkoxy-(C₁-C₆)-alkyl, (C₁-C₆)-alkylsulfonyl, arylsulfonyl, heteroarylsulfonyl, (C₁-C₆)-alkylsulfonylamino, arylsulfonylamino, aryl-(C₁-C₆)-alkylsulfonylamino, heteroarylsulfonylamino, heteroaryl-(C₁-C₆)-alkylsulfonylamino, bis-[(C₁-C₆)-alkyl]aminosulfonyl,
R⁵ is amino, (C₁-C₆)-alkyl, (C₃-C₆)-cycloalkyl, (C₃-C₆)-cycloalkyl-(C₁-C₆)-alkyl, (C₁-C₆)-haloalkyl, (C₃-C₆)-halocycloalkyl, (C₄-C₆)-cycloalkenyl, aryl, heteroaryl, heterocyclyl, aryl-(C₁-C₆)-alkyl, heteroaryl-(C₁-C₆)-alkyl, heterocyclyl-(C₁-C₆)-alkyl, (C₁-C₆)-alkoxycarbonyl-(C₁-C₆)-alkyl, aryl-(C₁-C₆)-alkoxycarbonyl-(C₁-C₆)-alkyl, (C₃-C₆)-cycloalkoxycarbonyl-(C₁-C₆)-alkyl, (C₃-C₆)-cycloalkyl-(C₁-C₆)-alkoxycarbonyl-(C₁-C₆)-alkyl, heteroaryl-(C₁-C₆)-alkoxycarbonyl-(C₁-C₆)-alkyl, aminocarbonyl-(C₁-C₆)-alkyl, (C₁-C₆)-alkylaminocarbonyl-(C₁-C₆)-alkyl, (C₃-C₆)-cycloalkylaminocarbonyl-(C₁-C₆)-alkyl, aryl-(C₁-C₆)-alkylaminocarbonyl-(C₁-C₆)-alkyl, (C₁-C₆)-alkylamino, arylamino, (C₃-C₆)-cycloalkylamino, aryl-(C₁-C₆)-alkylamino, heteroaryl-(C₁-C₆)-alkylamino, heteroarylamino, heterocyclylamino, aryloxy-(C₁-C₆)-alkyl, (C₁-C₆)-alkoxy-(C₁-C₆)-alkyl, heteroaryloxy-(C₁-C₆)-alkyl, (C₂-C₆)-alkenyl, (C₂-C₆)-alkynyl, (C₂-C₆)-alkenylamino, (C₂-C₆)-alkynylamino, bis-[(C₁-C₆)-alkenyl]amino, aryloxy, bis-[(C₁-C₆)-alkyl]amino, aryl-(C₂-C₆)-alkenyl, heteroaryl-(C₂-C₆)-alkenyl, heterocyclyl-(C₂-C₆)-alkenyl, aryloxycarbonyl-(C₁-C₆)-alkyl, heteroaryloxycarbonyl-(C₁-C₆)-alkyl, bis[(C₁-C₆)-alkyl]aminocarbonyl-(C₁-C₆)-alkyl, (C₁-C₆)-alkylthio-(C₁-C₆)-alkyl, cyano-(C₁-C₆)-alkyl, (C₁-C₆)-alkoxy-(C₁-C₆)-alkoxy-(C₁-C₆)-alkyl,
R⁶ is hydrogen, (C₁-C₆)-alkyl, (C₃-C₆)-cycloalkyl, cyano-(C₁-C₆)-alkyl, (C₃-C₆)-cycloalkyl-(C₁-C₆)-alkyl, (C₁-C₆)-alkylsulfonyl, arylsulfonyl, heteroarylsulfonyl, (C₃-C₆)-cycloalkylsulfonyl, heterocyclylsulfonyl, aryl-(C₁-C₆)-alkylsulfonyl, (C₁-C₆)-alkylcarbonyl, arylcarbonyl, heteroarylcarbonyl, (C₃-C₆)-cycloalkylcarbonyl, heterocyclylcarbonyl, (C₁-C₆)-alkoxycarbonyl, aryl-(C₁-C₆)-alkoxycarbonyl, (C₁-C₆)-haloalkylcarbonyl, (C₂-C₆)-alkenyl, (C₂-C₆)-alkynyl, (C₁-C₆)-haloalkyl, halo-(C₂-C₆)-alkynyl, halo-(C₂-C₆)-alkenyl, (C₁-C₆)-alkoxy-(C₁-C₆)-alkyl,
R⁷, R⁸ are each independently hydrogen, hydroxyl, amino, (C₁-C₆)-alkylamino, bis[(C₁-C₆)-alkyl]amino, (C₃-C₆)-cycloalkylamino, (C₁-C₆)-alkyl, fluorine, chlorine, bromine, iodine, (C₂-C₆)-alkenyl, (C₂-C₆)-alkynyl, (C₁-C₆)-haloalkyl, hydroxy-(C₁-C₆)-alkyl, cyano-(C₁-C₆)-alkyl, nitro-(C₁-C₆)-alkyl, aryl, heteroaryl, (C₃-C₆)-cycloalkyl, (C₄-C₆)-cycloalkenyl, heterocyclyl, (C₁-C₆)-alkoxy, (C₁-C₆)-haloalkoxy, (C₁-C₆)-alkoxy-(C₁-C₆)-alkyl, (C₁-C₆)-alkylthio-(C₁-C₆)-alkyl, amino-(C₁-C₆)-alkyl, (C₁-C₆)-alkylamino-(C₁-C₆)-alkyl, (C₃-C₆)-cycloalkylamino-(C₁-C₆)-alkyl, aryl-(C₁-C₆)-alkylamino-(C₁-C₆)-alkyl, heteroaryl-(C₁-C₆)-alkylamino-(C₁-C₆)-alkyl, heterocyclyl-(C₁-C₆)-alkylamino-(C₁-C₆)-alkyl, heterocyclylamino-(C₁-C₆)-alkyl, heteroarylamino-(C₁-C₆)-alkyl, (C₁-C₆)-alkoxycarbonylamino-(C₁-C₆)-alkyl, arylamino-(C₁-C₆)-alkyl, aryl-(C₁-C₆)-alkoxycarbonylamino-(C₁-C₆)-alkyl, (C₃-C₆)-cycloalkoxycarbonylamino-(C₁-C₆)-alkyl, (C₃-C₆)-cycloalkyl-(C₁-C₆)-alkoxycarbonylamino-(C₁-C₆)-alkyl, heteroaryl-(C₁-C₆)-alkoxycarbonylamino-(C₁-C₆)-alkyl, (C₁-C₆)-alkylcarbonylamino-(C₁-C₆)-alkyl, (C₃-C₆)-cycloalkylcarbonylamino-(C₁-C₆)-alkyl, arylcarbonylamino-(C₁-C₆)-alkyl, heteroarylcarbonylamino-(C₁-C₆)-alkyl, heterocyclylcarbonylamino-(C₁-C₆)-alkyl, (C₂-C₆)-alkenyloxycarbonylamino-(C₁-C₆)-alkyl, aryl-(C₂-C₆)-alkenylamino-(C₁-C₆)-alkyl, hydroxycarbonyl, (C₁-C₆)-alkoxycarbonyl, (C₂-C₆)-alkenyloxycarbonyl, aryl-(C₁-C₆)-alkoxycarbonyl, aminocarbonyl, alkylaminocarbonyl, (C₃-C₆)-cycloalkylaminocarbonyl, aryl-(C₁-C₆)-alkylaminocarbonyl, heteroarylaminocarbonyl or
R⁷ and R⁸ together with the carbon atom to which they are bonded form a fully saturated or partly saturated 3- to 8-membered monocyclic or bicyclic ring optionally interrupted by heteroatoms and optionally having further substitution or
R⁷ and R⁸ together with the carbon atom to which they are bonded form an oxo group or
R⁷ and R⁸ together with the carbon atom to which they are bonded form an oxime group substituted by hydrogen, (C₁-C₆)-alkyl, (C₃-C₆)-cycloalkyl, (C₃-C₆)-cycloalkyl-(C₁-C₆)-alkyl, aryl, heteroaryl, aryl-(C₁-C₆)-alkyl, heteroaryl-(C₁-C₆)-alkyl,
R⁹, R¹⁰ are each independently hydrogen, (C₁-C₆)-alkyl, fluorine, chlorine, bromine, iodine, cyano, (C₁-C₆)-haloalkyl, cyano-(C₁-C₆)-alkyl, aryl, heteroaryl, (C₃-C₆)-cycloalkyl, (C₄-C₆)-cycloalkenyl, heterocyclyl, (C₁-C₆)-alkoxy-(C₁-C₆)-alkyl, (C₁-C₆)-alkylthio-(C₁-C₆)-alkyl,
W is oxygen or sulfur, preferably oxygen,
X, Y are each independently hydrogen, (C₁-C₆)-alkyl, fluorine, chlorine, (C₂-C₆)-alkenyl, (C₁-C₆)-haloalkyl, (C₃-C₆)-cycloalkyl, (C₄-C₆)-cycloalkenyl, heterocyclyl, (C₁-C₆)-alkoxy, (C₁-C₆)-alkylthio, (C₁-C₆)-alkoxy-(C₁-C₆)-alkyl, (C₁-C₆)-alkylthio-(C₁-C₆)-alkyl, (C₁-C₆)-haloalkoxy, (C₁-C₆)-haloalkylthio, (C₁-C₆)-alkoxy-(C₁-C₆)-alkoxy, amino-(C₁-C₆)-alkyl, (C₁-C₆)-alkylamino-(C₁-C₆)-alkyl, (C₃-C₆)-cycloalkylamino-(C₁-C₆)-alkyl, aryl-(C₁-C₆)-alkylamino-(C₁-C₆)-alkyl, heteroaryl-(C₁-C₆)-alkylamino-(C₁-C₆)-alkyl, heterocyclyl-(C₁-C₆)-alkylamino-(C₁-C₆)-alkyl, heterocyclylamino-(C₁-C₆)-alkyl, heteroarylamino-(C₁-C₆)-alkyl, (C₁-C₆)-alkoxycarbonylamino-(C₁-C₆)-alkyl, arylamino-(C₁-C₆)-alkyl, aryl-(C₁-C₆)-alkoxycarbonylamino-(C₁-C₆)-alkyl, (C₃-C₆)-cycloalkoxycarbonylamino-(C₁-C₆)-alkyl, (C₃-C₆)-cycloalkyl-(C₁-C₆)-alkoxycarbonylamino-(C₁-C₆)-alkyl, heteroaryl-(C₁-C₆)-alkoxycarbonylamino-(C₁-C₆)-alkyl, (C₁-C₆)-alkylcarbonylamino-(C₁-C₆)-alkyl, (C₃-C₆)-cycloalkylcarbonylamino-(C₁-C₆)-alkyl, arylcarbonylamino-(C₁-C₆)-alkyl, heteroarylcarbonylamino-(C₁-C₆)-alkyl, heterocyclylcarbonylamino-(C₁-C₆)-alkyl, (C₂-C₆)-alkenyloxycarbonylamino-(C₁-C₆)-alkyl, aryl-(C₂-C₆)-alkenylamino-(C₁-C₆)-alkyl, arylsulfonyl-(C₁-C₆)-alkyl, heteroarylsulfonyl-(C₁-C₆)-alkyl, (C₁-C₆)-alkylsulfonyl-(C₁-C₆)-alkyl, (C₃-C₆)-cycloalkylsulfonyl-(C₁-C₆)-alkyl, arylsulfinyl-(C₁-C₆)-alkyl, heteroarylsulfinyl-(C₁-C₆)-alkyl, (C₁-C₆)-alkylsulfinyl-(C₁-C₆)-alkyl, (C₃-C₆)-cycloalkylsulfinyl-(C₁-C₆)-alkyl, bis[(C₁-C₆)-alkyl]amino-(C₁-C₆)-alkyl or
X and Y together with the carbon atom to which they are bonded form a fully saturated or partly saturated 3- to 8-membered monocyclic or bicyclic ring optionally interrupted by heteroatoms and optionally having further substitution.

Very particular preference is given to the inventive use of compounds of the general formula (I) which are described by the formulae (Iaa) to (Ibi) in which, here and later on in the description,

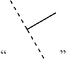

corresponds to a methyl radical,

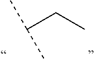

to an ethyl radical and

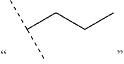

to an n-propyl radical,

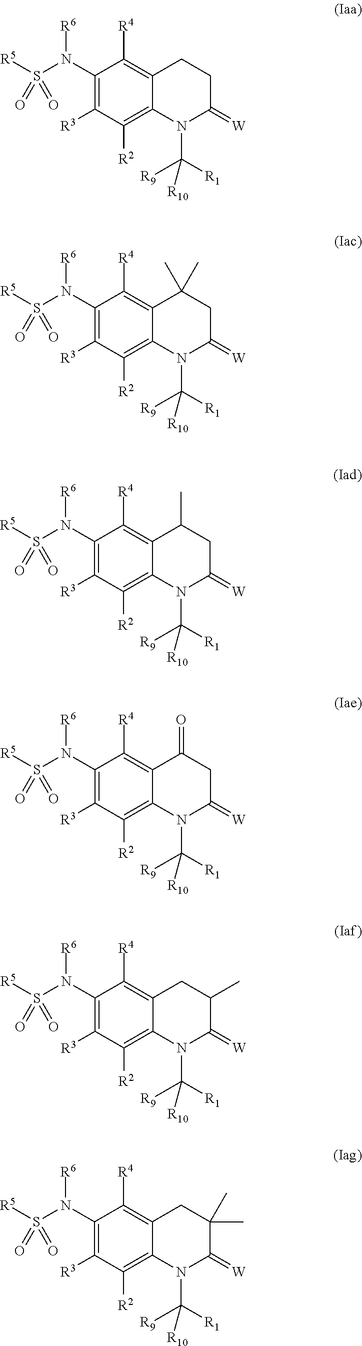

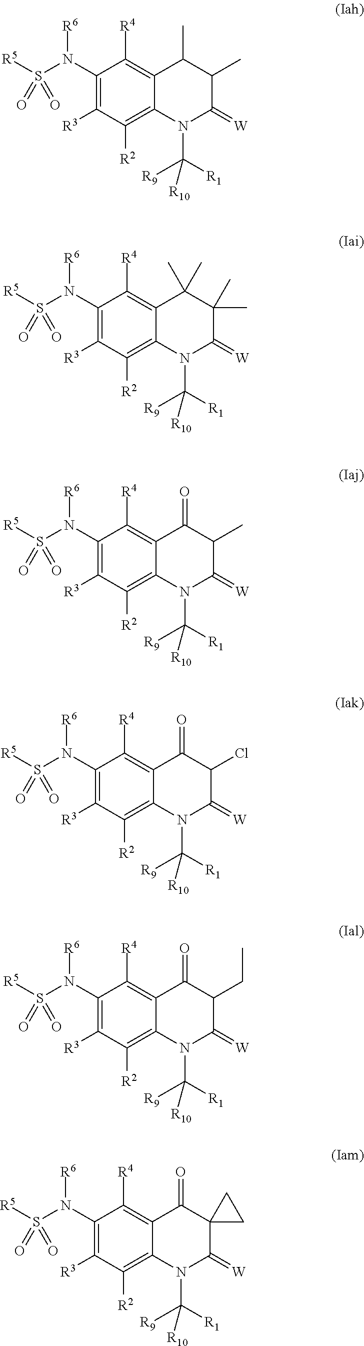

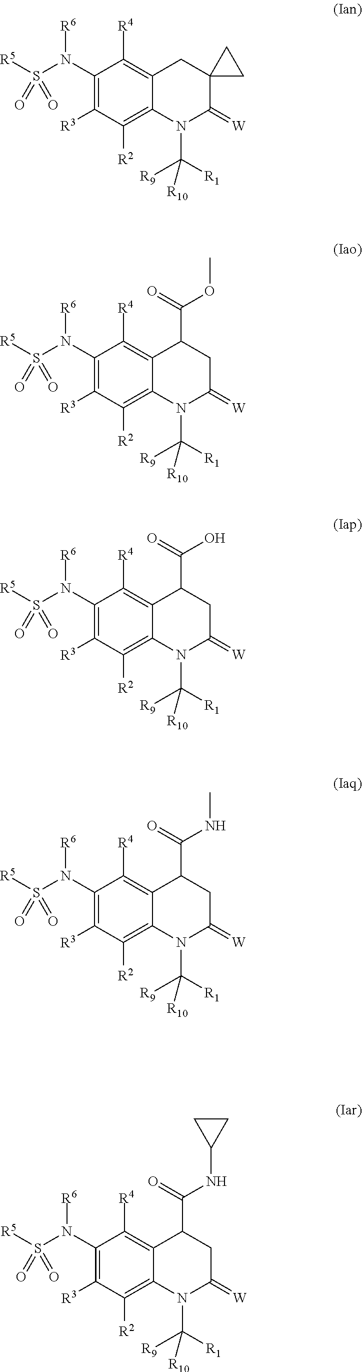

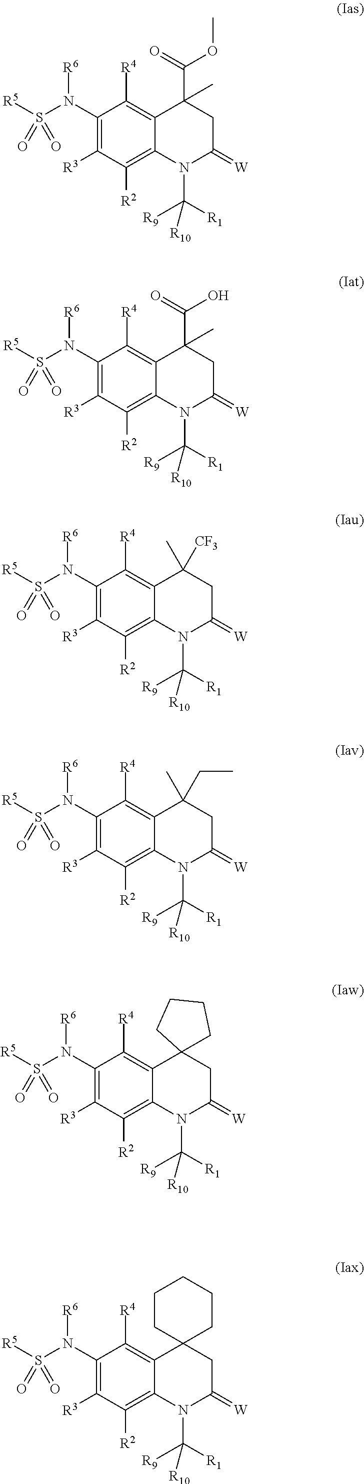

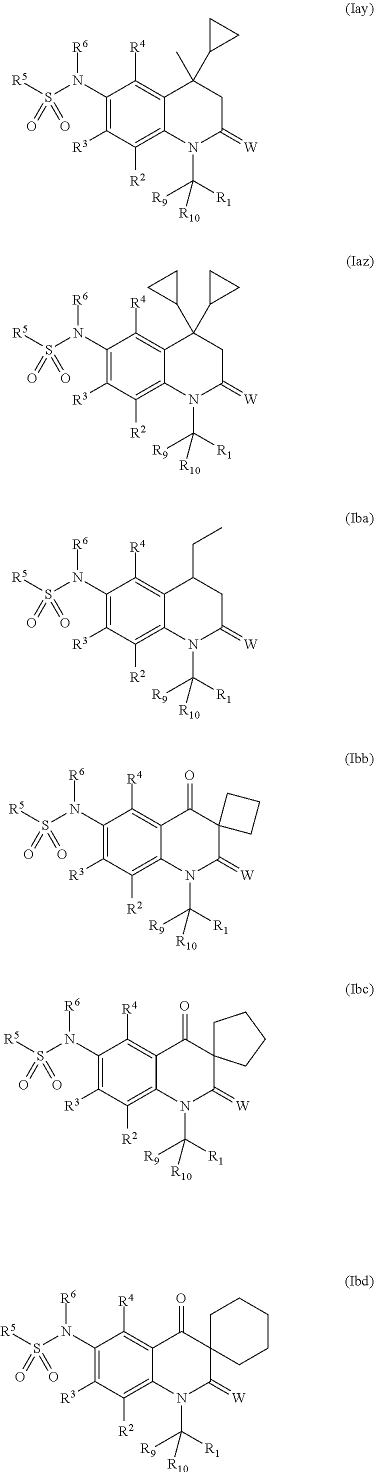

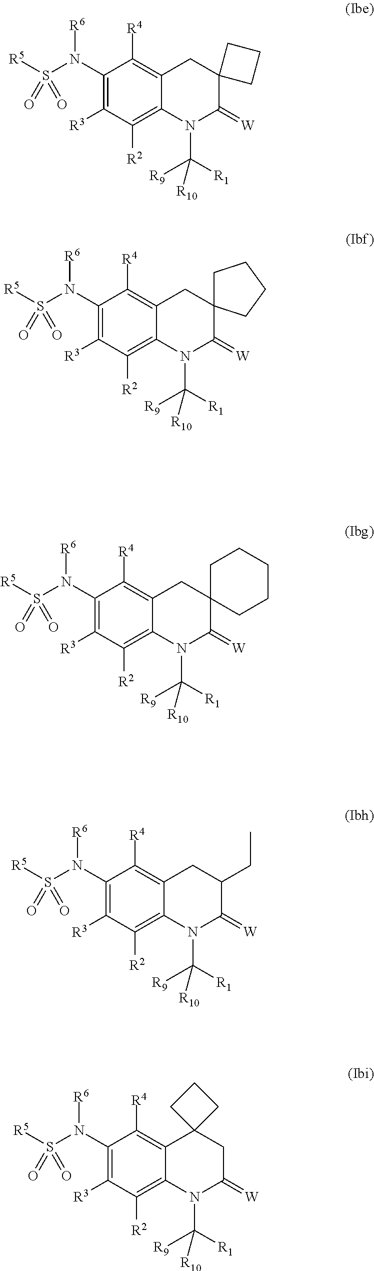

and in which
R¹ is fluorine, chlorine, bromine, iodine, cyano, (C₃-C₁₀)-cycloalkyl, (C₃-C₁₀)-halocycloalkyl, (C₄-C₁₀)-cycloalkenyl, (C₄-C₁₀)-halocycloalkenyl, (C₁-C₁₀)-haloalkyl, (C₂-C₆)-haloalkenyl, (C₁-C₆)-alkoxy-(C₁-C₆)-haloalkyl, aryl, aryl-(C₁-C₆)-alkyl, heteroaryl, heteroaryl-(C₁-C₆)-alkyl, (C₃-C₆)-cycloalkyl-(C₁-C₆)-alkyl, (C₂-C₆)-haloalkynyl, heterocyclyl, heterocyclyl-(C₁-C₆)-alkyl, (C₁-C₆)-alkoxy-(C₁-C₆)-alkyl, (C₁-C₆)-alkylcarbonyl-(C₁-C₆)-alkyl, hydroxycarbonyl-(C₁-C₆)-alkyl, (C₁-C₆)-alkoxycarbonyl-(C₁-C₆)-alkyl, (C₂-C₆)-alkenyloxycarbonyl-(C₁-C₆)-alkyl, (C₂-C₆)-alkynyloxycarbonyl-(C₁-C₆)-alkyl, aryl-(C₁-C₆)-alkoxycarbonyl-(C₁-C₆)-alkyl, (C₃-C₆)-cycloalkoxycarbonyl-(C₁-C₆)-alkyl, (C₃-C₆)-cycloalkyl-(C₁-C₆)-alkoxycarbonyl-(C₁-C₆)-alkyl, aminocarbonyl-(C₁-C₆)-alkyl, (C₁-C₆)-alkylaminocarbonyl-(C₁-C₆)-alkyl, (C₃-C₆)-cycloalkylaminocarbonyl-(C₁-C₆)-alkyl, aryl-(C₁-C₆)-alkylaminocarbonyl-(C₁-C₆)-alkyl, heteroaryl-(C₁-C₆)-alkylaminocarbonyl-(C₁-C₆)-alkyl, (C₁-C₆)-alkylthio-(C₁-C₆)-alkyl, (C₃-C₆)-cycloalkylthio-(C₁-C₆)-alkyl, arylthio-(C₁-C₆)-alkyl, heterocyclylthio-(C₁-C₆)-alkyl, heteroarylthio-(C₁-C₆)-alkyl, aryl-(C₁-C₆)-alkylthio-(C₁-C₆)-alkyl, (C₁-C₆)-alkylsulfinyl-(C₁-C₆)-alkyl, (C₁-C₆)-alkylsulfonyl-(C₁-C₆)-alkyl, arylsulfinyl-(C₁-C₆)-alkyl, arylsulfonyl-(C₁-C₆)-alkyl, (C₃-C₆)-cycloalkylsulfinyl-(C₁-C₆)-alkyl, (C₃-C₆)-cycloalkylsulfonyl-(C₁-C₆)-alkyl, (C₁-C₆)-alkoxy-(C₁-C₆)-alkoxy-(C₁-C₆)-alkyl, (C₁-C₆)-alkylcarbonyl, (C₁-C₆)-haloalkylcarbonyl, (C₃-C₆)-cycloalkylcarbonyl, hydroxycarbonyl, (C₁-C₆)-alkoxycarbonyl, (C₂-C₆)-alkenyloxycarbonyl, (C₂-C₆)-alkynyloxycarbonyl, aryl-(C₁-C₆)-alkoxycarbonyl, (C₃-C₆)-cycloalkyl-(C₁-C₆)-alkoxycarbonyl, arylcarbonyl, heteroarylcarbonyl, heterocyclylcarbonyl, aryl-(C₁-C₆)-alkylcarbonyl, (C₁-C₆)-alkylaminocarbonyl, (C₃-C₆)-cycloalkylaminocarbonyl, arylaminocarbonyl, aryl-(C₁-C₆)-alkylaminocarbonyl, heteroarylaminocarbonyl, heterocyclylaminocarbonyl, heteroaryl-(C₁-C₆)-alkylaminocarbonyl, heterocyclyl-(C₁-C₆)-alkylaminocarbonyl, (C₁-C₆)-alkylsulfonyl, (C₃-C₆)-cycloalkylsulfonyl, arylsulfonyl, aryl-(C₁-C₆)-alkylsulfonyl, heteroarylsulfonyl, heterocyclylsulfonyl, cyano-(C₁-C₆)-alkyl, (C₄-C₆)-cycloalkenyl-(C₁-C₆)-alkyl, nitro-(C₁-C₆)-alkyl, (C₁-C₆)-haloalkoxy-(C₁-C₆)-alkyl, (C₁-C₆)-haloalkylthio-(C₁-C₆)-alkyl, bis-[(C₁-C₆)-alkyl]aminocarbonyl, (C₃-C₆)-cycloalkyl-[(C₁-C₆)-alkyl]aminocarbonyl, aryl-[(C₁-C₆)-alkyl]aminocarbonyl, aryl-(C₁-C₆)-alkyl-[(C₁-C₆)-alkyl]aminocarbonyl, (C₂-C₆)-alkenylaminocarbonyl, (C₂-C₆)-alkynylaminocarbonyl, (C₁-C₆)-alkylaminosulfonyl, bis-[(C₁-C₆)-alkyl]aminosulfonyl, heterocyclylsulfinyl-(C₁-C₆)-alkyl, heteroarylsulfinyl-(C₁-C₆)-alkyl, aryl-(C₁-C₆)-alkylsulfinyl-(C₁-C₆)-alkyl, heterocyclylsulfonyl-(C₁-C₆)-alkyl, heteroarylsulfonyl-(C₁-C₆)-alkyl, aryl-(C₁-C₆)-alkylsulfonyl-(C₁-C₆)-alkyl, bis-[(C₁-C₆)-alkyl]aminocarbonyl-(C₁-C₆)-alkyl, (C₃-C₆)-cycloalkyl-[(C₁-C₆)-alkyl]aminocarbonyl-(C₁-C₆)-alkyl, aryl-[(C₁-C₆)-alkyl]aminocarbonyl-(C₁-C₆)-alkyl, aryl-(C₁-C₆)-alkyl-[(C₁-C₆)-alkyl]aminocarbonyl-(C₁-C₆)-alkyl, (C₂-C₆)-alkenylaminocarbonyl-(C₁-C₆)-alkyl, (C₂-C₆)-alkynylaminocarbonyl-(C₁-C₆)-alkyl, (C₁-C₆)-alkylamino, bis-[(C₁-C₆)-alkyl]amino, (C₃-C₆)-cycloalkyl[(C₁-C₆)-alkyl]amino, amino, (C₂-C₆)-alkenylamino, (C₂-C₆)-alkynylamino, arylamino, heteroarylamino, aryl-(C₁-C₆)-alkylamino, heteroaryl-(C₁-C₆)-alkylamino, heterocyclylamino, heterocyclyl-(C₁-C₆)-alkylamino, (C₂-C₆)-alkenylcarbonyl-(C₁-C₆)-alkyl, (C₂-C₆)-alkynylcarbonyl-(C₁-C₆)-alkyl, (C₃-C₆)-cycloalkyl-(C₁-C₆)-alkylaminocarbonyl-(C₁-C₆)-alkyl, (C₃-C₆)-cycloalkyl-(C₁-C₆)-alkyl-[(C₁-C₆)-alkyl]aminocarbonyl-(C₁-C₆)-alkyl, (C₂-C₆)-alkenylsulfonyl-(C₁-C₆)-alkyl, (C₂-C₆)-alkynylsulfonyl-(C₁-C₆)-alkyl, heteroaryl-(C₁-C₆)-alkylsulfonyl-(C₁-C₆)-alkyl, heterocyclyl-(C₁-C₆)-alkylsulfonyl-(C₁-C₆)-alkyl, (C₂-C₆)-alkenylsulfinyl-(C₁-C₆)-alkyl, (C₂-C₆)-alkynylsulfinyl-(C₁-C₆)-alkyl, heteroaryl-(C₁-C₆)-alkylsulfinyl-(C₁-C₆)-alkyl, heterocyclyl-(C₁-C₆)-alkylsulfinyl-(C₁-C₆)-alkyl, (C₂-C₆)-alkenyloxy-(C₁-C₆)-alkoxy-(C₁-C₆)-alkyl, (C₂-C₆)-alkynyloxy-(C₁-C₆)-alkoxy-(C₁-C₆)-alkyl, heteroaryl-(C₁-C₆)-alkoxy-(C₁-C₆)-alkyl, heterocyclyl-(C₁-C₆)-alkoxy-(C₁-C₆)-alkyl, tris[(C₁-C₆)-alkyl]silyl, tris[(C₁-C₆)-alkyl]silyl-(C₁-C₆)-alkyl, (C₁-C₆)-alkoxy, (C₁-C₆)-haloalkoxy, (C₁-C₆)-alkylamino-(C₁-C₆)-alkyl, bis-[(C₁-C₆)-alkyl]amino-(C₁-C₆)-alkyl, (C₃-C₆)-cycloalkyl[(C₁-C₆)-alkyl]amino-(C₁-C₆)-alkyl, amino-(C₁-C₆)-alkyl, (C₂-C₆)-alkenylamino-(C₁-C₆)-alkyl, (C₂-C₆)-alkynylamino-(C₁-C₆)-alkyl, arylamino-(C₁-C₆)-alkyl, heteroarylamino-(C₁-C₆)-alkyl, aryl-(C₁-C₆)-alkylamino-(C₁-C₆)-alkyl, heteroaryl-(C₁-C₆)-alkylamino-(C₁-C₆)-alkyl, heterocyclylamino-(C₁-C₆)-alkyl, heterocyclyl-(C₁-C₆)-alkylamino-(C₁-C₆)-alkyl, (C₁-C₆)-haloalkoxy-(C₁-C₆)-haloalkyl, (C₂-C₆)-alkenyloxy-(C₁-C₆)-haloalkyl, (C₂-C₆)-alkynyloxy-(C₁-C₆)-haloalkyl, (C₁-C₆)-alkoxy-(C₁-C₆)-alkoxy-(C₁-C₆)-haloalkyl, (C₃-C₆)-cycloalkyl-(C₁-C₆)-alkoxy-(C₁-C₆)-haloalkyl, (C₃-C₆)-cycloalkyl-(C₁-C₆)-alkoxy-(C₁-C₆)-alkyl, (C₁-C₆)-alkoxy-(C₁-C₆)-alkoxy, (C₁-C₆)-alkoxycarbonyl-(C₃-C₆)-cycloalkyl,
R², R³, R⁴ are each independently hydrogen, halogen, (C₁-C₅)-alkoxy, (C₁-C₅)-alkyl, (C₁-C₅)-haloalkyl, (C₁-C₅)-haloalkoxy, (C₁-C₅)-alkylthio, (C₁-C₅)-haloalkylthio, aryl, aryl-(C₁-C₅)-alkyl, heteroaryl, heteroaryl-(C₁-C₅)-alkyl, heterocyclyl, heterocyclyl-(C₁-C₅)-alkyl, (C₃-C₆)-cycloalkyl, nitro, amino, hydroxyl, (C₁-C₅)-alkylamino, bis-[(C₁-C₅)-alkyl]amino, hydrothio, (C₁-C₅)-alkylcarbonylamino, (C₃-C₆)-cycloalkylcarbonylamino, arylcarbonylamino, heteroarylcarbonylamino, heterocyclylcarbonylamino, formyl, hydroxyiminomethyl, (C₁-C₅)-alkoxyiminomethyl, (C₃-C₆)-cycloalkoxyiminomethyl, aryloxyiminomethyl, (C₃-C₆)-cycloalkyl-(C₁-C₅)-alkoxyiminomethyl, thiocyanato, isothiocyanato, aryloxy, heteroaryloxy, (C₃-C₆)-cycloalkoxy, (C₃-C₆)-cycloalkyl-(C₁-C₅)-alkoxy, aryl-(C₁-C₅)-alkoxy, (C₂-C₅)-alkynyl, (C₂-C₅)-alkenyl, aryl-(C₁-C₅)-alkynyl, tris-[(C₁-C₅)-alkyl]silyl-(C₂-C₅)-alkynyl, bis-[(C₁-C₅)-alkyl](aryl)silyl-(C₂-C₅)-alkynyl, bis-aryl[(C₁-C₅)-alkyl]silyl-(C₂-C₅)-alkynyl, (C₃-C₆)-cycloalkyl-(C₂-C₅)-alkynyl, aryl-(C₂-C₅)-alkenyl, heteroaryl-(C₂-C₅)-alkenyl, (C₃-C₆)-cycloalkyl-(C₂-C₅)-alkenyl, (C₂-C₅)-haloalkynyl, (C₂-C₅)-haloalkenyl, (C₄-C₅)-cycloalkenyl, (C₁-C₅)-alkoxy-(C₁-C₅)-alkoxy-(C₁-C₅)-alkyl, (C₁-C₅)-alkylsulfonyl, arylsulfonyl, heteroarylsulfonyl, (C₁-C₅)-alkylsulfonylamino, arylsulfonylamino, aryl-(C₁-C₅)-alkylsulfonylamino, heteroarylsulfonylamino, heteroaryl-(C₁-C₅)-alkylsulfonylamino, bis-[(C₁-C₅)-alkyl]aminosulfonyl,
R⁵ is amino, (C₁-C₅)-alkyl, (C₃-C₆)-cycloalkyl, (C₃-C₆)-cycloalkyl-(C₁-C₅)-alkyl, (C₁-C₅)-haloalkyl, (C₃-C₆)-halocycloalkyl, (C₄-C₆)-cycloalkenyl, aryl, heteroaryl, heterocyclyl, aryl-(C₁-C₅)-alkyl, heteroaryl-(C₁-C₅)-alkyl, heterocyclyl-(C₁-C₅)-alkyl, (C₁-C₅)-alkoxycarbonyl-(C₁-C₅)-alkyl, aryl-(C₁-C₅)-alkoxycarbonyl-(C₁-C₅)-alkyl, (C₃-C₆)-cycloalkoxycarbonyl-(C₁-C₅)-alkyl, (C₃-C₆)-cycloalkyl-(C₁-C₅)-alkoxycarbonyl-(C₁-C₅)-alkyl, heteroaryl-(C₁-C₅)-alkoxycarbonyl-(C₁-C₅)-alkyl, aminocarbonyl-(C₁-C₅)-alkyl, (C₁-C₅)-alkylaminocarbonyl-(C₁-C₅)-alkyl, (C₃-C₆)-cycloalkylaminocarbonyl-(C₁-C₅)-alkyl, aryl-(C₁-C₅)-alkylaminocarbonyl-(C₁-C₅)-alkyl, (C₁-C₅)-alkylamino, arylamino, (C₃-C₆)-cycloalkylamino, aryl-(C₁-C₅)-alkylamino, heteroaryl-(C₁-C₅)-alkylamino, heteroarylamino, heterocyclylamino, aryloxy-(C₁-C₅)-alkyl, (C₁-C₅)-alkoxy-(C₁-C₅)-alkyl, heteroaryloxy-(C₁-C₅)-alkyl, (C₂-C₅)-alkenyl, (C₂-C₅)-alkynyl, (C₂-C₅)-alkenylamino, (C₂-C₅)-alkynylamino, aryloxy, (C₃-C₆)-cycloalkyl-(C₂-C₅)-alkyl, bis-[(C₁-C₅)-alkyl]amino, aryl-(C₂-C₅)-alkenyl, heteroaryl-(C₂-C₅)-alkenyl, heterocyclyl-(C₂-C₅)-alkenyl,
R⁶ is hydrogen, (C₁-C₅)-alkyl, (C₃-C₆)-cycloalkyl, cyano-(C₁-C₅)-alkyl, (C₃-C₆)-cycloalkyl-(C₁-C₅)-alkyl, (C₁-C₅)-alkylsulfonyl, arylsulfonyl, heteroarylsulfonyl, (C₃-C₆)-cycloalkylsulfonyl, heterocyclylsulfonyl, aryl-(C₁-C₅)-alkylsulfonyl, (C₁-C₅)-alkylcarbonyl, arylcarbonyl, heteroarylcarbonyl, (C₃-C₆)-cycloalkylcarbonyl, heterocyclylcarbonyl, (C₁-C₅)-alkoxycarbonyl, aryl-(C₁-C₅)-alkoxycarbonyl, (C₁-C₅)-haloalkylcarbonyl, (C₂-C₅)-alkenyl, (C₂-C₅)-alkynyl, (C₁-C₅)-haloalkyl, halo-(C₂-C₅)-alkynyl, halo-(C₂-C₅)-alkenyl, (C₁-C₅)-alkoxy-(C₁-C₅)-alkyl,
R⁹, R¹⁰ are each independently hydrogen, (C₁-C₆)-alkyl, fluorine, chlorine, bromine, iodine, cyano, (C₁-C₆)-haloalkyl, cyano-(C₁-C₆)-alkyl, aryl, heteroaryl, (C₃-C₆)-cycloalkyl, (C₄-C₆)-cycloalkenyl, heterocyclyl, (C₁-C₆)-alkoxy-(C₁-C₆)-alkyl,
W is oxygen or sulfur, preferably oxygen.

Special preference is given to the inventive use of compounds of the general formula (I) which are described by the formulae (Iaa) to (Ibi)

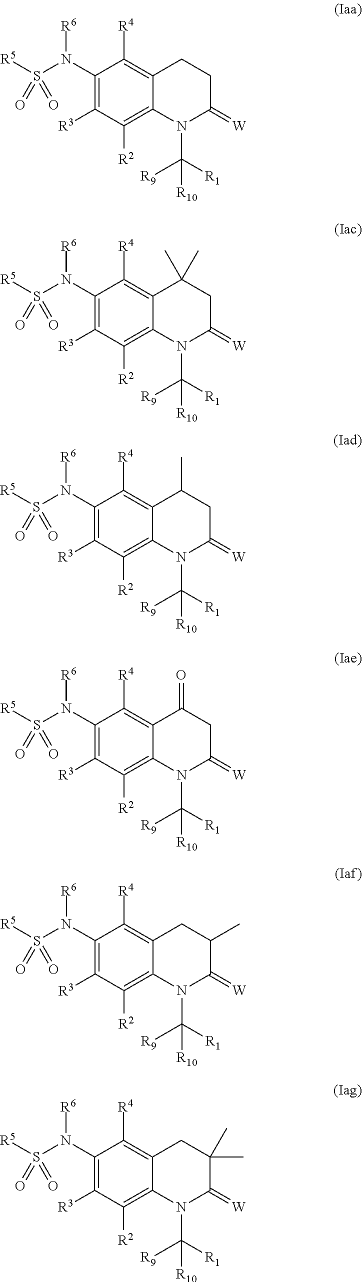

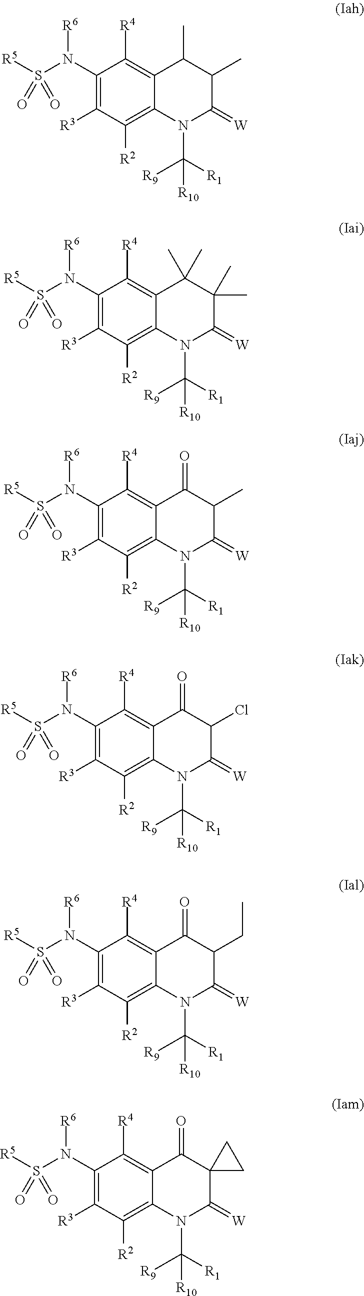

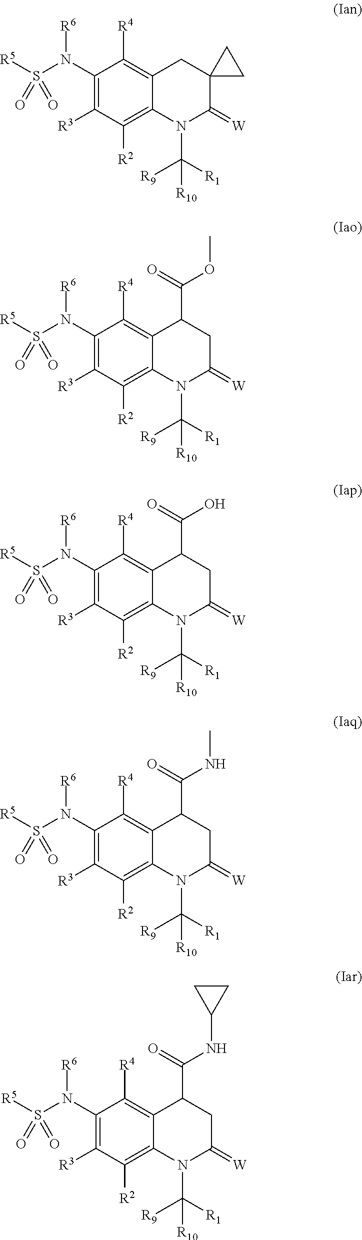

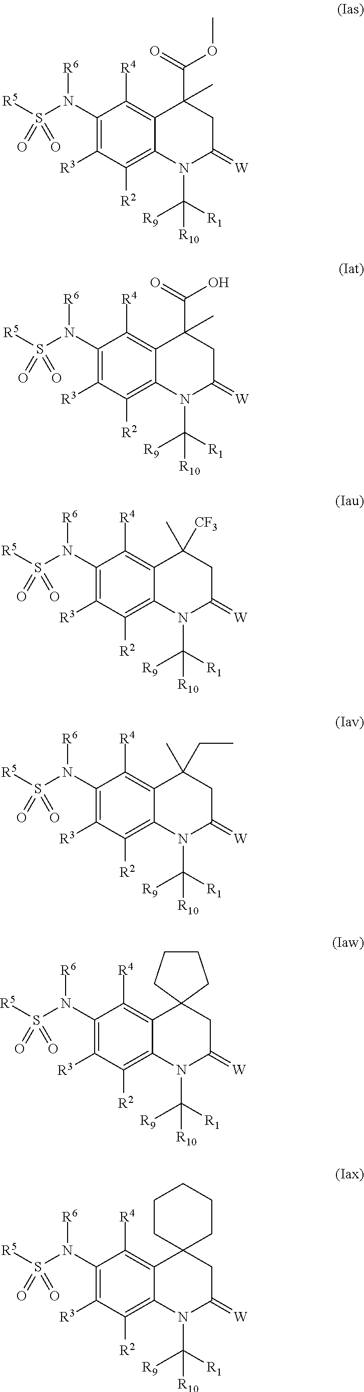

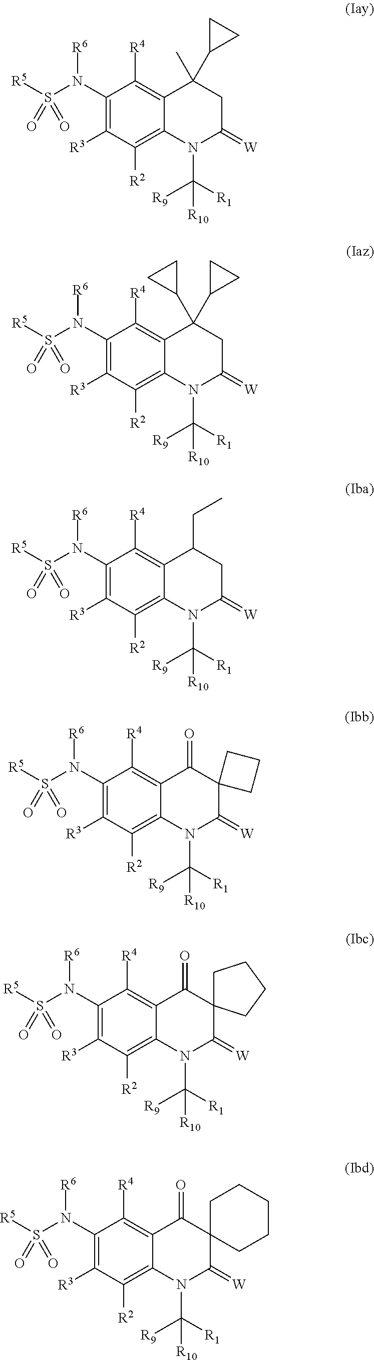

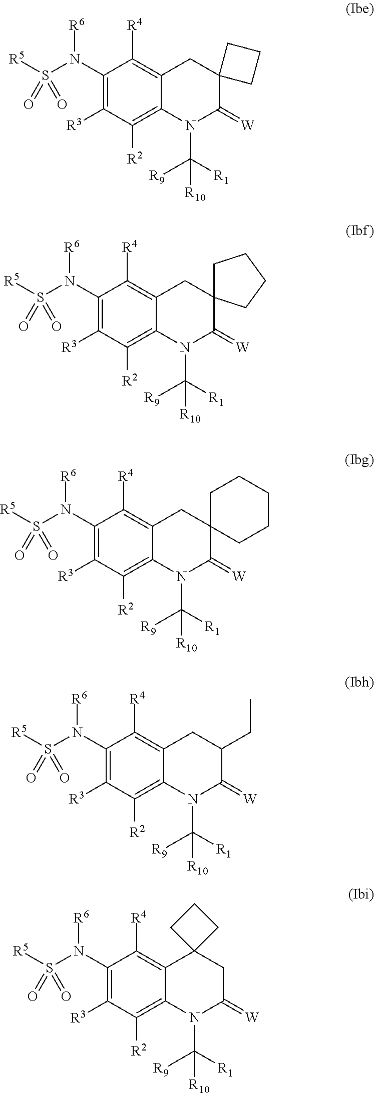

in which
R¹ is fluorine, chlorine, bromine, iodine, preferably fluorine and chlorine, cyano, cyclopropyl, cyclobutyl, cyclopentyl, cyclohexyl, cycloheptyl, cyclooctyl, spiro[2.2]pent-1-yl, spiro[2.3]hex-1-yl, spiro[2.3]hex-4-yl, 3-spiro[2.3]hex-5-yl, spiro[3.3]hept-1-yl, spiro[3.3]hept-2-yl, bicyclo[1.1.0]butan-1-yl, bicyclo[1.1.0]butan-2-yl, bicyclo[2.1.0]pentan-1-yl, bicyclo[1.1.1]pentan-1-yl, bicyclo[2.1.0]pentan-2-yl, bicyclo[2.1.0]pentan-5-yl, bicyclo[2.1.1]hexyl, bicyclo[2.2.1]hept-2-yl, bicyclo[2.2.2]octan-2-yl, bicyclo[3.2.1]octan-2-yl, bicyclo[3.2.2]nonan-2-yl, adamantan-1-yl, adamantan-2-yl, 1-methylcyclopropyl, 2-methylcyclopropyl, 2,2-dimethylcyclopropyl, 2,3-dimethylcyclopropyl, 1,1′-bi(cyclopropyl)-1-yl, 1,1′-bi(cyclopropyl)-2-yl, 2′-methyl-1,1′-bi(cyclopropyl)-2-yl, 1-cyanocyclopropyl, 2-cyanocyclopropyl, 1-methylcyclobutyl, 2-methylcyclobutyl, 3-methylcyclobutyl, 1-cyanocyclobutyl, 2-cyanocyclobutyl, 3-cyanocyclobutyl, 1-allylcyclopropyl, 1-vinylcyclobutyl, 1-vinylcyclopropyl, 1-ethylcyclopropyl, 2-ethylcyclopropyl, 1-ethylcyclobutyl, 2-ethylcyclobutyl, 3-ethylcyclobutyl, 4-methylcyclohexyl, 4-methoxycyclohexyl, 4-ethoxycyclohexyl, 4-n-propyloxycyclohexyl, 4-hydroxycyclohexyl, 4-trifluoromethylcyclohexyl, 4-cyanocyclohexyl, 3-methylcyclohexyl, 3-methoxycyclohexyl, 3-ethoxycyclohexyl, 3-n-propyloxycyclohexyl, 3-hydroxycyclohexyl, 3-methoxycyclobutyl, 2-methoxycyclopropyl, 2-ethoxycyclopropyl, 2-isopropyloxycyclopropyl, 1-cyclopropylcyclobutyl, 1-prop-2-enylcyclobutyl, 2-ethyl-3-methylcyclobutyl, 1-propylcyclopropyl, 1-methyl-2-propylcyclopropyl, 2-propylcyclopropyl, 1-propylcyclobutyl, 2-propylcyclobutyl, 3-propylcyclobutyl, 1-isopropylcyclobutyl, 1-isopropylcyclopropyl, 2-isopropylcyclopropyl, 3-isopropylcyclobutyl, 2-dimethylaminocyclobutyl, 3-dimethylaminocyclobutyl, 1-butylcyclobutyl, 2-butylcyclobutyl, 1-butylcyclopropyl, 3-butylcyclobutyl, 2-butylcyclopropyl, 1-isobutylcyclobutyl, 3-tert-butylcyclobutyl, 3,3-diethylcyclobutyl, 2,2-diethylcyclopropyl, 2-methylidenecyclopropyl, 1-methoxymethylcyclopropyl, 1-isobutylcyclopropyl, cyclopropylmethyl, cyclobutylmethyl, cyclopentylmethyl, cyclohexylmethyl, cyclopropylethyl, cyclobutylethyl, cyclopentylethyl, cyclohexylethyl, cyclopropyl-n-propyl, cyclobutyl-n-propyl, cyclopentyl-n-propyl, cyclohexyl-n-propyl, trichloromethyl, trichloroethyl, iodomethyl, iodoethyl, iodo-n-propyl, bromomethyl, bromoethyl, bromo-n-propyl, trifluoromethyl, difluoromethyl, fluoro-n-propyl, 2-fluoroprop-2-yl, 1-fluoroprop-2-yl, 2,2-difluoroethyl, 2,2,2-trifluoroethyl, 1,1-difluoroethyl, 3,3,3-trifluoropropyl, 4,4,4-trifluorobutyl, 3,3-difluoropropyl, pentafluoroethyl, heptafluoro-n-propyl, heptafluoroisopropyl, nonafluoro-n-butyl, chlorodifluoromethyl, bromodifluoromethyl, dichlorofluoromethyl, bromofluoromethyl, 1-fluoroethyl, 2-fluoroethyl, fluoromethyl, 2,2-dichloro-2-fluoroethyl, 2-chloro-2,2-difluoroethyl, difluoro-tert-butyl, 2-bromo-1,1,2-trifluoroethyl, 1,1,2,2-tetrafluoroethyl, 1,2,2,2-tetrafluoroethyl, 2-chloro-1,1,2-trifluoroethyl, 2-chloro-1,1,2,2-tetrafluoroethyl, 1,2,2,3,3,3-hexafluoropropyl, 1-methyl-2,2,2-trifluoroethyl, 1-chloro-2,2,2-trifluoroethyl, 2,2,3,3,3-pentafluoropropyl, 1,2,2,3,3,4,4,4-octafluorobutyl, 1,1,2,2,3,3,4,4-octafluorobutyl, n-propoxydifluoromethyl, methoxydifluoromethyl, ethoxydifluoromethyl, n-butoxydifluoromethyl, methoxyethoxydifluoromethyl, n-pentoxydifluoromethyl, 2-methylbutoxydifluoromethyl, 4-methylpentoxydifluoromethyl, n-hexyloxydifluoromethyl, isohexyloxydifluoromethyl, allyloxypropoxydifluoromethyl, methoxypropoxydifluoromethyl, cyclopropylmethoxydifluoromethyl, cyclobutylmethoxydifluoromethyl, but-3-yn-1-yloxydifluoromethyl, pent-4-yn-1-yloxydifluoromethyl, hex-3-yn-1-yloxydifluoromethyl, but-3-en-1-yloxydifluoromethyl, 2,2,2-trifluoroethoxydifluoromethyl, 3,3,3-trifluoropropoxydifluoromethyl, 4,4,4-trifluorobutoxydifluoromethyl, 3-chloro-1-methoxybut-3-yl, cyanomethyl, cyanoethyl, cyano-n-propyl, cyano-n-butyl, cyanoisopropyl, methoxymethyl, methoxyethyl, methoxy-n-propyl, methoxyisopropyl, methoxy-n-butyl, methoxy-n-pentyl, 2-methoxy-2-methylpropyl, 2-methoxy-1-methylpropyl, ethoxymethyl, ethoxyethyl, ethoxy-n-propyl, ethoxyisopropyl, ethoxy-n-butyl, ethoxy-n-pentyl, 2-ethoxy-2-methylpropyl, 2-ethoxy-1-methylpropyl, n-propyloxymethyl, n-propyloxyethyl, n-propyloxy-n-propyl, n-propyloxyisopropyl, n-propyloxy-n-butyl, 2-n-propyloxy-2-methylpropyl, 2-n-propyloxy-1-methylpropyl, isopropyloxymethyl, isopropyloxyethyl, isopropyloxy-n-propyl, isopropyloxyisopropyl, isopropyloxy-n-butyl, 2-isopropyloxy-2-methylpropyl, 2-isopropyloxy-1-methylpropyl, methoxymethoxymethyl, methoxymethoxy, ethoxymethoxy, methoxyethoxy, methoxy-n-propyloxy, ethoxy-n-propyloxy, n-propyloxymethoxy, isopropyloxymethoxy, methoxymethoxyethyl, ethoxymethoxymethyl, ethoxyethoxymethyl, methoxyethoxymethyl, methoxyethoxyethyl, methoxyethoxy-n-propyl, methoxymethoxy-n-propyl, methoxy-n-propyloxymethyl, trifluoromethoxymethyl, trifluoromethoxyethyl, trifluoromethoxy-n-propyl, trifluoromethoxyisopropyl, difluoromethoxymethyl, difluoromethoxyethyl, difluoromethoxy-n-propyl, difluoromethoxyisopropyl, pentafluoroethoxymethyl, pentafluoroethoxyethyl, pentafluoroethoxy-n-propyl, pentafluoroethoxyisopropyl, 1,1,2,2-tetrafluoroethoxymethyl, 1,1,2,2-tetrafluoroethoxyethyl, 1,1,2,2-tetrafluoroethoxy-n-propyl, 1,1,2,2-tetrafluoroethoxyisopropyl, 1,2,2,2-tetrafluoroethoxymethyl, 1,2,2,2-tetrafluoroethoxyethyl, 1,2,2,2-tetrafluoroethoxy-n-propyl, 1,2,2,2-tetrafluoroethoxyisopropyl, 2,2,2-trifluoroethoxymethyl, 2,2,2-trifluoroethoxyethyl, 2,2,2-trifluoroethoxy-n-propyl, 2,2,2-trifluoroethoxyisopropyl, 2,2-difluoroethoxymethyl, 2,2-difluoroethoxyethyl, 2,2-difluoroethoxy-n-propyl, 2,2-difluoroethoxyisopropyl, heptafluoropropoxymethyl, heptafluoropropoxyethyl, heptafluoropropoxy-n-propyl, heptafluoropropoxyisopropyl, trifluoromethylthiomethyl, trifluoromethylthioethyl, trifluoromethylthio-n-propyl, trifluoromethylthioisopropyl, difluoromethylthiomethyl, difluoromethylthioethyl, difluoromethylthio-n-propyl, difluoromethylthioisopropyl, pentafluoroethylthiomethyl, pentafluoroethylthioethyl, pentafluoroethylthio-n-propyl, pentafluoroethylthioisopropyl, 1,1,2,2-tetrafluoroethylthiomethyl, 1,1,2,2-tetrafluoroethylthioethyl, 1,1,2,2-tetrafluoroethylthio-n-propyl, 1,1,2,2-tetrafluoroethylthioisopropyl, 1,2,2,2-tetrafluoroethylthiomethyl, 1,2,2,2-tetrafluoroethylthioethyl, 1,2,2,2-tetrafluoroethylthio-n-propyl, 1,2,2,2-tetrafluoroethylthioisopropyl, 2,2,2-trifluoroethylthiomethyl, 2,2,2-trifluoroethylthioethyl, 2,2,2-trifluoroethylthio-n-propyl, 2,2,2-trifluoroethylthioisopropyl, 2,2-difluoroethylthiomethyl, 2,2-difluoroethylthioethyl, 2,2-difluoroethylthio-n-propyl, 2,2-difluoroethylthioisopropyl, heptafluoropropylthiomethyl, heptafluoropropylthioethyl, heptafluoropropylthio-n-propyl, heptafluoropropylthioisopropyl, (C₄-C₈)-halocycloalkenyl, (C₄-C₈)-cycloalkenyl, (C₃-C₈)-halocycloalkyl, (C₂-C₆)-haloalkenyl, optionally substituted phenyl, aryl-(C₁-C₅)-alkyl, heteroaryl, heteroaryl-(C₁-C₅)-alkyl, (C₂-C₅)-haloalkynyl, heterocyclyl, heterocyclyl-(C₁-C₅)-alkyl, methylcarbonylmethyl, methylcarbonylethyl, ethylcarbonylmethyl, ethylcarbonylethyl, n-propylcarbonylmethyl, n-propylcarbonylethyl, isopropylcarbonylmethyl, isopropylcarbonylethyl, hydroxycarbonylmethyl, 1-hydroxycarbonyleth-1-yl, 1-hydroxycarbonyleth-2-yl, hydroxycarbonyl-n-propyl, 2-hydroxycarbonylprop-2-yl, 1-hydroxycarbonylprop-2-yl, 2-hydroxycarbonylprop-1-yl, hydroxycarbonyl-n-butyl, hydroxycarbonylisobutyl, methoxycarbonylmethyl, 1-methoxycarbonyleth-1-yl, 1-methoxycarbonyleth-2-yl, methoxycarbonyl-n-propyl, 2-methoxycarbonylprop-2-yl, 1-methoxycarbonylprop-2-yl, 2-methoxycarbonylprop-1-yl, methoxycarbonyl-n-butyl, methoxycarbonylisobutyl, ethoxycarbonylmethyl, 1-ethoxycarbonyleth-1-yl, 1-ethoxycarbonyleth-2-yl, ethoxycarbonyl-n-propyl, 2-ethoxycarbonylprop-2-yl, 1-ethoxycarbonylprop-2-yl, 2-ethoxycarbonylprop-1-yl, ethoxycarbonyl-n-butyl, ethoxycarbonylisobutyl, isopropyloxycarbonylmethyl, 1-isopropyloxycarbonyleth-1-yl, 1-isopropyloxycarbonyleth-2-yl, isopropyloxycarbonyl-n-propyl, 2-isopropyloxycarbonylprop-2-yl, 1-isopropyloxycarbonylprop-2-yl, 2-isopropyloxycarbonylprop-1-yl, isopropyloxycarbonyl-n-butyl, isopropyloxycarbonylisobutyl, n-propyloxycarbonylmethyl, 1-n-propyloxycarbonyleth-1-yl, 1-n-propyloxycarbonyleth-2-yl, n-propyloxycarbonyl-n-propyl, 2-n-propyloxycarbonylprop-2-yl, 1-n-propyloxycarbonylprop-2-yl, 2-n-propyloxycarbonylprop-1-yl, n-propyloxycarbonyl-n-butyl, n-propyloxycarbonylisobutyl, tert-butyloxycarbonylmethyl, tert-butyloxycarbonylethyl, tert-butyloxycarbonyl-n-propyl, tert-butyloxycarbonylisopropyl, benzyloxycarbonylmethyl, benzyloxycarbonylethyl, benzyloxycarbonyl-n-propyl, benzyloxycarbonylisopropyl, allyloxycarbonylmethyl, allyloxycarbonylethyl, allyloxycarbonyl-n-propyl, methoxycarbonyl, ethoxycarbonyl, n-propyloxycarbonyl, isopropyloxycarbonyl, n-butyloxycarbonyl, tert-butyloxycarbonyl, methylcarbonyl, ethylcarbonyl, n-propylcarbonyl, isopropylcarbonyl, tert-butylcarbonyl, (C₂-C₅)-alkynyloxycarbonyl-(C₁-C₅)-alkyl, (C₃-C₆)-cycloalkoxycarbonyl-(C₁-C₅)-alkyl, (C₃-C₆)-cycloalkyl-(C₁-C₅)-alkoxycarbonyl-(C₁-C₅)-alkyl, aminocarbonyl-(C₁-C₅)-alkyl, (C₁-C₅)-alkylaminocarbonyl-(C₁-C₅)-alkyl, (C₃-C₆)-cycloalkylaminocarbonyl-(C₁-C₅)-alkyl, aryl-(C₁-C₅)-alkylaminocarbonyl-(C₁-C₅)-alkyl, heteroaryl-(C₁-C₅)-alkylaminocarbonyl-(C₁-C₅)-alkyl, (C₁-C₅)-haloalkylcarbonyl, (C₃-C₆)-cycloalkylcarbonyl, aryl-(C₁-C₅)-alkoxycarbonyl, arylcarbonyl, heteroarylcarbonyl, heterocyclylcarbonyl, aryl-(C₁-C₆)-alkylcarbonyl, (C₁-C₆)-alkylaminocarbonyl, (C₃-C₆)-cycloalkylaminocarbonyl, arylaminocarbonyl, aryl-(C₁-C₆)-alkylaminocarbonyl, heteroarylaminocarbonyl, heterocyclylaminocarbonyl, heteroaryl-(C₁-C₆)-alkylaminocarbonyl, heterocyclyl-(C₁-C₆)-alkylaminocarbonyl, (C₁-C₆)-alkylsulfonyl, (C₃-C₆)-cycloalkylsulfonyl, arylsulfonyl, aryl-(C₁-C₆)-alkylsulfonyl, heteroarylsulfonyl, heterocyclylsulfonyl, dimethylamino, diethylamino, methyl(ethyl)amino, methyl(n-propyl)amino, methyl(isopropyl)amino, dimethylaminomethyl, diethylaminomethyl, methyl(ethyl)aminomethyl, methyl(n-propyl)aminomethyl, methyl(isopropyl)aminomethyl, dimethylaminoethyl, diethylaminoethyl, methyl(ethyl)aminoethyl, methyl(n-propyl)aminoethyl, methyl(isopropyl)aminoethyl, dimethylamino-n-propyl, dimethylaminoisopropyl, diethylamino-n-propyl, diethylaminoisopropyl, 1-dimethylaminoprop-2-yl, 1-diethylaminoprop-2-yl, trimethylsilylmethyl, trimethylsilylethyl, trimethylsilyl-n-propyl, triethylsilylmethyl, triethylsilylethyl, triethylsilyl-n-propyl, tris[isopropyl]silylmethyl, tris[isopropyl]silylethyl, tris[isopropyl]silyl-n-propyl, methylthiomethyl, ethylthiomethyl, ethylthioethyl, n-propylthiomethyl, n-propylthioethyl, methylthioethyl, methylthio-n-propyl, 2-ethoxycarbonylcycloprop-1-yl, 2-methoxycarbonylcycloprop-1-yl, methoxy, ethoxy, n-propyloxy, isopropyloxy, tert-butyloxy, n-butyloxy, isobutyloxy,
R², R³, R⁴ are each independently hydrogen, fluorine, chlorine, bromine, iodine, preferably fluorine and chlorine, methoxy, ethoxy, n-propyloxy, isopropyloxy, methyl, ethyl, isopropyl, trifluoromethyl, difluoromethyl, pentafluoroethyl, trifluoromethoxy, difluoromethoxy, 2,2-difluoroethoxy, 3,3,3-trifluoroethoxy, methylthio, ethylthio, trifluoromethylthio, optionally substituted phenyl, benzyl, phenylethyl, p-chlorophenylethyl, heteroaryl, heterocyclyl, cyclopropyl, cyclobutyl, nitro, hydroxyl, dimethylamino, diethylamino, formyl, hydroxyiminomethyl, methoxyiminomethyl, ethoxyiminomethyl, cyclopropylmethoxymethyl, phenyloxy, p-chlorophenyloxy, p-trifluoromethylphenyloxy, m-chlorophenyloxy, m-trifluoromethylphenyloxy, 2,4-dichlorophenyloxy, heteroaryloxy, benzyloxy, ethynyl, prop-1-ynyl, (C₂-C₅)-alkenyl, phenylethynyl, p-chlorophenylethynyl, p-trifluoromethylphenylethynyl, p-methoxyphenylethynyl, p-fluorophenylethynyl, m-chlorophenylethynyl, m-trifluoromethylphenylethynyl, m-methoxyphenylethynyl, m-fluorophenylethynyl, trimethylsilylethynyl, triethylsilylethynyl, triisopropylsilylethynyl, 2-pyridylethynyl, 3-pyridylethynyl, 4-chloro-3-pyridylethynyl,
R⁵ is amino, methyl, ethyl, propyl, 1-methylethyl, butyl, 1-methylpropyl, 2-methylpropyl, 1,1-dimethylethyl, pentyl, 1-methylbutyl, 2-methylbutyl, 3-methylbutyl, 1,1-dimethylpropyl, 1,2-dimethylpropyl, 2,2-dimethylpropyl, 1-ethylpropyl, hexyl, 1-methylpentyl, 2-methylpentyl, 3-methylpentyl, 4-methylpentyl, 1,1-dimethylbutyl, 1,2-dimethylbutyl, 1,3-di-methylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl and 1-ethyl-2-methylpropyl, cyclopropyl, cyclobutyl, cyclopentyl, cyclohexyl, cyclopropylmethyl, cyclobutylmethyl, cyclopentylmethyl, cyclohexylmethyl, trifluoromethyl, difluoromethyl, 2,2-difluoroethyl, 2,2,2-trifluoroethyl, 3,3,3-trifluoropropyl, pentafluoroethyl, heptafluoro-n-propyl, heptafluoroisopropyl, nonafluoro-n-butyl, (C₃-C₆)-halocycloalkyl, (C₄-C₆)-cycloalkenyl, optionally substituted phenyl, heteroaryl, heterocyclyl, aryl-(C₁-C₅)-alkyl, heteroaryl-(C₁-C₅)-alkyl, heterocyclyl-(C₁-C₅)-alkyl, (C₁-C₅)-alkoxycarbonyl-(C₁-C₅)-alkyl, aryl-(C₁-C₅)-alkoxycarbonyl-(C₁-C₅)-alkyl, (C₃-C₆)-cycloalkoxycarbonyl-(C₁-C₅)-alkyl, (C₃-C₆)-cycloalkyl-(C₁-C₅)-alkoxycarbonyl-(C₁-C₅)-alkyl, heteroaryl-(C₁-C₅)-alkoxycarbonyl-(C₁-C₅)-alkyl, aminocarbonyl-(C₁-C₅)-alkyl, (C₁-C₅)-alkylaminocarbonyl-(C₁-C₅)-alkyl, (C₃-C₆)-cycloalkylaminocarbonyl-(C₁-C₅)-alkyl, aryl-(C₁-C₅)-alkylaminocarbonyl-(C₁-C₅)-alkyl, (C₁-C₅)-alkylamino, arylamino, (C₃-C₆)-cycloalkylamino, aryl-(C₁-C₅)-alkylamino, heteroaryl-(C₁-C₅)-alkylamino, heteroarylamino, heterocyclylamino, aryloxy-(C₁-C₅)-alkyl, (C₁-C₅)-alkoxy-(C₁-C₅)-alkyl, heteroaryloxy-(C₁-C₅)-alkyl, (C₂-C₅)-alkenyl, (C₂-C₅)-alkynyl, (C₂-C₅)-alkenylamino, (C₂-C₅)-alkynylamino, aryloxy, bis-[(C₁-C₅)-alkyl]amino, aryl-(C₂-C₅)-alkenyl, heteroaryl-(C₂-C₅)-alkenyl, heterocyclyl-(C₂-C₅)-alkenyl,
R⁶ is hydrogen, methyl, ethyl, isopropyl, n-propyl, n-butyl, isobutyl, tert-butyl, n-pentyl, isopentyl, neopentyl, n-hexyl, cyclopropyl, cyclobutyl, cyclopentyl, cyclohexyl, cyclopropylmethyl, cyclobutylmethyl, cyclopentylmethyl, cyclohexylmethyl, cyanomethyl, cyanoethyl, cyano-n-propyl, (C₁-C₅)-alkylsulfonyl, arylsulfonyl, heteroarylsulfonyl, (C₃-C₆)-cycloalkylsulfonyl, heterocyclylsulfonyl, aryl-(C₁-C₅)-alkylsulfonyl, (C₁-C₅)-alkylcarbonyl, arylcarbonyl, heteroarylcarbonyl, (C₃-C₆)-cycloalkylcarbonyl, heterocyclylcarbonyl, (C₁-C₅)-alkoxycarbonyl, aryl-(C₁-C₅)-alkoxycarbonyl, (C₁-C₅)-haloalkylcarbonyl, (C₂-C₅)-alkenyl, (C₂-C₅)-alkynyl, 2,2-difluoroethyl, 2,2,2-trifluoroethyl, 3,3,3-trifluoropropyl, halo-(C₂-C₅)-alkynyl, halo-(C₂-C₅)-alkenyl, (C₁-C₅)-alkoxy-(C₁-C₅)-alkyl,
R⁹, R¹⁰ are each independently hydrogen, methyl, ethyl, n-propyl, isopropyl, n-butyl, sec-butyl, tert-butyl, n-pentyl, isopentyl, neopentyl, fluorine, chlorine, bromine, iodine, preferably fluorine and chlorine, cyano, trifluoromethyl, difluoromethyl, pentafluoroethyl, 1,1,2,2-difluoroethyl, 2,2-difluoroethyl, 3,3,3-trifluoroethyl, cyanomethyl, cyanoethyl, cyano-n-propyl, cyanoisopropyl, optionally substituted phenyl, heteroaryl, cyclopropyl, cyclobutyl, cyclopentyl, cyclohexyl, cycloheptyl, (C₄-C₈)-cycloalkenyl, heterocyclyl, methoxymethyl, methoxyethyl, ethoxymethyl, ethoxyethyl, methylthiomethyl, ethylthiomethyl, methylthioethyl, ethylthioethyl and
W is oxygen or sulfur, preferably oxygen.

Very special preference is given to the inventive use of compounds of the general formula (I) which are described by the formulae (Iaa), (Iac), (Iad), (Iaf), (Iag), (Ian), (Iau) to (Iaz) and (Ibi)

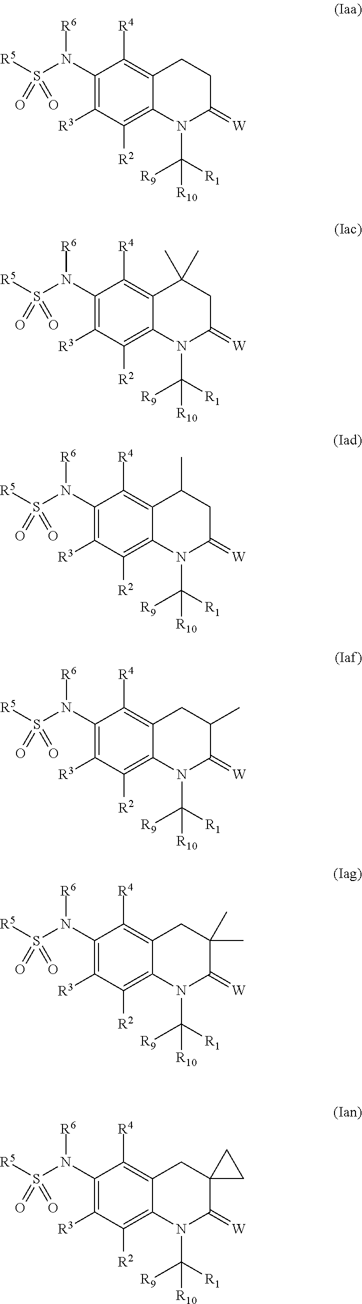

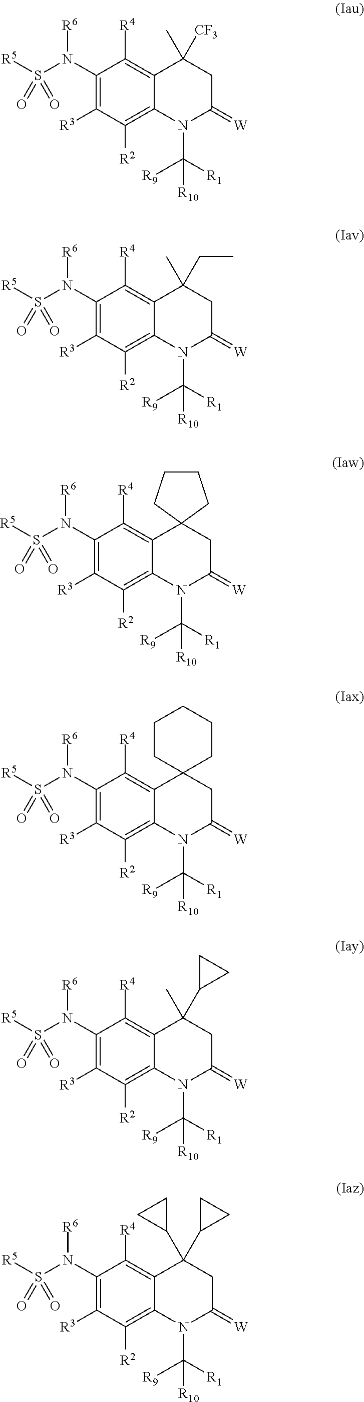

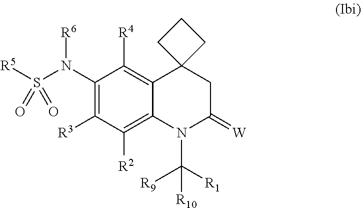

in which
R¹ is cyano, cyclopropyl, cyclobutyl, cyclopentyl, cyclohexyl, adamantan-1-yl, adamantan-2-yl, difluoromethyl, trifluoromethyl, fluoromethyl, 2-fluoroethyl, 2-fluoroprop-2-yl, 1,1-difluoroethyl, 2,2,2-trifluoroethyl, 3,3,3-trifluoropropyl, 1,1,2,2-tetrafluoroethyl, pentafluoroethyl, 2,2,3,3,3-pentafluoropropyl, heptafluoropropyl, nonafluorobutyl, cyanomethyl, cyanoeth-1-yl, cyanoeth-2-yl, cyano-n-propyl, cyano-n-butyl, cyanoisopropyl, 1-methylcyclopropan-1-yl, 2-methylcyclopropan-1-yl, 2,2-dimethylcyclopropyl, 2,3-dimethylcyclopropyl, 1,1′-bi(cyclopropyl)-1-yl, 1,1′-bi(cyclopropyl)-2-yl, 2′-methyl-1,1′-bi(cyclopropyl)-2-yl, 1-cyanocyclopropyl, 2-cyanocyclopropyl, 1-methylcyclobutyl, 2-methylcyclobutyl, 3-methylcyclobutyl, 1-cyanocyclobutyl, 2-cyanocyclobutyl, 3-cyanocyclobutyl, 1-ethylcyclopropyl, 2-ethylcyclopropyl, 1-ethylcyclobutyl, 2-ethylcyclobutyl, 3-ethylcyclobutyl, 4-methylcyclohexyl, 4-methoxycyclohexyl, 2-ethoxycarbonylcyclop-1-yl, 2-methoxycarbonylcyclop-1-yl, 2-tetrahydrofuryl, 3-tetrahydrofuryl, 2,2-dichlorocyclopropyl, tetrahydro-2H-pyran-4-yl, 2-ethoxycarbonylcyclopropyl, 2,2-difluorocyclopropyl, 2,2,3,3-tetrafluoropropyl, methoxymethyl, methoxyethyl, ethoxymethyl, trimethylsilylmethyl, trifluoromethoxymethyl, trifluoromethylthiomethyl, pentafluoroethoxymethyl, pentafluoroethylthiomethyl, methoxyethoxymethyl, methoxycarbonyl, ethoxycarbonyl, methoxycarbonylmethyl, ethoxycarbonylmethyl, cyclopropylmethyl, cyclobutylmethyl, cyclopentylmethyl, cyclohexylmethyl, cyclopropylethyl, cyclobutylethyl, cyclopentylethyl, cyclohexylethyl, methoxy, ethoxy, n-propyloxy,
R², R³, R⁴ are each independently hydrogen, fluorine, chlorine, methoxy, ethoxy, methyl, ethyl, trifluoromethyl, optionally substituted phenyl,
R⁵ is amino, methyl, ethyl, propyl, 1-methylethyl, butyl, 1-methylpropyl, 2-methylpropyl, 1,1-dimethylethyl, pentyl, 1-methylbutyl, 2-methylbutyl, 3-methylbutyl, 1,1-dimethylpropyl, 1,2-dimethylpropyl, 2,2-dimethylpropyl, 1-ethylpropyl, hexyl, 1-methylpentyl, 2-methylpentyl, 3-methylpentyl, 4-methylpentyl, 1,1-dimethylbutyl, 1,2-dimethylbutyl, 1,3-di-methylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl and 1-ethyl-2-methylpropyl, cyclopropyl, cyclobutyl, cyclopentyl, cyclohexyl, cyclopropylmethyl, cyclobutylmethyl, cyclopentylmethyl, cyclohexylmethyl, trifluoromethyl, difluoromethyl, 2,2-difluoroethyl, 2,2,2-trifluoroethyl, 3,3,3-trifluoropropyl, pentafluoroethyl, heptafluoro-n-propyl, heptafluoroisopropyl, nonafluoro-n-butyl, (C₃-C₆)-halocycloalkyl, (C₄-C₆)-cycloalkenyl, optionally substituted phenyl, heteroaryl, heterocyclyl, aryl-(C₁-C₅)-alkyl, heteroaryl-(C₁-C₅)-alkyl, heterocyclyl-(C₁-C₅)-alkyl, (C₁-C₅)-alkoxycarbonyl-(C₁-C₅)-alkyl, aryl-(C₁-C₅)-alkoxycarbonyl-(C₁-C₅)-alkyl, (C₃-C₆)-cycloalkoxycarbonyl-(C₁-C₅)-alkyl, (C₃-C₆)-cycloalkyl-(C₁-C₅)-alkoxycarbonyl-(C₁-C₅)-alkyl, heteroaryl-(C₁-C₅)-alkoxycarbonyl-(C₁-C₅)-alkyl, aminocarbonyl-(C₁-C₅)-alkyl, (C₁-C₅)-alkylaminocarbonyl-(C₁-C₅)-alkyl, (C₃-C₆)-cycloalkylaminocarbonyl-(C₁-C₅)-alkyl, aryl-(C₁-C₅)-alkylaminocarbonyl-(C₁-C₅)-alkyl, (C₁-C₅)-alkylamino, arylamino, (C₃-C₆)-cycloalkylamino, aryl-(C₁-C₅)-alkylamino, heteroaryl-(C₁-C₅)-alkylamino, heteroarylamino, heterocyclylamino, aryloxy-(C₁-C₅)-alkyl, (C₁-C₅)-alkoxy-(C₁-C₅)-alkyl, heteroaryloxy-(C₁-C₅)-alkyl, (C₂-C₅)-alkenyl, (C₂-C₅)-alkynyl, (C₂-C₅)-alkenylamino, (C₂-C₅)-alkynylamino, aryloxy, bis-[(C₁-C₅)-alkyl]amino, aryl-(C₂-C₅)-alkenyl, heteroaryl-(C₂-C₅)-alkenyl, heterocyclyl-(C₂-C₅)-alkenyl,
R⁶ is hydrogen, methyl, ethyl, isopropyl, n-propyl, n-butyl, isobutyl, tert-butyl, n-pentyl, isopentyl, neopentyl, n-hexyl, cyclopropyl, cyclobutyl, cyclopentyl, cyclohexyl, cyclopropylmethyl, cyclobutylmethyl, cyclopentylmethyl, cyclohexylmethyl, cyanomethyl, cyanoethyl, cyano-n-propyl, (C₁-C₅)-alkylsulfonyl, arylsulfonyl, heteroarylsulfonyl, (C₃-C₆)-cycloalkylsulfonyl, heterocyclylsulfonyl, aryl-(C₁-C₅)-alkylsulfonyl, (C₁-C₅)-alkylcarbonyl, arylcarbonyl, heteroarylcarbonyl, (C₃-C₆)-cycloalkylcarbonyl, heterocyclylcarbonyl, (C₁-C₅)-alkoxycarbonyl, aryl-(C₁-C₅)-alkoxycarbonyl, (C₁-C₅)-haloalkylcarbonyl, (C₂-C₅)-alkenyl, (C₂-C₅)-alkynyl, 2,2-difluoroethyl, 2,2,2-trifluoroethyl, 3,3,3-trifluoropropyl, halo-(C₂-C₅)-alkynyl, halo-(C₂-C₅)-alkenyl, (C₁-C₅)-alkoxy-(C₁-C₅)-alkyl,
R⁹, R¹⁰ are each independently hydrogen, methyl, ethyl, n-propyl, isopropyl, n-butyl, tert-butyl, fluorine, chlorine, cyano, trifluoromethyl, difluoromethyl, pentafluoroethyl, cyanomethyl, cyanoethyl, cyano-n-propyl, optionally substituted phenyl, heteroaryl, cyclopropyl, cyclobutyl, heterocyclyl, methoxymethyl, methoxyethyl, ethoxymethyl, ethoxyethyl, methylthiomethyl, ethylthiomethyl, methylthioethyl, ethylthioethyl and
W is oxygen or sulfur, preferably oxygen.

The abovementioned general or preferred radical definitions apply both to the end products of the general formula (I) and, correspondingly, to the starting materials or the intermediates required in each case for the preparation. These radical definitions can be combined with one another as desired, i.e. including combinations between the given preferred ranges.

The substituted oxotetrahydroquinolinylsulfonamides of the general formula (I) mentioned above are substantially likewise as yet unknown in the prior art. Thus, a further part of the invention is formed by oxotetrahydroquinolinylsulfonamides of the general formula (I), or salts thereof,

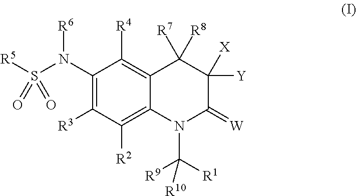

in which
R¹ is halogen, cyano, (C₃-C₁₀)-cycloalkyl, (C₃-C₁₀)-halocycloalkyl, (C₄-C₁₀)-cycloalkenyl, (C₄-C₁₀)-halocycloalkenyl, (C₁-C₁₀)-haloalkyl, (C₁-C₈)-alkoxy-(C₁-C₈)-haloalkyl, (C₃-C₈)-cycloalkyl-(C₁-C₈)-alkyl, (C₁-C₈)-alkylcarbonyl-(C₁-C₅)-alkyl, hydroxycarbonyl-(C₁-C₈)-alkyl, (C₁-C₈)-alkoxycarbonyl-(C₁-C₈)-alkyl, (C₂-C₈)-alkenyloxycarbonyl-(C₁-C₈)-alkyl, (C₂-C₈)-alkynyloxycarbonyl-(C₁-C₈)-alkyl, aryl-(C₁-C₈)-alkoxycarbonyl-(C₁-C₈)-alkyl, (C₃-C₈)-cycloalkoxycarbonyl-(C₁-C₈)-alkyl, (C₃-C₈)-cycloalkyl-(C₁-C₈)-alkoxycarbonyl-(C₁-C₈)-alkyl, aminocarbonyl-(C₁-C₈)-alkyl, (C₁-C₈)-alkylaminocarbonyl-(C₁-C₈)-alkyl, (C₃-C₈)-cycloalkylaminocarbonyl-(C₁-C₈)-alkyl, aryl-(C₁-C₈)-alkylaminocarbonyl-(C₁-C₈)-alkyl, heteroaryl-(C₁-C₈)-alkylaminocarbonyl-(C₁-C₈)-alkyl, (C₁-C₈)-alkylthio-(C₁-C₈)-alkyl, (C₃-C₈)-cycloalkylthio-(C₁-C₈)-alkyl, arylthio-(C₁-C₈)-alkyl, heterocyclylthio-(C₁-C₈)-alkyl, heteroarylthio-(C₁-C₈)-alkyl, aryl-(C₁-C₈)-alkylthio-(C₁-C₈)-alkyl, (C₁-C₈)-alkylsulfinyl-(C₁-C₈)-alkyl, (C₁-C₈)-alkylsulfonyl-(C₁-C₈)-alkyl, arylsulfinyl-(C₁-C₈)-alkyl, arylsulfonyl-(C₁-C₈)-alkyl, (C₃-C₈)-cycloalkylsulfinyl-(C₁-C₈)-alkyl, (C₃-C₈)-cycloalkylsulfonyl-(C₁-C₈)-alkyl, (C₁-C₈)-alkoxy-(C₁-C₈)-alkoxy-(C₁-C₈)-alkyl, (C₁-C₈)-alkylcarbonyl, (C₁-C₈)-haloalkylcarbonyl, (C₃-C₈)-cycloalkylcarbonyl, hydroxycarbonyl, (C₁-C₈)-alkoxycarbonyl, (C₂-C₈)-alkenyloxycarbonyl, (C₂-C₈)-alkynyloxycarbonyl, aryl-(C₁-C₈)-alkoxycarbonyl, (C₃-C₈)-cycloalkyl-(C₁-C₈)-alkoxycarbonyl, arylcarbonyl, heteroarylcarbonyl, heterocyclylcarbonyl, aryl-(C₁-C₈)-alkylcarbonyl, (C₁-C₈)-alkylaminocarbonyl, (C₃-C₈)-cycloalkylaminocarbonyl, arylaminocarbonyl, aryl-(C₁-C₈)-alkylaminocarbonyl, heteroarylaminocarbonyl, heterocyclylaminocarbonyl, heteroaryl-(C₁-C₈)-alkylaminocarbonyl, heterocyclyl-(C₁-C₈)-alkylaminocarbonyl, (C₁-C₈)-alkylsulfonyl, (C₃-C₈)-cycloalkylsulfonyl, arylsulfonyl, aryl-(C₁-C₈)-alkylsulfonyl, heteroarylsulfonyl, heterocyclylsulfonyl, cyano-(C₁-C₈)-alkyl, (C₄-C₆)-cycloalkenyl-(C₁-C₈)-alkyl, nitro-(C₁-C₈)-alkyl, (C₁-C₈)-haloalkoxy-(C₁-C₈)-alkyl, (C₁-C₈)-haloalkylthio-(C₁-C₈)-alkyl, bis-[(C₁-C₈)-alkyl]aminocarbonyl, (C₃-C₈)-cycloalkyl-[(C₁-C₈)-alkyl]aminocarbonyl, aryl-[(C₁-C₈)-alkyl]aminocarbonyl, aryl-(C₁-C₈)-alkyl-[(C₁-C₈)-alkyl]aminocarbonyl, (C₂-C₈)-alkenylaminocarbonyl, (C₂-C₈)-alkynylaminocarbonyl, (C₁-C₈)-alkylaminosulfonyl, bis-[(C₁-C₈)-alkyl]aminosulfonyl, heterocyclylsulfinyl-(C₁-C₈)-alkyl, heteroarylsulfinyl-(C₁-C₈)-alkyl, aryl-(C₁-C₈)-alkylsulfinyl-(C₁-C₈)-alkyl, heterocyclylsulfonyl-(C₁-C₈)-alkyl, heteroarylsulfonyl-(C₁-C₈)-alkyl, aryl-(C₁-C₈)-alkylsulfonyl-(C₁-C₈)-alkyl, bis-[(C₁-C₈)-alkyl]aminocarbonyl-(C₁-C₈)-alkyl, (C₃-C₈)-cycloalkyl-[(C₁-C₈)-alkyl]aminocarbonyl-(C₁-C₈)-alkyl, aryl-[(C₁-C₈)-alkyl]aminocarbonyl-(C₁-C₈)-alkyl, aryl-(C₁-C₈)-alkyl-[(C₁-C₈)-alkyl]aminocarbonyl-(C₁-C₈)-alkyl, (C₂-C₈)-alkenylaminocarbonyl-(C₁-C₈)-alkyl, (C₂-C₈)-alkynylaminocarbonyl-(C₁-C₈)-alkyl, (C₁-C₈)-alkylamino, bis-[(C₁-C₈)-alkyl]amino, (C₃-C₈)-cycloalkyl[(C₁-C₈)-alkyl]amino, amino, (C₂-C₈)-alkenylamino, (C₂-C₈)-alkynylamino, arylamino, heteroarylamino, aryl-(C₁-C₈)-alkylamino, heteroaryl-(C₁-C₈)-alkylamino, heterocyclylamino, heterocyclyl-(C₁-C₈)-alkylamino, (C₂-C₈)-alkenylcarbonyl-(C₁-C₈)-alkyl, (C₂-C₈)-alkynylcarbonyl-(C₁-C₈)-alkyl, (C₃-C₈)-cycloalkyl-(C₁-C₈)-alkylaminocarbonyl-(C₁-C₈)-alkyl, (C₃-C₈)-cycloalkyl-(C₁-C₈)-alkyl-[(C₁-C₈)-alkyl]aminocarbonyl-(C₁-C₈)-alkyl, (C₂-C₈)-alkenylsulfonyl-(C₁-C₈)-alkyl, (C₂-C₈)-alkynylsulfonyl-(C₁-C₈)-alkyl, heteroaryl-(C₁-C₈)-alkylsulfonyl-(C₁-C₈)-alkyl, heterocyclyl-(C₁-C₈)-alkylsulfonyl-(C₁-C₈)-alkyl, (C₂-C₈)-alkenylsulfinyl-(C₁-C₈)-alkyl, (C₂-C₈)-alkynylsulfinyl-(C₁-C₈)-alkyl, heteroaryl-(C₁-C₈)-alkylsulfinyl-(C₁-C₈)-alkyl, heterocyclyl-(C₁-C₈)-alkylsulfinyl-(C₁-C₈)-alkyl, (C₂-C₈)-alkenyloxy-(C₁-C₈)-alkoxy-(C₁-C₈)-alkyl, (C₂-C₈)-alkynyloxy-(C₁-C₈)-alkoxy-(C₁-C₈)-alkyl, heteroaryl-(C₁-C₈)-alkoxy-(C₁-C₈)-alkyl, heterocyclyl-(C₁-C₈)-alkoxy-(C₁-C₈)-alkyl, tris[(C₁-C₈)-alkyl]silyl, tris[(C₁-C₈)-alkyl]silyl-(C₁-C₈)-alkyl, (C₁-C₈)-alkoxy, (C₁-C₈)-haloalkoxy, (C₁-C₈)-alkylamino-(C₁-C₈)-alkyl, bis-[(C₁-C₈)-alkyl]amino-(C₁-C₈)-alkyl, (C₃-C₈)-cycloalkyl[(C₁-C₈)-alkyl]amino-(C₁-C₈)-alkyl, amino-(C₁-C₈)-alkyl, (C₂-C₈)-alkenylamino-(C₁-C₈)-alkyl, (C₂-C₈)-alkynylamino-(C₁-C₈)-alkyl, arylamino-(C₁-C₈)-alkyl, heteroarylamino-(C₁-C₈)-alkyl, aryl-(C₁-C₈)-alkylamino-(C₁-C₈)-alkyl, heteroaryl-(C₁-C₈)-alkylamino-(C₁-C₈)-alkyl, heterocyclylamino-(C₁-C₈)-alkyl, heterocyclyl-(C₁-C₈)-alkylamino-(C₁-C₈)-alkyl, (C₁-C₈)-haloalkoxy-(C₁-C₆)-haloalkyl, (C₂-C₈)-alkenyloxy-(C₁-C₆)-haloalkyl, (C₂-C₈)-alkynyloxy-(C₁-C₆)-haloalkyl, (C₁-C₈)-alkoxy-(C₁-C₈)-alkoxy-(C₁-C₆)-haloalkyl, (C₃-C₈)-cycloalkyl-(C₁-C₈)-alkoxy-(C₁-C₆)-haloalkyl, (C₃-C₈)-cycloalkyl-(C₁-C₈)-alkoxy-(C₁-C₈)-alkyl, (C₁-C₈)-alkoxy-(C₁-C₈)-alkoxy, (C₁-C₈)-alkoxycarbonyl-(C₃-C₈)-cycloalkyl,
R², R³, R⁴ are each independently hydrogen, halogen, (C₁-C₈)-alkoxy, (C₁-C₈)-alkyl, (C₁-C₈)-haloalkyl, (C₁-C₈)-haloalkoxy, (C₁-C₈)-alkylthio, (C₁-C₈)-haloalkylthio, aryl, aryl-(C₁-C₈)-alkyl, heteroaryl, heteroaryl-(C₁-C₈)-alkyl, heterocyclyl, heterocyclyl-(C₁-C₈)-alkyl, (C₃-C₈)-cycloalkyl, nitro, amino, hydroxyl, (C₁-C₈)-alkylamino, bis-[(C₁-C₈)-alkyl]amino, hydrothio, (C₁-C₈)-alkylcarbonylamino, (C₃-C₈)-cycloalkylcarbonylamino, arylcarbonylamino, heteroarylcarbonylamino, heterocyclylcarbonylamino, formyl, hydroxyiminomethyl, (C₁-C₈)-alkoxyiminomethyl, (C₃-C₈)-cycloalkoxyiminomethyl, aryloxyiminomethyl, (C₃-C₈)-cycloalkyl-(C₁-C₈)-alkoxyiminomethyl, thiocyanato, isothiocyanato, aryloxy, heteroaryloxy, (C₃-C₈)-cycloalkoxy, (C₃-C₈)-cycloalkyl-(C₁-C₈)-alkoxy, aryl-(C₁-C₈)-alkoxy, (C₂-C₈)-alkynyl, (C₂-C₈)-alkenyl, aryl-(C₁-C₈)-alkynyl, tris-[(C₁-C₈)-alkyl]silyl-(C₂-C₈)-alkynyl, bis-[(C₁-C₈)-alkyl](aryl)silyl-(C₂-C₈)-alkynyl, bis-aryl[(C₁-C₈)-alkyl]silyl-(C₂-C₈)-alkynyl, (C₃-C₈)-cycloalkyl-(C₂-C₈)-alkynyl, aryl-(C₂-C₈)-alkenyl, heteroaryl-(C₂-C₈)-alkenyl, (C₃-C₈)-cycloalkyl-(C₂-C₈)-alkenyl, (C₃-C₈)-cycloalkyl-(C₂-C₈)-alkyl, (C₂-C₈)-haloalkynyl, (C₂-C₈)-haloalkenyl, (C₄-C₈)-cycloalkenyl, (C₁-C₈)-alkoxy-(C₁-C₈)-alkoxy-(C₁-C₈)-alkyl, (C₁-C₈)-alkylsulfonyl, arylsulfonyl, heteroarylsulfonyl, (C₁-C₈)-alkylsulfonylamino, arylsulfonylamino, aryl-(C₁-C₈)-alkylsulfonylamino, heteroarylsulfonylamino, heteroaryl-(C₁-C₈)-alkylsulfonylamino, bis-[(C₁-C₈)-alkyl]aminosulfonyl,
R⁵ is amino, (C₁-C₈)-alkyl, (C₃-C₈)-cycloalkyl, (C₃-C₈)-cycloalkyl-(C₁-C₈)-alkyl, (C₁-C₈)-haloalkyl, (C₃-C₈)-halocycloalkyl, (C₄-C₈)-cycloalkenyl, aryl, heteroaryl, heterocyclyl, aryl-(C₁-C₈)-alkyl, heteroaryl-(C₁-C₈)-alkyl, heterocyclyl-(C₁-C₈)-alkyl, (C₁-C₈)-alkoxycarbonyl-(C₁-C₈)-alkyl, aryl-(C₁-C₈)-alkoxycarbonyl-(C₁-C₈)-alkyl, (C₃-C₈)-cycloalkoxycarbonyl-(C₁-C₈)-alkyl, (C₃-C₈)-cycloalkyl-(C₁-C₈)-alkoxycarbonyl-(C₁-C₈)-alkyl, heteroaryl-(C₁-C₈)-alkoxycarbonyl-(C₁-C₈)-alkyl, aminocarbonyl-(C₁-C₈)-alkyl, (C₁-C₈)-alkylaminocarbonyl-(C₁-C₈)-alkyl, (C₃-C₈)-cycloalkylaminocarbonyl-(C₁-C₈)-alkyl, aryl-(C₁-C₈)-alkylaminocarbonyl-(C₁-C₈)-alkyl, (C₁-C₈)-alkylamino, bis-[(C₁-C₈)-alkyl]amino, arylamino, (C₃-C₈)-cycloalkylamino, aryl-(C₁-C₈)-alkylamino, heteroaryl-(C₁-C₈)-alkylamino, heteroarylamino, heterocyclylamino, (C₂-C₈)-alkenylamino, (C₂-C₈)-alkynylamino, aryloxy-(C₁-C₈)-alkyl, heteroaryloxy-(C₁-C₈)-alkyl, (C₁-C₈)-alkoxy-(C₁-C₈)-alkyl, (C₂-C₈)-alkenyl, (C₂-C₈)-alkynyl, cyano-(C₁-C₈)-alkyl, aryloxy, aryl-(C₂-C₈)-alkenyl, heteroaryl-(C₂-C₈)-alkenyl, heterocyclyl-(C₂-C₈)-alkenyl,
R⁶ is hydrogen, (C₁-C₈)-alkyl, (C₃-C₈)-cycloalkyl, cyano-(C₁-C₈)-alkyl, (C₃-C₈)-cycloalkyl-(C₁-C₈)-alkyl, (C₁-C₈)-alkylsulfonyl, arylsulfonyl, aryl-(C₁-C₈)-alkylsulfonyl, heteroarylsulfonyl, (C₃-C₈)-cycloalkylsulfonyl, heterocyclylsulfonyl, (C₁-C₈)-alkylcarbonyl, arylcarbonyl, heteroarylcarbonyl, (C₃-C₈)-cycloalkylcarbonyl, heterocyclylcarbonyl, (C₁-C₈)-alkoxycarbonyl, aryl-(C₁-C₈)-alkoxycarbonyl, (C₁-C₈)-haloalkylcarbonyl, (C₂-C₈)-alkenyl, (C₂-C₈)-alkynyl, (C₁-C₈)-haloalkyl, aryl-(C₂-C₈)-alkenyl, halo-(C₂-C₈)-alkynyl, halo-(C₂-C₈)-alkenyl, (C₁-C₈)-alkoxy-(C₁-C₈)-alkyl,
R⁷, R⁸ are each independently hydrogen, hydroxyl, amino, (C₁-C₈)-alkylamino, bis[(C₁-C₈)-alkyl]amino, (C₃-C₈)-cycloalkylamino, (C₁-C₈)-alkyl, fluorine, chlorine, bromine, iodine, (C₂-C₈)-alkenyl, (C₂-C₈)-alkynyl, (C₁-C₈)-haloalkyl, hydroxy-(C₁-C₈)-alkyl, cyano-(C₁-C₈)-alkyl, nitro-(C₁-C₈)-alkyl, aryl, heteroaryl, (C₃-C₈)-cycloalkyl, (C₄-C₈)-cycloalkenyl, heterocyclyl, (C₁-C₈)-alkoxy, (C₁-C₈)-haloalkoxy, (C₁-C₈)-alkoxy-(C₁-C₈)-alkyl, (C₁-C₈)-alkylthio-(C₁-C₈)-alkyl, amino-(C₁-C₈)-alkyl, (C₁-C₈)-alkylamino-(C₁-C₈)-alkyl, (C₃-C₈)-cycloalkylamino-(C₁-C₈)-alkyl, aryl-(C₁-C₈)-alkylamino-(C₁-C₈)-alkyl, heteroaryl-(C₁-C₈)-alkylamino-(C₁-C₈)-alkyl, heterocyclyl-(C₁-C₈)-alkylamino-(C₁-C₈)-alkyl, heterocyclylamino-(C₁-C₈)-alkyl, heteroarylamino-(C₁-C₈)-alkyl, (C₁-C₈)-alkoxycarbonylamino-(C₁-C₈)-alkyl, arylamino-(C₁-C₈)-alkyl, aryl-(C₁-C₈)-alkoxycarbonylamino-(C₁-C₈)-alkyl, (C₃-C₈)-cycloalkoxycarbonylamino-(C₁-C₈)-alkyl, (C₃-C₈)-cycloalkyl-(C₁-C₈)-alkoxycarbonylamino-(C₁-C₈)-alkyl, heteroaryl-(C₁-C₈)-alkoxycarbonylamino-(C₁-C₈)-alkyl, (C₁-C₈)-alkylcarbonylamino-(C₁-C₈)-alkyl, (C₃-C₈)-cycloalkylcarbonylamino-(C₁-C₈)-alkyl, arylcarbonylamino-(C₁-C₈)-alkyl, heteroarylcarbonylamino-(C₁-C₈)-alkyl, heterocyclylcarbonylamino-(C₁-C₈)-alkyl, (C₂-C₈)-alkenyloxycarbonylamino-(C₁-C₈)-alkyl, aryl-(C₂-C₈)-alkenylamino-(C₁-C₈)-alkyl, hydroxycarbonyl, (C₁-C₈)-alkoxycarbonyl, (C₂-C₈)-alkenyloxycarbonyl, aryl-(C₁-C₈)-alkoxycarbonyl, aminocarbonyl, alkylaminocarbonyl, (C₃-C₈)-cycloalkylaminocarbonyl, aryl-(C₁-C₈)-alkylaminocarbonyl, heteroarylaminocarbonyl or
R⁷ and R⁸ together with the carbon atom to which they are bonded form a fully saturated or partly saturated 3- to 7-membered monocyclic or bicyclic ring optionally interrupted by heteroatoms and optionally having further substitution or
R⁷ and R⁸ together with the carbon atom to which they are bonded form an oxo group or
R⁷ and R⁸ together with the carbon atom to which they are bonded form an oxime group substituted by hydrogen, (C₁-C₈)-alkyl, (C₃-C₈)-cycloalkyl, (C₃-C₈)-cycloalkyl-(C₁-C₈)-alkyl, aryl, heteroaryl, aryl-(C₁-C₈)-alkyl, heteroaryl-(C₁-C₈)-alkyl,
R⁹, R¹⁰ are each independently hydrogen, (C₁-C₈)-alkyl, halogen, cyano, (C₁-C₈)-haloalkyl, cyano-(C₁-C₈)-alkyl, aryl, heteroaryl, (C₃-C₈)-cycloalkyl, (C₄-C₈)-cycloalkenyl, heterocyclyl, (C₁-C₈)-alkoxy-(C₁-C₈)-alkyl, (C₁-C₈)-alkylthio-(C₁-C₈)-alkyl,
W is oxygen or sulfur and
X, Y are each independently hydrogen, (C₁-C₈)-alkyl, halogen, (C₂-C₈)-alkenyl, (C₂-C₈)-alkynyl, (C₁-C₈)-haloalkyl, hydroxy-(C₁-C₈)-alkyl, cyano-(C₁-C₈)-alkyl, aryl, heteroaryl, (C₃-C₈)-cycloalkyl, (C₄-C₈)-cycloalkenyl, heterocyclyl, cyano, nitro, hydroxyl, (C₁-C₈)-alkoxy, (C₁-C₈)-alkylthio, (C₁-C₈)-alkoxy-(C₁-C₈)-alkyl, (C₁-C₈)-alkylthio-(C₁-C₈)-alkyl, aryloxy, aryl-(C₁-C₈)-alkoxy, (C₁-C₈)-haloalkoxy, (C₁-C₈)-haloalkylthio, (C₁-C₈)-alkylamino, bis[(C₁-C₈)-alkyl]amino, (C₁-C₈)-alkoxy-(C₁-C₈)-alkoxy, amino-(C₁-C₈)-alkyl, (C₁-C₈)-alkylamino-(C₁-C₈)-alkyl, (C₃-C₈)-cycloalkylamino-(C₁-C₈)-alkyl, aryl-(C₁-C₈)-alkylamino-(C₁-C₈)-alkyl, heteroaryl-(C₁-C₈)-alkylamino-(C₁-C₈)-alkyl, heterocyclyl-(C₁-C₈)-alkylamino-(C₁-C₈)-alkyl, heterocyclylamino-(C₁-C₈)-alkyl, heteroarylamino-(C₁-C₈)-alkyl, (C₁-C₈)-alkoxycarbonylamino-(C₁-C₈)-alkyl, arylamino-(C₁-C₈)-alkyl, aryl-(C₁-C₈)-alkoxycarbonylamino-(C₁-C₈)-alkyl, (C₃-C₈)-cycloalkoxycarbonylamino-(C₁-C₈)-alkyl, (C₃-C₈)-cycloalkyl-(C₁-C₈)-alkoxycarbonylamino-(C₁-C₈)-alkyl, heteroaryl-(C₁-C₈)-alkoxycarbonylamino-(C₁-C₈)-alkyl, (C₁-C₈)-alkylcarbonylamino-(C₁-C₈)-alkyl, (C₃-C₈)-cycloalkylcarbonylamino-(C₁-C₈)-alkyl, arylcarbonylamino-(C₁-C₈)-alkyl, heteroarylcarbonylamino-(C₁-C₈)-alkyl, heterocyclylcarbonylamino-(C₁-C₈)-alkyl, (C₂-C₆)-alkenyloxycarbonylamino-(C₁-C₈)-alkyl, aryl-(C₂-C₈)-alkenylamino-(C₁-C₈)-alkyl or
X and Y together with the atom to which they are bonded form a fully saturated or partly saturated 3- to 7-membered monocyclic or bicyclic ring optionally interrupted by heteroatoms and optionally having further substitution.

Preferred subject matter of the invention are compounds of the general formula (I) in which
R¹ is halogen, cyano, (C₃-C₁₀)-cycloalkyl, (C₃-C₁₀)-halocycloalkyl, (C₄-C₁₀)-cycloalkenyl, (C₄-C₁₀)-halocycloalkenyl, (C₁-C₁₀)-haloalkyl, (C₁-C₇)-alkoxy-(C₁-C₇)-haloalkyl, (C₃-C₇)-cycloalkyl-(C₁-C₇)-alkyl, (C₁-C₇)-alkylcarbonyl-(C₁-C₇)-alkyl, hydroxycarbonyl-(C₁-C₇)-alkyl, (C₁-C₇)-alkoxycarbonyl-(C₁-C₇)-alkyl, (C₂-C₇)-alkenyloxycarbonyl-(C₁-C₇)-alkyl, (C₂-C₇)-alkynyloxycarbonyl-(C₁-C₇)-alkyl, aryl-(C₁-C₇)-alkoxycarbonyl-(C₁-C₇)-alkyl, (C₃-C₇)-cycloalkoxycarbonyl-(C₁-C₇)-alkyl, (C₃-C₇)-cycloalkyl-(C₁-C₇)-alkoxycarbonyl-(C₁-C₇)-alkyl, aminocarbonyl-(C₁-C₇)-alkyl, (C₁-C₇)-alkylaminocarbonyl-(C₁-C₇)-alkyl, (C₃-C₇)-cycloalkylaminocarbonyl-(C₁-C₇)-alkyl, aryl-(C₁-C₇)-alkylaminocarbonyl-(C₁-C₇)-alkyl, heteroaryl-(C₁-C₇)-alkylaminocarbonyl-(C₁-C₇)-alkyl, (C₁-C₇)-alkylthio-(C₁-C₇)-alkyl, (C₃-C₇)-cycloalkylthio-(C₁-C₇)-alkyl, arylthio-(C₁-C₇)-alkyl, heterocyclylthio-(C₁-C₇)-alkyl, heteroarylthio-(C₁-C₇)-alkyl, aryl-(C₁-C₇)-alkylthio-(C₁-C₇)-alkyl, (C₁-C₇)-alkylsulfinyl-(C₁-C₇)-alkyl, (C₁-C₇)-alkylsulfonyl-(C₁-C₇)-alkyl, arylsulfinyl-(C₁-C₇)-alkyl, arylsulfonyl-(C₁-C₇)-alkyl, (C₃-C₇)-cycloalkylsulfinyl-(C₁-C₇)-alkyl, (C₃-C₇)-cycloalkylsulfonyl-(C₁-C₇)-alkyl, (C₁-C₇)-alkoxy-(C₁-C₇)-alkoxy-(C₁-C₇)-alkyl, (C₁-C₇)-alkylcarbonyl, (C₁-C₇)-haloalkylcarbonyl, (C₃-C₇)-cycloalkylcarbonyl, hydroxycarbonyl, (C₁-C₇)-alkoxycarbonyl, (C₂-C₇)-alkenyloxycarbonyl, (C₂-C₇)-alkynyloxycarbonyl, aryl-(C₁-C₇)-alkoxycarbonyl, (C₃-C₇)-cycloalkyl-(C₁-C₇)-alkoxycarbonyl, arylcarbonyl, heteroarylcarbonyl, heterocyclylcarbonyl, aryl-(C₁-C₇)-alkylcarbonyl, (C₁-C₇)-alkylaminocarbonyl, (C₃-C₇)-cycloalkylaminocarbonyl, arylaminocarbonyl, aryl-(C₁-C₇)-alkylaminocarbonyl, heteroarylaminocarbonyl, heterocyclylaminocarbonyl, heteroaryl-(C₁-C₇)-alkylaminocarbonyl, heterocyclyl-(C₁-C₇)-alkylaminocarbonyl, (C₁-C₇)-alkylsulfonyl, (C₃-C₇)-cycloalkylsulfonyl, arylsulfonyl, aryl-(C₁-C₇)-alkylsulfonyl, heteroarylsulfonyl, heterocyclylsulfonyl, cyano-(C₁-C₇)-alkyl, (C₄-C₇)-cycloalkenyl-(C₁-C₇)-alkyl, nitro-(C₁-C₇)-alkyl, (C₁-C₇)-haloalkoxy-(C₁-C₇)-alkyl, (C₁-C₇)-haloalkylthio-(C₁-C₇)-alkyl, bis-[(C₁-C₇)-alkyl]aminocarbonyl, (C₃-C₇)-cycloalkyl-[(C₁-C₇)-alkyl]aminocarbonyl, aryl-[(C₁-C₇)-alkyl]aminocarbonyl, aryl-(C₁-C₇)-alkyl-[(C₁-C₇)-alkyl]aminocarbonyl, (C₂-C₇)-alkenylaminocarbonyl, (C₂-C₇)-alkynylaminocarbonyl, (C₁-C₇)-alkylaminosulfonyl, bis-[(C₁-C₇)-alkyl]aminosulfonyl, heterocyclylsulfinyl-(C₁-C₇)-alkyl, heteroarylsulfinyl-(C₁-C₇)-alkyl, aryl-(C₁-C₇)-alkylsulfinyl-(C₁-C₇)-alkyl, heterocyclylsulfonyl-(C₁-C₇)-alkyl, heteroarylsulfonyl-(C₁-C₇)-alkyl, aryl-(C₁-C₇)-alkylsulfonyl-(C₁-C₇)-alkyl, bis-[(C₁-C₇)-alkyl]aminocarbonyl-(C₁-C₇)-alkyl, (C₃-C₇)-cycloalkyl-[(C₁-C₇)-alkyl]aminocarbonyl-(C₁-C₇)-alkyl, aryl-[(C₁-C₇)-alkyl]aminocarbonyl-(C₁-C₇)-alkyl, aryl-(C₁-C₇)-alkyl-[(C₁-C₇)-alkyl]aminocarbonyl-(C₁-C₇)-alkyl, (C₂-C₇)-alkenylaminocarbonyl-(C₁-C₇)-alkyl, (C₂-C₇)-alkynylaminocarbonyl-(C₁-C₇)-alkyl, (C₁-C₇)-alkylamino, bis-[(C₁-C₇)-alkyl]amino, (C₃-C₇)-cycloalkyl[(C₁-C₇)-alkyl]amino, amino, (C₂-C₇)-alkenylamino, (C₂-C₇)-alkynylamino, arylamino, heteroarylamino, aryl-(C₁-C₇)-alkylamino, heteroaryl-(C₁-C₇)-alkylamino, heterocyclylamino, heterocyclyl-(C₁-C₇)-alkylamino, (C₂-C₇)-alkenylcarbonyl-(C₁-C₇)-alkyl, (C₂-C₇)-alkynylcarbonyl-(C₁-C₇)-alkyl, (C₃-C₇)-cycloalkyl-(C₁-C₇)-alkylaminocarbonyl-(C₁-C₇)-alkyl, (C₃-C₇)-cycloalkyl-(C₁-C₇)-alkyl-[(C₁-C₇)-alkyl]aminocarbonyl-(C₁-C₇)-alkyl, (C₂-C₇)-alkenylsulfonyl-(C₁-C₇)-alkyl, (C₂-C₇)-alkynylsulfonyl-(C₁-C₇)-alkyl, heteroaryl-(C₁-C₇)-alkylsulfonyl-(C₁-C₇)-alkyl, heterocyclyl-(C₁-C₇)-alkylsulfonyl-(C₁-C₇)-alkyl, (C₂-C₇)-alkenylsulfinyl-(C₁-C₇)-alkyl, (C₂-C₇)-alkynylsulfinyl-(C₁-C₇)-alkyl, heteroaryl-(C₁-C₇)-alkylsulfinyl-(C₁-C₇)-alkyl, heterocyclyl-(C₁-C₇)-alkylsulfinyl-(C₁-C₇)-alkyl, (C₂-C₇)-alkenyloxy-(C₁-C₇)-alkoxy-(C₁-C₇)-alkyl, (C₂-C₇)-alkynyloxy-(C₁-C₇)-alkoxy-(C₁-C₇)-alkyl, heteroaryl-(C₁-C₇)-alkoxy-(C₁-C₇)-alkyl, heterocyclyl-(C₁-C₇)-alkoxy-(C₁-C₇)-alkyl, tris[(C₁-C₇)-alkyl]silyl, tris[(C₁-C₇)-alkyl]silyl-(C₁-C₇)-alkyl, (C₁-C₇)-alkoxy, (C₁-C₇)-haloalkoxy, (C₁-C₇)-alkylamino-(C₁-C₇)-alkyl, bis-[(C₁-C₇)-alkyl]amino-(C₁-C₇)-alkyl, (C₃-C₇)-cycloalkyl[(C₁-C₇)-alkyl]amino-(C₁-C₇)-alkyl, amino-(C₁-C₇)-alkyl, (C₂-C₇)-alkenylamino-(C₁-C₇)-alkyl, (C₂-C₇)-alkynylamino-(C₁-C₇)-alkyl, arylamino-(C₁-C₇)-alkyl, heteroarylamino-(C₁-C₇)-alkyl, aryl-(C₁-C₇)-alkylamino-(C₁-C₇)-alkyl, heteroaryl-(C₁-C₇)-alkylamino-(C₁-C₇)-alkyl, heterocyclylamino-(C₁-C₇)-alkyl, heterocyclyl-(C₁-C₇)-alkylamino-(C₁-C₇)-alkyl, (C₁-C₇)-haloalkoxy-(C₁-C₆)-haloalkyl, (C₂-C₇)-alkenyloxy-(C₁-C₆)-haloalkyl, (C₂-C₇)-alkynyloxy-(C₁-C₆)-haloalkyl, (C₁-C₇)-alkoxy-(C₁-C₇)-alkoxy-(C₁-C₆)-haloalkyl, (C₃-C₇)-cycloalkyl-(C₁-C₇)-alkoxy-(C₁-C₆)-haloalkyl, (C₃-C₇)-cycloalkyl-(C₁-C₇)-alkoxy-(C₁-C₇)-alkyl, (C₁-C₇)-alkoxy-(C₁-C₇)-alkoxy, (C₁-C₇)-alkoxycarbonyl-(C₃-C₇)-cycloalkyl,
R², R³, R⁴ are each independently hydrogen, halogen, (C₁-C₇)-alkoxy, (C₁-C₇)-alkyl, (C₁-C₇)-haloalkyl, (C₁-C₇)-haloalkoxy, (C₁-C₇)-alkylthio, (C₁-C₇)-haloalkylthio, aryl, aryl-(C₁-C₇)-alkyl, heteroaryl, heteroaryl-(C₁-C₇)-alkyl, heterocyclyl, heterocyclyl-(C₁-C₇)-alkyl, (C₃-C₇)-cycloalkyl, nitro, amino, hydroxyl, (C₁-C₇)-alkylamino, bis-[(C₁-C₇)-alkyl]amino, hydrothio, (C₁-C₇)-alkylcarbonylamino, (C₃-C₇)-cycloalkylcarbonylamino, arylcarbonylamino, heteroarylcarbonylamino, heterocyclylcarbonylamino, formyl, hydroxyiminomethyl, (C₁-C₇)-alkoxyiminomethyl, (C₃-C₇)-cycloalkoxyiminomethyl, aryloxyiminomethyl, (C₃-C₇)-cycloalkyl-(C₁-C₇)-alkoxyiminomethyl, thiocyanato, isothiocyanato, aryloxy, heteroaryloxy, (C₃-C₇)-cycloalkoxy, (C₃-C₇)-cycloalkyl-(C₁-C₇)-alkoxy, aryl-(C₁-C₇)-alkoxy, (C₂-C₇)-alkynyl, (C₂-C₇)-alkenyl, aryl-(C₁-C₇)-alkynyl, tris-[(C₁-C₇)-alkyl]silyl-(C₂-C₇)-alkynyl, bis-[(C₁-C₇)-alkyl](aryl)silyl-(C₂-C₇)-alkynyl, bis-aryl[(C₁-C₇)-alkyl]silyl-(C₂-C₇)-alkynyl, (C₃-C₇)-cycloalkyl-(C₂-C₇)-alkynyl, aryl-(C₂-C₇)-alkenyl, heteroaryl-(C₂-C₇)-alkenyl, (C₃-C₇)-cycloalkyl-(C₂-C₇)-alkenyl, (C₃-C₇)-cycloalkyl-(C₂-C₇)-alkyl, (C₂-C₇)-haloalkynyl, (C₂-C₇)-haloalkenyl, (C₄-C₇)-cycloalkenyl, (C₁-C₇)-alkoxy-(C₁-C₇)-alkoxy-(C₁-C₇)-alkyl, (C₁-C₇)-alkylsulfonyl, arylsulfonyl, heteroarylsulfonyl, (C₁-C₇)-alkylsulfonylamino, arylsulfonylamino, aryl-(C₁-C₇)-alkylsulfonylamino, heteroarylsulfonylamino, heteroaryl-(C₁-C₇)-alkylsulfonylamino, bis-[(C₁-C₇)-alkyl]aminosulfonyl,
R⁵ is amino, (C₁-C₇)-alkyl, (C₃-C₇)-cycloalkyl, (C₃-C₇)-cycloalkyl-(C₁-C₇)-alkyl, (C₁-C₇)-haloalkyl, (C₃-C₇)-halocycloalkyl, (C₄-C₇)-cycloalkenyl, aryl, heteroaryl, heterocyclyl, aryl-(C₁-C₇)-alkyl, heteroaryl-(C₁-C₇)-alkyl, heterocyclyl-(C₁-C₇)-alkyl, (C₁-C₇)-alkoxycarbonyl-(C₁-C₇)-alkyl, aryl-(C₁-C₇)-alkoxycarbonyl-(C₁-C₇)-alkyl, (C₃-C₇)-cycloalkoxycarbonyl-(C₁-C₇)-alkyl, (C₃-C₇)-cycloalkyl-(C₁-C₇)-alkoxycarbonyl-(C₁-C₇)-alkyl, heteroaryl-(C₁-C₇)-alkoxycarbonyl-(C₁-C₇)-alkyl, aminocarbonyl-(C₁-C₇)-alkyl, (C₁-C₇)-alkylaminocarbonyl-(C₁-C₇)-alkyl, (C₃-C₇)-cycloalkylaminocarbonyl-(C₁-C₇)-alkyl, aryl-(C₁-C₇)-alkylaminocarbonyl-(C₁-C₇)-alkyl, (C₁-C₇)-alkylamino, bis-[(C₁-C₇)-alkyl]amino, arylamino, (C₃-C₇)-cycloalkylamino, aryl-(C₁-C₇)-alkylamino, heteroaryl-(C₁-C₇)-alkylamino, heteroarylamino, heterocyclylamino, (C₂-C₇)-alkenylamino, (C₂-C₇)-alkynylamino, aryloxy-(C₁-C₇)-alkyl, heteroaryloxy-(C₁-C₇)-alkyl, (C₁-C₇)-alkoxy-(C₁-C₇)-alkyl, (C₂-C₇)-alkenyl, (C₂-C₇)-alkynyl, cyano-(C₁-C₇)-alkyl, aryloxy, aryl-(C₂-C₇)-alkenyl, heteroaryl-(C₂-C₇)-alkenyl, heterocyclyl-(C₂-C₇)-alkenyl,
R⁶ is hydrogen, (C₁-C₇)-alkyl, (C₃-C₇)-cycloalkyl, cyano-(C₁-C₇)-alkyl, (C₃-C₇)-cycloalkyl-(C₁-C₇)-alkyl, (C₁-C₇)-alkylsulfonyl, arylsulfonyl, aryl-(C₁-C₇)-alkylsulfonyl, heteroarylsulfonyl, (C₃-C₇)-cycloalkylsulfonyl, heterocyclylsulfonyl, (C₁-C₇)-alkylcarbonyl, arylcarbonyl, heteroarylcarbonyl, (C₃-C₇)-cycloalkylcarbonyl, heterocyclylcarbonyl, (C₁-C₇)-alkoxycarbonyl, aryl-(C₁-C₇)-alkoxycarbonyl, (C₁-C₇)-haloalkylcarbonyl, (C₂-C₇)-alkenyl, (C₂-C₇)-alkynyl, (C₁-C₇)-haloalkyl, aryl-(C₂-C₇)-alkenyl, halo-(C₂-C₇)-alkynyl, halo-(C₂-C₇)-alkenyl, (C₁-C₇)-alkoxy-(C₁-C₇)-alkyl,
R⁷, R⁸ are each independently hydrogen, hydroxyl, amino, (C₁-C₇)-alkylamino, bis[(C₁-C₇)-alkyl]amino, (C₃-C₇)-cycloalkylamino, (C₁-C₇)-alkyl, fluorine, chlorine, bromine, iodine, (C₂-C₇)-alkenyl, (C₂-C₇)-alkynyl, (C₁-C₇)-haloalkyl, hydroxy-(C₁-C₇)-alkyl, cyano-(C₁-C₇)-alkyl, nitro-(C₁-C₇)-alkyl, aryl, heteroaryl, (C₃-C₇)-cycloalkyl, (C₄-C₇)-cycloalkenyl, heterocyclyl, (C₁-C₇)-alkoxy, (C₁-C₇)-haloalkoxy, (C₁-C₇)-alkoxy-(C₁-C₇)-alkyl, (C₁-C₇)-alkylthio-(C₁-C₇)-alkyl, amino-(C₁-C₇)-alkyl, (C₁-C₇)-alkylamino-(C₁-C₇)-alkyl, (C₃-C₇)-cycloalkylamino-(C₁-C₇)-alkyl, aryl-(C₁-C₇)-alkylamino-(C₁-C₇)-alkyl, heteroaryl-(C₁-C₇)-alkylamino-(C₁-C₇)-alkyl, heterocyclyl-(C₁-C₇)-alkylamino-(C₁-C₇)-alkyl, heterocyclylamino-(C₁-C₇)-alkyl, heteroarylamino-(C₁-C₇)-alkyl, (C₁-C₇)-alkoxycarbonylamino-(C₁-C₇)-alkyl, arylamino-(C₁-C₇)-alkyl, aryl-(C₁-C₇)-alkoxycarbonylamino-(C₁-C₇)-alkyl, (C₃-C₇)-cycloalkoxycarbonylamino-(C₁-C₇)-alkyl, (C₃-C₇)-cycloalkyl-(C₁-C₇)-alkoxycarbonylamino-(C₁-C₇)-alkyl, heteroaryl-(C₁-C₇)-alkoxycarbonylamino-(C₁-C₇)-alkyl, (C₁-C₇)-alkylcarbonylamino-(C₁-C₇)-alkyl, (C₃-C₇)-cycloalkylcarbonylamino-(C₁-C₇)-alkyl, arylcarbonylamino-(C₁-C₇)-alkyl, heteroarylcarbonylamino-(C₁-C₇)-alkyl, heterocyclylcarbonylamino-(C₁-C₇)-alkyl, (C₂-C₇)-alkenyloxycarbonylamino-(C₁-C₇)-alkyl, aryl-(C₂-C₇)-alkenylamino-(C₁-C₇)-alkyl, hydroxycarbonyl, (C₁-C₇)-alkoxycarbonyl, (C₂-C₇)-alkenyloxycarbonyl, aryl-(C₁-C₇)-alkoxycarbonyl, aminocarbonyl, alkylaminocarbonyl, (C₃-C₇)-cycloalkylaminocarbonyl, aryl-(C₁-C₇)-alkylaminocarbonyl, heteroarylaminocarbonyl or
R⁷ and R⁸ together with the carbon atom to which they are bonded form a fully saturated or partly saturated 3- to 7-membered monocyclic or bicyclic ring optionally interrupted by heteroatoms and optionally having further substitution or
R⁷ and R⁸ together with the carbon atom to which they are bonded form an oxo group or
R⁷ and R⁸ together with the carbon atom to which they are bonded form an oxime group substituted by hydrogen, (C₁-C₇)-alkyl, (C₃-C₇)-cycloalkyl, (C₃-C₇)-cycloalkyl-(C₁-C₇)-alkyl, aryl, heteroaryl, aryl-(C₁-C₇)-alkyl, heteroaryl-(C₁-C₇)-alkyl,
R⁹, R¹⁰ are each independently hydrogen, (C₁-C₇)-alkyl, halogen, cyano, (C₁-C₇)-haloalkyl, cyano-(C₁-C₇)-alkyl, aryl, heteroaryl, (C₃-C₇)-cycloalkyl, (C₄-C₇)-cycloalkenyl, heterocyclyl, (C₁-C₇)-alkoxy-(C₁-C₇)-alkyl, (C₁-C₇)-alkylthio-(C₁-C₇)-alkyl,
W is oxygen or sulfur and
X, Y are each independently hydrogen, (C₁-C₇)-alkyl, halogen, (C₂-C₇)-alkenyl, (C₂-C₇)-alkynyl, (C₁-C₇)-haloalkyl, hydroxy-(C₁-C₇)-alkyl, cyano-(C₁-C₇)-alkyl, aryl, heteroaryl, (C₃-C₇)-cycloalkyl, (C₄-C₇)-cycloalkenyl, heterocyclyl, cyano, nitro, hydroxyl, (C₁-C₇)-alkoxy, (C₁-C₇)-alkylthio, (C₁-C₇)-alkoxy-(C₁-C₇)-alkyl, (C₁-C₇)-alkylthio-(C₁-C₇)-alkyl, aryloxy, aryl-(C₁-C₇)-alkoxy, (C₁-C₇)-haloalkoxy, (C₁-C₇)-haloalkylthio, (C₁-C₇)-alkylamino, bis[(C₁-C₇)-alkyl]amino, (C₁-C₇)-alkoxy-(C₁-C₇)-alkoxy, amino-(C₁-C₇)-alkyl, (C₁-C₇)-alkylamino-(C₁-C₇)-alkyl, (C₃-C₇)-cycloalkylamino-(C₁-C₇)-alkyl, aryl-(C₁-C₇)-alkylamino-(C₁-C₇)-alkyl, heteroaryl-(C₁-C₇)-alkylamino-(C₁-C₇)-alkyl, heterocyclyl-(C₁-C₇)-alkylamino-(C₁-C₇)-alkyl, heterocyclylamino-(C₁-C₇)-alkyl, heteroarylamino-(C₁-C₇)-alkyl, (C₁-C₇)-alkoxycarbonylamino-(C₁-C₇)-alkyl, arylamino-(C₁-C₇)-alkyl, aryl-(C₁-C₇)-alkoxycarbonylamino-(C₁-C₇)-alkyl, (C₃-C₇)-cycloalkoxycarbonylamino-(C₁-C₇)-alkyl, (C₃-C₇)-cycloalkyl-(C₁-C₇)-alkoxycarbonylamino-(C₁-C₇)-alkyl, heteroaryl-(C₁-C₇)-alkoxycarbonylamino-(C₁-C₇)-alkyl, (C₁-C₇)-alkylcarbonylamino-(C₁-C₇)-alkyl, (C₃-C₇)-cycloalkylcarbonylamino-(C₁-C₇)-alkyl, arylcarbonylamino-(C₁-C₇)-alkyl, heteroarylcarbonylamino-(C₁-C₇)-alkyl, heterocyclylcarbonylamino-(C₁-C₇)-alkyl, (C₂-C₇)-alkenyloxycarbonylamino-(C₁-C₇)-alkyl, aryl-(C₂-C₇)-alkenylamino-(C₁-C₇)-alkyl or
X and Y together with the atom to which they are bonded form a fully saturated or partly saturated 3- to 7-membered monocyclic or bicyclic ring optionally interrupted by heteroatoms and optionally having further substitution.

Particularly preferred subject matter of the invention are compounds of the general formula (I) which are described by the formulae (Iaa) to (Ibi)

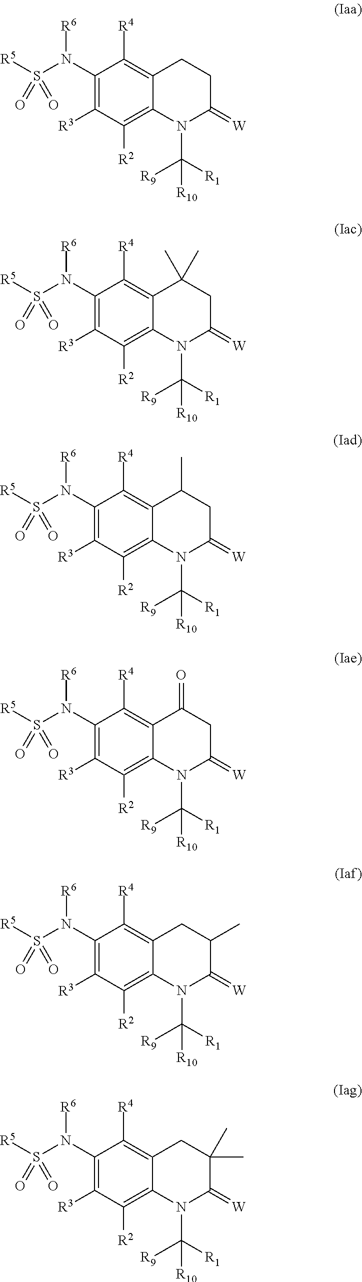

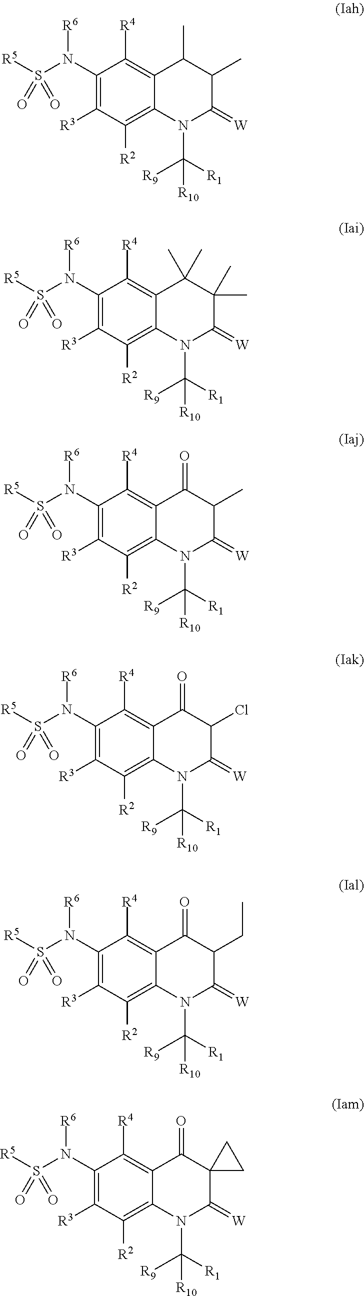

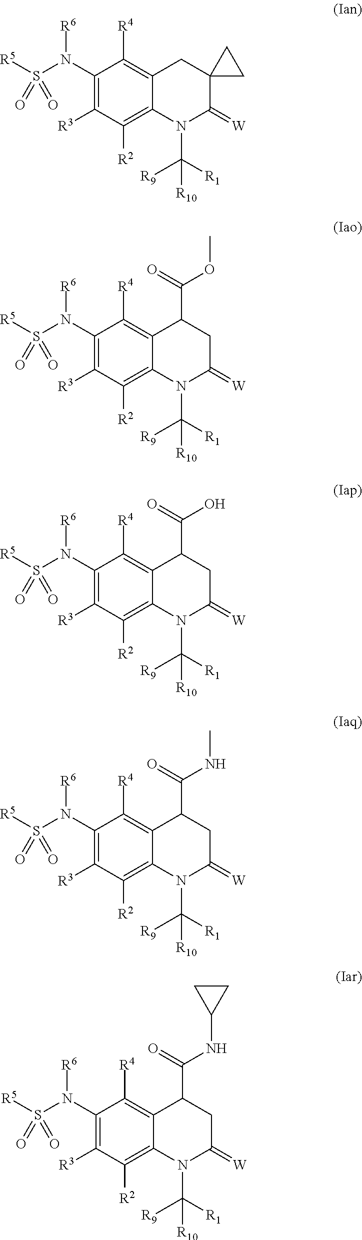

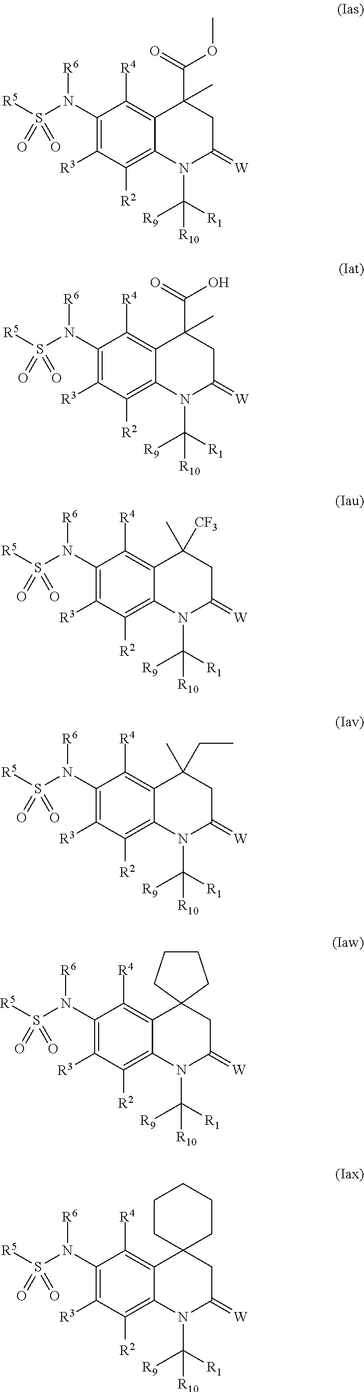

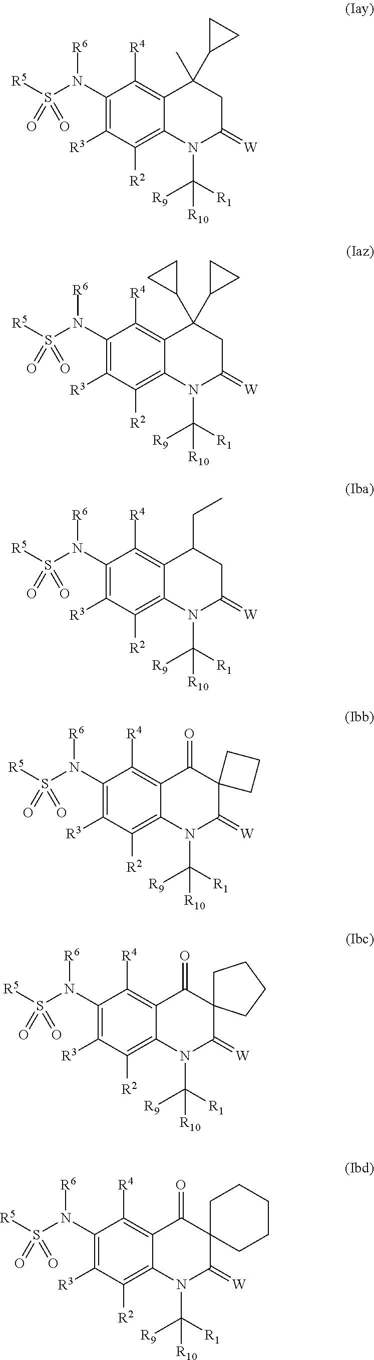

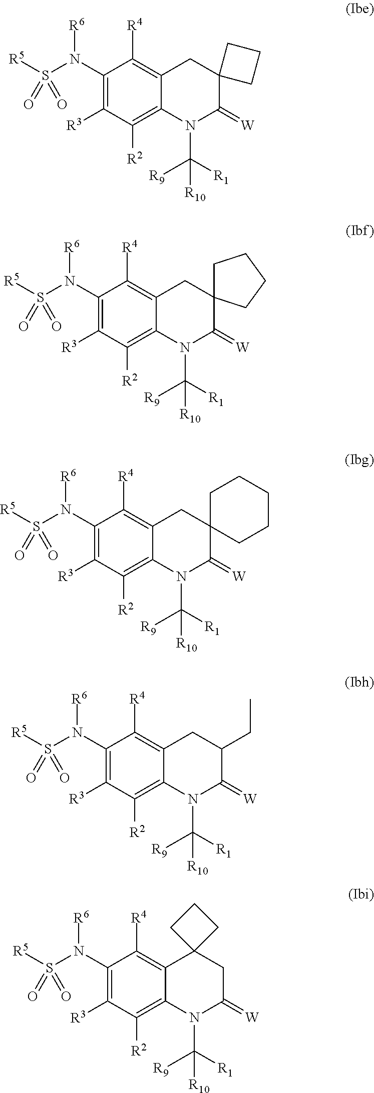

in which
R¹ is halogen, cyano, (C₃-C₁₀)-cycloalkyl, (C₃-C₁₀)-halocycloalkyl, (C₄-C₁₀)-cycloalkenyl, (C₄-C₁₀)-halocycloalkenyl, (C₁-C₁₀)-haloalkyl, (C₁-C₆)-alkoxy-(C₁-C₆)-haloalkyl, (C₃-C₆)-cycloalkyl-(C₁-C₆)-alkyl, (C₁-C₆)-alkylcarbonyl-(C₁-C₆)-alkyl, hydroxycarbonyl-(C₁-C₆)-alkyl, (C₁-C₆)-alkoxycarbonyl-(C₁-C₆)-alkyl, (C₂-C₆)-alkenyloxycarbonyl-(C₁-C₆)-alkyl, (C₂-C₆)-alkynyloxycarbonyl-(C₁-C₆)-alkyl, aryl-(C₁-C₆)-alkoxycarbonyl-(C₁-C₆)-alkyl, (C₃-C₆)-cycloalkoxycarbonyl-(C₁-C₆)-alkyl, (C₃-C₆)-cycloalkyl-(C₁-C₆)-alkoxycarbonyl-(C₁-C₆)-alkyl, aminocarbonyl-(C₁-C₆)-alkyl, (C₁-C₆)-alkylaminocarbonyl-(C₁-C₆)-alkyl, (C₃-C₆)-cycloalkylaminocarbonyl-(C₁-C₆)-alkyl, aryl-(C₁-C₆)-alkylaminocarbonyl-(C₁-C₆)-alkyl, heteroaryl-(C₁-C₆)-alkylaminocarbonyl-(C₁-C₆)-alkyl, (C₁-C₆)-alkylthio-(C₁-C₆)-alkyl, (C₃-C₆)-cycloalkylthio-(C₁-C₆)-alkyl, arylthio-(C₁-C₆)-alkyl, heterocyclylthio-(C₁-C₆)-alkyl, heteroarylthio-(C₁-C₆)-alkyl, aryl-(C₁-C₆)-alkylthio-(C₁-C₆)-alkyl, (C₁-C₆)-alkylsulfinyl-(C₁-C₆)-alkyl, (C₁-C₆)-alkylsulfonyl-(C₁-C₆)-alkyl, arylsulfinyl-(C₁-C₆)-alkyl, arylsulfonyl-(C₁-C₆)-alkyl, (C₃-C₆)-cycloalkylsulfinyl-(C₁-C₆)-alkyl, (C₃-C₆)-cycloalkylsulfonyl-(C₁-C₆)-alkyl, (C₁-C₆)-alkoxy-(C₁-C₆)-alkoxy-(C₁-C₆)-alkyl, (C₁-C₆)-alkylcarbonyl, (C₁-C₆)-haloalkylcarbonyl, (C₃-C₆)-cycloalkylcarbonyl, hydroxycarbonyl, (C₁-C₆)-alkoxycarbonyl, (C₂-C₆)-alkenyloxycarbonyl, (C₂-C₆)-alkynyloxycarbonyl, aryl-(C₁-C₆)-alkoxycarbonyl, (C₃-C₆)-cycloalkyl-(C₁-C₆)-alkoxycarbonyl, arylcarbonyl, heteroarylcarbonyl, heterocyclylcarbonyl, aryl-(C₁-C₆)-alkylcarbonyl, (C₁-C₆)-alkylaminocarbonyl, (C₃-C₆)-cycloalkylaminocarbonyl, arylaminocarbonyl, aryl-(C₁-C₆)-alkylaminocarbonyl, heteroarylaminocarbonyl, heterocyclylaminocarbonyl, heteroaryl-(C₁-C₆)-alkylaminocarbonyl, heterocyclyl-(C₁-C₆)-alkylaminocarbonyl, (C₁-C₆)-alkylsulfonyl, (C₃-C₆)-cycloalkylsulfonyl, arylsulfonyl, aryl-(C₁-C₆)-alkylsulfonyl, heteroarylsulfonyl, heterocyclylsulfonyl, cyano-(C₁-C₆)-alkyl, (C₄-C₆)-cycloalkenyl-(C₁-C₆)-alkyl, nitro-(C₁-C₆)-alkyl, (C₁-C₆)-haloalkoxy-(C₁-C₆)-alkyl, (C₁-C₆)-haloalkylthio-(C₁-C₆)-alkyl, bis-[(C₁-C₆)-alkyl]aminocarbonyl, (C₃-C₆)-cycloalkyl-[(C₁-C₆)-alkyl]aminocarbonyl, aryl-[(C₁-C₆)-alkyl]aminocarbonyl, aryl-(C₁-C₆)-alkyl-[(C₁-C₆)-alkyl]aminocarbonyl, (C₂-C₆)-alkenylaminocarbonyl, (C₂-C₆)-alkynylaminocarbonyl, (C₁-C₆)-alkylaminosulfonyl, bis-[(C₁-C₆)-alkyl]aminosulfonyl, heterocyclylsulfinyl-(C₁-C₆)-alkyl, heteroarylsulfinyl-(C₁-C₆)-alkyl, aryl-(C₁-C₆)-alkylsulfinyl-(C₁-C₆)-alkyl, heterocyclylsulfonyl-(C₁-C₆)-alkyl, heteroarylsulfonyl-(C₁-C₆)-alkyl, aryl-(C₁-C₆)-alkylsulfonyl-(C₁-C₆)-alkyl, bis-[(C₁-C₆)-alkyl]aminocarbonyl-(C₁-C₆)-alkyl, (C₃-C₆)-cycloalkyl-[(C₁-C₆)-alkyl]aminocarbonyl-(C₁-C₆)-alkyl, aryl-[(C₁-C₆)-alkyl]aminocarbonyl-(C₁-C₆)-alkyl, aryl-(C₁-C₆)-alkyl-[(C₁-C₆)-alkyl]aminocarbonyl-(C₁-C₆)-alkyl, (C₂-C₆)-alkenylaminocarbonyl-(C₁-C₆)-alkyl, (C₂-C₆)-alkynylaminocarbonyl-(C₁-C₆)-alkyl, (C₁-C₆)-alkylamino, bis-[(C₁-C₆)-alkyl]amino, (C₃-C₆)-cycloalkyl[(C₁-C₆)-alkyl]amino, amino, (C₂-C₆)-alkenylamino, (C₂-C₆)-alkynylamino, arylamino, heteroarylamino, aryl-(C₁-C₆)-alkylamino, heteroaryl-(C₁-C₆)-alkylamino, heterocyclylamino, heterocyclyl-(C₁-C₆)-alkylamino, (C₂-C₆)-alkenylcarbonyl-(C₁-C₆)-alkyl, (C₂-C₆)-alkynylcarbonyl-(C₁-C₆)-alkyl, (C₃-C₆)-cycloalkyl-(C₁-C₆)-alkylaminocarbonyl-(C₁-C₆)-alkyl, (C₃-C₆)-cycloalkyl-(C₁-C₆)-alkyl-[(C₁-C₆)-alkyl]aminocarbonyl-(C₁-C₆)-alkyl, (C₂-C₆)-alkenylsulfonyl-(C₁-C₆)-alkyl, (C₂-C₆)-alkynylsulfonyl-(C₁-C₆)-alkyl, heteroaryl-(C₁-C₆)-alkylsulfonyl-(C₁-C₆)-alkyl, heterocyclyl-(C₁-C₆)-alkylsulfonyl-(C₁-C₆)-alkyl, (C₂-C₆)-alkenylsulfinyl-(C₁-C₆)-alkyl, (C₂-C₆)-alkynylsulfinyl-(C₁-C₆)-alkyl, heteroaryl-(C₁-C₆)-alkylsulfinyl-(C₁-C₆)-alkyl, heterocyclyl-(C₁-C₆)-alkylsulfinyl-(C₁-C₆)-alkyl, (C₂-C₆)-alkenyloxy-(C₁-C₆)-alkoxy-(C₁-C₆)-alkyl, (C₂-C₆)-alkynyloxy-(C₁-C₆)-alkoxy-(C₁-C₆)-alkyl, heteroaryl-(C₁-C₆)-alkoxy-(C₁-C₆)-alkyl, heterocyclyl-(C₁-C₆)-alkoxy-(C₁-C₆)-alkyl, tris[(C₁-C₆)-alkyl]silyl, tris[(C₁-C₆)-alkyl]silyl-(C₁-C₆)-alkyl, (C₁-C₆)-alkoxy, (C₁-C₆)-haloalkoxy, (C₁-C₆)-alkylamino-(C₁-C₆)-alkyl, bis-[(C₁-C₆)-alkyl]amino-(C₁-C₆)-alkyl, (C₃-C₆)-cycloalkyl[(C₁-C₆)-alkyl]amino-(C₁-C₆)-alkyl, amino-(C₁-C₆)-alkyl, (C₂-C₆)-alkenylamino-(C₁-C₆)-alkyl, (C₂-C₆)-alkynylamino-(C₁-C₆)-alkyl, arylamino-(C₁-C₆)-alkyl, heteroarylamino-(C₁-C₆)-alkyl, aryl-(C₁-C₆)-alkylamino-(C₁-C₆)-alkyl, heteroaryl-(C₁-C₆)-alkylamino-(C₁-C₆)-alkyl, heterocyclylamino-(C₁-C₆)-alkyl, heterocyclyl-(C₁-C₆)-alkylamino-(C₁-C₆)-alkyl, (C₁-C₆)-haloalkoxy-(C₁-C₆)-haloalkyl, (C₂-C₆)-alkenyloxy-(C₁-C₆)-haloalkyl, (C₂-C₆)-alkynyloxy-(C₁-C₆)-haloalkyl, (C₁-C₆)-alkoxy-(C₁-C₆)-alkoxy-(C₁-C₆)-haloalkyl, (C₃-C₆)-cycloalkyl-(C₁-C₆)-alkoxy-(C₁-C₆)-haloalkyl, (C₃-C₆)-cycloalkyl-(C₁-C₆)-alkoxy-(C₁-C₆)-alkyl, (C₁-C₆)-alkoxy-(C₁-C₆)-alkoxy, (C₁-C₆)-alkoxycarbonyl-(C₃-C₆)-cycloalkyl,
R², R³, R⁴ are each independently hydrogen, fluorine, chlorine, bromine, iodine, (C₁-C₆)-alkoxy, (C₁-C₆)-alkyl, (C₁-C₆)-haloalkyl, (C₁-C₆)-haloalkoxy, (C₁-C₆)-alkylthio, (C₁-C₆)-haloalkylthio, optionally substituted phenyl, heteroaryl, heterocyclyl, (C₃-C₆)-cycloalkyl, aryl-(C₁-C₆)-alkyl, aryl-(C₂-C₆)-alkenyl, (C₂-C₆)-alkynyl, (C₂-C₆)-alkenyl, aryl-(C₁-C₆)-alkynyl, heteroaryl-(C₁-C₆)-alkyl, heteroaryl-(C₂-C₆)-alkenyl, heteroaryl-(C₁-C₆)-alkynyl, aryloxy, heteroaryloxy,
R⁵ is amino, (C₁-C₆)-alkyl, (C₃-C₆)-cycloalkyl, (C₃-C₆)-cycloalkyl-(C₁-C₆)-alkyl, (C₁-C₆)-haloalkyl, (C₃-C₆)-halocycloalkyl, (C₄-C₆)-cycloalkenyl, optionally substituted phenyl, heteroaryl, heterocyclyl, aryl-(C₁-C₆)-alkyl, heteroaryl-(C₁-C₆)-alkyl, heterocyclyl-(C₁-C₆)-alkyl, (C₁-C₆)-alkoxycarbonyl-(C₁-C₆)-alkyl, aryl-(C₁-C₆)-alkoxycarbonyl-(C₁-C₆)-alkyl, (C₃-C₆)-cycloalkoxycarbonyl-(C₁-C₆)-alkyl, (C₃-C₆)-cycloalkyl-(C₁-C₆)-alkoxycarbonyl-(C₁-C₆)-alkyl, heteroaryl-(C₁-C₆)-alkoxycarbonyl-(C₁-C₆)-alkyl, aminocarbonyl-(C₁-C₆)-alkyl, (C₁-C₆)-alkylaminocarbonyl-(C₁-C₆)-alkyl, (C₃-C₆)-cycloalkylaminocarbonyl-(C₁-C₆)-alkyl, aryl-(C₁-C₆)-alkylaminocarbonyl-(C₁-C₆)-alkyl, (C₁-C₆)-alkylamino, bis-[(C₁-C₆)-alkyl]amino, arylamino, (C₃-C₆)-cycloalkylamino, aryl-(C₁-C₆)-alkylamino, heteroaryl-(C₁-C₆)-alkylamino, heteroarylamino, heterocyclylamino, (C₂-C₆)-alkenylamino, (C₂-C₆)-alkynylamino, aryloxy-(C₁-C₆)-alkyl, heteroaryloxy-(C₁-C₆)-alkyl, (C₁-C₆)-alkoxy-(C₁-C₆)-alkyl, (C₂-C₆)-alkenyl, (C₂-C₆)-alkynyl, cyano-(C₁-C₆)-alkyl, aryloxy, aryl-(C₂-C₆)-alkenyl, heteroaryl-(C₂-C₆)-alkenyl, heterocyclyl-(C₂-C₆)-alkenyl,
R⁶ is hydrogen, (C₁-C₆)-alkyl, (C₃-C₆)-cycloalkyl, cyano-(C₁-C₆)-alkyl, (C₃-C₆)-cycloalkyl-(C₁-C₆)-alkyl, (C₁-C₆)-alkylsulfonyl, arylsulfonyl, aryl-(C₁-C₆)-alkylsulfonyl, heteroarylsulfonyl, (C₃-C₆)-cycloalkylsulfonyl, heterocyclylsulfonyl, (C₁-C₆)-alkylcarbonyl, arylcarbonyl, heteroarylcarbonyl, (C₃-C₆)-cycloalkylcarbonyl, heterocyclylcarbonyl, (C₁-C₆)-alkoxycarbonyl, aryl-(C₁-C₆)-alkoxycarbonyl, (C₁-C₆)-haloalkylcarbonyl, (C₂-C₆)-alkenyl, (C₂-C₆)-alkynyl, (C₁-C₆)-haloalkyl, halo-(C₂-C₆)-alkynyl, halo-(C₂-C₆)-alkenyl, (C₁-C₆)-alkoxy-(C₁-C₆)-alkyl,
R⁹, R¹⁰ are each independently hydrogen, (C₁-C₆)-alkyl, halogen, cyano, (C₁-C₆)-haloalkyl, cyano-(C₁-C₆)-alkyl, aryl, heteroaryl, (C₃-C₆)-cycloalkyl, (C₄-C₆)-cycloalkenyl, heterocyclyl, (C₁-C₆)-alkoxy-(C₁-C₆)-alkyl, (C₁-C₆)-alkylthio-(C₁-C₆)-alkyl and
W is oxygen or sulfur, preferably oxygen.

Especially preferred subject matter of the invention are compounds of the general formula (I) which are described by the formulae (Iaa), (Iac), (Iad), (Iaf) to (Iai), (Ian), (Iau) to (Iaz) and (Iba), (Ibe) to (Ibi)

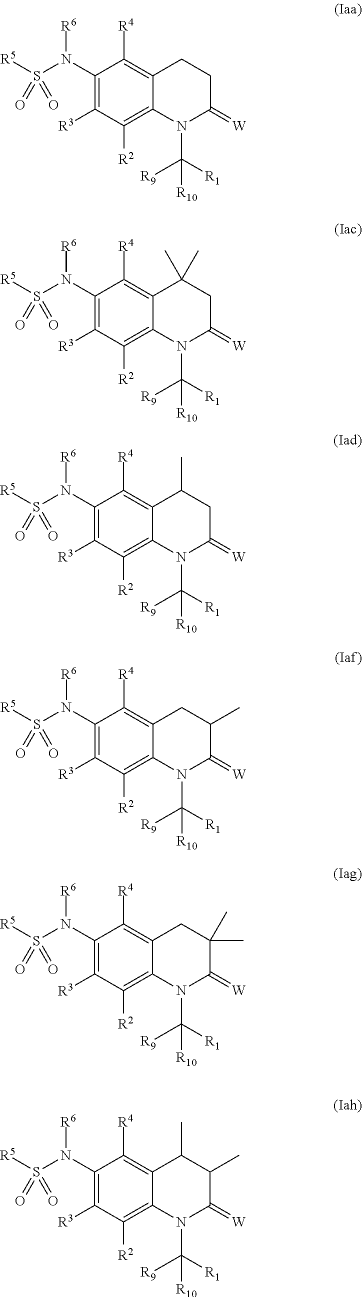

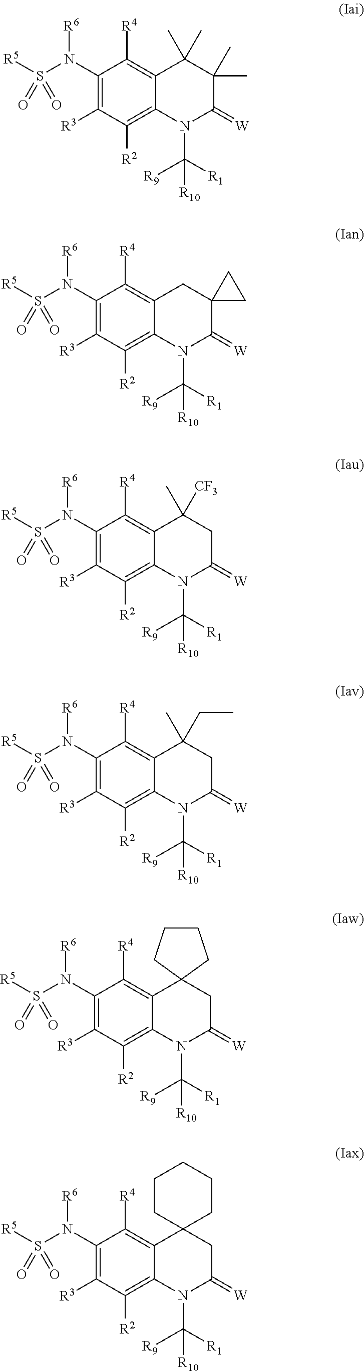

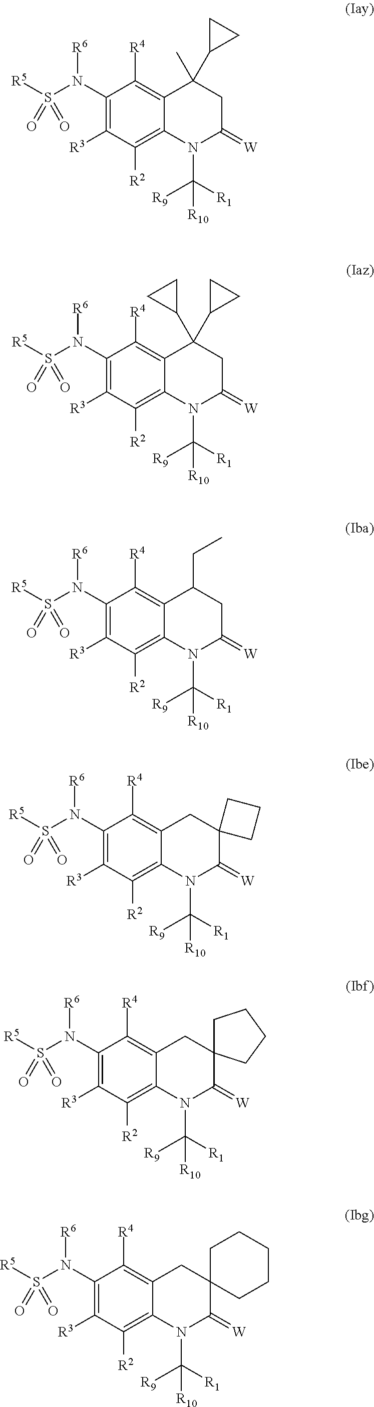

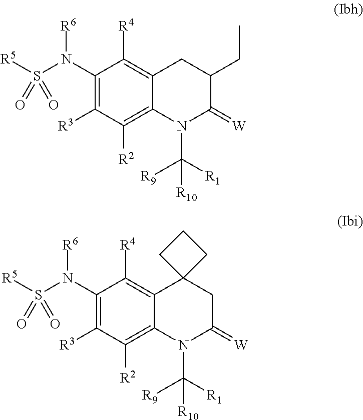

in which
R¹ is fluorine, chlorine, bromine, iodine, preferably fluorine and chlorine, cyano, cyclopropyl, cyclobutyl, cyclopentyl, cyclohexyl, cycloheptyl, cyclooctyl, spiro[2.2]pent-1-yl, spiro[2.3]hex-1-yl, spiro[2.3]hex-4-yl, 3-spiro[2.3]hex-5-yl, spiro[3.3]hept-1-yl, spiro[3.3]hept-2-yl, bicyclo[1.1.0]butan-1-yl, bicyclo[1.1.0]butan-2-yl, bicyclo[2.1.0]pentan-1-yl, bicyclo[1.1.1]pentan-1-yl, bicyclo[2.1.0]pentan-2-yl, bicyclo[2.1.0]pentan-5-yl, bicyclo[2.1.1]hexyl, bicyclo[2.2.1]hept-2-yl, bicyclo[2.2.2]octan-2-yl, bicyclo[3.2.1]octan-2-yl, bicyclo[3.2.2]nonan-2-yl, adamantan-1-yl, adamantan-2-yl, 1-methylcyclopropyl, 2-methylcyclopropyl, 2,2-dimethylcyclopropyl, 2,3-dimethylcyclopropyl, 1,1′-bi(cyclopropyl)-1-yl, 1,1′-bi(cyclopropyl)-2-yl, 2′-methyl-1,1′-bi(cyclopropyl)-2-yl, 1-cyanocyclopropyl, 2-cyanocyclopropyl, 1-methylcyclobutyl, 2-methylcyclobutyl, 3-methylcyclobutyl, 1-cyanocyclobutyl, 2-cyanocyclobutyl, 3-cyanocyclobutyl, 1-allylcyclopropyl, 1-vinylcyclobutyl, 1-vinylcyclopropyl, 1-ethylcyclopropyl, 2-ethylcyclopropyl, 1-ethylcyclobutyl, 2-ethylcyclobutyl, 3-ethylcyclobutyl, 4-methylcyclohexyl, 4-methoxycyclohexyl, 4-ethoxycyclohexyl, 4-n-propyloxycyclohexyl, 4-hydroxycyclohexyl, 4-trifluoromethylcyclohexyl, 4-cyanocyclohexyl, 3-methylcyclohexyl, 3-methoxycyclohexyl, 3-ethoxycyclohexyl, 3-n-propyloxycyclohexyl, 3-hydroxycyclohexyl, 3-methoxycyclobutyl, 2-methoxycyclopropyl, 2-ethoxycyclopropyl, 2-isopropyloxycyclopropyl, 1-cyclopropylcyclobutyl, 1-prop-2-enylcyclobutyl, 2-ethyl-3-methylcyclobutyl, 1-propylcyclopropyl, 1-methyl-2-propylcyclopropyl, 2-propylcyclopropyl, 1-propylcyclobutyl, 2-propylcyclobutyl, 3-propylcyclobutyl, 1-isopropylcyclobutyl, 1-isopropylcyclopropyl, 2-isopropylcyclopropyl, 3-isopropylcyclobutyl, 2-dimethylaminocyclobutyl, 3-dimethylaminocyclobutyl, 1-butylcyclobutyl, 2-butylcyclobutyl, 1-butylcyclopropyl, 3-butylcyclobutyl, 2-butylcyclopropyl, 1-isobutylcyclobutyl, 3-tert-butylcyclobutyl, 3,3-diethylcyclobutyl, 2,2-diethylcyclopropyl, 2-methylidenecyclopropyl, 1-methoxymethylcyclopropyl, 1-isobutylcyclopropyl, cyclopropylmethyl, cyclobutylmethyl, cyclopentylmethyl, cyclohexylmethyl, cyclopropylethyl, cyclobutylethyl, cyclopentylethyl, cyclohexylethyl, cyclopropyl-n-propyl, cyclobutyl-n-propyl, cyclopentyl-n-propyl, cyclohexyl-n-propyl, trichloromethyl, trichloroethyl, iodomethyl, iodoethyl, iodo-n-propyl, bromomethyl, bromoethyl, bromo-n-propyl, trifluoromethyl, difluoromethyl, fluoro-n-propyl, 2-fluoroprop-2-yl, 1-fluoroprop-2-yl, 2,2-difluoroethyl, 2,2,2-trifluoroethyl, 1,1-difluoroethyl, 3,3,3-trifluoropropyl, 4,4,4-trifluorobutyl, 3,3-difluoropropyl, pentafluoroethyl, heptafluoro-n-propyl, heptafluoroisopropyl, nonafluoro-n-butyl, chlorodifluoromethyl, bromodifluoromethyl, dichlorofluoromethyl, bromofluoromethyl, 1-fluoroethyl, 2-fluoroethyl, fluoromethyl, 2,2-dichloro-2-fluoroethyl, 2-chloro-2,2-difluoroethyl, difluoro-tert-butyl, 2-bromo-1,1,2-trifluoroethyl, 1,1,2,2-tetrafluoroethyl, 1,2,2,2-tetrafluoroethyl, 2-chloro-1,1,2-trifluoroethyl, 2-chloro-1,1,2,2-tetrafluoroethyl, 2,2,3,3,3-pentafluoropropyl, 1,2,2,3,3,3-hexafluoropropyl, 1-methyl-2,2,2-trifluoroethyl, 1-chloro-2,2,2-trifluoroethyl, 1,2,2,3,3,4,4,4-octafluorobutyl, 1,1,2,2,3,3,4,4-octafluorobutyl, n-propoxydifluoromethyl, methoxydifluoromethyl, ethoxydifluoromethyl, n-butoxydifluoromethyl, methoxyethoxydifluoromethyl, n-pentoxydifluoromethyl, 2-methylbutoxydifluoromethyl, 4-methylpentoxydifluoromethyl, n-hexyloxydifluoromethyl, isohexyloxydifluoromethyl, allyloxypropoxydifluoromethyl, methoxypropoxydifluoromethyl, cyclopropylmethoxydifluoromethyl, cyclobutylmethoxydifluoromethyl, but-3-yn-1-yloxydifluoromethyl, pent-4-yn-1-yloxydifluoromethyl, hex-3-yn-1-yloxydifluoromethyl, but-3-en-1-yloxydifluoromethyl, 2,2,2-trifluoroethoxydifluoromethyl, 3,3,3-trifluoropropoxydifluoromethyl, 4,4,4-trifluorobutoxydifluoromethyl, 3-chloro-1-methoxybut-3-yl, cyanomethyl, cyanoethyl, cyano-n-propyl, cyano-n-butyl, cyanoisopropyl, methoxymethoxymethyl, methoxymethoxy, ethoxymethoxy, methoxyethoxy, methoxy-n-propyloxy, ethoxy-n-propyloxy, n-propyloxymethoxy, isopropyloxymethoxy, methoxymethoxyethyl, ethoxymethoxymethyl, ethoxyethoxymethyl, methoxyethoxymethyl, methoxyethoxyethyl, methoxyethoxy-n-propyl, methoxymethoxy-n-propyl, methoxy-n-propyloxymethyl, trifluoromethoxymethyl, trifluoromethoxyethyl, trifluoromethoxy-n-propyl, trifluoromethoxyisopropyl, difluoromethoxymethyl, difluoromethoxyethyl, difluoromethoxy-n-propyl, difluoromethoxyisopropyl, pentafluoroethoxymethyl, pentafluoroethoxyethyl, pentafluoroethoxy-n-propyl, pentafluoroethoxyisopropyl, 1,1,2,2-tetrafluoroethoxymethyl, 1,1,2,2-tetrafluoroethoxyethyl, 1,1,2,2-tetrafluoroethoxy-n-propyl, 1,1,2,2-tetrafluoroethoxyisopropyl, 1,2,2,2-tetrafluoroethoxymethyl, 1,2,2,2-tetrafluoroethoxyethyl, 1,2,2,2-tetrafluoroethoxy-n-propyl, 1,2,2,2-tetrafluoroethoxyisopropyl, 2,2,2-trifluoroethoxymethyl, 2,2,2-trifluoroethoxyethyl, 2,2,2-trifluoroethoxy-n-propyl, 2,2,2-trifluoroethoxyisopropyl, 2,2-difluoroethoxymethyl, 2,2-difluoroethoxyethyl, 2,2-difluoroethoxy-n-propyl, 2,2-difluoroethoxyisopropyl, heptafluoropropoxymethyl, heptafluoropropoxyethyl, heptafluoropropoxy-n-propyl, heptafluoropropoxyisopropyl, trifluoromethylthiomethyl, trifluoromethylthioethyl, trifluoromethylthio-n-propyl, trifluoromethylthioisopropyl, difluoromethylthiomethyl, difluoromethylthioethyl, difluoromethylthio-n-propyl, difluoromethylthioisopropyl, pentafluoroethylthiomethyl, pentafluoroethylthioethyl, pentafluoroethylthio-n-propyl, pentafluoroethylthioisopropyl, 1,1,2,2-tetrafluoroethylthiomethyl, 1,1,2,2-tetrafluoroethylthioethyl, 1,1,2,2-tetrafluoroethylthio-n-propyl, 1,1,2,2-tetrafluoroethylthioisopropyl, 1,2,2,2-tetrafluoroethylthiomethyl, 1,2,2,2-tetrafluoroethylthioethyl, 1,2,2,2-tetrafluoroethylthio-n-propyl, 1,2,2,2-tetrafluoroethylthioisopropyl, 2,2,2-trifluoroethylthiomethyl, 2,2,2-trifluoroethylthioethyl, 2,2,2-trifluoroethylthio-n-propyl, 2,2,2-trifluoroethylthioisopropyl, 2,2-difluoroethylthiomethyl, 2,2-difluoroethylthioethyl, 2,2-difluoroethylthio-n-propyl, 2,2-difluoroethylthioisopropyl, heptafluoropropylthiomethyl, heptafluoropropylthioethyl, heptafluoropropylthio-n-propyl, heptafluoropropylthioisopropyl, (C₄-C₈)-halocycloalkenyl, (C₄-C₈)-cycloalkenyl, (C₃-C₈)-halocycloalkyl, (C₂-C₆)-haloalkenyl, heteroaryl, heteroaryl-(C₁-C₅)-alkyl, (C₂-C₅)-haloalkynyl, heterocyclyl, heterocyclyl-(C₁-C₅)-alkyl, methylcarbonylmethyl, methylcarbonylethyl, ethylcarbonylmethyl, ethylcarbonylethyl, n-propylcarbonylmethyl, n-propylcarbonylethyl, isopropylcarbonylmethyl, isopropylcarbonylethyl, hydroxycarbonylmethyl, 1-hydroxycarbonyleth-1-yl, 1-hydroxycarbonyleth-2-yl, hydroxycarbonyl-n-propyl, 2-hydroxycarbonylprop-2-yl, 1-hydroxycarbonylprop-2-yl, 2-hydroxycarbonylprop-1-yl, hydroxycarbonyl-n-butyl, hydroxycarbonylisobutyl, methoxycarbonylmethyl, 1-methoxycarbonyleth-1-yl, 1-methoxycarbonyleth-2-yl, methoxycarbonyl-n-propyl, 2-methoxycarbonylprop-2-yl, 1-methoxycarbonylprop-2-yl, 2-methoxycarbonylprop-1-yl, methoxycarbonyl-n-butyl, methoxycarbonylisobutyl, ethoxycarbonylmethyl, 1-ethoxycarbonyleth-1-yl, 1-ethoxycarbonyleth-2-yl, ethoxycarbonyl-n-propyl, 2-ethoxycarbonylprop-2-yl, 1-ethoxycarbonylprop-2-yl, 2-ethoxycarbonylprop-1-yl, ethoxycarbonyl-n-butyl, ethoxycarbonylisobutyl, isopropyloxycarbonylmethyl, 1-isopropyloxycarbonyleth-1-yl, 1-isopropyloxycarbonyleth-2-yl, isopropyloxycarbonyl-n-propyl, 2-isopropyloxycarbonylprop-2-yl, 1-isopropyloxycarbonylprop-2-yl, 2-isopropyloxycarbonylprop-1-yl, isopropyloxycarbonyl-n-butyl, isopropyloxycarbonylisobutyl, n-propyloxycarbonylmethyl, 1-n-propyloxycarbonyleth-1-yl, 1-n-propyloxycarbonyleth-2-yl, n-propyloxycarbonyl-n-propyl, 2-n-propyloxycarbonylprop-2-yl, 1-n-propyloxycarbonylprop-2-yl, 2-n-propyloxycarbonylprop-1-yl, n-propyloxycarbonyl-n-butyl, n-propyloxycarbonylisobutyl, tert-butyloxycarbonylmethyl, tert-butyloxycarbonylethyl, tert-butyloxycarbonyl-n-propyl, tert-butyloxycarbonylisopropyl, benzyloxycarbonylmethyl, benzyloxycarbonylethyl, benzyloxycarbonyl-n-propyl, benzyloxycarbonylisopropyl, allyloxycarbonylmethyl, allyloxycarbonylethyl, allyloxycarbonyl-n-propyl, methoxycarbonyl, ethoxycarbonyl, n-propyloxycarbonyl, isopropyloxycarbonyl, n-butyloxycarbonyl, tert-butyloxycarbonyl, methylcarbonyl, ethylcarbonyl, n-propylcarbonyl, isopropylcarbonyl, tert-butylcarbonyl, (C₂-C₅)-alkynyloxycarbonyl-(C₁-C₅)-alkyl, (C₃-C₆)-cycloalkoxycarbonyl-(C₁-C₅)-alkyl, (C₃-C₆)-cycloalkyl-(C₁-C₅)-alkoxycarbonyl-(C₁-C₅)-alkyl, aminocarbonyl-(C₁-C₅)-alkyl, (C₁-C₅)-alkylaminocarbonyl-(C₁-C₅)-alkyl, (C₃-C₆)-cycloalkylaminocarbonyl-(C₁-C₅)-alkyl, aryl-(C₁-C₅)-alkylaminocarbonyl-(C₁-C₅)-alkyl, heteroaryl-(C₁-C₅)-alkylaminocarbonyl-(C₁-C₅)-alkyl, (C₁-C₅)-haloalkylcarbonyl, (C₃-C₆)-cycloalkylcarbonyl, aryl-(C₁-C₅)-alkoxycarbonyl, arylcarbonyl, heteroarylcarbonyl, heterocyclylcarbonyl, aryl-(C₁-C₆)-alkylcarbonyl, (C₁-C₆)-alkylaminocarbonyl, (C₃-C₆)-cycloalkylaminocarbonyl, arylaminocarbonyl, aryl-(C₁-C₆)-alkylaminocarbonyl, heteroarylaminocarbonyl, heterocyclylaminocarbonyl, heteroaryl-(C₁-C₆)-alkylaminocarbonyl, heterocyclyl-(C₁-C₆)-alkylaminocarbonyl, (C₁-C₆)-alkylsulfonyl, (C₃-C₆)-cycloalkylsulfonyl, arylsulfonyl, aryl-(C₁-C₆)-alkylsulfonyl, heteroarylsulfonyl, heterocyclylsulfonyl, dimethylamino, diethylamino, methyl(ethyl)amino, methyl(n-propyl)amino, methyl(isopropyl)amino, dimethylaminomethyl, diethylaminomethyl, methyl(ethyl)aminomethyl, methyl(n-propyl)aminomethyl, methyl(isopropyl)aminomethyl, dimethylaminoethyl, diethylaminoethyl, methyl(ethyl)aminoethyl, methyl(n-propyl)aminoethyl, methyl(isopropyl)aminoethyl, dimethylamino-n-propyl, dimethylaminoisopropyl, diethylamino-n-propyl, diethylaminoisopropyl, 1-dimethylaminoprop-2-yl, 1-diethylaminoprop-2-yl, trimethylsilylmethyl, trimethylsilylethyl, trimethylsilyl-n-propyl, triethylsilylmethyl, triethylsilylethyl, triethylsilyl-n-propyl, tris[isopropyl]silylmethyl, tris[isopropyl]silylethyl, tris[isopropyl]silyl-n-propyl, methylthiomethyl, ethylthiomethyl, ethylthioethyl, n-propylthiomethyl, n-propylthioethyl, methylthioethyl, methylthio-n-propyl, 2-ethoxycarbonylcycloprop-1-yl, 2-methoxycarbonylcycloprop-1-yl,
R², R³, R⁴ are each independently hydrogen, fluorine, chlorine, bromine, iodine, preferably fluorine and chlorine, methoxy, ethoxy, n-propyloxy, isopropyloxy, methyl, ethyl, isopropyl, trifluoromethyl, difluoromethyl, pentafluoroethyl, trifluoromethoxy, difluoromethoxy, 2,2-difluoroethoxy, 3,3,3-trifluoroethoxy, methylthio, ethylthio, trifluoromethylthio, optionally substituted phenyl, heteroaryl, heterocyclyl, cyclopropyl, cyclobutyl, cyclopentyl, cyclohexyl,
R⁵ is amino, methyl, ethyl, n-propyl, 1-methylethyl, n-butyl, 1-methylpropyl, 2-methylpropyl, 1,1-dimethylethyl, n-pentyl, 1-methylbutyl, 2-methylbutyl, 3-methylbutyl, 1,1-dimethylpropyl, 1,2-dimethylpropyl, 2,2-dimethylpropyl, 1-ethylpropyl, n-hexyl, 1-methylpentyl, 2-methylpentyl, 3-methylpentyl, 4-methylpentyl, 1,1-dimethylbutyl, 1,2-dimethylbutyl, 1,3-di-methylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, 1-ethyl-2-methylpropyl, cyclopropyl, cyclobutyl, cyclopentyl, cyclohexyl, spiro[2.2]pent-1-yl, spiro[2.3]hex-1-yl, spiro[2.3]hex-4-yl, 3-spiro[2.3]hex-5-yl, cyclopropylmethyl, cyclobutylmethyl, cyclopentylmethyl, cyclohexylmethyl, trifluoromethyl, difluoromethyl, 2,2-difluoroethyl, 2,2,2-trifluoroethyl, 3,3,3-trifluoropropyl, pentafluoroethyl, heptafluoro-n-propyl, heptafluoroisopropyl, nonafluoro-n-butyl, (C₃-C₆)-halocycloalkyl, (C₄-C₆)-cycloalkenyl, optionally substituted phenyl, heteroaryl, heterocyclyl, aryl-(C₁-C₅)-alkyl, heteroaryl-(C₁-C₅)-alkyl, heterocyclyl-(C₁-C₅)-alkyl, (C₁-C₅)-alkoxycarbonyl-(C₁-C₅)-alkyl, aryl-(C₁-C₅)-alkoxycarbonyl-(C₁-C₅)-alkyl, (C₁-C₆)-cycloalkoxycarbonyl-(C₁-C₅)-alkyl, (C₃-C₆)-cycloalkyl-(C₁-C₅)-alkoxycarbonyl-(C₁-C₅)-alkyl, heteroaryl-(C₁-C₅)-alkoxycarbonyl-(C₁-C₅)-alkyl, aminocarbonyl-(C₁-C₅)-alkyl, (C₁-C₅)-alkylaminocarbonyl-(C₁-C₅)-alkyl, (C₃-C₆)-cycloalkylaminocarbonyl-(C₁-C₅)-alkyl, aryl-(C₁-C₅)-alkylaminocarbonyl-(C₁-C₅)-alkyl, (C₁-C₅)-alkylamino, bis-[(C₁-C₅)-alkyl]amino, arylamino, (C₃-C₆)-cycloalkylamino, aryl-(C₁-C₅)-alkylamino, heteroaryl-(C₁-C₅)-alkylamino, heteroarylamino, heterocyclylamino, (C₂-C₅)-alkenylamino, (C₂-C₅)-alkynylamino, aryloxy-(C₁-C₅)-alkyl, heteroaryloxy-(C₁-C₅)-alkyl, (C₁-C₅)-alkoxy-(C₁-C₅)-alkyl, phenylethenyl, p-chlorophenylethenyl, p-methylphenylethenyl, p-methoxyphenylethenyl, p-trifluoromethylphenylethenyl, p-fluorophenylethenyl, p-cyanophenylethenyl, p-trifluoromethoxyphenylethenyl, p-nitrophenylethenyl, p-bromophenylethenyl, p-iodophenylethenyl, m-chlorophenylethenyl, m-methylphenylethenyl, m-methoxyphenylethenyl, m-trifluoromethylphenylethenyl, m-fluorophenylethenyl, m-cyanophenylethenyl, m-trifluoromethoxyphenylethenyl, m-nitrophenylethenyl, m-bromophenylethenyl, m-iodophenylethenyl, p-methoxycarbonylphenylethenyl, m-methoxycarbonylphenylethenyl, o-methoxycarbonylphenylethenyl, p-ethoxycarbonylphenylethenyl, m-ethoxycarbonylphenylethenyl, o-ethoxycarbonylphenylethenyl, ethenyl, 1-propenyl, 2-propenyl, 1-methylethenyl, 1-butenyl, 2-butenyl, 3-butenyl, 1-methyl-1-propenyl, 2-methyl-1-propenyl, 1-methyl-2-propenyl, 2-methyl-2-propenyl, 1-pentenyl, 2-pentenyl, 3-pentenyl, 4-pentenyl, 1-methyl-1-butenyl, 2-methyl-1-butenyl, 3-methyl-1-butenyl, 1-methyl-2-butenyl, 2-methyl-2-butenyl, 3-methyl-2-butenyl, 1-methyl-3-butenyl, 2-methyl-3-butenyl, 3-methyl-3-butenyl, 1,1-dimethyl-2-propenyl, 1,2-dimethyl-1-propenyl, 1,2-dimethyl-2-propenyl, 1-ethyl-1-propenyl, 1-ethyl-2-propenyl, 1-hexenyl, 2-hexenyl, 3-hexenyl, 4-hexenyl, 5-hexenyl, 1-methyl-1-pentenyl, 2-methyl-1-pentenyl, 3-methyl-1-pentenyl, 4-methyl-1-pentenyl, 1-methyl-2-pentenyl, 2-methyl-2-pentenyl, 3-methyl-2-pentenyl, 4-methyl-2-pentenyl, 1-methyl-3-pentenyl, 2-methyl-3-pentenyl, 3-methyl-3-pentenyl, 4-methyl-3-pentenyl, 1-methyl-4-pentenyl, 2-methyl-4-pentenyl, 3-methyl-4-pentenyl, 4-methyl-4-pentenyl, 1,1-dimethyl-2-butenyl, 1, 1-dimethyl-3-butenyl, 1,2-dimethyl-1-butenyl, 1,2-dimethyl-2-butenyl, 1,2-dimethyl-3-butenyl, 1,3-dimethyl-1-butenyl, 1,3-dimethyl-2-butenyl, 1,3-dimethyl-3-butenyl, 2,2-dimethyl-3-butenyl, 2,3-dimethyl-1-butenyl, 2,3-dimethyl-2-butenyl, 2,3-dimethyl-3-butenyl, 3,3-dimethyl-1-butenyl, 3,3-dimethyl-2-butenyl, 1-ethyl-1-butenyl, 1-ethyl-2-butenyl, 1-ethyl-3-butenyl, 2-ethyl-1-butenyl, 2-ethyl-2-butenyl, 2-ethyl-3-butenyl, 1,1,2-trimethyl-2-propenyl, 1-ethyl-1-methyl-2-propenyl, 1-ethyl-2-methyl-1-propenyl and 1-ethyl-2-methyl-2-propenyl, ethynyl, 1-propynyl, 2-propynyl, 1-butynyl, 2-butynyl, 3-butynyl, 1-methyl-2-propynyl, 1-pentynyl, 2-pentynyl, 3-pentynyl, 4-pentynyl, 1-methyl-2-butynyl, 1-methyl-3-butynyl, 2-methyl-3-butynyl, 3-methyl-1-butynyl, 1,1-dimethyl-2-propynyl, 1-ethyl-2-propynyl, 1-hexynyl, 2-hexynyl, 3-hexynyl, 4-hexynyl, 5-hexynyl, 1-methyl-2-pentynyl, 1-methyl-3-pentynyl, 1-methyl-4-pentynyl, 2-methyl-3-pentynyl, 2-methyl-4-pentynyl, 3-methyl-1-pentynyl, 3-methyl-4-pentynyl, 4-methyl-1-pentynyl, 4-methyl-2-pentynyl, 1,1-dimethyl-2-butynyl, 1,1-dimethyl-3-butynyl, 1,2-dimethyl-3-butynyl, 2,2-dimethyl-3-butynyl, 3,3-dimethyl-1-butynyl, 1-ethyl-2-butynyl, 1-ethyl-3-butynyl, 2-ethyl-3-butynyl, 1-ethyl-1-methyl-2-propynyl, cyanoethyl, cyanomethyl, cyano-n-propyl, cyano-n-butyl, aryloxy, aryl-(C₂-C₅)-alkenyl, heteroaryl-(C₂-C₅)-alkenyl, heterocyclyl-(C₂-C₅)-alkenyl,
R⁶ is hydrogen, methyl, ethyl, n-propyl, 1-methylethyl, n-butyl, 1-methylpropyl, 2-methylpropyl, 1,1-dimethylethyl, n-pentyl, 1-methylbutyl, 2-methylbutyl, 3-methylbutyl, 1,1-dimethylpropyl, 1,2-dimethylpropyl, 2,2-dimethylpropyl, 1-ethylpropyl, n-hexyl, 1-methylpentyl, 2-methylpentyl, 3-methylpentyl, 4-methylpentyl, 1,1-dimethylbutyl, 1,2-dimethylbutyl, 1,3-di-methylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, 1-ethyl-2-methylpropyl, cyclopropyl, cyclobutyl, cyclopentyl, cyclohexyl, cyclopropylmethyl, cyclopropylethyl, cyclobutylmethyl, cyclopentylmethyl, cyclohexylmethyl, 2,2-difluoroethyl, 2,2,2-trifluoroethyl, 3,3,3-trifluoropropyl, cyanomethyl, cyanoethyl, cyano-n-propyl, cyclopropylcarbonyl, cyclobutylcarbonyl, cyclopentylcarbonyl, cyclohexylcarbonyl, methoxycarbonyl, (C₁-C₅)-alkylsulfonyl, arylsulfonyl, aryl-(C₁-C₅)-alkylsulfonyl, heteroarylsulfonyl, (C₃-C₆)-cycloalkylsulfonyl, heterocyclylsulfonyl, (C₁-C₅)-alkylcarbonyl, arylcarbonyl, heteroarylcarbonyl, heterocyclylcarbonyl, (C₁-C₅)-alkoxycarbonyl, aryl-(C₁-C₅)-alkoxycarbonyl, (C₁-C₅)-haloalkylcarbonyl, (C₂-C₅)-alkenyl, (C₂-C₅)-alkynyl, halo-(C₂-C₅)-alkynyl, halo-(C₂-C₅)-alkenyl, (C₁-C₅)-alkoxy-(C₁-C₅)-alkyl,
R⁹, R¹⁰ are each independently hydrogen, methyl, ethyl, n-propyl, isopropyl, n-butyl, sec-butyl, tert-butyl, n-pentyl, isopentyl, neopentyl, fluorine, chlorine, bromine, iodine, preferably fluorine and chlorine, cyano, trifluoromethyl, difluoromethyl, pentafluoroethyl, 1,1,2,2-difluoroethyl, 2,2-difluoroethyl, 3,3,3-trifluoroethyl, cyanomethyl, cyanoethyl, cyano-n-propyl, cyanoisopropyl, heteroaryl, cyclopropyl, cyclobutyl, cyclopentyl, cyclohexyl, cycloheptyl, (C₄-C₈)-cycloalkenyl, heterocyclyl, methylthiomethyl, ethylthiomethyl, methylthioethyl, ethylthioethyl and
W is oxygen or sulfur, preferably oxygen.

Very especially preferred subject matter of the invention are compounds of the general formula (I) which are described by the formulae (Iaa), (Iac), (Iad), (Iaf), (Iag), (Ian), (Iau) to (Iaz) and (Ibi)

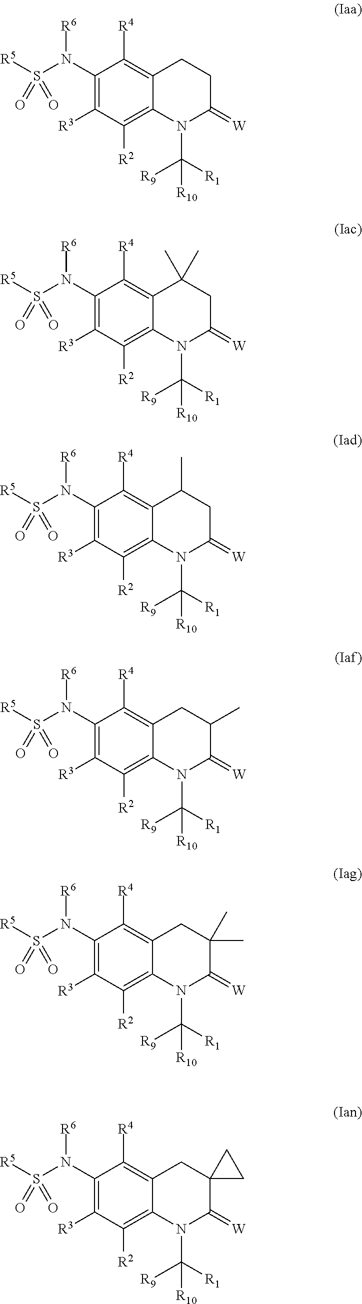

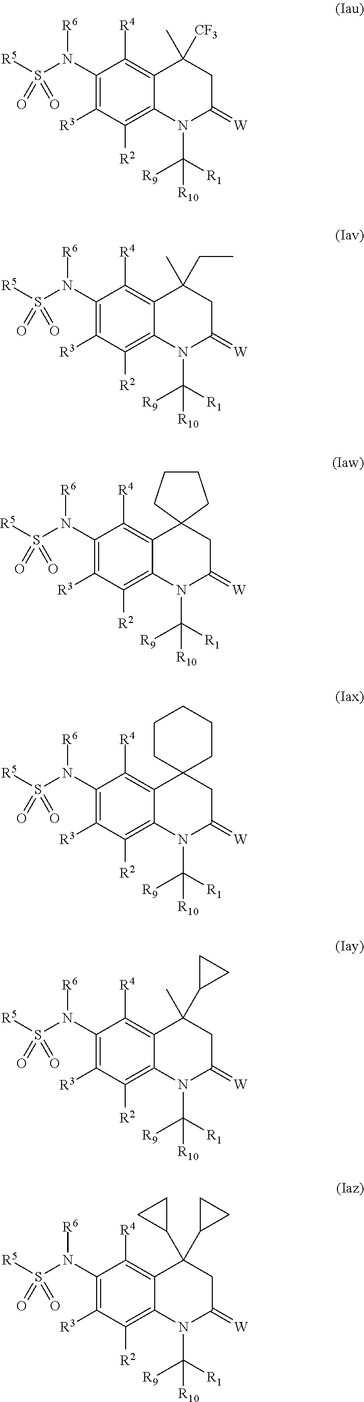

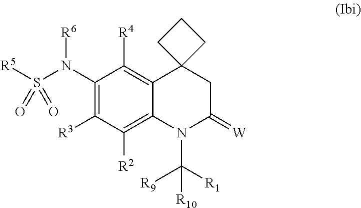

in which
R¹ is cyano, cyclopropyl, cyclobutyl, cyclopentyl, cyclohexyl, adamantan-1-yl, adamantan-2-yl, difluoromethyl, trifluoromethyl, fluoromethyl, 2-fluoroethyl, 2-fluoroprop-2-yl, 1,1-difluoroethyl, 2,2,2-trifluoroethyl, 3,3,3-trifluoropropyl, 1,1,2,2-tetrafluoroethyl, pentafluoroethyl, 2,2,3,3,3-pentafluoropropyl, heptafluoropropyl, nonafluorobutyl, cyanomethyl, cyanoeth-1-yl, cyanoeth-2-yl, cyano-n-propyl, cyano-n-butyl, cyanoisopropyl, 1-methylcyclopropan-1-yl, 2-methylcyclopropan-1-yl, 2,2-dimethylcyclopropyl, 2,3-dimethylcyclopropyl, 1,1′-bi(cyclopropyl)-1-yl, 1,1′-bi(cyclopropyl)-2-yl, 2′-methyl-1,1′-bi(cyclopropyl)-2-yl, 1-cyanocyclopropyl, 2-cyanocyclopropyl, 1-methylcyclobutyl, 2-methylcyclobutyl, 3-methylcyclobutyl, 1-cyanocyclobutyl, 2-cyanocyclobutyl, 3-cyanocyclobutyl, 1-ethylcyclopropyl, 2-ethylcyclopropyl, 1-ethylcyclobutyl, 2-ethylcyclobutyl, 3-ethylcyclobutyl, 4-methylcyclohexyl, 4-methoxycyclohexyl, 2-ethoxycarbonylcyclop-1-yl, 2-methoxycarbonylcyclop-1-yl, 2-tetrahydrofuryl, 3-tetrahydrofuryl, 2,2-dichlorocyclopropyl, tetrahydro-2H-pyran-4-yl, 2-ethoxycarbonylcyclopropyl, 2,2-difluorocyclopropyl, 2,2,3,3-tetrafluoropropyl, trimethylsilylmethyl, trifluoromethoxymethyl, trifluoromethylthiomethyl, pentafluoroethoxymethyl, pentafluoroethylthiomethyl, methoxyethoxymethyl, methoxycarbonyl, ethoxycarbonyl, methoxycarbonylmethyl, ethoxycarbonylmethyl, cyclopropylmethyl, cyclobutylmethyl, cyclopentylmethyl, cyclohexylmethyl, cyclopropylethyl, cyclobutylethyl, cyclopentylethyl, cyclohexylethyl,
R², R³, R⁴ are each independently hydrogen, fluorine, chlorine, methoxy, ethoxy, methyl, ethyl, trifluoromethyl, optionally substituted phenyl,
R⁵ is amino, methyl, ethyl, n-propyl, 1-methylethyl, n-butyl, 1-methylpropyl, 2-methylpropyl, 1,1-dimethylethyl, n-pentyl, 1-methylbutyl, 2-methylbutyl, 3-methylbutyl, 1,1-dimethylpropyl, 1,2-dimethylpropyl, 2,2-dimethylpropyl, 1-ethylpropyl, n-hexyl, 1-methylpentyl, 2-methylpentyl, 3-methylpentyl, 4-methylpentyl, 1,1-dimethylbutyl, 1,2-dimethylbutyl, 1,3-di-methylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, 1-ethyl-2-methylpropyl, cyclopropyl, cyclobutyl, cyclopentyl, cyclohexyl, spiro[2.2]pent-1-yl, spiro[2.3]hex-1-yl, spiro[2.3]hex-4-yl, 3-spiro[2.3]hex-5-yl, cyclopropylmethyl, cyclobutylmethyl, cyclopentylmethyl, cyclohexylmethyl, trifluoromethyl, difluoromethyl, 2,2-difluoroethyl, 2,2,2-trifluoroethyl, 3,3,3-trifluoropropyl, pentafluoroethyl, heptafluoro-n-propyl, heptafluoroisopropyl, nonafluoro-n-butyl, (C₃-C₆)-halocycloalkyl, (C₄-C₆)-cycloalkenyl, optionally substituted phenyl, heteroaryl, heterocyclyl, aryl-(C₁-C₅)-alkyl, heteroaryl-(C₁-C₅)-alkyl, heterocyclyl-(C₁-C₅)-alkyl, (C₁-C₅)-alkoxycarbonyl-(C₁-C₅)-alkyl, aryl-(C₁-C₅)-alkoxycarbonyl-(C₁-C₅)-alkyl, (C₁-C₆)-cycloalkoxycarbonyl-(C₁-C₅)-alkyl, (C₃-C₆)-cycloalkyl-(C₁-C₅)-alkoxycarbonyl-(C₁-C₅)-alkyl, heteroaryl-(C₁-C₅)-alkoxycarbonyl-(C₁-C₅)-alkyl, aminocarbonyl-(C₁-C₅)-alkyl, (C₁-C₅)-alkylaminocarbonyl-(C₁-C₅)-alkyl, (C₃-C₆)-cycloalkylaminocarbonyl-(C₁-C₅)-alkyl, aryl-(C₁-C₅)-alkylaminocarbonyl-(C₁-C₅)-alkyl, (C₁-C₅)-alkylamino, bis-[(C₁-C₅)-alkyl]amino, arylamino, (C₃-C₆)-cycloalkylamino, aryl-(C₁-C₅)-alkylamino, heteroaryl-(C₁-C₅)-alkylamino, heteroarylamino, heterocyclylamino, (C₂-C₅)-alkenylamino, (C₂-C₅)-alkynylamino, aryloxy-(C₁-C₅)-alkyl, heteroaryloxy-(C₁-C₅)-alkyl, (C₁-C₅)-alkoxy-(C₁-C₅)-alkyl, phenylethenyl, p-chlorophenylethenyl, p-methylphenylethenyl, p-methoxyphenylethenyl, p-trifluoromethylphenylethenyl, p-fluorophenylethenyl, p-cyanophenylethenyl, p-trifluoromethoxyphenylethenyl, p-nitrophenylethenyl, p-bromophenylethenyl, p-iodophenylethenyl, m-chlorophenylethenyl, m-methylphenylethenyl, m-methoxyphenylethenyl, m-trifluoromethylphenylethenyl, m-fluorophenylethenyl, m-cyanophenylethenyl, m-trifluoromethoxyphenylethenyl, m-nitrophenylethenyl, m-bromophenylethenyl, m-iodophenylethenyl, p-methoxycarbonylphenylethenyl, m-methoxycarbonylphenylethenyl, o-methoxycarbonylphenylethenyl, p-ethoxycarbonylphenylethenyl, m-ethoxycarbonylphenylethenyl, o-ethoxycarbonylphenylethenyl, ethenyl, 1-propenyl, 2-propenyl, 1-methylethenyl, 1-butenyl, 2-butenyl, 3-butenyl, 1-methyl-1-propenyl, 2-methyl-1-propenyl, 1-methyl-2-propenyl, 2-methyl-2-propenyl, 1-pentenyl, 2-pentenyl, 3-pentenyl, 4-pentenyl, 1-methyl-1-butenyl, 2-methyl-1-butenyl, 3-methyl-1-butenyl, 1-methyl-2-butenyl, 2-methyl-2-butenyl, 3-methyl-2-butenyl, 1-methyl-3-butenyl, 2-methyl-3-butenyl, 3-methyl-3-butenyl, 1,1-dimethyl-2-propenyl, 1,2-dimethyl-1-propenyl, 1,2-dimethyl-2-propenyl, 1-ethyl-1-propenyl, 1-ethyl-2-propenyl, 1-hexenyl, 2-hexenyl, 3-hexenyl, 4-hexenyl, 5-hexenyl, 1-methyl-1-pentenyl, 2-methyl-1-pentenyl, 3-methyl-1-pentenyl, 4-methyl-1-pentenyl, 1-methyl-2-pentenyl, 2-methyl-2-pentenyl, 3-methyl-2-pentenyl, 4-methyl-2-pentenyl, 1-methyl-3-pentenyl, 2-methyl-3-pentenyl, 3-methyl-3-pentenyl, 4-methyl-3-pentenyl, 1-methyl-4-pentenyl, 2-methyl-4-pentenyl, 3-methyl-4-pentenyl, 4-methyl-4-pentenyl, 1,1-dimethyl-2-butenyl, 1, 1-dimethyl-3-butenyl, 1,2-dimethyl-1-butenyl, 1,2-dimethyl-2-butenyl, 1,2-dimethyl-3-butenyl, 1,3-dimethyl-1-butenyl, 1,3-dimethyl-2-butenyl, 1,3-dimethyl-3-butenyl, 2,2-dimethyl-3-butenyl, 2,3-dimethyl-1-butenyl, 2,3-dimethyl-2-butenyl, 2,3-dimethyl-3-butenyl, 3,3-dimethyl-1-butenyl, 3,3-dimethyl-2-butenyl, 1-ethyl-1-butenyl, 1-ethyl-2-butenyl, 1-ethyl-3-butenyl, 2-ethyl-1-butenyl, 2-ethyl-2-butenyl, 2-ethyl-3-butenyl, 1,1,2-trimethyl-2-propenyl, 1-ethyl-1-methyl-2-propenyl, 1-ethyl-2-methyl-1-propenyl and 1-ethyl-2-methyl-2-propenyl, ethynyl, 1-propynyl, 2-propynyl, 1-butynyl, 2-butynyl, 3-butynyl, 1-methyl-2-propynyl, 1-pentynyl, 2-pentynyl, 3-pentynyl, 4-pentynyl, 1-methyl-2-butynyl, 1-methyl-3-butynyl, 2-methyl-3-butynyl, 3-methyl-1-butynyl, 1,1-dimethyl-2-propynyl, 1-ethyl-2-propynyl, 1-hexynyl, 2-hexynyl, 3-hexynyl, 4-hexynyl, 5-hexynyl, 1-methyl-2-pentynyl, 1-methyl-3-pentynyl, 1-methyl-4-pentynyl, 2-methyl-3-pentynyl, 2-methyl-4-pentynyl, 3-methyl-1-pentynyl, 3-methyl-4-pentynyl, 4-methyl-1-pentynyl, 4-methyl-2-pentynyl, 1,1-dimethyl-2-butynyl, 1,1-dimethyl-3-butynyl, 1,2-dimethyl-3-butynyl, 2,2-dimethyl-3-butynyl, 3,3-dimethyl-1-butynyl, 1-ethyl-2-butynyl, 1-ethyl-3-butynyl, 2-ethyl-3-butynyl, 1-ethyl-1-methyl-2-propynyl, cyanoethyl, cyanomethyl, cyano-n-propyl, cyano-n-butyl, aryloxy, aryl-(C₂-C₅)-alkenyl, heteroaryl-(C₂-C₅)-alkenyl, heterocyclyl-(C₂-C₅)-alkenyl,
R⁶ is hydrogen, methyl, ethyl, n-propyl, 1-methylethyl, n-butyl, 1-methylpropyl, 2-methylpropyl, 1,1-dimethylethyl, n-pentyl, 1-methylbutyl, 2-methylbutyl, 3-methylbutyl, 1,1-dimethylpropyl, 1,2-dimethylpropyl, 2,2-dimethylpropyl, 1-ethylpropyl, n-hexyl, 1-methylpentyl, 2-methylpentyl, 3-methylpentyl, 4-methylpentyl, 1,1-dimethylbutyl, 1,2-dimethylbutyl, 1,3-di-methylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, 1-ethyl-2-methylpropyl, cyclopropyl, cyclobutyl, cyclopentyl, cyclohexyl, cyclopropylmethyl, cyclopropylethyl, cyclobutylmethyl, cyclopentylmethyl, cyclohexylmethyl, 2,2-difluoroethyl, 2,2,2-trifluoroethyl, 3,3,3-trifluoropropyl, cyanomethyl, cyanoethyl, cyano-n-propyl, cyclopropylcarbonyl, cyclobutylcarbonyl, cyclopentylcarbonyl, cyclohexylcarbonyl, methoxycarbonyl, (C₁-C₅)-alkylsulfonyl, arylsulfonyl, aryl-(C₁-C₅)-alkylsulfonyl, heteroarylsulfonyl, (C₃-C₆)-cycloalkylsulfonyl, heterocyclylsulfonyl, (C₁-C₅)-alkylcarbonyl, arylcarbonyl, heteroarylcarbonyl, heterocyclylcarbonyl, (C₁-C₅)-alkoxycarbonyl, aryl-(C₁-C₅)-alkoxycarbonyl, (C₁-C₅)-haloalkylcarbonyl, (C₂-C₅)-alkenyl, (C₂-C₅)-alkynyl, halo-(C₂-C₅)-alkynyl, halo-(C₂-C₅)-alkenyl, (C₁-C₅)-alkoxy-(C₁-C₅)-alkyl,
R⁹, R¹⁰ are each independently hydrogen, methyl, ethyl, isopropyl, n-propyl, fluorine, chlorine, cyano, trifluoromethyl, difluoromethyl, pentafluoroethyl, 3,3,3-trifluoroethyl, cyanomethyl, cyanoethyl, cyano-n-propyl, heteroaryl, cyclopropyl, cyclobutyl, cyclopentyl, cyclohexyl, heterocyclyl, methylthiomethyl, ethylthiomethyl, methylthioethyl, ethylthioethyl and
W is oxygen or sulfur, preferably oxygen.

With regard to the compounds according to the invention, the terms used above and further below will be elucidated. These are familiar to the person skilled in the art and especially have the definitions elucidated hereinafter:

According to the invention, “arylsulfonyl” represents optionally substituted phenylsulfonyl or optionally substituted polycyclic arylsulfonyl, here especially optionally substituted naphthylsulfonyl, for example substituted by fluorine, chlorine, bromine, iodine, cyano, nitro, alkyl, haloalkyl, haloalkoxy, amino, alkylamino, alkylcarbonylamino, dialkylamino or alkoxy groups.

According to the invention, “cycloalkylsulfonyl”—alone or as part of a chemical group—represents optionally substituted cycloalkylsulfonyl, preferably having 3 to 6 carbon atoms, for example cyclopropylsulfonyl, cyclobutylsulfonyl, cyclopentylsulfonyl or cyclohexylsulfonyl.

According to the invention, “alkylsulfonyl”—alone or as part of a chemical group—represents straight-chain or branched alkylsulfonyl, preferably having 1 to 8 or 1 to 6 carbon atoms, for example (but not limited to) (C₁-C₆)-alkylsulfonyl such as methylsulfonyl, ethylsulfonyl, propylsulfonyl, 1-methylethylsulfonyl, butylsulfonyl, 1-methylpropylsulfonyl, 2-methylpropylsulfonyl, 1,1-dimethylethylsulfonyl, pentylsulfonyl, 1-methylbutylsulfonyl, 2-methylbutylsulfonyl, 3-methylbutylsulfonyl, 1,1-dimethylpropylsulfonyl, 1,2-dimethylpropylsulfonyl, 2,2-dimethylpropylsulfonyl, 1-ethylpropylsulfonyl, hexylsulfonyl, 1-methylpentylsulfonyl, 2-methylpentylsulfonyl, 3-methylpentylsulfonyl, 4-methylpentylsulfonyl, 1,1-dimethylbutylsulfonyl, 1,2-dimethylbutylsulfonyl, 1,3-dimethylbutylsulfonyl, 2,2-dimethylbutylsulfonyl, 2,3-dimethylbutylsulfonyl, 3,3-dimethylbutylsulfonyl, 1-ethylbutylsulfonyl, 2-ethylbutylsulfonyl, 1,1,2-trimethylpropylsulfonyl, 1,2,2-trimethylpropylsulfonyl, 1-ethyl-1-methylpropylsulfonyl and 1-ethyl-2-methylpropylsulfonyl.

According to the invention, “heteroarylsulfonyl” represents optionally substituted pyridylsulfonyl, pyrimidinylsulfonyl, pyrazinylsulfonyl or optionally substituted polycyclic heteroarylsulfonyl, here in particular optionally substituted quinolinylsulfonyl, for example substituted by fluorine, chlorine, bromine, iodine, cyano, nitro, alkyl, haloalkyl, haloalkoxy, amino, alkylamino, alkylcarbonylamino, dialkylamino or alkoxy groups.

According to the invention, “alkylthio”—alone or as part of a chemical group—represents straight-chain or branched S-alkyl, preferably having 1 to 8 or 1 to 6 carbon atoms, such as (C₁-C₁₀)-, (C₁-C₆)- or (C₁-C₄)-alkylthio, for example (but not limited to) (C₁-C₆)-alkylthio such as methylthio, ethylthio, propylthio, 1-methylethylthio, butylthio, 1-methylpropylthio, 2-methylpropylthio, 1,1-dimethylethylthio, pentylthio, 1-methylbutylthio, 2-methylbutylthio, 3-methylbutylthio, 1,1-dimethylpropylthio, 1,2-dimethylpropylthio, 2,2-dimethylpropylthio, 1-ethylpropylthio, hexylthio, 1-methylpentylthio, 2-methylpentylthio, 3-methylpentylthio, 4-methylpentylthio, 1,1-dimethylbutylthio, 1,2-dimethylbutylthio, 1,3-dimethylbutylthio, 2,2-dimethylbutylthio, 2,3-dimethylbutylthio, 3,3-dimethylbutylthio, 1-ethylbutylthio, 2-ethylbutylthio, 1,1,2-trimethylpropylthio, 1,2,2-trimethylpropylthio, 1-ethyl-1-methylpropylthio and 1-ethyl-2-methylpropylthio.

According to the invention, alkenylthio means an alkenyl radical bonded via a sulfur atom, alkynylthio is an alkynyl radical bonded via a sulfur atom, cycloalkylthio is a cycloalkyl radical bonded via a sulfur atom, and cycloalkenylthio is a cycloalkenyl radical bonded via a sulfur atom.

According to the invention, alkylsulfinyl (alkyl-S(═O)—), unless defined differently elsewhere, represents alkyl radicals which are bonded to the skeleton via —S(═O)—, such as (C₁-C₁₀)-, (C₁-C₆)- or (C₁-C₄)-alkylsulfinyl, for example (but not limited to) (C₁-C₆)-alkylsulfinyl such as methylsulfinyl, ethylsulfinyl, propylsulfinyl, 1-methylethylsulfinyl, butylsulfinyl, 1-methylpropylsulfinyl, 2-methylpropylulfinyl, 1,1-dimethylethylsulfinyl, pentylsulfinyl, 1-methylbutylsulfinyl, 2-methylbutylsulfinyl, 3-methylbutylsulfinyl, 1,1-dimethylpropylsulfinyl, 1,2-dimethylpropylsulfinyl, 2,2-dimethylpropylsulfinyl, 1-ethylpropylsulfinyl, hexylsulfinyl, 1-methylpentylsulfinyl, 2-methylpentylsulfinyl, 3-methylpentylsulfinyl, 4-methylpentylsulfinyl, 1,1-dimethylbutylsulfinyl, 1,2-dimethylbutylsulfinyl, 1,3-dimethylbutylsulfinyl, 2,2-dimethylbutylsulfinyl, 2,3-dimethylbutylsulfinyl, 3,3-dimethylbutylsulfinyl, 1-ethylbutylsulfinyl, 2-ethylbutylsulfinyl, 1,1,2-trimethylpropylsulfinyl, 1,2,2-trimethylpropylsulfinyl, 1-ethyl-1-methylpropylsulfinyl and 1-ethyl-2-methylpropylsulfinyl.

Analogously, alkenylsulfinyl and alkynylsulfinyl are defined in accordance with the invention respectively as alkenyl and alkynyl radicals bonded to the skeleton via —S(═O)—, such as (C₂-C₁₀)-, (C₂-C₆)- or (C₂-C₄)-alkenylsulfinyl or (C₃-C₁₀)-, (C₃-C₆)- or (C₃-C₄)-alkynylsulfinyl.

Analogously, alkenylsulfonyl and alkynylsulfonyl are defined in accordance with the invention respectively as alkenyl and alkynyl radicals bonded to the skeleton via —S(═O)₂—, such as (C₂-C₁₀)-, (C₂-C₆)- or (C₂-C₄)-alkenylsulfonyl or (C₃-C₁₀)-, (C₃-C₆)- or (C₃-C₄)-alkynylsulfonyl.

“Alkoxy” represents an alkyl radical bonded via an oxygen atom, for example (but not limited to) (C₁-C₆)-alkoxy such as methoxy, ethoxy, propoxy, 1-methylethoxy, butoxy, 1-methylpropoxy, 2-methylpropoxy, 1,1-dimethylethoxy, pentoxy, 1-methylbutoxy, 2-methylbutoxy, 3-methylbutoxy, 1,1-dimethylpropoxy, 1,2-dimethylpropoxy, 2,2-dimethylpropoxy, 1-ethylpropoxy, hexoxy, 1-methylpentoxy, 2-methylpentoxy, 3-methylpentoxy, 4-methylpentoxy, 1,1-dimethylbutoxy, 1,2-dimethylbutoxy, 1,3-dimethylbutoxy, 2,2-dimethylbutoxy, 2,3-dimethylbutoxy, 3,3-dimethylbutoxy, 1-ethylbutoxy, 2-ethylbutoxy, 1,1,2-trimethylpropoxy, 1,2,2-trimethylpropoxy, 1-ethyl-1-methylpropoxy and 1-ethyl-2-methylpropoxy. Alkenyloxy means an alkenyl radical bonded via an oxygen atom, and alkynyloxy means an alkynyl radical bonded via an oxygen atom, such as (C₂-C₁₀)-, (C₂-C₆)- or (C₂-C₄)-alkenoxy and (C₃-C₁₀)-, (C₃-C₆)- or (C₃-C₄)-alkynoxy.

“Cycloalkyloxy” means a cycloalkyl radical bonded via an oxygen atom and cycloalkenyloxy means a cycloalkenyl radical bonded via an oxygen atom.

According to the invention, “alkylcarbonyl” (alkyl-C(═O)—), unless defined differently elsewhere, represents alkyl radicals bonded to the skeleton via —C(═O)—, such as (C₁-C₁₀)-, (C₁-C₆)- or (C₁-C₄)-alkylcarbonyl. The number of the carbon atoms refers here to the alkyl radical in the alkylcarbonyl group.

Analogously, “alkenylcarbonyl” and “alkynylcarbonyl”, unless defined differently elsewhere, in accordance with the invention, respectively represent alkenyl and alkynyl radicals bonded to the skeleton via —C(═O)—, such as (C₂-C₁₀)-, (C₂-C₆)- or (C₂-C₄)-alkenylcarbonyl and (C₂-C₁₀)-, (C₂-C₆)- and (C₂-C₄)-alkynylcarbonyl. The number of the carbon atoms here refers to the alkenyl or alkynyl radical in the alkenyl or alkynyl group.

Alkoxycarbonyl (alkyl-O—C(═O)—), unless defined differently elsewhere: alkyl radicals bonded to the skeleton via —O—C(═O)—, such as (C₁-C₁₀)-, (C₁-C₆)- or (C₁-C₄)-alkoxycarbonyl. The number of the carbon atoms here refers to the alkyl radical in the alkoxycarbonyl group.

Analogously, “alkenyloxycarbonyl” and “alkynyloxycarbonyl”, unless defined differently elsewhere, in accordance with the invention, respectively represent alkenyl and alkynyl radicals bonded to the skeleton via —O—C(═O)—, such as (C₂-C₁₀)-, (C₂-C₆)- or (C₂-C₄)-alkenyloxycarbonyl and (C₃-C₁₀)-, (C₃-C₆)- and (C₃-C₄)-alkynyloxycarbonyl. The number of the carbon atoms here refers to the alkenyl or alkynyl radical in the alkenyloxycarbonyl or alkynyloxycarbonyl group.

According to the invention, the term “alkylcarbonyloxy” (alkyl-C(═O)—O—), unless defined differently elsewhere, represents alkyl radicals bonded to the skeleton via the oxygen of a carbonyloxy group (—C(═O)—O—), such as (C₁-C₁₀)-, (C₁-C₆)- or (C₁-C₄)-alkylcarbonyloxy. The number of the carbon atoms here refers to the alkyl radical in the alkylcarbonyloxy group.

Analogously, “alkenylcarbonyloxy” and “alkynylcarbonyloxy” are defined in accordance with the invention respectively as alkenyl and alkynyl radicals bonded to the skeleton via the oxygen of (—C(═O)—O—), such as (C₂-C₁₀)-, (C₂-C₆)- or (C₂-C₄)-alkenylcarbonyloxy or (C₂-C₁₀)-, (C₂-C₆)- or (C₂-C₄)-alkynylcarbonyloxy. The number of the carbon atoms here refers to the alkenyl or alkynyl radical in the alkenyl- or alkynylcarbonyloxy group respectively.

The term “aryl” means an optionally substituted mono-, bi- or polycyclic aromatic system having preferably 6 to 14, especially 6 to 10, ring carbon atoms, for example phenyl, naphthyl, anthryl, phenanthrenyl and the like, preferably phenyl.

The term “optionally substituted aryl” also embraces polycyclic systems, such as tetrahydronaphthyl, indenyl, indanyl, fluorenyl, biphenylyl, where the bonding site is on the aromatic system. In systematic terms, “aryl” is generally also encompassed by the term “optionally substituted phenyl”. Preferred aryl substituents here are, for example, hydrogen, halogen, alkyl, cycloalkyl, cycloalkylalkyl, cycloalkenyl, halocycloalkyl, alkenyl, alkynyl, aryl, arylalkyl, arylalkenyl, heteroaryl, heteroarylalkyl, heterocyclyl, heterocyclylalkyl, alkoxyalkyl, alkylthio, haloalkylthio, haloalkyl, alkoxy, haloalkoxy, cycloalkoxy, cycloalkylalkoxy, aryloxy, heteroraryloxy, alkoxyalkoxy, alkynylalkoxy, alkenyloxy, bis-alkylaminoalkoxy, tris-[alkyl]silyl, bis-[alkyl]arylsilyl, bis-[alkyl]alkylsilyl, tris-[alkyl]silylalkynyl, arylalkynyl, heteroarylalkynyl, alkylalkynyl, cycloalkylalkynyl, haloalkylalkynyl, heterocyclyl-N-alkoxy, nitro, cyano, amino, alkylamino, bis-alkylamino, alkylcarbonylamino, cycloalkylcarbonylamino, arylcarbonylamino, alkoxycarbonylamino, alkoxycarbonylalkylamino, arylalkoxycarbonylalkylamino, hydroxycarbonyl, alkoxycarbonyl, aminocarbonyl, alkylaminocarbonyl, cycloalkylaminocarbonyl, bis-alkylaminocarbonyl, heteroarylalkoxy, arylalkoxy.

A heterocyclic radical (heterocyclyl) contains at least one heterocyclic ring (=carbocyclic ring in which at least one carbon atom has been replaced by a heteroatom, preferably by a heteroatom from the group of N, O, S, P) which is saturated, unsaturated, partly saturated or heteroaromatic and may be unsubstituted or substituted, in which case the bonding site is localized on a ring atom. If the heterocyclyl radical or the heterocyclic ring is optionally substituted, it may be fused to other carbocyclic or heterocyclic rings. In the case of optionally substituted heterocyclyl, polycyclic systems are also included, for example 8-azabicyclo[3.2.1]octanyl, 8-azabicyclo[2.2.2]octanyl or 1-azabicyclo[2.2.1]heptyl. In the case of optionally substituted heterocyclyl, spirocyclic systems are also included, for example 1-oxa-5-azaspiro[2.3]hexyl. Unless defined differently, the heterocyclic ring contains preferably 3 to 9 ring atoms, especially 3 to 6 ring atoms, and one or more, preferably 1 to 4, especially 1, 2 or 3, heteroatoms in the heterocyclic ring, preferably from the group consisting of N, O and S, though no two oxygen atoms should be directly adjacent, for example with one heteroatom from the group consisting of N, O and S 1- or 2- or 3-pyrrolidinyl, 3,4-dihydro-2H-pyrrol-2- or 3-yl, 2,3-dihydro-1H-pyrrol-1- or 2- or 3- or 4- or 5-yl; 2,5-dihydro-1H-pyrrol-1- or 2- or 3-yl, 1- or 2- or 3- or 4-piperidinyl; 2,3,4,5-tetrahydropyridin-2- or 3- or 4- or 5-yl or 6-yl; 1,2,3,6-tetrahydropyridin-1- or 2- or 3- or 4- or 5- or 6-yl; 1,2,3,4-tetrahydropyridin-1- or 2- or 3- or 4- or 5- or 6-yl; 1,4-dihydropyridin-1- or 2- or 3- or 4-yl; 2,3-dihydropyridin-2- or 3- or 4- or 5- or 6-yl; 2,5-dihydropyridin-2- or 3- or 4- or 5- or 6-yl, 1- or 2- or 3- or 4-azepanyl; 2,3,4,5-tetrahydro-1H-azepin-1- or 2- or 3- or 4- or 5- or 6- or 7-yl; 2,3,4,7-tetrahydro-1H-azepin-1- or 2- or 3- or 4- or 5- or 6- or 7-yl; 2,3,6,7-tetrahydro-1H-azepin-1- or 2- or 3- or 4-yl; 3,4,5,6-tetrahydro-2H-azepin-2- or 3- or 4- or 5- or 6- or 7-yl; 4,5-dihydro-1H-azepin-1- or 2- or 3- or 4-yl; 2,5-dihydro-1H-azepin-1- or -2- or 3- or 4- or 5- or 6- or 7-yl; 2,7-dihydro-1H-azepin-1- or -2- or 3- or 4-yl; 2,3-dihydro-1H-azepin-1- or -2- or 3- or 4- or 5- or 6- or 7-yl; 3,4-dihydro-2H-azepin-2- or 3- or 4- or 5-r 6- or 7-yl; 3,6-dihydro-2H-azepin-2- or 3- or 4- or 5- or 6- or 7-yl; 5,6-dihydro-2H-azepin-2- or 3- or 4- or 5- or 6- or 7-yl; 4,5-dihydro-3H-azepin-2- or 3- or 4- or 5- or 6- or 7-yl; 1H-azepin-1- or -2- or 3- or 4- or 5- or 6- or 7-yl; 2H-azepin-2- or 3- or 4- or 5- or 6- or 7-yl; 3H-azepin-2- or 3- or 4- or 5- or 6- or 7-yl; 4H-azepin-2- or 3- or 4- or 5- or 6- or 7-yl, 2- or 3-oxolanyl (=2- or 3-tetrahydrofuranyl); 2,3-dihydrofuran-2- or 3- or 4- or 5-yl; 2,5-dihydrofuran-2- or 3-yl, 2- or 3- or 4-oxanyl (=2- or 3- or 4-tetrahydropyranyl); 3,4-dihydro-2H-pyran-2- or 3- or 4- or 5- or 6-yl; 3,6-dihydro-2H-pyran-2- or 3- or 4- or 5- or 6-yl; 2H-pyran-2- or 3- or 4- or 5- or 6-yl; 4H-pyran-2- or 3- or 4-yl, 2- or 3- or 4-oxepanyl; 2,3,4,5-tetrahydrooxepin-2- or 3- or 4- or 5- or 6- or 7-yl; 2,3,4,7-tetrahydrooxepin-2- or 3- or 4- or 5- or 6- or 7-yl; 2,3,6,7-tetrahydrooxepin-2- or 3- or 4-yl; 2,3-dihydrooxepin-2- or 3- or 4- or 5- or 6- or 7-yl; 4,5-dihydrooxepin-2- or 3- or 4-yl; 2,5-dihydrooxepin-2- or 3- or 4- or 5- or 6- or 7-yl; oxepin-2- or 3- or 4- or 5- or 6- or 7-yl; 2- or 3-tetrahydrothiophenyl; 2,3-dihydrothiophen-2- or 3- or 4- or 5-yl; 2,5-dihydrothiophen-2- or 3-yl; tetrahydro-2H-thiopyran-2- or 3- or 4-yl; 3,4-dihydro-2H-thiopyran-2- or 3- or 4- or 5- or 6-yl; 3,6-dihydro-2H-thiopyran-2- or 3- or 4- or 5- or 6-yl; 2H-thiopyran-2- or 3- or 4- or 5- or 6-yl; 4H-thiopyran-2- or 3- or 4-yl. Preferred 3-membered and 4-membered heterocycles are, for example, 1- or 2-aziridinyl, oxiranyl, thiiranyl, 1- or 2- or 3-azetidinyl, 2- or 3-oxetanyl, 2- or 3-thietanyl, 1,3-dioxetan-2-yl. Further examples of “heterocyclyl” are a partly or fully hydrogenated heterocyclic radical having two heteroatoms from the group of N, O and S, for example 1- or 2- or 3- or 4-pyrazolidinyl; 4,5-dihydro-3H-pyrazol-3- or 4- or 5-yl; 4,5-dihydro-1H-pyrazol-1- or 3- or 4- or 5-yl; 2,3-dihydro-1H-pyrazol-1- or 2- or 3- or 4- or 5-yl; 1- or 2- or 3- or 4-imidazolidinyl; 2,3-dihydro-1H-imidazol-1- or 2- or 3- or 4-yl; 2,5-dihydro-1H-imidazol-1- or 2- or 4- or 5-yl; 4,5-dihydro-1H-imidazol-1- or 2- or 4- or 5-yl; hexahydropyridazin-1- or 2- or 3- or 4-yl; 1,2,3,4-tetrahydropyridazin-1- or 2- or 3- or 4- or 5- or 6-yl; 1,2,3,6-tetrahydropyridazin-1- or 2- or 3- or 4- or 5- or 6-yl; 1,4,5,6-tetrahydropyridazin-1- or 3- or 4- or 5- or 6-yl; 3,4,5,6-tetrahydropyridazin-3- or 4- or 5-yl; 4,5-dihydropyridazin-3- or 4-yl; 3,4-dihydropyridazin-3- or 4- or 5- or 6-yl; 3,6-dihydropyridazin-3- or 4-yl; 1,6-dihydropyriazin-1- or 3- or 4- or 5- or 6-yl; hexahydropyrimidin-1- or 2- or 3- or 4-yl; 1,4,5,6-tetrahydropyrimidin-1- or 2- or 4- or 5- or 6-yl; 1,2,5,6-tetrahydropyrimidin-1- or 2- or 4- or 5- or 6-yl; 1,2,3,4-tetrahydropyrimidin-1- or 2- or 3- or 4- or 5- or 6-yl; 1,6-dihydropyrimidin-1- or 2- or 4- or 5- or 6-yl; 1,2-dihydropyrimidin-1- or 2- or 4- or 5- or 6-yl; 2,5-dihydropyrimidin-2- or 4- or 5-yl; 4,5-dihydropyrimidin-4- or 5- or 6-yl; 1,4-dihydropyrimidin-1- or 2- or 4- or 5- or 6-yl; 1- or 2- or 3-piperazinyl; 1,2,3,6-tetrahydropyrazin-1- or 2- or 3- or 5- or 6-yl; 1,2,3,4-tetrahydropyrazin-1- or 2- or 3- or 4- or 5- or 6-yl; 1,2-dihydropyrazin-1- or 2- or 3- or 5- or 6-yl; 1,4-dihydropyrazin-1- or 2- or 3-yl; 2,3-dihydropyrazin-2- or 3- or 5- or 6-yl; 2,5-dihydropyrazin-2- or 3-yl; 1,3-dioxolan-2- or 4- or 5-yl; 1,3-dioxol-2- or 4-yl; 1,3-dioxan-2- or 4- or 5-yl; 4H-1,3-dioxin-2- or 4- or 5- or 6-yl; 1,4-dioxan-2- or 3- or 5- or 6-yl; 2,3-dihydro-1,4-dioxin-2- or 3- or 5- or 6-yl; 1,4-dioxin-2- or 3-yl; 1,2-dithiolan-3- or 4-yl; 3H-1,2-dithiol-3- or 4- or 5-yl; 1,3-dithiolan-2- or 4-yl; 1,3-dithiol-2- or 4-yl; 1,2-dithian-3- or 4-yl; 3,4-dihydro-1,2-dithiin-3- or 4- or 5- or 6-yl; 3,6-dihydro-1,2-dithiin-3- or 4-yl; 1,2-dithiin-3- or 4-yl; 1,3-dithian-2- or 4- or 5-yl; 4H-1,3-dithiin-2- or 4- or 5- or 6-yl; isoxazolidin-2- or 3- or 4- or 5-yl; 2,3-dihydroisoxazol-2- or 3- or 4- or 5-yl; 2,5-dihydroisoxazol-2- or 3- or 4- or 5-yl; 4,5-dihydroisoxazol-3- or 4- or 5-yl; 1,3-oxazolidin-2- or 3- or 4- or 5-yl; 2,3-dihydro-1,3-oxazol-2- or 3- or 4- or 5-yl; 2,5-dihydro-1,3-oxazol-2- or 4- or 5-yl; 4,5-dihydro-1,3-oxazol-2- or 4- or 5-yl; 1,2-oxazinan-2- or 3- or 4- or 5- or 6-yl; 3,4-dihydro-2H-1,2-oxazin-2- or 3- or 4- or 5- or 6-yl; 3,6-dihydro-2H-1,2-oxazin-2- or 3- or 4- or 5- or 6-yl; 5,6-dihydro-2H-1,2-oxazin-2- or 3- or 4- or 5- or 6-yl; 5,6-dihydro-4H-1,2-oxazin-3- or 4- or 5- or 6-yl; 2H-1,2-oxazin-2- or 3- or 4- or 5- or 6-yl; 6H-1,2-oxazin-3- or 4- or 5- or 6-yl; 4H-1,2-oxazin-3- or 4- or 5- or 6-yl; 1,3-oxazinan-2- or 3- or 4- or 5- or 6-yl; 3,4-dihydro-2H-1,3-oxazin-2- or 3- or 4- or 5- or 6-yl; 3,6-dihydro-2H-1,3-oxazin-2- or 3- or 4- or 5- or 6-yl; 5,6-dihydro-2H-1,3-oxazin-2- or 4- or 5- or 6-yl; 5,6-dihydro-4H-1,3-oxazin-2- or 4- or 5- or 6-yl; 2H-1,3-oxazin-2- or 4- or 5- or 6-yl; 6H-1,3-oxazin-2- or 4- or 5- or 6-yl; 4H-1,3-oxazin-2- or 4- or 5- or 6-yl; morpholin-2- or 3- or 4-yl; 3,4-dihydro-2H-1,4-oxazin-2- or 3- or 4- or 5- or 6-yl; 3,6-dihydro-2H-1,4-oxazin-2- or 3- or 5- or 6-yl; 2H-1,4-oxazin-2- or 3- or 5- or 6-yl; 4H-1,4-oxazin-2- or 3-yl; 1,2-oxazepan-2- or 3- or 4- or 5- or 6- or 7-yl; 2,3,4,5-tetrahydro-1,2-oxazepin-2- or 3- or 4- or 5- or 6- or 7-yl; 2,3,4,7-tetrahydro-1,2-oxazepin-2- or 3- or 4- or 5- or 6- or 7-yl; 2,3,6,7-tetrahydro-1,2-oxazepin-2- or 3- or 4- or 5- or 6- or 7-yl; 2,5,6,7-tetrahydro-1,2-oxazepin-2- or 3- or 4- or 5- or 6- or 7-yl; 4,5,6,7-tetrahydro-1,2-oxazepin-3- or 4- or 5- or 6- or 7-yl; 2,3-dihydro-1,2-oxazepin-2- or 3- or 4- or 5- or 6- or 7-yl; 2,5-dihydro-1,2-oxazepin-2- or 3- or 4- or 5- or 6- or 7-yl; 2,7-dihydro-1,2-oxazepin-2- or 3- or 4- or 5- or 6- or 7-yl; 4,5-dihydro-1,2-oxazepin-3- or 4- or 5- or 6- or 7-yl; 4,7-dihydro-1,2-oxazepin-3- or 4- or 5- or 6- or 7-yl; 6,7-dihydro-1,2-oxazepin-3- or 4- or 5- or 6- or 7-yl; 1,2-oxazepin-3- or 4- or 5- or 6- or 7-yl; 1,3-oxazepan-2- or 3- or 4- or 5- or 6- or 7-yl; 2,3,4,5-tetrahydro-1,3-oxazepin-2- or 3- or 4- or 5- or 6- or 7-yl; 2,3,4,7-tetrahydro-1,3-oxazepin-2- or 3- or 4- or 5- or 6- or 7-yl; 2,3,6,7-tetrahydro-1,3-oxazepin-2- or 3- or 4- or 5- or 6- or 7-yl; 2,5,6,7-tetrahydro-1,3-oxazepin-2- or 4- or 5- or 6- or 7-yl; 4,5,6,7-tetrahydro-1,3-oxazepin-2- or 4- or 5- or 6- or 7-yl; 2,3-dihydro-1,3-oxazepin-2- or 3- or 4- or 5- or 6- or 7-yl; 2,5-dihydro-1,3-oxazepin-2- or 4- or 5- or 6- or 7-yl; 2,7-dihydro-1,3-oxazepin-2- or 4- or 5- or 6- or 7-yl; 4,5-dihydro-1,3-oxazepin-2- or 4- or 5- or 6- or 7-yl; 4,7-dihydro-1,3-oxazepin-2- or 4- or 5- or 6- or 7-yl; 6,7-dihydro-1,3-oxazepin-2- or 4- or 5- or 6- or 7-yl; 1,3-oxazepin-2- or 4- or 5- or 6- or 7-yl; 1,4-oxazepan-2- or 3- or 5- or 6- or 7-yl; 2,3,4,5-tetrahydro-1,4-oxazepin-2- or 3- or 4- or 5- or 6- or 7-yl; 2,3,4,7-tetrahydro-1,4-oxazepin-2- or 3- or 4- or 5- or 6- or 7-yl; 2,3,6,7-tetrahydro-1,4-oxazepin-2- or 3- or 5- or 6- or 7-yl; 2,5,6,7-tetrahydro-1,4-oxazepin-2- or 3- or 5- or 6- or 7-yl; 4,5,6,7-tetrahydro-1,4-oxazepin-2- or 3- or 4- or 5- or 6- or 7-yl; 2,3-dihydro-1,4-oxazepin-2- or 3- or 5- or 6- or 7-yl; 2,5-dihydro-1,4-oxazepin-2- or 3- or 5- or 6- or 7-yl; 2,7-dihydro-1,4-oxazepin-2- or 3- or 5- or 6- or 7-yl; 4,5-dihydro-1,4-oxazepin-2- or 3- or 4- or 5- or 6- or 7-yl; 4,7-dihydro-1,4-oxazepin-2- or 3- or 4- or 5- or 6- or 7-yl; 6,7-dihydro-1,4-oxazepin-2- or 3- or 5- or 6- or 7-yl; 1,4-oxazepin-2- or 3- or 5- or 6- or 7-yl; isothiazolidin-2- or 3- or 4- or 5-yl; 2,3-dihydroisothiazol-2- or 3- or 4- or 5-yl; 2,5-dihydroisothiazol-2- or 3- or 4- or 5-yl; 4,5-dihydroisothiazol-3- or 4- or 5-yl; 1,3-thiazolidin-2- or 3- or 4- or 5-yl; 2,3-dihydro-1,3-thiazol-2- or 3- or 4- or 5-yl; 2,5-dihydro-1,3-thiazol-2- or 4- or 5-yl; 4,5-dihydro-1,3-thiazol-2- or 4- or 5-yl; 1,3-thiazinan-2- or 3- or 4- or 5- or 6-yl; 3,4-dihydro-2H-1,3-thiazin-2- or 3- or 4- or 5- or 6-yl; 3,6-dihydro-2H-1,3-thiazin-2- or 3- or 4- or 5- or 6-yl; 5,6-dihydro-2H-1,3-thiazin-2- or 4- or 5- or 6-yl; 5,6-dihydro-4H-1,3-thiazin-2- or 4- or 5- or 6-yl; 2H-1,3-thiazin-2- or 4- or 5- or 6-yl; 6H-1,3-thiazin-2- or 4- or 5- or 6-yl; 4H-1,3-thiazin-2- or 4- or 5- or 6-yl. Further examples of “heterocyclyl” are a partly or fully hydrogenated heterocyclic radical having 3 heteroatoms from the group of N, O and S, for example 1,4,2-dioxazolidin-2- or 3- or 5-yl; 1,4,2-dioxazol-3- or 5-yl; 1,4,2-dioxazinan-2- or -3- or 5- or 6-yl; 5,6-dihydro-1,4,2-dioxazin-3- or 5- or 6-yl; 1,4,2-dioxazin-3- or 5- or 6-yl; 1,4,2-dioxazepan-2- or 3- or 5- or 6- or 7-yl; 6,7-dihydro-5H-1,4,2-dioxazepin-3- or 5- or 6- or 7-yl; 2,3-dihydro-7H-1,4,2-dioxazepin-2- or 3- or 5- or 6- or 7-yl; 2,3-dihydro-5H-1,4,2-dioxazepin-2- or 3- or 5- or 6- or 7-yl; 5H-1,4,2-dioxazepin-3- or 5- or 6- or 7-yl; 7H-1,4,2-dioxazepin-3- or 5- or 6- or 7-yl. Structural examples of heterocycles which are optionally substituted further are also listed below:

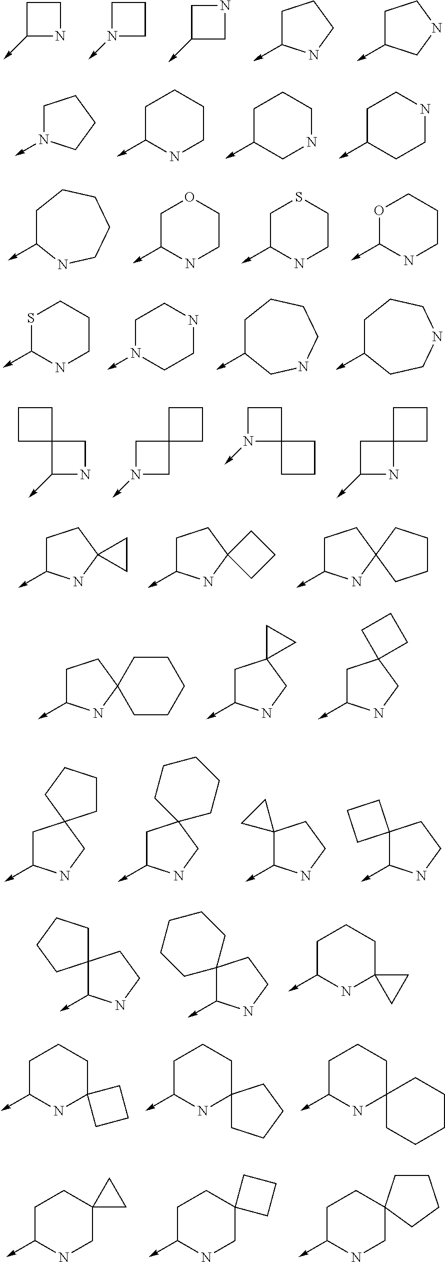

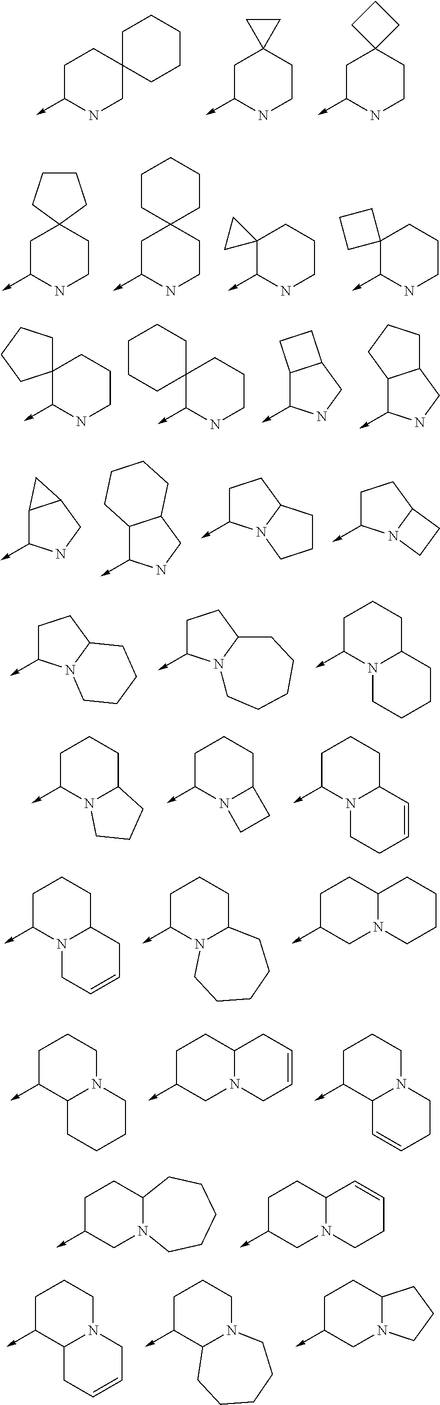

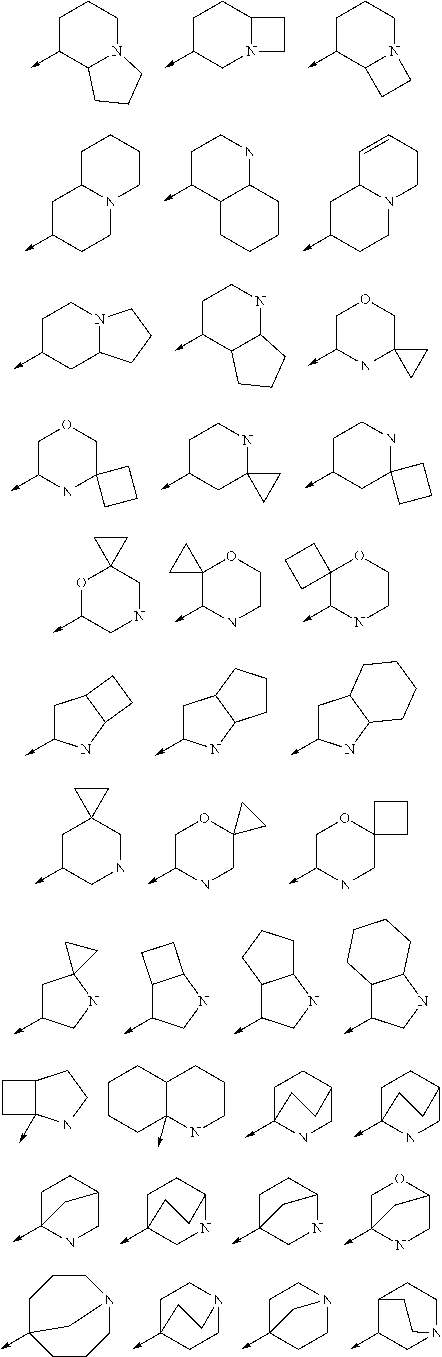

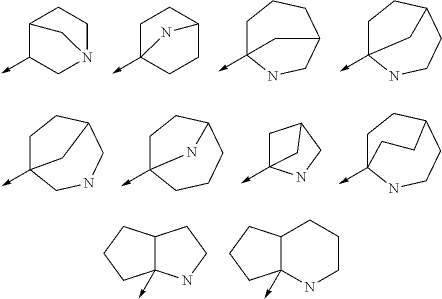

The heterocycles listed above are substituted at one or more positions, preferably at one position, for example in the case of a plurality of substituents by identical or different radicals selected from the group of hydrogen, halogen, alkyl, haloalkyl, hydroxyl, alkoxy, cycloalkoxy, aryloxy, alkoxyalkyl, alkoxyalkoxy, cycloalkyl, halocycloalkyl, aryl, arylalkyl, heteroaryl, heterocyclyl, alkenyl, alkylcarbonyl, cycloalkylcarbonyl, arylcarbonyl, heteroarylcarbonyl, alkoxycarbonyl, hydroxycarbonyl, cycloalkoxycarbonyl, cycloalkylalkoxycarbonyl, alkoxycarbonylalkyl, arylalkoxycarbonyl, arylalkoxycarbonylalkyl, alkynyl, alkynylalkyl, alkylalkynyl, trisalkylsilylalkynyl, nitro, amino, cyano, haloalkoxy, haloalkylthio, alkylthio, hydrothio, hydroxyalkyl, oxo, heteroarylalkoxy, arylalkoxy, heterocyclylalkoxy, heterocyclylalkylthio, heterocyclyloxy, heterocyclylthio, heteroaryloxy, bisalkylamino, alkylamino, cycloalkylamino, hydroxycarbonylalkylamino, alkoxycarbonylalkylamino, arylalkoxycarbonylalkylamino, alkoxycarbonylalkyl(alkyl)amino, aminocarbonyl, alkylaminocarbonyl, bisalkylaminocarbonyl, cycloalkylaminocarbonyl, hydroxycarbonylalkylaminocarbonyl, alkoxycarbonylalkylaminocarbonyl, arylalkoxycarbonylalkylaminocarbonyl.

When a base structure is substituted “by one or more radicals” from a list of radicals (=group) or a generically defined group of radicals, this in each case includes simultaneous substitution by a plurality of identical and/or structurally different radicals.

In the case of a partly or fully saturated nitrogen heterocycle, this may be joined to the remainder of the molecule either via carbon or via the nitrogen.

Suitable substituents for a substituted heterocyclic radical are the substituents specified further down, and additionally also oxo and thioxo. The oxo group as a substituent on a ring carbon atom is then, for example, a carbonyl group in the heterocyclic ring. As a result, lactones and lactams are preferably also included. The oxo group may also occur on the ring heteroatoms, which may exist in different oxidation states, for example in the case of N and S, and in that case form, for example, the divalent —N(O)—, —S(O)— (also SO for short) and —S(O)₂— (also SO₂ for short) groups in the heterocyclic ring. In the case of —N(O)— and —S(O)— groups, both enantiomers in each case are included.

According to the invention, the expression “heteroaryl” represents heteroaromatic compounds, i.e. fully unsaturated aromatic heterocyclic compounds, preferably 5- to 7-membered rings having 1 to 4, preferably 1 or 2, identical or different heteroatoms, preferably O, S or N. Inventive heteroaryls are, for example, 1H-pyrrol-1-yl; 1H-pyrrol-2-yl; 1H-pyrrol-3-yl; furan-2-yl; furan-3-yl; thien-2-yl; thien-3-yl, 1H-imidazol-1-yl; 1H-imidazol-2-yl; 1H-imidazol-4-yl; 1H-imidazol-5-yl; 1H-pyrazol-1-yl; 1H-pyrazol-3-yl; 1H-pyrazol-4-yl; 1H-pyrazol-5-yl, 1H-1,2,3-triazol-1-yl, 1H-1,2,3-triazol-4-yl, 1H-1,2,3-triazol-5-yl, 2H-1,2,3-triazol-2-yl, 2H-1,2,3-triazol-4-yl, 1H-1,2,4-triazol-1-yl, 1H-1,2,4-triazol-3-yl, 4H-1,2,4-triazol-4-yl, 1,2,4-oxadiazol-3-yl, 1,2,4-oxadiazol-5-yl, 1,3,4-oxadiazol-2-yl, 1,2,3-oxadiazol-4-yl, 1,2,3-oxadiazol-5-yl, 1,2,5-oxadiazol-3-yl, azepinyl, pyridin-2-yl, pyridin-3-yl, pyridin-4-yl, pyrazin-2-yl, pyrazin-3-yl, pyrimidin-2-yl, pyrimidin-4-yl, pyrimidin-5-yl, pyridazin-3-yl, pyridazin-4-yl, 1,3,5-triazin-2-yl, 1,2,4-triazin-3-yl, 1,2,4-triazin-5-yl, 1,2,4-triazin-6-yl, 1,2,3-triazin-4-yl, 1,2,3-triazin-5-yl, 1,2,4-, 1,3,2-, 1,3,6- and 1,2,6-oxazinyl, isoxazol-3-yl, isoxazol-4-yl, isoxazol-5-yl, 1,3-oxazol-2-yl, 1,3-oxazol-4-yl, 1,3-oxazol-5-yl, isothiazol-3-yl, isothiazol-4-yl, isothiazol-5-yl, 1,3-thiazol-2-yl, 1,3-thiazol-4-yl, 1,3-thiazol-5-yl, oxepinyl, thiepinyl, 1,2,4-triazolonyl and 1,2,4-diazepinyl, 2H-1,2,3,4-tetrazol-5-yl, 1H-1,2,3,4-tetrazol-5-yl, 1,2,3,4-oxatriazol-5-yl, 1,2,3,4-thiatriazol-5-yl, 1,2,3,5-oxatriazol-4-yl, 1,2,3,5-thiatriazol-4-yl. The heteroaryl groups according to the invention may also be substituted by one or more identical or different radicals. If two adjacent carbon atoms are part of a further aromatic ring, the systems are fused heteroaromatic systems, such as benzofused or polyannulated heteroaromatics. Preferred examples are quinolines (e.g. quinolin-2-yl, quinolin-3-yl, quinolin-4-yl, quinolin-5-yl, quinolin-6-yl, quinolin-7-yl, quinolin-8-yl); isoquinolines (e.g. isoquinolin-1-yl, isoquinolin-3-yl, isoquinolin-4-yl, isoquinolin-5-yl, isoquinolin-6-yl, isoquinolin-7-yl, isoquinolin-8-yl); quinoxaline; quinazoline; cinnoline; 1,5-naphthyridine; 1,6-naphthyridine; 1,7-naphthyridine; 1,8-naphthyridine; 2,6-naphthyridine; 2,7-naphthyridine; phthalazine; pyridopyrazines; pyridopyrimidines; pyridopyridazines; pteridines; pyrimidopyrimidines. Examples of heteroaryl are also 5- or 6-membered benzofused rings from the group of 1H-indol-1-yl, 1H-indol-2-yl, 1H-indol-3-yl, 1H-indol-4-yl, 1H-indol-5-yl, 1H-indol-6-yl, 1H-indol-7-yl, 1-benzofuran-2-yl, 1-benzofuran-3-yl, 1-benzofuran-4-yl, 1-benzofuran-5-yl, 1-benzofuran-6-yl, 1-benzofuran-7-yl, 1-benzothiophen-2-yl, 1-benzothiophen-3-yl, 1-benzothiophen-4-yl, 1-benzothiophen-5-yl, 1-benzothiophen-6-yl, 1-benzothiophen-7-yl, 1H-indazol-1-yl, 1H-indazol-3-yl, 1H-indazol-4-yl, 1H-indazol-5-yl, 1H-indazol-6-yl, 1H-indazol-7-yl, 2H-indazol-2-yl, 2H-indazol-3-yl, 2H-indazol-4-yl, 2H-indazol-5-yl, 2H-indazol-6-yl, 2H-indazol-7-yl, 2H-isoindol-2-yl, 2H-isoindol-1-yl, 2H-isoindol-3-yl, 2H-isoindol-4-yl, 2H-isoindol-5-yl, 2H-isoindol-6-yl; 2H-isoindol-7-yl, 1H-benzimidazol-1-yl, 1H-benzimidazol-2-yl, 1H-benzimidazol-4-yl, 1H-benzimidazol-5-yl, 1H-benzimidazol-6-yl, 1H-benzimidazol-7-yl, 1,3-benzoxazol-2-yl, 1,3-benzoxazol-4-yl, 1,3-benzoxazol-5-yl, 1,3-benzoxazol-6-yl, 1,3-benzoxazol-7-yl, 1,3-benzothiazol-2-yl, 1,3-benzothiazol-4-yl, 1,3-benzothiazol-5-yl, 1,3-benzothiazol-6-yl, 1,3-benzothiazol-7-yl, 1,2-benzisoxazol-3-yl, 1,2-benzisoxazol-4-yl, 1,2-benzisoxazol-5-yl, 1,2-benzisoxazol-6-yl, 1,2-benzisoxazol-7-yl, 1,2-benzisothiazol-3-yl, 1,2-benzisothiazol-4-yl, 1,2-benzisothiazol-5-yl, 1,2-benzisothiazol-6-yl, 1,2-benzisothiazol-7-yl.

The term “halogen” means, for example, fluorine, chlorine, bromine or iodine. If the term is used for a radical, “halogen” means, for example, a fluorine, chlorine, bromine or iodine atom.

According to the invention, “alkyl” means a straight-chain or branched open-chain, saturated hydrocarbon radical which is optionally mono- or polysubstituted. Preferred substituents are halogen atoms, alkoxy, haloalkoxy, cyano, alkylthio, haloalkylthio, amino or nitro groups, particular preference being given to methoxy, methyl, fluoroalkyl, cyano, nitro, fluorine, chlorine, bromine or iodine. The prefix “bis” also includes the combination of different alkyl radicals, e.g. methyl(ethyl) or ethyl(methyl).

“Haloalkyl”, “-alkenyl” and “-alkynyl” are, respectively, alkyl, alkenyl and alkynyl partly or fully substituted by identical or different halogen atoms, for example monohaloalkyl such as CH₂CH₂Cl, CH₂CH₂Br, CHClCH₃, CH₂Cl, CH₂F; perhaloalkyl such as CCl₃, CClF₂, CFCl₂, CF₂CClF₂, CF₂CClFCF₃; polyhaloalkyl such as CH₂CHFCl, CF₂CClFH, CF₂CBrFH, CH₂CF₃; the term perhaloalkyl also encompasses the term perfluoroalkyl.

Partly fluorinated alkyl means a straight-chain or branched, saturated hydrocarbon which is mono- or polysubstituted by fluorine, where the fluorine atoms in question may be present as substituents on one or more different carbon atoms of the straight-chain or branched hydrocarbon chain, for example CHFCH₃, CH₂CH₂F, CH₂CH₂CF₃, CHF₂, CH₂F, CHFCF₂CF₃.

Partly fluorinated haloalkyl means a straight-chain or branched, saturated hydrocarbon which is substituted by different halogen atoms with at least one fluorine atom, where any other halogen atoms optionally present are selected from the group consisting of fluorine, chlorine or bromine, iodine. The corresponding halogen atoms may be present as substituents on one or more different carbon atoms of the straight-chain or branched hydrocarbon chain. Partly fluorinated haloalkyl also includes full substitution of the straight or branched chain by halogen including at least one fluorine atom.

Haloalkoxy is, for example, OCF₃, OCHF₂, OCH₂F, OCF₂CF₃, OCH₂CF₃ and OCH₂CH₂Cl; the situation is equivalent for haloalkenyl and other halogen-substituted radicals.

The expression “(C₁-C₄)-alkyl” mentioned here by way of example is a brief notation for straight-chain or branched alkyl having one to 4 carbon atoms according to the range stated for carbon atoms, i.e. encompasses the methyl, ethyl, 1-propyl, 2-propyl, 1-butyl, 2-butyl, 2-methylpropyl or tert-butyl radicals. General alkyl radicals with a larger specified range of carbon atoms, e.g. “(C₁-C₆)-alkyl”, correspondingly also encompass straight-chain or branched alkyl radicals with a greater number of carbon atoms, i.e. according to the example also the alkyl radicals having 5 and 6 carbon atoms.

Unless stated specifically, preference is given to the lower carbon skeletons, for example having from 1 to 6 carbon atoms, or having from 2 to 6 carbon atoms in the case of unsaturated groups, in the case of the hydrocarbyl radicals such as alkyl, alkenyl and alkynyl radicals, including in composite radicals. Alkyl radicals, including in composite radicals such as alkoxy, haloalkyl, etc., are, for example, methyl, ethyl, n-propyl or i-propyl, n-, i-, t- or 2-butyl, pentyls, hexyls such as n-hexyl, i-hexyl and 1,3-dimethylbutyl, heptyls such as n-heptyl, 1-methylhexyl and 1,4-dimethylpentyl; alkenyl and alkynyl radicals are defined as the possible unsaturated radicals corresponding to the alkyl radicals, where at least one double bond or triple bond is present. Preference is given to radicals having one double bond or triple bond.

The term “alkenyl” also includes, in particular, straight-chain or branched open-chain hydrocarbon radicals having more than one double bond, such as 1,3-butadienyl and 1,4-pentadienyl, but also allenyl or cumulenyl radicals having one or more cumulated double bonds, for example allenyl (1,2-propadienyl), 1,2-butadienyl and 1,2,3-pentatrienyl. Alkenyl means, for example, vinyl which may optionally be substituted by further alkyl radicals, for example (but not limited thereto) (C₂-C₆)-alkenyl such as ethenyl, 1-propenyl, 2-propenyl, 1-methylethenyl, 1-butenyl, 2-butenyl, 3-butenyl, 1-methyl-1-propenyl, 2-methyl-1-propenyl, 1-methyl-2-propenyl, 2-methyl-2-propenyl, 1-pentenyl, 2-pentenyl, 3-pentenyl, 4-pentenyl, 1-methyl-1-butenyl, 2-methyl-1-butenyl, 3-methyl-1-butenyl, 1-methyl-2-butenyl, 2-methyl-2-butenyl, 3-methyl-2-butenyl, 1-methyl-3-butenyl, 2-methyl-3-butenyl, 3-methyl-3-butenyl, 1,1-dimethyl-2-propenyl, 1,2-dimethyl-1-propenyl, 1,2-dimethyl-2-propenyl, 1-ethyl-1-propenyl, 1-ethyl-2-propenyl, 1-hexenyl, 2-hexenyl, 3-hexenyl, 4-hexenyl, 5-hexenyl, 1-methyl-1-pentenyl, 2-methyl-1-pentenyl, 3-methyl-1-pentenyl, 4-methyl-1-pentenyl, 1-methyl-2-pentenyl, 2-methyl-2-pentenyl, 3-methyl-2-pentenyl, 4-methyl-2-pentenyl, 1-methyl-3-pentenyl, 2-methyl-3-pentenyl, 3-methyl-3-pentenyl, 4-methyl-3-pentenyl, 1-methyl-4-pentenyl, 2-methyl-4-pentenyl, 3-methyl-4-pentenyl, 4-methyl-4-pentenyl, 1,1-dimethyl-2-butenyl, 1,1-dimethyl-3-butenyl, 1,2-dimethyl-1-butenyl, 1,2-dimethyl-2-butenyl, 1,2-dimethyl-3-butenyl, 1,3-dimethyl-1-butenyl, 1,3-dimethyl-2-butenyl, 1,3-dimethyl-3-butenyl, 2,2-dimethyl-3-butenyl, 2,3-dimethyl-1-butenyl, 2,3-dimethyl-2-butenyl, 2,3-dimethyl-3-butenyl, 3,3-dimethyl-1-butenyl, 3,3-dimethyl-2-butenyl, 1-ethyl-1-butenyl, 1-ethyl-2-butenyl, 1-ethyl-3-butenyl, 2-ethyl-1-butenyl, 2-ethyl-2-butenyl, 2-ethyl-3-butenyl, 1,1,2-trimethyl-2-propenyl, 1-ethyl-1-methyl-2-propenyl, 1-ethyl-2-methyl-1-propenyl and 1-ethyl-2-methyl-2-propenyl.

The term “alkynyl” also includes, in particular, straight-chain or branched open-chain hydrocarbon radicals having more than one triple bond, or else having one or more triple bonds and one or more double bonds, for example 1,3-butatrienyl or 3-penten-1-yn-1-yl. (C₂-C₆)-Alkynyl is, for example, ethynyl, 1-propynyl, 2-propynyl, 1-butynyl, 2-butynyl, 3-butynyl, 1-methyl-2-propynyl, 1-pentynyl, 2-pentynyl, 3-pentynyl, 4-pentynyl, 1-methyl-2-butynyl, 1-methyl-3-butynyl, 2-methyl-3-butynyl, 3-methyl-1-butynyl, 1,1-dimethyl-2-propynyl, 1-ethyl-2-propynyl, 1-hexynyl, 2-hexynyl, 3-hexynyl, 4-hexynyl, 5-hexynyl, 1-methyl-2-pentynyl, 1-methyl-3-pentynyl, 1-methyl-4-pentynyl, 2-methyl-3-pentynyl, 2-methyl-4-pentynyl, 3-methyl-1-pentynyl, 3-methyl-4-pentynyl, 4-methyl-1-pentynyl, 4-methyl-2-pentynyl, 1,1-dimethyl-2-butynyl, 1,1-dimethyl-3-butynyl, 1,2-dimethyl-3-butynyl, 2,2-dimethyl-3-butynyl, 3,3-dimethyl-1-butynyl, 1-ethyl-2-butynyl, 1-ethyl-3-butynyl, 2-ethyl-3-butynyl and 1-ethyl-1-methyl-2-propynyl.

The term “cycloalkyl” means a carbocyclic saturated ring system having preferably 3-8 ring carbon atoms, for example cyclopropyl, cyclobutyl, cyclopentyl or cyclohexyl, which optionally has further substitution, preferably by hydrogen, alkyl, alkoxy, cyano, nitro, alkylthio, haloalkylthio, halogen, alkenyl, alkynyl, haloalkyl, amino, alkylamino, bisalkylamino, alkoxycarbonyl, hydroxycarbonyl, arylalkoxycarbonyl, aminocarbonyl, alkylaminocarbonyl, cycloalkylaminocarbonyl. In the case of optionally substituted cycloalkyl, cyclic systems with substituents are included, also including substituents with a double bond on the cycloalkyl radical, for example an alkylidene group such as methylidene. In the case of optionally substituted cycloalkyl, polycyclic aliphatic systems are also included, for example bicyclo[1.1.0]butan-1-yl, bicyclo[1.1.0]butan-2-yl, bicyclo[2.1.0]pentan-1-yl, bicyclo[1.1.1]pentan-1-yl, bicyclo[2.1.0]pentan-2-yl, bicyclo[2.1.0]pentan-5-yl, bicyclo[2.1.1]hexyl, bicyclo[2.2.1]hept-2-yl, bicyclo[2.2.2]octan-2-yl, bicyclo[3.2.1]octan-2-yl, bicyclo[3.2.2]nonan-2-yl, adamantan-1-yl and adamantan-2-yl, but also systems such as 1,1′-bi(cyclopropyl)-1-yl, 1,1′-bi(cyclopropyl)-2-yl, for example. The term “(C₃-C₇)-cycloalkyl” is a brief notation for cycloalkyl having three to 7 carbon atoms, corresponding to the range specified for carbon atoms.

In the case of substituted cycloalkyl, spirocyclic aliphatic systems are also included, for example spiro[2.2]pent-1-yl, spiro[2.3]hex-1-yl, spiro[2.3]hex-4-yl, 3-spiro[2.3]hex-5-yl, spiro[3.3]hept-1-yl, spiro[3.3]hept-2-yl.

“Cycloalkenyl” means a carbocyclic, nonaromatic, partly unsaturated ring system having preferably 4-8 carbon atoms, e.g. 1-cyclobutenyl, 2-cyclobutenyl, 1-cyclopentenyl, 2-cyclopentenyl, 3-cyclopentenyl, or 1-cyclohexenyl, 2-cyclohexenyl, 3-cyclohexenyl, 1,3-cyclohexadienyl or 1,4-cyclohexadienyl, also including substituents with a double bond on the cycloalkenyl radical, for example an alkylidene group such as methylidene. In the case of optionally substituted cycloalkenyl, the elucidations for substituted cycloalkyl apply correspondingly.

The term “alkylidene”, also, for example, in the form (C₁-C₁₀)-alkylidene, means the radical of a straight-chain or branched open-chain hydrocarbon radical which is attached via a double bond. Possible bonding sites for alkylidene are naturally only positions on the base structure where two hydrogen atoms can be replaced by the double bond; radicals are, for example, ═CH₂, ═CH—CH₃, ═C(CH₃)—CH₃, ═C(CH₃)—C₂H₅ or ═C(C₂H₅)—C₂H₅. Cycloalkylidene is a carbocyclic radical bonded via a double bond.

Depending on the nature of the substituents and the manner in which they are attached, the compounds of the general formula (I) may be present as stereoisomers. The formula (I) embraces all possible stereoisomers defined by the specific three-dimensional form thereof, such as enantiomers, diastereomers, Z and E isomers. If, for example, one or more alkenyl groups are present, diastereomers (Z and E isomers) may occur. If, for example, one or more asymmetric carbon atoms are present, enantiomers and diastereomers may occur. Stereoisomers can be obtained from the mixtures obtained in the preparation by customary separation methods. The chromatographic separation can be effected either on the analytical scale to find the enantiomeric excess or the diastereomeric excess, or else on the preparative scale to produce test specimens for biological testing. It is likewise possible to selectively prepare stereoisomers by using stereoselective reactions with use of optically active starting materials and/or auxiliaries. The invention thus also relates to all stereoisomers which are embraced by the general formula (I) but are not shown in their specific stereomeric form, and to mixtures thereof.

Synthesis of Oxotetrahydroquinolinylsulfonamides:

The inventive oxotetrahydroquinolinylsulfonamides of the general formula (I), optionally having further substitution, can be prepared by known processes. The synthesis routes used and examined proceed from commercially available or easily preparable oxotetrahydroquinolinylsulfonamides and the corresponding sulfonyl chlorides. Oxotetrahydroquinolinylsulfonamides optionally having further substitution (A) can be prepared proceeding from correspondingly substituted anilines (scheme 1). In this case, an aniline optionally having further substitution can be coupled with an appropriate halopropionyl halide using a suitable base in a suitable polar-aprotic solvent and, in the subsequent step, reacted with a suitable Lewis acid in a Friedel-Crafts alkylation to give correspondingly substituted oxotetrahydroquinolines in which, in further reaction steps, first the CR¹R⁹R¹⁰ radical, where R¹, R⁹ and R¹⁰ are as defined further up, is introduced with the aid of a suitable base (e.g. sodium hydride, potassium carbonate or cesium carbonate) in a suitable polar-aprotic solvent (e.g. acetonitrile or N,N-dimethylformamide, also corresponding to the abbreviation DMF), the product is nitrated with a suitable nitrating acid (e.g. conc. nitric acid) and then the nitro group is converted to the corresponding amino group with the aid of a suitable reducing agent (e.g. tin(II) chloride dihydrate, iron in acetic acid or hydrogen over palladium on charcoal). In this way, the desired illustrative substituted oxotetrahydroquinolinylamines (A) are obtained (cf. US2008/0234237, J. Med. Chem. 1986, 29(12), 2433 and Eur. J. Med. Chem. 2008, 43, 1730, J. Med. Chem. 2011, 54, 5562). Alternatively, a nitro-substituted oxotetrahydroquinoline can be obtained via a tandem reaction, mediated by tributyltin hydride and azobis(isobutyronitrile) (corresponding to the abbreviation AIBN), of an alkyl acrylate optionally having further substitution with an o-haloaniline optionally having further substitution (cf. Tetrahedron 2009, 65, 1982; B. Giese et al. Org. React. 1996, 48). This mode of cyclization can also be conducted by electrocatalytic or photochemical means (cf. J. Org. Chem. 1991, 56, 3246; J. Am. Chem. Soc. 2009, 131, 5036; Photochem. & Photobiol. Sci. 2009, 8, 751). A further alternative for preparation of nitro-substituted oxotetrahydroquinolines is the Beckmann rearrangement of indanooximes optionally having further substitution. Scheme 1 shows this reaction sequence for preparation of optionally substituted oxotetrahydroquinolinylamines (A) by way of example but without restriction with R², R³, R⁴, R⁷, R⁸=hydrogen and X and Y=H, and R¹, R⁹ and R¹⁰ are as defined above.

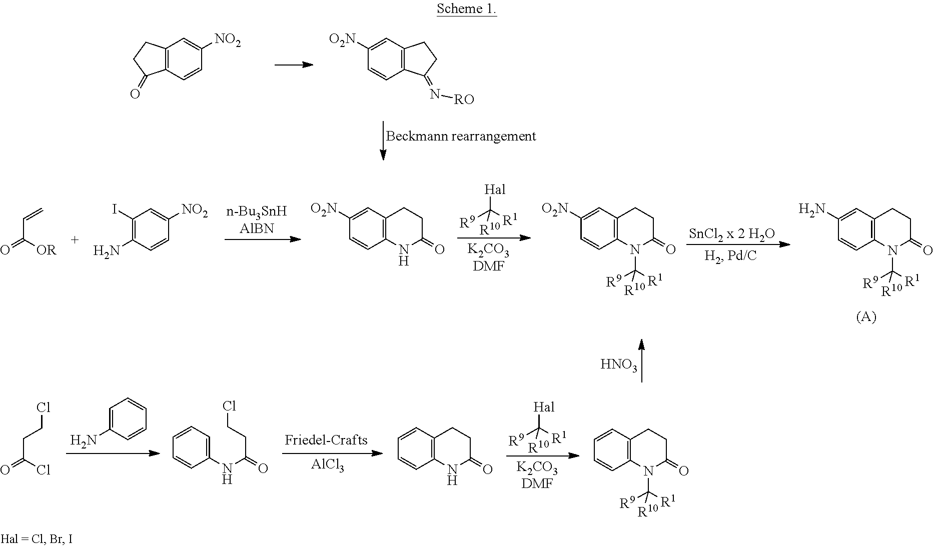

Oxotetrahydroquinolinylamines in which the CR¹R⁹R¹⁰ radical where R¹, R⁹ and R¹⁰ are as defined further up can be introduced only with difficulty, if at all, by simple alkylation can be prepared via alternative synthesis routes. By way of example, but without restriction, some of these routes are described hereinafter. When CR¹R⁹R¹⁰=bis-cyclopropylmethyl, the synthesis proceeds at first via Pd-mediated coupling of an aryl bromide with bis-cyclopropylmethylamine using suitable Pd catalysts (e.g. Pd₂(dba)₃) and phosphorus-containing ligands (e.g. BINAP, t-BuXPhos) (cf. Tetrahedron 2001, 57, 2953, WO2012/168350, Angew. Chem. Int. Ed. 2012, 51, 222; Tetrahedron 2001, 57, 2953), by copper(II) chloride-mediated coupling or by copper acetate-mediated reaction of bis(cyclopropylmethyl)amine with triphenylbismuth (cf. Chem. Commun. 2011, 47, 897; J. Med. Chem. 2003, 46, 623) are prepared. The abbreviation ‘dba’ stands for dibenzylideneacetone, BINAP stands for 2,2′-bis(diphenylphosphino)-1,1′-binaphthyl, while t-BuXPhos stands for 2-di-tert-butylphosphino-3,4,5,6-tetramethyl-2′,4′,6′-triisopropyl-1,1′-biphenyl. Thereafter, the N-bis(cyclopropylmethyl)aniline optionally having further substitution can be coupled with an appropriate halopropionyl halide using a suitable base in a suitable polar-aprotic solvent and, in the subsequent step, reacted with a suitable Lewis acid (e.g. aluminum trichloride or titanium tetrachloride) in a Friedel-Crafts alkylation to give a corresponding N-[bis(cyclopropylmethyl)]-substituted oxotetrahydroquinoline, which can be converted by nitration with nitric acid and subsequent reduction with a suitable reducing agent (e.g. tin(II) chloride hydrate, iron in acetic acid or hydrogen with palladium on charcoal) to the desired N-[bis(cyclopropylmethyl)]-substituted oxotetrahydroquinolinylamine (B) optionally having further substitution. Scheme 2 shows this reaction sequence by way of example but without restriction with R², R³, R⁴=hydrogen, and R⁷, R⁸, X and Y=H and R¹, R⁹=cyclopropyl and R¹⁰=H.

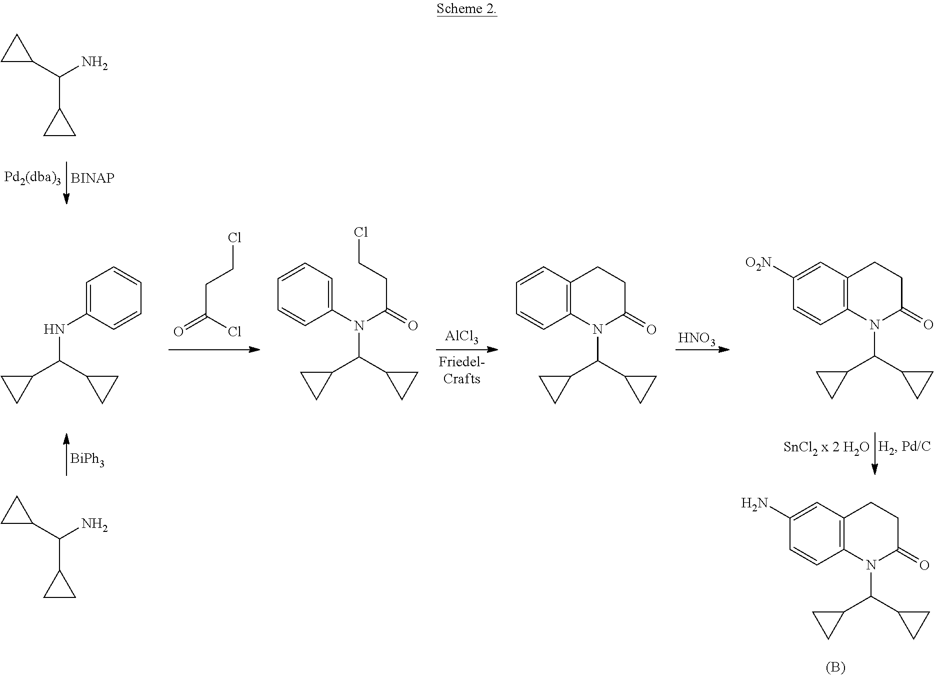

When R¹=haloalkyl, the synthesis of the N-haloalkylmethyl-substituted oxotetrahydroquinolinylamines optionally having further substitution proceeds, by way of example but without restriction, via an alkylation using a suitable haloalkyl trifluoromethanesulfonate and a suitable base (e.g. sodium hydride) in a suitable polar-aprotic solvent (e.g. N,N-dimethylformamide or acetonitrile). Thereafter, the N-haloalkylmethyl-substituted nitrooxotetrahydroquinoline can be converted by reduction with a suitable reducing agent (e.g. tin(II) chloride hydrate, iron in acetic acid or hydrogen with palladium on charcoal) to the desired N-haloalkylmethyl-substituted oxotetrahydroquinolinylamine (C) optionally having further substitution. Scheme 3 shows this reaction sequence by way of example but without restriction with difluoroethyl trifluoromethanesulfonate as reagent, R², R³, R⁴=hydrogen, and R⁷, R⁸, X and Y=H and R¹=CHF₂ and R⁹, R¹⁰=H.

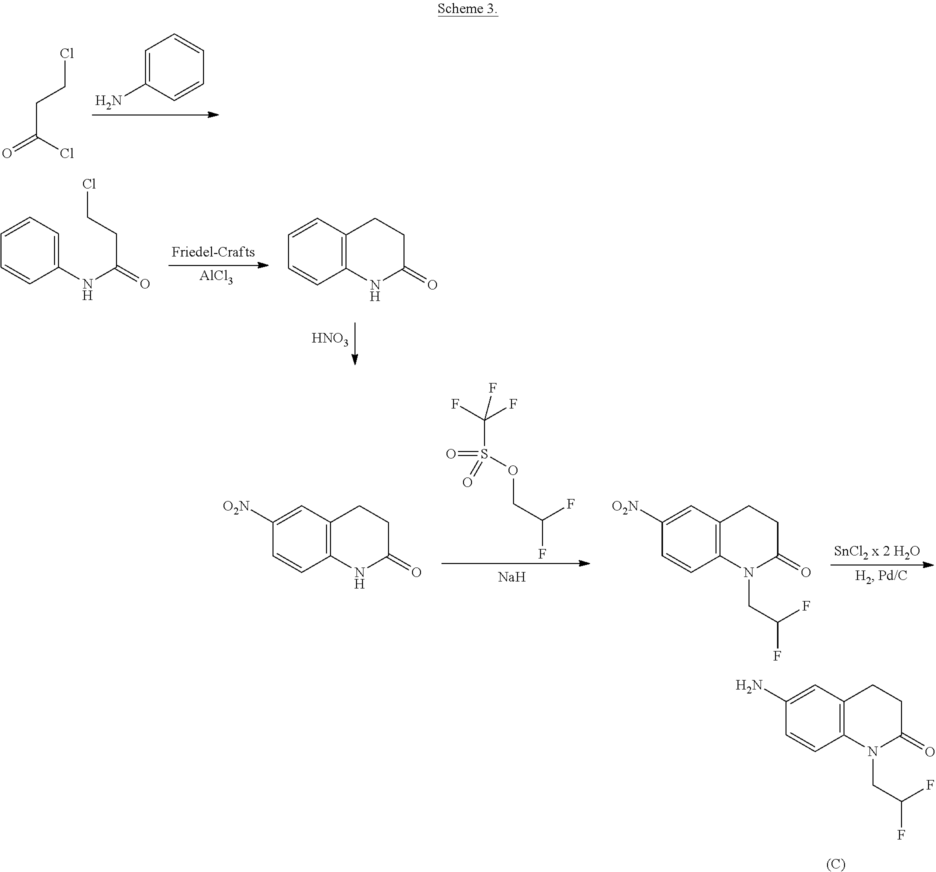

Aryl- and heteroarylsulfonyl chloride precursors can be prepared, for example, by direct chlorosulfonation of the corresponding substituted aromatics and heteroaromatics (cf. Eur J. Med. Chem. 2010, 45, 1760) or by diazotization of an amino-substituted aromatic or heteroaromatic and subsequent chlorosulfonation (cf. WO2005/035486). Coupling of the corresponding substituted sulfonyl chloride precursors with the appropriate oxotetrahydroquinolinylamines optionally having further substitution with the aid of a suitable base (e.g. triethylamine, pyridine or sodium hydroxide) in a suitable solvent (e.g. tetrahydrofuran, acetonitrile, DMSO or dichloromethane) affords the inventive oxotetrahydroquinolinylsulfonamides optionally having further substitution (for example sub-class (Iaa)). In scheme 5 below, R¹, R², R³, R⁴, R⁵, R⁶, R⁹ and R¹⁰ are each as defined above. R⁷, R⁸, X and Y are represented by way of example but without restriction by H.

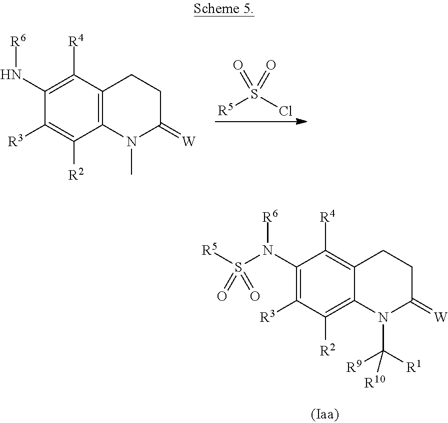

Selected detailed synthesis examples for the compounds of the general formula (I) according to the invention are given below. The example numbers mentioned correspond to the numbering scheme in Tables A1 to J5 below. The ¹H NMR, ¹³C NMR and ¹⁹F NMR spectroscopy data reported for the chemical examples described in the sections which follow (400 MHz for ¹H NMR and 150 MHz for ¹³C NMR and 375 MHz for ¹⁹F NMR, solvent CDCl₃, CD₃OD or d₆-DMSO, internal standard: tetramethylsilane δ=0.00 ppm) were obtained on a Bruker instrument, and the signals listed have the meanings given below: br=broad; s=singlet, d=doublet, t=triplet, dd=doublet of doublets, ddd=doublet of a doublet of doublets, m=multiplet, q=quartet, quint=quintet, sext=sextet, sept=septet, dq=doublet of quartets, dt=doublet of triplets, tt=triplet of triplets. In the case of diastereomer mixtures, either the significant signals for each of the two diastereomers are reported or the characteristic signal of the main diastereomer is reported. The abbreviations used for chemical groups are defined as follows: Me=CH₃, Et=CH₂CH₃, t-Hex=C(CH₃)₂CH(CH₃)₂, t-Bu=C(CH₃)₃, n-Bu=unbranched butyl, n-Pr=unbranched propyl, c-Hex=cyclohexyl.

### No. A1-153

### N-[1-(2,2-Difluoroethyl)-2-oxo-1,2,3,4-tetrahydroquinolin-6-yl]-1-(3-methylphenyl)methanesulfonamide

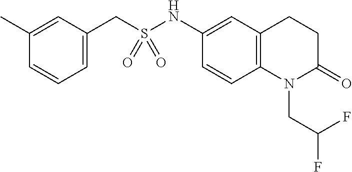 [SMILES: Cc1cccc(CS(=O)(=O)Nc2ccc3c(c2)CCC(=O)N3CC(F)F)c1]

3,4-Dihydroquinolin-2(1H)-one (1.54 g, 7.66 mmol) was added to conc. acetic acid (10 mL) and then cautiously admixed with fuming nitric acid (0.42 mL, 10.12 mmol). The resulting reaction mixture was stirred at room temperature for 2 h and then diluted with ice-water. The aqueous phase was then repeatedly extracted with ethyl acetate. The combined organic phases were dried over magnesium sulfate, filtered and concentrated under reduced pressure. By column chromatography purification of the crude product obtained (ethyl acetate/heptane gradient), 6-nitro-3,4-dihydroquinolin-2(1H)-one (1.09 g, 69% of theory) was isolated as a colorless solid. 6-Nitro-3,4-dihydroquinolin-2(1H)-one (2000 mg, 2.60 mmol) was dissolved under argon in abs. N,N-dimethylformamide, cooled down to a temperature of 0° C. and admixed with sodium hydride (458 mg, 11.45 mmol, 60% purity). After stirring at room temperature for 30 min, a solution of 2,2-difluoroethyl trifluoromethanesulfonate (223 mg, 10.41 mmol) in abs. N,N-dimethylformamide was slowly added dropwise, again while cooling with ice. The resulting reaction mixture was stirred at room temperature for 3 h, and water and ethyl acetate were then added. The aqueous phase was then repeatedly extracted with ethyl acetate. The combined organic phases were dried over magnesium sulfate, filtered and concentrated under reduced pressure. By column chromatography purification of the crude product obtained (ethyl acetate/heptane gradient), 1-(2,2-difluoroethyl)-6-nitro-3,4-dihydroquinolin-2(1H)-one (1.80 g, 64% of theory) was isolated as a colorless solid. In the next step, 1-(2,2-difluoroethyl)-6-nitro-3,4-dihydroquinolin-2(1H)-one (1.80 g, 7.03 mmol) was added together with tin(II) chloride dihydrate (6.34 g, 28.10 mmol) to abs. ethanol and the mixture was stirred under argon at a temperature of 60° C. for 4 h. After cooling to room temperature, the reaction mixture was poured into ice-water and then adjusted to pH 12 using aqueous NaOH. The aqueous phase was then repeatedly extracted with ethyl acetate. The combined organic phases were dried over magnesium sulfate, filtered and concentrated under reduced pressure. By column chromatography purification of the crude product obtained (ethyl acetate/heptane gradient), 6-amino-1-(2,2-difluoroethyl)-3,4-dihydroquinolin-2(1H)-one (1.56 g, 93% of theory) was isolated as a colorless solid. 6-Amino-1-(2,2-difluoroethyl)-3,4-dihydroquinolin-2(1H)-one (142 mg, 0.63 mmol) was dissolved together with (3-methylphenyl)methanesulfonyl chloride (167 mg, 0.82 mmol) in abs. acetonitrile (105 mL) in a baked-out round-bottom flask under argon, then pyridine (0.16 mL, 1.95 mmol) was added and the mixture was stirred at a temperature of 70° C. for 3 h. The reaction mixture was then concentrated under reduced pressure, the remaining residue was admixed with dil. HCl and dichloromethane, and the aqueous phase was extracted repeatedly with dichloromethane. The combined organic phases were dried over magnesium sulfate, filtered and concentrated under reduced pressure. By column chromatography purification of the crude product obtained (ethyl acetate/heptane gradient), N-[1-(2,2-difluoroethyl)-2-oxo-1,2,3,4-tetrahydroquinolin-6-yl]-1-(3-methylphenyl)methanesulfonamide (181 mg, 69% of theory) was isolated as a colorless solid. ¹H-NMR (400 MHz, CDCl₃ δ, ppm) 7.25 (m, 1H), 7.20 (m, 1H), 7.13-7.05 (m, 3H), 7.00 (m, 1H), 6.94 (m, 1H), 6.25-5.97 (tt, 1H), 6.18 (s, 1H, NH), 4.30 (s, 2H), 4.28-4.19 (m, 2H), 2.91 (m, 2H), 2.70 (m, 2H), 2.34 (s, 3H).

### No. A19-153

### N-[1-(Cyclopropylmethyl)-2-oxo-1,2,3,4-tetrahydroquinolin-6-yl]-1-(3-methylphenyl)methanesulfonamide

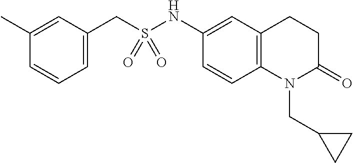 [SMILES: Cc1cccc(CS(=O)(=O)Nc2ccc3c(c2)CCC(=O)N3CC2CC2)c1]

3,4-Dihydroquinolin-2(1H)-one (770 mg, 3.83 mmol) was added to conc. acetic acid (5 mL) and then cautiously admixed with fuming nitric acid (0.21 mL, 5.06 mmol). The resulting reaction mixture was stirred at room temperature for 2 h and then diluted with ice-water. The aqueous phase was then repeatedly extracted with ethyl acetate. The combined organic phases were dried over magnesium sulfate, filtered and concentrated under reduced pressure. By column chromatography purification of the crude product obtained (ethyl acetate/heptane gradient), 6-nitro-3,4-dihydroquinolin-2(1H)-one (500 mg, 68% of theory) was isolated as a colorless solid. 6-Nitro-3,4-dihydroquinolin-2(1H)-one (500 mg, 2.60 mmol) was dissolved under argon in abs. N,N-dimethylformamide and admixed with fine potassium carbonate powder (1.08 mg, 7.81 mmol). After stirring at room temperature for 5 min, chloromethylcyclopropane (306 mg, 3.38 mmol) and potassium iodide (6 mg, 0.04 mmol) were added. The resulting reaction mixture was stirred at 120° C. for 2 h and, after cooling to room temperature, water and ethyl acetate were added. The aqueous phase was then repeatedly extracted with ethyl acetate. The combined organic phases were dried over magnesium sulfate, filtered and concentrated under reduced pressure. By column chromatography purification of the crude product obtained (ethyl acetate/heptane gradient), 1-(cyclopropylmethyl)-6-nitro-3,4-dihydroquinolin-2(1H)-one (600 mg, 94% of theory) was isolated as a colorless solid. ¹H-NMR (400 MHz, CDCl₃ δ, ppm) 8.17 (dd, 1H), 8.08 (d, 1H), 7.22 (d, 1H), 3.91 (d, 2H), 3.04 (m, 2H), 2.73 (m, 2H), 1.12 (m, 1H), 0.55 (m, 2H), 0.45 (m, 2H). In the next step, 1-(cyclopropylmethyl)-6-nitro-3,4-dihydroquinolin-2(1H)-one (600 mg, 2.44 mmol) was added together with tin(II) chloride dihydrate (2.19 g, 9.75 mmol) to abs. ethanol and the mixture was stirred under argon at a temperature of 80° C. for 5 h. After cooling to room temperature, the reaction mixture was poured into ice-water and then adjusted to pH 12 using aqueous NaOH. The aqueous phase was then repeatedly extracted with ethyl acetate. The combined organic phases were dried over magnesium sulfate, filtered and concentrated under reduced pressure. By column chromatography purification of the crude product obtained (ethyl acetate/heptane gradient), 6-amino-1-(cyclopropylmethyl)-3,4-dihydroquinolin-2(1H)-one (481 mg, 91% of theory) was isolated as a colorless solid. ¹H-NMR (400 MHz, CDCl₃ δ, ppm) 6.94 (d, 1H), 6.58 (dd, 1H), 6.53 (d, 1H), 3.83 (d, 3H), 2.81 (m, 2H), 2.61 (m, 2H), 1.12 (m, 1H), 0.47 (m, 2H), 0.39 (m, 2H). 6-Amino-1-cyclopropylmethyl-3,4-dihydroquinolin-2(1H)-one (120 mg, 0.56 mmol) was dissolved together with (3-methylphenyl)methanesulfonyl chloride (125 mg, 0.61 mmol) in abs. acetonitrile (5 mL) in a baked-out round-bottom flask under argon, then pyridine (0.09 mL, 1.11 mmol) was added and the mixture was stirred at room temperature for 8 h. The reaction mixture was then concentrated under reduced pressure, the remaining residue was admixed with dil. HCl and dichloromethane, and the aqueous phase was extracted repeatedly with dichloromethane. The combined organic phases were dried over magnesium sulfate, filtered and concentrated under reduced pressure. By column chromatography purification of the crude product obtained (ethyl acetate/heptane gradient), N-[1-(cyclopropylmethyl)-2-oxo-1,2,3,4-tetrahydroquinolin-6-yl]-1-(3-methylphenyl)methanesulfonamide (149 mg, 71% of theory) was isolated as a colorless solid. ¹H-NMR (400 MHz, CDCl₃ δ, ppm) 7.25 (m, 1H), 7.20 (m, 1H), 7.11 (m, 2H), 7.09 (d, 1H), 6.98 (m, 2H), 6.09 (s, 1H, NH), 4.31 (s, 2H), 3.87 (d, 2H), 2.88 (m, 2H), 2.66 (m, 2H), 2.35 (s, 3H), 1.13 (m, 1H), 0.51 (m, 2H), 0.42 (m, 2H).

### No. A19-325

### N-[1-(Cyclopropylmethyl)-2-oxo-1,2,3,4-tetrahydroquinolin-6-yl]-1-(4-ethylphenyl)methanesulfonamide

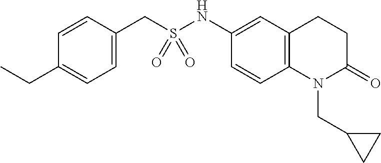 [SMILES: CCc1ccc(CS(=O)(=O)Nc2ccc3c(c2)CCC(=O)N3CC2CC2)cc1]

6-Amino-1-cyclopropylmethyl-3,4-dihydroquinolin-2(1H)-one (90 mg, 0.42 mmol) was dissolved together with (4-ethylphenyl)methanesulfonyl chloride (100 mg, 0.46 mmol) in abs. acetonitrile (5 mL) in a baked-out round-bottom flask under argon, then pyridine (0.07 mL, 0.83 mmol) was added and the mixture was stirred at room temperature for 9 h. The reaction mixture was then concentrated under reduced pressure, the remaining residue was admixed with dil. HCl and dichloromethane, and the aqueous phase was extracted repeatedly with dichloromethane. The combined organic phases were dried over magnesium sulfate, filtered and concentrated under reduced pressure. By column chromatography purification of the crude product obtained (ethyl acetate/heptane gradient), N-[1-(cyclopropylmethyl)-2-oxo-1,2,3,4-tetrahydroquinolin-6-yl]-1-(4-ethylphenyl)methanesulfonamide (114 mg, 69% of theory) was isolated as a colorless solid. ¹H-NMR (400 MHz, CDCl₃ δ, ppm) 7.24 (d, 2H), 7.22 (d, 2H), 7.08 (d, 1H), 6.97 (m, 2H), 6.08 (s, 1H, NH), 4.31 (s, 2H), 3.85 (d, 2H), 2.89 (m, 2H), 2.67 (m, 4H), 1.27 (t, 3H), 1.12 (m, 1H), 0.51 (m, 2H), 0.43 (m, 2H).

### No. A19-357

### N-[1-(Cyclopropylmethyl)-2-oxo-1,2,3,4-tetrahydroquinolin-6-yl]-1-(3-fluoro-4-methylphenyl)methanesulfonamide

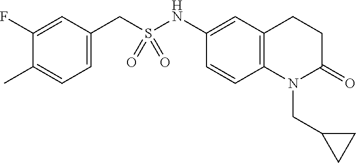 [SMILES: Cc1ccc(CS(=O)(=O)Nc2ccc3c(c2)CCC(=O)N3CC2CC2)cc1F]

6-Amino-1-cyclopropylmethyl-3,4-dihydroquinolin-2(1H)-one (90 mg, 0.42 mmol) was dissolved together with (3-fluoro-4-ethylphenyl)methanesulfonyl chloride (102 mg, 0.46 mmol) in abs. acetonitrile (5 mL) in a baked-out round-bottom flask under argon, then pyridine (0.07 mL, 0.83 mmol) was added and the mixture was stirred at room temperature for 6 h. The reaction mixture was then concentrated under reduced pressure, the remaining residue was admixed with dil. HCl and dichloromethane, and the aqueous phase was extracted repeatedly with dichloromethane. The combined organic phases were dried over magnesium sulfate, filtered and concentrated under reduced pressure. By column chromatography purification of the crude product obtained (ethyl acetate/heptane gradient), N-[1-(cyclopropylmethyl)-2-oxo-1,2,3,4-tetrahydroquinolin-6-yl]-1-(3-fluoro-4-methylphenyl)methanesulfonamide (107 mg, 64% of theory) was isolated as a colorless solid. ¹H-NMR (400 MHz, CDCl₃ δ, ppm) 7.19 (m, 1H), 7.10 (d, 1H), 7.03-6.96 (m, 4H), 6.14 (s, 1H, NH), 4.28 (s, 2H), 3.87 (d, 2H), 2.89 (m, 2H), 2.67 (m, 2H), 2.28 (s, 3H), 1.12 (m, 1H), 0.51 (m, 2H), 0.43 (m, 2H).

### No. A21-181

### N-[1-(Cyclobutylmethyl)-2-oxo-1,2,3,4-tetrahydroquinolin-6-yl]-1-(4-cyanophenyl)methanesulfonamide

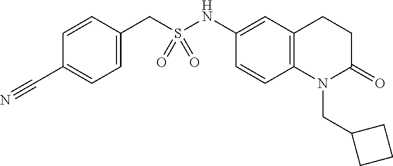 [SMILES: N#Cc1ccc(CS(=O)(=O)Nc2ccc3c(c2)CCC(=O)N3CC2CCC2)cc1]

3,4-Dihydroquinolin-2(1H)-one (1.54 g, 7.66 mmol) was added to conc. acetic acid (10 mL) and then cautiously admixed with fuming nitric acid (0.42 mL, 10.12 mmol). The resulting reaction mixture was stirred at room temperature for 2 h and then diluted with ice-water. The aqueous phase was then repeatedly extracted with ethyl acetate. The combined organic phases were dried over magnesium sulfate, filtered and concentrated under reduced pressure. By column chromatography purification of the crude product obtained (ethyl acetate/heptane gradient), 6-nitro-3,4-dihydroquinolin-2(1H)-one (1.09 g, 69% of theory) was isolated as a colorless solid. 6-Nitro-3,4-dihydroquinolin-2(1H)-one (2.0 g, 10.41 mmol) was dissolved under argon in abs. N,N-dimethylformamide (25 mL) and admixed with fine potassium carbonate powder (4.31 mg, 31.22 mmol). After stirring at room temperature for 5 min, cyclobutylmethyl bromide (2.02 g, 13.53 mmol) and potassium iodide (26 mg, 0.16 mmol) were added. The resulting reaction mixture was stirred at 120° C. for 2 h and, after cooling to room temperature, water and ethyl acetate were added. The aqueous phase was then repeatedly extracted with ethyl acetate. The combined organic phases were dried over magnesium sulfate, filtered and concentrated under reduced pressure. By column chromatography purification of the crude product obtained (ethyl acetate/heptane gradient), 1-(cyclobutylmethyl)-6-nitro-3,4-dihydroquinolin-2(1H)-one (792 mg, 29% of theory) was isolated as a colorless solid. ¹H-NMR (400 MHz, CDCl₃ δ, ppm) 8.14 (dd, 1H), 8.06 (d, 1H), 7.07 (d, 1H), 4.10 (d, 2H), 3.00 (m, 2H), 2.71 (m, 2H), 2.63 (m, 1H), 2.02 (m, 2H), 1.90-1.78 (m, 4H). In the next step, 1-(cyclobutylmethyl)-6-nitro-3,4-dihydroquinolin-2(1H)-one (1.34 g, 5.15 mmol) was added together with tin(II) chloride dihydrate (4.65 g, 20.59 mmol) to abs. ethanol (10 mL) and the mixture was stirred under argon at a temperature of 40-50° C. for 3 h. After cooling to room temperature, the reaction mixture was poured onto ice-water and then adjusted to pH 12 with 6 N NaOH. The aqueous phase was then repeatedly extracted with ethyl acetate. The combined organic phases were dried over magnesium sulfate, filtered and concentrated under reduced pressure. By column chromatography purification of the crude product obtained (ethyl acetate/heptane gradient), 6-amino-1-(cyclobutylmethyl)-3,4-dihydroquinolin-2(1H)-one (663 mg, 57% of theory) was isolated as a colorless solid. ¹H-NMR (400 MHz, CDCl₃ δ, ppm) 6.81 (d, 1H), 6.59 (dd, 1H), 6.54 (d, 1H), 4.06-3.72 (br. s, 2H, NH), 3.99 (d, 2H), 2.77 (m, 2H), 2.63 (m, 1H), 2.59 (m, 2H), 1.96 (m, 2H), 1.81 (m, 4H). 6-Amino-1-(cyclobutylmethyl)-3,4-dihydroquinolin-2(1H)-one (200 mg, 0.87 mmol) was dissolved together with (4-cyanophenyl)methanesulfonyl chloride (281 mg, 1.30 mmol) in abs. acetonitrile (8 mL) in a baked-out round-bottom flask under argon, then pyridine (0.14 mL, 1.74 mmol) and dimethyl sulfoxide (0.04 mL, 0.52 mmol) were added and the mixture was stirred at room temperature for 9 h. The reaction mixture was then concentrated under reduced pressure, the remaining residue was admixed with dil. HCl and dichloromethane, and the aqueous phase was extracted repeatedly with dichloromethane. The combined organic phases were dried over magnesium sulfate, filtered and concentrated under reduced pressure. By column chromatography purification of the crude product obtained (ethyl acetate/heptane gradient), N-[1-(cyclobutylmethyl)-2-oxo-1,2,3,4-tetrahydroquinolin-6-yl]-1-(4-cyanophenyl)methanesulfonamide (216 mg, 61% of theory) was isolated as a colorless solid. ¹H-NMR (400 MHz, CDCl₃ δ, ppm) 7.69 (d, 2H), 7.48 (d, 2H), 7.00 (m, 1H), 6.98-6.94 (m, 2H), 6.14 (s, 1H, NH), 4.38 (s, 2H), 4.04 (d, 2H), 2.86 (m, 2H), 2.65 (m, 3H), 2.01 (m, 2H), 1.86 (m, 4H).

### No. A32-178

### N-[1-(2′,2′-Dichlorocyclopropylmethyl)-2-oxo-1,2,3,4-tetrahydroquinolin-6-yl]-1-(4-trifluoromethylphenyl)methanesulfonamide

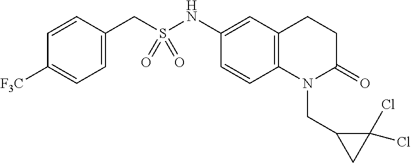 [SMILES: O=C1CCc2cc(NS(=O)(=O)Cc3ccc(C(F)(F)F)cc3)ccc2N1CC1CC1(Cl)Cl]

3,4-Dihydroquinolin-2(1H)-one (1.54 g, 7.66 mmol) was added to conc. acetic acid (10 mL) and then cautiously admixed with fuming nitric acid (0.42 mL, 10.12 mmol). The resulting reaction mixture was stirred at room temperature for 2 h and then diluted with ice-water. The aqueous phase was then repeatedly extracted with ethyl acetate. The combined organic phases were dried over magnesium sulfate, filtered and concentrated under reduced pressure. By column chromatography purification of the crude product obtained (ethyl acetate/heptane gradient), 6-nitro-3,4-dihydroquinolin-2(1H)-one (1.09 g, 69% of theory) was isolated as a colorless solid. 6-Nitro-3,4-dihydroquinolin-2(1H)-one (1.20 g, 6.24 mmol) was dissolved under argon in abs. N,N-dimethylformamide and admixed with fine potassium carbonate powder (2.59 g, 18.73 mmol). After stirring at room temperature for 5 min, 1,1-dichloro-2-chloromethylcyclopropane (1.29 g, 8.12 mmol) and potassium iodide (0.52 g, 3.12 mmol) were added. The resulting reaction mixture was stirred at 120° C. for 2 h and, after cooling to room temperature, water and ethyl acetate were added. The aqueous phase was then repeatedly extracted with ethyl acetate. The combined organic phases were dried over magnesium sulfate, filtered and concentrated under reduced pressure. By column chromatography purification of the crude product obtained (ethyl acetate/heptane gradient), 1-(2′,2′-dichlorocyclopropylmethyl)-6-nitro-3,4-dihydroquinolin-2(1H)-one (1.52 g, 77% of theory) was isolated as a colorless solid. ¹H-NMR (400 MHz, CDCl₃ δ, ppm) 8.21 (dd, 1H), 8.11 (d, 1H), 7.21 (d, 1H), 4.34 (dd, 1H), 4.17 (dd, 1H), 3.05 (m, 2H), 2.75 (m, 2H), 1.92 (m, 1H), 1.71 (m, 1H), 1.53 (m, 1H). In the next step, 1-(2′,2′-dichlorocyclopropylmethyl)-6-nitro-3,4-dihydroquinolin-2(1H)-one (1.38 g, 4.38 mmol) was added together with tin(II) chloride dihydrate (3.95 g, 17.52 mmol) to abs. ethanol and the mixture was stirred under argon at a temperature of 50° C. for 3 h. After cooling to room temperature, the reaction mixture was poured into ice-water and then adjusted to pH 12 using aqueous NaOH. The aqueous phase was then repeatedly extracted with ethyl acetate. The combined organic phases were dried over magnesium sulfate, filtered and concentrated under reduced pressure. By column chromatography purification of the crude product obtained (ethyl acetate/heptane gradient), 6-amino-1-(2′,2′-dichlorocyclopropylmethyl)-3,4-dihydroquinolin-2(1H)-one (1.06 g, 85% of theory) was isolated as a colorless solid. ¹H-NMR (400 MHz, CDC₃86, ppm) 6.90 (d, 1H), 6.61 (dd, 1H), 6.55 (d, 1H), 4.18 (dd, 1H), 4.12 (dd, 1H), 3.61 (br. s, 2H, NH), 2.82 (m, 2H), 2.62 (m, 2H), 1.95 (m, 1H), 1.64 (m, 1H), 1.49 (t, 3H). 6-Amino-1-(2′,2′-dichlorcyclopropylmethyl)-3,4-dihydroquinolin-2(1H)-one (185 mg, 0.65 mmol) was dissolved together with (4-trifluoromethylphenyl)methanesulfonyl chloride (252 mg, 0.97 mmol) in abs. acetonitrile (7 mL) in a baked-out round-bottom flask under argon, then pyridine (0.11 mL, 1.29 mmol) was added and the mixture was stirred at room temperature for 9 h. The reaction mixture was then concentrated under reduced pressure, the remaining residue was admixed with dil. HCl and dichloromethane, and the aqueous phase was extracted repeatedly with dichloromethane. The combined organic phases were dried over magnesium sulfate, filtered and concentrated under reduced pressure. By column chromatography purification of the crude product obtained (ethyl acetate/heptane gradient), N-[1-(2′,2′-dichlorocyclopropylmethyl)-2-oxo-1,2,3,4-tetrahydroquinolin-6-yl]-1-(4-trifluoromethylphenyl)methanesulfonamide (177 mg, 54% of theory) was isolated as a colorless solid. ¹H-NMR (400 MHz, CDCl₃ δ, ppm) 7.66 (d, 2H), 7.48 (d, 2H), 7.08 (d, 1H), 7.02 (m, 2H), 6.20 (s, 1H, NH), 4.41 (s, 2H), 4.26 (dd, 1H), 4.12 (dd, 1H), 2.90 (m, 2H), 2.66 (m, 2H), 1.93 (m, 1H), 1.69 (m, 1H), 1.52 (m, 1H).

### EXAMPLE NO. A34-181

### N-[1-(2′-Ethoxycarbonylcyclopropylmethyl)-2-oxo-1,2,3,4-tetrahydroquinolin-6-yl]-1-(4-cyanophenyl)methanesulfonamide

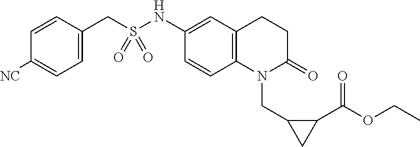

6-Nitro-3,4-dihydroquinolin-2(1H)-one (2.35 g, 12.23 mmol) was dissolved under argon in abs. N,N-dimethylformamide and admixed with fine potassium carbonate powder (5.07 g, 36.69 mmol). After stirring at room temperature for 5 min, ethyl 2-(chloromethyl)cyclopropanecarboxylate (2.59 g, 15.89 mmol) and potassium iodide (1.01 g, 6.11 mmol) were added. The resulting reaction mixture was stirred at 120° C. for 4 h and, after cooling to room temperature, water and ethyl acetate were added. The aqueous phase was then repeatedly extracted with ethyl acetate. The combined organic phases were dried over magnesium sulfate, filtered and concentrated under reduced pressure. By column chromatography purification of the crude product obtained (ethyl acetate/heptane gradient), 1-(2′-ethoxycarbonylcyclopropylmethyl)-6-nitro-3,4-dihydroquinolin-2(1H)-one (0.41 g, 11% of theory) was isolated as a colorless solid. In the next step, 1-(2′-ethoxycarbonylcyclopropylmethyl)-6-nitro-3,4-dihydroquinolin-2(1H)-one (0.41 g, 1.29 mmol) was added together with tin(II) chloride dihydrate (1.16 g, 5.15 mmol) to abs. ethanol and the mixture was stirred under argon at a temperature of 50° C. for 3 h. After cooling to room temperature, the reaction mixture was poured into ice-water and then adjusted to pH 12 using aqueous NaOH. The aqueous phase was then repeatedly extracted with ethyl acetate. The combined organic phases were dried over magnesium sulfate, filtered and concentrated under reduced pressure. By column chromatography purification of the crude product obtained (ethyl acetate/heptane gradient), 6-amino-1-(2′-ethoxycarbonylcyclopropylmethyl)-3,4-dihydroquinolin-2(1H)-one (0.35 g, 95% of theory) was isolated as a colorless solid. ¹H-NMR (400 MHz, CDCl₃ δ, ppm) 6.88 (d, 1H), 6.58 (dd, 1H), 6.53 (d, 1H), 4.11 (dd, 1H), 3.91 (m, 2H), 3.61 (br. s, 2H, NH), 2.81 (m, 2H), 2.61 (m, 2H), 1.78 (m, 2H), 1.27 (t, 3H), 1.18 (m, 1H), 1.04 (m, 1H). 6-Amino-1-(2′-ethoxycarbonylcyclopropylmethyl)-3,4-dihydroquinolin-2(1H)-one (140 mg, 0.49 mmol) was dissolved together with (4-cyanophenyl)methanesulfonyl chloride (157 mg, 0.73 mmol) in abs. acetonitrile (5 mL) in a baked-out round-bottom flask under argon, then pyridine (0.08 mL, 0.97 mmol) was added and the mixture was stirred at room temperature for 12 h. The reaction mixture was then concentrated under reduced pressure, the remaining residue was admixed with dil. HCl and dichloromethane, and the aqueous phase was extracted repeatedly with dichloromethane. The combined organic phases were dried over magnesium sulfate, filtered and concentrated under reduced pressure. By column chromatography purification of the crude product obtained (ethyl acetate/heptane gradient), N-[1-(2′-ethoxycarbonylcyclopropylmethyl)-2-oxo-1,2,3,4-tetrahydroquinolin-6-yl]-1-(4-cyanophenyl)methanesulfonamide (107 mg, 47% of theory) was isolated as a colorless solid. ¹H-NMR (400 MHz, CDCl₃ δ, ppm) 7.68 (d, 2H), 7.48 (d, 2H), 7.06 (m, 2H), 7.00 (m, 1H), 6.13 (s, 1H, NH), 4.38 (s, 2H), 4.12 (m, 2H), 3.96 (d, 2H), 2.92 (m, 2H), 2.68 (m, 2H), 1.78 (m, 2H), 1.27 (t, 3H), 1.20 (m, 1H), 1.08 (m, 1H).

### EXAMPLE NO. A38-152

### N-[1-(Methoxyethyl)-2-oxo-1,2,3,4-tetrahydroquinolin-6-yl]-1-(4-methylphenyl)methanesulfonamide

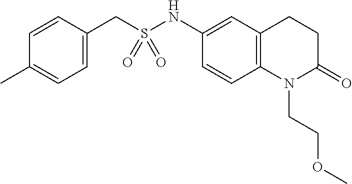

3,4-Dihydroquinolin-2(1H)-one (1.54 g, 7.66 mmol) was added to conc. acetic acid (10 mL) and then cautiously admixed with fuming nitric acid (0.42 mL, 10.12 mmol). The resulting reaction mixture was stirred at room temperature for 2 h and then diluted with ice-water. The aqueous phase was then repeatedly extracted with ethyl acetate. The combined organic phases were dried over magnesium sulfate, filtered and concentrated under reduced pressure. By column chromatography purification of the crude product obtained (ethyl acetate/heptane gradient), 6-nitro-3,4-dihydroquinolin-2(1H)-one (1.09 g, 69% of theory) was isolated as a colorless solid. 6-Nitro-3,4-dihydroquinolin-2(1H)-one (1.0 g, 5.20 mmol) was dissolved under argon in abs. N,N-dimethylformamide (18 mL) and admixed with fine potassium carbonate powder (2.16 g, 15.61 mmol). After stirring at room temperature for 5 min, 2-bromoethyl methyl ether (940 mg, 6.76 mmol) and potassium iodide (13 mg, 0.08 mmol) were added. The resulting reaction mixture was stirred at 100° C. for 2 h and, after cooling to room temperature, water and ethyl acetate were added. The aqueous phase was then repeatedly extracted with ethyl acetate. The combined organic phases were dried over magnesium sulfate, filtered and concentrated under reduced pressure. By column chromatography purification of the crude product obtained (ethyl acetate/heptane gradient), 1-(methoxyethyl)-6-nitro-3,4-dihydroquinolin-2(1H)-one (720 mg, 55% of theory) was isolated as a colorless solid. ¹H-NMR (400 MHz, CDCl₃ δ, ppm) 8.15 (dd, 1H), 8.06 (d, 1H), 7.39 (d, 1H), 4.16 (m, 2H), 3.68 (m, 2H), 3.35 (s, 3H), 3.02 (m, 2H), 2.72 (m, 2H). In the next step, 1-(methoxyethyl)-6-nitro-3,4-dihydroquinolin-2(1H)-one (720 mg, 2.87 mmol) was added together with tin(II) chloride dihydrate (2.59 g, 11.51 mmol) to abs. ethanol and the mixture was stirred under argon at a temperature of 50° C. for 3 h. After cooling to room temperature, the reaction mixture was poured onto ice-water and then adjusted to pH 12 with 6 N NaOH. The aqueous phase was then repeatedly extracted with ethyl acetate. The combined organic phases were dried over magnesium sulfate, filtered and concentrated under reduced pressure. By column chromatography purification of the crude product obtained (ethyl acetate/heptane gradient), 6-amino-1-(methoxyethyl)-3,4-dihydroquinolin-2(1H)-one (320 mg, 50% of theory) was isolated as a colorless solid. ¹H-NMR (400 MHz, CDCl₃ δ, ppm) 7.01 (d, 1H), 6.59 (dd, 1H), 6.52 (d, 1H), 4.07 (m, 2H), 3.62 (m, 2H), 3.35 (s, 3H), 2.80 (m, 2H), 2.61 (m, 2H). 6-Amino-1-(methoxyethyl)-3,4-dihydroquinolin-2(1H)-one (120 mg, 0.55 mmol) was dissolved together with (4-methylphenyl)methanesulfonyl chloride (123 mg, 0.60 mmol) in abs. acetonitrile (7 mL) in a baked-out round-bottom flask under argon, then pyridine (0.09 mL, 1.09 mmol) was added and the mixture was stirred at room temperature for 6 h. The reaction mixture was then concentrated under reduced pressure, the remaining residue was admixed with dil. HCl and dichloromethane, and the aqueous phase was extracted repeatedly with dichloromethane. The combined organic phases were dried over magnesium sulfate, filtered and concentrated under reduced pressure. By column chromatography purification of the crude product obtained (ethyl acetate/heptane gradient), N-[1-(methoxyethyl)-2-oxo-1,2,3,4-tetrahydroquinolin-6-yl]-1-(4-methylphenyl)methanesulfonamide (119 mg, 56% of theory) was isolated as a colorless solid. ¹H-NMR (400 MHz, CDCl₃ δ, ppm) 7.23-7.18 (m, 5H), 7.00-6.94 (m, 2H), 6.10 (s, 1H, NH), 4.29 (s, 2H), 4.09 (m, 2H), 3.65 (m, 2H), 3.37 (s, 3H), 2.88 (m, 2H), 2.66 (m, 2H), 2.37 (s, 3H).

### No. A39-165

### N-[1-(Ethoxyethyl)-2-oxo-1,2,3,4-tetrahydroquinolin-6-yl]-1-(4-chloromethylphenyl)methanesulfonamide

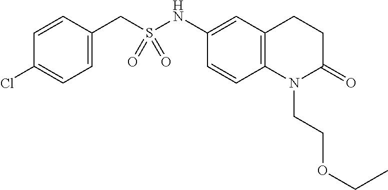 [SMILES: CCOCCN1C(=O)CCc2cc(NS(=O)(=O)Cc3ccc(Cl)cc3)ccc21]

3,4-Dihydroquinolin-2(1H)-one (1.54 g, 7.66 mmol) was added to conc. acetic acid (10 mL) and then cautiously admixed with fuming nitric acid (0.42 mL, 10.12 mmol). The resulting reaction mixture was stirred at room temperature for 2 h and then diluted with ice-water. The aqueous phase was then repeatedly extracted with ethyl acetate. The combined organic phases were dried over magnesium sulfate, filtered and concentrated under reduced pressure. By column chromatography purification of the crude product obtained (ethyl acetate/heptane gradient), 6-nitro-3,4-dihydroquinolin-2(1H)-one (1.09 g, 69% of theory) was isolated as a colorless solid. 6-Nitro-3,4-dihydroquinolin-2(1H)-one (1.30 g, 6.77 mmol) was dissolved under argon in abs. N,N-dimethylformamide (20 mL) and admixed with fine potassium carbonate powder (2.80 g, 20.29 mmol). After stirring at room temperature for 5 min, 2-bromoethyl ethyl ether (1.49 g, 8.79 mmol) and potassium iodide (17 mg, 0.10 mmol) were added. The resulting reaction mixture was stirred at 100° C. for 1.5 h and, after cooling to room temperature, water and ethyl acetate were added. The aqueous phase was then repeatedly extracted with ethyl acetate. The combined organic phases were dried over magnesium sulfate, filtered and concentrated under reduced pressure. By column chromatography purification of the crude product obtained (ethyl acetate/heptane gradient), 1-(ethoxyethyl)-6-nitro-3,4-dihydroquinolin-2(1H)-one (650 mg, 36% of theory) was isolated as a colorless solid. ¹H-NMR (400 MHz, CDCl₃ δ, ppm) 8.14 (dd, 1H), 8.05 (d, 1H), 7.45 (d, 1H), 4.14 (t, 2H), 3.70 (t, 2H), 3.50 (q, 2H), 3.01 (m, 2H), 2.72 (m, 2H), 1.16 (t, 3H). In the next step, 1-(ethoxyethyl)-6-nitro-3,4-dihydroquinolin-2(1H)-one (650 mg, 2.46 mmol) was added together with tin(II) chloride dihydrate (2.22 g, 9.38 mmol) to abs. ethanol (10 mL) and the mixture was stirred under argon at a temperature of 40° C. for 5 h. After cooling to room temperature, the reaction mixture was poured onto ice-water and then adjusted to pH 12 with 6 N NaOH. The aqueous phase was then repeatedly extracted with ethyl acetate. The combined organic phases were dried over magnesium sulfate, filtered and concentrated under reduced pressure. By column chromatography purification of the crude product obtained (ethyl acetate/heptane gradient), 6-amino-1-(ethoxyethyl)-3,4-dihydroquinolin-2(1H)-one (620 mg, 97% of theory) was isolated as a colorless solid. 6-Amino-1-(ethoxyethyl)-3,4-dihydroquinolin-2(1H)-one (150 mg, 0.58 mmol) was dissolved together with (4-chlorophenyl)methanesulfonyl chloride (143 mg, 0.63 mmol) in abs. acetonitrile (7 mL) in a baked-out round-bottom flask under argon, then pyridine (0.09 mL, 1.15 mmol) was added and the mixture was stirred at room temperature for 6 h. The reaction mixture was then concentrated under reduced pressure, the remaining residue was admixed with dil. HCl and dichloromethane, and the aqueous phase was extracted repeatedly with dichloromethane. The combined organic phases were dried over magnesium sulfate, filtered and concentrated under reduced pressure. By column chromatography purification of the crude product obtained (ethyl acetate/heptane gradient), N-[1-(ethoxyethyl)-2-oxo-1,2,3,4-tetrahydroquinolin-6-yl]-1-(4-chloromethylphenyl)methanesulfonamide (139 mg, 62% of theory) was isolated as a colorless solid. ¹H-NMR (400 MHz, CDCl₃ δ, ppm) 7.34 (d, 2H), 7.23 (m, 3H), 6.95-6.943 (m, 2H), 6.23 (s, 1H, NH), 4.30 (s, 2H), 4.08 (m, 2H), 3.68 (m, 2H), 3.53 (q, 2H), 2.87 (m, 2H), 2.66 (m, 2H), 1.18 (t, 3H).

### No. A46-158

### N-[1-(Adamantan-1-ylmethyl)-2-oxo-1,2,3,4-tetrahydroquinolin-6-yl]-1-(4-fluorophenyl)methanesulfonamide

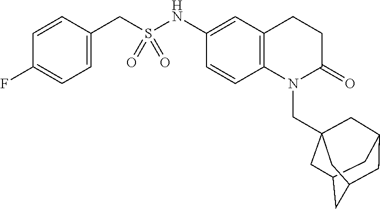 [SMILES: O=C1CCc2cc(NS(=O)(=O)Cc3ccc(F)cc3)ccc2N1CC12CC3CC(CC(C3)C1)C2]

6-Nitro-3,4-dihydroquinolin-2(1H)-one (2.00 g, 10.41 mmol) was dissolved under argon in abs. N,N-dimethylformamide and admixed with fine potassium carbonate powder (4.31 g, 31.22 mmol). After stirring at room temperature for 5 min, 1-bromomethyladamantane (3.10 g, 13.53 mmol) and potassium iodide (0.86 g, 5.20 mmol) were added. The resulting reaction mixture was stirred at 120° C. for 5 h and, after cooling to room temperature, water and ethyl acetate were added. The aqueous phase was then repeatedly extracted with ethyl acetate. The combined organic phases were dried over magnesium sulfate, filtered and concentrated under reduced pressure. By column chromatography purification of the crude product obtained (ethyl acetate/heptane gradient), 1-(adamantan-1-ylmethyl)-6-nitro-3,4-dihydroquinolin-2(1H)-one (1.01 g, 29% of theory) was isolated as a colorless solid. In the next step, 1-(adamantan-1-ylmethyl)-6-nitro-3,4-dihydroquinolin-2(1H)-one (1.01 g, 2.97 mmol) was added together with tin(II) chloride dihydrate (2.68 g, 11.87 mmol) to abs. ethanol (30 mL) and the mixture was stirred under argon at a temperature of 50° C. for 3 h. After cooling to room temperature, the reaction mixture was poured into ice-water and then adjusted to pH 12 using aqueous NaOH. The aqueous phase was then repeatedly extracted with ethyl acetate. The combined organic phases were dried over magnesium sulfate, filtered and concentrated under reduced pressure. By column chromatography purification of the crude product obtained (ethyl acetate/heptane gradient), 1-(adamantan-1-ylmethyl)-6-amino-3,4-dihydroquinolin-2(1H)-one (0.86 g, 94% of theory) was isolated as a colorless solid. ¹H-NMR (400 MHz, CDCl₃ δ, ppm) 6.94 (d, 1H), 6.55-6.52 (m, 2H), 3.79-3-30 (br. s, 2H, NH), 3.54 (m, 2H), 2.79 (m, 2H), 2.59 (m, 2H), 1.89 (m, 3H), 1.66 (m, 2H), 1.63 (m, 2H), 1.58 (m, 4H), 1.49 (m, 4H). 1-(Adamantan-1-ylmethyl)-6-amino-3,4-dihydroquinolin-2(1H)-one (230 mg, 0.74 mmol) was dissolved together with (4-fluorophenyl)methanesulfonyl chloride (232 mg, 1.11 mmol) in abs. acetonitrile (7 mL) in a baked-out round-bottom flask under argon, then pyridine (0.12 mL, 1.48 mmol) was added and the mixture was stirred at room temperature for 12 h. The reaction mixture was then concentrated under reduced pressure, the remaining residue was admixed with dil. HCl and dichloromethane, and the aqueous phase was extracted repeatedly with dichloromethane. The combined organic phases were dried over magnesium sulfate, filtered and concentrated under reduced pressure. By column chromatography purification of the crude product obtained (ethyl acetate/heptane gradient), N-[1-(adamantan-1-ylmethyl)-2-oxo-1,2,3,4-tetrahydroquinolin-6-yl]-1-(4-fluorophenyl)methanesulfonamide (210 mg, 59% of theory) was isolated as a colorless solid. ¹H-NMR (400 MHz, CDCl₃ δ, ppm) 7.29 (m, 2H), 7.10-7.02 (m, 3H), 6.98 (m, 1H), 6.87 (m, 1H), 6.06 (s, 1H, NH), 4.33 (s, 2H), 2.85 (m, 2H), 2.63 (m, 2H), 1.91 (m, 3H), 1.67 (m, 3H), 1.62-1.47 (m, 9H), 1.28 (m, 2H).

### EXAMPLE NO. B2-152

### N-[4,4-Dimethyl-2-oxo-1-(2,2,2-trifluoroethyl)-1,2,3,4-tetrahydroquinolin-6-yl]-1-(4-methylphenyl)methanesulfonamide

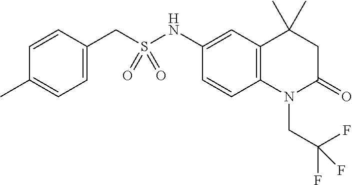 [SMILES: Cc1ccc(CS(=O)(=O)Nc2ccc3c(c2)C(C)(C)CC(=O)N3CC(F)(F)F)cc1]

N-2,2,2-Trifluoroethylaniline (1.50 g, 8.56 mmol) was dissolved under argon in abs. dichloromethane (20 mL) and pyridine (0.90 mL, 11.1 mmol), and, after the solution had been cooled down to 0° C., a solution of 3,3-dimethylacryloyl chloride (1.12 g, 9.42 mmol) in abs. dichloromethane was added. The resulting reaction mixture was stirred at 0° C. for a further 1 h and at room temperature for a further 4 h, and then admixed with aqueous HCl solution. The aqueous phase was then repeatedly extracted with dichloromethane. The combined organic phases were dried over magnesium sulfate, filtered and concentrated under reduced pressure. By column chromatography purification of the crude product obtained (ethyl acetate/heptane gradient), 3-methyl-N-phenyl-N-(2,2,2-trifluoroethyl)but-2-enamide (1.07 g, 46% of theory) was isolated as a colorless solid. In the next step, aluminum trichloride (1.94 g, 14.56 mmol) was initially charged in abs. dichloromethane (15 mL) under argon in a baked-out round-bottom flask and then, while cooling with ice, a solution of 3-methyl-N-phenyl-N-(2,2,2-trifluoroethyl)but-2-enamide (1.07 g, 4.16 mmol) in abs. dichloromethane (10 mL) was added. The resulting reaction mixture was stirred at room temperature for a further 4 h and then added cautiously to ice-water. After adding aqueous HCl and dichloromethane, the aqueous phase was extracted repeatedly with dichloromethane. The combined organic phases were dried over magnesium sulfate, filtered and concentrated cautiously under reduced pressure. By column chromatography purification of the crude product obtained (ethyl acetate/heptane gradient), 4,4-dimethyl-1-(2,2,2-trifluoroethyl)-3,4-dihydroquinolin-2(1H)-one (1.01 g, 85% of theory) was isolated as a colorless solid. 4,4-Dimethyl-1-(2,2,2-trifluoroethyl)-3,4-dihydroquinolin-2(1H)-one (1.01 g, 3.93 mmol) was added to conc. acetic acid (12 mL) and then cautiously admixed with fuming nitric acid (3 mL). The resulting reaction mixture was stirred at 50° C. for 4 h and, after cooling to room temperature, cautiously diluted with ice-water. The aqueous phase was then repeatedly extracted with ethyl acetate. The combined organic phases were dried over magnesium sulfate, filtered and concentrated under reduced pressure. By column chromatography purification of the crude product obtained (ethyl acetate/heptane gradient), 4,4-dimethyl-6-nitro-1-(2,2,2-trifluoroethyl)-3,4-dihydroquinolin-2(1H)-one (840 mg, 64% of theory) was isolated as a colorless solid. In the next step, 4,4-dimethyl-6-nitro-1-(2,2,2-trifluoroethyl)-3,4-dihydroquinolin-2(1H)-one (840 mg, 2.78 mmol) was added together with tin(II) chloride dihydrate (2.51 g, 11.12 mmol) to abs. ethanol and the mixture was stirred under argon at a temperature of 60° C. for 6 h. After cooling to room temperature, the reaction mixture was poured onto ice-water and then adjusted to pH 12 with 6 N NaOH. The aqueous phase was then repeatedly extracted with ethyl acetate. The combined organic phases were dried over magnesium sulfate, filtered and concentrated under reduced pressure. By column chromatography purification of the crude product obtained (ethyl acetate/heptane gradient), 6-amino-4,4-dimethyl-1-(2,2,2-trifluoroethyl)-3,4-dihydroquinolin-2(1H)-one (720 mg, 86% of theory) was isolated as a colorless solid. 6-Amino-4,4-dimethyl-1-(2,2,2-trifluoroethyl)-3,4-dihydroquinolin-2(1H)-one (180 mg, 0.66 mmol) was dissolved together with (4-methylphenyl)methanesulfonyl chloride (176 mg, 0.86 mmol) in abs. acetonitrile (10 mL) in a baked-out round-bottom flask under argon, then pyridine (0.17 mL, 2.05 mmol) was added and the mixture was stirred at room temperature for 6 h. The reaction mixture was then concentrated under reduced pressure, the remaining residue was admixed with dil. HCl and dichloromethane, and the aqueous phase was extracted repeatedly with dichloromethane. The combined organic phases were dried over magnesium sulfate, filtered and concentrated under reduced pressure. By column chromatography purification of the crude product obtained (ethyl acetate/heptane gradient), N-[4,4-dimethyl-2-oxo-1-(2,2,2-trifluoroethyl)-1,2,3,4-tetrahydroquinolin-6-yl]-1-(4-methylphenyl)methanesulfonamide (183 mg, 63% of theory) was isolated as a colorless solid. ¹H-NMR (400 MHz, CDCl₃ δ, ppm) 7.19 (d, 2H), 7.17 (d, 2H), 7.04 (m, 3H), 6.11 (s, 1H, NH), 4.69 (m, 2H), 4.30 (s, 2H), 2.58 (s, 2H), 2.36 (s, 3H), 1.29 (s, 6H).

### No. B41-45

### 4-Cyano-N-{4,4-dimethyl-2-oxo-1-[2-(trifluoromethoxy)ethyl]-1,2,3,4-tetrahydroquinolin-6-yl}benzenesulfonamide

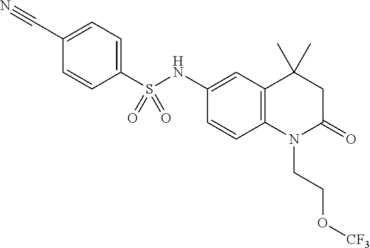 [SMILES: CC1(C)CC(=O)N(CCOC(F)(F)F)c2ccc(NS(=O)(=O)c3ccc(C#N)cc3)cc21]

Aniline (2.00 g, 21.48 mmol) was dissolved under argon in abs. dichloromethane (20 mL) and pyridine (2.39 mL, 21.48 mmol), and, after the solution had been cooled down to 0° C., a solution of 3,3-dimethylacryloyl chloride (2.55 g, 21.48 mmol) in abs. dichloromethane (5 mL) was added dropwise. The resulting reaction mixture was stirred at 0° C. for a further 1 h and at room temperature for a further 4 h, and then admixed with aqueous HCl solution. The aqueous phase was then repeatedly extracted with dichloromethane. The combined organic phases were dried over magnesium sulfate, filtered and concentrated under reduced pressure. By column chromatography purification of the crude product obtained (ethyl acetate/heptane gradient), 3-methyl-N-phenylbut-2-enamide (3.65 g, 92% of theory) was isolated as a colorless solid. In the next step, aluminum trichloride (7.06 g, 52.93 mmol) was initially charged in abs. dichloromethane (40 mL) under argon in a baked-out round-bottom flask and then, while cooling with ice, a solution of 3-methyl-N-phenylbut-2-enamide (2.65 g, 15.12 mmol) in abs. dichloromethane (13 mL) was added. The resulting reaction mixture was stirred at room temperature for a further 4 h and then added cautiously to ice-water. After adding aqueous HCl and dichloromethane, the aqueous phase was extracted repeatedly with dichloromethane. The combined organic phases were dried over magnesium sulfate, filtered and concentrated cautiously under reduced pressure. By column chromatography purification of the crude product obtained (ethyl acetate/heptane gradient), 4,4-dimethyl-3,4-dihydroquinolin-2(1H)-one (2.37 g, 85% of theory) was isolated as a colorless solid. 4,4-Dimethyl-3,4-dihydroquinolin-2(1H)-one (1.06 g, 6.05 mmol) was added to conc. acetic acid (8 mL) and then cautiously admixed with fuming nitric acid (2 mL). The resulting reaction mixture was stirred at 50° C. for 4 h and, after cooling to room temperature, cautiously diluted with ice-water. The aqueous phase was then repeatedly extracted with ethyl acetate. The combined organic phases were dried over magnesium sulfate, filtered and concentrated under reduced pressure. By column chromatography purification of the crude product obtained (ethyl acetate/heptane gradient), 4,4-dimethyl-6-nitro-3,4-dihydroquinolin-2(1H)-one (990 mg, 67% of theory) was isolated as a colorless solid. In the subsequent step, sodium hydride (0.59 g, 14.99 mmol, 60% dispersion) was admixed with N,N-dimethylformamide (20 mL) in a baked-out round-bottom flask. Thereafter, a solution of 4,4-dimethyl-6-nitro-3,4-dihydroquinolin-2(1H)-one (3.00 g, 13.62 mmol) in abs. N,N-dimethylformamide (10 mL) was slowly added dropwise. The resulting reaction mixture was stirred at room temperature for a further 30 min, cooled down to 0° C. and then admixed dropwise with 2-(trifluoromethoxy)ethyl trifluoromethanesulfonate (3.57 g, 13.62 mmol). The reaction mixture was then stirred at room temperature for 3 h and then added to ice-water and admixed with dichloromethane. The aqueous phase was then repeatedly extracted with dichloromethane. The combined organic phases were dried over magnesium sulfate, filtered and concentrated under reduced pressure. By column chromatography purification of the crude product obtained (ethyl acetate/heptane gradient), 4,4-dimethyl-6-nitro-1-[2-(trifluoromethoxy)ethyl]-3,4-dihydroquinolin-2(1H)-one (3.50 g, 73% of theory) was isolated as a colorless solid. In the next step, 4,4-dimethyl-6-nitro-1-[2-(trifluoromethoxy)ethyl]-3,4-dihydroquinolin-2(1H)-one (3.50 g, 10.53 mmol) was added together with tin(II) chloride dihydrate (9.51 g, 42.13 mmol) to abs. ethanol (50 mL) and the mixture was stirred under argon at a temperature of 60° C. for 4 h. After cooling to room temperature, the reaction mixture was poured onto ice-water and then adjusted to pH 12 with 6 N NaOH. The aqueous phase was then repeatedly extracted with ethyl acetate. The combined organic phases were dried over magnesium sulfate, filtered and concentrated under reduced pressure. By column chromatography purification of the crude product obtained (ethyl acetate/heptane gradient), 6-amino-4,4-dimethyl-1-[2-(trifluoromethoxy)ethyl]-3,4-dihydroquinolin-2(1H)-one (1.45 g, 43% of theory) was isolated as a colorless solid. 6-Amino-4,4-dimethyl-1-[2-(trifluoromethoxy)ethyl]-3,4-dihydroquinolin-2(1H)-one (156 mg, 0.52 mmol) was dissolved together with 4-cyanophenylsulfonyl chloride (114 mg, 0.57 mmol) in abs. acetonitrile (10 mL) in a baked-out round-bottom flask under argon, then pyridine (0.13 mL, 1.55 mmol) was added and the mixture was stirred at 70° C. for 3 h. The reaction mixture was then concentrated under reduced pressure, the remaining residue was admixed with dil. HCl and dichloromethane, and the aqueous phase was extracted repeatedly with dichloromethane. The combined organic phases were dried over magnesium sulfate, filtered and concentrated under reduced pressure. By column chromatography purification of the crude product obtained (ethyl acetate/heptane gradient), 4-cyano-N-{4,4-dimethyl-2-oxo-1-[2-(trifluoromethoxy)ethyl]-1,2,3,4-tetrahydroquinolin-6-yl}benzenesulfonamide (63 mg, 25% of theory) was isolated as a colorless solid. ¹H-NMR (600 MHz, CDCl₃ δ, ppm) 7.86 (d, 2H), 7.76 (d, 2H), 7.02-6.98 (m, 2H), 6.93 (m, 1H), 6.80 (s, 1H, NH), 4.22 (m, 4H), 2.50 (s, 2H), 1.22 (s, 6H); ¹³C-NMR (150 MHz, CDCl₃ δ, ppm) 169.5, 143.2, 137.7, 136.7, 133.0, 132.8, 130.9, 127.9, 127.7 122.3, 120.1, 117.1, 116.9, 116.4, 64.5, 45.4, 41.7, 33.3, 27.3, 26.9; ¹⁹F-NMR (377 MHz, CDCl₃ δ, ppm) 61.0.

### No. F7-50

### N-[4-Ethyl-1-(2-methoxyethyl)-4-methyl-2-oxo-1,2,3,4-tetrahydroquinolin-6-yl]-4-methylphenylsulfonamide

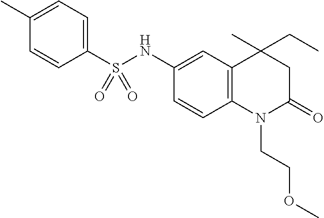 [SMILES: CCC1(C)CC(=O)N(CCOC)c2ccc(NS(=O)(=O)c3ccc(C)cc3)cc21]

Triethyl phosphonoacetate (80.0 g, 1.0 equiv) was dissolved in abs. tetrahydrofuran (50 mL) and added to a suspension, cooled down to 0° C., of sodium hydride (14.1 g, 1.03 equiv, 60% dispersion) in abs. tetrahydrofuran (50 mL). The resulting reaction mixture was stirred at a temperature of 0° C. for 10 minutes and then admixed with a solution of butan-2-one (25.0 g, 1.0 equiv) in abs. tetrahydrofuran (150 mL), and the mixture was stirred at room temperature for a further 4 h. After the cautious addition of water, the reaction mixture was concentrated under reduced pressure and admixed with dichloromethane. The aqueous phase was then repeatedly extracted with dichloromethane. The combined organic phases were dried over magnesium sulfate, filtered and concentrated under reduced pressure. By column chromatography purification of the crude product obtained (ethyl acetate/heptane gradient), ethyl 3-methylpent-2-enoate (40.0 g) was isolated. Ethyl 3-methylpent-2-enoate (40.0 g, 1.0 equiv) was dissolved in methanol and admixed with a 1 M solution of KOH in aq. methanol (400 mL). The resulting reaction mixture was stirred at room temperature for 16 h, then neutralized cautiously with dil. HCl, admixed with water, concentrated under reduced pressure and then admixed with dichloromethane. The aqueous phase was then repeatedly extracted with dichloromethane. The combined organic phases were dried over magnesium sulfate, filtered and concentrated under reduced pressure. By column chromatography purification of the crude product obtained (ethyl acetate/heptane gradient), 3-methylpent-2-enoic acid (30.0 g) was isolated. Aniline (22.9 g, 1.0 eq) was dissolved in dichloromethane (280 mL) and cooled down to a temperature of 0° C., and diisopropylethylamine (173 mL, 4.0 equiv.), 3-methylpent-2-enoic acid (28.0 g, 1.0 equiv.) and N,N,N′,N′-tetramethyl-O-(benzotriazol-1-yl)uronium tetrafluoroborate (86.5 g, 1.1 equiv.) were added. The resulting reaction mixture was stirred at room temperature for 3 h, and water and dichloromethane were then added. The aqueous phase was then repeatedly extracted with dichloromethane. The combined organic phases were dried over magnesium sulfate, filtered and concentrated under reduced pressure. By column chromatography purification of the crude product obtained (ethyl acetate/heptane gradient), 3-methyl-N-phenylpent-2-enamide (32.0 g, 69% of theory) was isolated. In the next step, aluminum trichloride (63.3 g, 3.0 equiv.) was initially charged in abs. dichloromethane (300 mL) in a baked-out round-bottom flask and then, while cooling with ice, a solution of 3-methyl-N-phenylpent-2-enamide (30.0 g, 1.0 equiv.) in abs. dichloromethane (100 mL) was added. The resulting reaction mixture was stirred at room temperature for a further 4 h and then added cautiously to ice-water. After adding aqueous HCl and dichloromethane, the aqueous phase was extracted repeatedly with dichloromethane. The combined organic phases were dried over magnesium sulfate, filtered and concentrated cautiously under reduced pressure. By column chromatography purification of the crude product obtained (ethyl acetate/heptane gradient), 4-ethyl-4-methyl-3,4-dihydrochinolin-2(1H)-one (10.0 g, 33% of theory) was isolated as a colorless solid. 4-Ethyl-4-methyl-3,4-dihydroquinolin-2(1H)-one (9.5 g, 50.26 mmol, 1 eq) was added to conc. acetic acid (90 mL), cooled down to 0° C. and then cautiously admixed with fuming nitric acid (15 mL). The resulting reaction mixture was stirred at 70° C. for 1 h and, after cooling to room temperature, cautiously diluted with ice-water. The aqueous phase was then repeatedly extracted with ethyl acetate. The combined organic phases were dried over magnesium sulfate, filtered and concentrated under reduced pressure. By column chromatography purification of the crude product obtained (ethyl acetate/heptane gradient), 4-ethyl-4-methyl-6-nitro-3,4-dihydrochinolin-2(1H)-one (4300 mg, 37% of theory) was isolated as a colorless solid. 4-Ethyl-4-methyl-6-nitro-3,4-dihydroquinolin-2(1H)-one (1000 mg, 4.27 mmol, 1.0 equiv.) was dissolved under argon in abs. dioxane (10 mL) and admixed with fine cesium carbonate powder (4180 mg, 3.0 eq.). After stirring at room temperature for 5 min, cyclopropylmethyl bromide (1150 mg, 2.0 equiv.) and potassium iodide (71 mg, 0.1 equiv.) were added at room temperature. The resulting reaction mixture was stirred at 150° C. under microwave conditions for 1 h and, after cooling to room temperature, water and ethyl acetate were added. The aqueous phase was then repeatedly extracted with ethyl acetate. The combined organic phases were dried over magnesium sulfate, filtered and concentrated under reduced pressure. By column chromatography purification of the crude product obtained (ethyl acetate/heptane gradient), 1-(cyclopropylmethyl)-4-ethyl-4-methyl-6-nitro-3,4-dihydroquinolin-2(1H)-one (950 mg, 77% of theory) was isolated as a colorless solid. In the next step, 1-(cyclopropylmethyl)-4-ethyl-4-methyl-6-nitro-3,4-dihydroquinolin-2(1H)-one (900 mg, 1.0 equiv.) together with zinc powder (1010 mg, 5.0 eq.) and ammonium chloride (828 mg, 5.0 eq.) were added to methanol (10 mL) and water (1.0 mL) at a temperature of 0° C. and the mixture was stirred under argon at room temperature for 1 h. The reaction mixture was then poured onto ice-water and subsequently adjusted to pH 12 with 6 N NaOH. The aqueous phase was then repeatedly extracted with ethyl acetate. The combined organic phases were dried over magnesium sulfate, filtered and concentrated under reduced pressure. By column chromatography purification of the crude product obtained (ethyl acetate/heptane gradient), 6-amino-1-(cyclopropylmethyl)-4-ethyl-4-methyl-3,4-dihydroquinolin-2(1H)-one (720 mg, 89% of theory) was isolated as a colorless solid. 6-Amino-1-(cyclopropylmethyl)-4-ethyl-4-methyl-3,4-dihydroquinolin-2(1H)-one (70 mg, 1.0 equiv.) was dissolved together with 4-methylphenylsulfonyl chloride (57 mg, 1.0 equiv) in abs. dichloromethane (5 mL) in a baked-out round-bottom flask under argon, then pyridine (0.1 mL, 5.0 equiv.) was added and the mixture was stirred at room temperature for 1 h. The reaction mixture was then concentrated under reduced pressure, the remaining residue was admixed with dil. HCl and dichloromethane, and the aqueous phase was extracted repeatedly with dichloromethane. The combined organic phases were dried over magnesium sulfate, filtered and concentrated under reduced pressure. By column chromatography purification of the crude product obtained (ethyl acetate/heptane gradient), N-[4-ethyl-1-(2-methoxyethyl)-4-methyl-2-oxo-1,2,3,4-tetrahydroquinolin-6-yl]-4-methylphenylsulfonamide (60 mg, 54% of theory) was isolated as a colorless solid. ¹H-NMR (400 MHz, CDCl₃ δ, ppm) 7.63 (d, 2H), 7.23 (d, 2H), 7.12 (m, 1H), 6.91 (m, 1H), 6.84 (m, 1H), 6.29 (s, 1H, NH), 4.08 (m, 2H), 3.61 (m, 2H), 3.32 (s, 2H), 2.48 (m, 2H), 2.41 (s, 3H), 1.48 (m, 2H), 1.17 (s, 3H), 0.68 (t, 3H).

### EXAMPLE NO. H3-45

### 4-Cyano-N-[1′-(cyclopropylmethyl)-2′-oxo-2′,3′-dihydro-1′H-spiro[cyclopentyl-1,4′-quinolin]-6′-yl]phenylsulfonamide

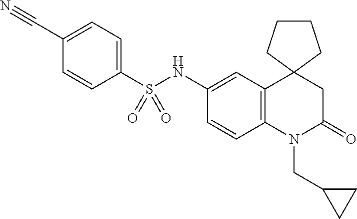 [SMILES: N#Cc1ccc(S(=O)(=O)Nc2ccc3c(c2)C2(CCCC2)CC(=O)N3CC2CC2)cc1]

Triethyl phosphonoacetate (272.0 g, 1.0 equiv) was dissolved in abs. tetrahydrofuran and added to a suspension, cooled down to 0° C., of sodium hydride (49.0 g, 1.02 equiv, 60% dispersion) in abs. tetrahydrofuran (500 mL). The resulting reaction mixture was stirred at a temperature of 0° C. for 10 minutes and then admixed with a solution of cyclopentanone (100.0 g, 1.0 equiv) in abs. tetrahydrofuran (500 mL), and the mixture was stirred at room temperature for a further 4 h. After the cautious addition of water, the reaction mixture was concentrated under reduced pressure and admixed with dichloromethane. The aqueous phase was then repeatedly extracted with dichloromethane. The combined organic phases were dried over magnesium sulfate, filtered and concentrated under reduced pressure. By column chromatography purification of the crude product obtained (ethyl acetate/heptane gradient), ethyl cyclopentylideneacetate (90.0 g, 70% of theory) was isolated. Ethyl cyclopentylideneacetate (90.0 g, 1.0 equiv) was dissolved in methanol and admixed with a 1 M solution of KOH in aq. methanol. The resulting reaction mixture was stirred at room temperature for 16 h, then neutralized with dil. HCl, admixed with water, concentrated under reduced pressure and then admixed with dichloromethane. The aqueous phase was then repeatedly extracted with dichloromethane. The combined organic phases were dried over magnesium sulfate, filtered and concentrated under reduced pressure. By column chromatography purification of the crude product obtained (ethyl acetate/heptane gradient), cyclopentylideneacetic acid (60.0 g) was isolated. Aniline (7.40 g, 1 equiv.) was dissolved in dichloromethane (50 mL) and cooled down to a temperature of 0° C., and diisopropylethylamine (56.8 mL, 4.0 equiv.), cyclopentylideneacetic acid (10.0 g, 1.0 equiv.) and N,N,N′,N′-tetramethyl-O-(benzotriazol-1-yl)uronium tetrafluoroborate (28.2 g, 1.1 equiv.) were added. The resulting reaction mixture was stirred at room temperature for 3 h, and water and dichloromethane were then added. The aqueous phase was then repeatedly extracted with dichloromethane. The combined organic phases were dried over magnesium sulfate, filtered and concentrated under reduced pressure. By column chromatography purification of the crude product obtained (ethyl acetate/heptane gradient), 2-cyclopentylidene-N-phenylacetamide (9.0 g, 56% of theory) was isolated. In the next step, aluminum trichloride (17.9 g, 3.0 equiv.) was initially charged in abs. dichloroethane (50 mL) under argon in a baked-out round-bottom flask and then, while cooling with ice, a solution of 2-cyclopentylidene-N-phenylacetamide (9.0 g, 1.0 equiv.) in abs. dichloroethane (50 mL) was added. The resulting reaction mixture was stirred at room temperature for a further 4 h and then added cautiously to ice-water. After adding aqueous HCl and dichloromethane, the aqueous phase was extracted repeatedly with dichloromethane. The combined organic phases were dried over magnesium sulfate, filtered and concentrated cautiously under reduced pressure. By column chromatography purification of the crude product obtained (ethyl acetate/heptane gradient), 1′H-spiro[cyclopentyl-1,4′-quinolin]-2′(3′H)-one (4.0 g, 44% of theory) was isolated as a colorless solid. 1′H-Spiro[cyclopentyl-1,4′-quinolin]-2′(3′H)-one (1.0 g, 1 equiv.) was added to conc. acetic acid (12 mL) and then cautiously admixed with fuming nitric acid (3 mL). The resulting reaction mixture was stirred at 50° C. for 4 h and, after cooling to room temperature, cautiously diluted with ice-water. The aqueous phase was then repeatedly extracted with ethyl acetate. The combined organic phases were dried over magnesium sulfate, filtered and concentrated under reduced pressure. By column chromatography purification of the crude product obtained (ethyl acetate/heptane gradient), 6′-nitro-1′H-spiro[cyclopentyl-1,4′-quinolin]-2′(3′H)-one (200 mg, 16% of theory) was isolated as a colorless solid. 6′-Nitro-1′H-spiro[cyclopentyl-1,4′-quinolin]-2′(3′H)-one (100 mg, 1.0 equiv.) was dissolved under argon in abs. dioxane (2 mL) and admixed with fine cesium carbonate powder (400 mg, 3.0 equiv.). After stirring at room temperature for 5 min, cyclobutylmethyl bromide (110 mg, 2.0 equiv.) and potassium iodide (35 mg, 0.1 equiv.) were added at room temperature. The resulting reaction mixture was stirred at 150° C. under microwave conditions for 1 h and, after cooling to room temperature, water and ethyl acetate were added. The aqueous phase was then repeatedly extracted with ethyl acetate. The combined organic phases were dried over magnesium sulfate, filtered and concentrated under reduced pressure. By column chromatography purification of the crude product obtained (ethyl acetate/heptane gradient), 1-(cyclopropylmethyl)-6′-nitro-1′H-spiro[cyclopentyl-1,4′-quinolin]-2′(3′H)-one (50 mg, 41% of theory) was isolated as a colorless solid. In the next step, 1-(cyclopropylmethyl)-6′-nitro-1′H-spiro[cyclopentyl-1,4′-quinolin]-2′(3′H)-one (50 mg, 1 equiv.) was added together with tin(II) chloride dihydrate (4 equiv.) to abs. ethanol and the mixture was stirred under argon at a temperature of 60° C. for 6 h. After cooling to room temperature, the reaction mixture was poured onto ice-water and then adjusted to pH 12 with 6 N NaOH. The aqueous phase was then repeatedly extracted with ethyl acetate. The combined organic phases were dried over magnesium sulfate, filtered and concentrated under reduced pressure. By column chromatography purification of the crude product obtained (ethyl acetate/heptane gradient), 6′-amino-1-(cyclopropylmethyl)-1′H-spiro[cyclopentyl-1,4′-quinolin]-2′(3′H)-one (40 mg, 90% of theory) was isolated as a colorless solid. 6′-Amino-1-(cyclopropylmethyl)-1′H-spiro[cyclopentyl-1,4′-quinolin]-2′(3′H)-one (40 mg, 1.0 equiv.) was dissolved together with 4-cyanophenylsulfonyl chloride (1.3 equiv) in abs. acetonitrile (5 mL) in a baked-out round-bottom flask under argon, then pyridine (2.5 equiv.) was added and the mixture was stirred at room temperature for 6 h. The reaction mixture was then concentrated under reduced pressure, the remaining residue was admixed with dil. HCl and dichloromethane, and the aqueous phase was extracted repeatedly with dichloromethane. The combined organic phases were dried over magnesium sulfate, filtered and concentrated under reduced pressure. By column chromatography purification of the crude product obtained (ethyl acetate/heptane gradient), 4-cyano-N-[1′-(cyclopropylmethyl)-2′-oxo-2′,3′-dihydro-1′H-spiro[cyclopentyl-1,4′-quinolin]-6′-yl]phenylsulfonamide (36 mg, 56% of theory) was isolated as a colorless solid. ¹H-NMR (400 MHz, d₆-DMSO δ, ppm) 10.32 (s, 1H, NH), 8.06 (d, 2H), 7.85 (d, 2H), 7.09 (d, 1H), 6.98 (dd, 1H), 6.92 (d, 1H), 3.79 (m, 2H), 2.44 (s, 2H), 1.77-1.44 (m, 8H), 0.99 (m, 1H), 0.38 (m, 2H), 0.24 (m, 2H).

### No. I3-178

### N-[1′-(Cyclopropylmethyl)-2′-oxo-2′,3′-dihydro-1′H-spiro[cyclohexane-1,4′-quinolin]-6′-yl]-1-(4-trifluoromethylphenyl)methanesulfonamide

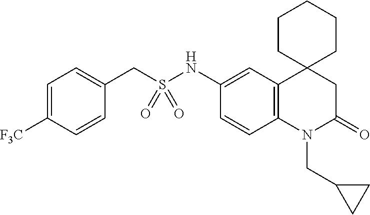 [SMILES: O=C1CC2(CCCCC2)c2cc(NS(=O)(=O)Cc3ccc(C(F)(F)F)cc3)ccc2N1CC1CC1]

Triethyl phosphonoacetate (232.0 g, 1.0 equiv) was dissolved in abs. tetrahydrofuran (200 mL) and added to a suspension, cooled down to 0° C., of sodium hydride (42.0 g, 1.02 equiv, 60% dispersion) in abs. tetrahydrofuran (200 mL). The resulting reaction mixture was stirred at a temperature of 0° C. for 10 minutes and then admixed with a solution of cyclohexanone (100.0 g, 1.0 equiv) in abs. tetrahydrofuran (300 mL), and the mixture was stirred at room temperature for a further 4 h. After the cautious addition of water, the reaction mixture was concentrated under reduced pressure and admixed with dichloromethane. The aqueous phase was then repeatedly extracted with dichloromethane. The combined organic phases were dried over magnesium sulfate, filtered and concentrated under reduced pressure. By column chromatography purification of the crude product obtained (ethyl acetate/heptane gradient), ethyl cyclohexylideneacetate (105.0 g) was isolated. Ethyl cyclopentylideneacetate (105.0 g, 1.0 equiv) was dissolved in methanol and admixed with a 1 M solution of KOH in aq. methanol (1000 mL). The resulting reaction mixture was stirred at room temperature for 16 h, then neutralized cautiously with dil. HCl, admixed with water, concentrated under reduced pressure and then admixed with dichloromethane. The aqueous phase was then repeatedly extracted with dichloromethane. The combined organic phases were dried over magnesium sulfate, filtered and concentrated under reduced pressure. By column chromatography purification of the crude product obtained (ethyl acetate/heptane gradient), cyclohexylideneacetic acid (70.0 g, 80% of theory) was isolated. Aniline (41.5 g, 1.0 eq.) was dissolved in dichloromethane (500 mL) and cooled down to a temperature of 0° C., and diisopropylethylamine (354 mL, 4.0 equiv.), cyclohexylideneacetic acid (70.0 g, 1.0 equiv.) and N,N,N′,N′-tetramethyl-O-(benzotriazol-1-yl)uronium tetrafluoroborate (180 g, 1.1 equiv.) were added. The resulting reaction mixture was stirred at room temperature for 3 h, and water and dichloromethane were then added. The aqueous phase was then repeatedly extracted with dichloromethane. The combined organic phases were dried over magnesium sulfate, filtered and concentrated under reduced pressure. By column chromatography purification of the crude product obtained (ethyl acetate/heptane gradient), 2-cyclohexylidene-N-phenylacetamide (80.0 g, 74% of theory) was isolated. In the next step, aluminum trichloride (93.2 g, 3.0 equiv.) was initially charged in abs. dichloromethane (400 mL) under argon in a baked-out round-bottom flask and then, while cooling with ice, a solution of 2-cyclohexylidene-N-phenylacetamide (50.0 g, 1.0 equiv.) in abs. dichloromethane (100 mL) was added. The resulting reaction mixture was stirred at room temperature for a further 4 h and then added cautiously to ice-water. After adding aqueous HCl and dichloromethane, the aqueous phase was extracted repeatedly with dichloromethane. The combined organic phases were dried over magnesium sulfate, filtered and concentrated cautiously under reduced pressure. By column chromatography purification of the crude product obtained (ethyl acetate/heptane gradient), 1′H-spiro[cyclohexyl-1,4′-quinolin]-2′(3′H)-one (12.0 g, 24% of theory) was isolated as a colorless solid. 1′H-Spiro[cyclohexyl-1,4′-quinolin]-2′(3′H)-one (12.0 g, 55.80 mmol, 1 eq.) was added to conc. acetic acid (100 mL) and then cautiously admixed with fuming nitric acid (20 mL). The resulting reaction mixture was stirred at 70° C. for 1 h and, after cooling to room temperature, cautiously diluted with ice-water. The aqueous phase was then repeatedly extracted with ethyl acetate. The combined organic phases were dried over magnesium sulfate, filtered and concentrated under reduced pressure. By column chromatography purification of the crude product obtained (ethyl acetate/heptane gradient), 6′-nitro-1′H-spiro[cyclohexyl-1,4′-quinolin]-2′(3′H)-one (2500 mg, 17% of theory) was isolated as a colorless solid. 6′-Nitro-1′H-spiro[cyclohexyl-1,4′-quinolin]-2′(3′H)-one (1000 mg, 3.84 mmol, 1.0 equiv.) was dissolved under argon in a mixture of abs. dioxane and N,N-dimethylformamide (5:1, 12 mL) and admixed with fine cesium carbonate powder (3800 mg, 3.0 eq.). After stirring at room temperature for 5 min, cyclopropylmethyl bromide (1400 mg, 2.0 equiv.) and potassium iodide (64 mg, 0.1 equiv.) were added at room temperature. The resulting reaction mixture was stirred at 150° C. under microwave conditions for 1 h and, after cooling to room temperature, water and ethyl acetate were added. The aqueous phase was then repeatedly extracted with ethyl acetate. The combined organic phases were dried over magnesium sulfate, filtered and concentrated under reduced pressure. By column chromatography purification of the crude product obtained (ethyl acetate/heptane gradient), 1-(cyclopropylmethyl)-6′-nitro-1′H-spiro[cyclopentyl-1,4′-quinolin]-2′(3′H)-one (700 mg, 58% of theory) was isolated as a colorless solid. In the next step, 1-(cyclopropylmethyl)-6′-nitro-1′H-spiro[cyclohexyl-1,4′-quinolin]-2′(3′H)-one (900 mg, 1.0 equiv.) together with zinc powder (931 mg, 5.0 eq.) and ammonium chloride (759 mg, 5.0 eq.) were added to abs. methanol at a temperature of 0° C. and the mixture was stirred under argon at room temperature for 1 h. The reaction mixture was then poured onto ice-water and subsequently adjusted to pH 12 with 6 N NaOH. The aqueous phase was then repeatedly extracted with ethyl acetate. The combined organic phases were dried over magnesium sulfate, filtered and concentrated under reduced pressure. By column chromatography purification of the crude product obtained (ethyl acetate/heptane gradient), 6′-amino-1-(cyclopropylmethyl)-1′H-spiro[cyclohexyl-1,4′-quinolin]-2′(3′H)-one (750 mg, 92% of theory) was isolated as a colorless solid. 6′-Amino-1-(cyclopropylmethyl)-1′H-spiro[cyclohexyl-1,4′-quinolin]-2′(3′H)-one (70 mg, 1.0 equiv.) was dissolved together with 4-trifluoromethylbenzylsulfonyl chloride (70 mg, 1.1 equiv) in abs. dichloromethane (5 mL) under argon in a baked-out round-bottom flask under argon, then pyridine (0.1 mL, 5.0 equiv.) was added and the mixture was stirred at room temperature for 1 h. The reaction mixture was then concentrated under reduced pressure, the remaining residue was admixed with dil. HCl and dichloromethane, and the aqueous phase was extracted repeatedly with dichloromethane. The combined organic phases were dried over magnesium sulfate, filtered and concentrated under reduced pressure. By column chromatography purification of the crude product obtained (ethyl acetate/heptane gradient), N-[1′-(cyclopropylmethyl)-2′-oxo-2′,3′-dihydro-1′H-spiro[cyclohexane-1,4′-quinolin]-6′-yl]-1-(4-trifluoromethylphenyl)methanesulfonamide (60 mg, 48% of theory) was isolated as a colorless solid. ¹H-NMR (400 MHz, CDCl₃ δ, ppm) 7.66 (d, 2H), 7.48 (d, 2H), 7.14-7.08 (m, 2H), 7.05 (m, 1H), 6.13 (s, 1H, NH), 4.39 (s, 2H), 3.39 (m, 2H), 2.67 (s, 2H), 1.78 (m, 1H), 1.71-1.54 (m, 8H), 1.29 (m, 1H), 1.11 (m, 1H), 0.50 (m, 2H), 0.43 (m, 2H).

### No. J3-50

### 4-Methyl-N-[1′-(cyclopropylmethyl)-2′-oxo-2′,3′-dihydro-1′H-spiro[cyclobutyl-1,4′-quinolin]-6′-yl]phenylsulfonamide

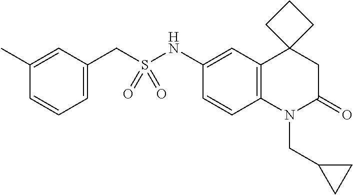 [SMILES: Cc1cccc(CS(=O)(=O)Nc2ccc3c(c2)C2(CCC2)CC(=O)N3CC2CC2)c1]

Triethyl phosphonoacetate (3.32 g, 1.0 equiv) was dissolved in abs. tetrahydrofuran and added to a suspension, cooled down to 0° C., of sodium hydride (0.58 g, 1.02 equiv, 60% dispersion) in abs. tetrahydrofuran (5 mL). The resulting reaction mixture was stirred at a temperature of 0° C. for 10 minutes and then admixed with a solution of cyclobutanone (1.0 g, 1.0 equiv) in abs. tetrahydrofuran (5 mL), and the mixture was stirred at room temperature for a further 4 h. After the cautious addition of water, the reaction mixture was concentrated under reduced pressure and admixed with dichloromethane. The aqueous phase was then repeatedly extracted with dichloromethane. The combined organic phases were dried over magnesium sulfate, filtered and concentrated under reduced pressure. By column chromatography purification of the crude product obtained (ethyl acetate/heptane gradient), ethyl cyclobutylideneacetate (1.5 g, 75% of theory) was isolated. Ethyl cyclobutylideneacetate (1.0 g, 1.0 equiv) was dissolved in methanol and admixed with a 1 M solution of KOH in aq. methanol. The resulting reaction mixture was stirred at room temperature for 16 h, then neutralized with dil. HCl, admixed with water, concentrated under reduced pressure and then admixed with dichloromethane. The aqueous phase was then repeatedly extracted with dichloromethane. The combined organic phases were dried over magnesium sulfate, filtered and concentrated under reduced pressure. By column chromatography purification of the crude product obtained (ethyl acetate/heptane gradient), cyclobutylideneacetic acid (0.40 g, 51% of theory) was isolated. Aniline (0.26 g, 1 equiv.) was dissolved in dichloromethane (5 mL) and cooled down to a temperature of 0° C., and diisopropylethylamine (1.98 mL, 4.0 equiv.), cyclopentylideneacetic acid (0.30 g, 1.0 equiv.) and N,N,N′,N′-tetramethyl-O-(benzotriazol-1-yl)uronium tetrafluoroborate (0.97 g, 1.1 equiv.) were added. The resulting reaction mixture was stirred at room temperature for 3 h, and water and dichloromethane were then added. The aqueous phase was then repeatedly extracted with dichloromethane. The combined organic phases were dried over magnesium sulfate, filtered and concentrated under reduced pressure. By column chromatography purification of the crude product obtained (ethyl acetate/heptane gradient), 2-cyclobutylidene-N-phenylacetamide (0.27 g, 54% of theory) was isolated. In the next step, aluminum trichloride (0.42 g, 3.0 equiv.) was initially charged in abs. dichloroethane (5 mL) under argon in a baked-out round-bottom flask and then, while cooling with ice, a solution of 2-cyclobutylidene-N-phenylacetamide (0.20 g, 1.0 equiv.) in abs. dichloroethane (5 mL) was added. The resulting reaction mixture was stirred at room temperature for a further 4 h and then added cautiously to ice-water. After adding aqueous HCl and dichloromethane, the aqueous phase was extracted repeatedly with dichloromethane. The combined organic phases were dried over magnesium sulfate, filtered and concentrated cautiously under reduced pressure. By column chromatography purification of the crude product obtained (ethyl acetate/heptane gradient), 1′H-spiro[cyclobutyl-1,4′-quinolin]-2′(3′H)-one was isolated as a colorless solid. 1′H-Spiro[cyclobutyl-1,4′-quinolin]-2′(3′H)-one (0.2 g, 1 equiv.) was added to conc. acetic acid (1.5 mL) and then cautiously admixed at 0° C. with fuming nitric acid (0.5 mL). The resulting reaction mixture was then stirred at 90° C. for 2 h and, after cooling to room temperature, cautiously diluted with ice-water. The aqueous phase was then repeatedly extracted with ethyl acetate. The combined organic phases were dried over magnesium sulfate, filtered and concentrated under reduced pressure. By column chromatography purification of the crude product obtained (ethyl acetate/heptane gradient), 6′-nitro-1′H-spiro[cyclobutyl-1,4′-quinolin]-2′(3′H)-one (100 mg, 78% of theory) was isolated as a colorless solid. 6′-Nitro-1′H-spiro[cyclobutyl-1,4′-quinolin]-2′(3′H)-one (100 mg, 1.0 equiv.) was dissolved under argon in abs. dioxane (2 mL) and admixed with fine cesium carbonate powder (400 mg, 3.0 equiv.). After stirring at room temperature for 5 min, cyclobutylmethyl bromide (110 mg, 2.0 equiv.) and potassium iodide (35 mg, 0.1 equiv.) were added at room temperature. The resulting reaction mixture was stirred at 150° C. under microwave conditions for 1 h and, after cooling to room temperature, water and ethyl acetate were added. The aqueous phase was then repeatedly extracted with ethyl acetate. The combined organic phases were dried over magnesium sulfate, filtered and concentrated under reduced pressure. By column chromatography purification of the crude product obtained (ethyl acetate/heptane gradient), 1-(cyclopropylmethyl)-6′-nitro-1′H-spiro[cyclobutyl-1,4′-quinolin]-2′(3′H)-one (70 mg, 60% of theory) was isolated as a colorless solid. In the next step, 1-(cyclopropylmethyl)-6′-nitro-1′H-spiro[cyclobutyl-1,4′-quinolin]-2′(3′H)-one (50 g, 1 equiv.) was added together with zinc dust (55 mg, 5 equiv.) and ammonium chloride (90 mg, 10 equiv.) to methanol/water (5:1) and the mixture was stirred under argon at a temperature of 70° C. for 2 h. After cooling to room temperature, the reaction mixture was poured onto ice-water and then adjusted to pH 12 with 6 N NaOH. The aqueous phase was then repeatedly extracted with ethyl acetate. The combined organic phases were dried over magnesium sulfate, filtered and concentrated under reduced pressure. By column chromatography purification of the crude product obtained (ethyl acetate/heptane gradient), 6′-amino-1-(cyclopropylmethyl)-1′H-spiro[cyclobutyl-1,4′-quinolin]-2′(3′H)-one (35 mg, 70% of theory) was isolated as a colorless solid. 6′-Amino-1-(cyclopropylmethyl)-1′H-spiro[cyclobutyl-1,4′-quinolin]-2′(3′H)-one (100 mg, 1.0 equiv.) was dissolved together with 4-methylphenylsulfonyl chloride (81 mg, 1.1 equiv) in abs. dichloromethane (5 mL) in a baked-out round-bottom flask under argon, then pyridine (0.15 mL, 5 equiv.) was added and the mixture was stirred at room temperature for 1 h. The reaction mixture was then concentrated under reduced pressure, the remaining residue was admixed with dil. HCl and dichloromethane, and the aqueous phase was extracted repeatedly with dichloromethane. The combined organic phases were dried over magnesium sulfate, filtered and concentrated under reduced pressure. By column chromatography purification of the crude product obtained (ethyl acetate/heptane gradient), 4-methyl-N-[1′-(cyclopropylmethyl)-2′-oxo-2′,3′-dihydro-1′H-spiro[cyclobutyl-1,4′-quinolin]-6′-yl]phenylsulfonamide (70 mg, 43% of theory) was isolated as a colorless solid. ¹H-NMR (400 MHz, d₆-DMSO δ, ppm) 10.05 (s, 1H, NH), 7.62 (d, 2H), 7.36 (d, 2H), 7.12 (m, 2H), 6.96 (m, 1H), 3.76 (m, 2H), 2.61 (s, 2H), 2.33 (s, 3H), 2.03-1.92 (m, 5H), 1.79 (m, 1H), 0.97 (m, 1H), 0.36 (m, 2H), 0.22 (m, 2H).

In analogy to the preparation examples cited above and recited at the appropriate point, and taking account of the general details relating to the preparation of substituted oxotetrahydroquinolinylsulfonamides of the general formula (I), the compounds cited below are obtained.

A1. Compounds A1-1 to A1-650 of the general formula (Iaa) in which R¹ is difluoromethyl, R², R³ and R⁴ are hydrogen, R⁹ and R¹⁰ are hydrogen, and W, R⁵, R⁶ correspond to the definitions (Nos 1 to 650; corresponding to compounds A1-1 to A1-650) in table 1 below. An arrow in any of the definitions of R⁵, R⁶ listed in table 1 represents a bond of the radical in question to the core structure (Iaa).

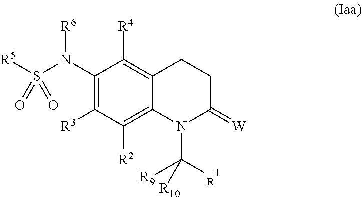

TABLE 1

| No. | R⁵ | W | R⁶ |
|---|---|---|---|
| 1 | CH₃ | O | H |
| 2 | ethyl | O | H |
| 3 | n-propyl | O | H |
| 4 | isopropyl | O | H |
| 5 | n-butyl | O | H |
| 6 | c-propyl | O | H |
| 7 | c-butyl | O | H |
| 8 | c-pentyl | O | H |
| 9 | c-hexyl | O | H |
| 10 | CH₃ | S | H |
| 11 | CH₃ | O | 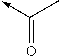 |
| 12 | CH₃ | O | 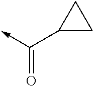 |
| 13 | CH₃ | O | 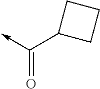 |
| 14 | CH₃ | O | CH₃ |
| 15 | CH₃ | O | 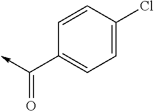 |
| 16 | CH₃ | O | Ethyl |
| 17 | ethyl | O | CH₃ |
| 18 | isopropyl | O | CH₃ |
| 19 | c-propyl | O | CH₃ |
| 20 | 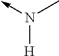 | O | H |
| 21 | 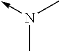 | O | H |
| 22 | 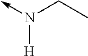 | O | H |
| 23 | 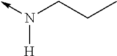 | O | H |
| 24 | 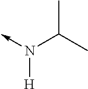 | O | H |
| 25 | 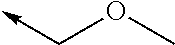 | O | H |
| 26 | 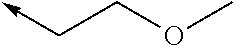 | O | H |
| 27 | 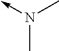 | S | H |
| 28 | 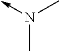 | O | CH₃ |
| 29 | 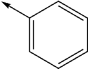 | O | H |
| 30 | 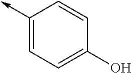 | O | H |
| 31 | 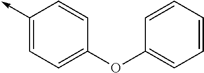 | O | H |
| 32 | 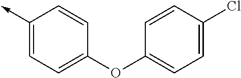 | O | H |
| 33 | 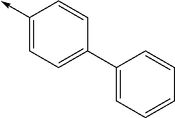 | O | H |
| 34 | 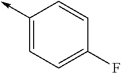 | O | H |
| 35 | 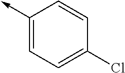 | O | H |
| 36 | 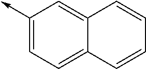 | O | H |
| 37 | 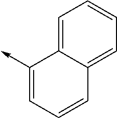 | O | H |
| 38 | 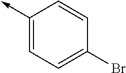 | O | H |
| 39 | 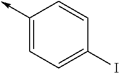 | O | H |
| 40 | 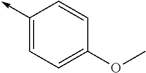 | O | H |
| 41 | 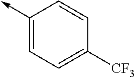 | O | H |
| 42 | 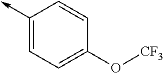 | O | H |
| 43 | 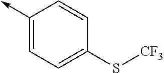 | O | H |
| 44 | 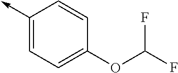 | O | H |
| 45 | 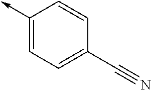 | O | H |
| 46 | 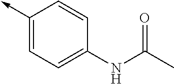 | O | H |
| 47 | 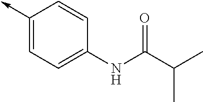 | O | H |
| 48 | 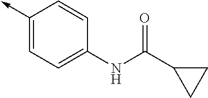 | O | H |
| 49 | NH₂ | O | H |
| 50 | 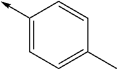 | O | H |
| 51 | 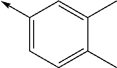 | O | H |
| 52 | 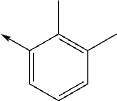 | O | H |
| 53 | 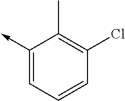 | O | H |
| 54 | 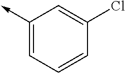 | O | H |
| 55 | 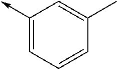 | O | H |
| 56 | 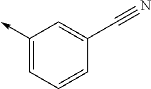 | O | H |
| 57 | 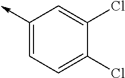 | O | H |
| 58 | 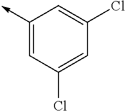 | O | H |
| 59 | 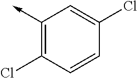 | O | H |
| 60 | 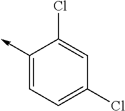 | O | H |
| 61 | 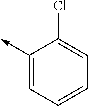 | O | H |
| 62 | 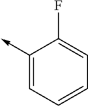 | O | H |
| 63 | 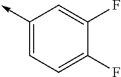 | O | H |
| 64 | 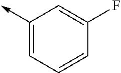 | O | H |
| 65 | 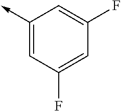 | O | H |
| 66 | 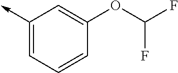 | O | H |
| 67 | 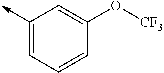 | O | H |
| 68 | 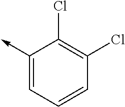 | O | H |
| 69 | 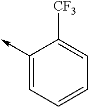 | O | H |
| 70 | 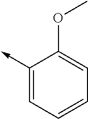 | O | H |
| 71 | 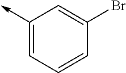 | O | H |
| 72 | 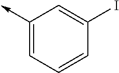 | O | H |
| 73 | 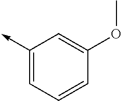 | O | H |
| 74 | 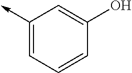 | O | H |
| 75 | 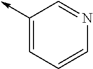 | O | H |
| 76 | 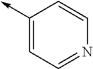 | O | H |
| 77 | 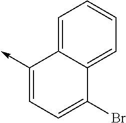 | O | H |
| 78 | 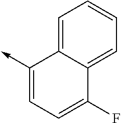 | O | H |
| 79 | 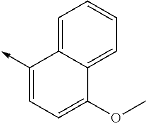 | O | H |
| 80 | 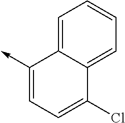 | O | H |
| 81 | 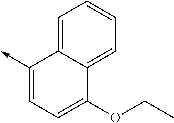 | O | H |
| 82 | 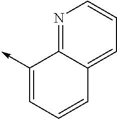 | O | H |
| 83 | 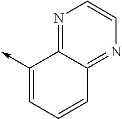 | O | H |
| 84 | 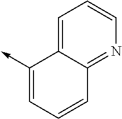 | O | H |
| 85 | 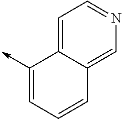 | O | H |
| 86 | 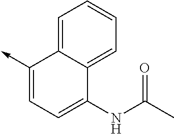 | O | H |
| 87 | 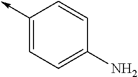 | O | H |
| 88 | 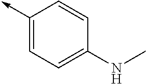 | O | H |
| 89 | 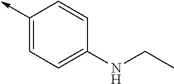 | O | H |
| 90 | 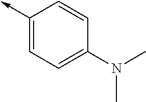 | O | H |
| 91 | 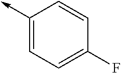 | S | H |
| 92 | 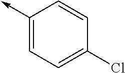 | S | H |
| 93 | 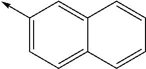 | S | H |
| 94 | 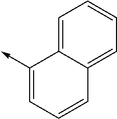 | S | H |
| 95 | 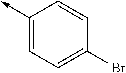 | S | H |
| 96 | 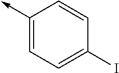 | S | H |
| 97 | 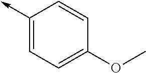 | S | H |
| 98 | 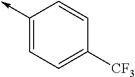 | S | H |
| 99 | 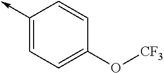 | S | H |
| 100 | 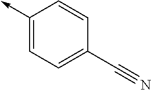 | S | H |
| 101 | 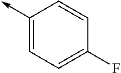 | O | CH₃ |
| 102 | 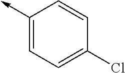 | O | CH₃ |
| 103 | 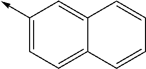 | O | CH₃ |
| 104 | 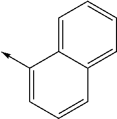 | O | CH₃ |
| 105 | 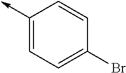 | O | CH₃ |
| 106 | 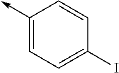 | O | CH₃ |
| 107 | 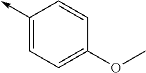 | O | CH₃ |
| 108 | 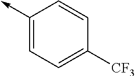 | O | CH₃ |
| 109 | 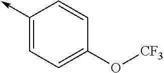 | O | CH₃ |
| 110 | 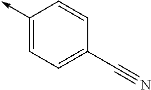 | O | 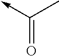 |
| 111 | 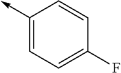 | O | 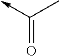 |
| 112 | 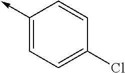 | O | 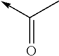 |
| 113 | 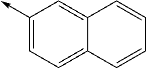 | O | 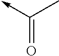 |
| 114 | 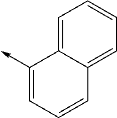 | O | 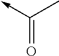 |
| 115 | 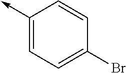 | O | 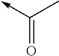 |
| 116 | 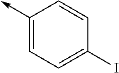 | O | 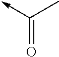 |
| 117 | 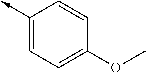 | O | 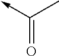 |
| 118 | 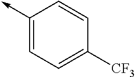 | O | 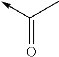 |
| 119 | 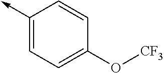 | O | 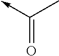 |
| 120 | 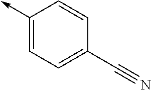 | O | 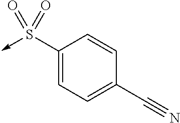 |
| 121 | 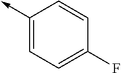 | O | 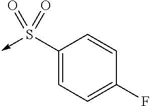 |
| 122 | 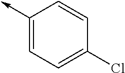 | O | 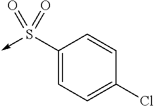 |
| 123 | 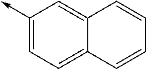 | O | 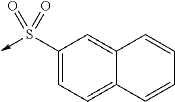 |
| 124 | 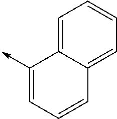 | O | 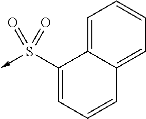 |
| 125 | 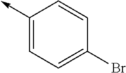 | O | 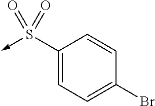 |
| 126 | 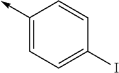 | O | 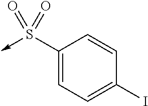 |
| 127 | 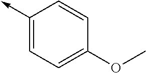 | O | 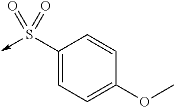 |
| 128 | 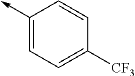 | O | 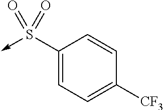 |
| 129 | 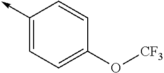 | O | 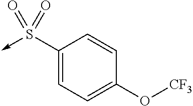 |
| 130 | 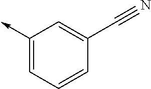 | O | 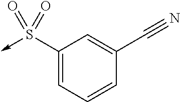 |
| 131 | 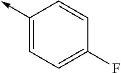 | O | 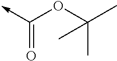 |
| 132 | 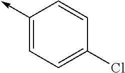 | O | 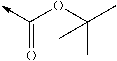 |
| 133 | 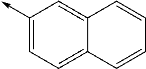 | O | 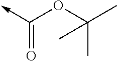 |
| 134 | 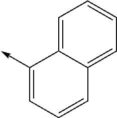 | O | 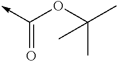 |
| 135 | 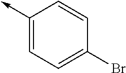 | O | 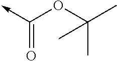 |
| 136 | 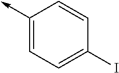 | O | 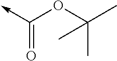 |
| 137 | 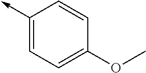 | O | 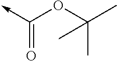 |
| 138 | 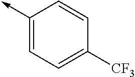 | O | 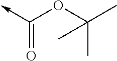 |
| 139 | 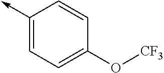 | O | 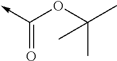 |
| 140 | 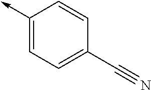 | O | 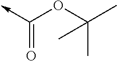 |
| 141 | 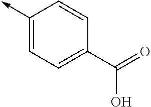 | O | H |
| 142 | 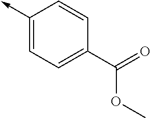 | O | H |
| 143 | 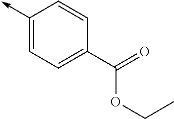 | O | H |
| 144 | 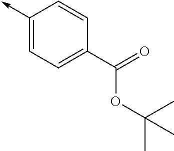 | O | H |
| 145 | 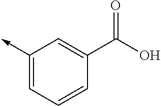 | O | H |
| 146 | 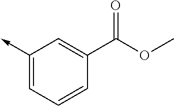 | O | H |
| 147 | 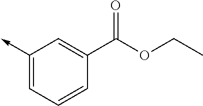 | O | H |
| 148 | 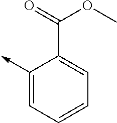 | O | H |
| 149 | 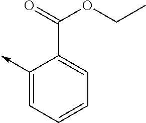 | O | H |
| 150 | 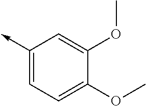 | O | H |
| 151 | 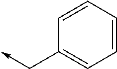 | O | H |
| 152 | 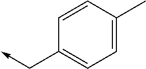 | O | H |
| 153 | 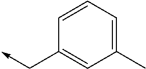 | O | H |
| 154 | 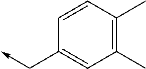 | O | H |
| 155 | 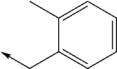 | O | H |
| 156 | 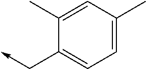 | O | H |
| 157 | 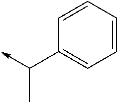 | O | H |
| 158 | 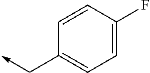 | O | H |
| 159 | 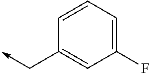 | O | H |
| 160 | 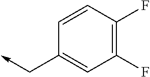 | O | H |
| 161 | 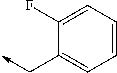 | O | H |
| 162 | 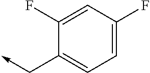 | O | H |
| 163 | 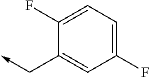 | O | H |
| 164 | 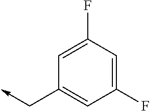 | O | H |
| 165 | 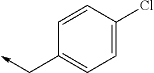 | O | H |
| 166 | 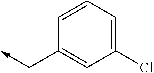 | O | H |
| 167 | 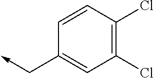 | O | H |
| 168 | 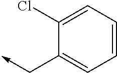 | O | H |
| 169 | 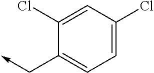 | O | H |
| 170 | 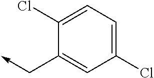 | O | H |
| 171 | 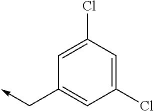 | O | H |
| 172 | 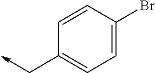 | O | H |
| 173 | 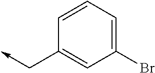 | O | H |
| 174 | 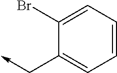 | O | H |
| 175 | 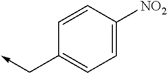 | O | H |
| 176 | 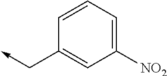 | O | H |
| 177 | 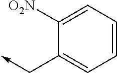 | O | H |
| 178 | 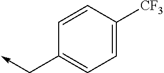 | O | H |
| 179 | 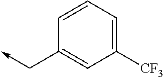 | O | H |
| 180 | 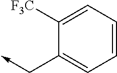 | O | H |
| 181 | 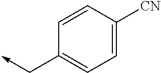 | O | H |
| 182 | 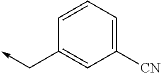 | O | H |
| 183 | 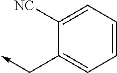 | O | H |
| 184 | 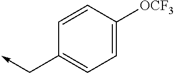 | O | H |
| 185 | 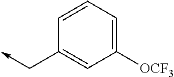 | O | H |
| 186 | 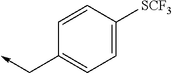 | O | H |
| 187 | 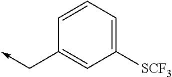 | O | H |
| 188 | 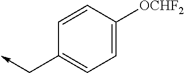 | O | H |
| 189 | 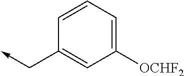 | O | H |
| 190 | 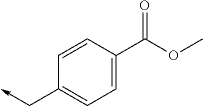 | O | H |
| 191 | 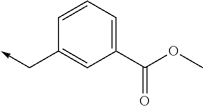 | O | H |
| 192 | 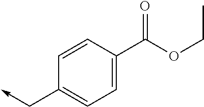 | O | H |
| 193 | 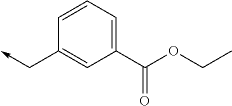 | O | H |
| 194 | 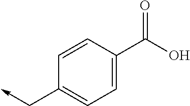 | O | H |
| 195 | 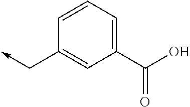 | O | H |
| 196 | 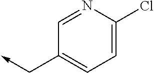 | O | H |
| 197 | 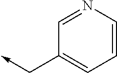 | O | H |
| 198 | 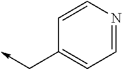 | O | H |
| 199 | 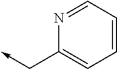 | O | H |
| 200 | 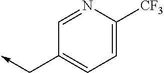 | O | H |
| 201 | 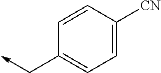 | S | H |
| 202 | 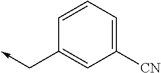 | S | H |
| 203 | 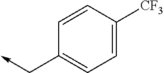 | S | H |
| 204 | 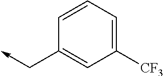 | S | H |
| 205 | 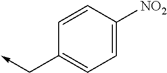 | S | H |
| 206 | 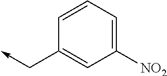 | S | H |
| 207 | 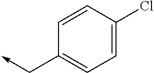 | S | H |
| 208 | 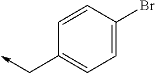 | S | H |
| 209 | 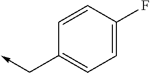 | S | H |
| 210 | 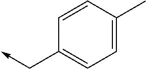 | S | H |
| 211 | 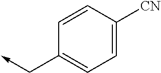 | O | CH₃ |
| 212 | 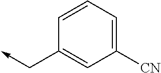 | O | CH₃ |
| 213 | 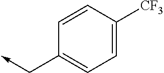 | O | CH₃ |
| 214 | 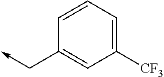 | O | CH₃ |
| 215 | 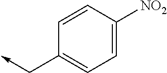 | O | CH₃ |
| 216 | 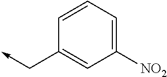 | O | CH₃ |
| 217 | 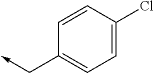 | O | CH₃ |
| 218 | 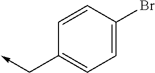 | O | CH₃ |
| 219 | 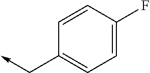 | O | CH₃ |
| 220 | 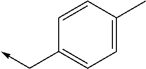 | O | CH₃ |
| 221 | 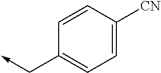 | O | Ethyl |
| 222 | 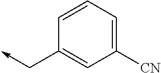 | O | Ethyl |
| 223 | 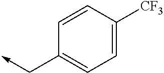 | O | Ethyl |
| 224 | 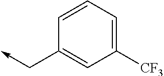 | O | Ethyl |
| 225 | 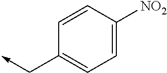 | O | Ethyl |
| 226 | 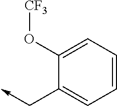 | O | H |
| 227 | 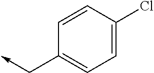 | O | Ethyl |
| 228 | 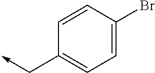 | O | Ethyl |
| 229 | 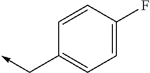 | O | Ethyl |
| 230 | 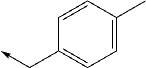 | O | Ethyl |
| 231 | 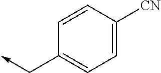 | O | 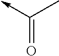 |
| 232 | 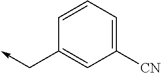 | O | 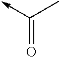 |
| 233 | 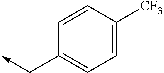 | O | 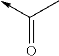 |
| 234 | 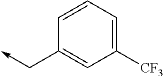 | O | 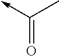 |
| 235 | 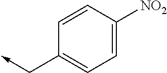 | O | 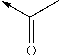 |
| 236 | 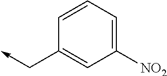 | O | 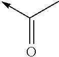 |
| 237 | 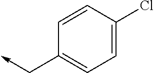 | O | 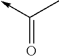 |
| 238 | 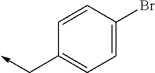 | O | 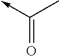 |
| 239 | 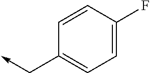 | O | 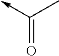 |
| 240 | 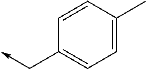 | O | 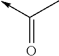 |
| 241 | 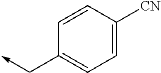 | O | 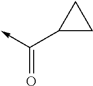 |
| 242 | 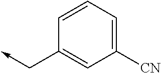 | O | 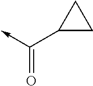 |
| 243 | 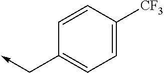 | O | 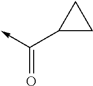 |
| 244 | 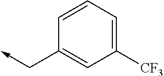 | O | 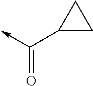 |
| 245 | 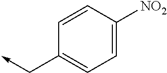 | O | 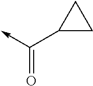 |
| 246 | 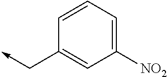 | O | 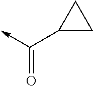 |
| 247 | 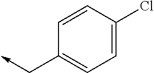 | O | 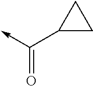 |
| 248 | 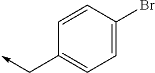 | O | 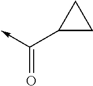 |
| 249 | 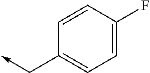 | O | 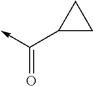 |
| 250 | 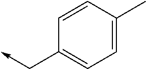 | O | 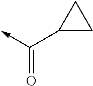 |
| 251 | 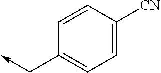 | O | 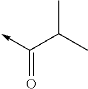 |
| 252 | 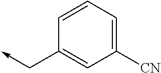 | O | 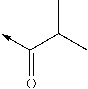 |
| 253 | 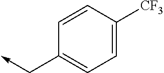 | O | 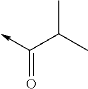 |
| 254 | 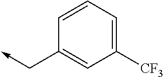 | O | 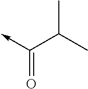 |
| 255 | 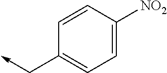 | O | 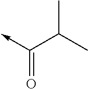 |
| 256 | 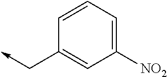 | O | 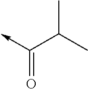 |
| 257 | 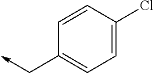 | O | 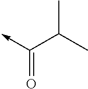 |
| 258 | 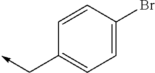 | O | 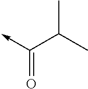 |
| 259 | 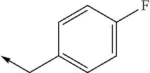 | O | 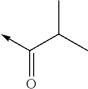 |
| 260 | 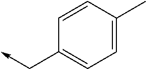 | O | 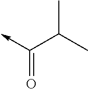 |
| 261 | 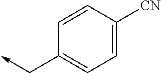 | O | 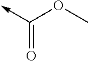 |
| 262 | 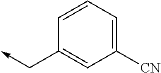 | O | 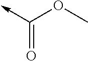 |
| 263 | 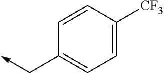 | O | 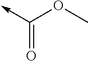 |
| 264 | 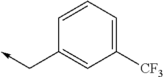 | O | 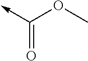 |
| 265 | 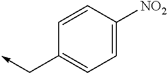 | O | 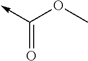 |
| 266 | 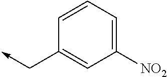 | O | 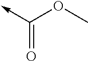 |
| 267 | 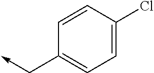 | O | 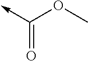 |
| 268 | 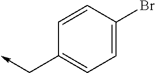 | O | 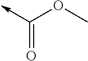 |
| 269 | 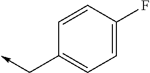 | O | 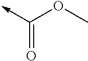 |
| 270 | 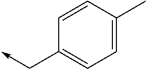 | O | 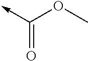 |
| 271 | 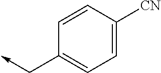 | O | 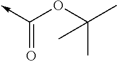 |
| 272 | 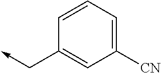 | O | 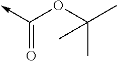 |
| 273 | 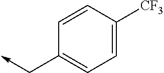 | O | 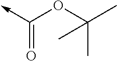 |
| 274 | 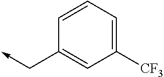 | O | 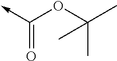 |
| 275 | 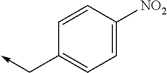 | O | 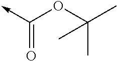 |
| 276 | 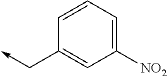 | O | 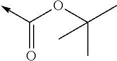 |
| 277 | 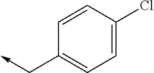 | O | 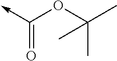 |
| 278 | 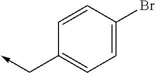 | O | 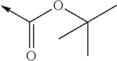 |
| 279 | 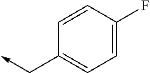 | O | 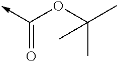 |
| 280 | 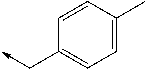 | O | 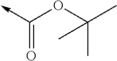 |
| 281 | 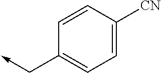 | O | 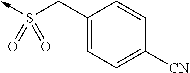 |
| 282 | 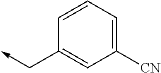 | O | 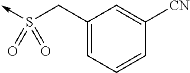 |
| 283 | 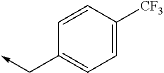 | O | 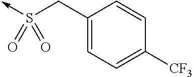 |
| 284 | 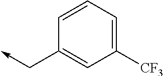 | O | 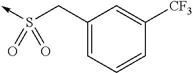 |
| 285 | 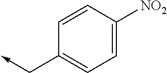 | O | 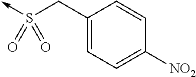 |
| 286 | 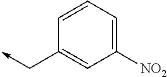 | O | 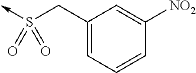 |
| 287 | 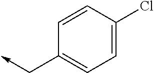 | O | 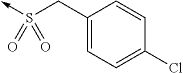 |
| 288 | 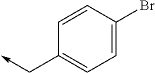 | O | 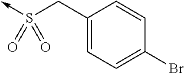 |
| 289 | 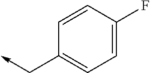 | O | 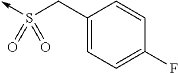 |
| 290 | 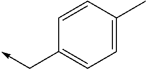 | O | 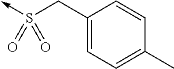 |
| 291 | 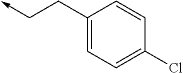 | O | H |
| 292 | 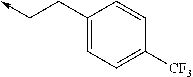 | O | H |
| 293 | 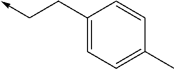 | O | H |
| 294 | 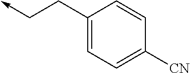 | O | H |
| 295 | 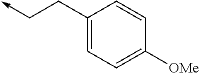 | O | H |
| 296 | 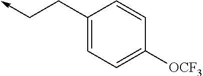 | O | H |
| 297 | 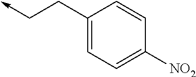 | O | H |
| 298 | 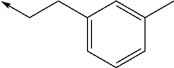 | O | H |
| 299 | 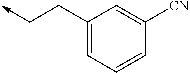 | O | H |
| 300 | 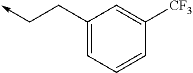 | O | H |
| 301 | 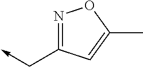 | O | H |
| 302 | pyrimidin-4-ylmethyl | O | H |
| 303 | pyrazin-2-ylmethyl | O | H |
| 304 | pyridazin-3-ylmethyl | O | H |
| 305 | pyridazin-4-ylmethyl | O | H |
| 306 | pyrimidin-2-ylmethyl | O | H |
| 307 | pyrimidin-5-ylmethyl | O | H |
| 308 | (6-methylpyridin-2-yl)methyl | O | H |
| 309 | 1-(pyridin-3-yl)ethyl | O | H |
| 310 | 1-(pyridin-2-yl)ethyl | O | H |
| 311 | (2-methylpyridin-4-yl)methyl | O | H |
| 312 | (4-hydroxyphenyl)methyl | O | H |
| 313 | (3-hydroxyphenyl)methyl | O | H |
| 314 | 1-(pyrazin-2-yl)ethyl | O | H |
| 315 | (5-methylpyrazin-2-yl)methyl | O | H |
| 316 | (2-methylpyrimidin-2-yl)methyl | O | H |
| 317 | (2-cyanopyridin-4-yl)methyl | O | H |
| 318 | (4-ethenylphenyl)methyl | O | H |
| 319 | 2,3-dihydro-1H-indan-1-yl | O | H |
| 320 | (2-formylphenyl)methyl | O | H |
| 321 | (3-formylphenyl)methyl | O | H |
| 322 | (4-formylphenyl)methyl | O | H |
| 323 | (2-ethylphenyl)methyl | O | H |
| 324 | (3-ethylphenyl)methyl | O | H |
| 325 | (4-ethylphenyl)methyl | O | H |
| 326 | 1-phenylpropan-1-yl | O | H |
| 327 | (2-isopropylphenyl)methyl | O | H |
| 328 | (3-isopropylphenyl)methyl | O | H |
| 329 | (4-isopropylphenyl)methyl | O | H |
| 330 | (2-tert-butylphenyl)methyl | O | H |
| 331 | (3-tert-butylphenyl)methyl | O | H |
| 332 | (4-tert-butylphenyl)methyl | O | H |
| 333 | (2-n-propylphenyl)methyl | O | H |
| 334 | (3-n-propylphenyl)methyl | O | H |
| 335 | (4-n-propylphenyl)methyl | O | H |
| 336 | (2-c-propylphenyl)methyl | O | H |
| 337 | (3-c-propylphenyl)methyl | O | H |
| 338 | (4-c-propylphenyl)methyl | O | H |
| 339 | 1-(4-methylphenyl)ethyl | O | H |
| 340 | 1-(3-methylphenyl)ethyl | O | H |
| 341 | 1-(2-methylphenyl)ethyl | O | H |
| 342 | (2,5-dimethylphenyl)methyl | O | H |
| 343 | (3,5-dimethylphenyl)methyl | O | H |
| 344 | (2,3-dimethylphenyl)methyl | O | H |
| 345 | (2,6-dimethylphenyl)methyl | O | H |
| 346 | (2-methoxyphenyl)methyl | O | H |
| 347 | (3-methoxyphenyl)methyl | O | H |
| 348 | (4-methoxyphenyl)methyl | O | H |
| 349 | (2,5-dimethoxyphenyl)methyl | O | H |
| 350 | (3,5-dimethoxyphenyl)methyl | O | H |
| 351 | (2,4-dimethoxyphenyl)methyl | O | H |
| 352 | (6-methoxypyridin-2-yl)methyl | O | H |
| 353 | (5-methoxypyridin-2-yl)methyl | O | H |
| 354 | (6-methoxypyridin-3-yl)methyl | O | H |
| 355 | (5-methoxypyrazin-2-yl)methyl | O | H |
| 356 | (2-methoxypyrimidin-5-yl)methyl | O | H |
| 357 | (3-fluoro-4-methylphenyl)methyl | O | H |
| 358 | (2-fluoro-4-methylphenyl)methyl | O | H |
| 359 | (4-fluoro-2-methylphenyl)methyl | O | H |
| 360 | (4-fluoro-3-methylphenyl)methyl | O | H |
| 361 | 1-(3-fluorophenyl)ethyl | O | H |
| 362 | 1-(4-fluorophenyl)ethyl | O | H |
| 363 | 1-(2-fluorophenyl)ethyl | O | H |
| 364 | 1-(2-chlorophenyl)ethyl | O | H |
| 365 | 1-(3-chlorophenyl)ethyl | O | H |
| 366 | 1-(4-chlorophenyl)ethyl | O | H |
| 367 | 1-(2-bromophenyl)ethyl | O | H |
| 368 | 1-(3-bromophenyl)ethyl | O | H |
| 369 | 1-(4-bromophenyl)ethyl | O | H |
| 370 | 1-(2-cyanophenyl)ethyl | O | H |
| 371 | 1-(3-cyanophenyl)ethyl | O | H |
| 372 | 1-(4-cyanophenyl)ethyl | O | H |
| 373 | 1-(2-trifluoromethylphenyl)ethyl | O | H |
| 374 | 1-(3-trifluoromethylphenyl)ethyl | O | H |
| 375 | 1-(4-trifluoromethylphenyl)ethyl | O | H |
| 376 | 1-(2-methoxyphenyl)ethyl | O | H |
| 377 | 1-(3-methoxyphenyl)ethyl | O | H |
| 378 | 1-(4-methoxyphenyl)ethyl | O | H |
| 379 | (4-chloropyridin-2-yl)methyl | O | H |
| 380 | (3-chloropyridin-4-yl)methyl | O | H |
| 381 | (2-chloropyridin-3-yl)methyl | O | H |
| 382 | (2-chloropyridin-4-yl)methyl | O | H |
| 383 | (2,6-difluorophenyl)methyl | O | H |
| 384 | (2,3-difluorophenyl)methyl | O | H |
| 385 | (5-chloropyrazin-2-yl)methyl | O | H |
| 386 | (2-chloropyrimidin-5-yl)methyl | O | H |
| 387 | 1-benzofuran-5-ylmethyl | O | H |
| 388 | cyclopropyl(phenyl)methyl | O | H |
| 389 | cyclopropyl(4-chlorophenyl)methyl | O | H |
| 390 | cyclopropyl(4-methylphenyl)methyl | O | H |
| 391 | cyclopropyl(4-cyanophenyl)methyl | O | H |
| 392 | cyclopropyl(4-fluorophenyl)methyl | O | H |
| 393 | indan-5-ylmethyl | O | H |
| 394 | (2,4,6-trimethylphenyl)methyl | O | H |
| 395 | (2,6-dichloro-4-methylphenyl)methyl | O | H |
| 396 | 1-(3-fluorophenyl)propyl | O | H |
| 397 | 1-(4-fluorophenyl)propyl | O | H |
| 398 | 1-(2-fluorophenyl)propyl | O | H |
| 399 | 1-(2-chlorophenyl)propyl | O | H |
| 400 | 1-(3-chlorophenyl)propyl | O | H |
| 401 | 1-(4-chlorophenyl)propyl | O | H |
| 402 | 1-(2-bromophenyl)propyl | O | H |
| 403 | 1-(3-bromophenyl)propyl | O | H |
| 404 | 1-(4-bromophenyl)propyl | O | H |
| 405 | 1-(2-cyanophenyl)propyl | O | H |
| 406 | 1-(3-cyanophenyl)propyl | O | H |
| 407 | 1-(4-cyanophenyl)propyl | O | H |
| 408 | 1-(2-trifluoromethylphenyl)propyl | O | H |
| 409 | 1-(3-trifluoromethylphenyl)propyl | O | H |
| 410 | 1-(4-trifluoromethylphenyl)propyl | O | H |
| 411 | 1-(2-methoxyphenyl)propyl | O | H |
| 412 | 1-(3-methoxyphenyl)propyl | O | H |
| 413 | 1-(4-methoxyphenyl)propyl | O | H |
| 414 | 1-(2-methylphenyl)propyl | O | H |
| 415 | 1-(3-methylphenyl)propyl | O | H |
| 416 | 1-(4-methylphenyl)propyl | O | H |
| 417 | 1-(2,4-dimethylphenyl)ethyl | O | H |
| 418 | 1-(4-ethylphenyl)ethyl | O | H |
| 419 | 1-(3,4-dimethylphenyl)ethyl | O | H |
| 420 | 1-(2,5-dimethylphenyl)ethyl | O | H |
| 421 | 1-(phenyl)butyl | O | H |
| 422 | 2-methyl-1-(phenyl)propyl | O | H |
| 423 | (2,4,5-trimethylphenyl)methyl | O | H |
| 424 | (5-cyano-2-fluorophenyl)methyl | O | H |
| 425 | (4-cyano-2-fluorophenyl)methyl | O | H |
| 426 | (2-cyano-4-fluorophenyl)methyl | O | H |
| 427 | (2-cyano-5-fluorophenyl)methyl | O | H |
| 428 | 4-(dimethylamino)phenylmethyl | O | H |
| 429 | 3-(dimethylamino)phenylmethyl | O | H |
| 430 | benzo[1,3]dioxol-5-ylmethyl | O | H |
| 431 | 4-(methoxymethyl)phenylmethyl | O | H |
| 432 | 3-(methoxymethyl)phenylmethyl | O | H |
| 433 | 2-(methoxymethyl)phenylmethyl | O | H |
| 434 | (2-methoxy-5-methylphenyl)methyl | O | H |
| 435 | (3-fluoro-4-methoxyphenyl)methyl | O | H |
| 436 | (2-fluoro-4-methoxyphenyl)methyl | O | H |
| 437 | (2-fluoro-5-methoxyphenyl)methyl | O | H |
| 438 | 1-(2,6-difluorophenyl)ethyl | O | H |
| 439 | 1-(2,5-difluorophenyl)ethyl | O | H |
| 440 | 1-(2,4-difluorophenyl)ethyl | O | H |
| 441 | 1-(2,6-dichlorophenyl)ethyl | O | H |
| 442 | 1-(2,5-dichlorophenyl)ethyl | O | H |
| 443 | 1-(2,4-dichlorophenyl)ethyl | O | H |
| 444 | 1-(2,3-dichlorophenyl)ethyl | O | H |
| 445 | 1-(3,5-dichlorophenyl)ethyl | O | H |
| 446 | 2-naphthylmethyl | O | H |
| 447 | 1-naphthylmethyl | O | H |
| 448 | quinolin-4-ylmethyl | O | H |
| 449 | quinolin-6-ylmethyl | O | H |
| 450 | quinolin-8-ylmethyl | O | H |
| 451 | quinolin-2-ylmethyl | O | H |
| 452 | quinoxalin-2-ylmethyl | O | H |
| 453 | (5-chloro-2-fluorophenyl)methyl | O | H |
| 454 | (4-chloro-2-fluorophenyl)methyl | O | H |
| 455 | (2-chloro-4-fluorophenyl)methyl | O | H |
| 456 | (2-chloro-5-fluorophenyl)methyl | O | H |
| 457 | (3-chloro-2-fluorophenyl)methyl | O | H |
| 458 | (3-chloro-4-fluorophenyl)methyl | O | H |
| 459 | (3-chloro-5-fluorophenyl)methyl | O | H |
| 460 | (4-chloro-3-fluorophenyl)methyl | O | H |
| 461 | (2-chloro-6-fluorophenyl)methyl | O | H |
| 462 | (2,4,5-trifluorophenyl)methyl | O | H |
| 463 | (2,4,6-trifluorophenyl)methyl | O | H |
| 464 | (3,4,5-trifluorophenyl)methyl | O | H |
| 465 | (3-cyano-4-methoxyphenyl)methyl | O | H |
| 466 | (4-cyano-3-methoxyphenyl)methyl | O | H |
| 467 | (4-cyano-2-methoxyphenyl)methyl | O | H |
| 468 | (4-cyclopropoxyphenyl)methyl | O | H |
| 469 | 1-benzothiophen-6-ylmethyl | O | H |
| 470 | 1-benzothiophen-5-ylmethyl | O | H |
| 471 | 1-(2,4,5-trimethylphenyl)ethyl | O | H |
| 472 | 1-(4-ethylphenyl)propyl | O | H |
| 473 | 1-(4-propan-2-ylphenyl)ethyl | O | H |
| 474 | 3-methyl-1-phenylbutan-1-yl | O | H |
| 475 | (3-acetamidophenyl)methyl | O | H |
| 476 | (4-acetamidophenyl)methyl | O | H |
| 477 | [4-(methylcarbamoyl)phenyl)methyl | O | H |
| 478 | [3-(methylcarbamoyl)phenyl)methyl | O | H |
| 479 | [4-(ethylcarbamoyl)phenyl)methyl | O | H |
| 480 | [3-(ethylcarbamoyl)phenyl)methyl | O | H |
| 481 | 1-(2,4,6-trimethylpyridin-3-yl)ethyl | O | H |
| 482 | [4-(propan-2-yloxy)phenyl]methyl | O | H |
| 483 | [3-(propan-2-yloxy)phenyl]methyl | O | H |
| 484 | (2-methyl-6-nitrophenyl)methyl | O | H |
| 485 | (4-methyl-3-nitrophenyl)methyl | O | H |
| 486 | (2-methyl-3-nitrophenyl)methyl | O | H |
| 487 | (2-methyl-4-nitrophenyl)methyl | O | H |
| 488 | 1-(2-nitrophenyl)ethyl | O | H |
| 489 | 1-(3-nitrophenyl)ethyl | O | H |
| 490 | 1-(4-nitrophenyl)ethyl | O | H |
| 491 | (3,4-dimethoxyphenyl)methyl | O | H |
| 492 | (4-methoxy-3,5-dimethylpyridin-2- | O | H |
| | yl)methyl | | |
| 493 | (4,5-dimethoxypyridin-2-yl)methyl | O | H |
| 494 | 1-(2-naphthyl)methyl | O | H |
| 495 | 1-(1-naphthyl)methyl | O | H |
| 496 | (3-chloro-4-methoxyphenyl)methyl | O | H |
| 497 | (4-chloro-3-methoxyphenyl)methyl | O | H |
| 498 | (4-chloro-2-methoxyphenyl)methyl | O | H |
| 499 | (5-chloro-2-methoxyphenyl)methyl | O | H |
| 500 | (3-chloro-5-methoxyphenyl)methyl | O | H |
| 501 | (2-methylquinolin-4-yl)methyl | O | H |
| 502 | 1-(5-chloro-2-fluorophenyl)ethyl | O | H |
| 503 | 1-(4-chloro-2-fluorophenyl)ethyl | O | H |
| 504 | 1-(2-chloro-4-fluorophenyl)ethyl | O | H |
| 505 | 1-(2-chloro-5-fluorophenyl)ethyl | O | H |
| 506 | 1-(3-chloro-2-fluorophenyl)ethyl | O | H |
| 507 | 1-(3-chloro-4-fluorophenyl)ethyl | O | H |
| 508 | 1-(3-chloro-5-fluorophenyl)ethyl | O | H |
| 509 | 1-(4-chloro-3-fluorophenyl)ethyl | O | H |
| 510 | 1-(2-chloro-6-fluorophenyl)ethyl | O | H |
| 511 | (2-hydroxyquinolin-3-yl)methyl | O | H |
| 512 | 1-(5,6,7,8-tetrahydronaphthalen-2- | O | H |
| | yl)ethyl | | |
| 513 | [5-(trifluoromethyppyridin-2-yl]methyl | O | H |
| 514 | [2-(trifluoromethyppyridin-4-yl]methyl | O | H |
| 515 | (3,6-dichloropyridin-2-yl)methyl | O | H |
| 516 | [5-(trifluoromethyppyrazin-2-yl]methyl | O | H |
| 517 | [2-(trifluoromethyl)pyrimidin-2- | O | H |
| | yl]methyl | | |
| 518 | 1-phenylhexan-1-yl | O | H |
| 519 | 1-(3-tert-butylphenyl)ethyl | O | H |
| 520 | 1-(4-tert-butylphenyl)ethyl | O | H |
| 521 | 1-(2-nitrophenyl)propyl | O | H |
| 522 | 1-(3-nitrophenyl)propyl | O | H |
| 523 | 1-(4-nitrophenyl)propyl | O | H |
| 524 | (2-methoxy-5-nitrophenyl)methyl | O | H |
| 525 | (4-methoxy-3-nitrophenyl)methyl | O | H |
| 526 | (2-methoxy-4-nitrophenyl)methyl | O | H |
| 527 | (3-methoxy-4-nitrophenyl)methyl | O | H |
| 528 | diphenylmethyl | O | H |
| 529 | (4-phenylphenyl)methyl | O | H |
| 530 | phenyl(pyridin-2-yl)methyl | O | H |
| 531 | phenyl(pyridin-3-yl)methyl | O | H |
| 532 | phenyl(pyridin-4-yl)methyl | O | H |
| 533 | (5-chloro-2-ethoxyphenyl)methyl | O | H |
| 534 | (5-chloro-2-nitrophenyl)methyl | O | H |
| 535 | (4-chloro-2-nitrophenyl)methyl | O | H |
| 536 | (2-chloro-4-nitrophenyl)methyl | O | H |
| 537 | (2-chloro-5-nitrophenyl)methyl | O | H |
| 538 | (3-chloro-2-nitrophenyl)methyl | O | H |
| 539 | (3-chloro-4-nitrophenyl)methyl | O | H |
| 540 | (3-chloro-5-nitrophenyl)methyl | O | H |
| 541 | (4-chloro-3-nitrophenyl)methyl | O | H |
| 542 | (2-chloro-6-nitrophenyl)methyl | O | H |
| 543 | (5-bromopyridin-2-yl)methyl | O | H |
| 544 | (2-bromopyridin-4-yl)methyl | O | H |
| 545 | (6-bromopyridin-2-yl)methyl | O | H |
| 546 | (2,4-difluoro-5-nitrophenyl)methyl | O | H |
| 547 | (3-methyl-2- | O | H |
| | trifluoromethylphenyl)methyl | | |
| 548 | 3,3,3-trifluoro-1-phenylpropyl | O | H |
| 549 | cyclohexyl(phenyl)methyl | O | H |
| 550 | cyclopentyl(phenyl)methyl | O | H |
| 551 | 1-(3,4-dichlorophenyl)ethyl | O | H |
| 552 | [4-(cyclopentyloxy)phenyl]methyl | O | H |
| 553 | [2-fluoro-4- | O | H |
| | (trifluoromethyl)phenyl]methyl | | |
| 554 | [3-fluoro-4- | O | H |
| | (trifluoromethyl)phenyl]methyl | | |
| 555 | [2-fluoro-5- | O | H |
| | (trifluoromethyl)phenyl]methyl | | |
| 556 | [3-fluoro-5- | O | H |
| | (trifluoromethyl)phenyl]methyl | | |
| 557 | 1-(2-nitrophenyl)butyl | O | H |
| 558 | 1-(3-nitrophenyl)butyl | O | H |
| 559 | 1-(4-nitrophenyl)butyl | O | H |
| 560 | 1-(2-cyanophenyl)butyl | O | H |
| 561 | 1-(3-cyanophenyl)butyl | O | H |
| 562 | 1-(4-cyanophenyl)butyl | O | H |
| 563 | 1-(2-fluorophenyl)butyl | O | H |
| 564 | 1-(3-fluorophenyl)butyl | O | H |
| 565 | 1-(4-fluorophenyl)butyl | O | H |
| 566 | 1-(2-chlorophenyl)butyl | O | H |
| 567 | 1-(3-chlorophenyl)butyl | O | H |
| 568 | 1-(4-chlorophenyl)butyl | O | H |
| 569 | (2,4-dinitrophenyl)methyl | O | H |
| 570 | (2-methylphenyl)(phenyl)methyl | O | H |
| 571 | 1,2-diphenylethyl | O | H |
| 572 | 1-(4-phenylphenyl)ethyl | O | H |
| 573 | (4-bromo-3-methylphenyl)methyl | O | H |
| 574 | (4-bromo-3-fluorophenyl)methyl | O | H |
| 575 | (4-bromo-3-chlorophenyl)methyl | O | H |
| 576 | (3-bromo-4-chlorophenyl)methyl | O | H |
| 577 | (3-bromo-5-chlorophenyl)methyl | O | H |
| 578 | 4-bromo-3-methylphenyl | O | H |
| 579 | 4-bromo-3-fluorophenyl | O | H |
| 580 | 4-bromo-3-chlorophenyl | O | H |
| 581 | 3-bromo-4-chlorophenyl | O | H |
| 582 | 3-bromo-5-chlorophenyl | O | H |
| 583 | 4-bromo-2-fluorophenyl | O | H |
| 584 | (5-bromo-2-fluorophenyl)methyl | O | H |
| 585 | (2-bromo-4-fluorophenyl)methyl | O | H |
| 586 | (4-bromo-2-fluorophenyl)methyl | O | H |
| 587 | (3-bromo-5-fluorophenyl)methyl | O | H |
| 588 | 5-bromo-2-fluorophenyl | O | H |
| 589 | 2-bromo-4-fluorophenyl | O | H |
| 590 | 3-bromo-5-fluorophenyl | O | H |
| 591 | 1-(2,4-dichlorophenyl)propyl | O | H |
| 592 | 1-(3,4-dichlorophenyl)propyl | O | H |
| 593 | 1-(2,6-dichlor-3-fluorophenyl)ethyl | O | H |
| 594 | 1-(2,4-dichlor-5-fluorophenyl)ethyl | O | H |
| 595 | (2-chloro-6- | O | H |
| | trifluoromethylphenyl)methyl | | |
| 596 | (2-chloro-4- | O | H |
| | trifluoromethylphenyl)methyl | | |
| 597 | (4-chloro-3- | O | H |
| | trifluoromethylphenyl)methyl | | |
| 598 | (2-chloro-4- | O | H |
| | trifluoromethylphenyl)methyl | | |
| 599 | (3-bromo-4-methoxyphenyl)methyl | O | H |
| 600 | 4-bromo-3-methoxyphenyl | O | H |
| 601 | 4-ethylphenyl | O | H |
| 602 | 4-n-propylphenyl | O | H |
| 603 | 4-isopropylphenyl | O | H |
| 604 | 4-cyclopropylphenyl | O | H |
| 605 | 4-n-butylphenyl | O | H |
| 606 | thiophen-2-yl | O | H |
| 607 | thiophen-3-yl | O | H |
| 608 | 5-methylthiophen-2-yl | O | H |
| 609 | 5-ethylthiophen-2-yl | O | H |
| 610 | 5-chlorothiophen-2-yl | O | H |
| 611 | 5-bromothiophen-2-yl | O | H |
| 612 | 4-methylthiophen-2-yl | O | H |
| 613 | 3-methylthiophen-2-yl | O | H |
| 614 | 5-fluorothiophen-3-yl | O | H |
| 615 | 3,5-dimethylthiophen-2-yl | O | H |
| 616 | 3-ethylthiophen-2-yl | O | H |
| 617 | 4,5-dimethylthiophen-2-yl | O | H |
| 618 | 3,4-dimethylthiophen-2-yl | O | H |
| 619 | 4-chlorothiophen-2-yl | O | H |
| 620 | 5-ethyl-4-methylthiophen-2-yl | O | H |
| 621 | 5-propylthiophen-2-yl | O | H |
| 622 | 5-nitrothiophen-2-yl | O | H |
| 623 | 3-nitrothiophen-2-yl | O | H |
| 624 | 4-nitrothiophen-2-yl | O | H |
| 625 | 5-n-butylthiophen-2-yl | O | H |
| 626 | 5-tert-butylthiophen-2-yl | O | H |
| 627 | 5-isobutylthiophen-2-yl | O | H |
| 628 | 5-(2-methoxyethypthiophen-2-yl | O | H |
| 629 | 3-(2-methoxyethypthiophen-2-yl | O | H |
| 630 | 2,3-dichlorothiophen-2-yl | O | H |
| 631 | 3-(1,2-oxazol-3-yl)thiophen-2-yl | O | H |
| 632 | 4-(1,2-oxazol-5-yl)thiophen-2-yl | O | H |
| 633 | 5-(1,3-oxazol-5-yl)thiophen-2-yl | O | H |
| 634 | 3,4-dichlorothiophen-2-yl | O | H |
| 635 | 5-(2-pyridyl)thiophen-2-yl | O | H |
| 636 | 4-isobutylphenyl | O | H |
| 637 | 5-n-pentylphenyl | O | H |
| 638 | 4-tert-butylphenyl | O | H |
| 639 | 5-isopentylphenyl | O | H |
| 640 | 5-neopentylphenyl | O | H |
| 641 | furan-2-yl | O | H |
| 642 | 5-methylfuran-2-yl | O | H |
| 643 | 5-ethylfuran-2-yl | O | H |
| 644 | 5-methoxycarbonylfuran-2-yl | O | H |
| 645 | 5-chlorofuran-2-yl | O | H |
| 646 | 5-bromofuran-2-yl | O | H |
| 647 | n-pentyl | O | H |
| 648 | n-hexyl | O | H |
| 649 | n-heptyl | O | H |
| 650 | n-octyl | O | H |

A2. Compounds A2-1 to A2-650 of the general formula (Iaa) shown above in which R¹ is trifluoromethyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds A2-1 to A2-650).

A3. Compounds A3-1 to A3-650 of the general formula (Iaa) in which R¹ is fluoromethyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds A3-1 to A3-650).

A4. Compounds A4-1 to A4-650 of the general formula (Iaa) in which R¹ is 2-fluoroethyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds A4-1 to A4-650).

A5. Compounds A5-1 to A5-650 of the general formula (Iaa) in which R¹ is 2-fluoroprop-2-yl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds A5-1 to A5-650).

A6. Compounds A6-1 to A6-650 of the general formula (Iaa) in which R¹ is 1,1-difluoroethyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds A6-1 to A6-650).

A7. Compounds A7-1 to A7-650 of the general formula (Iaa) in which R¹ is 2,2,2-trifluoroethyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds A7-1 to A7-650).

A8. Compounds A8-1 to A8-650 of the general formula (Iaa) in which R¹ is 3,3,3-trifluorobutyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds A8-1 to A8-650).

A9. Compounds A9-1 to A9-650 of the general formula (Iaa) in which R¹ is 1,1,2,2-tetrafluoroethyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds A9-1 to A9-650).

A10. Compounds A10-1 to A10-650 of the general formula (Iaa) in which R¹ is pentafluoroethyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds A10-1 to A10-650).

A11. Compounds A11-1 to A11-650 of the general formula (Iaa) in which R¹ is 1,1,2,2-tetrafluoroethyl, R², R³ and R⁴ are hydrogen, R⁹ is fluorine and R¹⁰ is hydrogen, and W, R⁵, R⁶ correspond to the definitions for the respective individual compound in the radical definitions cited in table 1 (Nos 1 to 650; corresponding to compounds A11-1 to A11-650).

A12. Compounds A12-1 to A12-650 of the general formula (Iaa) in which R¹ is 2,2,3,3,3-pentafluoropropyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds A12-1 to A12-650).

A13. Compounds A13-1 to A13-650 of the general formula (Iaa) in which R¹ is trifluoromethyl, R², R³ and R⁴ are hydrogen, R⁹ is trifluoromethyl and R¹⁰ is hydrogen, and W, R⁵, R⁶ correspond to the definitions for the respective individual compound in the radical definitions cited in table 1 (Nos 1 to 650; corresponding to compounds A13-1 to A13-650).

A14. Compounds A14-1 to A14-650 of the general formula (Iaa) in which R¹ is heptafluoropropyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds A14-1 to A14-650).

A15. Compounds A15-1 to A15-650 of the general formula (Iaa) in which R¹ is nonafluorobutyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds A15-1 to A15-650).

A16. Compounds A16-1 to A16-650 of the general formula (Iaa) in which R¹ is cyano, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds A16-1 to A16-650).

A17. Compounds A17-1 to A17-650 of the general formula (Iaa) in which R¹ is cyano, R², R³ and R⁴ are hydrogen, R⁹ is methyl and R¹⁰ is hydrogen, and W, R⁵, R⁶ correspond to the definitions for the respective individual compound in the radical definitions cited in table 1 (Nos 1 to 650; corresponding to compounds A17-1 to A17-650).

A18. Compounds A18-1 to A18-650 of the general formula (Iaa) in which R¹ is cyanomethyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds A18-1 to A18-650).

A19. Compounds A19-1 to A19-650 of the general formula (Iaa) in which R¹ is cyclopropyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds A19-1 to A19-650).

A20. Compounds A20-1 to A20-650 of the general formula (Iaa) in which R¹ is cyclopropyl, R², R³ and R⁴ are hydrogen, R⁹ is cyclopropyl and R¹⁰ is hydrogen, and W, R⁵, R⁶ correspond to the definitions for the respective individual compound in the radical definitions cited in table 1 (Nos 1 to 650; corresponding to compounds A20-1 to A20-650).

A21. Compounds A21-1 to A21-650 of the general formula (Iaa) R¹ is cyclobutyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds A21-1 to A21-650).

A22. Compounds A22-1 to A22-650 of the general formula (Iaa) in which R¹ is cyclopentyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds A22-1 to A22-650).

A23. Compounds A23-1 to A23-650 of the general formula (Iaa) in which R¹ is cyclohexyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds A23-1 to A23-650).

A24. Compounds A24-1 to A24-650 of the general formula (Iaa) in which R¹ is cyclopropyl, R², R³ and R⁴ are hydrogen, R⁹ is methyl and R¹⁰ is hydrogen, and W, R⁵, R⁶ correspond to the definitions for the respective individual compound in the radical definitions cited in table 1 (Nos 1 to 650; corresponding to compounds A24-1 to A24-650).

A25. Compounds A25-1 to A25-650 of the general formula (Iaa) in which R¹ is 1-methylcyclopropyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds A25-1 to A25-650).

A26. Compounds A26-1 to A26-650 of the general formula (Iaa) in which R¹ is 3-methylcyclobutyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds A26-1 to A26-650).

A27. Compounds A27-1 to A27-650 of the general formula (Iaa) in which R¹ is 3-ethylcyclobutyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds A27-1 to A27-650).

A28. Compounds A28-1 to A28-650 of the general formula (Iaa) in which R¹ is cyclopropyl, R² is fluorine, R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds A28-1 to A28-650).

A29. Compounds A29-1 to A29-650 of the general formula (Iaa) in which R¹ is cyclopropyl, R³ and R⁴ are fluorine and R² is hydrogen, R⁹ and R¹⁰ are hydrogen, and W, R⁵, R⁶ correspond to the definitions for the respective individual compound in the radical definitions cited in table 1 (Nos 1 to 650; corresponding to compounds A29-1 to A29-650).

A30. Compounds A30-1 to A30-650 of the general formula (Iaa) in which R¹ is cyclopropyl, R² and R⁴ are hydrogen and R³ is fluorine, R⁹ and R¹⁰ are hydrogen, and W, R⁵, R⁶ correspond to the definitions for the respective individual compound in the radical definitions cited in table 1 (Nos 1 to 650; corresponding to compounds A30-1 to A30-650).

A31. Compounds A31-1 to A31-650 of the general formula (Iaa) in which R¹ is 2-tetrahydrofuryl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds A31-1 to A31-650).

A32. Compounds A32-1 to A32-650 of the general formula (Iaa) in which R¹ is 2,2-dichlorocyclopropyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds A32-1 to A32-650).

A33. Compounds A33-1 to A33-650 of the general formula (Iaa) in which R¹ is tetrahydro-2H-pyran-4-yl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds A33-1 to A33-650).

A34. Compounds A34-1 to A34-650 of the general formula (Iaa) in which R¹ is 2-ethoxycarbonylcyclopropyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds A34-1 to A34-650).

A35. Compounds A35-1 to A35-650 of the general formula (Iaa) in which R¹ is 2,2-difluorocyclopropyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds A35-1 to A35-650).

A36. Compounds A36-1 to A36-650 of the general formula (Iaa) in which R¹ is 2,2,3,3-tetrafluoropropyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds A36-1 to A36-650).

A37. Compounds A37-1 to A37-650 of the general formula (Iaa) in which R¹ is 1-methylcyclopropan-1-yl, R², R³ and R⁴ are hydrogen, and W, R⁵, R⁶ correspond to the definitions for the respective individual compound in the radical definitions cited in table 1 (Nos 1 to 650; corresponding to compounds A37-1 to A37-650).

A38. Compounds A38-1 to A38-650 of the general formula (Iaa) in which R¹ is methoxymethyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds A38-1 to A38-650).

A39. Compounds A39-1 to A39-650 of the general formula (Iaa) in which R¹ is ethoxymethyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds A39-1 to A39-650).

A40. Compounds A40-1 to A40-650 of the general formula (Iaa) in which R¹ is trimethylsilylmethyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds A40-1 to A40-650).

A41. Compounds A41-1 to A41-650 of the general formula (Iaa) in which R¹ is trifluoromethoxymethyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds A41-1 to A41-650).

A42. Compounds A42-1 to A42-650 of the general formula (Iaa) in which R¹ is trifluoromethylthiomethyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds A42-1 to A42-650).

A43. Compounds A43-1 to A43-650 of the general formula (Iaa) in which R¹ is pentafluoroethoxymethyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds A43-1 to A43-650).

A44. Compounds A44-1 to A44-650 of the general formula (Iaa) in which R¹ is pentafluoroethylthiomethyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds A44-1 to A44-650).

A45. Compounds A44-1 to A44-650 of the general formula (Iaa) in which R¹ is methoxyethoxymethyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds A44-1 to A44-650).

A46. Compounds A46-1 to A46-650 of the general formula (Iaa) in which R¹ is adamantyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds A46-1 to A46-650).

A47. Compounds A47-1 to A47-650 of the general formula (Iaa) in which R¹ is 1-cyanoeth-1-yl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds A47-1 to A47-650).

A48. Compounds A48-1 to A48-650 of the general formula (Iaa) in which R¹ is 1-cyanoeth-2-yl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds A48-1 to A48-650).

A49. Compounds A49-1 to A49-650 of the general formula (Iaa) in which R¹ is methoxy, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds A49-1 to A49-650).

A50. Compounds A50-1 to A50-650 of the general formula (Iaa) in which R¹ is methoxycarbonyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds A50-1 to A50-650).

A51. Compounds A51-1 to A51-650 of the general formula (Iaa) in which R¹ is methoxycarbonylmethyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds A51-1 to A51-650).

A52. Compounds A52-1 to A52-650 of the general formula (Iaa) in which R¹ is ethoxycarbonylmethyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds A52-1 to A52-650).

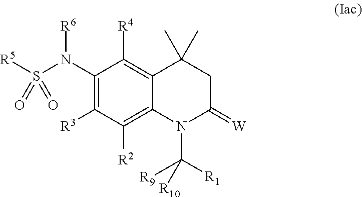

B1. Compounds B1-1 to B1-650 of the general formula (Iac) in which R¹ is difluoromethyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds B1-1 to B1-650).

B2. Compounds B2-1 to B2-650 of the general formula (Iac) shown above in which R¹ is trifluoromethyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds B2-1 to B2-650).

B3. Compounds B3-1 to B3-650 of the general formula (Iac) in which R¹ is fluoromethyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds B3-1 to B3-650).

B4. Compounds B4-1 to B4-650 of the general formula (Iac) in which R¹ is 2-fluoroethyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds B4-1 to B4-650).

B5. Compounds B5-1 to B5-650 of the general formula (Iac) in which R¹ is 2-fluoroprop-2-yl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds B5-1 to B5-650).

B6. Compounds B6-1 to B6-650 of the general formula (Iac) in which R¹ is 1,1-difluoroethyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds B6-1 to B6-650).

B7. Compounds B7-1 to B7-650 of the general formula (Iac) in which R¹ is 2,2,2-trifluoroethyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds B7-1 to B7-650).

B8. Compounds B8-1 to B8-650 of the general formula (Iac) in which R¹ is 3,3,3-trifluorobutyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds B8-1 to B8-650).

B9. Compounds B9-1 to B9-650 of the general formula (Iac) in which R¹ is 1,1,2,2-tetrafluoroethyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds B9-1 to B9-650).

B10. Compounds B10-1 to B10-650 of the general formula (Iac) in which R¹ is pentafluoroethyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds B10-1 to B10-650).

B11. Compounds B11-1 to B11-650 of the general formula (Iac) in which R¹ is 1,1,2,2-tetrafluoroethyl, R², R³ and R⁴ are hydrogen, R⁹ is fluorine and R¹⁰ is hydrogen, and W, R⁵, R⁶ correspond to the definitions for the respective individual compound in the radical definitions cited in table 1 (Nos 1 to 650; corresponding to compounds B11-1 to B11-650).

B12. Compounds B12-1 to B12-650 of the general formula (Iac) in which R¹ is 2,2,3,3,3-pentafluoropropyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds B12-1 to B12-650).

B13. Compounds B13-1 to B13-650 of the general formula (Iac) in which R¹ is trifluoromethyl, R², R³ and R⁴ are hydrogen, R⁹ is trifluoromethyl and R¹⁰ is hydrogen, and W, R⁵, R⁶ correspond to the definitions for the respective individual compound in the radical definitions cited in table 1 (Nos 1 to 650; corresponding to compounds B13-1 to B13-650).

B14. Compounds B14-1 to B14-650 of the general formula (Iac) in which R¹ is heptafluoropropyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds B14-1 to B14-650).

B15. Compounds B15-1 to B15-650 of the general formula (Iac) in which R¹ is nonafluorobutyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds B15-1 to B15-650).

B16. Compounds B16-1 to B16-650 of the general formula (Iac) in which R¹ is cyano, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds B16-1 to B16-650).

B17. Compounds B17-1 to B17-650 of the general formula (Iac) in which R¹ is cyano, R², R³ and R⁴ are hydrogen, R⁹ is methyl and R¹⁰ is hydrogen, and W, R⁵, R⁶ correspond to the definitions for the respective individual compound in the radical definitions cited in table 1 (Nos 1 to 650; corresponding to compounds B17-1 to B17-650).

B18. Compounds B18-1 to B18-650 of the general formula (Iac) in which R¹ is cyanomethyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds B18-1 to B18-650).

B19. Compounds B19-1 to B19-650 of the general formula (Iac) in which R¹ is cyclopropyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds B19-1 to B19-650).

B20. Compounds B20-1 to B20-650 of the general formula (Iac) in which R¹ is cyclopropyl, R², R³ and R⁴ are hydrogen, R⁹ is cyclopropyl and R¹⁰ is hydrogen, and W, R⁵, R⁶ correspond to the definitions for the respective individual compound in the radical definitions cited in table 1 (Nos 1 to 650; corresponding to compounds B20-1 to B20-650).

B21. Compounds B21-1 to B21-650 of the general formula (Iac) R¹ is cyclobutyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds B21-1 to B21-650).

B22. Compounds B22-1 to B22-650 of the general formula (Iac) in which R¹ is cyclopentyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds B22-1 to B22-650).

B23. Compounds B23-1 to B23-650 of the general formula (Iac) in which R¹ is cyclohexyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds B23-1 to B23-650).

B24. Compounds B24-1 to B24-650 of the general formula (Iac) in which R¹ is cyclopropyl, R², R³ and R⁴ are hydrogen, R⁹ is methyl and R¹⁰ is hydrogen, and W, R⁵, R⁶ correspond to the definitions for the respective individual compound in the radical definitions cited in table 1 (Nos 1 to 650; corresponding to compounds B24-1 to B24-650).

B25. Compounds B25-1 to B25-650 of the general formula (Iac) in which R¹ is 1-methylcyclopropyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds B25-1 to B25-650).

B26. Compounds B26-1 to B26-650 of the general formula (Iac) in which R¹ is 3-methylcyclobutyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds B26-1 to B26-650).

B27. Compounds B27-1 to B27-650 of the general formula (Iac) in which R¹ is 3-ethylcyclobutyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds B27-1 to B27-650).

B28. Compounds B28-1 to B28-650 of the general formula (Iac) in which R¹ is cyclopropyl, R² is fluorine, R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds B28-1 to B28-650).

B29. Compounds B29-1 to B29-650 of the general formula (Iac) in which R¹ is cyclopropyl, R², R³ are fluorine and R⁴ is hydrogen, R⁹ and R¹⁰ are hydrogen, and W, R⁵, R⁶ correspond to the definitions for the respective individual compound in the radical definitions cited in table 1 (Nos 1 to 650; corresponding to compounds B29-1 to B29-650).

B30. Compounds B30-1 to B30-650 of the general formula (Iac) in which R¹ is cyclohexyl, R², R³ are hydrogen and R⁴ is fluorine, R⁹ and R¹⁰ are hydrogen, and W, R⁵, R⁶ correspond to the definitions for the respective individual compound in the radical definitions cited in table 1 (Nos 1 to 650; corresponding to compounds B30-1 to B30-650).

B31. Compounds B31-1 to B31-650 of the general formula (Iac) in which R¹ is 2-tetrahydrofuryl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds B31-1 to B31-650).

B32. Compounds B32-1 to B32-650 of the general formula (Iac) in which R¹ is 2,2-dichlorocyclopropyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds B32-1 to B32-650).

B33. Compounds B33-1 to B33-650 of the general formula (Iac) in which R¹ is tetrahydro-2H-pyran-4-yl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds B33-1 to B33-650).

B34. Compounds B34-1 to B34-650 of the general formula (Iac) in which R¹ is 2-ethoxycarbonylcyclopropyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds B34-1 to B34-650).

B35. Compounds B35-1 to B35-650 of the general formula (Iac) in which R¹ is 2,2-difluorocyclopropyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds B35-1 to B35-650).

B36. Compounds B36-1 to B36-650 of the general formula (Iac) in which R¹ is 2,2,3,3-tetrafluorobutyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds B36-1 to B36-650).

B37. Compounds B37-1 to B37-650 of the general formula (Iac) in which R¹ is 1-methylcyclopropan-1-yl, R², R³ and R⁴ are hydrogen, and W, R⁵, R⁶ correspond to the definitions for the respective individual compound in the radical definitions cited in table 1 (Nos 1 to 650; corresponding to compounds B37-1 to B37-650).

B38. Compounds B38-1 to B38-650 of the general formula (Iac) in which R¹ is methoxymethyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds B38-1 to B38-650).

B39. Compounds B39-1 to B39-650 of the general formula (Iac) in which R¹ is ethoxymethyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds B39-1 to B39-650).

B40. Compounds B40-1 to B40-650 of the general formula (Iac) in which R¹ is trimethylsilylmethyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds B40-1 to B40-650).

B41. Compounds B41-1 to B41-650 of the general formula (Iac) in which R¹ is trifluoromethoxymethyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds B41-1 to B41-650).

B42. Compounds B42-1 to B42-650 of the general formula (Iac) in which R¹ is trifluoromethylthiomethyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds B42-1 to B42-650).

B43. Compounds B43-1 to B43-650 of the general formula (Iac) in which R¹ is pentafluoroethoxymethyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds B43-1 to B43-650).

B44. Compounds B44-1 to B44-650 of the general formula (Iac) in which R¹ is pentafluoroethylthiomethyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds B44-1 to B44-650).

B45. Compounds B44-1 to B44-650 of the general formula (Iac) in which R¹ is methoxyethoxymethyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds B44-1 to B44-650).

B46. Compounds B46-1 to A46-650 of the general formula (Iaa) in which R¹ is adamantyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds B46-1 to B46-650).

B47. Compounds B47-1 to B47-650 of the general formula (Iaa) in which R¹ is 1-cyanoeth-1-yl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds B47-1 to B47-650).

B48. Compounds B48-1 to B48-650 of the general formula (Iaa) in which R¹ is 1-cyanoeth-2-yl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds B48-1 to B48-650).

B49. Compounds B49-1 to B49-650 of the general formula (Iaa) in which R¹ is methoxy, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds B49-1 to B49-650).

B50. Compounds B50-1 to B50-650 of the general formula (Iaa) in which R¹ is methoxycarbonyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds B50-1 to B50-650).

B51. Compounds B51-1 to B51-650 of the general formula (Iaa) in which R¹ is methoxycarbonylmethyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds B51-1 to B51-650).

B52. Compounds B52-1 to B52-650 of the general formula (Iaa) in which R¹ is ethoxycarbonylmethyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds B52-1 to B52-650).

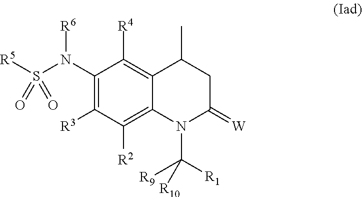

C1. Compounds C1-1 to C1-650 of the general formula (Iad) in which R¹ is difluoromethyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds C1-1 to C1-650).

C2. Compounds C2-1 to C2-650 of the general formula (Iad) shown above in which R¹ is trifluoromethyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds C2-1 to C2-650).

C3. Compounds C3-1 to C3-650 of the general formula (Iad) in which R¹ is cyclopropyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds C3-1 to C3-650).

C4. Compounds C4-1 to C4-650 of the general formula (Iad) in which R¹ is cyclopropyl, R², R³ and R⁴ are hydrogen, R⁹ is cyclopropyl and R¹⁰ is hydrogen, and W, R⁵, R⁶ correspond to the definitions for the respective individual compound in the radical definitions cited in table 1 (Nos 1 to 650; corresponding to compounds C4-1 to C4-650).

C5. Compounds C5-1 to C5-650 of the general formula (Iad) R¹ is cyclobutyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds C5-1 to C5-650).

C6. Compounds C6-1 to C6-650 of the general formula (Iad) in which R¹ is cyclopentyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds C6-1 to C6-650).

C7. Compounds C7-1 to C7-650 of the general formula (Iad) in which R¹ is methoxymethyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds C7-1 to C7-650).

C8. Compounds C8-1 to C8-650 of the general formula (Iad) in which R¹ is ethoxymethyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds C8-1 to C8-650).

C9. Compounds C9-1 to C9-650 of the general formula (Iad) in which R¹ is trimethylsilylmethyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds C9-1 to C9-650).

C10. Compounds C10-1 to C10-650 of the general formula (Iad) in which R¹ is trifluoromethoxymethyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds C10-1 to C10-650).

C11. Compounds C11-1 to C11-650 of the general formula (Iad) in which R¹ is trifluoromethylthiomethyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds C11-1 to C11-650).

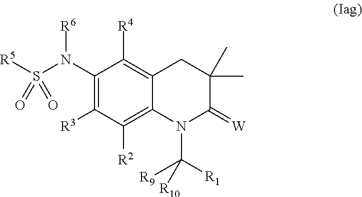

D1. Compounds D1-1 to D1-650 of the general formula (Iag) in which R¹ is difluoromethyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds D1-1 to D1-650).

D2. Compounds D2-1 to D2-650 of the general formula (Iag) shown above in which R¹ is trifluoromethyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds D2-1 to D2-650).

D3. Compounds D3-1 to D3-650 of the general formula (Iag) in which R¹ is cyclopropyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds D3-1 to D3-650).

D4. Compounds D4-1 to D4-650 of the general formula (Iag) in which R¹ is cyclopropyl, R², R³ and R⁴ are hydrogen, R⁹ is cyclopropyl and R¹⁰ is hydrogen, and W, R⁵, R⁶ correspond to the definitions for the respective individual compound in the radical definitions cited in table 1 (Nos 1 to 650; corresponding to compounds D4-1 to D4-650).

D5. Compounds D5-1 to D5-650 of the general formula (Iag) R¹ is cyclobutyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds D5-1 to D5-650).

D6. Compounds D6-1 to D6-650 of the general formula (Iag) in which R¹ is cyclopentyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds D6-1 to D6-650).

D7. Compounds D7-1 to D7-650 of the general formula (Iag) in which R¹ is methoxymethyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds D7-1 to D7-650).

D8. Compounds D8-1 to D8-650 of the general formula (Iag) in which R¹ is ethoxymethyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds D8-1 to D8-650).

D9. Compounds D9-1 to D9-650 of the general formula (Iag) in which R¹ is trimethylsilylmethyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds D9-1 to D9-650).

D10. Compounds D10-1 to D10-650 of the general formula (Iag) in which R¹ is trifluoromethoxymethyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds D10-1 to D10-650).

D11. Compounds D11-1 to D11-650 of the general formula (Iag) in which R¹ is trifluoromethylthiomethyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds D11-1 to D11-650).

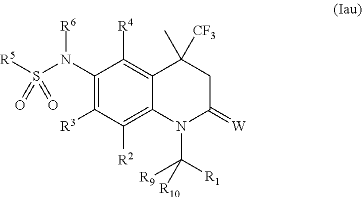

E1. Compounds E1-1 to E1-650 of the general formula (Iau) shown above in which R¹ is difluoromethyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds E1-1 to E1-650).

E2. Compounds E2-1 to E2-650 of the general formula (Iau) in which R¹ is trifluoromethyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds E2-1 to E2-650).

E3. Compounds E3-1 to E3-650 of the general formula (Iau) in which R¹ is cyclopropyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds E3-1 to E3-650).

E4. Compounds E4-1 to E4-650 of the general formula (Iau) in which R¹ is cyclopropyl, R², R³ and R⁴ are hydrogen, R⁹ is cyclopropyl and R¹⁰ is hydrogen, and W, R⁵, R⁶ correspond to the definitions for the respective individual compound in the radical definitions cited in table 1 (Nos 1 to 650; corresponding to compounds E4-1 to E4-650).

E5. Compounds E5-1 to E5-650 of the general formula (Iau) R¹ is cyclobutyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds E5-1 to E5-650).

E6. Compounds E6-1 to E6-650 of the general formula (Iau) in which R¹ is cyclopentyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds E6-1 to E6-650).

E7. Compounds E7-1 to E7-650 of the general formula (Iau) in which R¹ is methoxymethyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds E7-1 to E7-650).

E8. Compounds E8-1 to E8-650 of the general formula (Iau) in which R¹ is ethoxymethyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds E8-1 to E8-650).

E9. Compounds E9-1 to E9-650 of the general formula (Iau) in which R¹ is trimethylsilylmethyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds E9-1 to E9-650).

E10. Compounds E10-1 to E10-650 of the general formula (Iau) in which R¹ is trifluoromethoxymethyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds E10-1 to E10-650).

E11. Compounds E11-1 to E11-650 of the general formula (Iau) in which R¹ is trifluoromethylthiomethyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds E11-1 to E11-650).

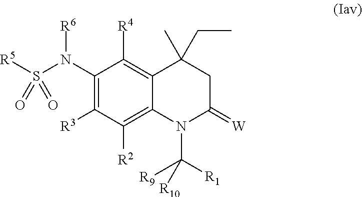

F1. Compounds F1-1 to F1-650 of the general formula (Iav) shown above in which R¹ is difluoromethyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds F1-1 to F1-650).

F2. Compounds F2-1 to F2-650 of the general formula (Iav) in which R¹ is trifluoromethyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds F2-1 to F2-650).

F3. Compounds F3-1 to F3-650 of the general formula (Iav) in which R¹ is cyclopropyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds F3-1 to F3-650).

F4. Compounds F4-1 to F4-650 of the general formula (Iav) in which R¹ is cyclopropyl, R², R³ and R⁴ are hydrogen, R⁹ is cyclopropyl and R¹⁰ is hydrogen, and W, R⁵, R⁶ correspond to the definitions for the respective individual compound in the radical definitions cited in table 1 (Nos 1 to 650; corresponding to compounds F4-1 to F4-650).

F5. Compounds F5-1 to F5-650 of the general formula (Iav) R¹ is cyclobutyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds F5-1 to F5-650).

F6. Compounds F6-1 to F6-650 of the general formula (Iav) in which R¹ is cyclopentyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds F6-1 to F6-650).

F7. Compounds F7-1 to F7-650 of the general formula (Iav) in which R¹ is methoxymethyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds F7-1 to F7-650).

F8. Compounds F8-1 to F8-650 of the general formula (Iav) in which R¹ is ethoxymethyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds F8-1 to F8-650).

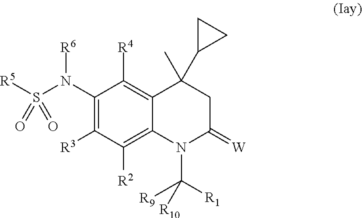

G1. Compounds G1-1 to G1-650 of the general formula (Iay) shown above in which R¹ is difluoromethyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds G1-1 to G1-650).

G2. Compounds G2-1 to G2-650 of the general formula (Iay) in which R¹ is trifluoromethyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds G2-1 to G2-650).

G3. Compounds G3-1 to G3-650 of the general formula (Iay) in which R¹ is cyclopropyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds G3-1 to G3-650).

G4. Compounds G4-1 to G4-650 of the general formula (Iay) in which R¹ is cyclopropyl, R², R³ and R⁴ are hydrogen, R⁹ is cyclopropyl and R¹⁰ is hydrogen, and W, R⁵, R⁶ correspond to the definitions for the respective individual compound in the radical definitions cited in table 1 (Nos 1 to 650; corresponding to compounds G4-1 to G4-650).

G5. Compounds G5-1 to G5-650 of the general formula (Iay) in which R¹ is cyclobutyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds G5-1 to G5-650).

G6. Compounds G6-1 to G6-650 of the general formula (Iay) in which R¹ is cyclopentyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds G6-1 to G6-650).

G7. Compounds G7-1 to G7-650 of the general formula (Iay) in which R¹ is methoxymethyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds G7-1 to G7-650).

G8. Compounds G8-1 to G8-650 of the general formula (Iay) in which R¹ is ethoxymethyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds G8-1 to G8-650).

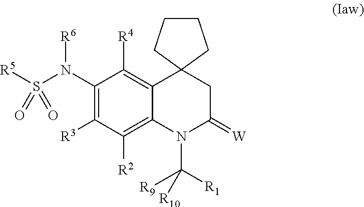

H1. Compounds H1-1 to H1-650 of the general formula (Iaw) shown above in which R¹ is difluoromethyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds H1-1 to H1-650).

H2. Compounds H2-1 to H2-650 of the general formula (Iaw) in which R¹ is trifluoromethyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds H2-1 to H2-650).

H3. Compounds H3-1 to H3-650 of the general formula (Iaw) in which R¹ is cyclopropyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds H3-1 to H3-650).

H4. Compounds H4-1 to H4-650 of the general formula (Iaw) in which R¹ is cyclobutyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds H4-1 to H4-650).

H5. Compounds H5-1 to H5-650 of the general formula (Iaw) in which R¹ is methoxymethyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds H5-1 to H5-650).

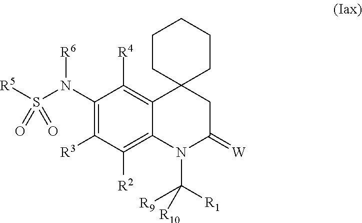

I1. Compounds I1-1 to I1-650 of the general formula (Iax) shown above in which R¹ is difluoromethyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds I1-1 to I1-650).

I2. Compounds I2-1 to I2-650 of the general formula (Iax) in which R¹ is trifluoromethyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds I2-1 to I2-650).

I3. Compounds I3-1 to I3-650 of the general formula (Iax) in which R¹ is cyclopropyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds I3-1 to I3-650).

I4. Compounds I4-1 to I4-650 of the general formula (Iax) in which R¹ is cyclobutyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds I4-1 to I4-650).

I5. Compounds I5-1 to I5-650 of the general formula (Iax) in which R¹ is methoxymethyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds I5-1 to I5-650).

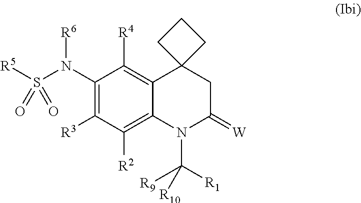

J1. Compounds J1-1 to J1-650 of the general formula (Ibi) shown above in which R¹ is difluoromethyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds J1-1 to J1-650).

J2. Compounds J2-1 to J2-650 of the general formula (Ibi) in which R¹ is trifluoromethyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds J2-1 to 12-650).

J3. Compounds J3-1 to J3-650 of the general formula (Ibi) in which R¹ is cyclopropyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds J3-1 to J3-650).

J4. Compounds J4-1 to J4-650 of the general formula (Ibi) in which R¹ is cyclobutyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds J4-1 to J4-650).

J5. Compounds J5-1 to J5-650 of the general formula (Ibi) in which R¹ is methoxymethyl, R², R³ and R⁴ are hydrogen, R⁹ and R¹⁰ are hydrogen, and W, R⁵, R⁶ correspond to the definitions for the respective individual compound in the radical definitions cited in table 1 (Nos 1 to 650; corresponding to compounds J5-1 to J5-650).

Spectroscopic data of selected table examples:

### EXAMPLE NO. A1-45

¹H-NMR (400 MHz, CDCl₃ δ, ppm) 7.87 (d, 2H), 7.77 (d, 2H), 7.01 (m, 2H), 6.88 (dd, 1H), 6.48 (br. s, 1H, NH), 6.21-5.92 (tt, 1H, CHF₂), 4.20 (m, 2H), 2.89 (m, 2H), 2.68 (m, 2H).

### EXAMPLE NO. A1-152

¹H-NMR (400 MHz, CDCl₃ δ, ppm) 7.20 (d, 2H), 7.18 (d, 2H), 7.09 (d, 1H), 7.02 (m, 1H), 6.93 (dd, 1H), 6.24-5.97 (tt, 1H, CHF₂), 6.11 (br. s, 1H, NH), 4.30 (s, 2H), 4.23 (m, 2H), 2.91 (m, 2H), 2.70 (m, 2H), 2.37 (s, 3H).

### EXAMPLE NO. A1-158

¹H-NMR (400 MHz, CDCl₃ δ, ppm) 7.30 (m, 2H), 7.08 (m, 3H), 7.00 (d, 1H), 6.94 (dd, 1H), 6.22 (br. s, 1H, NH), 6.21-5.97 (tt, 1H, CHF₂), 4.30 (s, 2H), 4.23 (m, 2H), 2.91 (dd, 2H), 2.70 (dd, 2H).

### EXAMPLE NO. A1-165

¹H-NMR (400 MHz, CDCl₃ δ, ppm) 7.36 (d, 2H), 7.24 (d, 2H), 7.08 (d, 1H), 6.99 (m, 1H), 6.95 (dd, 1H), 6.26-5.97 (tt, 1H, CHF₂), 6.11 (br. s, 1H, NH), 4.31 (s, 2H), 4.23 (m, 2H), 2.91 (m, 2H), 2.71 (m, 2H).

### EXAMPLE NO. A1-166

¹H-NMR (400 MHz, CDCl₃ δ, ppm) 7.37-7.28 (m, 3H), 7.25 (m, 1H), 7.09 (m, 1H), 6.98 (m, 1H), 6.27-5.96 (tt, 1H, CHF₂), 6.22 (br. s, 1H, NH), 4.31 (s, 2H), 4.24 (m, 2H), 2.92 (m, 2H), 2.71 (m, 2H).

### EXAMPLE NO. A1-168

¹H-NMR (400 MHz, CDCl₃ δ, ppm) 7.50 (m, 1H), 7.38 (m, 1H), 7.27 (m, 2H), 7.01 (t, 1H), 6.93 (d, 2H), 6.27 (br. s, 1H, NH), 6.21-5.92 (tt, 1H, CHF₂), 4.61 (s, 2H), 4.20 (m, 2H), 2.89 (m, 2H), 2.68 (m, 2H).

### EXAMPLE NO. A1-172

¹H-NMR (400 MHz, CDCl₃ δ, ppm) 7.50 (m, 2H), 7.19 (d, 2H), 7.09 (d, 1H), 6.99 (d, 1H), 6.95 (dd, 1H), 6.21 (br. s, 1H, NH), 6.21-5.96 (tt, 1H, CHF₂), 4.29 (s, 2H), 4.22 (m, 2H), 2.90 (m, 2H), 2.70 (m, 2H).

### EXAMPLE NO. A1-173

¹H-NMR (400 MHz, CDCl₃ δ, ppm) 7.53 (m, 1H), 7.38 (m, 1H), 7.29 (m, 2H), 7.09 (m, 1H), 7.03-6.97 (m, 2H), 6.26-5.95 (tt, 1H, CHF₂), 6.18 (br. s, 1H, NH), 4.43 (s, 2H), 4.25 (m, 2H), 2.94 (m, 2H), 2.72 (m, 2H).

### EXAMPLE NO. A1-175

¹H-NMR (400 MHz, CDCl₃ δ, ppm) 8.24 (d, 2H), 7.53 (d, 2H), 7.11 (m, 1H), 7.07 (m, 1H), 7.00 (m, 1H), 6.28 (br. s, 1H, NH), 6.26-5.94 (tt, 1H, CHF₂), 4.43 (s, 2H), 4.23 (m, 2H), 2.93 (m, 2H), 2.71 (m, 2H).

### EXAMPLE NO. A1-176

¹H-NMR (400 MHz, CDCl₃ δ, ppm) 8.25 (m, 1H), 8.10 (m, 1H), 7.73 (m, 1H), 7.59 (m, 1H), 7.11-7.03 (m, 2H), 6.99 (m, 1H), 6.25 (br. s, 1H, NH), 6.25-5.96 (tt, 1H, CHF₂), 4.43 (s, 2H), 4.25 (m, 2H), 2.94 (m, 2H), 2.72 (m, 2H).

### EXAMPLE NO. A1-177

¹H-NMR (400 MHz, CDCl₃ δ, ppm) 8.03 (m, 1H), 7.62 (m, 1H), 7.54 (m, 2H), 7.29 (m, 1H), 7.05 (m, 1H), 6.99 (m, 1H), 6.95 (m, 1H), 6.25 (br. s, 1H, NH), 6.25-5.94 (tt, 1H, CHF₂), 4.95 (s, 2H), 4.23 (m, 2H), 2.90 (m, 2H), 2.69 (m, 2H).

### EXAMPLE NO. A1-178

¹H-NMR (400 MHz, CDCl₃ δ, ppm) 7.65 (d, 2H), 7.47 (d, 2H), 7.08 (m, 1H), 6.98 (m, 1H), 6.95 (m, 1H), 6.26-5.95 (tt, 1H, CHF₂), 6.23 (br. s, 1H, NH), 4.40 (s, 2H), 4.24 (m, 2H), 2.91 (m, 2H), 2.69 (m, 2H).

### EXAMPLE NO. A1-179

¹H-NMR (400 MHz, CDCl₃ δ, ppm) 7.77 (m, 1H), 7.59 (m, 1H), 7.54 (m, 1H), 7.47 (m, 1H), 7.10 (m, 1H), 7.00 (m, 1H), 6.97 (m, 1H), 6.24 (br. s, 1H, NH), 6.24-5.96 (tt, 1H, CHF₂), 4.39 (s, 2H), 4.24 (m, 2H), 2.90 (m, 2H), 2.69 (m, 2H).

### EXAMPLE NO. A1-182

¹H-NMR (400 MHz, CDCl₃ δ, ppm) 7.68 (m, 1H), 7.61 (m, 1H), 7.56 (m, 1H), 7.52 (m, 1H), 7.10 (d, 1H), 7.01 (m, 2H), 6.21 (br. s, 1H, NH), 6.26-5.97 (tt, 1H, CHF₂), 4.36 (s, 2H), 4.25 (m, 2H), 2.96 (m, 2H), 2.72 (m, 2H).

### EXAMPLE NO. A1-291

¹H-NMR (400 MHz, CDCl₃ δ, ppm) 7.29 (d, 2H), 7.12 (d, 2H), 7.08 (d, 1H), 6.96 (dd, 1H), 6.88 (d, 1H), 6.23-5.94 (tt, 1H, CHF₂), 6.09 (br. s, 1H, NH), 4.22 (m, 2H), 3.32 (m, 2H), 3.14 (m, 2H), 2.91 (m, 2H), 2.70 (m, 2H).

### EXAMPLE NO. A2-45

¹H-NMR (400 MHz, CDCl₃ δ, ppm) 7.86 (d, 2H), 7.77 (d, 2H), 7.01 (m, 1H), 6.95 (d, 1H), 6.87 (m, 1H), 6.43 (s, 1H, NH), 4.60 (br. m, 2H), 2.91 (m, 2H), 2.71 (m, 2H).

### EXAMPLE NO. A2-152

¹H-NMR (400 MHz, CDCl₃ δ, ppm) 7.38 (m, 3H), 7.33 (m, 2H), 7.01 (m, 2H), 6.93 (m, 1H), 6.11 (br. s, 1H, NH), 4.64 (m, 2H), 4.35 (s, 2H), 2.92 (m, 2H), 2.73 (m, 2H).

### EXAMPLE NO. A2-152

¹H-NMR (400 MHz, CDCl₃ δ, ppm) 7.19 (d, 2H), 7.18 (d, 2H), 7.02 (m, 2H), 6.93 (dd, 1H), 6.10 (br. s, 1H, NH), 4.64 (m, 2H), 4.31 (s, 2H), 2.92 (m, 2H), 2.73 (m, 2H), 2.36 (s, 3H).

### EXAMPLE NO. A2-153

¹H-NMR (400 MHz, CDCl₃ δ, ppm) 7.24 (m, 1H), 7.19 (m, 1H), 7.09 (m, 2H), 7.01 (m, 2H), 6.94 (m, 1H), 6.11 (s, 1H, NH), 4.64 (br. m, 2H), 4.31 (s, 2H), 2.93 (m, 2H), 2.73 (m, 2H).

### EXAMPLE NO. A2-158

¹H-NMR (400 MHz, CDCl₃ δ, ppm) 7.28 (m, 2H), 7.06 (m, 2H), 7.00 (m, 2H), 6.95 (m, 1H), 6.10 (s, 1H, NH), 4.64 (br. m, 2H), 4.32 (s, 2H), 2.93 (m, 2H), 2.74 (m, 2H).

### EXAMPLE NO. A2-161

¹H-NMR (400 MHz, CDCl₃ δ, ppm) 7.44 (m, 1H), 7.35 (m, 1H), 7.17 (m, 1H), 7.05 (m, 1H), 7.01 (m, 1H), 6.99-6.96 (m, 2H), 6.21 (br. s, 1H, NH), 4.63 (br. m, 2H), 4.45 (s, 2H), 2.90 (m, 2H), 2.72 (m, 2H).

### EXAMPLE NO. A2-165

¹H-NMR (400 MHz, CDCl₃ δ, ppm) 7.35 (d, 2H), 7.24 (d, 2H), 7.02 (m, 2H), 6.96 (m, 1H), 6.18 (s, 1H, NH), 4.64 (br. m, 2H), 4.32 (s, 2H), 2.92 (m, 2H), 2.74 (m, 2H).

### EXAMPLE NO. A2-166

¹H-NMR (400 MHz, CDCl₃ δ, ppm) 7.37 (m, 1H), 7.33 (m, 1H), 7.29 (m, 1H), 7.24 (m, 1H), 7.00 (m, 3H), 6.17 (s, 1H, NH), 4.64 (br. m, 2H), 4.32 (s, 2H), 2.93 (m, 2H), 2.74 (m, 2H).

### EXAMPLE NO. A2-168

¹H-NMR (400 MHz, CDCl₃ δ, ppm) 7.52 (m, 1H), 7.33 (m, 1H), 7.29 (m, 2H), 6.95 (m, 3H), 6.30 (s, 1H, NH), 4.63 (s, 2H), 4.60 (br. m, 2H), 2.87 (m, 2H), 2.70 (m, 2H).

### EXAMPLE NO. A2-172

¹H-NMR (400 MHz, CDCl₃ δ, ppm) 7.51 (d, 2H), 7.18 (d, 2H), 7.00 (m, 2H), 6.95 (m, 1H), 6.13 (s, 1H, NH), 4.62 (br. m, 2H), 4.30 (s, 2H), 2.92 (m, 2H), 2.74 (m, 2H).

### EXAMPLE NO. A2-173

¹H-NMR (400 MHz, CDCl₃ δ, ppm) 7.47 (m, 2H), 7.41 (m, 1H), 7.22 (m, 2H), 7.08-6.98 (m, 4H), 4.63 (br. m, 2H), 4.29 (s, 2H), 2.93 (m, 2H), 2.73 (m, 2H).

### EXAMPLE NO. A2-175

¹H-NMR (400 MHz, CDCl₃ δ, ppm) 8.24 (d, 2H), 7.52 (d, 2H), 7.08 (m, 1H), 7.05-6.99 (m, 2H), 6.29 (s, 1H, NH), 4.63 (br. m, 2H), 4.44 (s, 2H), 2.95 (m, 2H), 2.74 (m, 2H).

### EXAMPLE NO. A2-176

¹H-NMR (400 MHz, d₆-DMSO δ, ppm) 9.83 (s, 1H, NH), 8.21 (m, 1H), 8.15 (m, 1H), 7.77 (m, 1H), 7.66 (m, 1H), 7.25 (m, 1H), 7.04 (m, 2H), 4.85 (br. m, 2H), 4.72 (s, 2H), 2.85 (m, 2H), 2.62 (m, 2H).

### EXAMPLE NO. A2-177

¹H-NMR (400 MHz, CDCl₃ δ, ppm) 8.01 (m, 1H), 7.62 (m, 1H), 7.53 (m, 2H), 7.00 (m, 1H), 6.97 (m, 2H), 6.52 (s, 1H, NH), 4.96 (s, 2H), 4.63 (br. m, 2H), 2.91 (m, 2H), 2.72 (m, 2H).

### EXAMPLE NO. A2-178

¹H-NMR (400 MHz, CDCl₃ δ, ppm) 7.64 (d, 2H), 7.46 (d, 2H), 7.02 (m, 2H), 6.97 (m, 1H), 6.22 (s, 1H, NH), 4.64 (br. m, 2H), 4.41 (s, 2H), 2.92 (m, 2H), 2.73 (m, 2H).

### EXAMPLE NO. A2-179

¹H-NMR (400 MHz, CDCl₃ δ, ppm) 7.66 (m, 1H), 7.58 (m, 1H), 7.52 (m, 1H), 7.46 (m, 1H), 7.01-6.97 (m, 3H), 6.12 (br. s, 1H, NH), 4.64 (br. m, 2H), 4.40 (s, 2H), 2.92 (m, 2H), 2.74 (m, 2H).

### EXAMPLE NO. A2-181

¹H-NMR (400 MHz, CDCl₃ δ, ppm) 7.68 (d, 2H), 7.46 (d, 2H), 7.11 (m, 1H), 7.05 (m, 2H), 6.20 (s, 1H, NH), 4.69 (br. m, 2H), 4.39 (s, 2H), 2.93 (m, 2H), 2.74 (m, 2H).

### EXAMPLE NO. A2-182

¹H-NMR (400 MHz, CDCl₃ δ, ppm) 7.68 (m, 1H), 7.60 (m, 1H), 7.58 (m, 1H), 7.52 (m, 1H), 7.02 (m, 3H), 6.18 (s, 1H, NH), 4.65 (br. m, 2H), 4.37 (s, 2H), 2.95 (m, 2H), 2.76 (m, 2H).

### EXAMPLE NO. A2-291

¹H-NMR (400 MHz, CDCl₃ δ, ppm) 7.31 (d, 2H), 7.27 (d, 2H), 7.12 (d, 1H), 6.98 (m, 1H), 6.88 (d, 1H), 6.04 (s, 1H, NH), 4.60 (br. m, 2H), 3.33 (m, 2H), 3.13 (m, 2H), 2.92 (m, 2H), 2.73 (m, 2H).

### EXAMPLE NO. A7-45

¹H-NMR (400 MHz, CDCl₃ δ, ppm) 7.87 (d, 1H), 7.76 (d, 1H), 6.99 (m, 1H), 6.91 (m, 2H), 6.84 (m, 1H), 6.47 (s, 1H, NH), 4.13 (m, 2H), 2.85 (m, 2H), 2.64 (m, 2H), 2.51-2.42 (m, 2H).

### EXAMPLE NO. A7-152

¹H-NMR (400 MHz, CDCl₃ δ, ppm) 7.21 (d, 2H), 7.19 (m, 2H), 7.02-6.97 (m, 2H), 6.91 (m, 1H), 6.11 (s, 1H, NH), 4.30 (s, 2H), 4.18 (m, 2H), 2.87 (m, 2H), 2.66 (m, 2H), 2.57-2.47 (m, 2H), 2.37 (s, 3H).

### EXAMPLE NO. A7-165

¹H-NMR (400 MHz, CDCl₃ δ, ppm) 7.35 (d, 2H), 7.28 (m, 2H), 6.97 (m, 2H), 6.91 (m, 1H), 6.11 (s, 1H, NH), 4.32 (s, 2H), 4.18 (m, 2H), 2.89 (m, 2H), 2.67 (m, 2H), 2.55-2.45 (m, 2H).

### EXAMPLE NO. A7-166

¹H-NMR (400 MHz, CDCl₃ δ, ppm) 7.38-7.24 (m, 4H), 7.04-6.98 (m, 2H), 6.91 (m, 1H), 6.18 (s, 1H, NH), 4.31 (s, 2H), 4.18 (m, 2H), 2.88 (m, 2H), 2.68 (m, 2H), 2.54-2.47 (m, 2H).

### EXAMPLE NO. A7-181

¹H-NMR (400 MHz, CDCl₃ δ, ppm) 7.69 (d, 2H), 7.47 (d, 2H), 7.07-7.00 (m, 2H), 6.95 (m, 1H), 6.24 (s, 1H, NH), 4.38 (s, 2H), 4.18 (m, 2H), 2.90 (m, 2H), 2.68 (m, 2H), 2.57-2.45 (m, 2H).

### EXAMPLE NO. A7-182

¹H-NMR (400 MHz, CDCl₃ δ, ppm) 7.68 (m, 1H), 7.62 (m, 1H), 7.56 (m, 1H), 7.53 (m, 1H), 7.06-7.00 (m, 2H), 6.93 (m, 1H), 6.29 (s, 1H, NH), 4.37 (s, 2H), 4.19 (m, 2H), 2.92 (m, 2H), 2.68 (m, 2H), 2.56-2.47 (m, 2H).

### EXAMPLE NO. A7-291

¹H-NMR (400 MHz, CDCl₃ δ, ppm) 7.29 (m, 2H), 7.13 (m, 2H), 6.99 (m, 1H), 6.88 (m, 2H), 6.07 (s, 1H, NH), 4.17 (m, 2H), 3.33 (m, 2H), 3.13 (m, 2H), 2.87 (m, 2H), 2.65 (m, 2H), 2.53-2.42 (m, 2H).

### EXAMPLE NO. A10-45

¹H-NMR (400 MHz, CDCl₃ δ, ppm) 7.86 (m, 2H), 7.77 (m, 2H), 7.01 (m, 1H), 6.94-6.87 (m, 3H), 6.47 (s, 1H, NH), 4.72-4.58 (br. m, 2H), 2.90 (m, 2H), 2.72 (m, 2H).

### EXAMPLE NO. A10-151

¹H-NMR (400 MHz, CDCl₃ δ, ppm) 7.39-7.35 (m, 3H), 7.33-7.29 (m, 2H), 7.01-6.96 (m, 2H), 6.93 (m, 1H), 6.14 (s, 1H, NH), 4.75-4.60 (br. m, 2H), 4.35 (s, 2H), 2.91 (m, 2H), 2.73 (m, 2H).

### EXAMPLE NO. A10-152

¹H-NMR (400 MHz, CDCl₃ δ, ppm) 7.21-7.17 (m, 4H), 7.02-6.92 (m, 3H), 6.10 (s, 1H, NH), 4.75-4.61 (br. m, 2H), 4.31 (s, 2H), 2.91 (m, 2H), 2.74 (m, 2H), 2.36 (s, 3H).

### EXAMPLE NO. A10-153

¹H-NMR (400 MHz, CDCl₃ δ, ppm) 7.23 (m, 1H), 7.19 (m, 1H), 7.11-7.08 (m, 2H), 7.01-6.92 (m, 3H), 6.14 (s, 1H, NH), 4.75-4.61 (br. m, 2H), 4.31 (s, 2H), 2.91 (m, 2H), 2.74 (m, 2H), 2.33 (s, 3H).

### EXAMPLE NO. A10-158

¹H-NMR (400 MHz, CDCl₃ δ, ppm) 7.31-7.26 (m, 2H), 7.09-6.93 (m, 5H), 6.13 (s, 1H, NH), 4.76-4.63 (br. m, 2H), 4.32 (s, 2H), 2.92 (m, 2H), 2.74 (m, 2H).

### EXAMPLE NO. A10-161

¹H-NMR (400 MHz, CDCl₃ δ, ppm) 7.44 (m, 1H), 7.33 (m, 1H), 7.17 (m, 1H), 7.07-7.00 (m, 2H), 6.98-6.94 (m, 2H), 6.20 (s, 1H, NH), 4.75-4.60 (br. m, 2H), 4.45 (s, 2H), 2.89 (m, 2H), 2.72 (m, 2H).

### EXAMPLE NO. A10-165

¹H-NMR (400 MHz, CDCl₃ δ, ppm) 7.36 (m, 2H), 7.24 (m, 2H), 7.02-6.99 (m, 2H), 6.96-6.93 (m, 1H), 6.19 (s, 1H, NH), 4.75-4.60 (br. m, 2H), 4.32 (s, 2H), 2.91 (m, 2H), 2.74 (m, 2H).

### EXAMPLE NO. A10-166

¹H-NMR (400 MHz, CDCl₃ δ, ppm) 7.38-7.20 (m, 4H), 7.02-6.98 (m, 3H), 6.20 (s, 1H, NH), 4.75-4.60 (br. m, 2H), 4.32 (s, 2H), 2.93 (m, 2H), 2.74 (m, 2H).

### EXAMPLE NO. A10-168

¹H-NMR (400 MHz, CDCl₃ δ, ppm) 7.52 (m, 1H), 7.33 (m, 1H), 7.29 (m, 2H), 6.97-6.93 (m, 3H), 6.27 (s, 1H, NH), 4.73-4.61 (br. m, 2H), 4.62 (s, 2H), 2.86 (m, 2H), 2.70 (m, 2H).

### EXAMPLE NO. A10-172

¹H-NMR (400 MHz, CDCl₃ δ, ppm) 7.51 (m, 2H), 7.19 (m, 2H), 7.02-6.93 (m, 3H), 6.17 (s, 1H, NH), 4.76-4.62 (br. m, 2H), 4.30 (s, 2H), 2.91 (m, 2H), 2.73 (m, 2H).

### EXAMPLE NO. A10-173

¹H-NMR (400 MHz, CDCl₃ δ, ppm) 7.52 (m, 1H), 7.39 (m, 1H), 7.30-7.23 (m, 2H), 7.02-6.98 (m, 3H), 6.23 (s, 1H, NH), 4.75-4.62 (br. m, 2H), 4.31 (s, 2H), 2.93 (m, 2H), 2.74 (m, 2H).

### EXAMPLE NO. A10-175

¹H-NMR (400 MHz, CDCl₃ δ, ppm) 8.25 (m, 2H), 7.53 (m, 2H), 7.08-6.99 (m, 3H), 6.20 (s, 1H, NH), 4.78-4.64 (br. m, 2H), 4.44 (s, 2H), 2.94 (m, 2H), 2.75 (m, 2H).

### EXAMPLE NO. A10-176

¹H-NMR (400 MHz, CDCl₃ δ, ppm) 8.24 (m, 1H), 8.11 (m, 1H), 7.73 (m, 1H), 7.58 (m, 1H), 7.10-6.96 (m, 3H), 6.32 (s, 1H, NH), 4.78-4.63 (br. m, 2H), 4.43 (s, 2H), 2.95 (m, 2H), 2.76 (m, 2H).

### EXAMPLE NO. A10-177

¹H-NMR (400 MHz, CDCl₃ δ, ppm) 8.01 (m, 1H), 7.62 (m, 1H), 7.58-7.20 (m, 2H), 6.99-6.96 (m, 3H), 6.34 (s, 1H, NH), 4.96 (s, 2H), 4.75-4.62 (br. m, 2H), 2.90 (m, 2H), 2.72 (m, 2H).

### EXAMPLE NO. A10-178

¹H-NMR (400 MHz, CDCl₃ δ, ppm) 7.64 (m, 2H), 7.46 (m, 2H), 7.02-6.94 (m, 3H), 6.22 (s, 1H, NH), 4.75-4.62 (br. m, 2H), 4.41 (s, 2H), 2.91 (m, 2H), 2.74 (m, 2H).

### EXAMPLE NO. A10-179

¹H-NMR (400 MHz, CDCl₃ δ, ppm) 7.66 (m, 1H), 7.60 (m, 1H), 7.54 (m, 1H), 7.46 (m, 1H), 7.00-6.96 (m, 3H), 6.17 (s, 1H, NH), 4.75-4.62 (br. m, 2H), 4.40 (s, 2H), 2.91 (m, 2H), 2.74 (m, 2H).

### EXAMPLE NO. A10-181

¹H-NMR (400 MHz, CDCl₃ δ, ppm) 7.68 (d, 2H), 7.45 (d, 2H), 7.08-6.97 (m, 3H), 6.31 (s, 1H, NH), 4.77-4.62 (br. m, 2H), 4.39 (s, 2H), 2.91 (m, 2H), 2.75 (m, 2H).

### EXAMPLE NO. A10-182

¹H-NMR (400 MHz, CDCl₃ δ, ppm) 7.68 (m, 1H), 7.61-7.57 (m, 2H), 7.52-7.47 (m, 1H), 7.04-6.99 (m, 3H), 6.26 (s, 1H, NH), 4.78-4.63 (br. m, 2H), 4.37 (s, 2H), 2.95 (m, 2H), 2.76 (m, 2H).

### EXAMPLE NO. A10-291

¹H-NMR (400 MHz, CDCl₃ δ, ppm) 7.32-7.27 (m, 2H), 7.12 (m, 2H), 6.99-6.94 (m, 2H), 6.88 (m, 1H), 6.04 (s, 1H, NH), 4.75-4.62 (br. m, 2H), 3.33 (m, 2H), 3.13 (m, 2H), 2.91 (m, 2H), 2.73 (m, 2H).

### EXAMPLE NO. A16-45

¹H-NMR (400 MHz, CDCl₃ δ, ppm) 7.87 (d, 2H), 7.78 (d, 2H), 7.06 (m, 1H), 6.94 (m, 2H), 6.45 (s, 1H, NH), 4.80 (s, 2H), 2.91 (m, 2H), 2.72 (m, 2H).

### EXAMPLE NO. A16-151

¹H-NMR (400 MHz, CDCl₃ δ, ppm) 7.37 (m, 3H), 7.31 (m, 2H), 7.04 (m, 1H), 6.98 (m, 2H), 6.18 (br. s, 1H, NH), 4.84 (s, 2H), 4.36 (s, 2H), 2.92 (m, 2H), 2.74 (m, 2H).

### EXAMPLE NO. A16-152

¹H-NMR (400 MHz, CDCl₃ δ, ppm) 7.51 (m, 1H), 7.20 (m, 3H), 7.05 (m, 1H), 7.00 (m, 2H), 6.10 (br. s, 1H, NH), 4.82 (s, 2H), 4.31 (s, 2H), 2.93 (dd, 2H), 2.72 (dd, 2H).

### EXAMPLE NO. A16-153

¹H-NMR (400 MHz, CDCl₃ δ, ppm) 7.24 (m, 1H), 7.20 (d, 1H), 7.11 (s, 1H), 7.09 (d, 1H), 7.04 (s, 1H), 7.00 (s, 2H), 6.19 (br. s, 1H, NH), 4.84 (s, 2H), 4.31 (s, 2H), 2.93 (dd, 2H), 2.72 (dd, 2H), 2.32 (s, 3H).

### EXAMPLE NO. A16-158

¹H-NMR (400 MHz, CDCl₃ δ, ppm) 7.30 (m, 2H), 7.06 (m, 3H), 7.00 (s, 2H), 6.21 (br. s, 1H, NH), 4.83 (s, 2H), 4.42 (s, 2H), 2.92 (dd, 2H), 2.73 (dd, 2H).

### EXAMPLE NO. A16-161

¹H-NMR (400 MHz, CDCl₃ δ, ppm) 7.44 (m, 1H), 7.38 (m, 1H), 7.89 (m, 1H), 7.09-6.94 (m, 4H), 6.30 (br. s, 1H, NH), 4.83 (s, 2H), 4.45 (s, 2H), 2.89 (m, 2H), 2.71 (m, 2H).

### EXAMPLE NO. A16-166

¹H-NMR (400 MHz, CDCl₃ δ, ppm) 7.37 (m, 1H), 7.33 (m, 1H), 7.30 (m, 1H), 7.23 (m, 1H), 7.03 (m, 3H), 6.20 (s, 1H, NH), 4.84 (s, 2H), 4.32 (s, 2H), 2.94 (m, 2H), 2.75 (m, 2H).

### EXAMPLE NO. A16-168

¹H-NMR (400 MHz, CDCl₃ δ, ppm) 7.50 (m, 1H), 7.38 (m, 1H), 7.29 (m, 2H), 7.00 (m, 2H), 6.92 (m, 1H), 6.30 (br. s, 1H, NH), 4.80 (s, 2H), 4.62 (s, 2H), 2.89 (dd, 2H), 2.70 (dd, 2H).

### EXAMPLE NO. A16-172

¹H-NMR (400 MHz, CDCl₃ δ, ppm) 7.52 (d, 3H), 7.20 (d, 2H), 7.01 (s, 1H), 7.00 (s, 2H), 6.19 (br. s, 1H, NH), 4.85 (s, 2H), 4.31 (s, 2H), 2.93 (dd, 2H), 2.72 (dd, 2H).

### EXAMPLE NO. A16-173

¹H-NMR (400 MHz, CDCl₃ δ, ppm) 7.52 (d, 2H), 7.39 (s, 2H), 7.28 (m, 2H), 7.05 (m, 1H), 7.00 (s, 2H), 6.21 (br. s, 1H, NH), 4.82 (s, 2H), 4.31 (s, 2H), 2.94 (dd, 2H), 2.72 (dd, 2H).

### EXAMPLE NO. A16-175

¹H-NMR (400 MHz, CDCl₃ δ, ppm) 8.24 (d, 2H), 7.52 (d, 2H), 7.11 (s, 1H), 7.06 (m, 2H), 6.30 (br. s, 1H, NH), 4.87 (s, 2H), 4.46 (s, 2H), 2.95 (dd, 2H), 2.73 (dd, 2H).

### EXAMPLE NO. A16-176

¹H-NMR (400 MHz, CDCl₃ δ, ppm) 8.25 (d, 1H), 8.10 (s, 1H), 7.72 (d, 1H), 7.60 (t, 1H), 7.15 (dd, 1H), 7.0 (m, 2H), 6.29 (br. s, 1H, NH), 4.85 (s, 2H), 4.43 (s, 2H), 2.95 (dd, 2H), 2.73 (dd, 2H).

### EXAMPLE NO. A16-177

¹H-NMR (400 MHz, CDCl₃ δ, ppm) 8.02 (d, 1H), 7.63 (d, 1H), 7.52 (m, 2H), 7.02-6.92 (m, 3H), 6.30 (br. s, 1H, NH), 4.98 (s, 2H), 4.85 (s, 2H), 2.92 (dd, 2H), 2.72 (dd, 2H).

### EXAMPLE NO. A16-178

¹H-NMR (400 MHz, CDCl₃ δ, ppm) 7.65 (d, 2H), 7.48 (d, 2H), 7.05 (m, 1H), 7.00 (s, 2H), 6.19 (br. s, 1H, NH), 4.83 (s, 2H), 4.40 (s, 2H), 2.92 (dd, 2H), 2.72 (dd, 2H).

### EXAMPLE NO. A16-179

¹H-NMR (400 MHz, CDCl₃ δ, ppm) 7.65 (d, 1H), 7.59 (d, 1H), 7.52 (t, 1H), 7.49 (s, 1H), 7.09 (m, 1H), 7.00 (d, 2H), 6.20 (br. s, 1H, NH), 4.82 (s, 2H), 4.40 (s, 2H), 2.92 (m, 2H), 2.72 (m, 2H).

### EXAMPLE NO. A16-181

¹H-NMR (400 MHz, CDCl₃ δ, ppm) 7.70 (d, 2H), 7.47 (d, 2H), 7.10 (m, 2H), 6.22 (br. s, 1H, NH), 4.86 (s, 2H), 4.39 (s, 2H), 2.96 (m, 2H), 2.76 (m, 2H).

### EXAMPLE NO. A16-182

¹H-NMR (400 MHz, d₆-DMSO δ, ppm) 9.86 (s, 1H, NH), 7.83 (m, 1H), 7.72 (m, 1H), 7.63 (m, 1H), 7.58 (m, 1H), 7.14 (d, 1H), 7.11 (dd, 1H), 7.05 (d, 1H), 4.99 (s, 2H), 4.60 (s, 2H), 2.87 (m, 2H), 2.77 (m, 2H).

### EXAMPLE NO. A16-291

¹H-NMR (400 MHz, CDCl₃ δ, ppm) 7.29 (d, 2H), 7.12 (d, 2H), 7.00 (m, 2H), 6.91 (d, 1H), 6.12 (s, 1H, NH), 4.83 (s, 2H), 3.35 (m, 2H), 3.14 (m, 2H), 2.92 (m, 2H), 2.73 (m, 2H).

### EXAMPLE NO. A19-152

¹H-NMR (400 MHz, d₆-DMSO) δ 9.63 (br. s, 1H, NH), 7.19 (m, 1H), 7.16 (m, 4H), 7.06 (m, 1H), 6.99 (d, 1H), 4.37 (s, 2H), 3.80 (d, 2H), 2.82 (m, 2H), 2.53 (m, 2H), 2.29 (s, 3H), 1.08 (m, 1H), 0.44 (m, 2H), 0.34 (m, 2H).

### EXAMPLE NO. A19-155

¹H-NMR (400 MHz, CDCl₃) δ 7.32-7.17 (m, 4H), 7.08 (d, 1H), 6.98 (dd, 1H), 6.94 (d, 1H), 6.13 (br. s, 1H, NH), 4.43 (s, 2H), 3.86 (d, 2H), 2.89 (m, 2H), 2.66 (m, 2H), 2.38 (s, 3H), 1.12 (m, 1H), 0.51 (m, 2H), 0.42 (m, 2H).

### EXAMPLE NO. A19-158

¹H-NMR (400 MHz, CDCl₃) δ 7.32 (m, 2H), 7.08 (m, 3H), 6.97 (m, 2H), 6.10 (br. s, 1H, NH), 4.32 (s, 2H), 3.87 (d, 2H), 2.89 (m, 2H), 2.66 (m, 2H), 1.11 (m, 1H), 0.53 (m, 2H), 0.44 (m, 2H).

### EXAMPLE NO. A19-164

¹H-NMR (400 MHz, CDCl₃) δ 7.11 (d, 1H), 7.02 (m, 2H), 6.90-6.80 (m, 3H), 6.20 (br. s, 1H, NH), 4.30 (s, 2H), 3.87 (d, 2H), 2.90 (m, 2H), 2.67 (m, 2H), 1.12 (m, 1H), 0.52 (m, 2H), 0.43 (m, 2H).

### EXAMPLE NO. A19-165

¹H-NMR (400 MHz, d₆-DMSO) δ 9.69 (br. s, 1H, NH), 7.41 (d, 2H), 7.30 (d, 2H), 7.18 (d, 1H), 7.05 (dd, 1H), 6.98 (d, 1H), 4.47 (s, 2H), 3.80 (d, 2H), 2.82 (m, 2H), 2.53 (m, 2H), 1.07 (m, 1H), 0.44 (m, 2H), 0.33 (m, 2H).

### EXAMPLE NO. A19-175

¹H-NMR (400 MHz, CDCl₃) δ 8.25 (d, 2H), 7.53 (d, 2H), 7.12 (d, 1H), 7.03 (m, 2H), 6.15 (br. s, 1H, NH), 4.43 (s, 2H), 3.87 (d, 2H), 2.91 (m, 2H), 2.67 (m, 2H), 1.12 (m, 1H), 0.52 (m, 2H), 0.42 (m, 2H).

### EXAMPLE NO. A19-178

¹H-NMR (400 MHz, d₆-DMSO) δ 9.75 (br. s, 1H, NH), 7.74 (d, 2H), 7.53 (d, 2H), 7.18 (d, 1H), 7.07 (dd, 1H), 7.01 (d, 1H), 4.59 (s, 2H), 3.79 (d, 2H), 2.81 (m, 2H), 2.53 (m, 2H), 1.09 (m, 1H), 0.44 (m, 2H), 0.34 (m, 2H).

### EXAMPLE NO. A19-181

¹H-NMR (400 MHz, d₆-DMSO) δ 9.77 (br. s, 1H, NH), 7.83 (d, 2H), 7.50 (d, 2H), 7.18 (d, 1H), 7.05 (dd, 1H), 6.99 (d, 1H), 4.60 (s, 2H), 3.80 (d, 2H), 2.81 (m, 2H), 2.53 (m, 2H), 1.09 (m, 1H), 0.45 (m, 2H), 0.34 (m, 2H).

### EXAMPLE NO. A19-182

¹H-NMR (400 MHz, CDCl₃) δ 7.68 (m, 1H), 7.63 (m, 1H), 7.59 (m, 1H), 7.52 (m, 1H), 7.12 (d, 1H), 7.02 (m, 2H), 6.24 (br. s, 1H, NH), 4.36 (s, 2H), 3.88 (d, 2H), 2.91 (m, 2H), 2.67 (m, 2H), 1.13 (m, 1H), 0.53 (m, 2H), 0.44 (m, 2H).

### EXAMPLE NO. A19-332

¹H-NMR (400 MHz, CDCl₃) δ 7.41 (d, 2H), 7.26 (m, 2H), 7.07 (d, 1H), 7.00-6.94 (m, 2H), 6.08 (br. s, 1H, NH), 4.31 (s, 2H), 3.87 (d, 2H), 2.92 (m, 2H), 2.68 (m, 2H), 1.33 (s, 9H), 1.11 (m, 1H), 0.52 (m, 2H), 0.43 (m, 2H).

### EXAMPLE NO. A19-601

¹H-NMR (400 MHz, CDCl₃) δ 7.69 (d, 2H), 7.28 (d, 2H), 6.98 (d, 1H), 6.94-6.88 (m, 2H), 6.43 (br. s, 1H, NH), 3.81 (d, 2H), 2.84 (t, 2H), 2.71 (m, 2H), 2.61 (m, 2H), 1.24 (t, 3H), 1.07 (m, 1H), 0.49 (m, 2H), 0.39 (m, 2H).

### EXAMPLE NO. A21-152

¹H-NMR (400 MHz, CDCl₃ δ, ppm) 7.22 (d, 2H), 7.19 (d, 2H), 6.96-6.91 (m, 3H), 6.02 (s, 1H, NH), 4.30 (s, 2H), 4.03 (d, 2H), 2.84 (m, 2H), 2.65 (m, 3H), 2.37 (s, 3H), 2.02 (m, 2H), 1.85 (m, 4H).

### EXAMPLE NO. A21-158

¹H-NMR (400 MHz, CDCl₃ δ, ppm) 7.30 (m, 2H), 7.08 (m, 2H), 7.00-6.92 (m, 3H), 6.15 (s, 1H, NH), 4.31 (s, 2H), 4.03 (d, 2H), 2.85 (m, 2H), 2.66 (m, 3H), 2.01 (m, 2H), 1.85 (m, 4H).

### EXAMPLE NO. A21-159

¹H-NMR (400 MHz, d₆-DMSO δ, ppm) 9.72 (br. s, 1H, NH), 7.39 (m, 1H), 7.18 (m, 1H), 7.15-6.94 (m, 5H), 4.49 (s, 2H), 3.97 (d, 2H), 2.78 (m, 2H), 2.58 (m, 3H), 1.94-1.86 (m, 2H), 1.821.68 (m, 4H).

### EXAMPLE NO. A21-165

¹H-NMR (400 MHz, CDCl₃ δ, ppm) 7.36 (d, 2H), 7.28 (d, 2H), 6.94 (m, 3H), 6.10 (s, 1H, NH), 4.31 (s, 2H), 4.03 (d, 2H), 2.84 (m, 2H), 2.66 (m, 3H), 2.02 (m, 2H), 1.86 (m, 4H).

### EXAMPLE NO. A21-178

¹H-NMR (400 MHz, CDCl₃ δ, ppm) 7.64 (d, 2H), 7.49 (d, 2H), 7.00 (dd, 1H), 6.94 (m, 2H), 6.15 (s, 1H, NH), 4.39 (s, 2H), 4.04 (d, 2H), 2.84 (m, 2H), 2.64 (m, 3H), 2.00 (m, 2H), 1.84 (m, 4H).

### EXAMPLE NO. A21-325

¹H-NMR (400 MHz, CDCl₃ δ, ppm) 7.22 (d, 2H), 7.19 (d, 2H), 6.96-6.91 (m, 3H), 6.06 (s, 1H, NH), 4.30 (s, 2H), 4.03 (d, 2H), 2.86 (m, 2H), 2.68-2.60 (m, 5H), 2.02 (m, 2H), 1.90-1.80 (m, 4H), 1.25 (t, 3H).

### EXAMPLE NO. A21-332

¹H-NMR (400 MHz, CDCl₃ δ, ppm) 7.41 (d, 2H), 7.24 (d, 2H), 6.98 (m, 1H), 6.94 (m, 2H), 6.12 (s, 1H, NH), 4.30 (s, 2H), 4.03 (d, 2H), 2.86 (m, 2H), 2.66 (m, 3H), 2.01 (m, 2H), 1.88-1.81 (m, 4H), 1.32 (s, 9H).

### EXAMPLE NO. A21-601

¹H-NMR (400 MHz, CDCl₃ δ, ppm) 7.67 (d, 2H), 7.29 (d, 2H), 6.90 (m, 1H), 6.84 (m, 2H), 6.25 (s, 1H, NH), 3.98 (d, 2H), 2.78 (m, 2H), 2.70 (q, 2H), 2.59 (m, 3H), 1.95 (m, 2H), 1.81 (m, 4H).

### EXAMPLE NO. A22-152

¹H-NMR (400 MHz, CDCl₃ δ, ppm) 7.22 (d, 2H), 7.19 (d, 2H), 6.99-6.94 (m, 3H), 6.08 (s, 1H, NH), 4.30 (s, 2H), 3.96 (d, 2H), 2.85 (m, 2H), 2.65 (m, 2H), 2.37 (s, 3H), 2.24 (m, 1H), 1.68 (m, 4H), 1.52 (m, 2H), 1.32 (m, 2H).

### EXAMPLE NO. A22-165

¹H-NMR (400 MHz, CDCl₃ δ, ppm) 7.36 (d, 2H), 7.26 (d, 2H), 6.99-6.93 (m, 3H), 6.13 (s, 1H, NH), 4.31 (s, 2H), 3.96 (d, 2H), 2.87 (m, 2H), 2.65 (m, 2H), 2.24 (m, 1H), 1.72-1.63 (m, 4H), 1.52 (m, 2H), 1.30 (m, 2H).

### EXAMPLE NO. A22-178

¹H-NMR (400 MHz, CDCl₃ δ, ppm) 7.64 (d, 2H), 7.50 (d, 2H), 7.00 (m, 2H), 6.94 (d, 1H), 6.12 (s, 1H, NH), 4.40 (s, 2H), 3.96 (d, 2H), 2.85 (m, 2H), 2.65 (m, 2H), 2.26 (m, 1H), 1.73-1.64 (m, 4H), 1.52 (m, 2H), 1.38-1.26 (m, 2H).

### EXAMPLE NO. A22-179

¹H-NMR (400 MHz, CDCl₃ δ, ppm) 7.66 (d, 1H), 7.62 (d, 1H), 7.53 (m, 1H), 7.49 (s, 1H), 7.00 (m, 2H), 6.94 (d, 1H), 6.12 (s, 1H, NH), 4.40 (s, 2H), 3.96 (d, 2H), 2.87 (m, 2H), 2.67 (m, 2H), 2.26 (m, 1H), 1.73-1.64 (m, 4H), 1.52 (m, 2H), 1.38-1.26 (m, 2H).

### EXAMPLE NO. A22-181

¹H-NMR (400 MHz, CDCl₃ δ, ppm) 7.69 (d, 2H), 7.48 (d, 2H), 7.02 (d, 1H), 6.99 (m, 2H), 6.24 (s, 1H, NH), 4.38 (s, 2H), 3.96 (d, 2H), 2.88 (m, 2H), 2.66 (m, 3H), 2.24 (m, 1H), 1.72-1.62 (m, 4H), 1.53 (m, 2H), 1.37-1.28 (m, 2H).

### EXAMPLE NO. A29-158

¹H-NMR (400 MHz, CDCl₃) δ 7.32 (m, 2H), 7.24-7.19 (m, 1H), 7.04 (m, 2H), 6.92 (m, 1H), 6.21 (br. s, 1H, NH), 4.33 (s, 2H), 3.82 (d, 2H), 2.84 (m, 2H), 2.64 (m, 2H), 1.09 (m, 1H), 0.53 (m, 2H), 0.44 (m, 2H).

### EXAMPLE NO. A30-158

¹H-NMR (400 MHz, CDCl₃) δ 7.31 (m, 2H), 7.25 (m, 1H), 7.06 (m, 2H), 6.92 (d, 1H), 6.20 (br. s, 1H, NH), 4.33 (s, 2H), 3.82 (d, 2H), 2.85 (m, 2H), 2.64 (m, 2H), 1.11 (m, 1H), 0.53 (m, 2H), 0.44 (m, 2H).

### EXAMPLE NO. A32-152

¹H-NMR (400 MHz, CDCl₃ δ, ppm) 7.21 (d, 2H), 7.19 (d, 2H), 7.08-6.97 (m, 3H), 6.14 (s, 1H, NH), 4.31 (s, 2H), 4.26 (dd, 2H), 4.12 (dd, 1H), 2.91 (m, 2H), 2.67 (m, 2H), 1.93 (m, 1H), 1.69 (m, 1H), 1.51 (m, 1H).

### EXAMPLE NO. A32-158

¹H-NMR (400 MHz, CDCl₃ δ, ppm) 7.30 (m, 2H), 7.26 (m, 2H), 7.09-6.98 (m, 3H), 6.17 (s, 1H, NH), 4.32 (s, 2H), 4.25 (dd, 2H), 4.10 (dd, 1H), 2.91 (m, 2H), 2.68 (m, 2H), 1.92 (m, 1H), 1.69 (m, 1H), 1.51 (m, 1H).

### EXAMPLE NO. A32-165

¹H-NMR (400 MHz, CDCl₃ δ, ppm) 7.37 (d, 2H), 7.26 (d, 2H), 7.06 (d, 1H), 7.00-6.95 (m, 2H), 6.13 (s, 1H, NH), 4.32 (s, 2H), 4.25 (dd, 2H), 4.11 (dd, 1H), 2.90 (m, 2H), 2.68 (m, 2H), 1.93 (m, 1H), 1.68 (m, 1H), 1.50 (m, 1H).

### EXAMPLE NO. A32-181

¹H-NMR (400 MHz, CDCl₃ δ, ppm) 7.70 (d, 2H), 7.48 (d, 2H), 7.09-7.00 (m, 3H), 6.22 (s, 1H, NH), 4.39 (s, 2H), 4.25 (dd, 2H), 4.11 (dd, 1H), 2.92 (m, 2H), 2.69 (m, 2H), 1.93 (m, 1H), 1.70 (m, 1H), 1.52 (m, 1H).

### EXAMPLE NO. A32-601

¹H-NMR (400 MHz, CDCl₃ δ, ppm) 7.68 (d, 2H), 7.29 (d, 2H), 7.00-6.91 (m, 3H), 6.44 (s, 1H, NH), 4.19 (dd, 2H), 4.06 (dd, 1H), 2.86 (m, 2H), 2.70 (q, 2H), 2.63 (m, 2H), 1.89 (m, 1H), 1.64 (m, 1H), 1.48 (m, 1H), 1.24 (t, 3H).

### EXAMPLE NO. A34-165

¹H-NMR (400 MHz, CDCl₃ δ, ppm) 7.36 (d, 2H), 7.29 (d, 2H), 7.03 (d, 1H), 6.97 (m, 2H), 6.11 (s, 1H, NH), 4.31 (s, 2H), 4.11 (m, 2H), 3.95 (d, 2H), 2.89 (m, 2H), 2.67 (m, 2H), 1.78 (m, 2H), 1.27 (t, 3H), 1.20 (m, 1H), 1.08 (m, 1H).

### EXAMPLE NO. A38-45

¹H-NMR (400 MHz, CDCl₃ δ, ppm) 7.87 (d, 2H), 7.77 (d, 2H), 7.14 (d, 1H), 6.94 (d, 1H), 6.86 (dd, 1H), 6.52 (s, 1H, NH), 4.04 (m, 2H), 3.61 (m, 2H), 3.34 (s, 3H), 2.84 (m, 2H), 2.63 (m, 2H).

### EXAMPLE NO. A38-165

¹H-NMR (400 MHz, CDCl₃ δ, ppm) 7.34 (d, 2H), 7.23 (d, 2H), 7.19 (d, 1H), 6.97 (m, 2H), 6.61 (s, 1H, NH), 4.29 (s, 2H), 4.08 (m, 2H), 3.65 (m, 2H), 3.36 (s, 3H), 2.87 (m, 2H), 2.65 (m, 2H).

### EXAMPLE NO. A38-166

¹H-NMR (400 MHz, CDCl₃ δ, ppm) 7.30-7.19 (m, 4H), 7.16 (d, 1H), 6.94-6.88 (m, 2H), 6.21 (s, 1H, NH), 4.23 (s, 2H), 4.04 (m, 2H), 3.58 (m, 2H), 3.30 (s, 3H), 2.82 (m, 2H), 2.60 (m, 2H).

### EXAMPLE NO. A38-178

¹H-NMR (400 MHz, CDCl₃ δ, ppm) 7.64 (d, 2H), 7.47 (d, 2H), 7.23 (d, 1H), 6.96 (m, 2H), 6.30 (s, 1H, NH), 4.38 (s, 2H), 4.08 (m, 2H), 3.65 (m, 2H), 3.37 (s, 3H), 2.88 (m, 2H), 2.65 (m, 2H).

### EXAMPLE NO. A39-152

¹H-NMR (400 MHz, CDCl₃ δ, ppm) 7.24 (m, 2H), 7.18 (m, 3H), 6.97-6.92 (m, 2H), 6.12 (s, 1H, NH), 4.29 (s, 2H), 4.09 (m, 2H), 3.68 (m, 2H), 3.52 (q, 2H), 2.87 (m, 2H), 2.66 (m, 2H), 2.37 (s, 3H), 1.19 (t, 3H).

### EXAMPLE NO. A40-152

¹H-NMR (400 MHz, CDCl₃ δ, ppm) 7.22 (d, 2H), 7.19 (d, 2H), 6.98 (m, 1H), 6.95 (m, 3H), 6.87 (m, 1H), 6.10 (s, 1H, NH), 4.29 (s, 3H), 3.95 (m, 2H), 2.85 (m, 2H), 2.62 (m, 2H), 2.36 (s, 3H), 0.95 (m, 2H), 0.10 (s, 9H).

### EXAMPLE NO. A42-152

¹H-NMR (400 MHz, CDCl₃ δ, ppm) 7.22 (d, 2H), 7.19 (d, 2H), 6.99 (m, 1H), 6.96 (m, 3H), 6.90 (m, 1H), 6.17 (s, 1H, NH), 4.30 (s, 2H), 4.20 (m, 2H), 3.13 (m, 2H), 2.88 (m, 2H), 2.66 (m, 2H), 2.37 (s, 3H)

### EXAMPLE NO. A44-152

¹H-NMR (400 MHz, CDCl₃ δ, ppm) 7.20-7.17 (m, 4H), 6.98 (m, 1H), 6.96 (m, 3H), 6.90 (m, 1H), 6.23 (s, 1H, NH), 4.30 (s, 2H), 4.20 (m, 2H), 3.17 (m, 2H), 2.88 (m, 2H), 2.66 (m, 2H), 2.36 (s, 3H)

### EXAMPLE NO. A39-158

¹H-NMR (400 MHz, CDCl₃ δ, ppm) 7.30 (m, 2H), 7.23 (m, 1H), 7.08 (m, 2H), 6.98-6.93 (m, 2H), 6.12 (s, 1H, NH), 4.30 (s, 2H), 4.09 (m, 2H), 3.68 (m, 2H), 3.53 (q, 2H), 2.88 (m, 2H), 2.67 (m, 2H), 1.19 (t, 3H).

### EXAMPLE NO. A39-181

¹H-NMR (400 MHz, CDCl₃ δ, ppm) 7.68 (d, 2H), 7.47 (d, 1H), 7.28 (m, 1H), 7.01-6.96 (m, 2H), 6.23 (s, 1H, NH), 4.37 (s, 2H), 4.09 (m, 2H), 3.69 (t, 2H), 3.52 (q, 2H), 2.89 (m, 2H), 2.67 (m, 2H), 1.19 (t, 3H).

### EXAMPLE NO. A46-165

¹H-NMR (400 MHz, CDCl₃ δ, ppm) 7.33 (d, 2H), 7.24 (d, 2H), 7.10 (d, 1H), 6.96 (d, 1H), 6.88 (dd, 1H), 6.10 (s, 1H, NH), 4.32 (s, 2H), 2.85 (m, 2H), 2.64 (m, 2H), 1.91 (m, 3H), 1.68 (m, 3H), 1.62-1.47 (m, 6H), 1.28 (m, 5H).

### EXAMPLE NO. A46-178

¹H-NMR (400 MHz, CDCl₃ δ, ppm) 7.65 (d, 2H), 7.47 (d, 2H), 7.13 (d, 1H), 6.99 (d, 1H), 6.90 (dd, 1H), 6.13 (s, 1H, NH), 4.40 (s, 2H), 2.87 (m, 2H), 2.64 (m, 2H), 1.91 (m, 3H), 1.68 (m, 3H), 1.62-1.47 (m, 6H), 1.29 (m, 5H).

### EXAMPLE NO. A46-181

¹H-NMR (400 MHz, CDCl₃ δ, ppm) 7.68 (d, 2H), 7.46 (d, 2H), 7.14 (d, 1H), 7.02 (d, 1H), 6.91 (dd, 1H), 6.15 (s, 1H, NH), 4.39 (s, 2H), 2.87 (m, 2H), 2.65 (m, 2H), 1.92 (m, 3H), 1.68 (m, 3H), 1.62-1.47 (m, 9H), 1.29 (m, 2H).

### EXAMPLE NO. A47-165

¹H-NMR (400 MHz, CDCl₃ δ, ppm) 7.36 (d, 2H), 7.24 (d, 2H), 7.02-6.95 (m, 3H), 6.19 (s, 1H, NH), 4.32 (s, 2H), 4.12 (m, 2H), 3.25 (m, 1H), 2.91 (m, 2H), 2.70 (m, 2H), 1.41 (d, 3H).

### EXAMPLE NO. A47-166

¹H-NMR (400 MHz, CDCl₃ δ, ppm) 7.54 (m, 1H), 7.49 (m, 1H), 7.27 (m, 2H), 7.04-6.98 (m, 3H), 6.21 (s, 1H, NH), 4.30 (s, 2H), 4.11 (d, 2H), 3.26 (m, 1H), 2.90 (m, 2H), 2.70 (m, 2H), 1.40 (d, 3H).

### EXAMPLE NO. A47-182

¹H-NMR (400 MHz, CDCl₃ δ, ppm) 7.38 (m, 1H), 7.31 (m, 1H), 7.24 (m, 2H), 7.04-6.98 (m, 3H), 6.20 (s, 1H, NH), 4.31 (s, 2H), 4.13 (d, 2H), 3.24 (m, 1H), 2.92 (m, 2H), 2.69 (m, 2H), 1.41 (d, 3H).

### EXAMPLE NO. A48-45

¹H-NMR (400 MHz, CDCl₃ δ, ppm) 7.87 (d, 2H), 7.77 (d, 2H), 6.99 (s, 1H), 6.90-6.87 (m, 2H), 6.48 (br. s, 1H, NH), 4.03 (m, 2H), 2.88 (m, 2H), 2.65 (m, 2H), 2.44 (m, 2H), 2.01 (m, 2H).

### EXAMPLE NO. A48-152

¹H-NMR (400 MHz, CDCl₃ δ, ppm) 7.21-7.18 (m, 4H), 7.02 (m, 1H), 7.00-6.93 (m, 2H), 6.09 (br. s, 1H, NH), 4.30 (s, 2H), 4.07 (m, 2H), 2.90 (m, 2H), 2.67 (m, 2H), 2.46 (m, 2H), 2.37 (s, 3H), 2.04 (m, 2H).

### EXAMPLE NO. A48-165

¹H-NMR (400 MHz, CDCl₃ δ, ppm) 7.36 (d, 2H), 7.28 (d, 2H), 7.00-6.94 (m, 3H), 6.21 (br. s, 1H, NH), 4.32 (s, 2H), 4.09 (m, 2H), 2.90 (m, 2H), 2.67 (m, 2H), 2.46 (m, 2H), 2.04 (m, 2H).

### EXAMPLE NO. A48-166

¹H-NMR (400 MHz, CDCl₃ δ, ppm) 7.37-7.32 (m, 2H), 7.29-7.22 (m, 3H), 7.04-6.99 (m, 2H), 6.96 (m, 1H), 6.28 (br. s, 1H, NH), 4.31 (s, 2H), 4.09 (m, 2H), 2.91 (m, 2H), 2.67 (m, 2H), 2.46 (m, 2H), 2.04 (m, 2H).

### EXAMPLE NO. A48-181

¹H-NMR (400 MHz, CDCl₃ δ, ppm) 7.69 (d, 2H), 7.48 (d, 2H), 7.05 (s, 1H), 7.01-6.95 (m, 2H), 6.21 (br. s, 1H, NH), 4.39 (s, 2H), 4.09 (m, 2H), 2.92 (m, 2H), 2.68 (m, 2H), 2.47 (m, 2H), 2.04 (m, 2H).

### EXAMPLE NO. A48-182

¹H-NMR (400 MHz, CDCl₃ δ, ppm) 7.68 (m, 1H), 7.62 (m, 1H), 7.57 (m, 1H), 7.53 (m, 2H), 7.04 (m, 2H), 6.98 (m, 1H), 6.50 (br. s, 1H, NH), 4.37 (s, 2H), 4.09 (m, 2H), 2.92 (m, 2H), 2.68 (m, 2H), 2.47 (m, 2H), 2.06 (m, 2H).

### EXAMPLE NO. A48-291

¹H-NMR (400 MHz, CDCl₃ δ, ppm) 7.29 (d, 2H), 7.14 (d, 2H), 6.99 (m, 1H), 6.93 (m, 1H), 6.88 (m, 1H), 6.09 (br. s, 1H, NH), 4.10 (m, 2H), 3.35 (m, 2H), 3.14 (m, 2H), 2.89 (m, 2H), 2.66 (m, 2H), 2.67 (m, 2H), 2.46 (m, 2H), 2.03 (m, 2H).

### EXAMPLE NO. A49-165

¹H-NMR (400 MHz, d₆-DMSO δ, ppm) 9.71 (br. s, 1H, NH), 7.43 (d, 2H), 7.31 (d, 2H), 7.16 (d, 1H), 7.06 (m, 1H), 6.98 (m, 1H), 5.21 (s, 2H), 4.47 (s, 2H), 3.28 (s, 3H), 2.85 (m, 2H), 2.60 (m, 2H).

### EXAMPLE NO. A49-178

¹H-NMR (400 MHz, CDCl₃ δ, ppm) 7.65 (d, 2H), 7.47 (d, 2H), 7.28 (m, 1H), 7.01 (m, 1H), 6.96 (m, 1H), 6.19 (br. s, 1H, NH), 5.30 (s, 2H), 4.39 (s, 2H), 3.42 (s, 3H), 2.90 (m, 2H), 2.71 (m, 2H).

### EXAMPLE NO. A50-45

¹H-NMR (400 MHz, CDCl₃ δ, ppm) 7.84 (d, 2H), 7.77 (d, 2H), 6.98 (m, 1H), 6.85 (m, 1H), 6.64 (m, 1H), 6.42 (br. s, 1H, NH), 4.62 (s, 2H), 3.76 (s, 3H), 2.90 (m, 2H), 2.70 (m, 2H).

### EXAMPLE NO. A50-151

¹H-NMR (400 MHz, CDCl₃ δ, ppm) 7.39-7.36 (m, 3H), 7.33-7.30 (m, 2H), 6.99 (m, 1H), 6.94 (m, 1H), 6.71 (m, 1H), 6.08 (br. s, 1H, NH), 4.66 (s, 2H), 4.33 (s, 2H), 3.78 (s, 3H), 2.93 (m, 2H), 2.73 (m, 2H).

### EXAMPLE NO. A50-152

¹H-NMR (400 MHz, CDCl₃ δ, ppm) 7.21-7.18 (m, 4H), 7.00 (m, 1H), 6.94 (m, 1H), 6.72 (m, 1H), 6.13 (br. s, 1H, NH), 4.66 (s, 2H), 4.29 (s, 2H), 3.78 (s, 3H), 2.93 (m, 2H), 2.73 (m, 2H), 2.37 (s, 3H).

### EXAMPLE NO. A50-153

¹H-NMR (400 MHz, CDCl₃ δ, ppm) 7.29-7.23 (m, 1H), 7.19 (m, 1H), 7.12-7.08 (m, 2H), 6.99 (m, 1H), 6.95 (m, 2H), 6.71 (m, 1H), 6.11 (br. s, 1H, NH), 4.66 (s, 2H), 4.29 (s, 2H), 3.78 (s, 3H), 2.94 (m, 2H), 2.73 (m, 2H), 2.34 (s, 3H).

### EXAMPLE NO. A50-158

¹H-NMR (400 MHz, CDCl₃ δ, ppm) 7.29 (m, 2H), 7.07 (d, 2H), 7.01 (m, 1H), 6.94 (m, 1H), 6.71 (m, 1H), 6.12 (br. s, 1H, NH), 4.66 (s, 2H), 4.30 (s, 2H), 3.78 (s, 3H), 2.94 (m, 2H), 2.73 (m, 2H).

### EXAMPLE NO. A50-161

¹H-NMR (400 MHz, CDCl₃ δ, ppm) 7.43 (m, 1), 7.35 (m, 1H), 7.17 (m, 1H), 7.09-7.06 (m, 1H), 6.99-6.95 (m, 2H), 6.69 (m, 1H), 6.25 (br. s, 1H, NH), 4.65 (s, 2H), 4.43 (s, 2H), 3.77 (s, 3H), 2.91 (m, 2H), 2.71 (m, 2H).

### EXAMPLE NO. A50-165

¹H-NMR (400 MHz, CDCl₃ δ, ppm) 7.36 (d, 2H), 7.25 (d, 2H), 7.00 (m, 1H), 6.94 (m, 1H), 6.71 (m, 1H), 6.10 (br. s, 1H, NH), 4.66 (s, 2H), 4.30 (s, 2H), 3.79 (s, 3H), 2.93 (m, 2H), 2.73 (m, 2H).

### EXAMPLE NO. A50-166

¹H-NMR (400 MHz, CDCl₃ δ, ppm) 7.38-7.23 (m, 4H), 6.99-6.95 (m, 2H), 6.73 (m, 1H), 6.13 (br. s, 1H, NH), 4.67 (s, 2H), 4.30 (s, 2H), 3.79 (s, 3H), 2.94 (m, 2H), 2.74 (m, 2H).

### EXAMPLE NO. A50-168

¹H-NMR (400 MHz, CDCl₃ δ, ppm) 7.51 (m, 1H), 7.37 (m, 1H), 7.31-7.25 (m, 2H), 6.95-6.92 (m, 2H), 6.66 (m, 1H), 6.28 (br. s, 1H, NH), 4.64 (s, 2H), 4.61 (s, 2H), 3.77 (s, 3H), 2.89 (m, 2H), 2.70 (m, 2H).

### EXAMPLE NO. A50-172

¹H-NMR (400 MHz, CDCl₃ δ, ppm) 7.52 (d, 2H), 7.20 (d, 2H), 7.00 (m, 1H), 6.94 (m, 1H), 6.71 (m, 1H), 6.14 (br. s, 1H, NH), 4.66 (s, 2H), 4.28 (s, 2H), 3.78 (s, 3H), 2.93 (m, 2H), 2.73 (m, 2H).

### EXAMPLE NO. A50-173

¹H-NMR (400 MHz, CDCl₃ δ, ppm) 7.53 (m, 1H), 7.39 (m, 1H), 7.30-7.23 (m, 2H), 6.99-6.96 (m, 2H), 6.73 (m, 1H), 6.18 (br. s, 1H, NH), 4.66 (s, 2H), 4.29 (s, 2H), 3.78 (s, 3H), 2.95 (m, 2H), 2.74 (m, 2H).

### EXAMPLE NO. A50-175

¹H-NMR (400 MHz, CDCl₃ δ, ppm) 8.24 (d, 2H), 7.53 (d, 2H), 7.08 (m, 1H), 6.98 (m, 1H), 6.74 (m, 1H), 6.22 (br. s, 1H, NH), 4.67 (s, 2H), 4.42 (s, 2H), 3.79 (s, 3H), 2.96 (m, 2H), 2.74 (m, 2H).

### EXAMPLE NO. A50-176

¹H-NMR (400 MHz, CDCl₃ δ, ppm) 8.25 (m, 1H), 8.11 (m, 1H), 7.75 (m, 1H), 7.59 (m, 1H), 7.07-7.03 (m, 2H), 6.75 (m, 1H), 6.28 (br. s, 1H, NH), 4.67 (s, 2H), 4.41 (s, 2H), 3.79 (s, 3H), 2.96 (m, 2H), 2.75 (m, 2H).

### EXAMPLE NO. A50-177

¹H-NMR (400 MHz, CDCl₃ δ, ppm) 8.01 (m, 1H), 7.61 (m, 1H), 7.56-7.53 (m, 2H), 6.99 (m, 1H), 6.95 (m, 1H), 6.68 (m, 1H), 6.28 (br. s, 1H, NH), 4.94 (s, 2H), 4.65 (s, 2H), 3.78 (s, 3H), 2.92 (m, 2H), 2.72 (m, 2H).

### EXAMPLE NO. A50-178

¹H-NMR (400 MHz, CDCl₃ δ, ppm) 7.65 (d, 2H), 7.47 (d, 2H), 7.02 (m, 1H), 6.96 (m, 1H), 6.70 (m, 1H), 6.22 (br. s, 1H, NH), 4.66 (s, 2H), 4.38 (s, 2H), 3.78 (s, 3H), 2.93 (m, 2H), 2.73 (m, 2H).

### EXAMPLE NO. A50-179

¹H-NMR (400 MHz, CDCl₃ δ, ppm) 7.66 (m, 1H), 7.59 (m, 1H), 7.53 (m, 1H), 7.48 (m, 1H), 6.99-6.95 (m, 2H), 6.72 (m, 1H), 6.17 (br. s, 1H, NH), 4.66 (s, 2H), 4.38 (s, 2H), 3.78 (s, 3H), 2.93 (m, 2H), 2.73 (m, 2H).

### EXAMPLE NO. A50-181

¹H-NMR (400 MHz, CDCl₃ δ, ppm) 7.69 (d, 2H), 7.46 (d, 2H), 7.06 (m, 1H), 6.97 (m, 1H), 6.74 (m, 1H), 6.26 (br. s, 1H, NH), 4.67 (s, 2H), 4.37 (s, 2H), 3.79 (s, 3H), 2.96 (m, 2H), 2.74 (m, 2H).

### EXAMPLE NO. A50-182

¹H-NMR (400 MHz, CDCl₃ δ, ppm) 7.70 (m, 1H), 7.62-7.57 (m, 2H), 7.52 (m, 1H), 7.04 (m, 1H), 6.98 (m, 2H), 6.74 (m, 1H), 6.22 (br. s, 1H, NH), 4.67 (s, 2H), 4.35 (s, 2H), 3.79 (s, 3H), 2.96 (m, 2H), 2.75 (m, 2H).

### EXAMPLE NO. A50-291

¹H-NMR (400 MHz, CDCl₃ δ, ppm) 7.29 (d, 2H), 7.12 (d, 2H), 6.95 (m, 1H), 6.88 (m, 1H), 6.69 (m, 1H), 6.13 (br. s, 1H, NH), 4.64 (s, 2H), 3.77 (s, 3H), 3.31 (m, 2H), 3.13 (m, 2H), 2.92 (m, 2H), 2.72 (m, 2H).

### EXAMPLE NO. A51-45

¹H-NMR (400 MHz, CDCl₃ δ, ppm) 7.88 (d, 2H), 7.78 (d, 2H), 6.98 (m, 1H), 6.93-6.88 (m, 2H), 6.63 (br. s, 1H, NH), 4.18 (m, 2H), 3.67 (s, 3H), 2.84 (m, 2H), 2.78-2.60 (m, 4H).

### EXAMPLE NO. A51-151

¹H-NMR (400 MHz, CDCl₃ δ, ppm) 7.38 (m, 3H), 7.33 (m, 2H), 6.99-6.95 (m, 3H), 6.21 (br. s, 1H, NH), 4.34 (s, 2H), 4.22 (m, 2H), 3.69 (s, 3H), 2.86 (m, 2H), 2.68 (m, 2H), 2.63 (m, 2H).

### EXAMPLE NO. A51-152

¹H-NMR (400 MHz, CDCl₃ δ, ppm) 7.22-7.17 (m, 4H), 7.00 (m, 1H), 6.97 (m, 2H), 6.18 (br. s, 1H, NH), 4.29 (s, 2H), 4.22 (m, 2H), 3.69 (s, 3H), 2.87 (m, 2H), 2.71-2.62 (m, 4H).

### EXAMPLE NO. A51-153

¹H-NMR (400 MHz, CDCl₃ δ, ppm) 7.28 (m, 2H), 7.20 (m, 1H), 7.13 (m, 1H), 7.10 (m, 1H), 6.97 (m, 2H), 6.14 (br. s, 1H, NH), 4.30 (s, 2H), 4.23 (m, 2H), 3.70 (s, 3H), 2.87 (m, 2H), 2.69 (m, 2H), 2.64 (m, 2H).

### EXAMPLE NO. A51-158

¹H-NMR (400 MHz, CDCl₃ δ, ppm) 7.31 (m, 2H), 7.07 (m, 2H), 6.99-6.95 (m, 3H), 6.13 (br. s, 1H, NH), 4.31 (s, 2H), 4.22 (m, 2H), 3.70 (s, 3H), 2.87 (m, 2H), 2.71-2.63 (m, 4H).

### EXAMPLE NO. A51-161

¹H-NMR (400 MHz, CDCl₃ δ, ppm) 7.44 (m, 1H), 7.37 (m, 1H), 7.18 (m, 1H), 7.08 (m, 1H), 6.99-6.93 (m, 3H), 6.26 (br. s, 1H, NH), 4.43 (s, 2H), 4.21 (m, 2H), 3.69 (s, 3H), 2.85 (m, 2H), 2.67 (m, 2H), 2.63 (m, 2H).

### EXAMPLE NO. A51-165

¹H-NMR (400 MHz, CDCl₃ δ, ppm) 7.36 (d, 2H), 7.25 (d, 2H), 6.98-6.96 (m, 3H), 6.24 (br. s, 1H, NH), 4.32 (s, 2H), 4.21 (m, 2H), 3.70 (s, 3H), 2.88 (m, 2H), 2.69-2.64 (m, 4H).

### EXAMPLE NO. A51-166

¹H-NMR (400 MHz, CDCl₃ δ, ppm) 7.33 (m, 1H), 7.31 (m, 1H), 7.24 (m, 2H), 7.01-6.96 (m, 3H), 6.29 (br. s, 1H, NH), 4.31 (s, 2H), 4.23 (m, 2H), 3.70 (s, 3H), 2.88 (m, 2H), 2.71-2.63 (m, 4H).

### EXAMPLE NO. A51-168

¹H-NMR (400 MHz, CDCl₃ δ, ppm) 7.52 (m, 1H), 7.38 (m, 1H), 7.29 (m, 2H), 6.96-6.91 (m, 3H), 6.25 (br. s, 1H, NH), 4.62 (s, 2H), 4.21 (m, 2H), 3.69 (s, 3H), 2.83 (m, 2H), 2.66 (m, 2H), 2.63 (m, 2H).

### EXAMPLE NO. A51-172

¹H-NMR (400 MHz, CDCl₃ δ, ppm) 7.51 (d, 2H), 7.20 (d, 2H), 6.99-6.95 (m, 3H), 6.28 (br. s, 1H, NH), 4.29 (s, 2H), 4.22 (m, 2H), 3.70 (s, 3H), 2.87 (m, 2H), 2.69 (m, 2H), 2.65 (m, 2H).

### EXAMPLE NO. A51-173

¹H-NMR (400 MHz, CDCl₃ δ, ppm) 7.53 (m, 1H), 7.39 (m, 1H), 7.32-7.24 (m, 2H), 7.02-6.98 (m, 2H), 6.96 (m, 1H), 6.18 (br. s, 1H, NH), 4.30 (s, 2H), 4.23 (m, 2H), 3.70 (s, 3H), 2.88 (m, 2H), 2.71-2.63 (m, 4H).

### EXAMPLE NO. A51-175

¹H-NMR (400 MHz, CDCl₃ δ, ppm) 8.24 (d, 2H), 7.53 (d, 2H), 7.06 (m, 1H), 7.02 (m, 2H), 6.29 (br. s, 1H, NH), 4.42 (s, 2H), 4.23 (m, 2H), 3.70 (s, 3H), 2.89 (m, 2H), 2.71-2.62 (m, 4H).

### EXAMPLE NO. A51-176

¹H-NMR (400 MHz, CDCl₃ δ, ppm) 8.25 (m, 1H), 8.11 (m, 1H), 7.75 (m, 1H), 7.59 (m, 1H), 7.08 (m, 1H), 7.02 (m, 2H), 6.34 (br. s, 1H, NH), 4.42 (s, 2H), 4.23 (m, 2H), 3.70 (s, 3H), 2.90 (m, 2H), 2.71-2.63 (m, 4H).

### EXAMPLE NO. A51-177

¹H-NMR (400 MHz, CDCl₃ δ, ppm) 8.03 (m, 1H), 7.63 (m, 1H), 7.57-7.52 (m, 2H), 7.01-6.92 (m, 3H), 6.40 (br. s, 1H, NH), 4.95 (s, 2H), 4.22 (m, 2H), 3.69 (s, 3H), 2.86 (m, 2H), 2.70-2.62 (m, 4H).

### EXAMPLE NO. A51-178

¹H-NMR (400 MHz, CDCl₃ δ, ppm) 7.65 (d, 2H), 7.48 (d, 2H), 7.01-6.97 (m, 3H), 6.22 (br. s, 1H, NH), 4.39 (s, 2H), 4.22 (m, 2H), 3.70 (s, 3H), 2.87 (m, 2H), 2.70-2.62 (m, 4H).

### EXAMPLE NO. A51-179

¹H-NMR (400 MHz, CDCl₃ δ, ppm) 7.65 (m, 1H), 7.60 (m, 1H), 7.53 (m, 1H), 7.48 (m, 1H), 7.03 (m, 1H), 6.9-6.95 (m, 2H), 6.24 (br. s, 1H, NH), 4.39 (s, 2H), 4.22 (m, 2H), 3.70 (s, 3H), 2.86 (m, 2H), 2.71-2.63 (m, 4H).

### EXAMPLE NO. A51-181

¹H-NMR (400 MHz, CDCl₃ δ, ppm) 7.69 (d, 2H), 7.48 (d, 2H), 7.05 (m, 1H), 7.01 (m, 2H), 6.29 (br. s, 1H, NH), 4.38 (s, 2H), 4.23 (m, 2H), 3.70 (s, 3H), 2.87 (m, 2H), 2.71-2.64 (m, 4H).

### EXAMPLE NO. A51-182

¹H-NMR (400 MHz, CDCl₃ δ, ppm) 7.68 (m, 1H), 7.59 (m, 2H), 7.52 (m, 1H), 7.03-6.98 (m, 3H), 6.42 (br. s, 1H, NH), 4.36 (s, 2H), 4.23 (m, 2H), 3.70 (s, 3H), 2.90 (m, 2H), 2.71-2.63 (m, 4H).

### EXAMPLE NO. A51-291

¹H-NMR (400 MHz, CDCl₃ δ, ppm) 7.29 (d, 2H), 7.13 (d, 2H), 6.98-6.95 (m, 2H), 6.87 (m, 1H), 6.09 (br. s, 1H, NH), 4.21 (m, 2H), 3.68 (s, 3H), 3.32 (m, 2H), 3.13 (m, 2H), 2.86 (m, 2H), 2.69-2.62 (m, 4H).

### EXAMPLE NO. B1-45

¹H-NMR (400 MHz, CDCl₃ δ, ppm) 7.87 (d, 2H), 7.77 (d, 2H), 7.03 (m, 2H), 6.92 (m, 1H), 6.60 (br. s, 1H, NH), 6.21-5.93 (tt, 1H), 4.27-4.20 (br. m, 2H), 2.51 (s, 2H), 1.23 (s, 6H).

### EXAMPLE NO. B1-151

¹H-NMR (400 MHz, CDCl₃ δ, ppm) 7.39 (m, 3H), 7.32 (m, 2H), 7.09 (m, 1H), 7.04 (m, 2H), 6.24-5.97 (tt, 1H), 6.11 (br. s, 1H, NH), 4.34 (s, 2H), 4.32-4.24 (br. m, 2H), 2.55 (s, 2H), 1.29 (s, 6H).

### EXAMPLE NO. B1-152

¹H-NMR (400 MHz, CDCl₃ δ, ppm) 7.19 (m, 4H), 7.08 (m, 1H), 7.04 (m, 2H), 6.24-5.97 (tt, 1H), 6.11 (br. s, 1H, NH), 4.32-4.24 (br. m, 2H), 4.28 (s, 2H), 2.55 (s, 2H), 2.37 (s, 3H), 1.28 (s, 6H).

### EXAMPLE NO. B1-153

¹H-NMR (400 MHz, CDCl₃ δ, ppm) 7.24 (m, 1H), 7.23 (m, 1H), 7.13-7.00 (m, 5H), 6.26-5.97 (tt, 1H), 6.11 (br. s, 1H, NH), 4.32-4.25 (br. m, 2H), 4.30 (s, 2H), 2.55 (s, 2H), 0.35 (s, 3H), 1.29 (s, 6H).

### EXAMPLE NO. B1-158

¹H-NMR (400 MHz, CDCl₃ δ, ppm) 7.29 (m, 2H), 7.10-6.99 (m, 5H), 6.26-5.96 (tt, 1H), 6.16 (br. s, 1H, NH), 4.32-4.24 (br. m, 2H), 4.31 (s, 2H), 2.55 (s, 2H), 1.29 (s, 6H).

### EXAMPLE NO. B1-161

¹H-NMR (400 MHz, CDCl₃ δ, ppm) 7.46 (m, 1H), 7.35 (m, 1H), 7.18 (m, 1H), 7.10-7.01 (m, 4H), 6.25-5.97 (tt, 1H), 6.22 (br. s, 1H, NH), 4.44 (s, 2H), 4.30-4.24 (br. m, 2H), 2.53 (s, 2H), 1.28 (s, 6H).

### EXAMPLE NO. B1-165

¹H-NMR (400 MHz, CDCl₃ δ, ppm) 7.35 (d, 2H), 7.24 (d, 2H), 7.09 (m, 1H), 7.03 (m, 2H), 6.24-5.97 (tt, 1H), 6.18 (br. s, 1H, NH), 4.32 (s, 2H), 4.29 (br. m, 2H), 2.55 (s, 2H), 1.28 (s, 6H).

### EXAMPLE NO. B1-166

¹H-NMR (400 MHz, CDCl₃ δ, ppm) 7.37-7.28 (m, 2H), 7.23 (m, 2H), 7.10 (m, 2H), 7.05 (m, 1H), 6.30 (br. s, 1H, NH), 6.26-5.97 (tt, 1H), 4.34-4.25 (br. m, 2H), 4.32 (s, 2H), 2.55 (s, 2H), 1.30 (s, 6H).

### EXAMPLE NO. B1-168

¹H-NMR (400 MHz, CDCl₃ δ, ppm) 7.53 (m, 1H), 7.36 (m, 2H), 7.28 (m, 2H), 7.05 (m, 1H), 7.01 (m, 1H), 6.24-5.94 (tt, 1H), 6.22 (br. s, 1H, NH), 4.62 (s, 2H), 4.30-4.24 (br. m, 2H), 2.51 (s, 2H), 1.27 (s, 6H).

### EXAMPLE NO. B1-172

¹H-NMR (400 MHz, CDCl₃ δ, ppm) 7.52 (d, 2H), 7.19 (d, 2H), 7.10 (m, 1H), 7.03 (m, 2H), 6.25-5.96 (tt, 1H), 6.14 (br. s, 1H, NH), 4.32-4.24 (br. m, 2H), 4.29 (s, 2H), 2.55 (s, 2H), 1.28 (s, 6H).

### EXAMPLE NO. B1-173

¹H-NMR (400 MHz, CDCl₃ δ, ppm) 7.52 (m, 1H), 7.40 (m, 1H), 7.28 (m, 2H), 7.10 (m, 2H), 7.05 (m, 1H), 6.25 (br. s, 1H, NH), 6.25-5.96 (tt, 1H), 4.32-4.25 (br. m, 2H), 4.28 (s, 2H), 2.55 (s, 2H), 1.30 (s, 6H).

### EXAMPLE NO. B1-175

¹H-NMR (400 MHz, CDCl₃ δ, ppm) 8.24 (d, 2H), 7.53 (d, 2H), 7.11 (m, 2H), 7.06 (m, 1H), 6.25-5.96 (tt, 1H), 6.23 (br. s, 1H, NH), 4.43 (s, 2H), 4.32-4.25 (br. m, 2H), 2.56 (s, 2H), 1.30 (s, 6H).

### EXAMPLE NO. B1-176

¹H-NMR (400 MHz, CDCl₃ δ, ppm) 8.25 (m, 1H), 8.12 (m, 1H), 7.73 (m, 1H), 7.60 (m, 1H), 7.13-7.08 (m, 3H), 6.26-5.97 (tt, 1H), 6.23 (br. s, 1H, NH), 4.43 (s, 2H), 4.32-4.24 (br. m, 2H), 2.56 (s, 2H), 1.30 (s, 6H).

### EXAMPLE NO. B1-177

¹H-NMR (400 MHz, CDCl₃ δ, ppm) 8.01 (m, 1H), 7.61 (m, 1H), 7.56-7.50 (m, 2H), 7.09 (m, 1H), 7.04-6.97 (m, 2H), 6.37 (br. s, 1H, NH), 6.24-5.95 (tt, 1H), 4.96 (s, 2H), 4.31-4.23 (br. m, 2H), 2.53 (s, 2H), 1.29 (s, 6H).

### EXAMPLE NO. B1-178

¹H-NMR (400 MHz, CDCl₃ δ, ppm) 7.63 (d, 2H), 7.46 (d, 2H), 7.08 (m, 2H), 7.04 (m, 1H), 6.37 (br. s, 1H, NH), 6.24-5.97 (tt, 1H), 4.39 (s, 2H), 4.32-4.25 (br. m, 2H), 2.54 (s, 2H), 1.28 (s, 6H).

### EXAMPLE NO. B1-179

¹H-NMR (400 MHz, CDCl₃ δ, ppm) 7.67 (m, 1H), 7.58 (m, 1H), 7.53 (m, 2H), 7.51 (m, 1H), 7.11-7.05 (m, 3H), 6.25 (br. s, 1H, NH), 6.25-5.97 (tt, 1H), 4.39 (s, 2H), 4.32-4.25 (br. m, 2H), 2.54 (s, 2H), 1.28 (s, 6H).

### EXAMPLE NO. B1-181

¹H-NMR (400 MHz, CDCl₃ δ, ppm) 7.68 (d, 2H), 7.46 (d, 2H), 7.10 (m, 1H), 7.06 (m, 1H), 6.34 (br. s, 1H, NH), 6.25-5.97 (tt, 1H), 4.38 (s, 2H), 4.33-4.26 (br. m, 2H), 2.56 (s, 2H), 1.30 (s, 6H).

### EXAMPLE NO. B1-182

¹H-NMR (400 MHz, CDCl₃ δ, ppm) 7.68 (m, 1H), 7.60 (m, 1H), 7.57 (m, 1H), 7.51 (m, 1H), 7.12-7.08 (m, 3H), 6.36 (br. s, 1H, NH), 6.27-5.97 (tt, 1H), 4.36 (s, 2H), 4.33-4.24 (br. m, 2H), 2.56 (s, 2H), 1.31 (s, 6H).

### EXAMPLE NO. B1-291

¹H-NMR (400 MHz, CDCl₃ δ, ppm) 7.28 (d, 2H), 7.13 (d, 2H), 7.08 (m, 1H), 7.00 (m, 2H), 6.24-5.95 (tt, 1H), 6.03 (br. s, 1H, NH), 4.29-4.22 (br. m, 2H), 3.33 (m, 2H), 3.14 (m, 2H), 2.53 (s, 2H), 1.28 (s, 6H).

### EXAMPLE NO. B2-45

¹H-NMR (400 MHz, CDCl₃ δ, ppm) 7.85 (d, 2H), 7.76 (d, 2H), 7.04 (d, 1H), 6.98 (d, 1H), 6.92 (dd, 1H), 6.41 (s, 1H, NH), 4.66 (m, 2H), 2.55 (s, 2H), 1.24 (s, 6H).

### EXAMPLE NO. B2-153

¹H-NMR (400 MHz, CDCl₃ δ, ppm) 7.25 (m, 2H), 7.20 (m, 1H), 7.13 (m, 1H), 7.09-7.03 (m, 3H), 6.11 (s, 1H, NH), 4.69 (br. m, 2H), 4.31 (s, 2H), 2.58 (s, 2H), 2.34 (s, 3H), 1.30 (s, 6H).

### EXAMPLE NO. B2-158

¹H-NMR (400 MHz, CDCl₃ δ, ppm) 7.28 (m, 2H), 7.08 (d, 2H), 7.07-7.02 (m, 3H), 6.16 (s, 1H, NH), 4.68 (br. m, 2H), 4.32 (s, 2H), 2.58 (s, 2H), 1.30 (s, 6H).

### EXAMPLE NO. B2-165

¹H-NMR (400 MHz, CDCl₃ δ, ppm) 7.35 (d, 2H), 7.24 (d, 2H), 7.06-7.03 (m, 3H), 6.13 (s, 1H, NH), 4.69 (m, 2H), 4.31 (s, 2H), 2.58 (s, 2H), 1.29 (s, 6H).

### EXAMPLE NO. B2-166

¹H-NMR (400 MHz, CDCl₃ δ, ppm) 7.36 (m, 1H), 7.32 (m, 1H), 7.25 (m, 2H), 7.10 (m, 1H), 7.06 (m, 2H), 6.16 (s, 1H, NH), 4.70 (br. m, 2H), 4.31 (s, 2H), 2.59 (s, 2H), 1.31 (s, 6H).

### EXAMPLE NO. B2-168

¹H-NMR (400 MHz, CDCl₃ δ, ppm) 7.53 (m, 1H), 7.33 (m, 1H), 7.28 (m, 2H), 7.06 (m, 1H), 7.02 (m, 2H), 6.98 (m, 1H), 6.23 (s, 1H, NH), 4.67 (br. m, 2H), 4.63 (s, 2H), 2.54 (s, 2H), 1.27 (s, 6H).

### EXAMPLE NO. B2-172

¹H-NMR (400 MHz, CDCl₃ δ, ppm) 7.50 (d, 2H), 7.18 (d, 2H), 7.05-7.02 (m, 3H), 6.20 (s, 1H, NH), 4.68 (br. m, 2H), 4.30 (s, 2H), 2.58 (s, 2H), 1.29 (s, 6H).

### EXAMPLE NO. B2-173

¹H-NMR (400 MHz, CDCl₃ δ, ppm) 7.52 (m, 1H), 7.40 (m, 1H), 7.28 (m, 2H), 7.010-7.03 (m, 3H), 6.17 (s, 1H, NH), 4.69 (br. m, 2H), 4.30 (s, 2H), 2.59 (s, 2H), 1.31 (s, 6H).

### EXAMPLE NO. B2-175

¹H-NMR (400 MHz, CDCl₃ δ, ppm) 8.24 (d, 2H), 7.52 (d, 2H), 7.12 (m, 1H), 7.07 (m, 2H), 6.24 (s, 1H, NH), 4.70 (br. m, 2H), 4.44 (s, 2H), 2.59 (s, 2H), 1.28 (s, 6H).

### EXAMPLE NO. B2-176

¹H-NMR (400 MHz, CDCl₃ δ, ppm) 8.26 (m, 1H), 8.13 (m, 1H), 7.73 (m, 1H), 7.60 (m, 1H), 7.13 (m, 2H), 7.06 (m, 1H), 6.21 (s, 1H, NH), 4.70 (br. m, 2H), 4.44 (s, 2H), 2.59 (s, 2H), 1.28 (s, 6H).

### EXAMPLE NO. B2-177

¹H-NMR (400 MHz, CDCl₃ δ, ppm) 7.99 (m, 1H), 7.67 (br. s, 1H, NH), 7.58 (m, 1H), 7.51 (m, 2H), 7.16 (d, 1H), 7.05 (dd, 1H), 6.96 (d, 1H), 4.93 (s, 2H), 4.67 (br. m, 2H), 2.56 (s, 2H), 1.30 (s, 6H).

### EXAMPLE NO. B2-178

¹H-NMR (400 MHz, CDCl₃ δ, ppm) 7.64 (d, 2H), 7.46 (d, 2H), 7.08 (m, 1H), 7.04 (m, 2H), 6.23 (s, 1H, NH), 4.69 (br. m, 2H), 4.40 (s, 2H), 2.58 (s, 2H), 1.29 (s, 6H).

### EXAMPLE NO. B2-179

¹H-NMR (400 MHz, CDCl₃ δ, ppm) 7.64 (d, 1H), 7.58 (m, 1H), 7.56-7.49 (m, 2H), 7.10 (m, 1H), 7.06 (m, 2H), 6.20 (s, 1H, NH), 4.69 (br. m, 2H), 4.40 (s, 2H), 2.58 (s, 2H), 1.29 (s, 6H).

### EXAMPLE NO. B2-181

¹H-NMR (400 MHz, CDCl₃ δ, ppm) 7.68 (d, 2H), 7.46 (d, 2H), 7.11 (m, 1H), 7.05 (m, 2H), 6.20 (s, 1H, NH), 4.69 (br. m, 2H), 4.39 (s, 2H), 2.59 (s, 2H), 1.28 (s, 6H).

### EXAMPLE NO. B2-182

¹H-NMR (400 MHz, CDCl₃ δ, ppm) 7.68 (m, 1H), 7.59 (m, 1H), 7.52 (m, 2H), 7.08 (m, 3H), 6.22 (s, 1H, NH), 4.69 (br. m, 2H), 4.37 (s, 2H), 2.60 (s, 2H), 1.32 (s, 6H).

### EXAMPLE NO. B2-291

¹H-NMR (400 MHz, CDCl₃ δ, ppm) 7.31 (d, 2H), 7.28 (d, 2H), 7.11 (d, 1H), 7.01 (m, 2H), 6.00 (s, 1H, NH), 4.68 (m, 2H), 3.34 (m, 2H), 3.14 (m, 2H), 2.57 (s, 2H), 1.29 (s, 6H).

### EXAMPLE NO. B7-158

¹H-NMR (400 MHz, CDCl₃ δ, ppm) 7.30 (m, 2H), 7.08-7.04 (m, 4H), 6.94 (m, 1H), 6.16 (s, 1H, NH), 4.31 (s, 2H), 4.21 (m, 2H), 2.52 (s, 2H), 2.49 (m, 2H), 1.27 (s, 6H).

### EXAMPLE NO. B7-165

¹H-NMR (400 MHz, CDCl₃ δ, ppm) 7.36 (m, 2H), 7.27 (m, 2H), 7.08-7.04 (m, 2H), 6.94 (m, 1H), 6.17 (s, 1H, NH), 4.31 (s, 2H), 4.21 (m, 2H), 2.52 (s, 2H), 2.50 (m, 2H), 1.27 (s, 6H).

### EXAMPLE NO. B7-291

¹H-NMR (400 MHz, CDCl₃ δ, ppm) 7.29 (d, 2H), 7.14 (d, 2H), 7.04 (m, 1H), 7.00 (m, 1H), 6.92 (m, 1H), 6.09 (s, 1H, NH), 4.20 (m, 2H), 3.34 (m, 2H), 3.14 (m, 2H), 2.50 (s, 2H), 2.47 (m, 2H), 1.27 (s, 6H).

### EXAMPLE NO. B10-45

¹H-NMR (400 MHz, CDCl₃ δ, ppm) 7.86 (d, 2H), 7.77 (d, 2H), 7.04 (m, 1H), 6.94-6.90 (m, 2H), 6.58 (s, 1H, NH), 4.78-4.63 (m, 2H), 2.56 (s, 2H), 1.25 (s, 6H).

### EXAMPLE NO. B10-151

¹H-NMR (400 MHz, CDCl₃ δ, ppm) 7.38 (m, 3H), 7.29 (m, 2H), 7.05-7.00 (m, 3H), 6.14 (s, 1H, NH), 4.78-4.67 (m, 2H), 4.34 (s, 2H), 2.59 (s, 2H), 1.30 (s, 6H).

### EXAMPLE NO. B10-152

¹H-NMR (400 MHz, CDCl₃ δ, ppm) 7.20-7.16 (m, 4H), 7.07-7.00 (m, 3H), 6.17 (s, 1H, NH), 4.79-4.65 (m, 2H), 4.30 (s, 2H), 2.59 (s, 2H), 2.36 (s, 3H), 1.30 (s, 6H).

### EXAMPLE NO. B10-153

¹H-NMR (400 MHz, CDCl₃ δ, ppm) 7.25-13 (m, 3H), 7.09-6.99 (m, 4H), 6.12 (s, 1H, NH), 4.79-4.66 (m, 2H), 4.31 (s, 2H), 2.59 (s, 2H), 2.34 (s, 3H), 1.30 (s, 6H).

### EXAMPLE NO. B10-158

¹H-NMR (400 MHz, CDCl₃ δ, ppm) 7.28 (m, 2H), 7.08-7.00 (m, 5H), 6.23 (s, 1H, NH), 4.79-4.65 (m, 2H), 4.32 (s, 2H), 2.59 (s, 2H), 1.30 (s, 6H).

### EXAMPLE NO. B10-161

¹H-NMR (400 MHz, CDCl₃ δ, ppm) 7.45 (m, 1H), 7.33 (m, 1H), 7.17 (m, 1H), 7.10 (m, 1H), 7.07-6.95 (m, 3H), 6.28 (s, 1H, NH), 4.78-4.64 (m, 2H), 4.44 (s, 2H), 2.57 (s, 2H), 1.29 (s, 6H).

### EXAMPLE NO. B10-165

¹H-NMR (400 MHz, CDCl₃ δ, ppm) 7.35 (m, 2H), 7.25 (m, 2H), 7.06-7.00 (m, 3H), 6.19 (s, 1H, NH), 4.79-4.65 (m, 2H), 4.31 (s, 2H), 2.59 (s, 2H), 1.30 (s, 6H).

### EXAMPLE NO. B10-166

¹H-NMR (400 MHz, CDCl₃ δ, ppm) 7.38-7.22 (m, 4H), 7.11-7.00 (m, 3H), 6.19 (s, 1H, NH), 4.79-4.67 (m, 2H), 4.31 (s, 2H), 2.60 (s, 2H), 1.31 (s, 6H).

### EXAMPLE NO. B10-168

¹H-NMR (400 MHz, CDCl₃ δ, ppm) 7.52 (m, 1H), 7.33 (m, 1H), 7.28-7.24 (m, 2H), 7.07 (m, 1H), 7.03 (m, 1H), 6.94 (m, 1H), 6.35 (s, 1H, NH), 4.78-4.65 (m, 2H), 4.63 (s, 2H), 2.56 (s, 2H), 1.28 (s, 6H).

### EXAMPLE NO. B10-172

¹H-NMR (400 MHz, CDCl₃ δ, ppm) 7.50 (m, 2H), 7.18 (m, 2H), 7.07-7.00 (m, 3H), 6.20 (s, 1H, NH), 4.78-4.65 (m, 2H), 4.30 (s, 2H), 2.59 (s, 2H), 1.30 (s, 6H).

### EXAMPLE NO. B10-173

¹H-NMR (400 MHz, CDCl₃ δ, ppm) 7.53 (m, 1H), 7.41 (m, 1H), 7.28 (m, 2H), 7.11-7.00 (m, 3H), 6.21 (s, 1H, NH), 4.78-4.66 (m, 2H), 4.30 (s, 2H), 2.60 (s, 2H), 1.32 (s, 6H).

### EXAMPLE NO. B10-175

¹H-NMR (400 MHz, CDCl₃ δ, ppm) 8.24 (d, 2H), 7.53 (m, 2H), 7.13 (m, 1H), 7.08-6.99 (m, 2H), 6.19 (s, 1H, NH), 4.78-4.65 (m, 2H), 4.44 (s, 2H), 2.60 (s, 2H), 1.32 (s, 6H).

### EXAMPLE NO. B10-176

¹H-NMR (400 MHz, d₆-DMSO δ, ppm) 9.83 (s, 1H), 8.20 (m, 1H), 8.12 (m, 1H), 7.76 (m, 1H), 7.65 (m, 1H), 7.29 (m, 1H), 7.11-7.05 (m, 2H), 4.96-4.84 (m, 2H), 4.72 (s, 2H), 2.53 (s, 2H), 1.19 (s, 6H).

### EXAMPLE NO. B10-177

¹H-NMR (400 MHz, CDCl₃ δ, ppm) 8.00 (m, 1H), 7.59 (m, 1H), 7.56-7.48 (m, 2H), 7.10 (m, 1H), 7.00-6.93 (m, 2H), 6.38 (s, 1H, NH), 4.97 (s, 2H), 4.78-4.65 (m, 2H), 2.57 (s, 2H), 1.30 (s, 6H).

### EXAMPLE NO. B10-178

¹H-NMR (400 MHz, CDCl₃ δ, ppm) 7.64 (d, 2H), 7.46 (m, 2H), 7.09 (m, 1H), 7.03 (m, 2H), 6.29 (s, 1H, NH), 4.79-4.65 (m, 2H), 4.40 (s, 2H), 2.59 (s, 2H), 1.30 (s, 6H).

### EXAMPLE NO. B10-179

¹H-NMR (400 MHz, CDCl₃ δ, ppm) 7.66 (m, 1H), 7.57-7.48 (m, 3H), 7.09-7.00 (m, 3H), 6.29 (s, 1H, NH), 4.78-4.65 (m, 2H), 4.40 (s, 2H), 2.59 (s, 2H), 1.30 (s, 6H).

### EXAMPLE NO. B10-181

¹H-NMR (400 MHz, CDCl₃ δ, ppm) 7.68 (d, 2H), 7.46 (d, 2H), 7.11 (m, 1H), 7.05-7.01 (m, 2H), 6.22 (s, 1H, NH), 4.79-4.65 (m, 2H), 4.38 (s, 2H), 2.60 (s, 2H), 1.32 (s, 6H).

### EXAMPLE NO. B10-182

¹H-NMR (400 MHz, CDCl₃ δ, ppm) 7.68 (m, 1H), 7.61-7.56 (m, 2H), 7.52 (m, 1H), 7.09 (m, 2H), 7.05 (m, 1H), 6.25 (s, 1H, NH), 4.82-4.67 (m, 2H), 4.36 (s, 2H), 2.61 (s, 2H), 1.32 (s, 6H).

### EXAMPLE NO. B10-291

¹H-NMR (400 MHz, CDCl₃ δ, ppm) 7.28 (m, 2H), 7.12 (d, 2H), 7.04-7.00 (m, 3H), 6.15 (s, 1H, NH), 4.78-4.66 (m, 2H), 3.34 (m, 2H), 3.14 (m, 2H), 2.58 (s, 2H), 1.30 (s, 6H).

### EXAMPLE NO. B16-45

¹H-NMR (400 MHz, CDCl₃ δ, ppm) 7.87 (d, 2H), 7.79 (d, 2H), 7.09 (m, 1H), 7.00-6.94 (m, 2H), 6.47 (br. s, 1H, NH), 4.86 (s, 2H), 2.56 (s, 2H), 1.25 (s, 6H).

### EXAMPLE NO. B16-152

¹H-NMR (400 MHz, CDCl₃ δ, ppm) 7.19 (m, 4H), 7.09 (m, 2H), 7.00 (m, 1H), 6.16 (br. s, 1H, NH), 4.90 (s, 2H), 4.31 (s, 2H), 2.58 (s, 2H), 2.37 (s, 3H), 1.26 (s, 6H).

### EXAMPLE NO. B16-153

¹H-NMR (400 MHz, CDCl₃ δ, ppm) 7.24 (m, 1H), 7.20 (m, 1H), 7.14 (m, 1H), 7.09 (m, 3H), 7.00 (m, 1H), 6.16 (br. s, 1H, NH), 4.90 (s, 2H), 4.31 (s, 2H), 2.58 (s, 2H), 2.35 (s, 3H), 1.30 (s, 6H).

### EXAMPLE NO. B16-158

¹H-NMR (400 MHz, CDCl₃ δ, ppm) 7.30 (m, 2H), 7.09 (m, 3H), 7.07-7.01 (m, 2H), 6.22 (br. s, 1H, NH), 4.90 (s, 2H), 4.32 (s, 2H), 2.58 (s, 2H), 1.30 (s, 6H).

### EXAMPLE NO. B16-165

¹H-NMR (400 MHz, CDCl₃ δ, ppm) 7.36 (d, 2H), 7.24 (d, 2H), 7.08 (m, 2H), 7.00 (m, 1H), 6.19 (br. s, 1H, NH), 4.90 (s, 2H), 4.32 (s, 2H), 2.59 (s, 2H), 1.26 (s, 6H).

### EXAMPLE NO. B16-166

¹H-NMR (400 MHz, CDCl₃ δ, ppm) 7.36 (m, 1H), 7.32 (m, 1H), 7.24 (m, 2H), 7.15 (m, 1H), 7.08 (m, 1H), 7.02 (m, 1H), 6.24 (br. s, 1H, NH), 4.90 (s, 2H), 4.32 (s, 2H), 2.59 (s, 2H), 1.31 (s, 6H).

### EXAMPLE NO. B16-168

¹H-NMR (400 MHz, CDCl₃ δ, ppm) 7.54 (m, 1H), 7.35 (m, 1H), 7.28 (m, 2H), 7.09 (m, 1H), 7.07 (m, 1H), 6.94 (m, 1H), 6.25 (br. s, 1H, NH), 4.87 (s, 2H), 4.64 (s, 2H), 2.55 (s, 2H), 1.27 (s, 6H).

### EXAMPLE NO. B16-172

¹H-NMR (400 MHz, CDCl₃ δ, ppm) 7.50 (d, 2H), 7.19 (d, 2H), 7.08 (m, 2H), 7.02 (m, 1H), 6.24 (br. s, 1H, NH), 4.90 (s, 2H), 4.31 (s, 2H), 2.59 (s, 2H), 1.29 (s, 6H).

### EXAMPLE NO. B16-173

¹H-NMR (400 MHz, CDCl₃ δ, ppm) 7.53 (m, 1H), 7.42 (m, 1H), 7.28 (m, 2H), 7.16 (m, 1H), 7.08 (m, 1H), 7.02 (m, 1H), 6.19 (br. s, 1H, NH), 4.90 (s, 2H), 4.31 (s, 2H), 2.59 (s, 2H), 1.31 (s, 6H).

### EXAMPLE NO. B16-175

¹H-NMR (400 MHz, CDCl₃ δ, ppm) 8.25 (d, 2H), 7.54 (d, 2H), 7.116 (m, 1H), 7.12 (m, 1H), 7.06 (m, 1H), 6.28 (br. s, 1H, NH), 4.91 (s, 2H), 4.44 (s, 2H), 2.60 (s, 2H), 1.31 (s, 6H).

### EXAMPLE NO. B16-176

¹H-NMR (400 MHz, CDCl₃ δ, ppm) 8.27 (m, 1H), 8.11 (m, 1H), 7.75 (m, 1H), 7.60 (m, 1H), 7.19 (m, 1H), 7.14 (m, 1H), 7.05 (m, 1H), 6.28 (br. s, 1H, NH), 4.91 (s, 2H), 4.45 (s, 2H), 2.60 (s, 2H), 1.31 (s, 6H).

### EXAMPLE NO. B16-177

¹H-NMR (400 MHz, CDCl₃ δ, ppm) 8.01 (m, 1H), 7.62 (m, 1H), 7.57-7.52 (m, 2H), 7.13 (m, 1H), 7.03 (m, 1H), 6.95 (m, 1H), 6.39 (br. s, 1H, NH), 4.97 (s, 2H), 4.89 (s, 2H), 2.57 (s, 2H), 1.28 (s, 6H).

### EXAMPLE NO. B16-178

¹H-NMR (400 MHz, CDCl₃ δ, ppm) 7.66 (d, 2H), 7.48 (d, 2H), 7.10 (m, 2H), 7.02 (m, 1H), 6.19 (br. s, 1H, NH), 4.90 (s, 2H), 4.41 (s, 2H), 2.59 (s, 2H), 1.28 (s, 6H).

### EXAMPLE NO. B16-179

¹H-NMR (400 MHz, CDCl₃ δ, ppm) 7.66 (m, 1H), 7.59-7.50 (m, 3H), 7.16-7.10 (m, 2H), 7.03 (m, 1H), 6.32 (br. s, 1H, NH), 4.90 (s, 2H), 4.41 (s, 2H), 2.58 (s, 2H), 1.29 (s, 6H).

### EXAMPLE NO. B16-181

¹H-NMR (400 MHz, CDCl₃ δ, ppm) 7.70 (d, 2H), 7.48 (d, 2H), 7.12 (m, 1H), 7.08 (m, 1H), 7.00 (m, 1H), 6.22 (br. s, 1H, NH), 4.92 (s, 2H), 4.39 (s, 2H), 2.60 (s, 2H), 1.31 (s, 6H).

### EXAMPLE NO. B16-182

¹H-NMR (400 MHz, CDCl₃ δ, ppm) 7.69 (m, 1H), 7.61-7.57 (m, 2H), 7.52 (m, 1H), 7.12 (m, 2H), 7.05 (m, 1H), 6.28 (br. s, 1H, NH), 4.91 (s, 2H), 4.38 (s, 2H), 2.60 (s, 2H), 1.32 (s, 6H).

### EXAMPLE NO. B16-291

¹H-NMR (400 MHz, CDCl₃ δ, ppm) 7.31 (d, 2H), 7.14 (d, 2H), 7.07-7.03 (m, 2H), 7.00 (m, 1H), 6.02 (br. s, 1H, NH), 4.89 (s, 2H), 3.34 (m, 2H), 3.14 (m, 2H), 2.57 (s, 2H), 1.26 (s, 6H).

### EXAMPLE NO. B41-151

¹H-NMR (400 MHz, CDCl₃ δ, ppm) 7.39-7.35 (m, 3H), 7.31-7.27 (m, 2H), 7.05-6.99 (m, 3H), 6.08 (s, 1H, NH), 4.34 (s, 2H), 4.25 (m, 4H), 2.53 (s, 2H), 1.28 (s, 6H).

### EXAMPLE NO. B41-152

¹H-NMR (400 MHz, CDCl₃ δ, ppm) 7.21-7.17 (m, 4H), 7.06-7.00 (m, 3H), 6.06 (s, 1H, NH), 4.30 (s, 2H), 4.25 (m, 4H), 2.53 (s, 2H), 2.37 (s, 3H), 1.28 (s, 6H).

### EXAMPLE NO. B41-153

¹H-NMR (400 MHz, CDCl₃ δ, ppm) 7.27-7.13 (m, 3H), 7.09-7.03 (m, 4H), 6.11 (s, 1H, NH), 4.30 (s, 2H), 4.25 (m, 4H), 2.53 (s, 2H), 2.35 (s, 3H), 1.28 (s, 6H).

### EXAMPLE NO. B41-158

¹H-NMR (400 MHz, CDCl₃ δ, ppm) 7.30-7.25 (m, 2H), 7.08-7.01 (m, 5H), 6.11 (s, 1H, NH), 4.31 (s, 2H), 4.25 (m, 4H), 2.53 (s, 2H), 1.28 (s, 6H).

### EXAMPLE NO. B41-161

¹H-NMR (400 MHz, CDCl₃ δ, ppm) 7.47 (m, 1H), 7.34 (m, 1H), 7.19-7.16 (m, 1H), 7.08-7.00 (m, 4H), 6.16 (s, 1H, NH), 4.44 (s, 2H), 4.24 (m, 4H), 2.51 (s, 2H), 1.27 (s, 6H).

### EXAMPLE NO. B41-165

¹H-NMR (400 MHz, CDCl₃ δ, ppm) 7.34 (d, 2H), 7.23 (m, 2H), 7.05-7.00 (m, 3H), 6.11 (s, 1H, NH), 4.31 (s, 2H), 4.25 (m, 4H), 2.53 (s, 2H), 1.28 (s, 6H).

### EXAMPLE NO. B41-166

¹H-NMR (400 MHz, CDCl₃ δ, ppm) 7.37-7.29 (m, 2H), 7.23 (m, 2H), 7.11-7.06 (m, 2H), 7.03 (m, 1H), 6.14 (s, 1H, NH), 4.30 (s, 2H), 4.26 (m, 4H), 2.53 (s, 2H), 1.31 (s, 6H).

### EXAMPLE NO. B41-168

¹H-NMR (400 MHz, CDCl₃ δ, ppm) 7.53 (m, 1H), 7.35 (m, 1H), 7.30-7.27 (m, 2H), 7.05-6.96 (m, 3H), 6.19 (s, 1H, NH), 4.63 (s, 2H), 4.23 (m, 4H), 2.49 (s, 2H), 1.26 (s, 6H).

### EXAMPLE NO. B41-172

¹H-NMR (400 MHz, CDCl₃ δ, ppm) 7.51 (m, 2H), 7.18 (m, 2H), 7.07-7.01 (m, 3H), 6.12 (s, 1H, NH), 4.29 (s, 2H), 4.25 (m, 4H), 2.53 (s, 2H), 1.28 (s, 6H).

### EXAMPLE NO. B41-173

¹H-NMR (400 MHz, CDCl₃ δ, ppm) 7.53 (m, 1H), 7.41 (m, 1H), 7.28 (m, 2H), 7.09-7.02 (m, 3H), 6.14 (s, 1H, NH), 4.30 (s, 2H), 4.26 (m, 4H), 2.53 (s, 2H), 1.30 (s, 6H).

### EXAMPLE NO. B41-175

¹H-NMR (400 MHz, CDCl₃ δ, ppm) 8.24 (d, 2H), 7.53 (m, 2H), 7.10-7.03 (m, 3H), 6.19 (s, 1H, NH), 4.43 (s, 2H), 4.26 (m, 4H), 2.54 (s, 2H), 1.29 (s, 6H).

### EXAMPLE NO. B41-176

¹H-NMR (400 MHz, CDCl₃ δ, ppm) 8.25 (m, 1H), 8.12 (m, 1H), 7.74 (m, 1H), 7.59 (m, 1H), 7.13-7.06 (m, 3H), 6.26 (s, 1H, NH), 4.43 (s, 2H), 4.26 (m, 4H), 2.54 (s, 2H), 1.29 (s, 6H).

### EXAMPLE NO. B41-177

¹H-NMR (400 MHz, CDCl₃ δ, ppm) 8.01 (m, 1H), 7.61 (m, 1H), 7.55-7.52 (m, 2H), 7.07 (m, 1H), 6.99 (m, 2H), 6.28 (s, 1H, NH), 4.96 (s, 2H), 4.23 (m, 4H), 2.51 (s, 2H), 1.28 (s, 6H).

### EXAMPLE NO. B41-178

¹H-NMR (400 MHz, CDCl₃ δ, ppm) 7.64 (d, 2H), 7.46 (m, 2H), 7.06-7.02 (m, 3H), 6.18 (s, 1H, NH), 4.39 (s, 2H), 4.25 (m, 4H), 2.53 (s, 2H), 1.28 (s, 6H).

### EXAMPLE NO. B41-179

¹H-NMR (400 MHz, CDCl₃ δ, ppm) 7.66 (m, 1H), 7.59-7.48 (m, 3H), 7.08-7.06 (m, 3H), 6.14 (s, 1H, NH), 4.39 (s, 2H), 4.25 (m, 4H), 2.52 (s, 2H), 1.28 (s, 6H).

### EXAMPLE NO. B41-181

¹H-NMR (400 MHz, CDCl₃ δ, ppm) 7.69 (d, 2H), 7.46 (d, 2H), 7.10-7.04 (m, 3H), 6.19 (s, 1H, NH), 4.38 (s, 2H), 4.26 (m, 4H), 2.54 (s, 2H), 1.29 (s, 6H).

### EXAMPLE NO. B41-182

¹H-NMR (400 MHz, CDCl₃ δ, ppm) 7.68 (m, 1H), 7.61-7.55 (m, 2H), 7.52 (m, 1H), 7.10-7.07 (m, 3H), 6.30 (s, 1H, NH), 4.36 (s, 2H), 4.26 (m, 4H), 2.54 (s, 2H), 1.31 (s, 6H).

### EXAMPLE NO. B41-291

¹H-NMR (400 MHz, CDCl₃ δ, ppm) 7.29 (m, 2H), 7.13 (d, 2H), 7.05-6.98 (m, 3H), 6.01 (s, 1H, NH), 4.24 (m, 4H), 3.33 (m, 2H9, 3.14 (m, 2H), 2.51 (s, 2H), 1.28 (s, 6H).

### EXAMPLE NO. B50-45

¹H-NMR (400 MHz, CDCl₃ δ, ppm) 7.85 (d, 2H), 7.76 (d, 2H), 7.00 (m, 1H), 6.88 (m, 1H), 6.67 (d, 1H), 6.43 (br. s, 1H, NH), 4.70 (s, 2H), 3.74 (s, 3H), 2.55 (s, 2H), 1.28 (s, 6H).

### EXAMPLE NO. B50-151

¹H-NMR (400 MHz, CDCl₃ δ, ppm) 7.39 (m, 3H), 7.32 (m, 2H), 7.05-7.03 (m, 2H), 6.75 (d, 1H), 6.11 (br. s, 1H, NH), 4.74 (s, 2H), 4.32 (s, 2H), 3.77 (s, 3H), 2.58 (s, 2H), 1.33 (s, 6H).

### EXAMPLE NO. B50-152

¹H-NMR (400 MHz, CDCl₃ δ, ppm) 7.21-7.18 (m, 4H), 7.05-7.00 (m, 2H), 6.75 (d, 1H), 6.06 (br. s, 1H, NH), 4.74 (s, 2H), 4.28 (s, 2H), 3.77 (s, 3H), 2.58 (s, 2H), 2.37 (s, 3H), 1.31 (s, 6H).

### EXAMPLE NO. B50-153

¹H-NMR (400 MHz, CDCl₃ δ, ppm) 7.27-7.23 (m, 1H), 7.19 (m, 1H), 7.14 (m, 1H), 7.08-7.03 (m, 1H), 6.75 (m, 1H), 6.17 (br. s, 1H, NH), 4.74 (s, 2H), 4.28 (s, 2H), 3.77 (s, 3H), 2.58 (s, 2H), 2.35 (s, 3H), 1.33 (s, 6H).

### EXAMPLE NO. B50-158

¹H-NMR (400 MHz, CDCl₃ δ, ppm) 7.28 (m, 2H), 7.08-7.00 (m, 4H), 6.77 (d, 1H), 6.16 (br. s, 1H, NH), 4.74 (s, 2H), 4.30 (s, 2H), 3.77 (s, 3H), 2.58 (s, 2H), 1.33 (s, 6H).

### EXAMPLE NO. B50-161

¹H-NMR (400 MHz, CDCl₃ δ, ppm) 7.46 (m, 1H), 7.37 (m, 1H), 7.18 (m, 1H), 7.09-7.02 (m, 2H), 6.72 (m, 1H), 6.19 (br. s, 1H, NH), 4.73 (s, 2H), 4.42 (s, 2H), 3.76 (s, 3H), 2.57 (s, 2H), 1.32 (s, 6H).

### EXAMPLE NO. B50-165

¹H-NMR (400 MHz, CDCl₃ δ, ppm) 7.52 (d, 2H), 7.24 (d, 2H), 7.04 (m, 2H), 7.01 (m, 1H), 6.75 (d, 1H), 6.19 (br. s, 1H, NH), 4.74 (s, 2H), 4.29 (s, 2H), 3.77 (s, 3H), 2.58 (s, 2H), 1.33 (s, 6H).

### EXAMPLE NO. B50-166

¹H-NMR (400 MHz, CDCl₃ δ, ppm) 7.37-7.29 (m, 2H), 7.23 (m, 2H), 7.08 (m, 1H), 7.04 (m, 1H), 6.77 (m, 1H), 6.20 (br. s, 1H, NH), 4.74 (s, 2H), 4.29 (s, 2H), 3.77 (s, 3H), 2.59 (s, 2H), 1.34 (s, 6H).

### EXAMPLE NO. B50-168

¹H-NMR (400 MHz, CDCl₃ δ, ppm) 7.52 (m, 1H), 7.37 (m, 1H), 7.30-7.25 (m, 2H), 7.06 (m, 1H), 7.00 (m, 1H), 6.69 (m, 1H), 6.24 (br. s, 1H, NH), 4.72 (s, 2H), 4.61 (s, 2H), 3.75 (s, 3H), 2.55 (s, 2H), 1.31 (s, 6H).

### EXAMPLE NO. B50-172

¹H-NMR (400 MHz, CDCl₃ δ, ppm) 7.52 (d, 2H), 7.18 (d, 2H), 7.03-7.00 (m, 2H), 6.75 (d, 1H), 6.11 (br. s, 1H, NH), 4.74 (s, 2H), 4.28 (s, 2H), 3.77 (s, 3H), 2.59 (s, 2H), 1.33 (s, 6H).

### EXAMPLE NO. B50-173

¹H-NMR (400 MHz, CDCl₃ δ, ppm) 7.53 (m, 1H), 7.41 (m, 1H), 7.29 (m, 2H), 7.09-7.04 (m, 2H), 6.77 (m, 1H), 6.15 (br. s, 1H, NH), 4.74 (s, 2H), 4.28 (s, 2H), 3.77 (s, 3H), 2.59 (s, 2H), 1.35 (s, 6H).

### EXAMPLE NO. B50-175

¹H-NMR (400 MHz, CDCl₃ δ, ppm) 8.24 (d, 2H), 7.52 (d, 2H), 7.11 (m, 1H), 7.04 (m, 1H), 6.77 (d, 1H), 6.24 (br. s, 1H, NH), 4.74 (s, 2H), 4.42 (s, 2H), 3.78 (s, 3H), 2.59 (s, 2H), 1.34 (s, 6H).

### EXAMPLE NO. B50-176

¹H-NMR (400 MHz, CDCl₃ δ, ppm) 8.26 (m, 1H), 8.13 (m, 1H), 7.74 (m, 1H), 7.59 (m, 1H), 7.12-7.08 (m, 2H), 6.78 (m, 1H), 6.21 (br. s, 1H, NH), 4.75 (s, 2H), 4.42 (s, 2H), 3.78 (s, 3H), 2.59 (s, 2H), 1.35 (s, 6H).

### EXAMPLE NO. B50-177

¹H-NMR (400 MHz, CDCl₃ δ, ppm) 8.02 (m, 1H), 7.61 (m, 1H), 7.53 (m, 1H), 7.09 (m, 1H), 6.97 (m, 1H), 6.70 (m, 1H), 6.32 (br. s, 1H, NH), 4.95 (s, 2H), 4.72 (s, 2H), 3.76 (s, 3H), 2.57 (s, 2H), 1.33 (s, 6H).

### EXAMPLE NO. B50-178

¹H-NMR (400 MHz, CDCl₃ δ, ppm) 7.65 (d, 2H), 7.47 (d, 2H), 7.07 (m, 1H), 7.05-7.00 (m, 2H), 6.76 (d, 1H), 6.18 (br. s, 1H, NH), 4.74 (s, 2H), 4.38 (s, 2H), 3.77 (s, 3H), 2.59 (s, 2H), 1.33 (s, 6H).

### EXAMPLE NO. B50-179

¹H-NMR (400 MHz, CDCl₃ δ, ppm) 7.66 (m, 1H), 7.57-7.49 (m, 3H), 7.08 (m, 1H), 7.04 (m, 1H), 6.76 (m, 1H), 6.21 (br. s, 1H, NH), 4.74 (s, 2H), 4.37 (s, 2H), 3.77 (s, 3H), 2.58 (s, 2H), 1.33 (s, 6H).

### EXAMPLE NO. B50-181

¹H-NMR (400 MHz, CDCl₃ δ, ppm) 7.68 (d, 2H), 7.46 (d, 2H), 7.10 (m, 1H), 7.03 (m, 1H), 6.77 (d, 1H), 6.26 (br. s, 1H, NH), 4.74 (s, 2H), 4.37 (s, 2H), 3.78 (s, 3H), 2.59 (s, 2H), 1.34 (s, 6H).

### EXAMPLE NO. B50-182

¹H-NMR (400 MHz, CDCl₃ δ, ppm) 7.70 (m, 1H), 7.61-7.57 (m, 2H), 7.52 (m, 2H), 7.08 (m, 1H), 7.05 (m, 1H), 6.78 (m, 1H), 6.17 (br. s, 1H, NH), 4.75 (s, 2H), 4.34 (s, 2H), 3.78 (s, 3H), 2.60 (s, 2H), 1.35 (s, 6H).

### EXAMPLE NO. B50-291

¹H-NMR (400 MHz, CDCl₃ δ, ppm) 7.28 (d, 2H), 7.12 (d, 2H), 7.01-6.97 (m, 2H), 6.73 (d, 1H), 6.03 (br. s, 1H, NH), 4.72 (s, 2H), 3.75 (s, 3H), 3.32 (m, 2H), 3.13 (m, 2H), 2.57 (s, 2H), 1.32 (s, 6H).

### EXAMPLE NO. B51-45

¹H-NMR (400 MHz, CDCl₃ δ, ppm) 7.86 (d, 2H), 7.78 (d, 2H), 6.99 (m, 1H), 6.95-6.89 (m, 2H), 6.44 (br. s, 1H, NH), 4.23 (m, 2H), 3.67 (s, 3H), 2.65 (m, 2H), 2.46 (s, 2H), 1.20 (s, 6H).

### EXAMPLE NO. B51-152

¹H-NMR (400 MHz, CDCl₃ δ, ppm) 7.21 (d, 2H), 7.19 (d, 2H), 7.07 (m, 1H), 7.05-7.00 (m, 2H), 6.17 (br. s, 1H, NH), 4.29 (s, 2H), 4.27 (m, 2H), 3.69 (s, 3H), 2.69 (m, 2H), 2.50 (s, 2H), 2.37 (s, 3H), 1.25 (s, 6H).

### EXAMPLE NO. B51-153

¹H-NMR (400 MHz, CDCl₃ δ, ppm) 7.28-7.23 (m, 1H), 7.19 (m, 1H), 7.15 (m, 1H), 7.10-7.00 (m, 4H), 6.17 (br. s, 1H, NH), 4.29 (s, 2H), 4.27 (m, 2H), 3.69 (s, 3H), 2.69 (m, 2H), 2.50 (s, 2H), 2.35 (s, 3H), 1.27 (s, 6H).

### EXAMPLE NO. B51-158

¹H-NMR (400 MHz, CDCl₃ δ, ppm) 7.32-7.25 (m, 2H), 7.09-7.00 (m, 5H), 6.12 (br. s, 1H, NH), 4.30 (s, 2H), 4.27 (m, 2H), 3.69 (s, 3H), 2.69 (m, 2H), 2.50 (s, 2H), 1.27 (s, 6H).

### EXAMPLE NO. B51-165

¹H-NMR (400 MHz, CDCl₃ δ, ppm) 7.36 (d, 2H), 7.25 (d, 2H), 7.06-7.00 (m, 3H), 6.19 (br. s, 1H, NH), 4.30 (s, 2H), 4.28 (m, 2H), 3.69 (s, 3H), 2.69 (m, 2H), 2.50 (s, 2H), 1.26 (s, 6H).

### EXAMPLE NO. B51-166

¹H-NMR (400 MHz, CDCl₃ δ, ppm) 7.38-7.31 (m, 2H), 7.28-7.23 (m, 2H), 7.10 (m, 1H), 7.04-7.01 (m, 2H), 6.28 (br. s, 1H, NH), 4.30 (s, 2H), 4.27 (m, 2H), 3.69 (s, 3H), 2.69 (m, 2H), 2.50 (s, 2H), 1.26 (s, 6H).

### EXAMPLE NO. B51-168

¹H-NMR (400 MHz, CDCl₃ δ, ppm) 7.54 (m, 1H), 7.37 (m, 1H), 7.28 (m, 2H), 7.05-7.01 (m, 2H), 6.94 I/d, 1H), 6.29 (br. s, 1H, NH), 4.61 (s, 2H), 4.27 (m, 2H), 3.69 (s, 3H), 2.66 (m, 2H), 2.47 (s, 2H), 1.24 (s, 6H).

### EXAMPLE NO. B51-172

¹H-NMR (400 MHz, CDCl₃ δ, ppm) 7.51 (d, 2H), 7.21 (d, 2H), 7.06-7.00 (m, 3H), 6.16 (br. s, 1H, NH), 4.29 (s, 2H), 4.27 (m, 2H), 3.69 (s, 3H), 2.69 (m, 2H), 2.50 (s, 2H), 1.26 (s, 6H).

### EXAMPLE NO. B51-173

¹H-NMR (400 MHz, CDCl₃ δ, ppm) 7.52 (m, 1H), 7.40 (m, 1H), 7.31-7.23 (m, 2H), 7.10 (m, 1H), 7.04-7.01 (m, 2H), 6.19 (br. s, 1H, NH), 4.28 (s, 2H), 4.26 (m, 2H), 3.69 (s, 3H), 2.69 (m, 2H), 2.50 (s, 2H), 1.28 (s, 6H).

### EXAMPLE NO. B51-175

¹H-NMR (400 MHz, CDCl₃ δ, ppm) 8.25 (d, 2H), 7.54 (d, 2H), 7.09-7.01 (m, 3H), 6.21 (br. s, 1H, NH), 4.42 (s, 2H), 4.27 (m, 2H), 3.70 (s, 3H), 2.69 (m, 2H), 2.51 (s, 2H), 1.28 (s, 6H).

### EXAMPLE NO. B51-176

¹H-NMR (400 MHz, CDCl₃ δ, ppm) 8.26 (m, 1H), 8.13 (m, 1H), 7.75 (m, 1H), 7.61 (m, 1H), 7.11 (m, 2H), 7.05-7.00 (m, 2H), 6.22 (br. s, 1H, NH), 4.43 (s, 2H), 4.28 (m, 2H), 3.70 (s, 3H), 2.69 (m, 2H), 2.51 (s, 2H), 1.28 (s, 6H).

### EXAMPLE NO. B51-177

¹H-NMR (400 MHz, CDCl₃ δ, ppm) 8.02 (m, 1H), 7.63 (m, 1H), 7.57-7.51 (m, 2H), 7.08 (m, 1H), 7.00-6.95 (m, 2H), 6.35 (br. s, 1H, NH), 4.95 (s, 2H), 4.26 (m, 2H), 3.69 (s, 3H), 2.67 (m, 2H), 2.48 (s, 2H), 1.27 (s, 6H).

### EXAMPLE NO. B51-178

¹H-NMR (400 MHz, CDCl₃ δ, ppm) 7.65 (d, 2H), 7.48 (d, 2H), 7.07-7.00 (m, 3H), 6.16 (br. s, 1H, NH), 4.39 (s, 2H), 4.27 (m, 2H), 3.69 (s, 3H), 2.69 (m, 2H), 2.50 (s, 2H), 1.25 (s, 6H).

### EXAMPLE NO. B51-179

¹H-NMR (400 MHz, CDCl₃ δ, ppm) 7.67 (m, 1H), 7.58-7.51 (m, 3H), 7.09-7.00 (m, 3H), 6.15 (br. s, 1H, NH), 4.39 (s, 2H), 4.27 (m, 2H), 3.69 (s, 3H), 2.69 (m, 2H), 2.50 (s, 2H), 1.26 (s, 6H).

### EXAMPLE NO. B51-181

¹H-NMR (400 MHz, CDCl₃ δ, ppm) 7.69 (d, 2H), 7.47 (d, 2H), 7.08 (m, 1H), 7.05 (m, 2H), 6.22 (br. s, 1H, NH), 4.37 (s, 2H), 4.28 (m, 2H), 3.69 (s, 3H), 2.69 (m, 2H), 2.51 (s, 2H), 1.28 (s, 6H).

### EXAMPLE NO. B51-182

¹H-NMR (400 MHz, CDCl₃ δ, ppm) 7.69 (m, 1H), 7.62-7.57 (m, 2H), 7.52 (m, 1H), 7.10-7.02 (m, 3H), 6.26 (br. s, 1H, NH), 4.35 (s, 2H), 4.28 (m, 2H), 3.70 (s, 3H), 2.69 (m, 2H), 2.51 (s, 2H), 1.29 (s, 6H).

### EXAMPLE NO. B51-291

¹H-NMR (400 MHz, CDCl₃ δ, ppm) 7.29 (m, 2H), 7.14 (m, 2H), 7.02-6.98 (m, 3H), 6.02 (br. s, 1H, NH), 4.26 (m, 2H), 3.68 (s, 3H), 3.32 (m, 2H), 3.15 (m, 2H), 2.67 (m, 2H), 2.48 (s, 2H), 1.26 (s, 6H).

### EXAMPLE NO. B52-45

¹H-NMR (400 MHz, CDCl₃ δ, ppm) 7.86 (d, 2H), 7.78 (d, 2H), 6.99 (m, 1H), 6.96-6.90 (m, 2H), 6.47 (br. s, 1H, NH), 4.23 (m, 2H), 4.12 (m, 2H), 2.64 (m, 2H), 2.46 (s, 2H), 1.25-1.20 (m, 9H).

### EXAMPLE NO. B52-152

¹H-NMR (400 MHz, CDCl₃ δ, ppm) 7.21 (d, 2H), 7.19 (d, 2H), 7.06-7.01 (m, 3H), 6.07 (br. s, 1H, NH), 4.29 (s, 2H), 4.27 (m, 2H), 4.15 (m, 2H), 2.67 (m, 2H), 2.50 (s, 2H), 2.37 (s, 3H), 1.28-1.24 (m, 9H).

### EXAMPLE NO. B52-153

¹H-NMR (400 MHz, CDCl₃ δ, ppm) 7.28-7.23 (m, 1H), 7.19 (m, 1H), 7.15 (m, 1H), 7.10-6.98 (m, 4H), 6.15 (br. s, 1H, NH), 4.29 (s, 2H), 4.27 (m, 2H), 4.15 (m, 2H), 2.67 (m, 2H), 2.50 (s, 2H), 2.35 (s, 3H), 1.28-1.22 (m, 9H).

### EXAMPLE NO. B52-158

¹H-NMR (400 MHz, CDCl₃ δ, ppm) 7.32-7.25 (m, 2H), 7.09-7.00 (m, 5H), 6.09 (br. s, 1H, NH), 4.30 (s, 2H), 4.27 (m, 2H), 4.15 (q, 2H), 2.67 (m, 2H), 2.50 (s, 2H), 1.28-1.23 (m, 9H).

### EXAMPLE NO. B52-165

¹H-NMR (400 MHz, CDCl₃ δ, ppm) 7.36 (d, 2H), 7.25 (d, 2H), 7.05-7.00 (m, 3H), 6.12 (br. s, 1H, NH), 4.30 (s, 2H), 4.27 (m, 2H), 4.15 (m, 2H), 2.67 (m, 2H), 2.50 (s, 2H), 1.28-1.24 (m, 9H).

### EXAMPLE NO. B52-166

¹H-NMR (400 MHz, CDCl₃ δ, ppm) 7.38-7.29 (m, 3H), 7.24 (m, 1H), 7.10 (m, 1H), 7.03 (m, 2H), 6.15 (br. s, 1H, NH), 4.30 (s, 2H), 4.27 (m, 2H), 4.16 (m, 2H), 2.67 (m, 2H), 2.50 (s, 2H), 1.28-1.24 (m, 9H).

### EXAMPLE NO. B52-168

¹H-NMR (400 MHz, CDCl₃ δ, ppm) 7.54 (m, 1H), 7.37 (m, 1H), 7.28 (m, 2H), 7.05-7.00 (m, 2H), 6.96 (d, 1H), 6.24 (br. s, 1H, NH), 4.62 (s, 2H), 4.25 (m, 2H), 4.15 (m, 2H), 2.64 (m, 2H), 2.47 (s, 2H), 1.27-1.23 (m, 9H).

### EXAMPLE NO. B52-172

¹H-NMR (400 MHz, CDCl₃ δ, ppm) 7.52 (d, 2H), 7.21 (d, 2H), 7.05-7.00 (m, 3H), 6.11 (br. s, 1H, NH), 4.28 (s, 2H), 4.26 (m, 2H), 4.15 (q, 2H), 2.67 (m, 2H), 2.50 (s, 2H), 1.28-1.23 (m, 9H).

### EXAMPLE NO. B52-173

¹H-NMR (400 MHz, CDCl₃ δ, ppm) 7.52 (m, 1H), 7.40 (m, 1H), 7.31-7.23 (m, 2H), 7.10 (m, 1H), 7.04-7.00 (m, 2H), 6.16 (br. s, 1H, NH), 4.29 (s, 2H), 4.27 (m, 2H), 4.16 (q, 2H), 2.68 (m, 2H), 2.50 (s, 2H), 1.28-1.24 (m, 9H).

### EXAMPLE NO. B52-175

¹H-NMR (400 MHz, CDCl₃ δ, ppm) 8.25 (d, 2H), 7.54 (d, 2H), 7.09-7.05 (m, 3H), 6.20 (br. s, 1H, NH), 4.42 (s, 2H), 4.27 (m, 2H), 4.16 (q, 2H), 2.67 (m, 2H), 2.51 (s, 2H), 1.29-1.23 (m, 9H).

### EXAMPLE NO. B52-177

¹H-NMR (400 MHz, CDCl₃ δ, ppm) 8.02 (m, 1H), 7.62 (m, 1H), 7.57-7.51 (m, 2H), 7.07 (m, 1H), 7.00-6.95 (m, 2H), 6.28 (br. s, 1H, NH), 4.95 (s, 2H), 4.26 (m, 2H), 4.15 (q, 2H), 2.65 (m, 2H), 2.48 (s, 2H), 1.28-1.22 (m, 9H).

### EXAMPLE NO. B52-178

¹H-NMR (400 MHz, CDCl₃ δ, ppm) 7.65 (d, 2H), 7.48 (d, 2H), 7.07-7.00 (m, 3H), 6.15 (br. s, 1H, NH), 4.39 (s, 2H), 4.27 (m, 2H), 4.16 (m, 2H), 2.67 (m, 2H), 2.50 (s, 2H), 1.28-1.23 (s, 6H).

### EXAMPLE NO. B52-181

¹H-NMR (400 MHz, CDCl₃ δ, ppm) 7.69 (d, 2H), 7.48 (d, 2H), 7.08-7.06 (m, 3H), 6.16 (br. s, 1H, NH), 4.37 (s, 2H), 4.28 (m, 2H), 4.16 (m, 2H), 2.67 (m, 2H), 2.51 (s, 2H), 1.29-1.24 (m, 9H).

### EXAMPLE NO. B52-182

¹H-NMR (400 MHz, CDCl₃ δ, ppm)) 7.69 (m, 1H), 7.63-7.57 (m, 2H), 7.53 (m, 1H), 7.10-7.04 (m, 3H), 6.17 (br. s, 1H, NH), 4.35 (s, 2H), 4.28 (m, 2H), 4.16 (m, 2H), 2.68 (m, 2H), 2.51 (s, 2H), 1.29-1.24 (m, 9H).

### EXAMPLE NO. B52-291

¹H-NMR (400 MHz, CDCl₃ δ, ppm) 7.28 (m, 2H), 7.14 (m, 2H), 7.02-6.98 (m, 3H), 6.00 (br. s, 1H, NH), 4.25 (m, 2H), 4.14 (m, 2H), 3.32 (m, 2H), 3.15 (m, 2H), 2.65 (m, 2H), 2.48 (s, 2H), 1.27-1.22 (m, 9H).

### EXAMPLE NO. F3-35

¹H-NMR (400 MHz, CDCl₃ δ, ppm) 7.67 (d, 2H), 7.42 (d, 2H), 7.04 (m, 1H), 6.93 (m, 1H), 6.86 (m, 1H), 6.33 (br. s, 1H, NH), 3.85 (m, 2H), 2.54-2.40 (m, 2H), 1.53 (m, 2H), 1.17 (s, 3H), 1.06 (m, 1H), 0.71 (m, 3H), 0.48-0.38 (m, 4H).

### EXAMPLE NO. F3-45

¹H-NMR (400 MHz, CDCl₃ δ, ppm) 7.83 (d, 2H), 7.77 (d, 2H), 7.04 (m, 1H), 6.93-6.88 (m, 2H), 6.43 (br. s, 1H, NH), 3.93 (m, 2H), 2.57-2.43 (m, 2H), 1.57 (m, 2H), 1.20 (s, 3H), 1.08 (m, 1H), 0.73 (m, 3H), 0.51-0.37 (m, 4H).

### EXAMPLE NO. F3-50

¹H-NMR (400 MHz, CDCl₃ δ, ppm) 7.61 (d, 2H), 7.23 (d, 2H), 7.01 (m, 1H), 6.97 (m, 1H), 6.83 (m, 2H), 6.29 (br. s, 1H, NH), 3.85 (m, 2H), 2.52-2.40 (m, 2H), 2.39 (s, 3H), 1.51 (m, 2H), 1.18 (s, 3H), 1.06 (m, 1H), 0.68 (m, 3H), 0.47-0.37 (m, 4H).

### EXAMPLE NO. F3-61

¹H-NMR (400 MHz, CDCl₃ δ, ppm) 7.96 (m, 1H), 7.55-7-46 (m, 2H), 7.33 (m, 1H), 7.03-6.88 (m, 4H), 3.81 (m, 2H), 2.48-2.35 (m, 2H), 1.49 (m, 2H), 1.14 (s, 3H), 1.03 (m, 1H), 0.63 (m, 3H), 0.43-0.33 (m, 4H).

### EXAMPLE NO. F3-152

¹H-NMR (400 MHz, CDCl₃ δ, ppm) 7.27-7.19 (m, 4H), 7.11 (m, 2H), 6.98 (m, 1H), 6.08 (br. s, 1H, NH), 4.29 (s, 2H), 3.91 (m, 2H), 2.60-2.45 (m, 2H), 1.60 (m, 2H), 1.26 (s, 3H), 1.12 (m, 1H), 0.84 (m, 3H), 0.50-0.41 (m, 4H).

### EXAMPLE NO. F3-158

¹H-NMR (400 MHz, CDCl₃ δ, ppm) 7.28 (m, 2H), 7.12-7.04 (m, 4H), 6.99 (m, 1H), 6.13 (br. s, 1H, NH), 4.31 (s, 2H), 3.91 (m, 2H), 2.59-2.46 (m, 2H), 1.60 (m, 2H), 1.27 (s, 3H), 1.11 (m, 1H), 0.84 (m, 3H), 0.51-0.39 (m, 4H).

### EXAMPLE NO. F3-165

¹H-NMR (400 MHz, CDCl₃ δ, ppm) 7.35 (m, 2H), 7.24 (m, 2H), 7.14-7.08 (m, 2H), 6.97 (m, 1H), 6.10 (br. s, 1H, NH), 4.30 (s, 2H), 3.91 (m, 2H), 2.59-2.47 (m, 2H), 1.60 (m, 2H), 1.26 (s, 3H), 1.13 (m, 1H), 0.84 (m, 3H), 0.53-0.40 (m, 4H).

### EXAMPLE NO. F3-166

¹H-NMR (400 MHz, CDCl₃ δ, ppm) 7.38-7.22 (m, 5H), 7.12 (m, 1H), 6.98 (m, 1H), 6.15 (br. s, 1H, NH), 4.29 (s, 2H), 3.89 (m, 2H), 2.59-2.47 (m, 2H), 1.61 (m, 2H), 1.27 (s, 3H), 1.13 (m, 1H), 0.84 (m, 3H), 0.52-0.40 (m, 4H).

### EXAMPLE NO. F3-178

¹H-NMR (400 MHz, CDCl₃ δ, ppm) 7.63 (d, 2H), 7.47 (d, 2H), 7.14-7.04 (m, 2H), 6.99 (m, 1H), 6.15 (br. s, 1H, NH), 4.39 (s, 2H), 3.91 (m, 2H), 2.59-2.47 (m, 2H), 1.61 (m, 2H), 1.26 (s, 3H), 1.12 (m, 1H), 0.84 (m, 3H), 0.52-0.39 (m, 4H).

### EXAMPLE NO. F7-35

¹H-NMR (400 MHz, CDCl₃ δ, ppm) 7.67 (d, 2H), 7.43 (d, 2H), 7.14 (d, 1H), 6.93-6.85 (m, 2H), 6.34 (br. s, 1H, NH), 4.08 (m, 2H), 3.61 (m, 2H), 3.32 (s, 3H), 2.51 (d, 1H), 2.45 (d, 1H), 1.54 (m, 2H), 1.16 (s, 3H), 0.69 (m, 3H).

### EXAMPLE NO. F7-45

¹H-NMR (400 MHz, CDCl₃ δ, ppm) 7.84 (d, 2H), 7.77 (d, 2H), 7.16 (d, 1H), 6.92-6.86 (m, 2H), 6.41 (s, 1H, NH), 4.07 (m, 2H), 3.61 (m, 2H), 3.32 (s, 3H), 2.57-2.44 (m, 2H), 1.57 (m, 2H), 1.19 (s, 3H), 0.71 (m, 3H).

### EXAMPLE NO. F7-61

¹H-NMR (400 MHz, CDCl₃ δ, ppm) 7.95 (m, 1H), 7.51 (m, 1H), 7.47 (m, 1H), 7.33 (m, 1H), 7.06 (m, 1H), 6.99-6.93 (m, 3H), 4.04 (m, 2H), 3.58 (m, 2H), 3.29 (s, 3H), 2.44 (d, 1H), 2.40 (d, 1H), 1.46 (m, 2H), 1.14 (s, 3H), 0.62 (m, 3H).

### EXAMPLE NO. F7-151

¹H-NMR (400 MHz, CDCl₃ δ, ppm) 7.39 (m, 3H), 7.33 (m, 2H), 7.22 (m, 2H), 7.07 (m, 1H), 6.97 (m, 1H), 6.09 (br. s, 1H, NH), 4.32 (s, 2H), 4.15 (m, 2H), 3.64 (m, 2H), 3.36 (s, 3H), 2.58-2.47 (m, 2H), 2.37 (s, 3H), 1.59 (m, 2H), 1.25 (s, 3H), 0.83 (m, 3H).

### EXAMPLE NO. F7-152

¹H-NMR (400 MHz, CDCl₃ δ, ppm) 7.30-7.18 (m, 5H), 7.07 (m, 2H), 6.96 (m, 1H), 6.09 (br. s, 1H, NH), 4.28 (s, 2H), 4.14 (m, 2H), 3.64 (m, 2H), 3.36 (s, 3H), 2.58-2.47 (m, 2H), 2.37 (s, 3H), 1.58 (m, 2H), 1.25 (s, 3H), 0.83 (m, 3H).

### EXAMPLE NO. F7-158

¹H-NMR (400 MHz, CDCl₃ δ, ppm) 7.32-7.21 (m, 4H), 7.05 (m, 2H), 6.97 (m, 1H), 6.09 (br. s, 1H, NH), 4.29 (s, 2H), 4.14 (m, 2H), 3.64 (m, 2H), 3.35 (s, 3H), 2.55 (d, 1H), 2.51 (d, 1H), 1.60 (m, 2H), 1.25 (s, 3H), 0.83 (m, 3H).

### EXAMPLE NO. F7-165

¹H-NMR (400 MHz, CDCl₃ δ, ppm) 7.38 (d, 2H), 7.27-7.20 (m, 3H), 7.05 (m, 1H), 6.96 (m, 1H), 6.08 (br. s, 1H, NH), 4.29 (s, 2H), 4.13 (m, 2H), 3.64 (m, 2H), 3.35 (s, 3H), 2.55 (d, 1H), 2.51 (d, 1H), 1.58 (m, 2H), 1.25 (s, 3H), 0.83 (m, 3H).

### EXAMPLE NO. F7-166

¹H-NMR (400 MHz, CDCl₃ δ, ppm) 7.40-7.21 (m, 5H), 7.11 (m, 1H), 6.98 (m, 1H), 6.15 (br. s, 1H, NH), 4.29 (s, 2H), 4.09 (m, 2H), 3.63 (m, 2H), 3.36 (s, 3H), 2.54 (d, 1H), 2.47 (d, 1H), 1.58 (m, 2H), 1.26 (s, 3H), 0.82 (m, 3H).

### EXAMPLE NO. F7-178

¹H-NMR (400 MHz, CDCl₃ δ, ppm) 7.65 (d, 2H), 7.47 (d, 2H), 7.22 (m, 1H), 7.03 (m, 1H), 6.98 (m, 1H), 6.13 (br. s, 1H, NH), 4.38 (s, 2H), 4.14 (m, 2H), 3.65 (m, 2H), 3.35 (s, 3H), 2.57-2.47 (d, 1H), 1.59 (m, 2H), 1.25 (s, 3H), 0.85 (m, 3H).

### EXAMPLE NO. H3-35

¹H-NMR (400 MHz, d₆-DMSO δ, ppm) 10.13 (s, 1H, NH), 7.68 (d, 2H), 7.61 (d, 2H), 7.16 (d, 1H), 6.97 (dd, 1H), 6.84 (d, 1H), 3.80 (m, 2H), 2.43 (s, 2H), 1.77-1.43 (m, 8H), 1.00 (m, 1H), 0.38 (m, 2H), 0.25 (m, 2H).

### EXAMPLE NO. H3-50

¹H-NMR (400 MHz, d₆-DMSO δ, ppm) 9.99 (s, 1H, NH), 7.61 (d, 2H), 7.37 (d, 2H), 7.16 (d, 1H), 6.96 (dd, 1H), 6.89 (d, 1H), 3.78 (m, 2H), 2.43 (s, 2H), 2.33 (s, 3H), 1.77-1.45 (m, 8H), 0.99 (m, 1H), 0.38 (m, 2H), 0.25 (m, 2H).

### EXAMPLE NO. H3-61

¹H-NMR (400 MHz, d₆-DMSO δ, ppm) 10.42 (s, 1H, NH), 8.01 (d, 1H), 7.64 (m, 2H), 7.52 (m, 1H), 7.13 (d, 1H), 6.95 (m, 2H), 3.78 (m, 2H), 2.42 (s, 2H), 1.77-1.46 (m, 8H), 0.99 (m, 1H), 0.35 (m, 2H), 0.23 (m, 2H).

### EXAMPLE NO. H3-151

¹H-NMR (400 MHz, CDCl₃ δ, ppm) 7.42 (m, 2H), 7.33 (m, 3H), 7.12-7.03 (m, 3H), 6.18 (s, 1H, NH), 4.33 (s, 2H), 3.91 (m, 2H), 2.58 (s, 2H), 1.93-1.65 (m, 8H), 1.15 (m, 1H), 0.49 (m, 2H), 0.42 (m, 2H).

### EXAMPLE NO. H3-152

¹H-NMR (400 MHz, CDCl₃ δ, ppm) 7.23 (d, 2H), 7.21 (d, 2H), 7.17-7.02 (m, 3H), 6.04 (s, 1H, NH), 4.29 (s, 2H), 3.91 (m, 2H), 2.58 (s, 2H), 2.37 (s, 3H), 1.92-1.63 (m, 8H), 1.14 (m, 1H), 0.48 (m, 2H), 0.42 (m, 2H).

### EXAMPLE NO. H3-158

¹H-NMR (400 MHz, d₆-DMSO δ, ppm) 9.67 (s, 1H, NH), 7.33 (d, 2H), 7.19 (m, 2H), 7.17-7.03 (m, 3H), 4.44 (s, 2H), 3.84 (m, 2H), 2.43 (s, 2H), 1.79-1.55 (m, 8H), 1.06 (m, 1H), 0.41 (m, 2H), 0.29 (m, 2H).

### EXAMPLE NO. H3-165

¹H-NMR (400 MHz, d₆-DMSO δ, ppm) 9.68 (s, 1H, NH), 7.39 (d, 2H), 7.29 (d, 2H), 7.21 (d, 1H), 7.08-7.01 (m, 2H), 4.47 (s, 2H), 3.84 (m, 2H), 2.43 (s, 2H), 1.79-1.55 (m, 8H), 1.08 (m, 1H), 0.41 (m, 2H), 0.30 (m, 2H).

### EXAMPLE NO. H3-166

¹H-NMR (400 MHz, CDCl₃ δ, ppm) 7.40-7.22 (m, 4H), 7.15-7.01 (m, 3H), 6.13 (s, 1H, NH), 4.30 (s, 2H), 3.91 (m, 2H), 2.58 (s, 2H), 1.93-1.65 (m, 8H), 1.14 (m, 1H), 0.48 (m, 2H), 0.42 (m, 2H).

### EXAMPLE NO. H3-178

¹H-NMR (400 MHz, CDCl₃ δ, ppm) 7.63 (d, 2H), 7.48 (d, 2H), 7.14-7.03 (m, 3H), 6.19 (s, 1H, NH), 4.33 (s, 2H), 3.91 (m, 2H), 2.59 (s, 2H), 1.91-1.65 (m, 8H), 1.14 (m, 1H), 0.48 (m, 2H), 0.42 (m, 2H).

### EXAMPLE NO. H5-35

¹H-NMR (400 MHz, CDCl₃ δ, ppm) 7.67 (d, 2H), 7.44 (d, 2H), 7.14 (d, 1H), 6.90-6.85 (m, 2H), 6.33 (s, 1H, NH), 4.09 (m, 2H), 3.61 (m, 2H), 3.32 (s, 3H), 2.53 (s, 2H), 1.82-1.58 (m, 8H).

### EXAMPLE NO. H5-45

¹H-NMR (400 MHz, CDCl₃ δ, ppm) 7.84 (d, 2H), 7.77 (d, 2H), 7.16 (d, 1H), 6.91-6.85 (m, 2H), 6.37 (s, 1H, NH), 4.07 (m, 2H), 3.61 (m, 2H), 3.33 (s, 3H), 2.54 (s, 2H), 1.81-1.61 (m, 8H).

### EXAMPLE NO. H5-50

¹H-NMR (400 MHz, CDCl₃ δ, ppm) 7.62 (d, 2H), 7.23 (d, 2H), 7.11 (d, 1H), 6.90 (dd, 1H), 6.85 (d, 1H), 6.36 (s, 1H, NH), 4.09 (m, 2H), 3.60 (m, 2H), 3.32 (s, 3H), 2.51 (s, 2H), 2.39 (s, 3H), 1.79-1.56 (m, 8H).

### EXAMPLE NO. H5-61

¹H-NMR (400 MHz, CDCl₃ δ, ppm) 7.97 (d, 1H), 7.53 (m, 2H), 7.34 (m, 1H), 7.09 (d, 1H), 6.99-6.91 (m, 3H), 4.03 (m, 2H), 3.59 (m, 2H), 3.30 (s, 3H), 2.48 (s, 2H), 1.79-1.57 (m, 8H).

### EXAMPLE NO. H5-151

¹H-NMR (400 MHz, CDCl₃ δ, ppm) 7.40-7.26 (m, 4H), 7.21 (m, 1H), 7.08-6.99 (m, 3H), 6.06 (s, 1H, NH), 4.33 (s, 2H), 4.13 (m, 2H), 3.65 (m, 2H), 3.36 (s, 3H), 2.58 (s, 2H), 1.92-1.62 (m, 8H).

### EXAMPLE NO. H5-152

¹H-NMR (400 MHz, CDCl₃ δ, ppm) 7.23 (m, 1H), 7.21 (d, 2H), 7.19 (d, 2H), 7.04-6.98 (m, 2H), 6.13 (s, 1H, NH), 4.28 (s, 2H), 4.12 (m, 2H), 3.65 (m, 2H), 3.36 (s, 3H), 2.58 (s, 2H), 2.37 (s, 3H), 1.87-1.65 (m, 8H).

### EXAMPLE NO. H5-158

¹H-NMR (400 MHz, CDCl₃ δ, ppm) 7.33-7.20 (m, 4H), 7.09-6.97 (m, 3H), 6.08 (s, 1H, NH), 4.29 (s, 2H), 4.11 (m, 2H), 3.64 (m, 2H), 3.36 (s, 3H), 2.58 (s, 2H), 1.89-1.62 (m, 8H).

### EXAMPLE NO. H5-165

¹H-NMR (400 MHz, CDCl₃ δ, ppm) 7.33 (d, 2H), 7.24 (d, 2H), 7.02-6.97 (m, 3H), 6.07 (s, 1H, NH), 4.29 (s, 2H), 4.11 (m, 2H), 3.65 (m, 2H), 3.36 (s, 3H), 2.58 (s, 2H), 1.86-1.65 (m, 8H).

### EXAMPLE NO. H5-166

¹H-NMR (400 MHz, CDCl₃ δ, ppm) 7.40-7.22 (m, 4H), 7.09-7.00 (m, 3H), 6.17 (s, 1H, NH), 4.29 (s, 2H), 4.12 (m, 2H), 3.65 (m, 2H), 3.36 (s, 3H), 2.58 (s, 2H), 1.87-1.65 (m, 8H).

### EXAMPLE NO. H5-178

¹H-NMR (400 MHz, CDCl₃ δ, ppm) 7.65 (d, 2H), 7.47 (d, 2H), 7.21 (m, 1H), 7.02-6.97 (m, 2H), 6.11 (s, 1H, NH), 4.38 (s, 2H), 4.12 (m, 2H), 3.65 (m, 2H), 3.36 (s, 3H), 2.58 (s, 2H), 1.86-1.62 (m, 8H).

### EXAMPLE NO. I3-35

¹H-NMR (400 MHz, d₆-DMSO δ, ppm) 10.14 (s, 1H, NH), 7.69 (d, 2H), 7.64 (d, 2H), 7.17 (m, 1H), 6.99-6.94 (m, 2H), 3.78 (m, 2H), 2.58 (s, 2H), 1.61 (m, 1H), 1.57-1.39 (m, 8H), 1.23 (m, 1H), 0.99 (m, 1H), 0.37 (m, 2H), 0.25 (m, 2H).

### EXAMPLE NO. I3-45

¹H-NMR (400 MHz, CDCl₃ δ, ppm) 7.83 (d, 2H), 7.77 (d, 2H), 7.03 (m, 2H), 6.92 (m, 1H), 6.39 (s, 1H, NH), 3.83 (m, 2H), 2.63 (s, 2H), 1.76 (m, 1H), 1.63-1.45 (m, 8H), 1.26 (m, 1H), 1.06 (m, 1H), 0.47 (m, 2H), 0.41 (m, 2H).

### EXAMPLE NO. I3-50

¹H-NMR (400 MHz, CDCl₃ δ, ppm) 7.63 (d, 2H), 7.23 (d, 2H), 7.02-6.95 (m, 3H), 6.32 (s, 1H, NH), 3.82 (m, 2H), 2.60 (s, 2H), 2.39 (s, 3H), 1.75 (m, 1H), 1.61-1.45 (m, 8H), 1.25 (m, 1H), 1.06 (m, 1H), 0.46 (m, 2H), 0.43 (m, 2H).

### EXAMPLE NO. I3-61

¹H-NMR (400 MHz, CDCl₃ δ, ppm) 7.97 (m, 1H), 7.58-7.46 (m, 2H), 7.33 (m, 1H), 7.09 (m, 1H), 6.98 (m, 2H), 6.91 (s, 1H, NH), 3.81 (m, 2H), 2.58 (s, 2H), 1.73 (m, 1H), 1.61-1.48 (m, 8H), 1.25 (m, 1H), 1.03 (m, 1H), 0.41 (m, 2H), 0.36 (m, 2H).

### EXAMPLE NO. I3-151

¹H-NMR (400 MHz, CDCl₃ δ, ppm) 7.42-7.24 (m, 5H), 7.13-7.03 (m, 3H), 6.10 (s, 1H, NH), 4.34 (s, 2H), 3.90 (m, 2H), 2.67 (s, 2H), 1.79 (m, 1H), 1.73-1.54 (m, 8H), 1.29 (m, 1H), 1.14 (m, 1H), 0.49 (m, 2H), 0.42 (m, 2H).

### EXAMPLE NO. I3-152

¹H-NMR (400 MHz, CDCl₃ δ, ppm) 7.21 (d, 2H), 7.19 (d, 2H), 7.15-7.07 (m, 3H), 6.07 (s, 1H, NH), 4.30 (s, 2H), 3.93 (m, 2H), 2.68 (s, 2H), 2.39 (s, 3H), 1.80 (m, 1H), 1.73-1.54 (m, 8H), 1.30 (m, 1H), 1.16 (m, 1H), 0.49 (m, 2H), 0.43 (m, 2H).

### EXAMPLE NO. I3-158

¹H-NMR (400 MHz, CDCl₃ δ, ppm) 7.32 (m, 2H), 7.14-7.04 (m, 5H), 6.14 (s, 1H, NH), 4.31 (s, 2H), 3.90 (m, 2H), 2.68 (s, 2H), 1.79 (m, 1H), 1.75-1.54 (m, 8H), 1.31 (m, 1H), 1.13 (m, 1H), 0.50 (m, 2H), 0.43 (m, 2H).

### EXAMPLE NO. I3-165

¹H-NMR (400 MHz, CDCl₃ δ, ppm) 7.37 (d, 2H), 7.25 (d, 2H), 7.13-7.05 (m, 3H), 6.17 (s, 1H, NH), 4.31 (s, 2H), 3.90 (m, 2H), 2.67 (s, 2H), 1.78 (m, 1H), 1.72-1.53 (m, 8H), 1.31 (m, 1H), 1.13 (m, 1H), 0.50 (m, 2H), 0.42 (m, 2H).

### EXAMPLE NO. I3-166

¹H-NMR (400 MHz, d₆-DMSO δ, ppm) 9.73 (s, 1H, NH), 7.41-7.38 (m, 2H), 7.36-7.20 (m, 3H), 7.12-7.08 (m, 2H), 4.49 (s, 2H), 3.84 (m, 2H), 2.58 (s, 2H), 1.63 (m, 1H), 1.60-1.45 (m, 8H), 1.23 (m, 1H), 1.09 (m, 1H), 0.40 (m, 2H), 0.29 (m, 2H).

### EXAMPLE NO. I5-35

¹H-NMR (400 MHz, CDCl₃ δ, ppm) 7.69 (d, 2H), 7.44 (d, 2H), 7.14 (d, 1H), 6.99 (m, 1H), 6.91 (m, 1H), 6.34 (s, 1H, NH), 4.09 (m, 2H), 3.60 (m, 2H), 3.32 (s, 3H), 2.62 (s, 2H), 1.74 (m, 1H), 1.71-1.48 (m, 8H), 1.25 (m, 1H).

### EXAMPLE NO. I5-45

¹H-NMR (400 MHz, d₆-DMSO δ, ppm) 10.34 (s, 1H, NH), 8.07 (d, 2H), 7.86 (d, 2H), 7.15 (m, 1H), 6.99-6.93 (m, 2H), 4.03 (m, 2H), 3.43 (m, 2H), 3.18 (s, 3H), 2.58 (s, 2H), 1.62 (m, 1H), 1.54-1.34 (m, 8H), 1.23 (m, 1H).

### EXAMPLE NO. I5-50

¹H-NMR (400 MHz, d₆-DMSO δ, ppm) 10.01 (s, 1H, NH), 7.61 (d, 2H), 7.37 (d, 2H), 7.09 (m, 1H), 7.04 (m, 1H), 6.91 (m, 1H), 4.00 (m, 2H), 3.41 (m, 2H), 3.19 (s, 3H), 2.51 (s, 2H), 2.35 (s, 3H), 1.61 (m, 1H), 1.53-1.37 (m, 8H), 1.19 (m, 1H).

### EXAMPLE NO. I5-61

¹H-NMR (400 MHz, CDCl₃ δ, ppm) 7.98 (m, 1H), 7.58-7.43 (m, 2H), 7.34 (m, 1H), 7.08 (m, 2H), 6.97-6.91 (m, 2H), 4.04 (m, 2H), 3.57 (m, 2H), 3.30 (s, 3H), 2.56 (s, 2H), 1.74 (m, 1H), 1.71-1.47 (m, 8H), 1.24 (m, 1H).

### EXAMPLE NO. I5-151

¹H-NMR (400 MHz, CDCl₃ δ, ppm) 7.41-7.26 (m, 3H), 7.28-7.20 (m, 2H), 7.09-7.01 (m, 3H), 6.08 (s, 1H, NH), 4.33 (s, 2H), 4.11 (m, 2H), 3.67 (m, 2H), 3.36 (s, 3H), 2.68 (s, 2H), 1.79 (m, 1H), 1.71-1.52 (m, 8H), 1.29 (m, 1H).

### EXAMPLE NO. I5-152

¹H-NMR (400 MHz, d₆-DMSO δ, ppm) 9.62 (s, 1H, NH), 7.22-7.03 (m, 7H), 4.36 (s, 2H), 4.06 (m, 2H), 3.48 (m, 2H), 3.22 (s, 3H), 2.57 (s, 2H), 2.29 (s, 3H), 1.65 (m, 1H), 1.61-1.46 (m, 8H), 1.26 (m, 1H).

### EXAMPLE NO. I5-158

¹H-NMR (400 MHz, CDCl₃ δ, ppm) 7.38-7.21 (m, 4H), 7.10-7.00 (m, 3H), 6.09 (s, 1H, NH), 4.30 (s, 2H), 4.13 (m, 2H), 3.65 (m, 2H), 3.36 (s, 3H), 2.68 (s, 2H), 1.79 (m, 1H), 1.72-1.53 (m, 8H), 1.29 (m, 1H).

### EXAMPLE NO. I5-165

¹H-NMR (400 MHz, CDCl₃ δ, ppm) 7.38-7.21 (m, 4H), 7.10-7.00 (m, 3H), 6.09 (s, 1H, NH), 4.31 (s, 2H), 4.11 (m, 2H), 3.67 (m, 2H), 3.36 (s, 3H), 2.68 (s, 2H), 1.79 (m, 1H), 1.70-1.53 (m, 8H), 1.28 (m, 1H).

### EXAMPLE NO. I5-166

¹H-NMR (400 MHz, CDCl₃ δ, ppm) 7.37 (m, 1H), 7.30-7.19 (m, 4H), 7.11-6.98 (m, 2H), 6.12 (s, 1H, NH), 4.30 (s, 2H), 4.13 (m, 2H), 3.67 (m, 2H), 3.36 (s, 3H), 2.68 (s, 2H), 1.79 (m, 1H), 1.71-1.52 (m, 8H), 1.30 (m, 1H).

### EXAMPLE NO. I5-178

¹H-NMR (400 MHz, d₆-DMSO δ, ppm) 9.75 (s, 1H, NH), 7.73 (d, 2H), 7.51 (d, 2H), 7.19-7.04 (m, 3H), 4.59 (s, 2H), 4.05 (m, 2H), 3.48 (m, 2H), 3.23 (s, 3H), 2.56 (s, 2H), 1.64 (m, 1H), 1.61-1.44 (m, 8H), 1.24 (m, 1H).

### EXAMPLE NO. J3-35

¹H-NMR (400 MHz, CDCl₃ δ, ppm) 7.70 (d, 2H), 7.44 (d, 2H), 7.09 (d, 1H), 7.01 (d, 1H), 6.93 (m, 1H), 6.37 (s, 1H, NH), 3.83 (m, 2H), 2.71 (s, 2H), 2.13-2.02 (m, 5H), 1.87 (m, 1H), 1.04 (m, 1H), 0.45 (m, 2H), 0.35 (m, 2H).

### EXAMPLE NO. J3-45

¹H-NMR (400 MHz, CDCl₃ δ, ppm) 7.88 (d, 2H), 7.78 (d, 2H), 7.13 (d, 1H), 7.01 (d, 1H), 6.92 (m, 1H), 6.51 (s, 1H, NH), 3.83 (m, 2H), 2.73 (s, 2H), 2.20-2.14 (m, 2H), 2.13-2.02 (m, 3H), 1.88 (m, 1H), 1.03 (m, 1H), 0.45 (m, 2H), 0.36 (m, 2H).

### EXAMPLE NO. J3-61

¹H-NMR (400 MHz, CDCl₃ δ, ppm) 7.99 (d, 1H), 7.56-7.47 (m, 2H), 7.34 (m, 1H), 7.18 (d, 1H), 7.00-6.93 (m, 3H), 3.83 (m, 2H), 2.66 (s, 2H), 2.18-2.10 (m, 2H), 2.09-1.99 (m, 3H), 1.87 (m, 1H), 0.99 (m, 1H), 0.41 (m, 2H), 0.32 (m, 2H).

### EXAMPLE NO. J3-151

¹H-NMR (400 MHz, CDCl₃ δ, ppm) 7.41-7.34 (m, 4H), 7.19 (m, 1H), 7.13-7.04 (m, 2H), 6.17 (br. s, 1H, NH), 4.36 (s, 2H), 3.88 (m, 2H), 2.77 (s, 2H), 2.29-2.21 (m, 2H), 2.14-2.04 (m, 3H), 1.99 (m, 1H), 1.12 (m, 1H), 0.48 (m, 2H), 0.41 (m, 2H).

### EXAMPLE NO. J3-152

¹H-NMR (400 MHz, CDCl₃ δ, ppm) 7.25-7.18 (m, 5H), 7.13-7.07 (m, 2H), 6.14 (br. s, 1H, NH), 4.32 (s, 2H), 3.88 (m, 2H), 2.76 (s, 2H), 2.37 (s, 3H), 2.29-2.21 (m, 2H), 2.14-2.04 (m, 3H), 1.99 (m, 1H), 1.11 (m, 1H), 0.48 (m, 2H), 0.40 (m, 2H).

### EXAMPLE NO. J3-158

¹H-NMR (400 MHz, CDCl₃ δ, ppm) 7.37-7.28 (m, 2H), 7.19 (m, 1H), 7.11-7.01 (m, 4H), 6.12 (br. s, 1H, NH), 4.34 (s, 2H), 3.88 (m, 2H), 2.78 (s, 2H), 2.30-2.20 (m, 2H), 2.12-2.03 (m, 3H), 1.98 (m, 1H), 1.09 (m, 1H), 0.47 (m, 2H), 0.39 (m, 2H).

### EXAMPLE NO. J3-165

¹H-NMR (400 MHz, CDCl₃ δ, ppm) 7.38 (d, 2H), 7.31 (d, 1H), 7.20 (m, 1H), 7.11-7.03 (m, 2H), 6.20 (br. s, 1H, NH), 4.38 (s, 2H), 3.88 (m, 2H), 2.78 (s, 2H), 2.29-2.20 (m, 2H), 2.17-2.03 (m, 3H), 1.99 (m, 1H), 1.09 (m, 1H), 0.45 (m, 2H), 0.40 (m, 2H).

### EXAMPLE NO. J3-166

¹H-NMR (400 MHz, CDCl₃ δ, ppm) 7.38-7.22 (m, 4H), 7.18 (m, 1H), 7.12-7.08 (m, 2H), 6.22 (br. s, 1H, NH), 4.33 (s, 2H), 3.88 (m, 2H), 2.77 (s, 2H), 2.29-2.20 (m, 2H), 2.15-2.03 (m, 3H), 1.99 (m, 1H), 1.09 (m, 1H), 0.48 (m, 2H), 0.40 (m, 2H).

### EXAMPLE NO. J3-178

¹H-NMR (400 MHz, CDCl₃ δ, ppm) 7.63 (d, 2H), 7.49 (d, 2H), 7.21 (m, 1H), 7.12-7.01 (m, 3H), 6.10 (br. s, 1H, NH), 4.34 (s, 2H), 3.88 (m, 2H), 2.77 (s, 2H), 2.28-2.20 (m, 2H), 2.14-2.05 (m, 3H), 1.99 (m, 1H), 1.09 (m, 1H), 0.45 (m, 2H), 0.39 (m, 2H).

The present invention further provides for the inventive use of any desired mixtures of these substituted oxotetrahydroquinolinylsulfonamides of the general formula (I), and of at least one substituted oxotetrahydroquinolinylsulfonamides of the general formula (I), with further active agrochemical ingredients, for example fungicides, insecticides, herbicides, plant growth regulators or safeners, for increasing the resistance of plants to abiotic stress factors, preferably drought stress, and for enhancing plant growth and/or for increasing plant yield.

The present invention further provides a spray solution for treatment of plants, comprising an amount, effective for increasing the resistance of plants to abiotic stress factors, of at least one compound selected from the group consisting of at least one of the substituted oxotetrahydroquinolinylsulfonamides of the general formula (I) for use in accordance with the invention. The abiotic stress conditions which can be relativized may include, for example, heat, drought, cold and aridity stress (stress caused by aridity and/or lack of water), osmotic stress, waterlogging, elevated soil salinity, elevated exposure to minerals, ozone conditions, strong light conditions, limited availability of nitrogen nutrients, limited availability of phosphorus nutrients.

In one embodiment, it may, for example, be the case that one or more of the compounds for use in accordance with the invention, i.e. the appropriate substituted oxotetrahydroquinolinylsulfonamides of the general formula (I) having substitution in accordance with the invention, are applied by spray application to plants or plant parts to be treated correspondingly. The compounds of the general formula (I) or salts thereof are used as envisaged in accordance with the invention preferably with a dosage between 0.00005 and 3 kg/ha, more preferably between 0.0001 and 2 kg/ha, especially preferably between 0.0005 and 1 kg/ha, specifically preferably between 0.001 and 0.25 kg/ha.

The term “resistance to abiotic stress” is understood in the context of the present invention to mean various kinds of benefits for plants. Such advantageous properties are manifested, for example, in the following improved plant characteristics: improved root growth with regard to surface area and depth, increased stolon or tiller formation, stronger and more productive stolons and tillers, improvement in shoot growth, increased lodging resistance, increased shoot base diameter, increased leaf area, higher yields of nutrients and constituents, for example carbohydrates, fats, oils, proteins, vitamins, minerals, essential oils, dyes, fibers, better fiber quality, earlier flowering, increased number of flowers, reduced content of toxic products such as mycotoxins, reduced content of residues or disadvantageous constituents of any kind, or better digestibility, improved storage stability of the harvested material, improved tolerance to disadvantageous temperatures, improved tolerance to drought and aridity, and also oxygen deficiency as a result of waterlogging, improved tolerance to elevated salt contents in soil and water, enhanced tolerance to ozone stress, improved compatibility with respect to herbicides and other plant treatment compositions, improved water absorption and photosynthesis performance, advantageous plant properties, for example acceleration of ripening, more homogeneous ripening, greater attractiveness to beneficial animals, improved pollination, or other advantages well known to a person skilled in the art.

More particularly, the use according to the invention of one or more compounds of the general formula (I) exhibits the advantages described in spray application to plants and plant parts. In addition, the combined use of oxotetrahydroquinolinylsulfonamides of the general formula (I) having substitution in accordance with the invention with genetically modified cultivars with a view to increased tolerance to abiotic stress is likewise possible.

The further various benefits for plants mentioned above can be combined in a known manner in component form, and generally applicable terms can be used to describe them. Such terms are, for example, the following names: phytotonic effect, resistance to stress factors, less plant stress, plant health, healthy plants, plant fitness, plant wellness, plant concept, vigor effect, stress shield, protective shield, crop health, crop health properties, crop health products, crop health management, crop health therapy, plant health, plant health properties, plant health products, plant health management, plant health therapy, greening effect or regreening effect, freshness, or other terms with which a person skilled in the art is entirely familiar.

In the context of the present invention, a good effect on resistance to abiotic stress is understood to mean, without limitation,
at least an emergence improved by generally 3%, especially more than 5%, more preferably more than 10%,
at least a yield enhanced by generally 3%, especially more than 5%, more preferably more than 10%,
at least a root development improved by generally 3%, especially more than 5%, more preferably more than 10%,
at least a shoot size rising by generally 3%, especially more than 5%, more preferably more than 10%,
at least a leaf area increased by generally 3%, especially more than 5%, more preferably more than 10%,
at least a photosynthesis performance improved by generally 3%, especially more than 5%, more preferably more than 10%, and/or
at least a flower development improved by generally 3%, especially more than 5%, more preferably more than 10%,
   and the effects may occur individually or else in any combination of two or more effects.

The present invention further provides a spray solution for treatment of plants, comprising an amount, effective for enhancement of the resistance of plants to abiotic stress factors, of at least one compound from the group of the substituted oxotetrahydroquinolinylsulfonamides of the general formula (I) having substitution in accordance with the invention. The spray solution may comprise other customary constituents, such as solvents, formulation auxiliaries, especially water. Further constituents may include active agrochemical ingredients which are described in more detail below.

The present invention further provides for the use of corresponding spray solutions for increasing the resistance of plants to abiotic stress factors. The remarks which follow apply both to the use according to the invention of one or more compounds of the general formula (I) per se and to the corresponding spray solutions.

In accordance with the invention, it has additionally been found that the inventive application of one or more compounds of the general formula (I) in combination with at least one fertilizer as defined further below to plants or in their environment is possible.

Fertilizers which can be used in accordance with the invention together with the compounds of the general formula (I) elucidated in detail above are generally organic and inorganic nitrogen-containing compounds, for example ureas, urea/formaldehyde condensation products, amino acids, ammonium salts and ammonium nitrates, potassium salts (preferably chlorides, sulfates, nitrates), salts of phosphoric acid and/or salts of phosphorous acid (preferably potassium salts and ammonium salts). In this context, particular mention should be made of the NPK fertilizers, i.e. fertilizers which contain nitrogen, phosphorus and potassium, calcium ammonium nitrate, i.e. fertilizers which additionally contain calcium, or ammonium sulfate nitrate (general formula (NH₄)₂SO₄ NH₄NO₃), ammonium phosphate and ammonium sulfate. These fertilizers are generally known to the person skilled in the art; see also, for example, Ullmann's Encyclopedia of Industrial Chemistry, 5th edition, Vol. A 10, pages 323 to 431, Verlagsgesellschaft, Weinheim, 1987.

The fertilizers may additionally comprise salts of micronutrients (preferably calcium, sulfur, boron, manganese, magnesium, iron, boron, copper, zinc, molybdenum and cobalt) and of phytohormones (for example vitamin B1 and indole-(III)-acetic acid) or mixtures of these. Fertilizers used in accordance with the invention may also contain other salts such as monoammonium phosphate (MAP), diammonium phosphate (DAP), potassium sulfate, potassium chloride, magnesium sulfate. Suitable amounts for the secondary nutrients or trace elements are amounts of 0.5% to 5% by weight, based on the overall fertilizer. Further possible constituents are crop protection agents, insecticides, fungicides, safeners or growth regulators or mixtures thereof. Further details of these are given further down.

The fertilizers can be used, for example, in the form of powders, granules, prills or compactates. However, the fertilizers can also be used in liquid form, dissolved in an aqueous medium. In this case, dilute aqueous ammonia can also be used as a nitrogen fertilizer. Further possible ingredients for fertilizers are described, for example, in Ullmann's Encyclopedia of Industrial Chemistry, 5th edition, 1987, volume A 10, pages 363 to 401, DE-A 41 28 828, DE-A 19 05 834 and DE-A 196 31 764. The general composition of the fertilizers, which, in the context of the present invention, may take the form of straight and/or compound fertilizers, for example composed of nitrogen, potassium or phosphorus, may vary within a wide range. In general, a content of 1% to 30% by weight of nitrogen (preferably 5% to 20% by weight), of 1% to 20% by weight of potassium (preferably 3% to 15% by weight) and a content of 1% to 20% by weight of phosphorus (preferably 3% to 10% by weight) is advantageous. The microelement content is usually in the ppm range, preferably in the range from 1 to 1000 ppm.

In the context of the present invention, the fertilizer and one or more inventive compounds of the general formula (I) may be administered simultaneously. However, it is also possible first to apply the fertilizer and then one or more inventive compounds of the general formula (I), or first to apply one or more compounds of the general formula (I) and then the fertilizer. In the case of nonsynchronous application of one or more compounds of the general formula (I) and the fertilizer, the application in the context of the present invention is, however, effected in a functional relationship, especially within a period of generally 24 hours, preferably 18 hours, more preferably 12 hours, specifically 6 hours, more specifically 4 hours, even more specifically within 2 hours. In very particular embodiments of the present invention, one or more compounds of the formula (I) according to the invention and the fertilizer are applied within a time frame of less than 1 hour, preferably less than 30 minutes, more preferably less than 15 minutes.

Preference is given to the use according to the invention of compounds of the general formula (I) on plants from the group of the useful plants, ornamentals, turfgrass types, commonly used trees which are used as ornamentals in the public and domestic sectors, and forestry trees. Forestry trees include trees for the production of timber, cellulose, paper and products made from parts of the trees. The term useful plants as used here refers to crop plants which are used as plants for obtaining foods, animal feeds, fuels or for industrial purposes.

The useful plants include, for example, the following types of plants: triticale, durum (hard wheat), turf, vines, cereals, for example wheat, barley, rye, oats, rice, corn and millet; beet, for example sugar beet and fodder beet; fruits, for example pome fruit, stone fruit and soft fruit, for example apples, pears, plums, peaches, almonds, cherries and berries, for example strawberries, raspberries, blackberries; legumes, for example beans, lentils, peas and soybeans; oil crops, for example oilseed rape, mustard, poppies, olives, sunflowers, coconuts, castor oil plants, cocoa beans and peanuts; cucurbits, for example pumpkin/squash, cucumbers and melons; fiber plants, for example cotton, flax, hemp and jute; citrus fruits, for example oranges, lemons, grapefruit and tangerines; vegetables, for example spinach, lettuce, asparagus, cabbage species, carrots, onions, tomatoes, potatoes and bell peppers; Lauraceae, for example avocado, Cinnamomum, camphor, or also plants such as tobacco, nuts, coffee, eggplant, sugar cane, tea, pepper, grapevines, hops, bananas, latex plants and ornamentals, for example flowers, shrubs, deciduous trees and coniferous trees. This enumeration does not constitute a limitation.

The following plants are considered to be particularly suitable target crops for the application of the method of the invention: oats, rye, triticale, durum, cotton, eggplant, turf, pome fruit, stone fruit, soft fruit, corn, wheat, barley, cucumber, tobacco, vines, rice, cereals, pears, pepper, beans, soybeans, oilseed rape, tomato, bell pepper, melons, cabbage, potatoes and apples.

Examples of trees which can be improved by the method of the invention include: Abies sp., Eucalyptus sp., Picea sp., Pinus sp., Aesculus sp., Platanus sp., Tilia sp., Acer sp., Tsuga sp., Fraxinus sp., Sorbus sp., Betula sp., Crataegus sp., Ulmus sp., Quercus sp., Fagus sp., Salix sp., Populus sp.

Preferred trees which can be improved by the method of the invention include: from the tree species Aesculus: A. hippocastanum, A. pariflora, A. carnea; from the tree species Platanus: P. aceriflora, P. occidentalis, P. racemosa; from the tree species Picea: P. abies; from the tree species Pinus: P. radiate, P. ponderosa, P. contorta, P. sylvestre, P. elliottii, P. montecola, P. albicaulis, P. resinosa, P. palustris, P. taeda, P. flexilis, P. jeffregi, P. baksiana, P. strobes; from the tree species Eucalyptus: E. grandis, E. globulus, E. camadentis, E. nitens, E. obliqua, E. regnans, E. pilularus.

Particularly preferred trees which can be improved by the method of the invention are: from the tree species Pinus: P. radiate, P. ponderosa, P. contorta, P. sylvestre, P. strobes; from the tree species Eucalyptus: E. grandis, E. globulus and E. camadentis.

Particularly preferred trees which can be improved by the method of the invention are: horse chestnut, Platanaceae, linden tree and maple tree.

The present invention can also be applied to any desired turfgrasses, including cool-season turfgrasses and warm-season turfgrasses. Examples of cool-season turfgrasses are bluegrasses (Poa spp.), such as Kentucky bluegrass (Poa pratensis L.), rough bluegrass (Poa trivialis L.), Canada bluegrass (Poa compressa L.), annual bluegrass (Poa annua L.), upland bluegrass (Poa glaucantha Gaudin), wood bluegrass (Poa nemoralis L.) and bulbous bluegrass (Poa bulbosa L.); bentgrasses (Agrostis spp.) such as creeping bentgrass (Agrostis palustris Huds.), colonial bentgrass (Agrostis tenuis Sibth.), velvet bentgrass (Agrostis canina L.), South German Mixed Bentgrass (Agrostis spp. including Agrostis tenius Sibth., Agrostis canina L., and Agrostis palustris Huds.), and redtop (Agrostis alba L.); fescues (Festuca spp.), such as red fescue (Festuca rubra L. spp. rubra), creeping fescue (Festuca rubra L.), chewings fescue (Festuca rubra commutata Gaud.), sheep fescue (Festuca ovina L.), hard fescue (Festuca longifolia Thuill.), hair fescue (Festucu capillata Lam.), tall fescue (Festuca arundinacea Schreb.) and meadow fescue (Festuca elanor L.); ryegrasses (Lolium spp.), such as annual ryegrass (Lolium multiflorum Lam.), perennial ryegrass (Lolium perenne L.) and Italian ryegrass (Lolium multiflorum Lam.); and wheatgrasses (Agropyron spp.), such as fairway wheatgrass (Agropyron cristatum (L.) Gaertn.), crested wheatgrass (Agropyron desertorum (Fisch.) Schult.) and “western wheatgrass” (Agropyron smithii Rydb.).

Examples of further cool-season turfgrasses are beachgrass (Ammophila breviligulata Fern.), smooth bromegrass (Bromus inermis Leyss.), cattails such as Timothy (Phleum pratense L.), sand cattail (Phleum subulatum L.), orchardgrass (Dactylis glomerata L.), weeping alkaligrass (Puccinellia distans (L.) Parl.) and crested dog's-tail (Cynosurus cristatus L.).

Examples of warm-season turfgrasses are Bermuda grass (Cynodon spp. L. C. Rich), zoysia grass (Zoysia spp. Willd.), St. Augustine grass (Stenotaphrum secundatum Walt Kuntze), centipede grass (Eremochloa ophiuroides Munro Hack.), carpet grass (Axonopus affinis Chase), Bahia grass (Paspalum notatum Flugge), Kikuyu grass (Pennisetum clandestinum Hochst. ex Chiov.), buffalo grass (Buchloe dactyloids (Nutt.) Engelm.), Blue grama (Bouteloua gracilis (H.B.K.) Lag. ex Griffiths), seashore paspalum (Paspalum vaginatum Swartz) and sideoats grama (Bouteloua curtipendula (Michx. Torr.)). Cool-season turfgrasses are generally preferred for the use according to the invention. Particular preference is given to bluegrass, bentgrass and redtop, fescues and ryegrasses. Bentgrass is especially preferred.

Particular preference is given to using the inventive compounds of the general formula (I) to treat plants of the respective commercially available or commonly used plant cultivars. Plant cultivars are understood to mean plants which have new properties (“traits”) and which have been obtained by conventional breeding, by mutagenesis or with the aid of recombinant DNA techniques. Crop plants may accordingly be plants which can be obtained by conventional breeding and optimization methods or by biotechnological and genetic engineering methods or combinations of these methods, including the transgenic plants and including the plant cultivars which are protectable or non-protectable by plant breeders' rights.

The treatment method according to the invention can thus also be used for the treatment of genetically modified organisms (GMOs), e.g. plants or seeds. Genetically modified plants (or transgenic plants) are plants in which a heterologous gene has been stably integrated into the genome. The expression “heterologous gene” essentially means a gene which is provided or assembled outside the plant and when introduced into the nuclear, chloroplastic or hypochondrial genome gives the transformed plant new or improved agronomic or other properties by expressing a protein or polypeptide of interest or by downregulating or silencing (an)other gene(s) which is/are present in the plant (using for example antisense technology, cosuppression technology or RNAi technology [RNA interference]). A heterologous gene that is located in the genome is also called a transgene. A transgene that is defined by its specific presence in the plant genome is called a transformation or transgenic event.

Plants and plant varieties which are preferably treated with the compounds of the general formula (I) according to the invention include all plants which have genetic material which imparts particularly advantageous, useful traits to these plants (whether obtained by breeding and/or biotechnological means or not).

Plants and plant varieties which can likewise be treated with the compounds of the general formula (I) according to the invention are those plants which are resistant to one or more abiotic stress factors. Abiotic stress conditions may include, for example, heat, drought, cold and aridity stress, osmotic stress, waterlogging, increased soil salinity, increased exposure to minerals, ozone conditions, strong light conditions, limited availability of nitrogen nutrients, limited availability of phosphorus nutrients or shade avoidance.

Plants and plant cultivars which can likewise be treated with the compounds of the general formula (I) according to the invention are those plants which are characterized by enhanced yield characteristics. Increased yield in said plants can be the result of, for example, improved plant physiology, growth and development, such as water use efficiency, water retention efficiency, improved nitrogen use, enhanced carbon assimilation, improved photosynthesis, increased germination efficiency and accelerated maturation. Yield can also be affected by improved plant architecture (under stress and non-stress conditions), including but not limited to early flowering, flowering control for hybrid seed production, seedling vigor, plant size, internode number and distance, root growth, seed size, fruit size, pod size, pod or ear number, seed number per pod or ear, seed mass, enhanced seed filling, reduced seed dispersal, reduced pod dehiscence and lodging resistance. Further yield traits include seed composition, such as carbohydrate content, protein content, oil content and oil composition, nutritional value, reduction in antinutritional compounds, improved processability and better storage stability.

Plants that may also be treated with the compounds of the general formula (I) according to the invention are hybrid plants that already express the characteristics of heterosis, or hybrid effect, which results in generally higher yield, higher vigor, better health and better resistance towards biotic and abiotic stress factors. Such plants are typically produced by crossing an inbred male-sterile parent line (the female crossbreeding parent) with another inbred male-fertile parent line (the male crossbreeding parent). Hybrid seed is typically harvested from the male-sterile plants and sold to growers. Male-sterile plants can sometimes (for example in corn) be produced by detasseling (i.e. mechanical removal of the male reproductive organs or male flowers); however, it is more typical for male sterility to be the result of genetic determinants in the plant genome. In that case, and especially when seed is the desired product to be harvested from the hybrid plants, it is typically beneficial to ensure that male fertility in hybrid plants, which contain the genetic determinants responsible for male sterility, is fully restored. This can be accomplished by ensuring that the male crossbreeding parents have appropriate fertility restorer genes which are capable of restoring the male fertility in hybrid plants that contain the genetic determinants responsible for male sterility. Genetic determinants for male sterility may be located in the cytoplasm. Examples of cytoplasmic male sterility (CMS) were for instance described for Brassica species (WO 92/005251, WO 95/009910, WO 98/27806, WO 2005/002324, WO 2006/021972 and U.S. Pat. No. 6,229,072). However, genetic determinants for male sterility can also be located in the nuclear genome. Male-sterile plants can also be obtained by plant biotechnology methods such as genetic engineering. A particularly useful means of obtaining male-sterile plants is described in WO 89/10396 in which, for example, a ribonuclease such as a barnase is selectively expressed in the tapetum cells in the stamens. Fertility can then be restored by expression in the tapetum cells of a ribonuclease inhibitor such as barstar (e.g. WO 91/002069).

Plants or plant cultivars (obtained by plant biotechnology methods such as genetic engineering) which may also be treated with the inventive compounds of the general formula (I) are herbicide-tolerant plants, i.e. plants made tolerant to one or more given herbicides. Such plants can be obtained either by genetic transformation, or by selection of plants containing a mutation imparting such herbicide tolerance.

Herbicide-tolerant plants are for example glyphosate-tolerant plants, i.e. plants made tolerant to the herbicide glyphosate or salts thereof. Thus, for example, glyphosate-tolerant plants can be obtained by transforming the plant with a gene encoding the enzyme 5-enolpyruvylshikimate-3-phosphate synthase (EPSPS). Examples of such EPSPS genes are the AroA gene (mutant CT7) of the bacterium Salmonella typhimurium (Comai et al., Science (1983), 221, 370-371), the CP4 gene of the bacterium Agrobacterium sp. (Barry et al., Curr. Topics Plant Physiol. (1992), 7, 139-145), the genes encoding a petunia EPSPS (Shah et al., Science (1986), 233, 478-481), a tomato EPSPS (Gasser et al., J. Biol. Chem. (1988), 263, 4280-4289) or an Eleusine EPSPS (WO 2001/66704). It can also be a mutated EPSPS, as described, for example, in EP-A 0837944, WO 2000/066746, WO 2000/066747 or WO 2002/026995. Glyphosate-tolerant plants can also be obtained by expressing a gene that encodes a glyphosate oxidoreductase enzyme as described in U.S. Pat. No. 5,776,760 and U.S. Pat. No. 5,463,175. Glyphosate-tolerant plants can also be obtained by expressing a gene that encodes a glyphosate acetyl transferase enzyme as described, for example, in WO 2002/036782, WO 2003/092360, WO 2005/012515 and WO 2007/024782. Glyphosate-tolerant plants can also be obtained by selecting plants containing naturally occurring mutations of the abovementioned genes, as described, for example, in WO 01/024615 or WO 2003/013226.

Other herbicide-resistant plants are for example plants that are made tolerant to herbicides inhibiting the enzyme glutamine synthase, such as bialaphos, phosphinothricin or glufosinate. Such plants can be obtained by expressing an enzyme detoxifying the herbicide or a mutant glutamine synthase enzyme that is resistant to inhibition. One example of such an effective detoxifying enzyme is an enzyme encoding a phosphinothricin acetyltransferase (such as the bar or pat protein from Streptomyces species). Plants expressing an exogenous phosphinothricin acetyltransferase are described, for example, in U.S. Pat. No. 5,561,236; U.S. Pat. No. 5,648,477; U.S. Pat. No. 5,646,024; U.S. Pat. No. 5,273,894; U.S. Pat. No. 5,637,489; U.S. Pat. No. 5,276,268; U.S. Pat. No. 5,739,082; U.S. Pat. No. 5,908,810 and U.S. Pat. No. 7,112,665.

Further herbicide-tolerant plants are also plants that have been made tolerant to the herbicides inhibiting the enzyme hydroxyphenylpyruvate dioxygenase (HPPD). Hydroxyphenylpyruvate dioxygenases are enzymes that catalyze the reaction in which para-hydroxyphenylpyruvate (HPP) is converted to homogentizate. Plants tolerant to HPPD inhibitors can be transformed with a gene encoding a naturally occurring resistant HPPD enzyme, or a gene encoding a mutated HPPD enzyme according to WO 96/038567, WO 99/024585 and WO 99/024586. Tolerance to HPPD inhibitors can also be obtained by transforming plants with genes encoding certain enzymes enabling the formation of homogentisate despite inhibition of the native HPPD enzyme by the HPPD inhibitor. Such plants and genes are described in WO 99/034008 and WO 2002/36787. Tolerance of plants to HPPD inhibitors can also be improved by transforming plants with a gene encoding a prephenate dehydrogenase enzyme in addition to a gene encoding an HPPD-tolerant enzyme, as described in WO 2004/024928.

Other herbicide-resistant plants are plants which have been rendered tolerant to acetolactate synthase (ALS) inhibitors. Known ALS inhibitors include, for example, sulfonylurea, imidazolinone, triazolopyrimidines, pyrimidinyloxy(thio)benzoates, and/or sulfonylaminocarbonyltriazolinone herbicides. Different mutations in the ALS enzyme (also known as acetohydroxyacid synthase, AHAS) are known to confer tolerance to different herbicides and groups of herbicides, as described for example in Tranel and Wright, Weed Science (2002), 50, 700-712, but also in U.S. Pat. No. 5,605,011, U.S. Pat. No. 5,378,824, U.S. Pat. No. 5,141,870 and U.S. Pat. No. 5,013,659. The production of sulfonylurea-tolerant plants and imidazolinone-tolerant plants has been described in U.S. Pat. No. 5,605,011; U.S. Pat. No. 5,013,659; U.S. Pat. No. 5,141,870; U.S. Pat. No. 5,767,361; U.S. Pat. No. 5,731,180; U.S. Pat. No. 5,304,732; U.S. Pat. No. 4,761,373; U.S. Pat. No. 5,331,107; U.S. Pat. No. 5,928,937; and U.S. Pat. No. 5,378,824; and also in the international publication WO 96/033270. Further imidazolinone-tolerant plants have also been described, for example, in WO 2004/040012, WO 2004/106529, WO 2005/020673, WO 2005/093093, WO 2006/007373, WO 2006/015376, WO 2006/024351 and WO 2006/060634. Further sulfonylurea- and imidazolinone-tolerant plants have also been described, for example, in WO 2007/024782.

Further plants tolerant to ALS-inhibitors, in particular to imidazolinones, sulfonylureas and/or sulfamoylcarbonyltriazolinones can be obtained by induced mutagenesis, by selection in cell cultures in the presence of the herbicide or by mutation breeding, as described, for example, for soybeans in U.S. Pat. No. 5,084,082, for rice in WO 97/41218, for sugarbeet in U.S. Pat. No. 5,773,702 and WO 99/057965, for lettuce in U.S. Pat. No. 5,198,599 or for sunflower in WO 2001/065922.

Plants or plant cultivars (obtained by plant biotechnology methods such as genetic engineering) which may also be treated with the compounds of the general formula (I) according to the invention are insect-resistant transgenic plants, i.e. plants made resistant to attack by certain target insects. Such plants can be obtained by genetic transformation, or by selection of plants containing a mutation imparting such insect resistance.

In the present context, the term “insect-resistant transgenic plant” includes any plant containing at least one transgene comprising a coding sequence encoding the following:

1) an insecticidal crystal protein from Bacillus thuringiensis or an insecticidal portion thereof, such as the insecticidal crystal proteins compiled by Crickmore et al., Microbiology and Molecular Biology Reviews (1998), 62, 807-813, updated by Crickmore et al. (2005) in the Bacillus thuringiensis toxin nomenclature (online at: http://www.lifesci.sussex.ac.uk/Home/Neil_Crickmore/Bt/), or insecticidal portions thereof, for example proteins of the Cry protein classes Cry1Ab, Cry1Ac, Cry1F, Cry2Ab, Cry3Ae or Cry3Bb or insecticidal portions thereof; or
2) a crystal protein from Bacillus thuringiensis or a portion thereof which is insecticidal in the presence of a second other crystal protein from Bacillus thuringiensis or a portion thereof, such as the binary toxin made up of the Cy34 and Cy35 crystal proteins (Moellenbeck et al., Nat. Biotechnol. (2001), 19, 668-72; Schnepf et al., Applied Environm. Microb. (2006), 71, 1765-1774); or
3) a hybrid insecticidal protein comprising parts of two different insecticidal crystal proteins from Bacillus thuringiensis, such as a hybrid of the proteins of 1) above or a hybrid of the proteins of 2) above, for example the Cry1A. 105 protein produced by maize event MON98034 (WO 2007/027777); or
4) a protein of any one of points 1) to 3) above wherein some, particularly 1 to 10, amino acids have been replaced by another amino acid to obtain a higher insecticidal activity to a target insect species, and/or to expand the range of target insect species affected, and/or because of changes induced in the encoding DNA during cloning or transformation, such as the Cry3Bb1 protein in maize events MON863 or MON88017, or the Cry3A protein in maize event MIR 604; or
5) an insecticidal secreted protein from Bacillus thuringiensis or Bacillus cereus, or an insecticidal portion thereof, such as the vegetative insecticidal proteins (VIPs) listed under the following link, for example proteins from the VIP3Aa protein class: http://www.lifesci.sussex.ac.uk/Home/Neil_Crickmore/Bt/vip.html; or
6) a secreted protein from Bacillus thuringiensis or Bacillus cereus which is insecticidal in the presence of a second secreted protein from Bacillus thuringiensis or B. cereus, such as the binary toxin made up of the VIP1A and VIP2A proteins (WO 94/21795); or
7) a hybrid insecticidal protein comprising parts from different secreted proteins from Bacillus thuringiensis or Bacillus cereus, such as a hybrid of the proteins in 1) or a hybrid of the proteins in 2) above; or
8) a protein of any one of points 1) to 3) above wherein some, particularly 1 to 10, amino acids have been replaced by another amino acid to obtain a higher insecticidal activity to a target insect species, and/or to expand the range of target insect species affected, and/or because of changes induced in the encoding DNA during cloning or transformation (while still encoding an insecticidal protein), such as the VIP3Aa protein in cotton event COT 102.

Of course, the insect-resistant transgenic plants, as used herein, also include any plant comprising a combination of genes encoding the proteins of any one of the above classes 1 to 8. In one embodiment, an insect-resistant plant contains more than one transgene encoding a protein of any one of the above classes 1 to 8, to expand the range of the target insect species affected or to delay insect resistance development to the plants, by using different proteins insecticidal to the same target insect species but having a different mode of action, such as binding to different receptor binding sites in the insect.

Plants or plant cultivars (obtained by plant biotechnology methods such as genetic engineering) which may also be treated with the compounds according to the invention of the general formula (I) are tolerant to abiotic stress factors. Such plants can be obtained by genetic transformation, or by selection of plants containing a mutation imparting such stress resistance. Particularly useful stress-tolerant plants include:

a. plants which contain a transgene capable of reducing the expression and/or the activity of the poly(ADP-ribose)polymerase (PARP) gene in the plant cells or plants, as described in WO 2000/004173 or EP 04077984.5 or EP 06009836.5;
b. plants which contain a stress tolerance-enhancing transgene capable of reducing the expression and/or the activity of the PARG-encoding genes of the plants or plant cells, as described, for example, in WO 2004/090140;
c. plants which contain a stress tolerance-enhancing transgene encoding a plant-functional enzyme of the nicotinamide adenine dinucleotide salvage biosynthesis pathway, including nicotinamidase, nicotinate phosphoribosyltransferase, nicotinic acid mononucleotide adenyltransferase, nicotinamide adenine dinucleotide synthetase or nicotinamide phosphoribosyltransferase, as described, for example, in EP 04077624.7 or WO 2006/133827 or PCT/EP07/002433.

Plants or plant varieties (obtained by plant biotechnology methods such as genetic engineering) which may also be treated with the compounds of the general formula (I) according to the invention show altered quantity, quality and/or storage stability of the harvested product and/or altered properties of specific ingredients of the harvested product such as, for example:

1) Transgenic plants which synthesize a modified starch which, in its physicochemical characteristics, in particular the amylose content or the amylose/amylopectin ratio, the degree of branching, the average chain length, the side chain distribution, the viscosity behavior, the gelling strength, the starch granule size and/or the starch granule morphology, is changed in comparison with the synthesized starch in wild-type plant cells or plants, so that this modified starch is better suited to specific applications. These transgenic plants synthesizing a modified starch are described, for example, in EP 0571427, WO 95/004826, EP 0719338, WO 96/15248, WO 96/19581, WO 96/27674, WO 97/11188, WO 97/26362, WO 97/32985, WO 97/42328, WO 97/44472, WO 97/45545, WO 98/27212, WO 98/40503, WO 99/58688, WO 99/58690, WO 99/58654, WO 2000/008184, WO 2000/008185, WO 2000/28052, WO 2000/77229, WO 2001/12782, WO 2001/12826, WO 2002/101059, WO 2003/071860, WO 2004/056999, WO 2005/030942, WO 2005/030941, WO 2005/095632, WO 2005/095617, WO 2005/095619, WO 2005/095618, WO 2005/123927, WO 2006/018319, WO 2006/103107, WO 2006/108702, WO 2007/009823, WO 2000/22140, WO 2006/063862, WO 2006/072603, WO 2002/034923, EP 06090134.5, EP 06090228.5, EP 06090227.7, EP 07090007.1, EP 07090009.7, WO 2001/14569, WO 2002/79410, WO 2003/33540, WO 2004/078983, WO 2001/19975, WO 95/26407, WO 96/34968, WO 98/20145, WO 99/12950, WO 99/66050, WO 99/53072, U.S. Pat. No. 6,734,341, WO 2000/11192, WO 98/22604, WO 98/32326, WO 2001/98509, WO 2001/98509, WO 2005/002359, U.S. Pat. No. 5,824,790, U.S. Pat. No. 6,013,861, WO 94/004693, WO 94/009144, WO 94/11520, WO 95/35026 and WO 97/20936.
2) Transgenic plants which synthesize non-starch carbohydrate polymers or which synthesize non-starch carbohydrate polymers with altered properties in comparison to wild-type plants without genetic modification. Examples are plants producing polyfructose, especially of the inulin and levan type, as described in EP 0663956, WO 96/001904, WO 96/021023, WO 98/039460 and WO 99/024593, plants producing alpha-1,4-glucans, as described in WO 95/031553, US 2002/031826, U.S. Pat. No. 6,284,479, U.S. Pat. No. 5,712,107, WO 97/047806, WO 97/047807, WO 97/047808 and WO 2000/14249, plants producing alpha-1,6-branched alpha-1,4-glucans, as described in WO 2000/73422, and plants producing alternan, as described in WO 2000/047727, EP 06077301.7, U.S. Pat. No. 5,908,975 and EP 0728213.
3) Transgenic plants which produce hyaluronan, as for example described in WO 06/032538, WO 2007/039314, WO 2007/039315, WO 2007/039316, JP 2006/304779 and WO 2005/012529.

Plants or plant cultivars (obtained by plant biotechnology methods such as genetic engineering) which may also be treated with the inventive compounds of the general formula (I) are plants, such as cotton plants, with altered fiber characteristics. Such plants can be obtained by genetic transformation, or by selection of plants containing a mutation imparting such altered fiber characteristics and include:

a) plants, such as cotton plants, which contain an altered form of cellulose synthase genes, as described in WO 98/000549;
b) plants, such as cotton plants, which contain an altered form of rsw2 or rsw3 homologous nucleic acids, as described in WO 2004/053219;
c) plants, such as cotton plants, with an increased expression of sucrose phosphate synthase, as described in WO 2001/017333;
d) plants, such as cotton plants, with an increased expression of sucrose synthase as described in WO 2002/45485;
e) plants, such as cotton plants, wherein the timing of the plasmodesmatal gating at the basis of the fiber cell is altered, for example through downregulation of fiber-selective β-1,3-glucanase as described in WO 2005/017157;
f) plants, such as cotton plants, which have fibers with altered reactivity, for example through expression of the N-acetylglucosamine transferase gene including nodC and chitin synthase genes, as described in WO 2006/136351.

Plants or plant cultivars (obtained by plant biotechnology methods such as genetic engineering) which may also be treated with the compounds of the general formula (I) according to the invention are plants, such as oilseed rape or related Brassica plants, with altered oil profile characteristics. Such plants can be obtained by genetic transformation, or by selection of plants containing a mutation imparting such altered oil characteristics and include:

a) plants, such as oilseed rape plants, which produce oil having a high oleic acid content, as described, for example, in U.S. Pat. No. 5,969,169, U.S. Pat. No. 5,840,946 or U.S. Pat. No. 6,323,392 or U.S. Pat. No. 6,063,947;
b) plants, such as oilseed rape plants, which produce oil having a low linolenic acid content, as described in U.S. Pat. No. 6,270,828, U.S. Pat. No. 6,169,190 or U.S. Pat. No. 5,965,755;
c) plants, such as oilseed rape plants, which produce oil having a low level of saturated fatty acids, as described, for example, in U.S. Pat. No. 5,434,283.

Particularly useful transgenic plants which may be treated with the compounds of the general formula (I) according to the invention are plants containing transformation events, or a combination of transformation events, and that are listed for example in the databases of various national or regional regulatory agencies.

Particularly useful transgenic plants which may be treated with the compounds of the general formula (I) according to the invention are, for example, plants which comprise one or more genes which encode one or more toxins and are the transgenic plants available under the following trade names: YIELD GARD® (for example corn, cotton, soybeans), KnockOut® (for example corn), BiteGard® (for example corn), BT-Xtra® (for example corn), StarLink® (for example corn), Bollgard® (cotton), Nucotn® (cotton), Nucotn 33B® (cotton), NatureGard® (for example corn), Protecta® and NewLeaf® (potato). Examples of herbicide-tolerant plants include are corn varieties, cotton varieties and soya bean varieties which are available under the following trade names: Roundup Ready® (tolerance to glyphosates, for example corn, cotton, soybeans), Liberty Link® (tolerance to phosphinothricin, for example oilseed rape), IMI® (tolerance to imidazolinone) and SCS® (tolerance to sulfonylurea), for example corn. Herbicide-resistant plants (plants bred in a conventional manner for herbicide tolerance) which may be mentioned include the varieties sold under the name Clearfield® (for example corn).

The compounds of the formula (I) to be used in accordance with the invention can be converted to customary formulations, such as solutions, emulsions, wettable powders, water- and oil-based suspensions, powders, dusts, pastes, soluble powders, soluble granules, granules for broadcasting, suspoemulsion concentrates, natural compounds impregnated with active ingredient, synthetic substances impregnated with active ingredient, fertilizers, and also microencapsulations in polymeric substances. In the context of the present invention, it is especially preferred when the compounds of the general formula (I) are used in the form of a spray formulation.

The present invention therefore additionally also relates to a spray formulation for enhancing the resistance of plants to abiotic stress. A spray formulation is described in detail hereinafter:

The formulations for spray application are produced in a known manner, for example by mixing the compounds of the general formula (I) for use in accordance with the invention with extenders, i.e. liquid solvents and/or solid carriers, optionally with use of surfactants, i.e. emulsifiers and/or dispersants and/or foam formers. Further customary additives, for example customary extenders and solvents or diluents, dyes, wetting agents, dispersants, emulsifiers, antifoams, preservatives, secondary thickeners, stickers, gibberellins and also water, can optionally also be used. The formulations are produced either in suitable facilities or else before or during application.

The auxiliaries used may be those substances which are suitable for imparting, to the composition itself and/or to preparations derived therefrom (for example spray liquors), particular properties such as particular technical properties and/or else special biological properties. Typical auxiliaries include: extenders, solvents and carriers.

Suitable extenders are, for example, water, polar and nonpolar organic chemical liquids, for example from the classes of the aromatic and nonaromatic hydrocarbons (such as paraffins, alkylbenzenes, alkylnaphthalenes, chlorobenzenes), the alcohols and polyols (which, if appropriate, may also be substituted, etherified and/or esterified), the ketones (such as acetone, cyclohexanone), esters (including fats and oils) and (poly)ethers, the unsubstituted and substituted amines, amides, lactams (such as N-alkylpyrrolidones) and lactones, the sulfones and sulfoxides (such as dimethyl sulfoxide).

If the extender utilized is water, it is also possible to use, for example, organic solvents as auxiliary solvents. Useful liquid solvents essentially include: aromatics such as xylene, toluene or alkylnaphthalenes, chlorinated aromatics and chlorinated aliphatic hydrocarbons such as chlorobenzenes, chloroethylenes or methylene chloride, aliphatic hydrocarbons such as cyclohexane or paraffins, for example petroleum fractions, mineral and vegetable oils, alcohols such as butanol or glycol and also their ethers and esters, ketones such as acetone, methyl ethyl ketone, methyl isobutyl ketone or cyclohexanone, strongly polar solvents such as dimethyl sulfoxide, and also water.

It is possible to use colorants such as inorganic pigments, for example iron oxide, titanium oxide and Prussian blue, and organic colorants such as alizarin colorants, azo colorants and metal phthalocyanine colorants, and trace nutrients such as salts of iron, manganese, boron, copper, cobalt, molybdenum and zinc.

Suitable wetting agents which may be present in the formulations which can be used in accordance with the invention are all substances which promote wetting and which are conventionally used for the formulation of agrochemical active substances. Preference is given to using alkyl naphthalenesulfonates, such as diisopropyl or diisobutyl naphthalenesulfonates.

Suitable dispersants and/or emulsifiers which may be present in the formulations which can be used in accordance with the invention are all nonionic, anionic and cationic dispersants conventionally used for the formulation of active agrochemical ingredients. Preference is given to using nonionic or anionic dispersants or mixtures of nonionic or anionic dispersants. Suitable nonionic dispersants include in particular ethylene oxide/propylene oxide block polymers, alkylphenol polyglycol ethers and tristyrylphenol polyglycol ethers, and the phosphated or sulfated derivatives thereof. Suitable anionic dispersants are especially lignosulfonates, polyacrylic acid salts and arylsulfonate-formaldehyde condensates.

Suitable antifoams which may be present in the formulations usable in accordance with the invention are all foam-inhibiting substances conventionally used for the formulation of active agrochemical ingredients. Silicone antifoams and magnesium stearate can be used with preference.

Preservatives which may be present in the formulations usable in accordance with the invention are all substances usable for such purposes in agrochemical compositions. Examples include dichlorophene and benzyl alcohol hemiformal.

Secondary thickeners which may be present in the formulations usable in accordance with the invention are all substances usable for such purposes in agrochemical compositions. Preferred examples include cellulose derivatives, acrylic acid derivatives, xanthan, modified clays and finely divided silica.

Stickers which may be present in the formulations usable in accordance with the invention include all customary binders usable in seed-dressing products. Preferred examples include polyvinylpyrrolidone, polyvinyl acetate, polyvinyl alcohol and tylose. Suitable gibberellins which may be present in the formulations which can be used in accordance with the invention are preferably the gibberellins A1, A3 (=gibberellic acid), A4 and A7; gibberellic acid is especially preferably used. The gibberellins are known (cf. R. Wegler “Chemie der Pflanzenschutz-und Schädlingsbekämpfungsmittel” [Chemistry of Crop Protection and Pest Control Compositions], vol. 2, Springer Verlag, 1970, p. 401-412).

Further additives may be fragrances, mineral or vegetable, optionally modified oils, waxes and nutrients (including trace nutrients), such as salts of iron, manganese, boron, copper, cobalt, molybdenum and zinc. Additionally present may be stabilizers, such as cold stabilizers, antioxidants, light stabilizers or other agents which improve chemical and/or physical stability.

The formulations contain generally between 0.01 and 98% by weight, preferably between 0.5 and 90%, of the compound of the general formula (I).

The inventive compounds of the general formula (I) according to the invention may be present in commercially available formulations, and also in the use forms, prepared from these formulations, in a mixture with other active compounds, such as insecticides, attractants, sterilizing agents, bactericides, acaricides, nematicides, fungicides, growth-regulating substances, herbicides, safeners, fertilizers or semiochemicals.

In addition, the described positive effect of the compounds of the formula (I) on the plants' own defenses can be supported by an additional treatment with active insecticidal, fungicidal or bactericidal compounds.

Preferred times for the application of compounds of the general formula (I) to be used according to the invention or salts thereof for enhancing resistance to abiotic stress are treatments of the soil, stems and/or leaves with the approved application rates.

The inventive active ingredients of the general formula (I) or salts thereof may generally additionally be present in their commercial formulations, and in the use forms prepared from these formulations, in mixtures with other active ingredients, such as insecticides, attractants, sterilants, acaricides, nematicides, fungicides, bactericides, growth regulators, substances which influence plant maturity, safeners or herbicides.

The invention is to be illustrated by the biological in vivo and in vitro examples which follow, but without restricting it thereto.

### BIOLOGICAL EXAMPLES

### In Vivo Analyses—Part A

Seeds of monocotyledonous and dicotyledonous crop plants were sown in sandy loam in plastic pots, covered with soil or sand and cultivated in a greenhouse under good growth conditions. The trial plants were treated at the early leaf stage (BBCH10-BBCH13). To assure uniform water supply before commencement of stress, the potted plants were supplied with water by dam irrigation prior to substance application.

The inventive compounds formulated in the form of wettable powders (WP) were sprayed onto the green parts of the plants as an aqueous suspension at an equivalent water application rate of 600 l/ha with addition of 0.2% wetting agent (e.g. agrotin). Substance application was followed immediately by stress treatment of the plants.

Drought stress was induced by gradual drying out under the following conditions:

“Day”: 14 hours with illumination at ˜26-30° C.
“Night”: 10 hours without illumination at ˜18-20° C.

The duration of the respective stress phases was guided mainly by the condition of the stressed control plants. It was ended (by re-irrigating and transfer to a greenhouse with good growth conditions) as soon as irreversible damage was observed on the stressed control plants.

The end of the stress phase was followed by an about 4-7-day recovery phase, during which the plants were once again kept under good growth conditions in a greenhouse. The duration of the recovery phase was guided mainly by when the trial plants had attained a state which enabled visual scoring of potential effects, and was therefore variable.

Once this juncture had been reached, the appearance of the plants treated with test substances was recorded in comparison to the stressed control plants by the following categories:

| | |
|---|---|
| 0 | no effect |
| 10 | slight positive effect |
| 20 | clear positive effect |
| 30 | strong positive effect |

In order to rule out any influence on the effects observed by any fungicidal or insecticidal action of the test compounds, it was additionally ensured that the tests proceeded without fungal infection or insect infestation.

In each test, for each crop and dosage, plants in 3 pots were treated and evaluated separately. The values reported in Tables A-1 to A-2 below for the effects obtained are averages from the scores obtained.

Effects of selected compounds of the general formula (I) under drought stress:

TABLE A-1

| No. | Substance | Dosage | Unit | Effect (BRSNS) |
|---|---|---|---|---|
| 1 | A19-158 | 250 | g/ha | 20 |
| 2 | A19-178 | 250 | g/ha | 20 |

TABLE A-2

| No. | Substance | Dosage | Unit | Effect (TRZAS) |
|---|---|---|---|---|
| 1 | A19-152 | 25 | g/ha | 20 |
| 2 | A19-158 | 250 | g/ha | 20-30 |
| 3 | A19-158 | 25 | g/ha | 20-30 |
| 4 | A19-182 | 250 | g/ha | 20-30 |
| 5 | A19-182 | 25 | g/ha | 20 |
| 6 | B2-45 | 25 | g/ha | 20 |
| 7 | B2-165 | 25 | g/ha | 20 |
| 8 | B2-291 | 250 | g/ha | 30 |
| 9 | B2-291 | 25 | g/ha | 20 |

### In Vivo Analyses—Part B

Seeds of monocotyledonous and dicotyledonous crop plants were sown in sandy loam in plastic pots, covered with soil or sand and cultivated in a greenhouse under good growth conditions. The trial plants were treated at the early leaf stage (BBCH10-BBCH13). To assure uniform water supply before commencement of stress, the potted plants were supplied with water by dam irrigation prior to substance application.

The inventive compounds formulated in the form of wettable powders (WP) were sprayed onto the green parts of the plants as an aqueous suspension at an equivalent water application rate of 600 l/ha with addition of 0.2% wetting agent (e.g. agrotin). Substance application was followed immediately by stress treatment of the plants.

Drought stress was induced by gradual drying out under the following conditions:

“Day”: 14 hours with illumination at 26-30° C.
“Night”: 10 hours without illumination at 18-20° C.

The duration of the respective stress phases was guided mainly by the condition of the stressed control plants. It was ended (by re-irrigating and transfer to a greenhouse with good growth conditions) as soon as irreversible damage was observed on the stressed control plants.

The end of the stress phase was followed by an about 4-7-day recovery phase, during which the plants were once again kept under good growth conditions in a greenhouse. The duration of the recovery phase was guided mainly by when the trial plants had attained a state which enabled visual scoring of potential effects, and is therefore variable.

Once this juncture had been reached, the appearance of the plants treated with test substances was recorded in comparison to the stressed control plants by the following categories:

| | |
|---|---|
| 0 | no positive effect |
| 10 | slight positive effect |
| 20 | clear positive effect |
| 30 | strong positive effect |

For each substance and dosage, 2-3 pots were treated and evaluated. The respective efficacy ranges are reported in Tables B-1 and B-2 below.

TABLE B-1

| No. | Substance | Dosage | Unit | Effect (BRSNS) |
|---|---|---|---|---|
| 1 | A16-172 | 25 | g/ha | 20 |
| 2 | A19-164 | 2.5 | g/ha | 20 |

TABLE B-2

| No. | Substance | Dosage | Unit | Effect (TRZAS) |
|---|---|---|---|---|
| 1 | A1-158 | 250 | g/ha | 10-20 |
| 2 | A16-172 | 25 | g/ha | 10-20 |
| 3 | A19-181 | 250 | g/ha | 10-20 |
| 4 | A19-357 | 250 | g/ha | 10-20 |

### In Vivo Analyses—Part C

Seeds of monocotyledonous and dicotyledonous crop plants were sown in sandy loam in plastic or wood-fiber pots, covered with soil or sand and cultivated in a greenhouse under good growth conditions. The trial plants were treated at the early leaf stage (BBCH10-BBCH13). To assure uniform water supply before commencement of stress, the potted plants were supplied with water by dam irrigation prior to substance application.

The inventive compounds were first formulated as wettable powders (WP) or dissolved in a solvent mixture. The further dilution was effected with water supplemented with 0.2% wetting agent (e.g. agrotin). The finished spray liquor was sprayed onto the green parts of the plant at an equivalent water application rate of 600 l/ha. Substance application was followed immediately by stress treatment of the plants. For this purpose, the wood-fiber pots were transferred in plastic inserts in order to prevent them from subsequently drying out too quickly.

Drought stress was induced by gradual drying out under the following conditions:

“Day”: 14 hours with illumination at 26-30° C.
“Night”: 10 hours without illumination at 18-20° C.

The duration of the respective stress phases was guided mainly by the condition of the stressed control plants. It was ended (by re-irrigating and transfer to a greenhouse with good growth conditions) as soon as irreversible damage was observed on the stressed control plants. The end of the stress phase was followed by an about 4-7-day recovery phase, during which the plants were once again kept under good growth conditions in a greenhouse. The duration of the recovery phase was guided mainly by when the trial plants had attained a state which enabled visual scoring of potential effects, and was therefore variable.

Once this juncture had been reached, the appearance of the plants treated with test substances was recorded in comparison to the stressed control plants by the following categories:

| | |
|---|---|
| 0 | no positive effect |
| 10 | slight positive effect |
| 20 | clear positive effect |
| 30 | strong positive effect |

For each substance and dosage, 3-4 pots were treated and evaluated. The respective efficacy ranges are reported in Tables C-1 and C-2 below.

TABLE C-1

| No. | Substance | Dosage | Unit | Effect (BRSNS) |
|---|---|---|---|---|
| 1 | A49-178 | 250 | g/ha | 20 |
| 2 | A51-158 | 25 | g/ha | 20-30 |

TABLE C-2

| No. | Substance | Dosage | Unit | Effect (TRZAS) |
|---|---|---|---|---|
| 1 | A38-165 | 250 | g/ha | 10-30 |
| 2 | A42-152 | 25 | g/ha | 10-20 |
| 3 | A46-178 | 25 | g/ha | 20-30 |
| 4 | A50-152 | 250 | g/ha | 10-20 |
| 5 | A50-173 | 25 | g/ha | 10-20 |
| 6 | A50-175 | 25 | g/ha | 10-20 |
| 7 | A50-182 | 250 | g/ha | 10-20 |
| 8 | A51-172 | 250 | g/ha | 10-20 |
| 9 | B50-165 | 250 | g/ha | 10-20 |
| 10 | B51-152 | 250 | g/ha | 10-20 |
| 11 | B51-172 | 25 | g/ha | 10-20 |
| 12 | B52-181 | 250 | g/ha | 10-20 |
| 13 | F3-158 | 25 | g/ha | 10-20 |
| 14 | F3-166 | 250 | g/ha | 10-20 |
| 15 | F7-151 | 25 | g/ha | 10-20 |
| 16 | F7-158 | 250 | g/ha | 10-20 |
| 17 | F7-165 | 25 | g/ha | 10-20 |
| 18 | F7-166 | 250 | g/ha | 10-20 |
| 19 | I5-166 | 250 | g/ha | 10-20 |
| 20 | I5-178 | 250 | g/ha | 10-30 |
| 21 | J3-165 | 250 | g/ha | 10-20 |

### In Vivo Analyses—Part D

Wheat grains were sown in a standardized number in sandy loam soil plastic pots, covered with soil or sand and grown in a greenhouse under good growth conditions. Pots with uneven degrees of emergence were excluded prior to the start of the trial. The treatment with test substances was effected at the early leaf stage (BBCH10-BBCH13). To assure uniform water supply, the potted plants were supplied with water by dam irrigation prior to substance application.

The inventive compounds were first formulated as wettable powders (WP) or dissolved in a solvent mixture. The further dilution was effected with water supplemented with 0.2% wetting agent (e.g. agrotin). The finished spray liquor was sprayed onto the green parts of the plant at an equivalent water application rate of 600 l/ha. Substance application was followed immediately by stress treatment of the plants.

Drought stress was induced by gradual drying out under the following conditions:

“Day”: 14 hours with illumination at 26-30° C.
“Night”: 10 hours without illumination at 18-20° C.

The duration of the respective stress phases was guided mainly by the condition of the stressed control plants. It was ended (by re-irrigating and transfer to a greenhouse with good growth conditions) as soon as irreversible damage was observed on the stressed control plants.

The end of the stress phase was followed by an about 7-day recovery phase, during which the plants were once again kept under good growth conditions in a greenhouse. The exact duration of the recovery phase was variable for reasons related to the trial.

At the end of the recovery phase, the fresh weights of the plant parts above ground were determined.

By comparison with unstressed control plants which were kept under good growth conditions over the entire duration of the trial, percentage damage intensities were first calculated from the fresh weight values.

The reduction in damage intensity resulting from treatment with test substance was then calculated by the following formula:

$$EF = \frac{( {DI}_{s} - {DI}_{t} ) \times 100}{{DI}_{s}}$$

### EF: Efficacy

DIₛ: Damage intensity of the stressed control plants
DIₜ: Damage intensity of the stressed plants treated with test compound

The values reported in table D-1 below are results from at least three repeats.

TABLE D-1

| No. | Substance | Dosage | Unit | EF [%] (TRZAS) |
|---|---|---|---|---|
| 1 | A48-166 | 250 | g/ha | 13 |
| 2 | A50-177 | 250 | g/ha | 19 |
| 3 | A51-153 | 250 | g/ha | 16 |
| 4 | A51-158 | 25 | g/ha | 11 |
| 5 | A51-165 | 25 | g/ha | 18 |
| 6 | A51-166 | 250 | g/ha | 20 |
| 7 | A51-178 | 25 | g/ha | 10 |
| 8 | A51-181 | 250 | g/ha | 15 |
| 9 | B50-158 | 250 | g/ha | 18 |
| 10 | B50-168 | 250 | g/ha | 14 |
| 11 | B50-175 | 25 | g/ha | 12 |
| 12 | B50-178 | 250 | g/ha | 20 |
| 13 | B50-179 | 250 | g/ha | 15 |
| 14 | B51-152 | 250 | g/ha | 16 |
| 15 | B51-158 | 25 | g/ha | 13 |
| 16 | B51-173 | 25 | g/ha | 16 |
| 17 | B52-158 | 25 | g/ha | 10 |
| 18 | B52-166 | 250 | g/ha | 14 |
| 19 | B52-172 | 250 | g/ha | 14 |
| 20 | B52-173 | 25 | g/ha | 14 |
| 21 | B52-175 | 250 | g/ha | 10 |
| 22 | B52-181 | 250 | g/ha | 14 |

In the above tables:

BRSNS=Brassica napus
TRZAS=Triticum aestivum

### In Vitro Analyses

Effects of the phytohormone abscisic acid (ABA) on the behavior of plants under abiotic stress and the mechanism of action of ABA are described in the literature (cf. Abrams et al., WO97/23441, Park et al. Science, 2009, 324, 1068; Grill et al. Science, 2009, 324, 1064; Tanokura et al. Biophysics, 2011, 7, 123; Schroeder et al. Plant J. 2010, 61, 290). Therefore, it is possible with the aid of a suitable in vitro test system to derive a correlation between the action of ABA and the stress response of a plant under abiotic stress. In the event of water deficiency (drought stress), plants form the phytohormone abscisic acid (ABA). This binds, along with a co-regulator (Regulatory Component of ABA-Receptor=RCAR according to Grill et al. Science, 2009, 324, 1064 or PYR/PYL according to Cutler et al. Science, 2009, 324, 1068), to a phosphatase (e.g. ABI1, a type 2C protein phosphatase, also abbreviated to PP2C) and inhibits its activity. As a result, a “downstream” kinase (e.g. SnRK2) is no longer dephosphorylated. This kinase, which is thus active, via phosphorylation of transcription factors (e.g. AREB/ABF, cf. Yoshida et al., 2010, 61, 672), switches on a genetic protection program to increase drought stress tolerance. The assay described hereinafter utilizes the inhibition of the phosphatase ABI1 via the co-regulator RCAR11/PYR1 aus Arabidopsis thaliana. For the determination of activity, the dephosphorylation of 4-methylumbelliferyl phosphate (MUP) was measured at 460 nm. The in vitro assay was conducted in Greiner 384-well PS microplates F-well, using two controls: a) 0.5% dimethyl sulfoxide (DMSO) and b) 5 μM abscisic acid (ABA). The assay described here was generally conducted with substance concentrations of the appropriate chemical test substances in a concentration range of 0.1 μM to 100 μM in a solution of DMSO and water. The substance solution thus obtained, if necessary, was stirred with esterase from porcine liver (EC 3.1.1.1) at room temperature for 3 h and centrifuged at 4000 rpm for 30 min. A total volume of 45 μl was introduced into each cavity of the microplate, having the following composition:
1) 5 μl of substance solution, i.e. a) DMSO 5% or b) abscisic acid solution or c) the corresponding example compound of the general formula (I) dissolved in 5% DMSO.
2) 20 μl of enzyme buffer mix, composed of a) 40% by vol. of enzyme buffer (10 mL contain equal proportions by volume of 500 mM Tris-HCl pH 8, 500 mM NaCl, 3.33 mM MnCl₂, 40 mM dithiothreitol (DTT)), b) 4% by vol. of ABI1 dilution (protein stock solution was diluted so as to give, after addition, a final concentration in the assay of 0.15 μg ABI1/well), c) 4% by vol. of RCAR11 dilution (enzyme stock was diluted so as to give, on addition of the dilution to the enzyme buffer mix, a final concentration in the assay of 0.30 μg enzyme/well), d) 5% by vol. of Tween20 (1%), e) 47% by vol. H₂O bi-dist.
3) 20 μl of substrate mix, composed of a) 10% by vol. of 500 mM Tris-HCl pH8, b) 10% by vol. of 500 mM NaCl, c) 10% by vol. of 3.33 mM MnCl₂, d) 5% by vol. of 25 mM MUP, 5% by vol. of Tween20 (1%), 60% by vol. of H₂O bi-dist.

Enzyme buffer mix and substrate mix were made up 5 minutes prior to the addition and warmed to a temperature of 35° C. On completion of pipetting of all the solutions and on completion of mixing, the plate was incubated at 35° C. for 20 minutes. Finally, a relative fluorescence measurement was made at 35° C. with a BMG Labtech “POLARstar Optima” microplate reader using a 340/10 nm excitation filter and a 460 nm emission filter. The efficacy of the compounds of the general formula (I) is reported in the table which follows using abscisic acid (5 mM) as comparative substance (No. 37) according to the following classification: ++++ (inhibition≧90%), +++ (90%>inhibition≧70%), ++ (70%>inhibition≧50%), + (50%>inhibition≧30%).

Effects of selected compounds of the general formula (I) in the above-described in vitro assay at a concentration of 5 mM of the substance of the general formula (I) in question in a solution of DMSO and water:

TABLE E-1

| No. | Substance | ABI1 inhibition |
|---|---|---|
| 1 | A1-152 | ++++ |
| 2 | A1-158 | +++ |
| 3 | A1-165 | ++++ |
| 4 | A1-166 | ++ |
| 5 | A1-172 | ++++ |
| 6 | A1-173 | ++ |
| 7 | A1-175 | +++ |
| 8 | A1-178 | ++++ |
| 9 | A1-181 | ++++ |
| 10 | A1-181 | ++++ |
| 11 | A2-151 | ++++ |
| 12 | A2-152 | ++++ |
| 13 | A2-153 | +++ |
| 14 | A2-158 | ++++ |
| 15 | A2-165 | ++++ |
| 16 | A2-166 | +++ |
| 17 | A2-168 | ++ |
| 18 | A2-172 | ++++ |
| 19 | A2-173 | +++ |
| 20 | A2-175 | ++++ |
| 21 | A2-176 | +++ |
| 22 | A2-177 | +++ |
| 23 | A2-178 | ++++ |
| 24 | A2-179 | +++ |
| 25 | A2-181 | ++++ |
| 26 | A7-152 | ++++ |
| 27 | A7-165 | ++++ |
| 28 | A7-181 | ++++ |
| 29 | A7-182 | ++ |
| 30 | A10-152 | ++++ |
| 31 | A10-165 | ++++ |
| 32 | A10-181 | ++++ |
| 33 | A16-152 | ++ |
| 34 | A16-178 | ++ |
| 35 | A19-152 | ++++ |
| 36 | A19-153 | +++ |
| 37 | A19-158 | ++++ |
| 38 | A19-164 | +++ |
| 39 | A19-165 | ++++ |
| 40 | A19-175 | ++++ |
| 41 | A19-178 | ++++ |
| 42 | A19-181 | ++++ |
| 43 | A19-182 | ++ |
| 44 | A19-325 | ++++ |
| 45 | A19-332 | ++++ |
| 46 | A19-357 | ++++ |
| 47 | A19-601 | +++ |
| 48 | A21-152 | ++++ |
| 49 | A21-158 | ++++ |
| 50 | A21-159 | ++++ |
| 51 | A21-165 | ++++ |
| 52 | A21-178 | +++ |
| 53 | A21-181 | ++++ |
| 54 | A21-325 | ++++ |
| 55 | A21-332 | ++++ |
| 56 | A21-601 | ++++ |
| 57 | A22-152 | +++ |
| 58 | A22-165 | +++ |
| 59 | A22-181 | +++ |
| 60 | A29-158 | ++ |
| 61 | A32-152 | ++ |
| 62 | A32-158 | + |
| 63 | A32-165 | ++ |
| 64 | A32-178 | ++ |
| 65 | A32-181 | +++ |
| 66 | A38-152 | ++++ |
| 67 | A38-165 | ++++ |
| 68 | A38-166 | +++ |
| 69 | A38-178 | ++++ |
| 70 | A39-152 | ++++ |
| 71 | A39-158 | + |
| 72 | A39-165 | +++ |
| 73 | A39-181 | +++ |
| 74 | A42-152 | +++ |
| 75 | A47-165 | ++++ |
| 76 | A48-152 | ++++ |
| 77 | A48-165 | ++++ |
| 78 | A48-166 | ++ |
| 79 | A48-181 | ++++ |
| 80 | A49-165 | ++++ |
| 81 | A49-178 | ++++ |
| 82 | A50-151 | ++ |
| 83 | A50-152 | ++++ |
| 84 | A50-153 | ++ |
| 85 | A50-158 | +++ |
| 86 | A50-161 | +++ |
| 87 | A50-165 | ++++ |
| 88 | A50-166 | ++ |
| 89 | A50-172 | ++++ |
| 90 | A50-175 | +++ |
| 91 | A50-177 | ++ |
| 92 | A50-181 | +++ |
| 93 | A50-291 | ++ |
| 95 | A51-151 | +++ |
| 96 | A51-152 | ++++ |
| 97 | A51-153 | ++ |
| 98 | A51-158 | +++ |
| 99 | A51-161 | +++ |
| 100 | A51-165 | ++++ |
| 101 | A51-166 | ++ |
| 102 | A51-168 | ++++ |
| 103 | A51-172 | ++++ |
| 104 | A51-173 | ++ |
| 105 | A51-175 | +++ |
| 106 | A51-177 | ++ |
| 107 | A51-178 | ++++ |
| 108 | A51-179 | ++ |
| 109 | A51-181 | ++++ |
| 110 | B16-165 | +++ |
| 111 | J3-50 | + |
| 112 | abscisic acid | ++++ |

Similar results were also achievable with further compounds of the general formula (I), even on application to different plant species.

1. A method of using one or more substituted oxotetrahydroquinolinylsulfonamides of formula (I) and/or one or more salts thereof 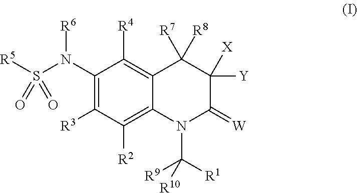
for increasing stress tolerance in plants to abiotic stress and/or for increasing plant yield, in which
R¹ is halogen, cyano, (C₃-C₁₀)-cycloalkyl, (C₃-C₁₀)-halocycloalkyl, (C₄-C₁₀)-cycloalkenyl, (C₄-C₁₀)-halocycloalkenyl, (C₁-C₁₀)-haloalkyl, (C₂-C₈)-haloalkenyl, (C₁-C₈)-alkoxy-(C₁-C₈)-haloalkyl, aryl, aryl-(C₁-C₈)-alkyl, heteroaryl, heteroaryl-(C₁-C₈)-alkyl, (C₃-C₈)-cycloalkyl-(C₁-C₈)-alkyl, (C₂-C₈)-haloalkynyl, heterocyclyl, heterocyclyl-(C₁-C₈)-alkyl, (C₁-C₈)-alkoxy-(C₁-C₈)-alkyl, (C₁-C₈)-alkylcarbonyl-(C₁-C₈)-alkyl, hydroxycarbonyl-(C₁-C₈)-alkyl, (C₁-C₈)-alkoxycarbonyl-(C₁-C₈)-alkyl, (C₂-C₈)-alkenyloxycarbonyl-(C₁-C₈)-alkyl, (C₂-C₈)-alkynyloxycarbonyl-(C₁-C₈)-alkyl, aryl-(C₁-C₈)-alkoxycarbonyl-(C₁-C₈)-alkyl, (C₃-C₈)-cycloalkoxycarbonyl-(C₁-C₈)-alkyl, (C₃-C₈)-cycloalkyl-(C₁-C₈)-alkoxycarbonyl-(C₁-C₈)-alkyl, aminocarbonyl-(C₁-C₈)-alkyl, (C₁-C₈)-alkylaminocarbonyl-(C₁-C₈)-alkyl, (C₃-C₈)-cycloalkylaminocarbonyl-(C₁-C₈)-alkyl, aryl-(C₁-C₈)-alkylaminocarbonyl-(C₁-C₈)-alkyl, heteroaryl-(C₁-C₈)-alkylaminocarbonyl-(C₁-C₈)-alkyl, (C₁-C₈)-alkylthio-(C₁-C₈)-alkyl, (C₃-C₈)-cycloalkylthio-(C₁-C₈)-alkyl, arylthio-(C₁-C₈)-alkyl, heterocyclylthio-(C₁-C₈)-alkyl, heteroarylthio-(C₁-C₈)-alkyl, aryl-(C₁-C₈)-alkylthio-(C₁-C₈)-alkyl, (C₁-C₈)-alkylsulfinyl-(C₁-C₈)-alkyl, (C₁-C₈)-alkylsulfonyl-(C₁-C₈)-alkyl, arylsulfinyl-(C₁-C₈)-alkyl, arylsulfonyl-(C₁-C₈)-alkyl, (C₃-C₈)-cycloalkylsulfinyl-(C₁-C₈)-alkyl, (C₃-C₈)-cycloalkylsulfonyl-(C₁-C₈)-alkyl, (C₁-C₈)-alkoxy-(C₁-C₈)-alkoxy-(C₁-C₈)-alkyl, (C₁-C₈)-alkylcarbonyl, (C₁-C₈)-haloalkylcarbonyl, (C₃-C₈)-cycloalkylcarbonyl, hydroxycarbonyl, (C₁-C₈)-alkoxycarbonyl, (C₂-C₈)-alkenyloxycarbonyl, (C₂-C₈)-alkynyloxycarbonyl, aryl-(C₁-C₈)-alkoxycarbonyl, (C₃-C₈)-cycloalkyl-(C₁-C₈)-alkoxycarbonyl, arylcarbonyl, heteroarylcarbonyl, heterocyclylcarbonyl, aryl-(C₁-C₈)-alkylcarbonyl, (C₁-C₈)-alkylaminocarbonyl, (C₃-C₈)-cycloalkylaminocarbonyl, arylaminocarbonyl, aryl-(C₁-C₈)-alkylaminocarbonyl, heteroarylaminocarbonyl, heterocyclylaminocarbonyl, heteroaryl-(C₁-C₈)-alkylaminocarbonyl, heterocyclyl-(C₁-C₈)-alkylaminocarbonyl, (C₁-C₈)-alkylsulfonyl, (C₃-C₈)-cycloalkylsulfonyl, arylsulfonyl, aryl-(C₁-C₈)-alkylsulfonyl, heteroarylsulfonyl, heterocyclylsulfonyl, cyano-(C₁-C₈)-alkyl, (C₄-C₈)-cycloalkenyl-(C₁-C₈)-alkyl, nitro-(C₁-C₈)-alkyl, (C₁-C₈)-haloalkoxy-(C₁-C₈)-alkyl, (C₁-C₈)-haloalkylthio-(C₁-C₈)-alkyl, bis-[(C₁-C₈)-alkyl]aminocarbonyl, (C₃-C₈)-cycloalkyl-[(C₁-C₈)-alkyl]aminocarbonyl, aryl-[(C₁-C₈)-alkyl]aminocarbonyl, aryl-(C₁-C₈)-alkyl-[(C₁-C₈)-alkyl]aminocarbonyl, (C₂-C₈)-alkenylaminocarbonyl, (C₂-C₈)-alkynylaminocarbonyl, (C₁-C₈)-alkylaminosulfonyl, bis-[(C₁-C₈)-alkyl]aminosulfonyl, heterocyclylsulfinyl-(C₁-C₈)-alkyl, heteroarylsulfinyl-(C₁-C₈)-alkyl, aryl-(C₁-C₈)-alkylsulfinyl-(C₁-C₈)-alkyl, heterocyclylsulfonyl-(C₁-C₈)-alkyl, heteroarylsulfonyl-(C₁-C₈)-alkyl, aryl-(C₁-C₈)-alkylsulfonyl-(C₁-C₈)-alkyl, bis-[(C₁-C₈)-alkyl]aminocarbonyl-(C₁-C₈)-alkyl, (C₃-C₈)-cycloalkyl-[(C₁-C₈)-alkyl]aminocarbonyl-(C₁-C₈)-alkyl, aryl-[(C₁-C₈)-alkyl]aminocarbonyl-(C₁-C₈)-alkyl, aryl-(C₁-C₈)-alkyl-[(C₁-C₈)-alkyl]aminocarbonyl-(C₁-C₈)-alkyl, (C₂-C₈)-alkenylaminocarbonyl-(C₁-C₈)-alkyl, (C₂-C₈)-alkynylaminocarbonyl-(C₁-C₈)-alkyl, (C₁-C₈)-alkylamino, bis-[(C₁-C₈)-alkyl]amino, (C₃-C₈)-cycloalkyl[(C₁-C₈)-alkyl]amino, amino, (C₂-C₈)-alkenylamino, (C₂-C₈)-alkynylamino, arylamino, heteroarylamino, aryl-(C₁-C₈)-alkylamino, heteroaryl-(C₁-C₈)-alkylamino, heterocyclylamino, heterocyclyl-(C₁-C₈)-alkylamino, (C₂-C₈)-alkenylcarbonyl-(C₁-C₈)-alkyl, (C₂-C₈)-alkynylcarbonyl-(C₁-C₈)-alkyl, (C₃-C₈)-cycloalkyl-(C₁-C₈)-alkylaminocarbonyl-(C₁-C₈)-alkyl, (C₃-C₈)-cycloalkyl-(C₁-C₈)-alkyl-[(C₁-C₈)-alkyl]aminocarbonyl-(C₁-C₈)-alkyl, (C₂-C₈)-alkenylsulfonyl-(C₁-C₈)-alkyl, (C₂-C₈)-alkynylsulfonyl-(C₁-C₈)-alkyl, heteroaryl-(C₁-C₈)-alkylsulfonyl-(C₁-C₈)-alkyl, heterocyclyl-(C₁-C₈)-alkylsulfonyl-(C₁-C₈)-alkyl, (C₂-C₈)-alkenylsulfinyl-(C₁-C₈)-alkyl, (C₂-C₈)-alkynylsulfinyl-(C₁-C₈)-alkyl, heteroaryl-(C₁-C₈)-alkylsulfinyl-(C₁-C₈)-alkyl, heterocyclyl-(C₁-C₈)-alkylsulfinyl-(C₁-C₈)-alkyl, (C₂-C₈)-alkenyloxy-(C₁-C₈)-alkoxy-(C₁-C₈)-alkyl, (C₂-C₈)-alkynyloxy-(C₁-C₈)-alkoxy-(C₁-C₈)-alkyl, heteroaryl-(C₁-C₈)-alkoxy-(C₁-C₈)-alkyl, heterocyclyl-(C₁-C₈)-alkoxy-(C₁-C₈)-alkyl, tris[(C₁-C₈)-alkyl]silyl, tris[(C₁-C₈)-alkyl]silyl-(C₁-C₈)-alkyl, (C₁-C₈)-alkoxy, (C₁-C₈)-haloalkoxy, (C₁-C₈)-alkylamino-(C₁-C₈)-alkyl, bis-[(C₁-C₈)-alkyl]amino-(C₁-C₈)-alkyl, (C₃-C₈)-cycloalkyl[(C₁-C₈)-alkyl]amino-(C₁-C₈)-alkyl, amino-(C₁-C₈)-alkyl, (C₂-C₈)-alkenylamino-(C₁-C₈)-alkyl, (C₂-C₈)-alkynylamino-(C₁-C₈)-alkyl, arylamino-(C₁-C₈)-alkyl, heteroarylamino-(C₁-C₈)-alkyl, aryl-(C₁-C₈)-alkylamino-(C₁-C₈)-alkyl, heteroaryl-(C₁-C₈)-alkylamino-(C₁-C₈)-alkyl, heterocyclylamino-(C₁-C₈)-alkyl, heterocyclyl-(C₁-C₈)-alkylamino-(C₁-C₈)-alkyl, (C₁-C₈)-haloalkoxy-(C₁-C₆)-haloalkyl, (C₂-C₈)-alkenyloxy-(C₁-C₆)-haloalkyl, (C₂-C₈)-alkynyloxy-(C₁-C₆)-haloalkyl, (C₁-C₈)-alkoxy-(C₁-C₈)-alkoxy-(C₁-C₆)-haloalkyl, (C₃-C₈)-cycloalkyl-(C₁-C₈)-alkoxy-(C₁-C₆)-haloalkyl, (C₃-C₈)-cycloalkyl-(C₁-C₈)-alkoxy-(C₁-C₈)-alkyl, (C₁-C₈)-alkoxy-(C₁-C₈)-alkoxy, (C₁-C₈)-alkoxycarbonyl-(C₃-C₈)-cycloalkyl,
R², R³, R⁴ are each independently hydrogen, halogen, (C₁-C₈)-alkoxy, (C₁-C₈)-alkyl, (C₁-C₈)-haloalkyl, (C₁-C₈)-haloalkoxy, (C₁-C₈)-alkylthio, (C₁-C₈)-haloalkylthio, aryl, aryl-(C₁-C₈)-alkyl, heteroaryl, heteroaryl-(C₁-C₈)-alkyl, heterocyclyl, heterocyclyl-(C₁-C₈)-alkyl, (C₃-C₈)-cycloalkyl, nitro, amino, hydroxyl, (C₁-C₈)-alkylamino, bis-[(C₁-C₈)-alkyl]amino, hydrothio, (C₁-C₈)-alkylcarbonylamino, (C₃-C₈)-cycloalkylcarbonylamino, arylcarbonylamino, heteroarylcarbonylamino, heterocyclylcarbonylamino, formyl, hydroxyiminomethyl, (C₁-C₈)-alkoxyiminomethyl, (C₃-C₈)-cycloalkoxyiminomethyl, aryloxyiminomethyl, (C₃-C₈)-cycloalkyl-(C₁-C₈)-alkoxyiminomethyl, thiocyanato, isothiocyanato, aryloxy, heteroaryloxy, (C₃-C₈)-cycloalkoxy, (C₃-C₈)-cycloalkyl-(C₁-C₈)-alkoxy, aryl-(C₁-C₈)-alkoxy, (C₂-C₈)-alkynyl, (C₂-C₈)-alkenyl, aryl-(C₁-C₈)-alkynyl, tris-[(C₁-C₈)-alkyl]silyl-(C₂-C₈)-alkynyl, bis-[(C₁-C₈)-alkyl](aryl)silyl-(C₂-C₈)-alkynyl, bis-aryl[(C₁-C₈)-alkyl]silyl-(C₂-C₈)-alkynyl, (C₃-C₈)-cycloalkyl-(C₂-C₈)-alkynyl, aryl-(C₂-C₈)-alkenyl, heteroaryl-(C₂-C₈)-alkenyl, (C₃-C₈)-cycloalkyl-(C₂-C₈)-alkenyl, (C₃-C₈)-cycloalkyl-(C₂-C₈)-alkyl, (C₂-C₈)-haloalkynyl, (C₂-C₈)-haloalkenyl, (C₄-C₈)-cycloalkenyl, (C₁-C₈)-alkoxy-(C₁-C₈)-alkoxy-(C₁-C₈)-alkyl, (C₁-C₈)-alkylsulfonyl, arylsulfonyl, heteroarylsulfonyl, (C₁-C₈)-alkylsulfonylamino, arylsulfonylamino, aryl-(C₁-C₈)-alkylsulfonylamino, heteroarylsulfonylamino, heteroaryl-(C₁-C₈)-alkylsulfonylamino, bis-[(C₁-C₈)-alkyl]aminosulfonyl, (C₄-C₈)-cycloalkenyl-(C₁-C₈)-alkyl, (C₁-C₈)-alkylsulfinyl, arylsulfinyl, heteroarylsulfinyl, (C₁-C₈)-haloalkylsulfinyl, (C₁-C₈)-haloalkylsulfonyl, aryl-(C₁-C₈)-alkylsulfonyl, heteroaryl-(C₁-C₈)-alkylsulfonyl, (C₁-C₈)-alkylaminosulfonyl, (C₁-C₈)-alkylaminosulfonylamino, bis-[(C₁-C₈)-alkyl]aminosulfonyl, (C₃-C₈)-cycloalkylaminosulfonylamino, (C₁-C₈)-alkoxycarbonyl, (C₂-C₈)-alkenyloxycarbonyl, (C₂-C₈)-alkynyloxycarbonyl, (C₃-C₈)-cycloalkyloxycarbonyl, aryl-(C₁-C₈)-alkoxycarbonyl, (C₁-C₈)-alkylaminocarbonyl, (C₃-C₈)-cycloalkylaminocarbonyl, aryl-(C₁-C₈)-alkylaminocarbonyl,
R⁵ is amino, (C₁-C₈)-alkyl, (C₃-C₈)-cycloalkyl, (C₃-C₈)-cycloalkyl-(C₁-C₈)-alkyl, (C₁-C₈)-haloalkyl, (C₃-C₈)-halocycloalkyl, (C₄-C₈)-cycloalkenyl, aryl, heteroaryl, heterocyclyl, aryl-(C₁-C₈)-alkyl, heteroaryl-(C₁-C₈)-alkyl, heterocyclyl-(C₁-C₈)-alkyl, (C₁-C₈)-alkoxycarbonyl-(C₁-C₈)-alkyl, aryl-(C₁-C₈)-alkoxycarbonyl-(C₁-C₈)-alkyl, (C₃-C₈)-cycloalkoxycarbonyl-(C₁-C₈)-alkyl, (C₃-C₈)-cycloalkyl-(C₁-C₈)-alkoxycarbonyl-(C₁-C₈)-alkyl, heteroaryl-(C₁-C₈)-alkoxycarbonyl-(C₁-C₈)-alkyl, aminocarbonyl-(C₁-C₈)-alkyl, (C₁-C₈)-alkylaminocarbonyl-(C₁-C₈)-alkyl, (C₃-C₈)-cycloalkylaminocarbonyl-(C₁-C₈)-alkyl, aryl-(C₁-C₈)-alkylaminocarbonyl-(C₁-C₈)-alkyl, (C₁-C₈)-alkylamino, arylamino, (C₃-C₈)-cycloalkylamino, aryl-(C₁-C₈)-alkylamino, heteroaryl-(C₁-C₈)-alkylamino, heteroarylamino, heterocyclylamino, aryloxy-(C₁-C₈)-alkyl, (C₁-C₈)-alkoxy-(C₁-C₈)-alkyl, heteroaryloxy-(C₁-C₈)-alkyl, (C₂-C₈)-alkenyl, (C₂-C₈)-alkynyl, (C₂-C₈)-alkenylamino, (C₂-C₈)-alkynylamino, bis-[(C₁-C₈)-alkenyl]amino, aryloxy, bis-[(C₁-C₈)-alkyl]amino, aryl-(C₂-C₈)-alkenyl, heteroaryl-(C₂-C₈)-alkenyl, heterocyclyl-(C₂-C₈)-alkenyl, aryloxycarbonyl-(C₁-C₈)-alkyl, heteroaryloxycarbonyl-(C₁-C₈)-alkyl, bis[(C₁-C₈)-alkyl]aminocarbonyl-(C₁-C₈)-alkyl, (C₁-C₈)-alkylthio-(C₁-C₈)-alkyl, cyano-(C₁-C₈)-alkyl, (C₁-C₈)-alkoxy-(C₁-C₈)-alkoxy-(C₁-C₈)-alkyl, (C₁-C₈)-alkylsulfonylamino-(C₁-C₈)-alkyl, (C₃-C₈)-cycloalkylsulfonylamino-(C₁-C₈)-alkyl, arylsulfonylamino-(C₁-C₈)-alkyl, heteroarylsulfonylamino-(C₁-C₈)-alkyl, heterocyclylsulfonylamino-(C₁-C₈)-alkyl, bis-[(C₁-C₈)-alkyl]aminosulfonyl-(C₁-C₈)-alkyl,
R⁶ is hydrogen, (C₁-C₈)-alkyl, (C₃-C₈)-cycloalkyl, cyano-(C₁-C₈)-alkyl, (C₃-C₈)-cycloalkyl-(C₁-C₈)-alkyl, (C₁-C₈)-alkylsulfonyl, arylsulfonyl, heteroarylsulfonyl, (C₃-C₈)-cycloalkylsulfonyl, heterocyclylsulfonyl, aryl-(C₁-C₈)-alkylsulfonyl, (C₁-C₈)-alkylcarbonyl, arylcarbonyl, heteroarylcarbonyl, (C₃-C₈)-cycloalkylcarbonyl, heterocyclylcarbonyl, (C₁-C₈)-alkoxycarbonyl, aryl-(C₁-C₈)-alkoxycarbonyl, (C₁-C₈)-haloalkylcarbonyl, (C₂-C₈)-alkenyl, (C₂-C₈)-alkynyl, (C₁-C₈)-haloalkyl, halo-(C₂-C₈)-alkynyl, halo-(C₂-C₈)-alkenyl, (C₁-C₈)-alkoxy-(C₁-C₈)-alkyl, amino, (C₁-C₈)-alkoxy-(C₁-C₈)-alkoxy-(C₁-C₈)-alkyl, heteroaryl-(C₁-C₈)-alkylsulfonyl, heterocyclyl-(C₁-C₈)-alkylsulfonyl, (C₄-C₈)-cycloalkenyl, (C₄-C₈)-cycloalkenyl-(C₁-C₈)-alkyl, (C2-C₈)-alkenyloxycarbonyl, (C₂-C₈)-alkynyloxycarbonyl, (C₁-C₈)-alkylaminocarbonyl, (C₃-C₈)-cycloalkylaminocarbonyl, bis-[(C₁-C₈)-alkyl]aminocarbonyl,
R⁷, R⁸ are each independently hydrogen, (C₁-C₈)-alkyl, halogen, cyano, nitro, hydroxyl, amino, hydrothio, (C₁-C₈)-alkylamino, bis[(C₁-C₈)-alkyl]amino, (C₃-C₈)-cycloalkylamino, aryl-(C₁-C₈)-alkylamino, heteroaryl-(C₁-C₈)-alkylamino, (C₂-C₈)-alkenyl, (C₂-C₈)-alkynyl, (C₁-C₈)-haloalkyl, hydroxy-(C₁-C₈)-alkyl, cyano-(C₁-C₈)-alkyl, nitro-(C₁-C₈)-alkyl, aryl, heteroaryl, (C₃-C₈)-cycloalkyl, (C₄-C₈)-cycloalkenyl, heterocyclyl, (C₁-C₈)-alkoxy, (C₁-C₈)-haloalkoxy, (C₁-C₈)-haloalkylthio, (C₁-C₈)-alkylthio, (C₁-C₈)-alkoxy-(C₁-C₈)-alkyl, (C₁-C₈)-alkylthio-(C₁-C₈)-alkyl, amino-(C₁-C₈)-alkyl, (C₁-C₈)-alkylamino-(C₁-C₈)-alkyl, (C₃-C₈)-cycloalkylamino-(C₁-C₈)-alkyl, aryl-(C₁-C₈)-alkylamino-(C₁-C₈)-alkyl, heteroaryl-(C₁-C₈)-alkylamino-(C₁-C₈)-alkyl, heterocyclyl-(C₁-C₈)-alkylamino-(C₁-C₈)-alkyl, heterocyclylamino-(C₁-C₈)-alkyl, heteroarylamino-(C₁-C₈)-alkyl, (C₁-C₈)-alkoxycarbonylamino-(C₁-C₈)-alkyl, arylamino-(C₁-C₈)-alkyl, aryl-(C₁-C₈)-alkoxycarbonylamino-(C₁-C₈)-alkyl, (C₃-C₈)-cycloalkoxycarbonylamino-(C₁-C₈)-alkyl, (C₃-C₈)-cycloalkyl-(C₁-C₈)-alkoxycarbonylamino-(C₁-C₈)-alkyl, heteroaryl-(C₁-C₈)-alkoxycarbonylamino-(C₁-C₈)-alkyl, (C₁-C₈)-alkylcarbonylamino-(C₁-C₈)-alkyl, (C₃-C₈)-cycloalkylcarbonylamino-(C₁-C₈)-alkyl, arylcarbonylamino-(C₁-C₈)-alkyl, heteroarylcarbonylamino-(C₁-C₈)-alkyl, heterocyclylcarbonylamino-(C₁-C₈)-alkyl, (C₂-C₈)-alkenyloxycarbonylamino-(C₁-C₈)-alkyl, aryl-(C₂-C₈)-alkenylamino-(C₁-C₈)-alkyl, hydroxycarbonyl, (C₁-C₈)-alkoxycarbonyl, (C₂-C₈)-alkenyloxycarbonyl, aryl-(C₁-C₈)-alkoxycarbonyl, aminocarbonyl, alkylaminocarbonyl, (C₃-C₈)-cycloalkylaminocarbonyl, aryl-(C₁-C₈)-alkylaminocarbonyl, heteroarylaminocarbonyl, arylamino, heteroarylamino, heterocyclylamino, (C₂-C₈)-alkenylamino, (C₂-C₈)-alkynylamino, (C₁-C₈)-alkylsulfinyl, (C₂-C₈)-alkenylsulfinyl, arylsulfinyl, heteroarylsulfinyl, heterocyclylsulfinyl, (C₃-C₈)-cycloalkylsulfinyl, (C₁-C₈)-alkylsulfonyl, (C₂-C₈)-alkenylsulfonyl, arylsulfonyl, heteroarylsulfonyl, heterocyclylsulfonyl, (C₃-C₈)-cycloalkylsulfonyl, bis-[(C₁-C₈)-alkyl]amino-(C₁-C₈)-alkyl, (C₁-C₈)-alkyl(aryl)amino-(C₁-C₈)-alkyl, heteroaryloxycarbonylamino-(C₁-C₈)-alkyl, heterocyclyloxycarbonylamino-(C₁-C₈)-alkyl, aryl-(C₁-C₈)-alkoxycarbonylamino-(C₁-C₈)-alkyl, arylaminocarbonyl, (C₁-C₈)-alkylsulfonylamino-(C₁-C₈)-alkyl, (C₃-C₈)-cycloalkylsulfonylamino-(C₁-C₈)-alkyl, arylsulfonylamino-(C₁-C₈)-alkyl, heteroarylsulfonylamino-(C₁-C₈)-alkyl, heterocyclylsulfonylamino-(C₁-C₈)-alkyl, bis-[(C₁-C₈)-alkyl]aminosulfonyl-(C₁-C₈)-alkyl, (C₁-C₈)-alkylsulfonylamino, (C₃-C₈)-cycloalkylsulfonylamino, arylsulfonylamino, heteroarylsulfonylamino, heterocyclylsulfonylamino, (C₁-C₈)-alkoxy-(C₁-C₈)-alkoxy or
R⁷ and R⁸ together with the carbon atom to which they are bonded form a fully saturated or partly saturated 3- to 10-membered monocyclic or bicyclic ring optionally interrupted by heteroatoms and optionally having further substitution or
R⁷ and R⁸ together with the carbon atom to which they are bonded form an oxo group or
R⁷ and R⁸ together with the carbon atom to which they are bonded form an oxime group substituted by hydrogen, (C₁-C₈)-alkyl, (C₃-C₈)-cycloalkyl, (C₃-C₈)-cycloalkyl-(C₁-C₈)-alkyl, aryl, heteroaryl, aryl-(C₁-C₈)-alkyl, heteroaryl-(C₁-C₈)-alkyl,
R⁹, R¹⁰ are each independently hydrogen, (C₁-C₈)-alkyl, halogen, cyano, (C₁-C₈)-haloalkyl, cyano-(C₁-C₈)-alkyl, aryl, heteroaryl, (C₃-C₈)-cycloalkyl, (C₄-C₈)-cycloalkenyl, heterocyclyl, (C₁-C₈)-alkoxy-(C₁-C₈)-alkyl, (C₁-C₈)-alkylthio-(C₁-C₈)-alkyl,
W is oxygen or sulfur,
X, Y are each independently hydrogen, (C₁-C₈)-alkyl, halogen, (C₂-C₈)-alkenyl, (C2-C₈)-alkynyl, (C₁-C₈)-haloalkyl, hydroxy-(C₁-C₈)-alkyl, cyano-(C₁-C₈)-alkyl, aryl, heteroaryl, (C₃-C₈)-cycloalkyl, (C₄-C₈)-cycloalkenyl, heterocyclyl, cyano, nitro, hydroxyl, (C₁-C₈)-alkoxy, (C₁-C₈)-alkylthio, (C₁-C₈)-alkoxy-(C₁-C₈)-alkyl, (C₁-C₈)-alkylthio-(C₁-C₈)-alkyl, aryloxy, aryl-(C₁-C₈)-alkoxy, (C₁-C₈)-haloalkoxy, (C₁-C₈)-haloalkylthio, (C₁-C₈)-alkylamino, bis-[(C₁-C₈)-alkyl]amino, (C₁-C₈)-alkoxy-(C₁-C₈)-alkoxy, amino-(C₁-C₈)-alkyl, (C₁-C₈)-alkylamino-(C₁-C₈)-alkyl, (C₃-C₈)-cycloalkylamino-(C₁-C₈)-alkyl, aryl-(C₁-C₈)-alkylamino-(C₁-C₈)-alkyl, heteroaryl-(C₁-C₈)-alkylamino-(C₁-C₈)-alkyl, heterocyclyl-(C₁-C₈)-alkylamino-(C₁-C₈)-alkyl, heterocyclylamino-(C₁-C₈)-alkyl, heteroarylamino-(C₁-C₈)-alkyl, (C₁-C₈)-alkoxycarbonylamino-(C₁-C₈)-alkyl, arylamino-(C₁-C₈)-alkyl, aryl-(C₁-C₈)-alkoxycarbonylamino-(C₁-C₈)-alkyl, (C₃-C₈)-cycloalkoxycarbonylamino-(C₁-C₈)-alkyl, (C₃-C₈)-cycloalkyl-(C₁-C₈)-alkoxycarbonylamino-(C₁-C₈)-alkyl, heteroaryl-(C₁-C₈)-alkoxycarbonylamino-(C₁-C₈)-alkyl, (C₁-C₈)-alkylcarbonylamino-(C₁-C₈)-alkyl, (C₃-C₈)-cycloalkylcarbonylamino-(C₁-C₈)-alkyl, arylcarbonylamino-(C₁-C₈)-alkyl, heteroarylcarbonylamino-(C₁-C₈)-alkyl, heterocyclylcarbonylamino-(C₁-C₈)-alkyl, (C₂-C₈)-alkenyloxycarbonylamino-(C₁-C₈)-alkyl, aryl-(C2-C₈)-alkenylamino-(C₁-C₈)-alkyl, arylsulfonyl-(C₁-C₈)-alkyl, heteroarylsulfonyl-(C₁-C₈)-alkyl, (C₁-C₈)-alkylsulfonyl-(C₁-C₈)-alkyl, (C₃-C₈)-cycloalkylsulfonyl-(C₁-C₈)-alkyl, arylsulfinyl-(C₁-C₈)-alkyl, heteroarylsulfinyl-(C₁-C₈)-alkyl, (C₁-C₈)-alkylsulfinyl-(C₁-C₈)-alkyl, (C₃-C₈)-cycloalkylsulfinyl-(C₁-C₈)-alkyl, bis[(C₁-C₈)-alkyl]amino-(C₁-C₈)-alkyl, (C₁-C₈)-alkoxycarbonyl, aryl-(C₁-C₈)-alkoxycarbonyl, heteroaryl-(C₁-C₈)-alkoxycarbonyl, (C₃-C₈)-cycloalkoxycarbonyl, (C₃-C₈)-cycloalkyl-(C₁-C₈)-alkoxycarbonyl, (C₁-C₈)-alkylcarbonyl, (C₃-C₈)-cycloalkylcarbonyl, arylcarbonyl, heteroarylcarbonyl, heterocyclylcarbonyl, (C₁-C₈)-alkylsulfonylamino-(C₁-C₈)-alkyl, (C₃-C₈)-cycloalkylsulfonylamino-(C₁-C₈)-alkyl, arylsulfonylamino-(C₁-C₈)-alkyl, heteroarylsulfonylamino-(C₁-C₈)-alkyl, heterocyclylsulfonylamino-(C₁-C₈)-alkyl, bis-[(C₁-C₈)-alkyl]aminosulfonyl-(C₁-C₈)-alkyl, (C₁-C₈)-alkylsulfonylamino, (C₃-C₈)-cycloalkylsulfonylamino, arylsulfonylamino, heteroarylsulfonylamino, heterocyclylsulfonylamino, heteroaryloxycarbonylamino-(C₁-C₈)-alkyl, heterocyclyloxycarbonylamino-(C₁-C₈)-alkyl or
X and Y together with the carbon atom to which they are bonded form a fully saturated or partly saturated 3- to 10-membered monocyclic or bicyclic ring optionally interrupted by one or more heteroatoms and optionally having further substitution.

2. The method as claimed in claim 1, where, in formula (I),
R¹ is halogen, cyano, (C₃-C₁₀)-cycloalkyl, (C₃-C₁₀)-halocycloalkyl, (C₄-C₁₀)-cycloalkenyl, (C₄-C₁₀)-halocycloalkenyl, (C₁-C₁₀)-haloalkyl, (C₂-C₇)-haloalkenyl, (C₁-C₇)-alkoxy-(C₁-C₇)-haloalkyl, aryl, aryl-(C₁-C₇)-alkyl, heteroaryl, heteroaryl-(C₁-C₇)-alkyl, (C₃-C₇)-cycloalkyl-(C₁-C₇)-alkyl, (C₂-C₇)-haloalkynyl, heterocyclyl, heterocyclyl-(C₁-C₇)-alkyl, (C₁-C₇)-alkoxy-(C₁-C₇)-alkyl, (C₁-C₇)-alkylcarbonyl-(C₁-C₇)-alkyl, hydroxycarbonyl-(C₁-C₇)-alkyl, (C₁-C₇)-alkoxycarbonyl-(C₁-C₇)-alkyl, (C₂-C₇)-alkenyloxycarbonyl-(C₁-C₇)-alkyl, (C₂-C₇)-alkynyloxycarbonyl-(C₁-C₇)-alkyl, aryl-(C₁-C₇)-alkoxycarbonyl-(C₁-C₇)-alkyl, (C₃-C₇)-cycloalkoxycarbonyl-(C₁-C₇)-alkyl, (C₃-C₇)-cycloalkyl-(C₁-C₇)-alkoxycarbonyl-(C₁-C₇)-alkyl, aminocarbonyl-(C₁-C₇)-alkyl, (C₁-C₇)-alkylaminocarbonyl-(C₁-C₇)-alkyl, (C₃-C₇)-cycloalkylaminocarbonyl-(C₁-C₇)-alkyl, aryl-(C₁-C₇)-alkylaminocarbonyl-(C₁-C₇)-alkyl, heteroaryl-(C₁-C₇)-alkylaminocarbonyl-(C₁-C₇)-alkyl, (C₁-C₇)-alkylthio-(C₁-C₇)-alkyl, (C₃-C₇)-cycloalkylthio-(C₁-C₇)-alkyl, arylthio-(C₁-C₇)-alkyl, heterocyclylthio-(C₁-C₇)-alkyl, heteroarylthio-(C₁-C₇)-alkyl, aryl-(C₁-C₇)-alkylthio-(C₁-C₇)-alkyl, (C₁-C₇)-alkylsulfinyl-(C₁-C₇)-alkyl, (C₁-C₇)-alkylsulfonyl-(C₁-C₇)-alkyl, arylsulfinyl-(C₁-C₇)-alkyl, arylsulfonyl-(C₁-C₇)-alkyl, (C₃-C₇)-cycloalkylsulfinyl-(C₁-C₇)-alkyl, (C₃-C₇)-cycloalkylsulfonyl-(C₁-C₇)-alkyl, (C₁-C₇)-alkoxy-(C₁-C₇)-alkoxy-(C₁-C₇)-alkyl, (C₁-C₇)-alkylcarbonyl, (C₁-C₇)-haloalkylcarbonyl, (C₃-C₇)-cycloalkylcarbonyl, hydroxycarbonyl, (C₁-C₇)-alkoxycarbonyl, (C₂-C₇)-alkenyloxycarbonyl, (C₂-C₇)-alkynyloxycarbonyl, aryl-(C₁-C₇)-alkoxycarbonyl, (C₃-C₇)-cycloalkyl-(C₁-C₇)-alkoxycarbonyl, arylcarbonyl, heteroarylcarbonyl, heterocyclylcarbonyl, aryl-(C₁-C₇)-alkylcarbonyl, (C₁-C₇)-alkylaminocarbonyl, (C₃-C₇)-cycloalkylaminocarbonyl, arylaminocarbonyl, aryl-(C₁-C₇)-alkylaminocarbonyl, heteroarylaminocarbonyl, heterocyclylaminocarbonyl, heteroaryl-(C₁-C₇)-alkylaminocarbonyl, heterocyclyl-(C₁-C₇)-alkylaminocarbonyl, (C₁-C₇)-alkylsulfonyl, (C₃-C₇)-cycloalkylsulfonyl, arylsulfonyl, aryl-(C₁-C₇)-alkylsulfonyl, heteroarylsulfonyl, heterocyclylsulfonyl, cyano-(C₁-C₇)-alkyl, (C₄-C₇)-cycloalkenyl-(C₁-C₇)-alkyl, nitro-(C₁-C₇)-alkyl, (C₁-C₇)-haloalkoxy-(C₁-C₇)-alkyl, (C₁-C₇)-haloalkylthio-(C₁-C₇)-alkyl, bis-[(C₁-C₇)-alkyl]aminocarbonyl, (C₃-C₇)-cycloalkyl-[(C₁-C₇)-alkyl]aminocarbonyl, aryl-[(C₁-C₇)-alkyl]aminocarbonyl, aryl-(C₁-C₇)-alkyl-[(C₁-C₇)-alkyl]aminocarbonyl, (C₂-C₇)-alkenylaminocarbonyl, (C₂-C₇)-alkynylaminocarbonyl, (C₁-C₇)-alkylaminosulfonyl, bis-[(C₁-C₇)-alkyl]aminosulfonyl, heterocyclylsulfinyl-(C₁-C₇)-alkyl, heteroarylsulfinyl-(C₁-C₇)-alkyl, aryl-(C₁-C₇)-alkylsulfinyl-(C₁-C₇)-alkyl, heterocyclylsulfonyl-(C₁-C₇)-alkyl, heteroarylsulfonyl-(C₁-C₇)-alkyl, aryl-(C₁-C₇)-alkylsulfonyl-(C₁-C₇)-alkyl, bis-[(C₁-C₇)-alkyl]aminocarbonyl-(C₁-C₇)-alkyl, (C₃-C₇)-cycloalkyl-[(C₁-C₇)-alkyl]aminocarbonyl-(C₁-C₇)-alkyl, aryl-[(C₁-C₇)-alkyl]aminocarbonyl-(C₁-C₇)-alkyl, aryl-(C₁-C₇)-alkyl-[(C₁-C₇)-alkyl]aminocarbonyl-(C₁-C₇)-alkyl, (C₂-C₇)-alkenylaminocarbonyl-(C₁-C₇)-alkyl, (C₂-C₇)-alkynylaminocarbonyl-(C₁-C₇)-alkyl, (C₁-C₇)-alkylamino, bis-[(C₁-C₇)-alkyl]amino, (C₃-C₇)-cycloalkyl[(C₁-C₇)-alkyl]amino, amino, (C₂-C₇)-alkenylamino, (C₂-C₇)-alkynylamino, arylamino, heteroarylamino, aryl-(C₁-C₇)-alkylamino, heteroaryl-(C₁-C₇)-alkylamino, heterocyclylamino, heterocyclyl-(C₁-C₇)-alkylamino, (C₂-C₇)-alkenylcarbonyl-(C₁-C₇)-alkyl, (C₂-C₇)-alkynylcarbonyl-(C₁-C₇)-alkyl, (C₃-C₇)-cycloalkyl-(C₁-C₇)-alkylaminocarbonyl-(C₁-C₇)-alkyl, (C₃-C₇)-cycloalkyl-(C₁-C₇)-alkyl-[(C₁-C₇)-alkyl]aminocarbonyl-(C₁-C₇)-alkyl, (C₂-C₇)-alkenylsulfonyl-(C₁-C₇)-alkyl, (C₂-C₇)-alkynylsulfonyl-(C₁-C₇)-alkyl, heteroaryl-(C₁-C₇)-alkylsulfonyl-(C₁-C₇)-alkyl, heterocyclyl-(C₁-C₇)-alkylsulfonyl-(C₁-C₇)-alkyl, (C₂-C₇)-alkenylsulfinyl-(C₁-C₇)-alkyl, (C₂-C₇)-alkynylsulfinyl-(C₁-C₇)-alkyl, heteroaryl-(C₁-C₇)-alkylsulfinyl-(C₁-C₇)-alkyl, heterocyclyl-(C₁-C₇)-alkylsulfinyl-(C₁-C₇)-alkyl, (C₂-C₇)-alkenyloxy-(C₁-C₇)-alkoxy-(C₁-C₇)-alkyl, (C₂-C₇)-alkynyloxy-(C₁-C₇)-alkoxy-(C₁-C₇)-alkyl, heteroaryl-(C₁-C₇)-alkoxy-(C₁-C₇)-alkyl, heterocyclyl-(C₁-C₇)-alkoxy-(C₁-C₇)-alkyl, tris[(C₁-C₇)-alkyl]silyl, tris[(C₁-C₇)-alkyl]silyl-(C₁-C₇)-alkyl, (C₁-C₇)-alkoxy, (C₁-C₇)-haloalkoxy, (C₁-C₇)-alkylamino-(C₁-C₇)-alkyl, bis-[(C₁-C₇)-alkyl]amino-(C₁-C₇)-alkyl, (C₃-C₇)-cycloalkyl[(C₁-C₇)-alkyl]amino-(C₁-C₇)-alkyl, amino-(C₁-C₇)-alkyl, (C₂-C₇)-alkenylamino-(C₁-C₇)-alkyl, (C₂-C₇)-alkynylamino-(C₁-C₇)-alkyl, arylamino-(C₁-C₇)-alkyl, heteroarylamino-(C₁-C₇)-alkyl, aryl-(C₁-C₇)-alkylamino-(C₁-C₇)-alkyl, heteroaryl-(C₁-C₇)-alkylamino-(C₁-C₇)-alkyl, heterocyclylamino-(C₁-C₇)-alkyl, heterocyclyl-(C₁-C₇)-alkylamino-(C₁-C₇)-alkyl, (C₁-C₇)-haloalkoxy-(C₁-C₆)-haloalkyl, (C₂-C₇)-alkenyloxy-(C₁-C₆)-haloalkyl, (C₂-C₇)-alkynyloxy-(C₁-C₆)-haloalkyl, (C₁-C₇)-alkoxy-(C₁-C₇)-alkoxy-(C₁-C₆)-haloalkyl, (C₃-C₇)-cycloalkyl-(C₁-C₇)-alkoxy-(C₁-C₆)-haloalkyl, (C₃-C₇)-cycloalkyl-(C₁-C₇)-alkoxy-(C₁-C₇)-alkyl, (C₁-C₇)-alkoxy-(C₁-C₇)-alkoxy, (C₁-C₇)-alkoxycarbonyl-(C₃-C₇)-cycloalkyl,
R², R³, R⁴ are each independently hydrogen, halogen, (C₁-C₇)-alkoxy, (C₁-C₇)-alkyl, (C₁-C₇)-haloalkyl, (C₁-C₇)-haloalkoxy, (C₁-C₇)-alkylthio, (C₁-C₇)-haloalkylthio, aryl, aryl-(C₁-C₇)-alkyl, heteroaryl, heteroaryl-(C₁-C₇)-alkyl, heterocyclyl, heterocyclyl-(C₁-C₇)-alkyl, (C₃-C₇)-cycloalkyl, nitro, amino, hydroxyl, (C₁-C₇)-alkylamino, bis-[(C₁-C₇)-alkyl]amino, hydrothio, (C₁-C₇)-alkylcarbonylamino, (C₃-C₇)-cycloalkylcarbonylamino, arylcarbonylamino, heteroarylcarbonylamino, heterocyclylcarbonylamino, formyl, hydroxyiminomethyl, (C₁-C₇)-alkoxyiminomethyl, (C₃-C₇)-cycloalkoxyiminomethyl, aryloxyiminomethyl, (C₃-C₇)-cycloalkyl-(C₁-C₇)-alkoxyiminomethyl, thiocyanato, isothiocyanato, aryloxy, heteroaryloxy, (C₃-C₇)-cycloalkoxy, (C₃-C₇)-cycloalkyl-(C₁-C₇)-alkoxy, aryl-(C₁-C₇)-alkoxy, (C₂-C₇)-alkynyl, (C₂-C₇)-alkenyl, aryl-(C₁-C₇)-alkynyl, tris-[(C₁-C₇)-alkyl]silyl-(C₂-C₇)-alkynyl, bis-[(C₁-C₇)-alkyl](aryl)silyl-(C₂-C₇)-alkynyl, bis-aryl[(C₁-C₇)-alkyl]silyl-(C₂-C₇)-alkynyl, (C₃-C₇)-cycloalkyl-(C₂-C₇)-alkynyl, aryl-(C₂-C₇)-alkenyl, heteroaryl-(C₂-C₇)-alkenyl, (C₃-C₇)-cycloalkyl-(C₂-C₇)-alkenyl, (C₃-C₇)-cycloalkyl-(C₂-C₇)-alkyl, (C₂-C₇)-haloalkynyl, (C₂-C₇)-haloalkenyl, (C₄-C₇)-cycloalkenyl, (C₁-C₇)-alkoxy-(C₁-C₇)-alkoxy-(C₁-C₇)-alkyl, (C₁-C₇)-alkylsulfonyl, arylsulfonyl, heteroarylsulfonyl, (C₁-C₇)-alkylsulfonylamino, arylsulfonylamino, aryl-(C₁-C₇)-alkylsulfonylamino, heteroarylsulfonylamino, heteroaryl-(C₁-C₇)-alkylsulfonylamino, bis-[(C₁-C₇)-alkyl]aminosulfonyl, (C₄-C₇)-cycloalkenyl-(C₁-C₇)-alkyl, (C₁-C₇)-alkylsulfinyl, arylsulfinyl, heteroarylsulfinyl, (C₁-C₇)-haloalkylsulfinyl, (C₁-C₇)-haloalkylsulfonyl, aryl-(C₁-C₇)-alkylsulfonyl, heteroaryl-(C₁-C₇)-alkylsulfonyl, (C₁-C₇)-alkylaminosulfonyl, (C₁-C₇)-alkylaminosulfonylamino, bis-[(C₁-C₇)-alkyl]aminosulfonyl, (C₃-C₇)-cycloalkylaminosulfonylamino, (C₁-C₇)-alkoxycarbonyl, (C₂-C₇)-alkenyloxycarbonyl, (C₂-C₇)-alkynyloxycarbonyl, (C₃-C₇)-cycloalkyloxycarbonyl, aryl-(C₁-C₇)-alkoxycarbonyl, (C₁-C₇)-alkylaminocarbonyl, (C₃-C₇)-cycloalkylaminocarbonyl, aryl-(C₁-C₇)-alkylaminocarbonyl,
R⁵ is amino, (C₁-C₇)-alkyl, (C₃-C₇)-cycloalkyl, (C₃-C₇)-cycloalkyl-(C₁-C₇)-alkyl, (C₁-C₇)-haloalkyl, (C₃-C₇)-halocycloalkyl, (C₄-C₇)-cycloalkenyl, aryl, heteroaryl, heterocyclyl, aryl-(C₁-C₇)-alkyl, heteroaryl-(C₁-C₇)-alkyl, heterocyclyl-(C₁-C₇)-alkyl, (C₁-C₇)-alkoxycarbonyl-(C₁-C₇)-alkyl, aryl-(C₁-C₇)-alkoxycarbonyl-(C₁-C₇)-alkyl, (C₃-C₇)-cycloalkoxycarbonyl-(C₁-C₇)-alkyl, (C₃-C₇)-cycloalkyl-(C₁-C₇)-alkoxycarbonyl-(C₁-C₇)-alkyl, heteroaryl-(C₁-C₇)-alkoxycarbonyl-(C₁-C₇)-alkyl, aminocarbonyl-(C₁-C₇)-alkyl, (C₁-C₇)-alkylaminocarbonyl-(C₁-C₇)-alkyl, (C₃-C₇)-cycloalkylaminocarbonyl-(C₁-C₇)-alkyl, aryl-(C₁-C₇)-alkylaminocarbonyl-(C₁-C₇)-alkyl, (C₁-C₇)-alkylamino, arylamino, (C₃-C₇)-cycloalkylamino, aryl-(C₁-C₇)-alkylamino, heteroaryl-(C₁-C₇)-alkylamino, heteroarylamino, heterocyclylamino, aryloxy-(C₁-C₇)-alkyl, (C₁-C₇)-alkoxy-(C₁-C₇)-alkyl, heteroaryloxy-(C₁-C₇)-alkyl, (C₂-C₇)-alkenyl, (C₂-C₇)-alkynyl, (C₂-C₇)-alkenylamino, (C₂-C₇)-alkynylamino, bis-[(C₁-C₇)-alkenyl]amino, aryloxy, bis-[(C₁-C₇)-alkyl]amino, aryl-(C₂-C₇)-alkenyl, heteroaryl-(C₂-C₇)-alkenyl, heterocyclyl-(C₂-C₇)-alkenyl, aryloxycarbonyl-(C₁-C₇)-alkyl, heteroaryloxycarbonyl-(C₁-C₇)-alkyl, bis[(C₁-C₇)-alkyl]aminocarbonyl-(C₁-C₇)-alkyl, (C₁-C₇)-alkylthio-(C₁-C₇)-alkyl, cyano-(C₁-C₇)-alkyl, (C₁-C₇)-alkoxy-(C₁-C₇)-alkoxy-(C₁-C₇)-alkyl,
R⁶ is hydrogen, (C₁-C₇)-alkyl, (C₃-C₇)-cycloalkyl, cyano-(C₁-C₇)-alkyl, (C₃-C₇)-cycloalkyl-(C₁-C₇)-alkyl, (C₁-C₇)-alkylsulfonyl, arylsulfonyl, heteroarylsulfonyl, (C₃-C₇)-cycloalkylsulfonyl, heterocyclylsulfonyl, aryl-(C₁-C₇)-alkylsulfonyl, (C₁-C₇)-alkylcarbonyl, arylcarbonyl, heteroarylcarbonyl, (C₃-C₇)-cycloalkylcarbonyl, heterocyclylcarbonyl, (C₁-C₇)-alkoxycarbonyl, aryl-(C₁-C₇)-alkoxycarbonyl, (C₁-C₇)-haloalkylcarbonyl, (C₂-C₇)-alkenyl, (C₂-C₇)-alkynyl, (C₁-C₇)-haloalkyl, halo-(C₂-C₇)-alkynyl, halo-(C₂-C₇)-alkenyl, (C₁-C₇)-alkoxy-(C₁-C₇)-alkyl, amino, (C₁-C₇)-alkoxy-(C₁-C₇)-alkoxy-(C₁-C₇)-alkyl, heteroaryl-(C₁-C₇)-alkylsulfonyl, heterocyclyl-(C₁-C₇)-alkylsulfonyl, (C₄-C₇)-cycloalkenyl, (C₄-C₇)-cycloalkenyl-(C₁-C₇)-alkyl, (C₂-C₇)-alkenyloxycarbonyl, (C₂-C₇)-alkynyloxycarbonyl, (C₁-C₇)-alkylaminocarbonyl, (C₃-C₇)-cycloalkylaminocarbonyl, bis-[(C₁-C₇)-alkyl]aminocarbonyl,
R⁷, R⁸ are each independently hydrogen, hydroxyl, amino, (C₁-C₇)-alkylamino, bis[(C₁-C₇)-alkyl]amino, (C₃-C₇)-cycloalkylamino, (C₁-C₇)-alkyl, halogen, (C₂-C₇)-alkenyl, (C₂-C₇)-alkynyl, (C₁-C₇)-haloalkyl, hydroxy-(C₁-C₇)-alkyl, cyano-(C₁-C₇)-alkyl, nitro-(C₁-C₇)-alkyl, aryl, heteroaryl, (C₃-C₇)-cycloalkyl, (C₄-C₇)-cycloalkenyl, heterocyclyl, (C₁-C₇)-alkoxy, (C₁-C₇)-haloalkoxy, (C₁-C₇)-alkoxy-(C₁-C₇)-alkyl, (C₁-C₇)-alkylthio-(C₁-C₇)-alkyl, amino-(C₁-C₇)-alkyl, (C₁-C₇)-alkylamino-(C₁-C₇)-alkyl, (C₃-C₇)-cycloalkylamino-(C₁-C₇)-alkyl, aryl-(C₁-C₇)-alkylamino-(C₁-C₇)-alkyl, heteroaryl-(C₁-C₇)-alkylamino-(C₁-C₇)-alkyl, heterocyclyl-(C₁-C₇)-alkylamino-(C₁-C₇)-alkyl, heterocyclylamino-(C₁-C₇)-alkyl, heteroarylamino-(C₁-C₇)-alkyl, (C₁-C₇)-alkoxycarbonylamino-(C₁-C₇)-alkyl, arylamino-(C₁-C₇)-alkyl, aryl-(C₁-C₇)-alkoxycarbonylamino-(C₁-C₇)-alkyl, (C₃-C₇)-cycloalkoxycarbonylamino-(C₁-C₇)-alkyl, (C₃-C₇)-cycloalkyl-(C₁-C₇)-alkoxycarbonylamino-(C₁-C₇)-alkyl, heteroaryl-(C₁-C₇)-alkoxycarbonylamino-(C₁-C₇)-alkyl, (C₁-C₇)-alkylcarbonylamino-(C₁-C₇)-alkyl, (C₃-C₇)-cycloalkylcarbonylamino-(C₁-C₇)-alkyl, arylcarbonylamino-(C₁-C₇)-alkyl, heteroarylcarbonylamino-(C₁-C₇)-alkyl, heterocyclylcarbonylamino-(C₁-C₇)-alkyl, (C₂-C₇)-alkenyloxycarbonylamino-(C₁-C₇)-alkyl, aryl-(C₂-C₇)-alkenylamino-(C₁-C₇)-alkyl, hydroxycarbonyl, (C₁-C₇)-alkoxycarbonyl, (C₂-C₇)-alkenyloxycarbonyl, aryl-(C₁-C₇)-alkoxycarbonyl, aminocarbonyl, alkylaminocarbonyl, (C₃-C₇)-cycloalkylaminocarbonyl, aryl-(C₁-C₇)-alkylaminocarbonyl, heteroarylaminocarbonyl, arylamino, heteroarylamino, heterocyclylamino, (C₂-C₇)-alkenylamino, (C₂-C₇)-alkynylamino, (C₁-C₇)-alkylsulfinyl, (C₂-C₇)-alkenylsulfinyl, arylsulfinyl, heteroarylsulfinyl, heterocyclylsulfinyl, (C₃-C₇)-cycloalkylsulfinyl, (C₁-C₇)-alkylsulfonyl, (C₂-C₇)-alkenylsulfonyl, arylsulfonyl, heteroarylsulfonyl, heterocyclylsulfonyl, (C₃-C₇)-cycloalkylsulfonyl, bis-[(C₁-C₇)-alkyl]amino-(C₁-C₇)-alkyl, (C₁-C₇)-alkyl(aryl)amino-(C₁-C₇)-alkyl, heteroaryloxycarbonylamino-(C₁-C₇)-alkyl, heterocyclyloxycarbonylamino-(C₁-C₇)-alkyl, aryl-(C₁-C₇)-alkoxycarbonylamino-(C₁-C₇)-alkyl, arylaminocarbonyl, (C₁-C₇)-alkylsulfonylamino-(C₁-C₇)-alkyl, (C₃-C₇)-cycloalkylsulfonylamino-(C₁-C₇)-alkyl, arylsulfonylamino-(C₁-C₇)-alkyl, heteroarylsulfonylamino-(C₁-C₇)-alkyl, heterocyclylsulfonylamino-(C₁-C₇)-alkyl, bis-[(C₁-C₇)-alkyl]aminosulfonyl-(C₁-C₇)-alkyl, (C₁-C₇)-alkylsulfonylamino, (C₃-C₇)-cycloalkylsulfonylamino, arylsulfonylamino, heteroarylsulfonylamino, heterocyclylsulfonylamino, (C₁-C₇)-alkoxy-(C₁-C₇)-alkoxy or
R⁷ and R⁸ together with the carbon atom to which they are bonded form a fully saturated or partly saturated 3- to 10-membered monocyclic or bicyclic ring optionally interrupted by heteroatoms and optionally having further substitution or
R⁷ and R⁸ together with the carbon atom to which they are bonded form an oxo group or
R⁷ and R⁸ together with the carbon atom to which they are bonded form an oxime group substituted by hydrogen, (C₁-C₇)-alkyl, (C₃-C₇)-cycloalkyl, (C₃-C₇)-cycloalkyl-(C₁-C₇)-alkyl, aryl, heteroaryl, aryl-(C₁-C₇)-alkyl, heteroaryl-(C₁-C₇)-alkyl,
R⁹, R¹⁰ are each independently hydrogen, (C₁-C₇)-alkyl, halogen, cyano, (C₁-C₇)-haloalkyl, cyano-(C₁-C₇)-alkyl, aryl, heteroaryl, (C₃-C₇)-cycloalkyl, (C₄-C₇)-cycloalkenyl, heterocyclyl, (C₁-C₇)-alkoxy-(C₁-C₇)-alkyl, (C₁-C₇)-alkylthio-(C₁-C₇)-alkyl,
W is oxygen or sulfur,
X, Y are each independently hydrogen, (C₁-C₇)-alkyl, halogen, (C₂-C₇)-alkenyl, (C2-C₇)-alkynyl, (C₁-C₇)-haloalkyl, hydroxy-(C₁-C₇)-alkyl, cyano-(C₁-C₇)-alkyl, aryl, heteroaryl, (C₃-C₇)-cycloalkyl, (C₄-C₇)-cycloalkenyl, heterocyclyl, cyano, nitro, hydroxyl, (C₁-C₇)-alkoxy, (C₁-C₇)-alkylthio, (C₁-C₇)-alkoxy-(C₁-C₇)-alkyl, (C₁-C₇)-alkylthio-(C₁-C₇)-alkyl, aryloxy, aryl-(C₁-C₇)-alkoxy, (C₁-C₇)-haloalkoxy, (C₁-C₇)-haloalkylthio, (C₁-C₇)-alkylamino, bis-[(C₁-C₇)-alkyl]amino, (C₁-C₇)-alkoxy-(C₁-C₇)-alkoxy, amino-(C₁-C₇)-alkyl, (C₁-C₇)-alkylamino-(C₁-C₇)-alkyl, (C₃-C₇)-cycloalkylamino-(C₁-C₇)-alkyl, aryl-(C₁-C₇)-alkylamino-(C₁-C₇)-alkyl, heteroaryl-(C₁-C₇)-alkylamino-(C₁-C₇)-alkyl, heterocyclyl-(C₁-C₇)-alkylamino-(C₁-C₇)-alkyl, heterocyclylamino-(C₁-C₇)-alkyl, heteroarylamino-(C₁-C₇)-alkyl, (C₁-C₇)-alkoxycarbonylamino-(C₁-C₇)-alkyl, arylamino-(C₁-C₇)-alkyl, aryl-(C₁-C₇)-alkoxycarbonylamino-(C₁-C₇)-alkyl, (C₃-C₇)-cycloalkoxycarbonylamino-(C₁-C₇)-alkyl, (C₃-C₇)-cycloalkyl-(C₁-C₇)-alkoxycarbonylamino-(C₁-C₇)-alkyl, heteroaryl-(C₁-C₇)-alkoxycarbonylamino-(C₁-C₇)-alkyl, (C₁-C₇)-alkylcarbonylamino-(C₁-C₇)-alkyl, (C₃-C₇)-cycloalkylcarbonylamino-(C₁-C₇)-alkyl, arylcarbonylamino-(C₁-C₇)-alkyl, heteroarylcarbonylamino-(C₁-C₇)-alkyl, heterocyclylcarbonylamino-(C₁-C₇)-alkyl, (C₂-C₇)-alkenyloxycarbonylamino-(C₁-C₇)-alkyl, aryl-(C₂-C₇)-alkenylamino-(C₁-C₇)-alkyl, arylsulfonyl-(C₁-C₇)-alkyl, heteroarylsulfonyl-(C₁-C₇)-alkyl, (C₁-C₇)-alkylsulfonyl-(C₁-C₇)-alkyl, (C₃-C₇)-cycloalkylsulfonyl-(C₁-C₇)-alkyl, arylsulfinyl-(C₁-C₇)-alkyl, heteroarylsulfinyl-(C₁-C₇)-alkyl, (C₁-C₇)-alkylsulfinyl-(C₁-C₇)-alkyl, (C₃-C₇)-cycloalkylsulfinyl-(C₁-C₇)-alkyl, bis[(C₁-C₇)-alkyl]amino-(C₁-C₇)-alkyl, (C₁-C₇)-alkoxycarbonyl, aryl-(C₁-C₇)-alkoxycarbonyl, heteroaryl-(C₁-C₇)-alkoxycarbonyl, (C₃-C₇)-cycloalkoxycarbonyl, (C₃-C₇)-cycloalkyl-(C₁-C₇)-alkoxycarbonyl, (C₁-C₇)-alkylcarbonyl, (C₃-C₇)-cycloalkylcarbonyl, arylcarbonyl, heteroarylcarbonyl, heterocyclylcarbonyl, (C₁-C₇)-alkylsulfonylamino-(C₁-C₇)-alkyl, (C₃-C₇)-cycloalkylsulfonylamino-(C₁-C₇)-alkyl, arylsulfonylamino-(C₁-C₇)-alkyl, heteroarylsulfonylamino-(C₁-C₇)-alkyl, heterocyclylsulfonylamino-(C₁-C₇)-alkyl, bis-[(C₁-C₇)-alkyl]aminosulfonyl-(C₁-C₇)-alkyl, (C₁-C₇)-alkylsulfonylamino, (C₃-C₇)-cycloalkylsulfonylamino, arylsulfonylamino, heteroarylsulfonylamino, heterocyclylsulfonylamino, heteroaryloxycarbonylamino-(C₁-C₇)-alkyl, heterocyclyloxycarbonylamino-(C₁-C₇)-alkyl or
X and Y together with the carbon atom to which they are bonded form a fully saturated or partly saturated 3- to 10-membered monocyclic or bicyclic ring optionally interrupted by one or more heteroatoms and optionally having further substitution.

3. The method as claimed in claim 1, where the one or more compounds of formula (I) and/or one or more salts are described by formulae (Iaa) to (Ibi) 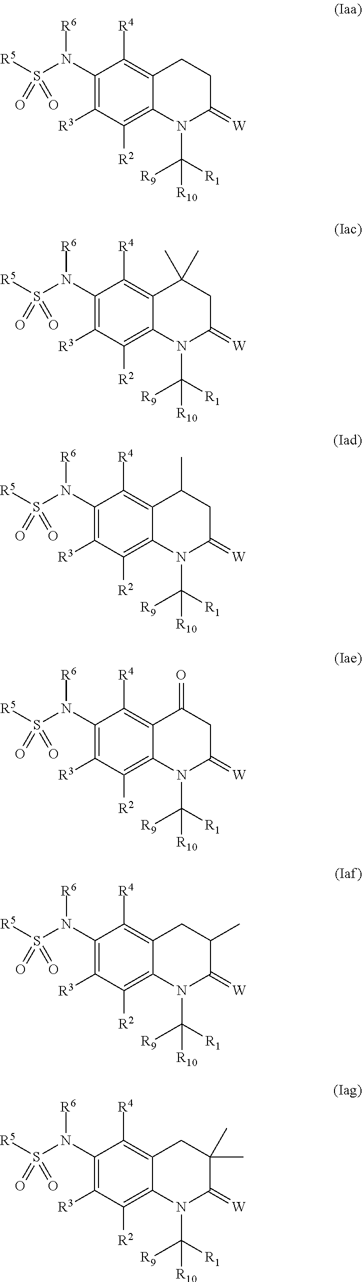 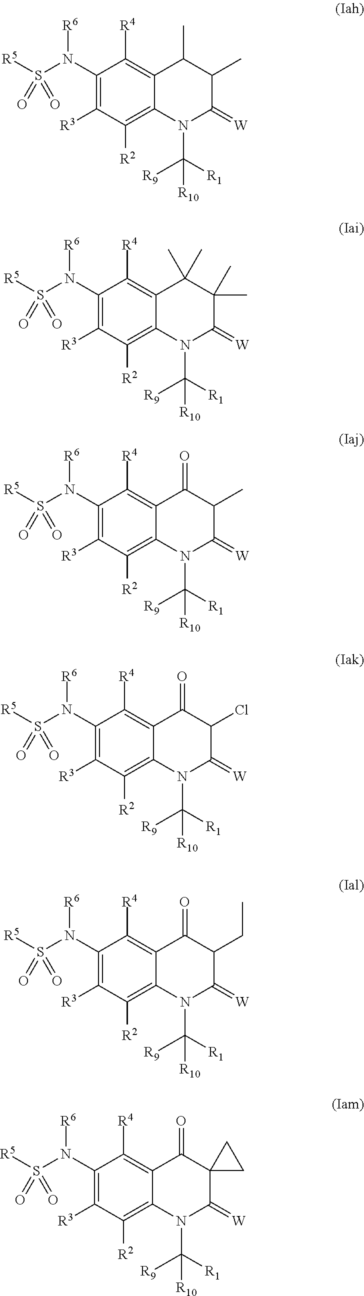 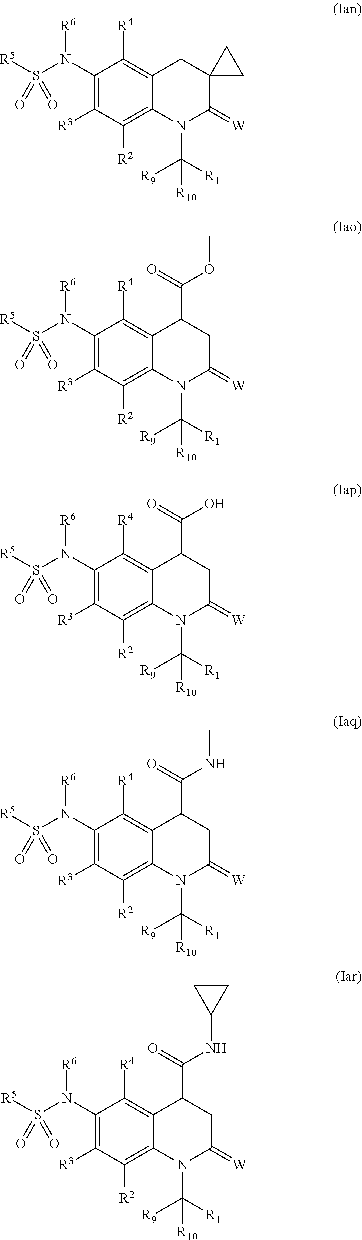 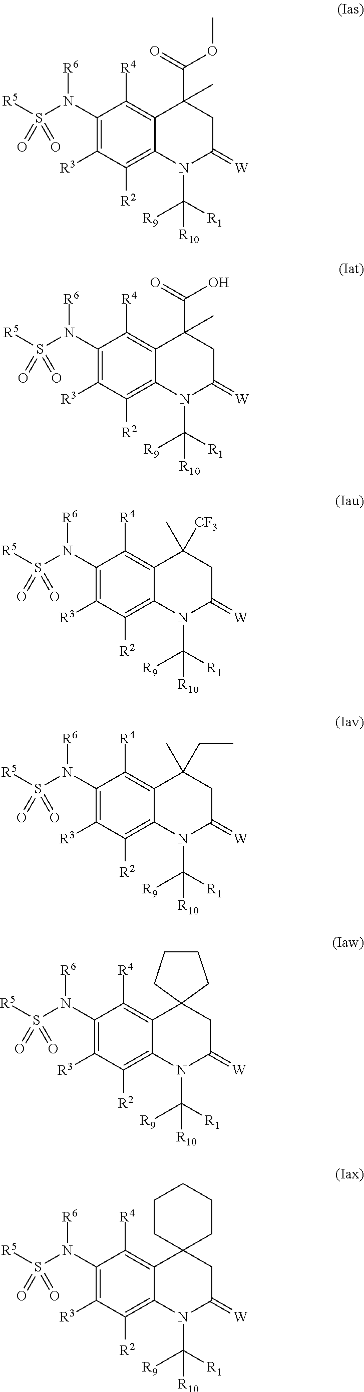 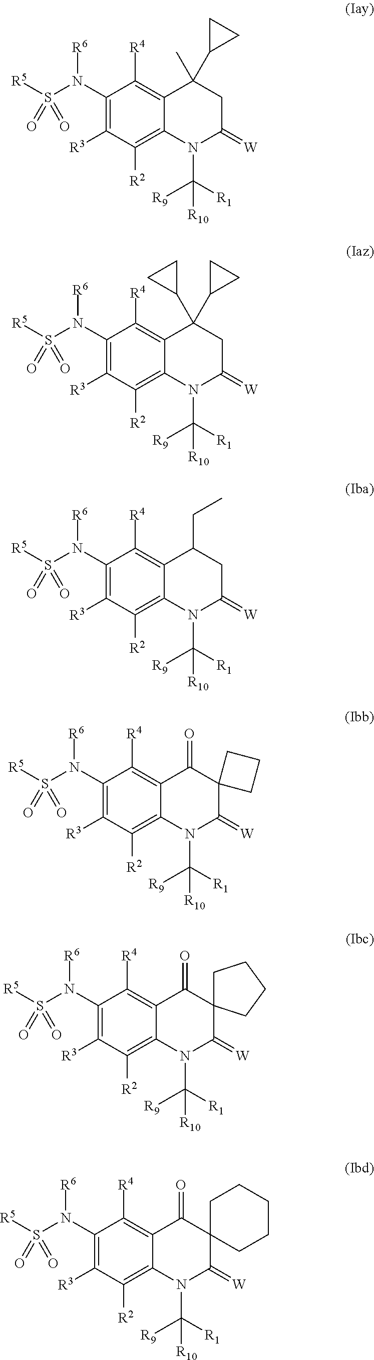 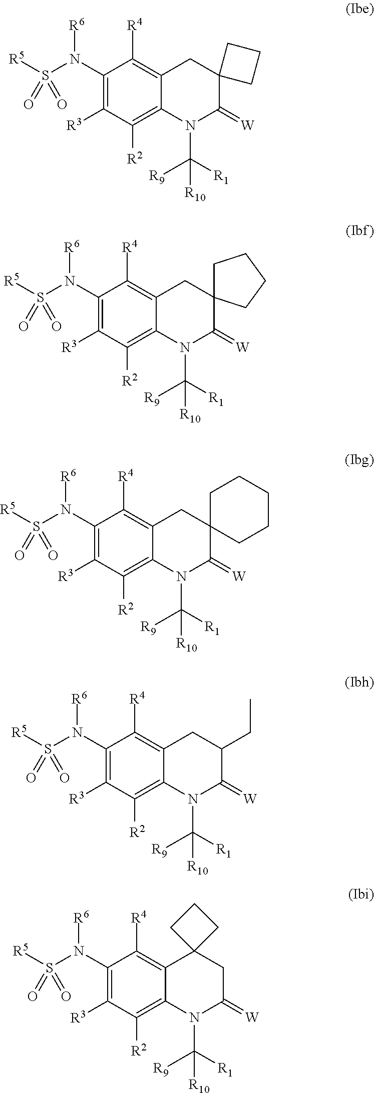
and in which
R¹ is fluorine, chlorine, bromine, iodine, cyano, (C₃-C₁₀)-cycloalkyl, (C₃-C₁₀)-halocycloalkyl, (C₄-C₁₀)-cycloalkenyl, (C₄-C₁₀)-halocycloalkenyl, (C₁-C₁₀)-haloalkyl, (C₂-C₆)-haloalkenyl, (C₁-C₆)-alkoxy-(C₁-C₆)-haloalkyl, aryl, aryl-(C₁-C₆)-alkyl, heteroaryl, heteroaryl-(C₁-C₆)-alkyl, (C₃-C₆)-cycloalkyl-(C₁-C₆)-alkyl, (C₂-C₆)-haloalkynyl, heterocyclyl, heterocyclyl-(C₁-C₆)-alkyl, (C₁-C₆)-alkoxy-(C₁-C₆)-alkyl, (C₁-C₆)-alkylcarbonyl-(C₁-C₆)-alkyl, hydroxycarbonyl-(C₁-C₆)-alkyl, (C₁-C₆)-alkoxycarbonyl-(C₁-C₆)-alkyl, (C₂-C₆)-alkenyloxycarbonyl-(C₁-C₆)-alkyl, (C₂-C₆)-alkynyloxycarbonyl-(C₁-C₆)-alkyl, aryl-(C₁-C₆)-alkoxycarbonyl-(C₁-C₆)-alkyl, (C₃-C₆)-cycloalkoxycarbonyl-(C₁-C₆)-alkyl, (C₃-C₆)-cycloalkyl-(C₁-C₆)-alkoxycarbonyl-(C₁-C₆)-alkyl, aminocarbonyl-(C₁-C₆)-alkyl, (C₁-C₆)-alkylaminocarbonyl-(C₁-C₆)-alkyl, (C₃-C₆)-cycloalkylaminocarbonyl-(C₁-C₆)-alkyl, aryl-(C₁-C₆)-alkylaminocarbonyl-(C₁-C₆)-alkyl, heteroaryl-(C₁-C₆)-alkylaminocarbonyl-(C₁-C₆)-alkyl, (C₁-C₆)-alkylthio-(C₁-C₆)-alkyl, (C₃-C₆)-cycloalkylthio-(C₁-C₆)-alkyl, arylthio-(C₁-C₆)-alkyl, heterocyclylthio-(C₁-C₆)-alkyl, heteroarylthio-(C₁-C₆)-alkyl, aryl-(C₁-C₆)-alkylthio-(C₁-C₆)-alkyl, (C₁-C₆)-alkylsulfinyl-(C₁-C₆)-alkyl, (C₁-C₆)-alkylsulfonyl-(C₁-C₆)-alkyl, arylsulfinyl-(C₁-C₆)-alkyl, arylsulfonyl-(C₁-C₆)-alkyl, (C₃-C₆)-cycloalkylsulfinyl-(C₁-C₆)-alkyl, (C₃-C₆)-cycloalkylsulfonyl-(C₁-C₆)-alkyl, (C₁-C₆)-alkoxy-(C₁-C₆)-alkoxy-(C₁-C₆)-alkyl, (C₁-C₆)-alkylcarbonyl, (C₁-C₆)-haloalkylcarbonyl, (C₃-C₆)-cycloalkylcarbonyl, hydroxycarbonyl, (C₁-C₆)-alkoxycarbonyl, (C₂-C₆)-alkenyloxycarbonyl, (C₂-C₆)-alkynyloxycarbonyl, aryl-(C₁-C₆)-alkoxycarbonyl, (C₃-C₆)-cycloalkyl-(C₁-C₆)-alkoxycarbonyl, arylcarbonyl, heteroarylcarbonyl, heterocyclylcarbonyl, aryl-(C₁-C₆)-alkylcarbonyl, (C₁-C₆)-alkylaminocarbonyl, (C₃-C₆)-cycloalkylaminocarbonyl, arylaminocarbonyl, aryl-(C₁-C₆)-alkylaminocarbonyl, heteroarylaminocarbonyl, heterocyclylaminocarbonyl, heteroaryl-(C₁-C₆)-alkylaminocarbonyl, heterocyclyl-(C₁-C₆)-alkylaminocarbonyl, (C₁-C₆)-alkylsulfonyl, (C₃-C₆)-cycloalkylsulfonyl, arylsulfonyl, aryl-(C₁-C₆)-alkylsulfonyl, heteroarylsulfonyl, heterocyclylsulfonyl, cyano-(C₁-C₆)-alkyl, (C₄-C₆)-cycloalkenyl-(C₁-C₆)-alkyl, nitro-(C₁-C₆)-alkyl, (C₁-C₆)-haloalkoxy-(C₁-C₆)-alkyl, (C₁-C₆)-haloalkylthio-(C₁-C₆)-alkyl, bis-[(C₁-C₆)-alkyl]aminocarbonyl, (C₃-C₆)-cycloalkyl-[(C₁-C₆)-alkyl]aminocarbonyl, aryl-[(C₁-C₆)-alkyl]aminocarbonyl, aryl-(C₁-C₆)-alkyl-[(C₁-C₆)-alkyl]aminocarbonyl, (C₂-C₆)-alkenylaminocarbonyl, (C₂-C₆)-alkynylaminocarbonyl, (C₁-C₆)-alkylaminosulfonyl, bis-[(C₁-C₆)-alkyl]aminosulfonyl, heterocyclylsulfinyl-(C₁-C₆)-alkyl, heteroarylsulfinyl-(C₁-C₆)-alkyl, aryl-(C₁-C₆)-alkylsulfinyl-(C₁-C₆)-alkyl, heterocyclylsulfonyl-(C₁-C₆)-alkyl, heteroarylsulfonyl-(C₁-C₆)-alkyl, aryl-(C₁-C₆)-alkylsulfonyl-(C₁-C₆)-alkyl, bis-[(C₁-C₆)-alkyl]aminocarbonyl-(C₁-C₆)-alkyl, (C₃-C₆)-cycloalkyl-[(C₁-C₆)-alkyl]aminocarbonyl-(C₁-C₆)-alkyl, aryl-[(C₁-C₆)-alkyl]aminocarbonyl-(C₁-C₆)-alkyl, aryl-(C₁-C₆)-alkyl-[(C₁-C₆)-alkyl]aminocarbonyl-(C₁-C₆)-alkyl, (C₂-C₆)-alkenylaminocarbonyl-(C₁-C₆)-alkyl, (C₂-C₆)-alkynylaminocarbonyl-(C₁-C₆)-alkyl, (C₁-C₆)-alkylamino, bis-[(C₁-C₆)-alkyl]amino, (C₃-C₆)-cycloalkyl[(C₁-C₆)-alkyl]amino, amino, (C₂-C₆)-alkenylamino, (C₂-C₆)-alkynylamino, arylamino, heteroarylamino, aryl-(C₁-C₆)-alkylamino, heteroaryl-(C₁-C₆)-alkylamino, heterocyclylamino, heterocyclyl-(C₁-C₆)-alkylamino, (C₂-C₆)-alkenylcarbonyl-(C₁-C₆)-alkyl, (C₂-C₆)-alkynylcarbonyl-(C₁-C₆)-alkyl, (C₃-C₆)-cycloalkyl-(C₁-C₆)-alkylaminocarbonyl-(C₁-C₆)-alkyl, (C₃-C₆)-cycloalkyl-(C₁-C₆)-alkyl-[(C₁-C₆)-alkyl]aminocarbonyl-(C₁-C₆)-alkyl, (C₂-C₆)-alkenylsulfonyl-(C₁-C₆)-alkyl, (C₂-C₆)-alkynylsulfonyl-(C₁-C₆)-alkyl, heteroaryl-(C₁-C₆)-alkylsulfonyl-(C₁-C₆)-alkyl, heterocyclyl-(C₁-C₆)-alkylsulfonyl-(C₁-C₆)-alkyl, (C₂-C₆)-alkenylsulfinyl-(C₁-C₆)-alkyl, (C₂-C₆)-alkynylsulfinyl-(C₁-C₆)-alkyl, heteroaryl-(C₁-C₆)-alkylsulfinyl-(C₁-C₆)-alkyl, heterocyclyl-(C₁-C₆)-alkylsulfinyl-(C₁-C₆)-alkyl, (C₂-C₆)-alkenyloxy-(C₁-C₆)-alkoxy-(C₁-C₆)-alkyl, (C₂-C₆)-alkynyloxy-(C₁-C₆)-alkoxy-(C₁-C₆)-alkyl, heteroaryl-(C₁-C₆)-alkoxy-(C₁-C₆)-alkyl, heterocyclyl-(C₁-C₆)-alkoxy-(C₁-C₆)-alkyl, tris[(C₁-C₆)-alkyl]silyl, tris[(C₁-C₆)-alkyl]silyl-(C₁-C₆)-alkyl, (C₁-C₆)-alkoxy, (C₁-C₆)-haloalkoxy, (C₁-C₆)-alkylamino-(C₁-C₆)-alkyl, bis-[(C₁-C₆)-alkyl]amino-(C₁-C₆)-alkyl, (C₃-C₆)-cycloalkyl[(C₁-C₆)-alkyl]amino-(C₁-C₆)-alkyl, amino-(C₁-C₆)-alkyl, (C₂-C₆)-alkenylamino-(C₁-C₆)-alkyl, (C₂-C₆)-alkynylamino-(C₁-C₆)-alkyl, arylamino-(C₁-C₆)-alkyl, heteroarylamino-(C₁-C₆)-alkyl, aryl-(C₁-C₆)-alkylamino-(C₁-C₆)-alkyl, heteroaryl-(C₁-C₆)-alkylamino-(C₁-C₆)-alkyl, heterocyclylamino-(C₁-C₆)-alkyl, heterocyclyl-(C₁-C₆)-alkylamino-(C₁-C₆)-alkyl, (C₁-C₆)-haloalkoxy-(C₁-C₆)-haloalkyl, (C₂-C₆)-alkenyloxy-(C₁-C₆)-haloalkyl, (C₂-C₆)-alkynyloxy-(C₁-C₆)-haloalkyl, (C₁-C₆)-alkoxy-(C₁-C₆)-alkoxy-(C₁-C₆)-haloalkyl, (C₃-C₆)-cycloalkyl-(C₁-C₆)-alkoxy-(C₁-C₆)-haloalkyl, (C₃-C₆)-cycloalkyl-(C₁-C₆)-alkoxy-(C₁-C₆)-alkyl, (C₁-C₆)-alkoxy-(C₁-C₆)-alkoxy, (C₁-C₆)-alkoxycarbonyl-(C₃-C₆)-cycloalkyl,
R², R³, R⁴ are each independently hydrogen, halogen, (C₁-C₅)-alkoxy, (C₁-C₅)-alkyl, (C₁-C₅)-haloalkyl, (C₁-C₅)-haloalkoxy, (C₁-C₅)-alkylthio, (C₁-C₅)-haloalkylthio, aryl, aryl-(C₁-C₅)-alkyl, heteroaryl, heteroaryl-(C₁-C₅)-alkyl, heterocyclyl, heterocyclyl-(C₁-C₅)-alkyl, (C₃-C₆)-cycloalkyl, nitro, amino, hydroxyl, (C₁-C₅)-alkylamino, bis-[(C₁-C₅)-alkyl]amino, hydrothio, (C₁-C₅)-alkylcarbonylamino, (C₃-C₆)-cycloalkylcarbonylamino, arylcarbonylamino, heteroarylcarbonylamino, heterocyclylcarbonylamino, formyl, hydroxyiminomethyl, (C₁-C₅)-alkoxyiminomethyl, (C₃-C₆)-cycloalkoxyiminomethyl, aryloxyiminomethyl, (C₃-C₆)-cycloalkyl-(C₁-C₅)-alkoxyiminomethyl, thiocyanato, isothiocyanato, aryloxy, heteroaryloxy, (C₃-C₆)-cycloalkoxy, (C₃-C₆)-cycloalkyl-(C₁-C₅)-alkoxy, aryl-(C₁-C₅)-alkoxy, (C₂-C₅)-alkynyl, (C₂-C₅)-alkenyl, aryl-(C₁-C₅)-alkynyl, tris-[(C₁-C₅)-alkyl]silyl-(C₂-C₅)-alkynyl, bis-[(C₁-C₅)-alkyl](aryl)silyl-(C₂-C₅)-alkynyl, bis-aryl[(C₁-C₅)-alkyl]silyl-(C₂-C₅)-alkynyl, (C₃-C₆)-cycloalkyl-(C₂-C₅)-alkynyl, aryl-(C₂-C₅)-alkenyl, heteroaryl-(C₂-C₅)-alkenyl, (C₃-C₆)-cycloalkyl-(C₂-C₅)-alkenyl, (C₂-C₅)-haloalkynyl, (C₂-C₅)-haloalkenyl, (C₄-C₅)-cycloalkenyl, (C₁-C₅)-alkoxy-(C₁-C₅)-alkoxy-(C₁-C₅)-alkyl, (C₁-C₅)-alkylsulfonyl, arylsulfonyl, heteroarylsulfonyl, (C₁-C₅)-alkylsulfonylamino, arylsulfonylamino, aryl-(C₁-C₅)-alkylsulfonylamino, heteroarylsulfonylamino, heteroaryl-(C₁-C₅)-alkylsulfonylamino, bis-[(C₁-C₅)-alkyl]aminosulfonyl,
R⁵ is amino, (C₁-C₅)-alkyl, (C₃-C₆)-cycloalkyl, (C₃-C₆)-cycloalkyl-(C₁-C₅)-alkyl, (C₁-C₅)-haloalkyl, (C₃-C₆)-halocycloalkyl, (C₄-C₆)-cycloalkenyl, aryl, heteroaryl, heterocyclyl, aryl-(C₁-C₅)-alkyl, heteroaryl-(C₁-C₅)-alkyl, heterocyclyl-(C₁-C₅)-alkyl, (C₁-C₅)-alkoxycarbonyl-(C₁-C₅)-alkyl, aryl-(C₁-C₅)-alkoxycarbonyl-(C₁-C₅)-alkyl, (C₃-C₆)-cycloalkoxycarbonyl-(C₁-C₅)-alkyl, (C₃-C₆)-cycloalkyl-(C₁-C₅)-alkoxycarbonyl-(C₁-C₅)-alkyl, heteroaryl-(C₁-C₅)-alkoxycarbonyl-(C₁-C₅)-alkyl, aminocarbonyl-(C₁-C₅)-alkyl, (C₁-C₅)-alkylaminocarbonyl-(C₁-C₅)-alkyl, (C₃-C₆)-cycloalkylaminocarbonyl-(C₁-C₅)-alkyl, aryl-(C₁-C₅)-alkylaminocarbonyl-(C₁-C₅)-alkyl, (C₁-C₅)-alkylamino, arylamino, (C₃-C₆)-cycloalkylamino, aryl-(C₁-C₅)-alkylamino, heteroaryl-(C₁-C₅)-alkylamino, heteroarylamino, heterocyclylamino, aryloxy-(C₁-C₅)-alkyl, (C₁-C₅)-alkoxy-(C₁-C₅)-alkyl, heteroaryloxy-(C₁-C₅)-alkyl, (C₂-C₅)-alkenyl, (C₂-C₅)-alkynyl, (C₂-C₅)-alkenylamino, (C₂-C₅)-alkynylamino, aryloxy, (C₃-C₆)-cycloalkyl-(C₂-C₅)-alkyl, bis-[(C₁-C₅)-alkyl]amino, aryl-(C₂-C₅)-alkenyl, heteroaryl-(C₂-C₅)-alkenyl, heterocyclyl-(C₂-C₅)-alkenyl,
R⁶ is hydrogen, (C₁-C₅)-alkyl, (C₃-C₆)-cycloalkyl, cyano-(C₁-C₅)-alkyl, (C₃-C₆)-cycloalkyl-(C₁-C₅)-alkyl, (C₁-C₅)-alkylsulfonyl, arylsulfonyl, heteroarylsulfonyl, (C₃-C₆)-cycloalkylsulfonyl, heterocyclylsulfonyl, aryl-(C₁-C₅)-alkylsulfonyl, (C₁-C₅)-alkylcarbonyl, arylcarbonyl, heteroarylcarbonyl, (C₃-C₆)-cycloalkylcarbonyl, heterocyclylcarbonyl, (C₁-C₅)-alkoxycarbonyl, aryl-(C₁-C₅)-alkoxycarbonyl, (C₁-C₅)-haloalkylcarbonyl, (C₂-C₅)-alkenyl, (C₂-C₅)-alkynyl, (C₁-C₅)-haloalkyl, halo-(C₂-C₅)-alkynyl, halo-(C₂-C₅)-alkenyl, (C₁-C₅)-alkoxy-(C₁-C₅)-alkyl,
R⁹, R¹⁰ are each independently hydrogen, (C₁-C₆)-alkyl, fluorine, chlorine, bromine, iodine, cyano, (C₁-C₆)-haloalkyl, cyano-(C₁-C₆)-alkyl, aryl, heteroaryl, (C₃-C₆)-cycloalkyl, (C₄-C₆)-cycloalkenyl, heterocyclyl, (C₁-C₆)-alkoxy-(C₁-C₆)-alkyl,
W is oxygen or sulfur.

4. A method of claim 1, which comprises a treatment for plants, comprising application of a nontoxic amount, effective for increasing the resistance of plants to abiotic stress factors, of one or more of the compounds of the formula (I) or one or more salts thereof.

5. The method as claimed in claim 4, wherein the abiotic stress conditions are one or more conditions selected from the group consisting of aridity, cold stress, heat stress, drought stress, osmotic stress, waterlogging, elevated soil salinity, elevated exposure to minerals, ozone conditions, strong light conditions, limited availability of nitrogen nutrients and limited availability of phosphorus nutrients.

6. The method as claimed in claim 1 in spray application to plants and parts of plants in combinations with one or more active compounds selected from the group of the insecticides, attractants, acaricides, fungicides, nematicides, herbicides, growth regulators, safeners, substances which affect plant maturity and bactericides.

7. The method as claimed in claim 1 in spray application to plants and parts of plants in combinations with fertilizers.

8. The method as claimed in claim 1 for application to genetically modified cultivars, seed thereof, and/or to one or more cultivated areas on which cultivars grow.

9. The method of claim 1 that comprises use of a spray solution comprising one or more of the compounds of formula (I) and/or salts thereof for enhancing resistance of one or more plants to one or more abiotic stress factors.

10. A method of claim 1 for increasing stress tolerance in one or more plants selected from the group of useful plants, ornamental plants, turfgrasses and trees, comprising applying a sufficient nontoxic amount of one or more compounds of formula (I) and/or one or more salts thereof to an area where a corresponding effect is desired, and/or comprising applying to one or more plants, seed thereof and/or to an area on which plants grow.

11. Substituted oxotetrahydroquinolinylsulfonamide of formula (I) and/or a salt thereof 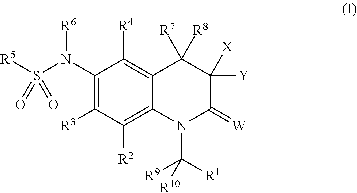
in which
R¹ is halogen, cyano, (C₃-C₁₀)-cycloalkyl, (C₃-C₁₀)-halocycloalkyl, (C₄-C₁₀)-cycloalkenyl, (C₄-C₁₀)-halocycloalkenyl, (C₁-C₁₀)-haloalkyl, (C₁-C₈)-alkoxy-(C₁-C₈)-haloalkyl, (C₃-C₈)-cycloalkyl-(C₁-C₈)-alkyl, (C₁-C₈)-alkylcarbonyl-(C₁-C₈)-alkyl, hydroxycarbonyl-(C₁-C₈)-alkyl, (C₁-C₈)-alkoxycarbonyl-(C₁-C₈)-alkyl, (C₂-C₈)-alkenyloxycarbonyl-(C₁-C₈)-alkyl, (C₂-C₈)-alkynyloxycarbonyl-(C₁-C₈)-alkyl, aryl-(C₁-C₈)-alkoxycarbonyl-(C₁-C₈)-alkyl, (C₃-C₈)-cycloalkoxycarbonyl-(C₁-C₈)-alkyl, (C₃-C₈)-cycloalkyl-(C₁-C₈)-alkoxycarbonyl-(C₁-C₈)-alkyl, aminocarbonyl-(C₁-C₈)-alkyl, (C₁-C₈)-alkylaminocarbonyl-(C₁-C₈)-alkyl, (C₃-C₈)-cycloalkylaminocarbonyl-(C₁-C₈)-alkyl, aryl-(C₁-C₈)-alkylaminocarbonyl-(C₁-C₈)-alkyl, heteroaryl-(C₁-C₈)-alkylaminocarbonyl-(C₁-C₈)-alkyl, (C₁-C₈)-alkylthio-(C₁-C₈)-alkyl, (C₃-C₈)-cycloalkylthio-(C₁-C₈)-alkyl, arylthio-(C₁-C₈)-alkyl, heterocyclylthio-(C₁-C₈)-alkyl, heteroarylthio-(C₁-C₈)-alkyl, aryl-(C₁-C₈)-alkylthio-(C₁-C₈)-alkyl, (C₁-C₈)-alkylsulfinyl-(C₁-C₈)-alkyl, (C₁-C₈)-alkylsulfonyl-(C₁-C₈)-alkyl, arylsulfinyl-(C₁-C₈)-alkyl, arylsulfonyl-(C₁-C₈)-alkyl, (C₃-C₈)-cycloalkylsulfinyl-(C₁-C₈)-alkyl, (C₃-C₈)-cycloalkylsulfonyl-(C₁-C₈)-alkyl, (C₁-C₈)-alkoxy-(C₁-C₈)-alkoxy-(C₁-C₈)-alkyl, (C₁-C₈)-alkylcarbonyl, (C₁-C₈)-haloalkylcarbonyl, (C₃-C₈)-cycloalkylcarbonyl, hydroxycarbonyl, (C₁-C₈)-alkoxycarbonyl, (C₂-C₈)-alkenyloxycarbonyl, (C₂-C₈)-alkynyloxycarbonyl, aryl-(C₁-C₈)-alkoxycarbonyl, (C₃-C₈)-cycloalkyl-(C₁-C₈)-alkoxycarbonyl, arylcarbonyl, heteroarylcarbonyl, heterocyclylcarbonyl, aryl-(C₁-C₈)-alkylcarbonyl, (C₁-C₈)-alkylaminocarbonyl, (C₃-C₈)-cycloalkylaminocarbonyl, arylaminocarbonyl, aryl-(C₁-C₈)-alkylaminocarbonyl, heteroarylaminocarbonyl, heterocyclylaminocarbonyl, heteroaryl-(C₁-C₈)-alkylaminocarbonyl, heterocyclyl-(C₁-C₈)-alkylaminocarbonyl, (C₁-C₈)-alkylsulfonyl, (C₃-C₈)-cycloalkylsulfonyl, arylsulfonyl, aryl-(C₁-C₈)-alkylsulfonyl, heteroarylsulfonyl, heterocyclylsulfonyl, cyano-(C₁-C₈)-alkyl, (C₄-C₈)-cycloalkenyl-(C₁-C₈)-alkyl, nitro-(C₁-C₈)-alkyl, (C₁-C₈)-haloalkoxy-(C₁-C₈)-alkyl, (C₁-C₈)-haloalkylthio-(C₁-C₈)-alkyl, bis-[(C₁-C₈)-alkyl]aminocarbonyl, (C₃-C₈)-cycloalkyl-[(C₁-C₈)-alkyl]aminocarbonyl, aryl-[(C₁-C₈)-alkyl]aminocarbonyl, aryl-(C₁-C₈)-alkyl-[(C₁-C₈)-alkyl]aminocarbonyl, (C₂-C₈)-alkenylaminocarbonyl, (C₂-C₈)-alkynylaminocarbonyl, (C₁-C₈)-alkylaminosulfonyl, bis-[(C₁-C₈)-alkyl]aminosulfonyl, heterocyclylsulfinyl-(C₁-C₈)-alkyl, heteroarylsulfinyl-(C₁-C₈)-alkyl, aryl-(C₁-C₈)-alkylsulfinyl-(C₁-C₈)-alkyl, heterocyclylsulfonyl-(C₁-C₈)-alkyl, heteroarylsulfonyl-(C₁-C₈)-alkyl, aryl-(C₁-C₈)-alkylsulfonyl-(C₁-C₈)-alkyl, bis-[(C₁-C₈)-alkyl]aminocarbonyl-(C₁-C₈)-alkyl, (C₃-C₈)-cycloalkyl-[(C₁-C₈)-alkyl]aminocarbonyl-(C₁-C₈)-alkyl, aryl-[(C₁-C₈)-alkyl]aminocarbonyl-(C₁-C₈)-alkyl, aryl-(C₁-C₈)-alkyl-[(C₁-C₈)-alkyl]aminocarbonyl-(C₁-C₈)-alkyl, (C₂-C₈)-alkenylaminocarbonyl-(C₁-C₈)-alkyl, (C₂-C₈)-alkynylaminocarbonyl-(C₁-C₈)-alkyl, (C₁-C₈)-alkylamino, bis-[(C₁-C₈)-alkyl]amino, (C₃-C₈)-cycloalkyl[(C₁-C₈)-alkyl]amino, amino, (C₂-C₈)-alkenylamino, (C₂-C₈)-alkynylamino, arylamino, heteroarylamino, aryl-(C₁-C₈)-alkylamino, heteroaryl-(C₁-C₈)-alkylamino, heterocyclylamino, heterocyclyl-(C₁-C₈)-alkylamino, (C₂-C₈)-alkenylcarbonyl-(C₁-C₈)-alkyl, (C₂-C₈)-alkynylcarbonyl-(C₁-C₈)-alkyl, (C₃-C₈)-cycloalkyl-(C₁-C₈)-alkylaminocarbonyl-(C₁-C₈)-alkyl, (C₃-C₈)-cycloalkyl-(C₁-C₈)-alkyl-[(C₁-C₈)-alkyl]aminocarbonyl-(C₁-C₈)-alkyl, (C₂-C₈)-alkenylsulfonyl-(C₁-C₈)-alkyl, (C₂-C₈)-alkynylsulfonyl-(C₁-C₈)-alkyl, heteroaryl-(C₁-C₈)-alkylsulfonyl-(C₁-C₈)-alkyl, heterocyclyl-(C₁-C₈)-alkylsulfonyl-(C₁-C₈)-alkyl, (C₂-C₈)-alkenylsulfinyl-(C₁-C₈)-alkyl, (C₂-C₈)-alkynylsulfinyl-(C₁-C₈)-alkyl, heteroaryl-(C₁-C₈)-alkylsulfinyl-(C₁-C₈)-alkyl, heterocyclyl-(C₁-C₈)-alkylsulfinyl-(C₁-C₈)-alkyl, (C2-C₈)-alkenyloxy-(C₁-C₈)-alkoxy-(C₁-C₈)-alkyl, (C₂-C₈)-alkynyloxy-(C₁-C₈)-alkoxy-(C₁-C₈)-alkyl, heteroaryl-(C₁-C₈)-alkoxy-(C₁-C₈)-alkyl, heterocyclyl-(C₁-C₈)-alkoxy-(C₁-C₈)-alkyl, tris[(C₁-C₈)-alkyl]silyl, tris[(C₁-C₈)-alkyl]silyl-(C₁-C₈)-alkyl, (C₁-C₈)-alkoxy, (C₁-C₈)-haloalkoxy, (C₁-C₈)-alkylamino-(C₁-C₈)-alkyl, bis-[(C₁-C₈)-alkyl]amino-(C₁-C₈)-alkyl, (C₃-C₈)-cycloalkyl[(C₁-C₈)-alkyl]amino-(C₁-C₈)-alkyl, amino-(C₁-C₈)-alkyl, (C₂-C₈)-alkenylamino-(C₁-C₈)-alkyl, (C₂-C₈)-alkynylamino-(C₁-C₈)-alkyl, arylamino-(C₁-C₈)-alkyl, heteroarylamino-(C₁-C₈)-alkyl, aryl-(C₁-C₈)-alkylamino-(C₁-C₈)-alkyl, heteroaryl-(C₁-C₈)-alkylamino-(C₁-C₈)-alkyl, heterocyclylamino-(C₁-C₈)-alkyl, heterocyclyl-(C₁-C₈)-alkylamino-(C₁-C₈)-alkyl, (C₁-C₈)-haloalkoxy-(C₁-C₆)-haloalkyl, (C₂-C₈)-alkenyloxy-(C₁-C₆)-haloalkyl, (C₂-C₈)-alkynyloxy-(C₁-C₆)-haloalkyl, (C₁-C₈)-alkoxy-(C₁-C₈)-alkoxy-(C₁-C₆)-haloalkyl, (C₃-C₈)-cycloalkyl-(C₁-C₈)-alkoxy-(C₁-C₆)-haloalkyl, (C₃-C₈)-cycloalkyl-(C₁-C₈)-alkoxy-(C₁-C₈)-alkyl, (C₁-C₈)-alkoxy-(C₁-C₈)-alkoxy, (C₁-C₈)-alkoxycarbonyl-(C₃-C₈)-cycloalkyl,
R², R³, R⁴ are each independently hydrogen, halogen, (C₁-C₈)-alkoxy, (C₁-C₈)-alkyl, (C₁-C₈)-haloalkyl, (C₁-C₈)-haloalkoxy, (C₁-C₈)-alkylthio, (C₁-C₈)-haloalkylthio, aryl, aryl-(C₁-C₈)-alkyl, heteroaryl, heteroaryl-(C₁-C₈)-alkyl, heterocyclyl, heterocyclyl-(C₁-C₈)-alkyl, (C₃-C₈)-cycloalkyl, nitro, amino, hydroxyl, (C₁-C₈)-alkylamino, bis-[(C₁-C₈)-alkyl]amino, hydrothio, (C₁-C₈)-alkylcarbonylamino, (C₃-C₈)-cycloalkylcarbonylamino, arylcarbonylamino, heteroarylcarbonylamino, heterocyclylcarbonylamino, formyl, hydroxyiminomethyl, (C₁-C₈)-alkoxyiminomethyl, (C₃-C₈)-cycloalkoxyiminomethyl, aryloxyiminomethyl, (C₃-C₈)-cycloalkyl-(C₁-C₈)-alkoxyiminomethyl, thiocyanato, isothiocyanato, aryloxy, heteroaryloxy, (C₃-C₈)-cycloalkoxy, (C₃-C₈)-cycloalkyl-(C₁-C₈)-alkoxy, aryl-(C₁-C₈)-alkoxy, (C₂-C₈)-alkynyl, (C₂-C₈)-alkenyl, aryl-(C₁-C₈)-alkynyl, tris-[(C₁-C₈)-alkyl]silyl-(C₂-C₈)-alkynyl, bis-[(C₁-C₈)-alkyl](aryl)silyl-(C₂-C₈)-alkynyl, bis-aryl[(C₁-C₈)-alkyl]silyl-(C₂-C₈)-alkynyl, (C₃-C₈)-cycloalkyl-(C₂-C₈)-alkynyl, aryl-(C₂-C₈)-alkenyl, heteroaryl-(C₂-C₈)-alkenyl, (C₃-C₈)-cycloalkyl-(C₂-C₈)-alkenyl, (C₃-C₈)-cycloalkyl-(C₂-C₈)-alkyl, (C₂-C₈)-haloalkynyl, (C₂-C₈)-haloalkenyl, (C₄-C₈)-cycloalkenyl, (C₁-C₈)-alkoxy-(C₁-C₈)-alkoxy-(C₁-C₈)-alkyl, (C₁-C₈)-alkylsulfonyl, arylsulfonyl, heteroarylsulfonyl, (C₁-C₈)-alkylsulfonylamino, arylsulfonylamino, aryl-(C₁-C₈)-alkylsulfonylamino, heteroarylsulfonylamino, heteroaryl-(C₁-C₈)-alkylsulfonylamino, bis-[(C₁-C₈)-alkyl]aminosulfonyl,
R⁵ is amino, (C₁-C₈)-alkyl, (C₃-C₈)-cycloalkyl, (C₃-C₈)-cycloalkyl-(C₁-C₈)-alkyl, (C₁-C₈)-haloalkyl, (C₃-C₈)-halocycloalkyl, (C₄-C₈)-cycloalkenyl, aryl, heteroaryl, heterocyclyl, aryl-(C₁-C₈)-alkyl, heteroaryl-(C₁-C₈)-alkyl, heterocyclyl-(C₁-C₈)-alkyl, (C₁-C₈)-alkoxycarbonyl-(C₁-C₈)-alkyl, aryl-(C₁-C₈)-alkoxycarbonyl-(C₁-C₈)-alkyl, (C₃-C₈)-cycloalkoxycarbonyl-(C₁-C₈)-alkyl, (C₃-C₈)-cycloalkyl-(C₁-C₈)-alkoxycarbonyl-(C₁-C₈)-alkyl, heteroaryl-(C₁-C₈)-alkoxycarbonyl-(C₁-C₈)-alkyl, aminocarbonyl-(C₁-C₈)-alkyl, (C₁-C₈)-alkylaminocarbonyl-(C₁-C₈)-alkyl, (C₃-C₈)-cycloalkylaminocarbonyl-(C₁-C₈)-alkyl, aryl-(C₁-C₈)-alkylaminocarbonyl-(C₁-C₈)-alkyl, (C₁-C₈)-alkylamino, bis-[(C₁-C₈)-alkyl]amino, arylamino, (C₃-C₈)-cycloalkylamino, aryl-(C₁-C₈)-alkylamino, heteroaryl-(C₁-C₈)-alkylamino, heteroarylamino, heterocyclylamino, (C₂-C₈)-alkenylamino, (C₂-C₈)-alkynylamino, aryloxy-(C₁-C₈)-alkyl, heteroaryloxy-(C₁-C₈)-alkyl, (C₁-C₈)-alkoxy-(C₁-C₈)-alkyl, (C₂-C₈)-alkenyl, (C₂-C₈)-alkynyl, cyano-(C₁-C₈)-alkyl, aryloxy, aryl-(C₂-C₈)-alkenyl, heteroaryl-(C₂-C₈)-alkenyl, heterocyclyl-(C₂-C₈)-alkenyl,
R⁶ is hydrogen, (C₁-C₈)-alkyl, (C₃-C₈)-cycloalkyl, cyano-(C₁-C₈)-alkyl, (C₃-C₈)-cycloalkyl-(C₁-C₈)-alkyl, (C₁-C₈)-alkylsulfonyl, arylsulfonyl, aryl-(C₁-C₈)-alkylsulfonyl, heteroarylsulfonyl, (C₃-C₈)-cycloalkylsulfonyl, heterocyclylsulfonyl, (C₁-C₈)-alkylcarbonyl, arylcarbonyl, heteroarylcarbonyl, (C₃-C₈)-cycloalkylcarbonyl, heterocyclylcarbonyl, (C₁-C₈)-alkoxycarbonyl, aryl-(C₁-C₈)-alkoxycarbonyl, (C₁-C₈)-haloalkylcarbonyl, (C₂-C₈)-alkenyl, (C₂-C₈)-alkynyl, (C₁-C₈)-haloalkyl, aryl-(C₂-C₈)-alkenyl, halo-(C₂-C₈)-alkynyl, halo-(C₂-C₈)-alkenyl, (C₁-C₈)-alkoxy-(C₁-C₈)-alkyl,
R⁷, R⁸ are each independently hydrogen, hydroxyl, amino, (C₁-C₈)-alkylamino, bis[(C₁-C₈)-alkyl]amino, (C₃-C₈)-cycloalkylamino, (C₁-C₈)-alkyl, fluorine, chlorine, bromine, iodine, (C₂-C₈)-alkenyl, (C₂-C₈)-alkynyl, (C₁-C₈)-haloalkyl, hydroxy-(C₁-C₈)-alkyl, cyano-(C₁-C₈)-alkyl, nitro-(C₁-C₈)-alkyl, aryl, heteroaryl, (C₃-C₈)-cycloalkyl, (C₄-C₈)-cycloalkenyl, heterocyclyl, (C₁-C₈)-alkoxy, (C₁-C₈)-haloalkoxy, (C₁-C₈)-alkoxy-(C₁-C₈)-alkyl, (C₁-C₈)-alkylthio-(C₁-C₈)-alkyl, amino-(C₁-C₈)-alkyl, (C₁-C₈)-alkylamino-(C₁-C₈)-alkyl, (C₃-C₈)-cycloalkylamino-(C₁-C₈)-alkyl, aryl-(C₁-C₈)-alkylamino-(C₁-C₈)-alkyl, heteroaryl-(C₁-C₈)-alkylamino-(C₁-C₈)-alkyl, heterocyclyl-(C₁-C₈)-alkylamino-(C₁-C₈)-alkyl, heterocyclylamino-(C₁-C₈)-alkyl, heteroarylamino-(C₁-C₈)-alkyl, (C₁-C₈)-alkoxycarbonylamino-(C₁-C₈)-alkyl, arylamino-(C₁-C₈)-alkyl, aryl-(C₁-C₈)-alkoxycarbonylamino-(C₁-C₈)-alkyl, (C₃-C₈)-cycloalkoxycarbonylamino-(C₁-C₈)-alkyl, (C₃-C₈)-cycloalkyl-(C₁-C₈)-alkoxycarbonylamino-(C₁-C₈)-alkyl, heteroaryl-(C₁-C₈)-alkoxycarbonylamino-(C₁-C₈)-alkyl, (C₁-C₈)-alkylcarbonylamino-(C₁-C₈)-alkyl, (C₃-C₈)-cycloalkylcarbonylamino-(C₁-C₈)-alkyl, arylcarbonylamino-(C₁-C₈)-alkyl, heteroarylcarbonylamino-(C₁-C₈)-alkyl, heterocyclylcarbonylamino-(C₁-C₈)-alkyl, (C₂-C₈)-alkenyloxycarbonylamino-(C₁-C₈)-alkyl, aryl-(C₂-C₈)-alkenylamino-(C₁-C₈)-alkyl, hydroxycarbonyl, (C₁-C₈)-alkoxycarbonyl, (C₂-C₈)-alkenyloxycarbonyl, aryl-(C₁-C₈)-alkoxycarbonyl, aminocarbonyl, alkylaminocarbonyl, (C₃-C₈)-cycloalkylaminocarbonyl, aryl-(C₁-C₈)-alkylaminocarbonyl, heteroarylaminocarbonyl or
R⁷ and R⁸ together with the carbon atom to which they are bonded form a fully saturated or partly saturated 3- to 7-membered monocyclic or bicyclic ring optionally interrupted by heteroatoms and optionally having further substitution or
R⁷ and R⁸ together with the carbon atom to which they are bonded form an oxo group or
R⁷ and R⁸ together with the carbon atom to which they are bonded form an oxime group substituted by hydrogen, (C₁-C₈)-alkyl, (C₃-C₈)-cycloalkyl, (C₃-C₈)-cycloalkyl-(C₁-C₈)-alkyl, aryl, heteroaryl, aryl-(C₁-C₈)-alkyl, heteroaryl-(C₁-C₈)-alkyl,
R⁹, R¹⁰ are each independently hydrogen, (C₁-C₈)-alkyl, halogen, cyano, (C₁-C₈)-haloalkyl, cyano-(C₁-C₈)-alkyl, aryl, heteroaryl, (C₃-C₈)-cycloalkyl, (C₄-C₈)-cycloalkenyl, heterocyclyl, (C₁-C₈)-alkoxy-(C₁-C₈)-alkyl, (C₁-C₈)-alkylthio-(C₁-C₈)-alkyl,
W is oxygen or sulfur and
X, Y are each independently hydrogen, (C₁-C₈)-alkyl, halogen, (C₂-C₈)-alkenyl, (C2-C₈)-alkynyl, (C₁-C₈)-haloalkyl, hydroxy-(C₁-C₈)-alkyl, cyano-(C₁-C₈)-alkyl, aryl, heteroaryl, (C₃-C₈)-cycloalkyl, (C₄-C₈)-cycloalkenyl, heterocyclyl, cyano, nitro, hydroxyl, (C₁-C₈)-alkoxy, (C₁-C₈)-alkylthio, (C₁-C₈)-alkoxy-(C₁-C₈)-alkyl, (C₁-C₈)-alkylthio-(C₁-C₈)-alkyl, aryloxy, aryl-(C₁-C₈)-alkoxy, (C₁-C₈)-haloalkoxy, (C₁-C₈)-haloalkylthio, (C₁-C₈)-alkylamino, bis[(C₁-C₈)-alkyl]amino, (C₁-C₈)-alkoxy-(C₁-C₈)-alkoxy, amino-(C₁-C₈)-alkyl, (C₁-C₈)-alkylamino-(C₁-C₈)-alkyl, (C₃-C₈)-cycloalkylamino-(C₁-C₈)-alkyl, aryl-(C₁-C₈)-alkylamino-(C₁-C₈)-alkyl, heteroaryl-(C₁-C₈)-alkylamino-(C₁-C₈)-alkyl, heterocyclyl-(C₁-C₈)-alkylamino-(C₁-C₈)-alkyl, heterocyclylamino-(C₁-C₈)-alkyl, heteroarylamino-(C₁-C₈)-alkyl, (C₁-C₈)-alkoxycarbonylamino-(C₁-C₈)-alkyl, arylamino-(C₁-C₈)-alkyl, aryl-(C₁-C₈)-alkoxycarbonylamino-(C₁-C₈)-alkyl, (C₃-C₈)-cycloalkoxycarbonylamino-(C₁-C₈)-alkyl, (C₃-C₈)-cycloalkyl-(C₁-C₈)-alkoxycarbonylamino-(C₁-C₈)-alkyl, heteroaryl-(C₁-C₈)-alkoxycarbonylamino-(C₁-C₈)-alkyl, (C₁-C₈)-alkylcarbonylamino-(C₁-C₈)-alkyl, (C₃-C₈)-cycloalkylcarbonylamino-(C₁-C₈)-alkyl, arylcarbonylamino-(C₁-C₈)-alkyl, heteroarylcarbonylamino-(C₁-C₈)-alkyl, heterocyclylcarbonylamino-(C₁-C₈)-alkyl, (C₂-C₈)-alkenyloxycarbonylamino-(C₁-C₈)-alkyl, aryl-(C₂-C₈)-alkenylamino-(C₁-C₈)-alkyl or
X and Y together with the atom to which they are bonded form a fully saturated or partly saturated 3- to 7-membered monocyclic or bicyclic ring optionally interrupted by one or more heteroatoms and optionally having further substitution.

12. Substituted oxotetrahydroquinolinylsulfonamide of formula (I) and/or a salt thereof as claimed in claim 11,
in which
R¹ is halogen, cyano, (C₃-C₁₀)-cycloalkyl, (C₃-C₁₀)-halocycloalkyl, (C₄-C₁₀)-cycloalkenyl, (C₄-C₁₀)-halocycloalkenyl, (C₁-C₁₀)-haloalkyl, (C₁-C₇)-alkoxy-(C₁-C₇)-haloalkyl, (C₃-C₇)-cycloalkyl-(C₁-C₇)-alkyl, (C₁-C₇)-alkylcarbonyl-(C₁-C₇)-alkyl, hydroxycarbonyl-(C₁-C₇)-alkyl, (C₁-C₇)-alkoxycarbonyl-(C₁-C₇)-alkyl, (C₂-C₇)-alkenyloxycarbonyl-(C₁-C₇)-alkyl, (C₂-C₇)-alkynyloxycarbonyl-(C₁-C₇)-alkyl, aryl-(C₁-C₇)-alkoxycarbonyl-(C₁-C₇)-alkyl, (C₃-C₇)-cycloalkoxycarbonyl-(C₁-C₇)-alkyl, (C₃-C₇)-cycloalkyl-(C₁-C₇)-alkoxycarbonyl-(C₁-C₇)-alkyl, aminocarbonyl-(C₁-C₇)-alkyl, (C₁-C₇)-alkylaminocarbonyl-(C₁-C₇)-alkyl, (C₃-C₇)-cycloalkylaminocarbonyl-(C₁-C₇)-alkyl, aryl-(C₁-C₇)-alkylaminocarbonyl-(C₁-C₇)-alkyl, heteroaryl-(C₁-C₇)-alkylaminocarbonyl-(C₁-C₇)-alkyl, (C₁-C₇)-alkylthio-(C₁-C₇)-alkyl, (C₃-C₇)-cycloalkylthio-(C₁-C₇)-alkyl, arylthio-(C₁-C₇)-alkyl, heterocyclylthio-(C₁-C₇)-alkyl, heteroarylthio-(C₁-C₇)-alkyl, aryl-(C₁-C₇)-alkylthio-(C₁-C₇)-alkyl, (C₁-C₇)-alkylsulfinyl-(C₁-C₇)-alkyl, (C₁-C₇)-alkylsulfonyl-(C₁-C₇)-alkyl, arylsulfinyl-(C₁-C₇)-alkyl, arylsulfonyl-(C₁-C₇)-alkyl, (C₃-C₇)-cycloalkylsulfinyl-(C₁-C₇)-alkyl, (C₃-C₇)-cycloalkylsulfonyl-(C₁-C₇)-alkyl, (C₁-C₇)-alkoxy-(C₁-C₇)-alkoxy-(C₁-C₇)-alkyl, (C₁-C₇)-alkylcarbonyl, (C₁-C₇)-haloalkylcarbonyl, (C₃-C₇)-cycloalkylcarbonyl, hydroxycarbonyl, (C₁-C₇)-alkoxycarbonyl, (C₂-C₇)-alkenyloxycarbonyl, (C₂-C₇)-alkynyloxycarbonyl, aryl-(C₁-C₇)-alkoxycarbonyl, (C₃-C₇)-cycloalkyl-(C₁-C₇)-alkoxycarbonyl, arylcarbonyl, heteroarylcarbonyl, heterocyclylcarbonyl, aryl-(C₁-C₇)-alkylcarbonyl, (C₁-C₇)-alkylaminocarbonyl, (C₃-C₇)-cycloalkylaminocarbonyl, arylaminocarbonyl, aryl-(C₁-C₇)-alkylaminocarbonyl, heteroarylaminocarbonyl, heterocyclylaminocarbonyl, heteroaryl-(C₁-C₇)-alkylaminocarbonyl, heterocyclyl-(C₁-C₇)-alkylaminocarbonyl, (C₁-C₇)-alkylsulfonyl, (C₃-C₇)-cycloalkylsulfonyl, arylsulfonyl, aryl-(C₁-C₇)-alkylsulfonyl, heteroarylsulfonyl, heterocyclylsulfonyl, cyano-(C₁-C₇)-alkyl, (C₄-C₇)-cycloalkenyl-(C₁-C₇)-alkyl, nitro-(C₁-C₇)-alkyl, (C₁-C₇)-haloalkoxy-(C₁-C₇)-alkyl, (C₁-C₇)-haloalkylthio-(C₁-C₇)-alkyl, bis-[(C₁-C₇)-alkyl]aminocarbonyl, (C₃-C₇)-cycloalkyl-[(C₁-C₇)-alkyl]aminocarbonyl, aryl-[(C₁-C₇)-alkyl]aminocarbonyl, aryl-(C₁-C₇)-alkyl-[(C₁-C₇)-alkyl]aminocarbonyl, (C₂-C₇)-alkenylaminocarbonyl, (C₂-C₇)-alkynylaminocarbonyl, (C₁-C₇)-alkylaminosulfonyl, bis-[(C₁-C₇)-alkyl]aminosulfonyl, heterocyclylsulfinyl-(C₁-C₇)-alkyl, heteroarylsulfinyl-(C₁-C₇)-alkyl, aryl-(C₁-C₇)-alkylsulfinyl-(C₁-C₇)-alkyl, heterocyclylsulfonyl-(C₁-C₇)-alkyl, heteroarylsulfonyl-(C₁-C₇)-alkyl, aryl-(C₁-C₇)-alkylsulfonyl-(C₁-C₇)-alkyl, bis-[(C₁-C₇)-alkyl]aminocarbonyl-(C₁-C₇)-alkyl, (C₃-C₇)-cycloalkyl-[(C₁-C₇)-alkyl]aminocarbonyl-(C₁-C₇)-alkyl, aryl-[(C₁-C₇)-alkyl]aminocarbonyl-(C₁-C₇)-alkyl, aryl-(C₁-C₇)-alkyl-[(C₁-C₇)-alkyl]aminocarbonyl-(C₁-C₇)-alkyl, (C₂-C₇)-alkenylaminocarbonyl-(C₁-C₇)-alkyl, (C₂-C₇)-alkynylaminocarbonyl-(C₁-C₇)-alkyl, (C₁-C₇)-alkylamino, bis-[(C₁-C₇)-alkyl]amino, (C₃-C₇)-cycloalkyl[(C₁-C₇)-alkyl]amino, amino, (C₂-C₇)-alkenylamino, (C₂-C₇)-alkynylamino, arylamino, heteroarylamino, aryl-(C₁-C₇)-alkylamino, heteroaryl-(C₁-C₇)-alkylamino, heterocyclylamino, heterocyclyl-(C₁-C₇)-alkylamino, (C₂-C₇)-alkenylcarbonyl-(C₁-C₇)-alkyl, (C₂-C₇)-alkynylcarbonyl-(C₁-C₇)-alkyl, (C₃-C₇)-cycloalkyl-(C₁-C₇)-alkylaminocarbonyl-(C₁-C₇)-alkyl, (C₃-C₇)-cycloalkyl-(C₁-C₇)-alkyl-[(C₁-C₇)-alkyl]aminocarbonyl-(C₁-C₇)-alkyl, (C₂-C₇)-alkenylsulfonyl-(C₁-C₇)-alkyl, (C₂-C₇)-alkynylsulfonyl-(C₁-C₇)-alkyl, heteroaryl-(C₁-C₇)-alkylsulfonyl-(C₁-C₇)-alkyl, heterocyclyl-(C₁-C₇)-alkylsulfonyl-(C₁-C₇)-alkyl, (C₂-C₇)-alkenylsulfinyl-(C₁-C₇)-alkyl, (C₂-C₇)-alkynylsulfinyl-(C₁-C₇)-alkyl, heteroaryl-(C₁-C₇)-alkylsulfinyl-(C₁-C₇)-alkyl, heterocyclyl-(C₁-C₇)-alkylsulfinyl-(C₁-C₇)-alkyl, (C₂-C₇)-alkenyloxy-(C₁-C₇)-alkoxy-(C₁-C₇)-alkyl, (C₂-C₇)-alkynyloxy-(C₁-C₇)-alkoxy-(C₁-C₇)-alkyl, heteroaryl-(C₁-C₇)-alkoxy-(C₁-C₇)-alkyl, heterocyclyl-(C₁-C₇)-alkoxy-(C₁-C₇)-alkyl, tris[(C₁-C₇)-alkyl]silyl, tris[(C₁-C₇)-alkyl]silyl-(C₁-C₇)-alkyl, (C₁-C₇)-alkoxy, (C₁-C₇)-haloalkoxy, (C₁-C₇)-alkylamino-(C₁-C₇)-alkyl, bis-[(C₁-C₇)-alkyl]amino-(C₁-C₇)-alkyl, (C₃-C₇)-cycloalkyl[(C₁-C₇)-alkyl]amino-(C₁-C₇)-alkyl, amino-(C₁-C₇)-alkyl, (C₂-C₇)-alkenylamino-(C₁-C₇)-alkyl, (C₂-C₇)-alkynylamino-(C₁-C₇)-alkyl, arylamino-(C₁-C₇)-alkyl, heteroarylamino-(C₁-C₇)-alkyl, aryl-(C₁-C₇)-alkylamino-(C₁-C₇)-alkyl, heteroaryl-(C₁-C₇)-alkylamino-(C₁-C₇)-alkyl, heterocyclylamino-(C₁-C₇)-alkyl, heterocyclyl-(C₁-C₇)-alkylamino-(C₁-C₇)-alkyl, (C₁-C₇)-haloalkoxy-(C₁-C₆)-haloalkyl, (C₂-C₇)-alkenyloxy-(C₁-C₆)-haloalkyl, (C₂-C₇)-alkynyloxy-(C₁-C₆)-haloalkyl, (C₁-C₇)-alkoxy-(C₁-C₇)-alkoxy-(C₁-C₆)-haloalkyl, (C₃-C₇)-cycloalkyl-(C₁-C₇)-alkoxy-(C₁-C₆)-haloalkyl, (C₃-C₇)-cycloalkyl-(C₁-C₇)-alkoxy-(C₁-C₇)-alkyl, (C₁-C₇)-alkoxy-(C₁-C₇)-alkoxy, (C₁-C₇)-alkoxycarbonyl-(C₃-C₇)-cycloalkyl,
R², R³, R⁴ are each independently hydrogen, halogen, (C₁-C₇)-alkoxy, (C₁-C₇)-alkyl, (C₁-C₇)-haloalkyl, (C₁-C₇)-haloalkoxy, (C₁-C₇)-alkylthio, (C₁-C₇)-haloalkylthio, aryl, aryl-(C₁-C₇)-alkyl, heteroaryl, heteroaryl-(C₁-C₇)-alkyl, heterocyclyl, heterocyclyl-(C₁-C₇)-alkyl, (C₃-C₇)-cycloalkyl, nitro, amino, hydroxyl, (C₁-C₇)-alkylamino, bis-[(C₁-C₇)-alkyl]amino, hydrothio, (C₁-C₇)-alkylcarbonylamino, (C₃-C₇)-cycloalkylcarbonylamino, arylcarbonylamino, heteroarylcarbonylamino, heterocyclylcarbonylamino, formyl, hydroxyiminomethyl, (C₁-C₇)-alkoxyiminomethyl, (C₃-C₇)-cycloalkoxyiminomethyl, aryloxyiminomethyl, (C₃-C₇)-cycloalkyl-(C₁-C₇)-alkoxyiminomethyl, thiocyanato, isothiocyanato, aryloxy, heteroaryloxy, (C₃-C₇)-cycloalkoxy, (C₃-C₇)-cycloalkyl-(C₁-C₇)-alkoxy, aryl-(C₁-C₇)-alkoxy, (C₂-C₇)-alkynyl, (C₂-C₇)-alkenyl, aryl-(C₁-C₇)-alkynyl, tris-[(C₁-C₇)-alkyl]silyl-(C₂-C₇)-alkynyl, bis-[(C₁-C₇)-alkyl](aryl)silyl-(C₂-C₇)-alkynyl, bis-aryl[(C₁-C₇)-alkyl]silyl-(C₂-C₇)-alkynyl, (C₃-C₇)-cycloalkyl-(C₂-C₇)-alkynyl, aryl-(C₂-C₇)-alkenyl, heteroaryl-(C₂-C₇)-alkenyl, (C₃-C₇)-cycloalkyl-(C₂-C₇)-alkenyl, (C₃-C₇)-cycloalkyl-(C₂-C₇)-alkyl, (C₂-C₇)-haloalkynyl, (C₂-C₇)-haloalkenyl, (C₄-C₇)-cycloalkenyl, (C₁-C₇)-alkoxy-(C₁-C₇)-alkoxy-(C₁-C₇)-alkyl, (C₁-C₇)-alkylsulfonyl, arylsulfonyl, heteroarylsulfonyl, (C₁-C₇)-alkylsulfonylamino, arylsulfonylamino, aryl-(C₁-C₇)-alkylsulfonylamino, heteroarylsulfonylamino, heteroaryl-(C₁-C₇)-alkylsulfonylamino, bis-[(C₁-C₇)-alkyl]aminosulfonyl,
R⁵ is amino, (C₁-C₇)-alkyl, (C₃-C₇)-cycloalkyl, (C₃-C₇)-cycloalkyl-(C₁-C₇)-alkyl, (C₁-C₇)-haloalkyl, (C₃-C₇)-halocycloalkyl, (C₄-C₇)-cycloalkenyl, aryl, heteroaryl, heterocyclyl, aryl-(C₁-C₇)-alkyl, heteroaryl-(C₁-C₇)-alkyl, heterocyclyl-(C₁-C₇)-alkyl, (C₁-C₇)-alkoxycarbonyl-(C₁-C₇)-alkyl, aryl-(C₁-C₇)-alkoxycarbonyl-(C₁-C₇)-alkyl, (C₃-C₇)-cycloalkoxycarbonyl-(C₁-C₇)-alkyl, (C₃-C₇)-cycloalkyl-(C₁-C₇)-alkoxycarbonyl-(C₁-C₇)-alkyl, heteroaryl-(C₁-C₇)-alkoxycarbonyl-(C₁-C₇)-alkyl, aminocarbonyl-(C₁-C₇)-alkyl, (C₁-C₇)-alkylaminocarbonyl-(C₁-C₇)-alkyl, (C₃-C₇)-cycloalkylaminocarbonyl-(C₁-C₇)-alkyl, aryl-(C₁-C₇)-alkylaminocarbonyl-(C₁-C₇)-alkyl, (C₁-C₇)-alkylamino, bis-[(C₁-C₇)-alkyl]amino, arylamino, (C₃-C₇)-cycloalkylamino, aryl-(C₁-C₇)-alkylamino, heteroaryl-(C₁-C₇)-alkylamino, heteroarylamino, heterocyclylamino, (C₂-C₇)-alkenylamino, (C₂-C₇)-alkynylamino, aryloxy-(C₁-C₇)-alkyl, heteroaryloxy-(C₁-C₇)-alkyl, (C₁-C₇)-alkoxy-(C₁-C₇)-alkyl, (C₂-C₇)-alkenyl, (C₂-C₇)-alkynyl, cyano-(C₁-C₇)-alkyl, aryloxy, aryl-(C₂-C₇)-alkenyl, heteroaryl-(C₂-C₇)-alkenyl, heterocyclyl-(C₂-C₇)-alkenyl,
R⁶ is hydrogen, (C₁-C₇)-alkyl, (C₃-C₇)-cycloalkyl, cyano-(C₁-C₇)-alkyl, (C₃-C₇)-cycloalkyl-(C₁-C₇)-alkyl, (C₁-C₇)-alkylsulfonyl, arylsulfonyl, aryl-(C₁-C₇)-alkylsulfonyl, heteroarylsulfonyl, (C₃-C₇)-cycloalkylsulfonyl, heterocyclylsulfonyl, (C₁-C₇)-alkylcarbonyl, arylcarbonyl, heteroarylcarbonyl, (C₃-C₇)-cycloalkylcarbonyl, heterocyclylcarbonyl, (C₁-C₇)-alkoxycarbonyl, aryl-(C₁-C₇)-alkoxycarbonyl, (C₁-C₇)-haloalkylcarbonyl, (C₂-C₇)-alkenyl, (C₂-C₇)-alkynyl, (C₁-C₇)-haloalkyl, aryl-(C₂-C₇)-alkenyl, halo-(C₂-C₇)-alkynyl, halo-(C₂-C₇)-alkenyl, (C₁-C₇)-alkoxy-(C₁-C₇)-alkyl,
R⁷, R⁸ are each independently hydrogen, hydroxyl, amino, (C₁-C₇)-alkylamino, bis[(C₁-C₇)-alkyl]amino, (C₃-C₇)-cycloalkylamino, (C₁-C₇)-alkyl, fluorine, chlorine, bromine, iodine, (C₂-C₇)-alkenyl, (C₂-C₇)-alkynyl, (C₁-C₇)-haloalkyl, hydroxy-(C₁-C₇)-alkyl, cyano-(C₁-C₇)-alkyl, nitro-(C₁-C₇)-alkyl, aryl, heteroaryl, (C₃-C₇)-cycloalkyl, (C₄-C₇)-cycloalkenyl, heterocyclyl, (C₁-C₇)-alkoxy, (C₁-C₇)-haloalkoxy, (C₁-C₇)-alkoxy-(C₁-C₇)-alkyl, (C₁-C₇)-alkylthio-(C₁-C₇)-alkyl, amino-(C₁-C₇)-alkyl, (C₁-C₇)-alkylamino-(C₁-C₇)-alkyl, (C₃-C₇)-cycloalkylamino-(C₁-C₇)-alkyl, aryl-(C₁-C₇)-alkylamino-(C₁-C₇)-alkyl, heteroaryl-(C₁-C₇)-alkylamino-(C₁-C₇)-alkyl, heterocyclyl-(C₁-C₇)-alkylamino-(C₁-C₇)-alkyl, heterocyclylamino-(C₁-C₇)-alkyl, heteroarylamino-(C₁-C₇)-alkyl, (C₁-C₇)-alkoxycarbonylamino-(C₁-C₇)-alkyl, arylamino-(C₁-C₇)-alkyl, aryl-(C₁-C₇)-alkoxycarbonylamino-(C₁-C₇)-alkyl, (C₃-C₇)-cycloalkoxycarbonylamino-(C₁-C₇)-alkyl, (C₃-C₇)-cycloalkyl-(C₁-C₇)-alkoxycarbonylamino-(C₁-C₇)-alkyl, heteroaryl-(C₁-C₇)-alkoxycarbonylamino-(C₁-C₇)-alkyl, (C₁-C₇)-alkylcarbonylamino-(C₁-C₇)-alkyl, (C₃-C₇)-cycloalkylcarbonylamino-(C₁-C₇)-alkyl, arylcarbonylamino-(C₁-C₇)-alkyl, heteroarylcarbonylamino-(C₁-C₇)-alkyl, heterocyclylcarbonylamino-(C₁-C₇)-alkyl, (C₂-C₇)-alkenyloxycarbonylamino-(C₁-C₇)-alkyl, aryl-(C₂-C₇)-alkenylamino-(C₁-C₇)-alkyl, hydroxycarbonyl, (C₁-C₇)-alkoxycarbonyl, (C₂-C₇)-alkenyloxycarbonyl, aryl-(C₁-C₇)-alkoxycarbonyl, aminocarbonyl, alkylaminocarbonyl, (C₃-C₇)-cycloalkylaminocarbonyl, aryl-(C₁-C₇)-alkylaminocarbonyl, heteroarylaminocarbonyl or
R⁷ and R⁸ together with the carbon atom to which they are bonded form a fully saturated or partly saturated 3- to 7-membered monocyclic or bicyclic ring optionally interrupted by heteroatoms and optionally having further substitution or
R⁷ and R⁸ together with the carbon atom to which they are bonded form an oxo group or
R⁷ and R⁸ together with the carbon atom to which they are bonded form an oxime group substituted by hydrogen, (C₁-C₇)-alkyl, (C₃-C₇)-cycloalkyl, (C₃-C₇)-cycloalkyl-(C₁-C₇)-alkyl, aryl, heteroaryl, aryl-(C₁-C₇)-alkyl, heteroaryl-(C₁-C₇)-alkyl,
R⁹, R¹⁰ are each independently hydrogen, (C₁-C₇)-alkyl, halogen, cyano, (C₁-C₇)-haloalkyl, cyano-(C₁-C₇)-alkyl, aryl, heteroaryl, (C₃-C₇)-cycloalkyl, (C₄-C₇)-cycloalkenyl, heterocyclyl, (C₁-C₇)-alkoxy-(C₁-C₇)-alkyl, (C₁-C₇)-alkylthio-(C₁-C₇)-alkyl,
W is oxygen or sulfur and
X, Y are each independently hydrogen, (C₁-C₇)-alkyl, halogen, (C₂-C₇)-alkenyl, (C2-C₇)-alkynyl, (C₁-C₇)-haloalkyl, hydroxy-(C₁-C₇)-alkyl, cyano-(C₁-C₇)-alkyl, aryl, heteroaryl, (C₃-C₇)-cycloalkyl, (C₄-C₇)-cycloalkenyl, heterocyclyl, cyano, nitro, hydroxyl, (C₁-C₇)-alkoxy, (C₁-C₇)-alkylthio, (C₁-C₇)-alkoxy-(C₁-C₇)-alkyl, (C₁-C₇)-alkylthio-(C₁-C₇)-alkyl, aryloxy, aryl-(C₁-C₇)-alkoxy, (C₁-C₇)-haloalkoxy, (C₁-C₇)-haloalkylthio, (C₁-C₇)-alkylamino, bis[(C₁-C₇)-alkyl]amino, (C₁-C₇)-alkoxy-(C₁-C₇)-alkoxy, amino-(C₁-C₇)-alkyl, (C₁-C₇)-alkylamino-(C₁-C₇)-alkyl, (C₃-C₇)-cycloalkylamino-(C₁-C₇)-alkyl, aryl-(C₁-C₇)-alkylamino-(C₁-C₇)-alkyl, heteroaryl-(C₁-C₇)-alkylamino-(C₁-C₇)-alkyl, heterocyclyl-(C₁-C₇)-alkylamino-(C₁-C₇)-alkyl, heterocyclylamino-(C₁-C₇)-alkyl, heteroarylamino-(C₁-C₇)-alkyl, (C₁-C₇)-alkoxycarbonylamino-(C₁-C₇)-alkyl, arylamino-(C₁-C₇)-alkyl, aryl-(C₁-C₇)-alkoxycarbonylamino-(C₁-C₇)-alkyl, (C₃-C₇)-cycloalkoxycarbonylamino-(C₁-C₇)-alkyl, (C₃-C₇)-cycloalkyl-(C₁-C₇)-alkoxycarbonylamino-(C₁-C₇)-alkyl, heteroaryl-(C₁-C₇)-alkoxycarbonylamino-(C₁-C₇)-alkyl, (C₁-C₇)-alkylcarbonylamino-(C₁-C₇)-alkyl, (C₃-C₇)-cycloalkylcarbonylamino-(C₁-C₇)-alkyl, arylcarbonylamino-(C₁-C₇)-alkyl, heteroarylcarbonylamino-(C₁-C₇)-alkyl, heterocyclylcarbonylamino-(C₁-C₇)-alkyl, (C₂-C₇)-alkenyloxycarbonylamino-(C₁-C₇)-alkyl, aryl-(C₂-C₇)-alkenylamino-(C₁-C₇)-alkyl or
X and Y together with the atom to which they are bonded form a fully saturated or partly saturated 3- to 7-membered monocyclic or bicyclic ring optionally interrupted by one or more heteroatoms and optionally having further substitution.

13. Substituted oxotetrahydroquinolinylsulfonamide of formula (I) and/or a salt thereof as claimed in claim 11 which is described by one or more of formulae (Iaa) to (Ibi) 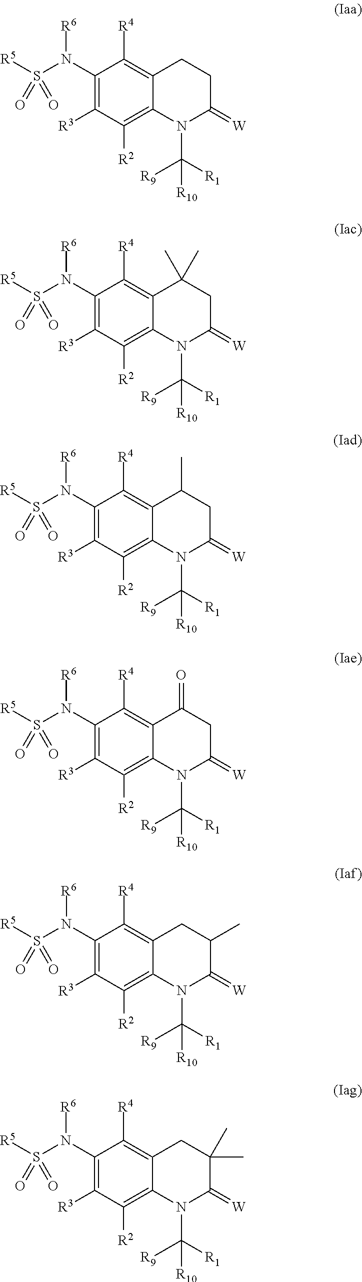 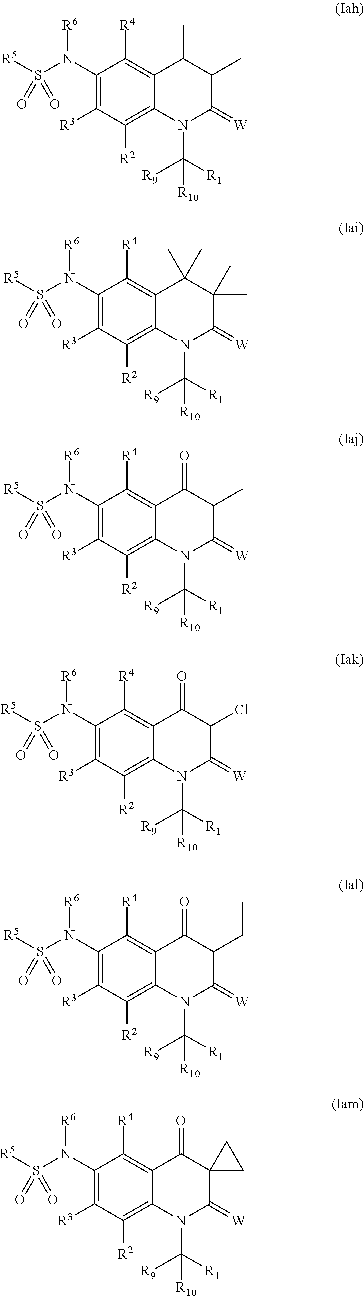 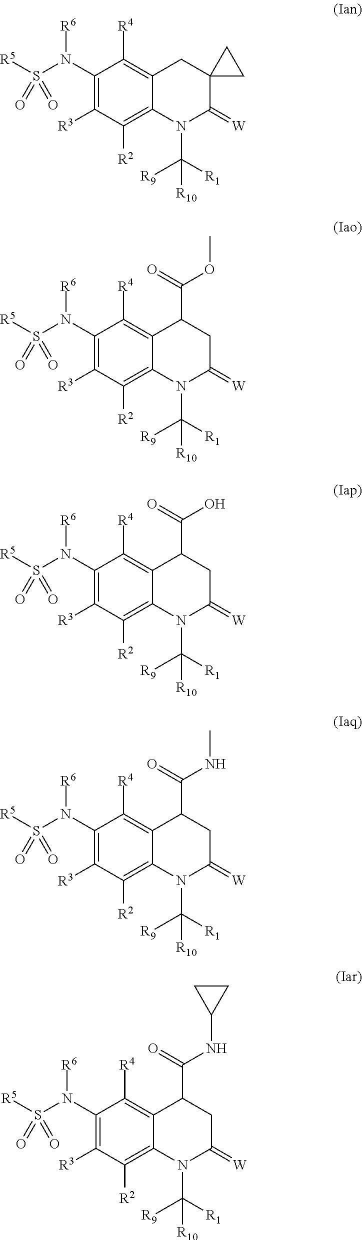 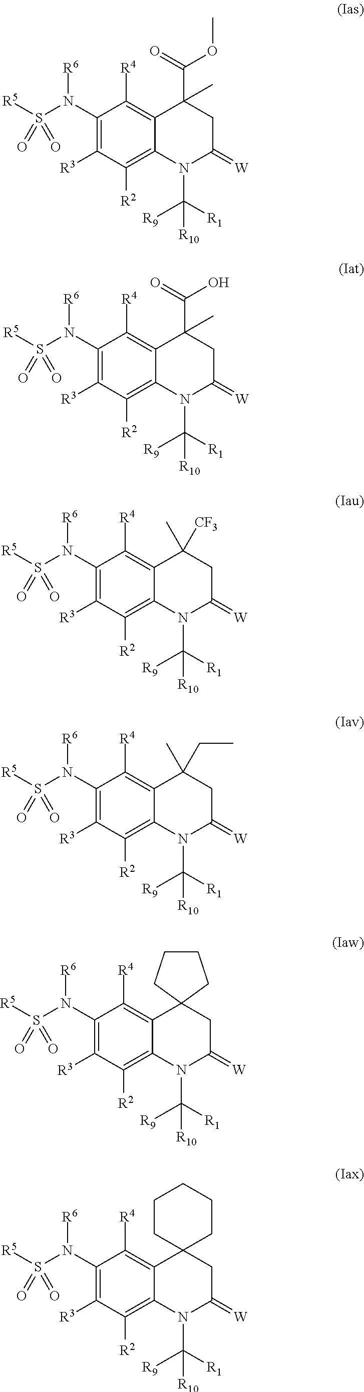 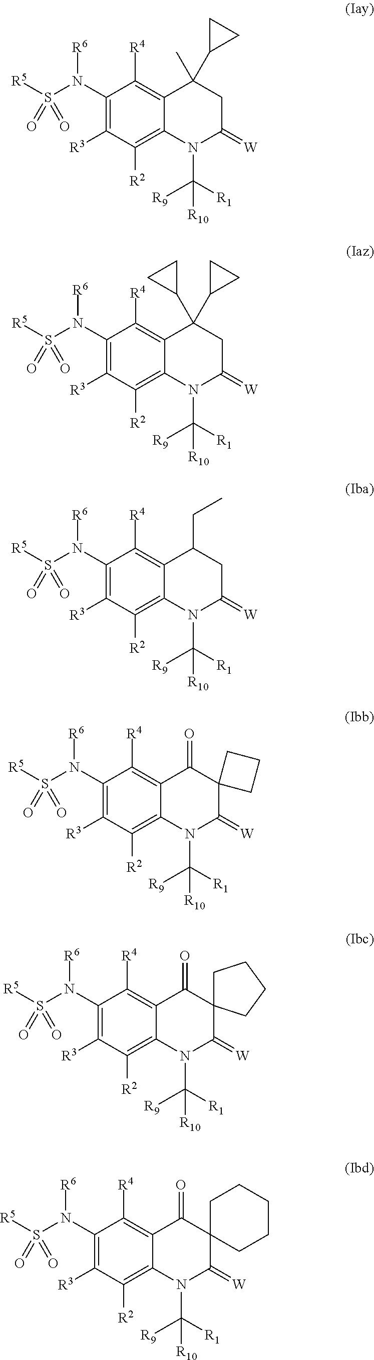 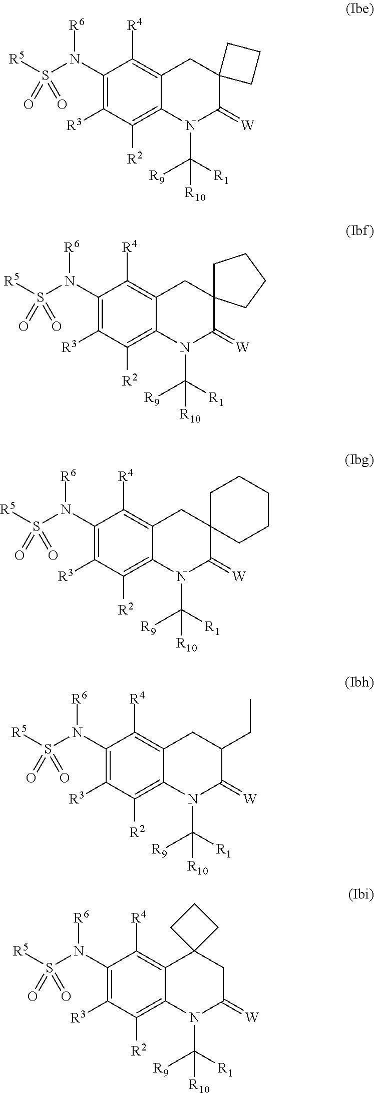
and in which
R¹ is halogen, cyano, (C₃-C₁₀)-cycloalkyl, (C₃-C₁₀)-halocycloalkyl, (C₄-C₁₀)-cycloalkenyl, (C₄-C₁₀)-halocycloalkenyl, (C₁-C₁₀)-haloalkyl, (C₁-C₆)-alkoxy-(C₁-C₆)-haloalkyl, (C₃-C₆)-cycloalkyl-(C₁-C₆)-alkyl, (C₁-C₆)-alkylcarbonyl-(C₁-C₆)-alkyl, hydroxycarbonyl-(C₁-C₆)-alkyl, (C₁-C₆)-alkoxycarbonyl-(C₁-C₆)-alkyl, (C₂-C₆)-alkenyloxycarbonyl-(C₁-C₆)-alkyl, (C₂-C₆)-alkynyloxycarbonyl-(C₁-C₆)-alkyl, aryl-(C₁-C₆)-alkoxycarbonyl-(C₁-C₆)-alkyl, (C₃-C₆)-cycloalkoxycarbonyl-(C₁-C₆)-alkyl, (C₃-C₆)-cycloalkyl-(C₁-C₆)-alkoxycarbonyl-(C₁-C₆)-alkyl, aminocarbonyl-(C₁-C₆)-alkyl, (C₁-C₆)-alkylaminocarbonyl-(C₁-C₆)-alkyl, (C₃-C₆)-cycloalkylaminocarbonyl-(C₁-C₆)-alkyl, aryl-(C₁-C₆)-alkylaminocarbonyl-(C₁-C₆)-alkyl, heteroaryl-(C₁-C₆)-alkylaminocarbonyl-(C₁-C₆)-alkyl, (C₁-C₆)-alkylthio-(C₁-C₆)-alkyl, (C₃-C₆)-cycloalkylthio-(C₁-C₆)-alkyl, arylthio-(C₁-C₆)-alkyl, heterocyclylthio-(C₁-C₆)-alkyl, heteroarylthio-(C₁-C₆)-alkyl, aryl-(C₁-C₆)-alkylthio-(C₁-C₆)-alkyl, (C₁-C₆)-alkylsulfinyl-(C₁-C₆)-alkyl, (C₁-C₆)-alkylsulfonyl-(C₁-C₆)-alkyl, arylsulfinyl-(C₁-C₆)-alkyl, arylsulfonyl-(C₁-C₆)-alkyl, (C₃-C₆)-cycloalkylsulfinyl-(C₁-C₆)-alkyl, (C₃-C₆)-cycloalkylsulfonyl-(C₁-C₆)-alkyl, (C₁-C₆)-alkoxy-(C₁-C₆)-alkoxy-(C₁-C₆)-alkyl, (C₁-C₆)-alkylcarbonyl, (C₁-C₆)-haloalkylcarbonyl, (C₃-C₆)-cycloalkylcarbonyl, hydroxycarbonyl, (C₁-C₆)-alkoxycarbonyl, (C₂-C₆)-alkenyloxycarbonyl, (C₂-C₆)-alkynyloxycarbonyl, aryl-(C₁-C₆)-alkoxycarbonyl, (C₃-C₆)-cycloalkyl-(C₁-C₆)-alkoxycarbonyl, arylcarbonyl, heteroarylcarbonyl, heterocyclylcarbonyl, aryl-(C₁-C₆)-alkylcarbonyl, (C₁-C₆)-alkylaminocarbonyl, (C₃-C₆)-cycloalkylaminocarbonyl, arylaminocarbonyl, aryl-(C₁-C₆)-alkylaminocarbonyl, heteroarylaminocarbonyl, heterocyclylaminocarbonyl, heteroaryl-(C₁-C₆)-alkylaminocarbonyl, heterocyclyl-(C₁-C₆)-alkylaminocarbonyl, (C₁-C₆)-alkylsulfonyl, (C₃-C₆)-cycloalkylsulfonyl, arylsulfonyl, aryl-(C₁-C₆)-alkylsulfonyl, heteroarylsulfonyl, heterocyclylsulfonyl, cyano-(C₁-C₆)-alkyl, (C₄-C₆)-cycloalkenyl-(C₁-C₆)-alkyl, nitro-(C₁-C₆)-alkyl, (C₁-C₆)-haloalkoxy-(C₁-C₆)-alkyl, (C₁-C₆)-haloalkylthio-(C₁-C₆)-alkyl, bis-[(C₁-C₆)-alkyl]aminocarbonyl, (C₃-C₆)-cycloalkyl-[(C₁-C₆)-alkyl]aminocarbonyl, aryl-[(C₁-C₆)-alkyl]aminocarbonyl, aryl-(C₁-C₆)-alkyl-[(C₁-C₆)-alkyl]aminocarbonyl, (C₂-C₆)-alkenylaminocarbonyl, (C₂-C₆)-alkynylaminocarbonyl, (C₁-C₆)-alkylaminosulfonyl, bis-[(C₁-C₆)-alkyl]aminosulfonyl, heterocyclylsulfinyl-(C₁-C₆)-alkyl, heteroarylsulfinyl-(C₁-C₆)-alkyl, aryl-(C₁-C₆)-alkylsulfinyl-(C₁-C₆)-alkyl, heterocyclylsulfonyl-(C₁-C₆)-alkyl, heteroarylsulfonyl-(C₁-C₆)-alkyl, aryl-(C₁-C₆)-alkylsulfonyl-(C₁-C₆)-alkyl, bis-[(C₁-C₆)-alkyl]aminocarbonyl-(C₁-C₆)-alkyl, (C₃-C₆)-cycloalkyl-[(C₁-C₆)-alkyl]aminocarbonyl-(C₁-C₆)-alkyl, aryl-[(C₁-C₆)-alkyl]aminocarbonyl-(C₁-C₆)-alkyl, aryl-(C₁-C₆)-alkyl-[(C₁-C₆)-alkyl]aminocarbonyl-(C₁-C₆)-alkyl, (C₂-C₆)-alkenylaminocarbonyl-(C₁-C₆)-alkyl, (C₂-C₆)-alkynylaminocarbonyl-(C₁-C₆)-alkyl, (C₁-C₆)-alkylamino, bis-[(C₁-C₆)-alkyl]amino, (C₃-C₆)-cycloalkyl[(C₁-C₆)-alkyl]amino, amino, (C₂-C₆)-alkenylamino, (C₂-C₆)-alkynylamino, arylamino, heteroarylamino, aryl-(C₁-C₆)-alkylamino, heteroaryl-(C₁-C₆)-alkylamino, heterocyclylamino, heterocyclyl-(C₁-C₆)-alkylamino, (C₂-C₆)-alkenylcarbonyl-(C₁-C₆)-alkyl, (C₂-C₆)-alkynylcarbonyl-(C₁-C₆)-alkyl, (C₃-C₆)-cycloalkyl-(C₁-C₆)-alkylaminocarbonyl-(C₁-C₆)-alkyl, (C₃-C₆)-cycloalkyl-(C₁-C₆)-alkyl-[(C₁-C₆)-alkyl]aminocarbonyl-(C₁-C₆)-alkyl, (C₂-C₆)-alkenylsulfonyl-(C₁-C₆)-alkyl, (C₂-C₆)-alkynylsulfonyl-(C₁-C₆)-alkyl, heteroaryl-(C₁-C₆)-alkylsulfonyl-(C₁-C₆)-alkyl, heterocyclyl-(C₁-C₆)-alkylsulfonyl-(C₁-C₆)-alkyl, (C₂-C₆)-alkenylsulfinyl-(C₁-C₆)-alkyl, (C₂-C₆)-alkynylsulfinyl-(C₁-C₆)-alkyl, heteroaryl-(C₁-C₆)-alkylsulfinyl-(C₁-C₆)-alkyl, heterocyclyl-(C₁-C₆)-alkylsulfinyl-(C₁-C₆)-alkyl, (C₂-C₆)-alkenyloxy-(C₁-C₆)-alkoxy-(C₁-C₆)-alkyl, (C₂-C₆)-alkynyloxy-(C₁-C₆)-alkoxy-(C₁-C₆)-alkyl, heteroaryl-(C₁-C₆)-alkoxy-(C₁-C₆)-alkyl, heterocyclyl-(C₁-C₆)-alkoxy-(C₁-C₆)-alkyl, tris[(C₁-C₆)-alkyl]silyl, tris[(C₁-C₆)-alkyl]silyl-(C₁-C₆)-alkyl, (C₁-C₆)-alkoxy, (C₁-C₆)-haloalkoxy, (C₁-C₆)-alkylamino-(C₁-C₆)-alkyl, bis-[(C₁-C₆)-alkyl]amino-(C₁-C₆)-alkyl, (C₃-C₆)-cycloalkyl[(C₁-C₆)-alkyl]amino-(C₁-C₆)-alkyl, amino-(C₁-C₆)-alkyl, (C₂-C₆)-alkenylamino-(C₁-C₆)-alkyl, (C₂-C₆)-alkynylamino-(C₁-C₆)-alkyl, arylamino-(C₁-C₆)-alkyl, heteroarylamino-(C₁-C₆)-alkyl, aryl-(C₁-C₆)-alkylamino-(C₁-C₆)-alkyl, heteroaryl-(C₁-C₆)-alkylamino-(C₁-C₆)-alkyl, heterocyclylamino-(C₁-C₆)-alkyl, heterocyclyl-(C₁-C₆)-alkylamino-(C₁-C₆)-alkyl, (C₁-C₆)-haloalkoxy-(C₁-C₆)-haloalkyl, (C₂-C₆)-alkenyloxy-(C₁-C₆)-haloalkyl, (C₂-C₆)-alkynyloxy-(C₁-C₆)-haloalkyl, (C₁-C₆)-alkoxy-(C₁-C₆)-alkoxy-(C₁-C₆)-haloalkyl, (C₃-C₆)-cycloalkyl-(C₁-C₆)-alkoxy-(C₁-C₆)-haloalkyl, (C₃-C₆)-cycloalkyl-(C₁-C₆)-alkoxy-(C₁-C₆)-alkyl, (C₁-C₆)-alkoxy-(C₁-C₆)-alkoxy, (C₁-C₆)-alkoxycarbonyl-(C₃-C₆)-cycloalkyl,
R², R³, R⁴ are each independently hydrogen, fluorine, chlorine, bromine, iodine, (C₁-C₆)-alkoxy, (C₁-C₆)-alkyl, (C₁-C₆)-haloalkyl, (C₁-C₆)-haloalkoxy, (C₁-C₆)-alkylthio, (C₁-C₆)-haloalkylthio, optionally substituted phenyl, heteroaryl, heterocyclyl, (C₃-C₆)-cycloalkyl, aryl-(C₁-C₆)-alkyl, aryl-(C₂-C₆)-alkenyl, (C₂-C₆)-alkynyl, (C₂-C₆)-alkenyl, aryl-(C₁-C₆)-alkynyl, heteroaryl-(C₁-C₆)-alkyl, heteroaryl-(C₂-C₆)-alkenyl, heteroaryl-(C₁-C₆)-alkynyl, aryloxy, heteroaryloxy,
R⁵ is amino, (C₁-C₆)-alkyl, (C₃-C₆)-cycloalkyl, (C₃-C₆)-cycloalkyl-(C₁-C₆)-alkyl, (C₁-C₆)-haloalkyl, (C₃-C₆)-halocycloalkyl, (C₄-C₆)-cycloalkenyl, optionally substituted phenyl, heteroaryl, heterocyclyl, aryl-(C₁-C₆)-alkyl, heteroaryl-(C₁-C₆)-alkyl, heterocyclyl-(C₁-C₆)-alkyl, (C₁-C₆)-alkoxycarbonyl-(C₁-C₆)-alkyl, aryl-(C₁-C₆)-alkoxycarbonyl-(C₁-C₆)-alkyl, (C₃-C₆)-cycloalkoxycarbonyl-(C₁-C₆)-alkyl, (C₃-C₆)-cycloalkyl-(C₁-C₆)-alkoxycarbonyl-(C₁-C₆)-alkyl, heteroaryl-(C₁-C₆)-alkoxycarbonyl-(C₁-C₆)-alkyl, aminocarbonyl-(C₁-C₆)-alkyl, (C₁-C₆)-alkylaminocarbonyl-(C₁-C₆)-alkyl, (C₃-C₆)-cycloalkylaminocarbonyl-(C₁-C₆)-alkyl, aryl-(C₁-C₆)-alkylaminocarbonyl-(C₁-C₆)-alkyl, (C₁-C₆)-alkylamino, bis-[(C₁-C₆)-alkyl]amino, arylamino, (C₃-C₆)-cycloalkylamino, aryl-(C₁-C₆)-alkylamino, heteroaryl-(C₁-C₆)-alkylamino, heteroarylamino, heterocyclylamino, (C₂-C₆)-alkenylamino, (C₂-C₆)-alkynylamino, aryloxy-(C₁-C₆)-alkyl, heteroaryloxy-(C₁-C₆)-alkyl, (C₁-C₆)-alkoxy-(C₁-C₆)-alkyl, (C₂-C₆)-alkenyl, (C₂-C₆)-alkynyl, cyano-(C₁-C₆)-alkyl, aryloxy, aryl-(C₂-C₆)-alkenyl, heteroaryl-(C₂-C₆)-alkenyl, heterocyclyl-(C₂-C₆)-alkenyl,
R⁶ is hydrogen, (C₁-C₆)-alkyl, (C₃-C₆)-cycloalkyl, cyano-(C₁-C₆)-alkyl, (C₃-C₆)-cycloalkyl-(C₁-C₆)-alkyl, (C₁-C₆)-alkylsulfonyl, arylsulfonyl, aryl-(C₁-C₆)-alkylsulfonyl, heteroarylsulfonyl, (C₃-C₆)-cycloalkylsulfonyl, heterocyclylsulfonyl, (C₁-C₆)-alkylcarbonyl, arylcarbonyl, heteroarylcarbonyl, (C₃-C₆)-cycloalkylcarbonyl, heterocyclylcarbonyl, (C₁-C₆)-alkoxycarbonyl, aryl-(C₁-C₆)-alkoxycarbonyl, (C₁-C₆)-haloalkylcarbonyl, (C₂-C₆)-alkenyl, (C₂-C₆)-alkynyl, (C₁-C₆)-haloalkyl, halo-(C₂-C₆)-alkynyl, halo-(C₂-C₆)-alkenyl, (C₁-C₆)-alkoxy-(C₁-C₆)-alkyl,
R⁹, R¹⁰ are each independently hydrogen, (C₁-C₆)-alkyl, halogen, cyano, (C₁-C₆)-haloalkyl, cyano-(C₁-C₆)-alkyl, aryl, heteroaryl, (C₃-C₆)-cycloalkyl, (C₄-C₆)-cycloalkenyl, heterocyclyl, (C₁-C₆)-alkoxy-(C₁-C₆)-alkyl, (C₁-C₆)-alkylthio-(C₁-C₆)-alkyl and
W is oxygen or sulfur.

14. A spray solution for treatment of plants, comprising an amount, effective for increasing the resistance of plants to abiotic stress factors, of one or more substituted oxotetrahydroquinolinylsulfonamide as claimed in claim 11.
